(19) United States
(12) Patent Application Publication
(10) Pub. No.: US 2025/0377758 A1
(43) Pub. Date: Dec. 11, 2025

(54) Devices, Methods, And Graphical User Interfaces For Interacting With Volumetric Application User Interfaces Within Three-Dimensional Environments

(71) Applicant: Apple Inc., Cupertino, CA (US)

(72) Inventors: Benjamin H. Boesel, Jackson, WY (US); Amy E. DeDonato, San Francisco, CA (US); Lynn I. Streja, San Francisco, CA (US)

(21) Appl. No.: 19/226,051

(22) Filed: Jun. 2, 2025

Related U.S. Application Data
(60) Provisional application No. 63/657,710, filed on Jun. 7, 2024.
(60) Provisional application No. 63/808,126, filed on May 19, 2025.

(51) Int. Cl. G06F 3/04815; G06F 3/01; G06F 3/04845; G06T 19/20

(52) U.S. Cl. CPC G06F 3/04815; G06F 3/013; G06F 3/04845; G06T 19/20; G06T 2200/24; G06T 2219/2016

(57) ABSTRACT

While displaying first application content that corresponds to a first application in a first view of a three-dimensional environment, a computer system detects a first change in position of attention of a user relative to the first application content. In response to detecting the first change in position, the computer system: in accordance with a determination that the attention of the user has moved closer to a first portion of a first boundary than to a second portion of the first boundary, visually emphasizes the first portion of the first boundary relative to the second portion of the first boundary; and in accordance with a determination that the attention of the user has moved closer to the second portion of the first boundary than the first portion of the first boundary, visually emphasizes the second portion of the first boundary relative to the first portion of the first boundary.

### RELATED APPLICATIONS

This application claims the benefit of and priority to U.S. Patent Application No. 63/808,126, filed on May 19, 2025, and U.S. Patent Application No. 63/657,710, filed on Jun. 7, 2024, each of which is hereby incorporated by reference in its entirety.

### TECHNICAL FIELD

The present disclosure relates generally to computer systems that are in communication with a display generation component and, optionally, one or more input devices that provide computer-generated experiences, including, but not limited to, electronic devices that provide virtual reality and mixed reality experiences via a display.

### BACKGROUND

The development of computer systems for augmented reality has increased significantly in recent years. Example augmented reality environments include at least some virtual elements that replace or augment the physical world. Input devices, such as cameras, controllers, joysticks, touch-sensitive surfaces, and touch-screen displays for computer systems and other electronic computing devices are used to interact with virtual/augmented reality environments. Example virtual elements include virtual objects, such as digital images, video, text, icons, and control elements such as buttons and other graphics.

### SUMMARY

Some methods and interfaces for interacting with volumetric application user interfaces within environments that include at least some virtual elements (e.g., applications, augmented reality environments, mixed reality environments, and virtual reality environments) are cumbersome, inefficient, and limited. For example, systems that do not provide affordances and/or user interface elements for interacting within an application volume of a volumetric application user interface and/or provide insufficient feedback for performing actions associated with virtual objects, systems that require a series of inputs to achieve a desired outcome in an augmented reality environment, and systems in which manipulation of virtual objects are complex, tedious, and error-prone, create a significant cognitive burden on a user, and detract from the experience with the virtual/augmented reality environment. In addition, these methods take longer than necessary, thereby wasting energy of the computer system. This latter consideration is particularly important in battery-operated devices.

Accordingly, there is a need for computer systems with improved methods and interfaces for interacting with volumetric application user interfaces that make interaction with the computer systems more efficient and intuitive for a user. Such methods and interfaces optionally complement or replace conventional methods for interacting with volumetric application user interfaces when providing extended reality experiences to users. Such methods and interfaces reduce the number, extent, and/or nature of the inputs from a user by helping the user to understand the connection between provided inputs and device responses to the inputs, thereby creating a more efficient human-machine interface.

The above deficiencies and other problems associated with user interfaces for computer systems are reduced or eliminated by the disclosed systems. In some embodiments, the computer system is a desktop computer with an associated display. In some embodiments, the computer system is a portable device (e.g., a notebook computer, tablet computer, or handheld device). In some embodiments, the computer system is a personal electronic device (e.g., a wearable electronic device, such as a watch, or a head-mounted device). In some embodiments, the computer system has a touchpad. In some embodiments, the computer system has one or more cameras. In some embodiments, the computer system has a touch-sensitive display (also known as a “touch screen” or “touch-screen display”). In some embodiments, the computer system has one or more eye-tracking components. In some embodiments, the computer system has one or more hand-tracking components. In some embodiments, the computer system has one or more output devices in addition to the display generation component, the output devices including one or more tactile output generators and/or one or more audio output devices. In some embodiments, the computer system has a graphical user interface (GUI), one or more processors, memory and one or more modules, programs or sets of instructions stored in the memory for performing multiple functions. In some embodiments, the user interacts with the GUI through a stylus and/or finger contacts and gestures on the touch-sensitive surface, movement of the user's eyes and hand in space relative to the GUI (and/or computer system) or the user's body as captured by cameras and other movement sensors, and/or voice inputs as captured by one or more audio input devices. In some embodiments, the functions performed through the interactions optionally include image editing, drawing, presenting, word processing, spreadsheet making, game playing, telephoning, video conferencing, e-mailing, instant messaging, workout support, digital photographing, digital videoing, web browsing, digital music playing, note taking, and/or digital video playing. Executable instructions for performing these functions are, optionally, included in a transitory and/or non-transitory computer readable storage medium or other computer program product configured for execution by one or more processors.

There is a need for electronic devices with improved methods and interfaces for interacting with volumetric application user interfaces within a three-dimensional environment. Such methods and interfaces may complement or replace conventional methods for interacting with volumetric application user interfaces within a three-dimensional environment. Such methods and interfaces reduce the number, extent, and/or the nature of the inputs from a user and produce a more efficient human-machine interface. For battery-operated computing devices, such methods and interfaces conserve power and increase the time between battery charges.

A method is performed at a computer system that is in communication with one or more display generation components and one or more input devices. The method includes displaying, via the one or more display generation components, a first view of a three-dimensional environment. The first view of the three-dimensional environment corresponds to a first viewpoint of a user, and includes a first three-dimensional application volume that corresponds to a first application. The method includes, while displaying the first three-dimensional application volume in the first view of the three-dimensional environment, detecting occurrence of a first event. The method includes, in response to detecting the occurrence of the first event: in accordance with a determination that first criteria are met as a result of the occurrence of the first event and that the first viewpoint of the user is outside of a first threshold range of a respective portion of the first three-dimensional application volume, displaying a first user interface object at a first location in the three-dimensional environment, wherein the first location is on a first side of a boundary of the first three-dimensional application volume; and in accordance with a determination that the first criteria are met as the result of the occurrence of the first event and that the first viewpoint of the user is within the first threshold range of the respective portion of the first three-dimensional application volume, displaying the first user interface object at a second location in the three-dimensional environment, wherein the second location is on a second side of the boundary of the first three-dimensional application volume.

A method is performed at a computer system that is in communication with one or more display generation components and one or more input devices. The method includes displaying, via the one or more display generation components, a first view of a three-dimensional environment. The first view of the three-dimensional environment includes first application content that corresponds to a first application. The method includes, while displaying the first application content that corresponds to the first application in the first view of the three-dimensional environment, detecting a first change in position of attention of a user relative to the first application content. The method includes, in response to detecting the first change in position of the attention of the user relative to the first application content: in accordance with a determination that the attention of the user has moved closer to a first portion of a first boundary that confines the first application content in two or more dimensions than to a second portion of the first boundary that is adjacent to the first portion of the first boundary, visually emphasizing the first portion of the first boundary relative to the second portion of the first boundary; and in accordance with a determination that the attention of the user has moved closer to the second portion of the first boundary than the first portion of the first boundary, visually emphasizing the second portion of the first boundary relative to the first portion of the first boundary.

A method is performed at a computer system that is in communication with one or more display generation components and one or more input devices. The method includes displaying, via the one or more display generation components, a first view of a three-dimensional environment. The first view of the three-dimensional environment corresponds to a first viewpoint of a user, and includes a first three-dimensional application volume that corresponds to a first application. The first three-dimensional application volume has a first size at a first depth relative to the first viewpoint of the user in the three-dimensional environment. Three-dimensional application content of the first application is confined within the first three-dimensional application volume. The method includes, while displaying the first view of the three-dimensional environment that includes the first three-dimensional application volume at the first depth with the first size, detecting a first user input that corresponds to a request to move the first three-dimensional application volume from the first depth to a second depth relative to the first viewpoint of the user. The method includes, in response to detecting the first user input that corresponds to the request to move the first three-dimensional application volume from the first depth to the second depth relative to the first viewpoint of the user: ceasing to display the first three-dimensional application volume at the first depth relative to the first viewpoint of the user; and displaying the first three-dimensional application volume at the second depth relative to the first viewpoint of the user with a second size of the first three-dimensional application volume that is different from the first size of the first three-dimensional application volume.

A method is performed at a computer system that is in communication with one or more display generation components and one or more input devices. The method includes displaying, via the one or more display generation components, a first view of a three-dimensional environment. The first view of the three-dimensional environment corresponds to a first viewpoint of a user, and includes a first three-dimensional application volume that corresponds to a respective application, and a first user interface object that is displayed at a first position relative to the first three-dimensional application volume. The method includes while displaying the first user interface object at the first position relative to the first three-dimensional application volume, detecting movement of a current viewpoint of the user from the first viewpoint to a second viewpoint, wherein the second viewpoint is different from the first viewpoint. The method includes, in response to detecting the movement of the current viewpoint of the user from the first viewpoint to the second viewpoint: in accordance with a determination that the first three-dimensional application volume meets first criteria, wherein the first criteria include a requirement that the first three-dimensional application volume is a first type of application volume in order to for the first criteria to be met, ceasing to display the first user interface object at the first position and displaying the first user interface object at a second position relative to the first three-dimensional application volume, wherein the second position is different from the first position; and in accordance with a determination that the first three-dimensional application volume meets second criteria, wherein the second criteria include a requirement that the first three-dimensional application volume is a second type of application volume in order for the first criteria to be met, ceasing to display the first user interface object at the first position and displaying the first user interface object at a third position relative to the first three-dimensional application volume, wherein the third position is different from the first position and the second position.

A method is performed at a computer system that is in communication with one or more display generation components and one or more input devices. The method includes displaying, via the one or more display generation components, a first view of a three-dimensional environment. the first view of the three-dimensional environment corresponds to a first viewpoint of a user, and includes a first three-dimensional application volume that corresponds to a first application. The first three-dimensional application volume confines content of the first application, including a first portion of the content of the first application and a second portion of the content of the first application, in two or more dimensions. The method includes while displaying the first view of the three-dimensional environment, including the first three-dimensional application volume that confines the content of the first application in the two or more dimensions, detecting that user interface focus is directed to the first portion of the content of the first application. The method includes, in response to detecting that the user interface focus is directed to the first portion of the content of the first application: in accordance with a determination that the first portion of the content of the first application is behind the second portion of the content of the first application relative to the first viewpoint of the user, changing one or more visual properties of the second portion of the content of the first application to increase a visibility of the first portion of the content of the first application; and in accordance with a determination that the first portion of the content of the first application is not behind the second portion of the content of the first application relative to the first viewpoint of the user, forgoing changing the one or more visual properties of the second portion of the content of the first application to increase a visibility of the first portion of the content of the first application.

A method is performed at a computer system that is in communication with one or more display generation components and one or more input devices. The method includes displaying, via the one or more display generation components, a first view of a three-dimensional environment that includes a first three-dimensional volume that includes three-dimensional virtual content. The method includes while displaying the first three-dimensional volume in the first view of the three-dimensional environment, detecting occurrence of a first event for displaying a first user interface object associated with the first three-dimensional volume. The method includes, in response to detecting the occurrence of the first event: in accordance with a determination that the first user interface object is associated with a first type of content included in the first three-dimensional volume displayed in the first view of the three-dimensional environment, displaying, via the one or more display generation components, the first user interface object at a first location in the three-dimensional environment, wherein the first location has a first spatial relationship to the first three-dimensional volume displayed in the first view of the three-dimensional environment; and in accordance with a determination that the first user interface object is associated with a second type of content included in the first three-dimensional volume displayed in the first view of the three-dimensional environment, wherein the second type of content is different from the first type of content, displaying, via the one or more display generation components, the first user interface object at a second location in the three-dimensional environment, wherein the second location has a second spatial relationship, different from the first spatial relationship, to the first three-dimensional volume displayed in the first view of the three-dimensional environment.

A method is performed at a computer system that is in communication with one or more display generation components and one or more input devices. The method includes displaying, via the one or more display generation components, a first view of a three-dimensional environment. The first view of the three-dimensional environment corresponds to a first viewpoint of a user. The method includes while displaying the first view of the three-dimensional environment, detecting, via the one or more input devices, a first request to display a first user interface element. The method includes, in response to detecting the first request to display the first user interface element: in accordance with a determination that the first request to display the first user interface element is a request to display the first user interface element at a first distance from the first viewpoint of the user, displaying, via the one or more display generation components, the first user interface element at the first distance from the first viewpoint of the user with a first size for the first user interface element; and in accordance with a determination that the first request to display the first user interface element is a request to display the first user interface element at a second distance, different from the first distance, from the first viewpoint of the user, displaying, via the one or more display generation components, the first user interface element at the second distance from the first viewpoint of the user with a second size for the first user interface element that is different from the first size for the first user interface element.

A method is performed at a computer system that is in communication with one or more display generation components and one or more input devices. The method includes displaying, via the one or more display generation components, a first view of a three-dimensional environment that includes three-dimensional virtual content and a two-dimensional user interface element. The method includes while displaying the first view of the three-dimensional environment that includes the three-dimensional virtual content and the two-dimensional user interface element, detecting, via the one or more input devices, one or more inputs that correspond to a first request to move the three-dimensional virtual content from a first location in the three-dimensional environment to a second location in the three-dimensional environment. The method includes moving the three-dimensional virtual content and the two-dimensional user interface element in the three-dimensional environment in accordance with the one or more inputs and changing an orientation of the two-dimensional user interface element from a first orientation relative to the three-dimensional virtual content to a second orientation, different from the first orientation, relative to the three-dimensional virtual content.

Note that the various embodiments described above can be combined with any other embodiments described herein. The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the figures.

FIG. 1A is a block diagram illustrating an operating environment of a computer system for providing extended reality (XR) experiences in accordance with some embodiments.

FIGS. 1B-1P are examples of a computer system for providing XR experiences in the operating environment of FIG. 1A.

FIG. 2 is a block diagram illustrating a controller of a computer system that is configured to manage and coordinate an XR experience for the user in accordance with some embodiments.

FIG. 3A is a block diagram illustrating a display generation component of a computer system that is configured to provide a visual component of the XR experience to the user in accordance with some embodiments.

FIGS. 3B-3G illustrate the use of Application Programming Interfaces (APIs) to perform operations.

FIG. 4 is a block diagram illustrating a hand tracking unit of a computer system that is configured to capture gesture inputs of the user in accordance with some embodiments.

FIG. 5 is a block diagram illustrating an eye tracking unit of a computer system that is configured to capture gaze inputs of the user in accordance with some embodiments.

FIG. 6 is a flow diagram illustrating a glint-assisted gaze tracking pipeline in accordance with some embodiments.

FIGS. 7A-7O illustrate example techniques for displaying a user interface element while a volumetric application is displayed in the viewport, in accordance with some embodiments.

FIGS. 8A-8X illustrate example techniques for displaying visual feedback when attention of the user is directed toward a boundary of a volumetric application, in accordance with some embodiments.

FIGS. 9A-9P illustrate example techniques for scaling of a volumetric application user interface within a three-dimensional environment, in accordance with some embodiments.

FIGS. 10A-10I illustrate example techniques for changing a display location of a user interface element based on a change in a viewpoint of the user, in accordance with some embodiments.

FIGS. 11A-11T illustrate example techniques for resolving spatial conflicts between content elements within a three-dimensional environment with respect to a viewpoint of the user, in accordance with some embodiments.

FIGS. 12A-12G are flow diagrams of methods of displaying a user interface element while a volumetric application is displayed in the viewport, in accordance with various embodiments.

FIGS. 13A-13G are flow diagrams of methods of displaying visual feedback when attention of the user is directed toward a boundary of a volumetric application, in accordance with various embodiments.

FIGS. 14A-14H are flow diagrams of methods of scaling of a volumetric application user interface within a three-dimensional environment, in accordance with various embodiments.

FIGS. 15A-15F are flow diagrams of methods of changing a display location of a user interface element based on a change in a viewpoint of the user, in accordance with various embodiments.

FIGS. 16A-16C are flow diagrams of methods of resolving spatial conflicts between content elements within a three-dimensional environment with respect to a viewpoint of the user, in accordance with various embodiments.

FIGS. 17A-17M illustrate example user interface elements associated with different types of contents of a volumetric application, in accordance with some embodiments.

FIGS. 18A-18AA illustrate example examples of displaying a user interface element with a size that is based on a distance from a viewpoint of the user and/or a distance from a respective portion of an application user interface, in accordance with some embodiments.

FIGS. 19A-19N illustrate example techniques for orienting two-dimensional user interface elements within a three-dimensional application volume when the three-dimensional application volume is moved with respect to the three-dimensional environment, in accordance with some embodiments.

FIG. 20 is a flow diagram of methods of displaying user interface elements associated with different types of contents of a volumetric application, in accordance with various embodiments.

FIG. 21 is a flow diagram of methods of displaying a user interface element with a size that is based on a distance from a viewpoint of the user and/or a distance from a respective portion of an application user interface, in accordance with various embodiments.

FIG. 22 is a flow diagram of methods of orienting two-dimensional user interface elements within a three-dimensional application volume when the three-dimensional application volume is moved with respect to the three-dimensional environment, in accordance with various embodiments.

### DESCRIPTION OF EMBODIMENTS

The present disclosure relates to user interfaces for providing an extended reality (XR) experience to a user, in accordance with some embodiments.

The systems, methods, and GUIs described herein improve user interface interactions with virtual/augmented reality environments in multiple ways.

In some embodiments, a computer system displays a representation of a three-dimensional application (e.g., also referred to herein as a three-dimensional application volume) in a three-dimensional environment, and determines whether to display an alert or other user interface object for a user near an edge of the three-dimensional application or within the three-dimensional application based on a position of the user in the three-dimensional environment. For example, if the user is at a viewpoint that is near a boundary of the representation of the three-dimensional application, the alert or user interface object is displayed near an edge of the representation of the three-dimensional application; and if the user is at a viewpoint that is outside of a threshold distance of the representation of the three-dimensional application, the alert or user interface object is displayed at a position within the representation of the three-dimensional application. Automatically determining a position at which to display an alert or other user interface object relative to a displayed three-dimensional application makes it easier for the user to view and/or interact with alert or other user interface object without requiring the user to change the user's viewpoint of the three-dimensional environment, thereby improving the visibility of the alert or other user interface element and providing the user with additional information and/or control options without visually obscuring the three-dimensional application unnecessarily.

In some embodiments, the computer system displays application content in a three-dimensional environment such that, in response to detecting the user's attention being directed to and/or near a portion of the application content, the system displays visual emphasis of a boundary of the application content to provide the user with improved visual feedback that the user's attention is detected near the application content. Automatically displaying visual emphasis of at least a portion of the boundary of the application content in response to detecting the user's attention directed to the application content improves the visibility of the application content and defines the boundary of the application content such that the user is aware of where the application content begins and/or ends without requiring additional user inputs for the user to explore the application content within the three-dimensional environment. Additionally, visually emphasizing a portion of a boundary relative to another portion of the boundary based on the user's attention moving closer to the portion of the boundary reduces the number of inputs and amount of time needed for the user to locate one or more affordances that perform different operations on the application user interface without displaying additional controls.

In some embodiments, a computer system displays a three-dimensional application volume in a three-dimensional environment with a different size based on moving the three-dimensional application volume to a different depth relative to the user's viewpoint. For example, moving the three-dimensional application volume to a depth in the three-dimensional environment that is farther away from the user's viewpoint causes the system to increase a size of the three-dimensional application volume while the three-dimensional application volume is displayed at the increased depth. Automatically updating a size of the three-dimensional application volume in response to a change in the depth at which the three-dimensional application volume is displayed improves the visibility and legibility of the application volume without requiring additional user input.

In some embodiments, a computer system repositions user interface elements around a three-dimensional application volume in a three-dimensional environment based on movement of the viewpoint of the user relative to the three-dimensional application volume. Automatically repositioning user interface elements for a displayed three-dimensional application based on a current viewpoint of the user improves the visibility of and makes it easier for the user to access the user interface elements even as the viewpoint of the user moves relative to the three-dimensional application, which reduces the amount of time and extent of inputs needed for the user to access control options for the three-dimensional application even from a different viewpoint relative to the three-dimensional application.

In some embodiments, a computer system changes one or more visual properties of a first portion of content within a three-dimensional application volume in response to detecting that another portion of the content of the volumetric application has user interface focus and is behind the first portion of the content from a viewpoint of the user. Changing one or more visual properties of a first portion of the content of a volumetric application to increase a visibility of another portion of the content of the volumetric application that has user interface focus and is behind the first portion of the content from a viewpoint of the user reduces the number of inputs and amount of time needed to display relevant information to the user while maintaining display of depth information within the volumetric application, without displaying additional controls.

In some embodiments, a computer system displays a first user interface object, associated with a first type of content, at a first location in the three-dimensional environment that has a first spatial relationship to a three-dimensional volume displayed in the three-dimensional environment, and displays the first user interface object, associated with a second type of content, at a second location in the three-dimensional environment that has a second spatial relationship to the three-dimensional volume displayed in the three-dimensional environment. Changing a location of where the first user interface object is displayed provides improved feedback to the user while automatically providing display of pertinent information to the user without displaying additional controls.

In some embodiments, a computer system displaying a first user interface element at a first distance from a first viewpoint of the user with a first size and displaying the first user interface element a second distance from the first viewpoint of the user with a second size. Changing a size of a displayed user interface element provides improved feedback to the user by ensuring that the first user interface element can be more easily viewed by the user and helps to maintain display of depth information within the volumetric application, without displaying additional controls.

In some embodiments, a computer system changes an orientation of a two-dimensional user interface element from a first orientation relative to the three-dimensional virtual content to a second orientation relative to the three-dimensional virtual content in response to the movement of the three-dimensional virtual content. Changing an orientation of a two-dimensional user interface element from a first orientation relative to the three-dimensional virtual content to a second orientation relative to the three-dimensional virtual content reduces the number of inputs and amount of time needed to display relevant information to the user while providing improved feedback by displaying information at an orientation that allows the first user interface element to be more easily viewed by the user, without displaying additional controls.

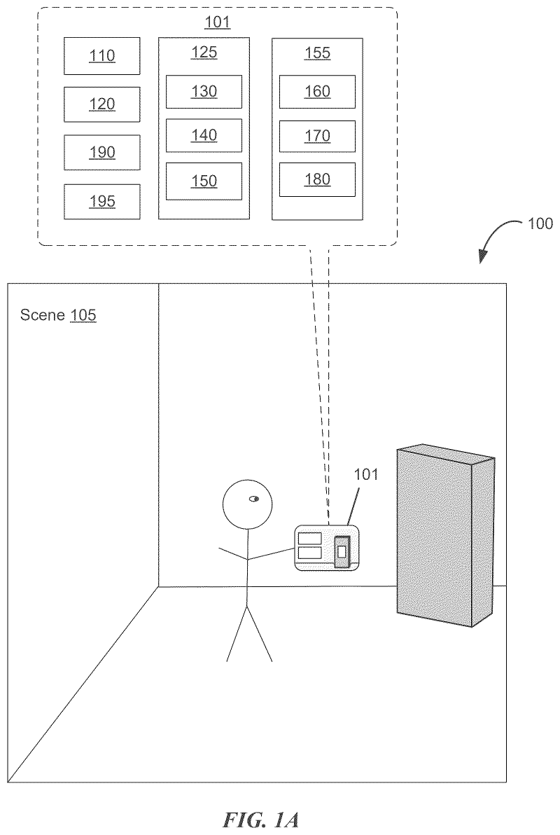

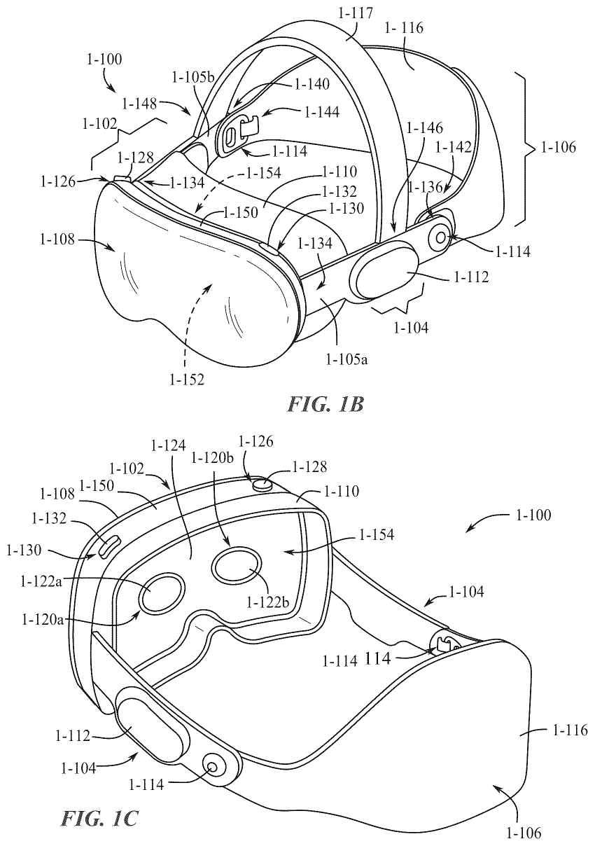

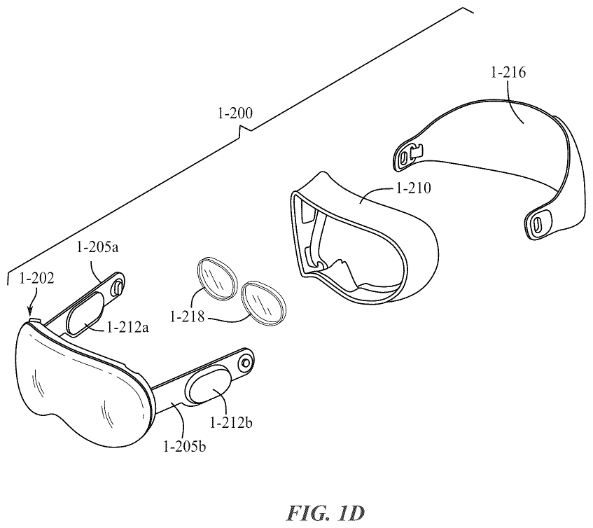

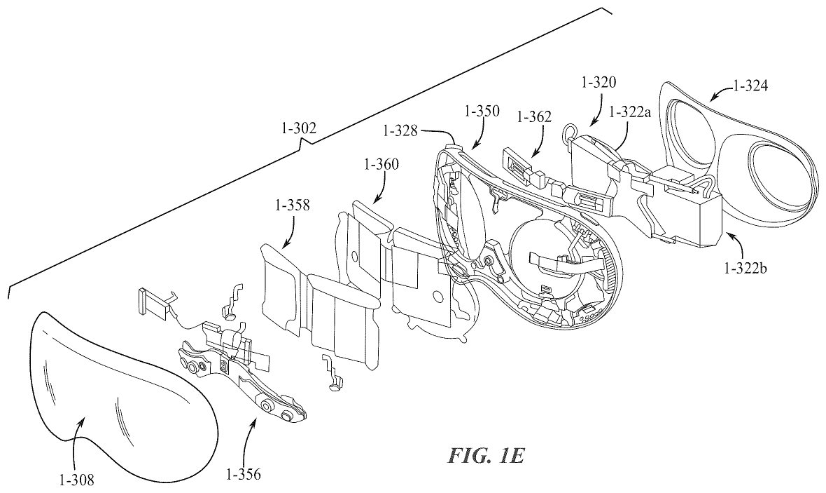

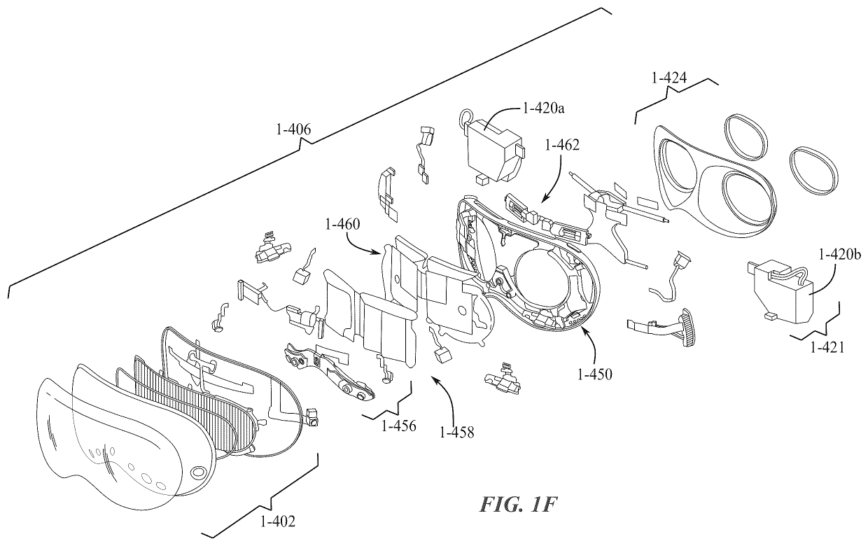

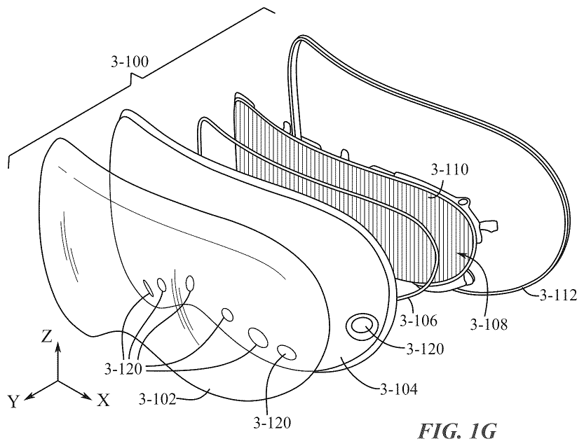

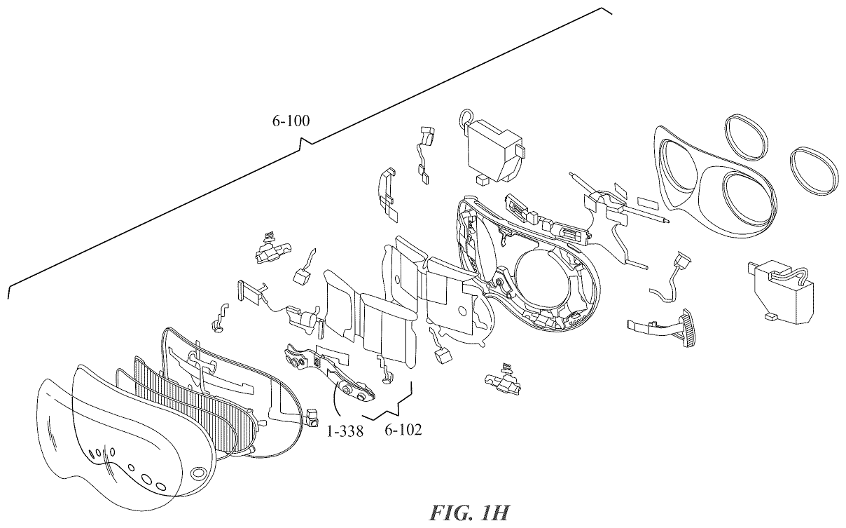

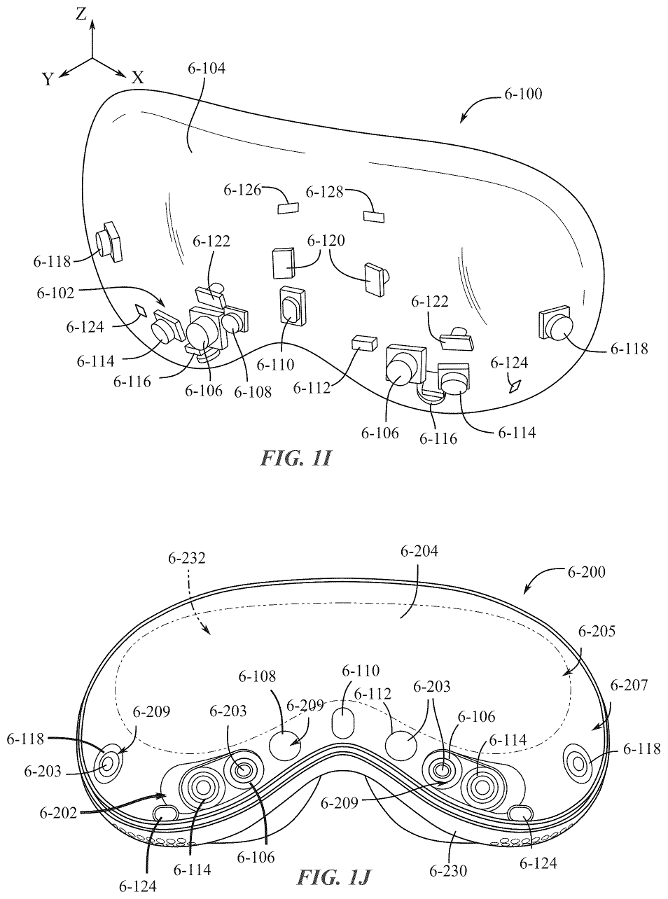

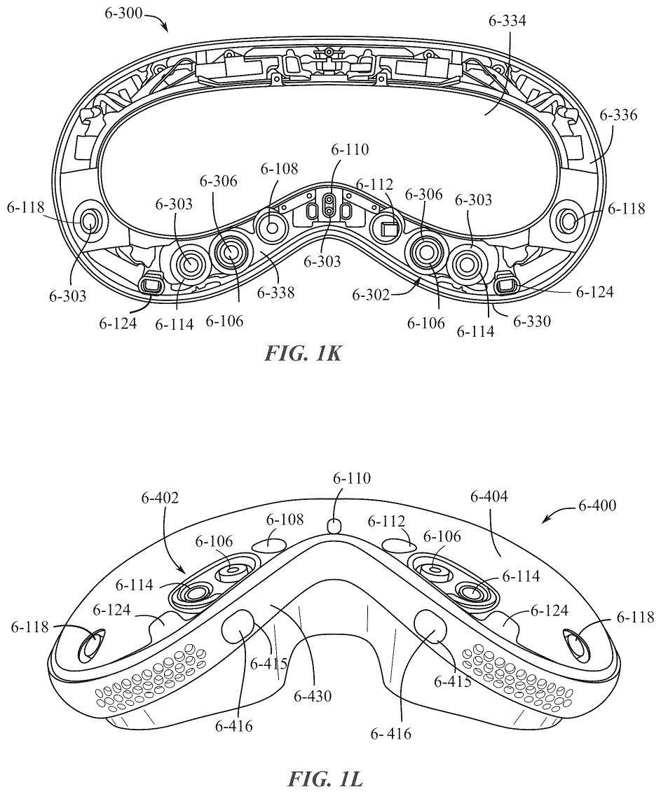

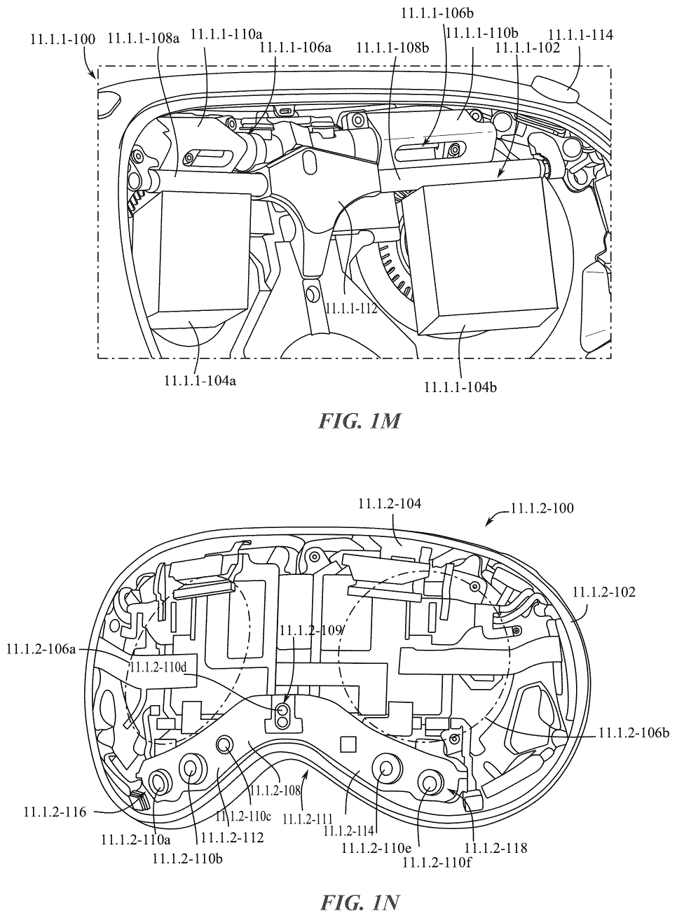

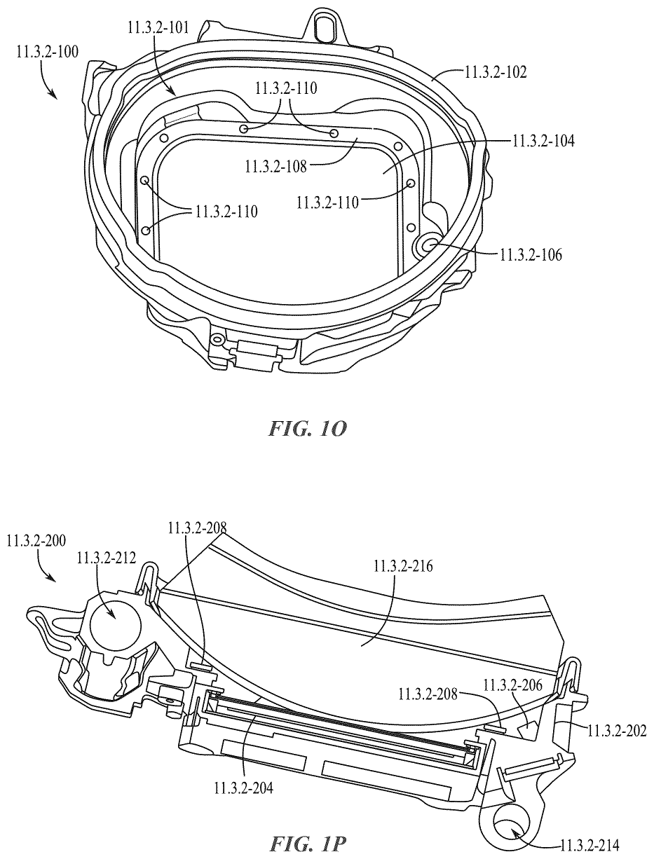

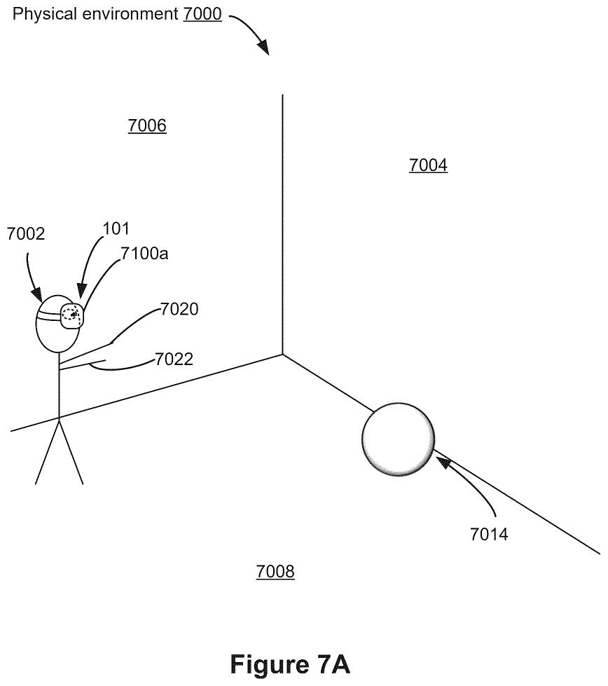

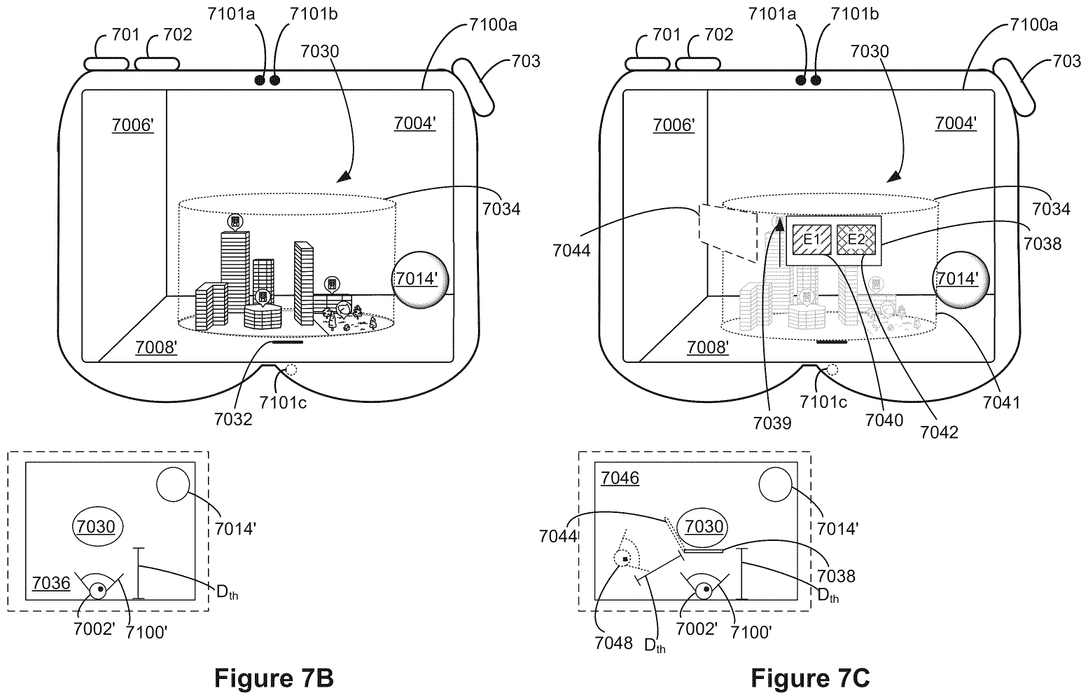

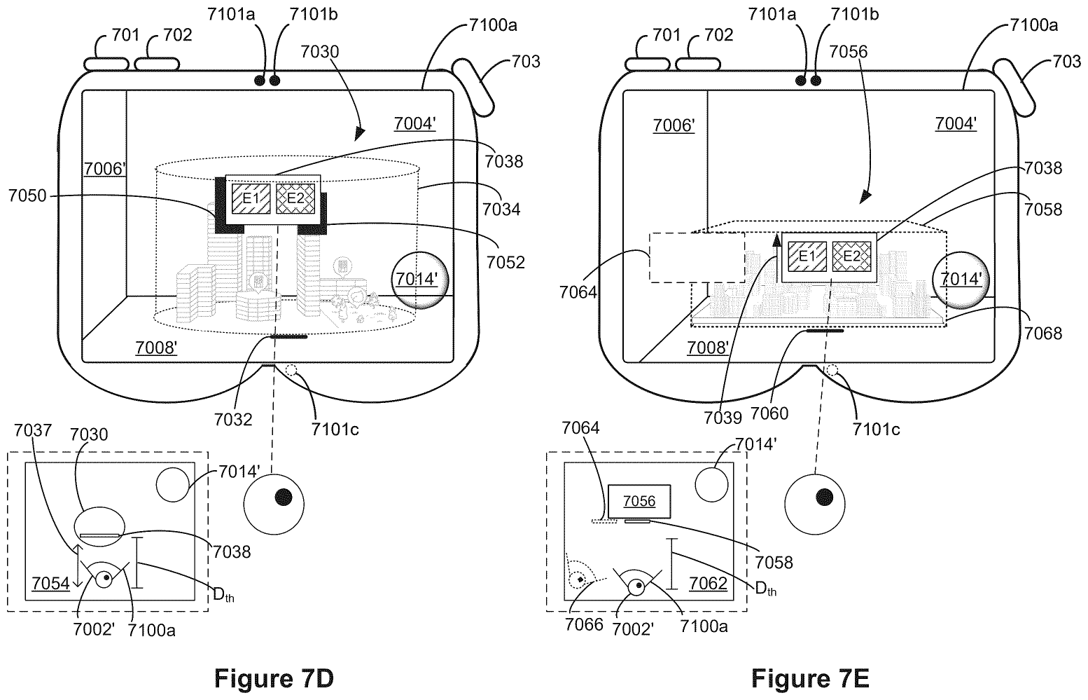

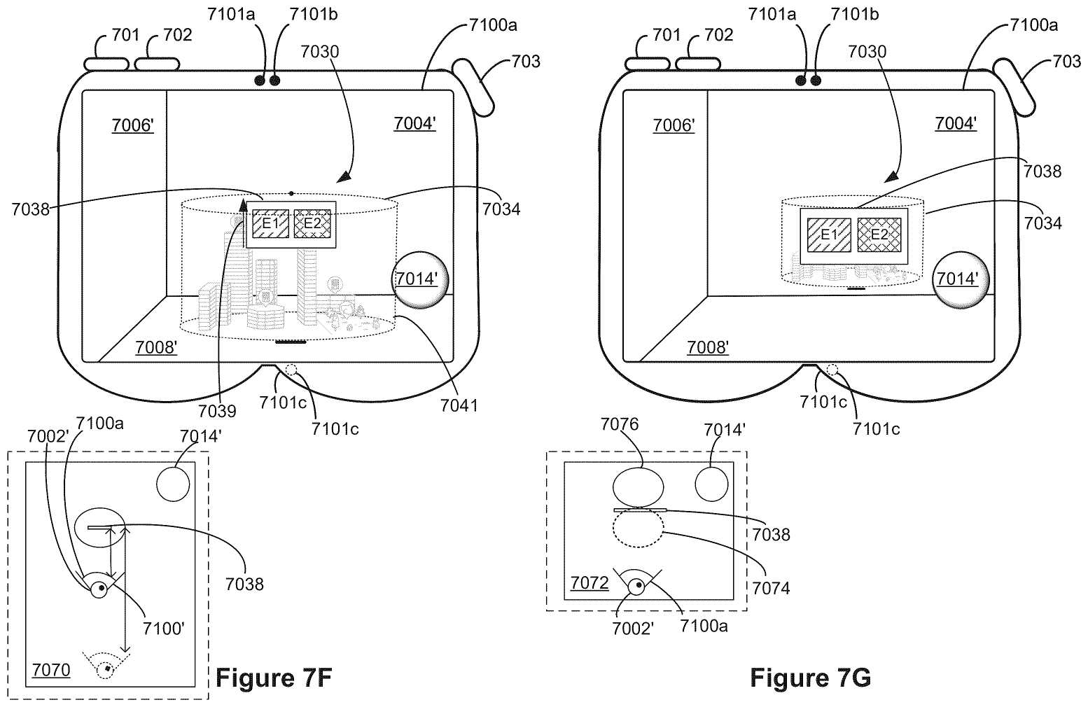

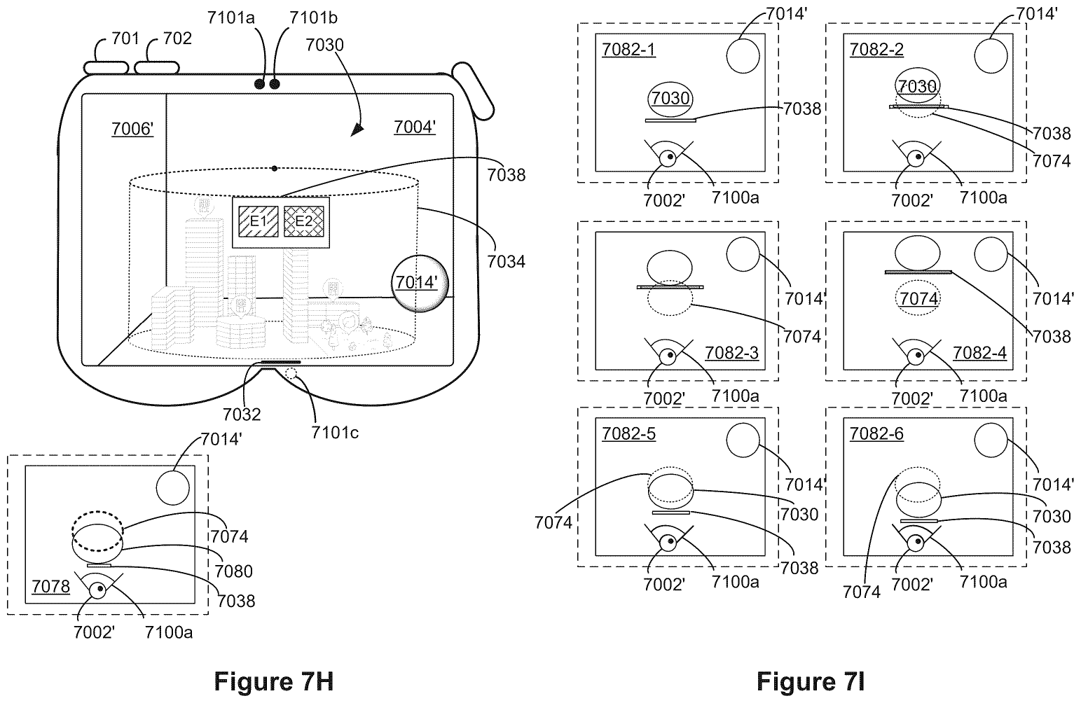

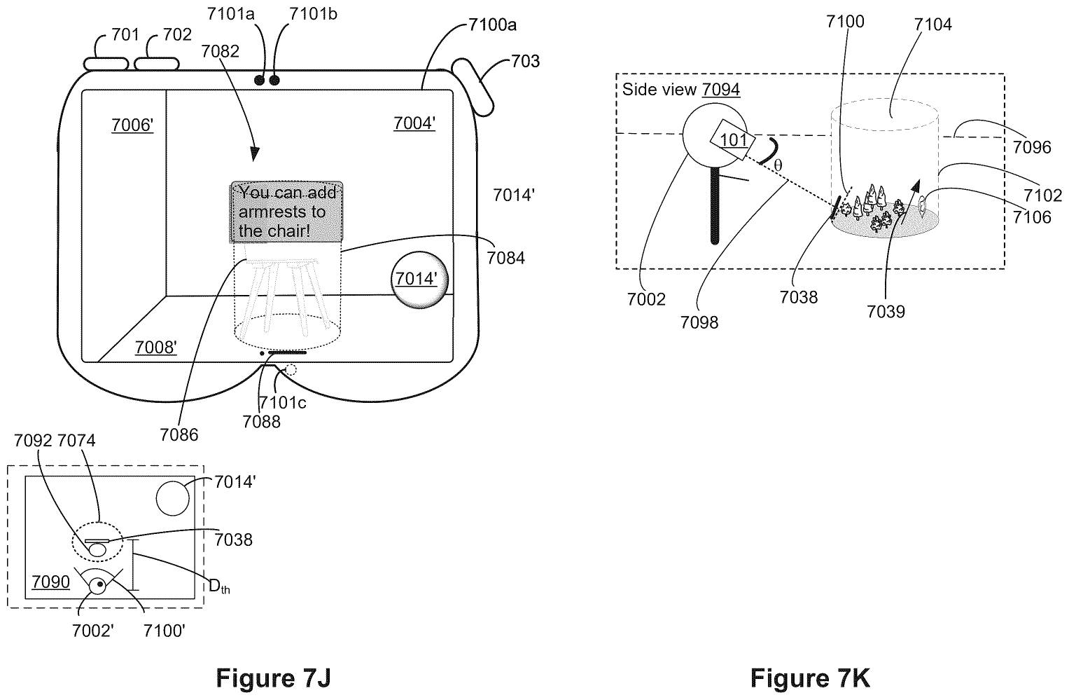

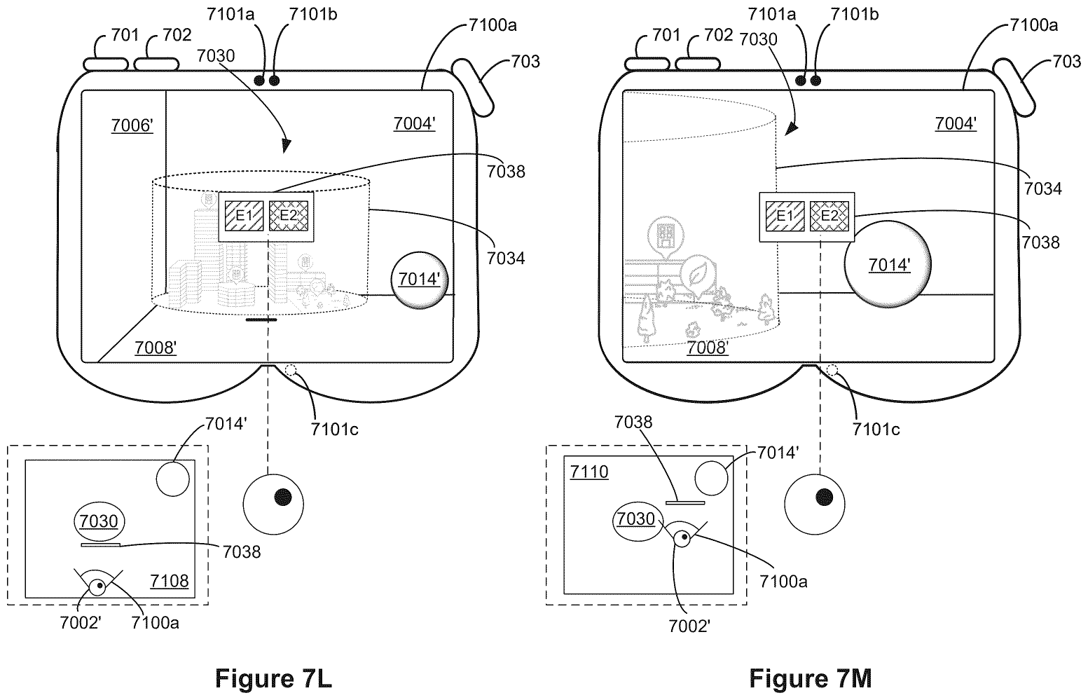

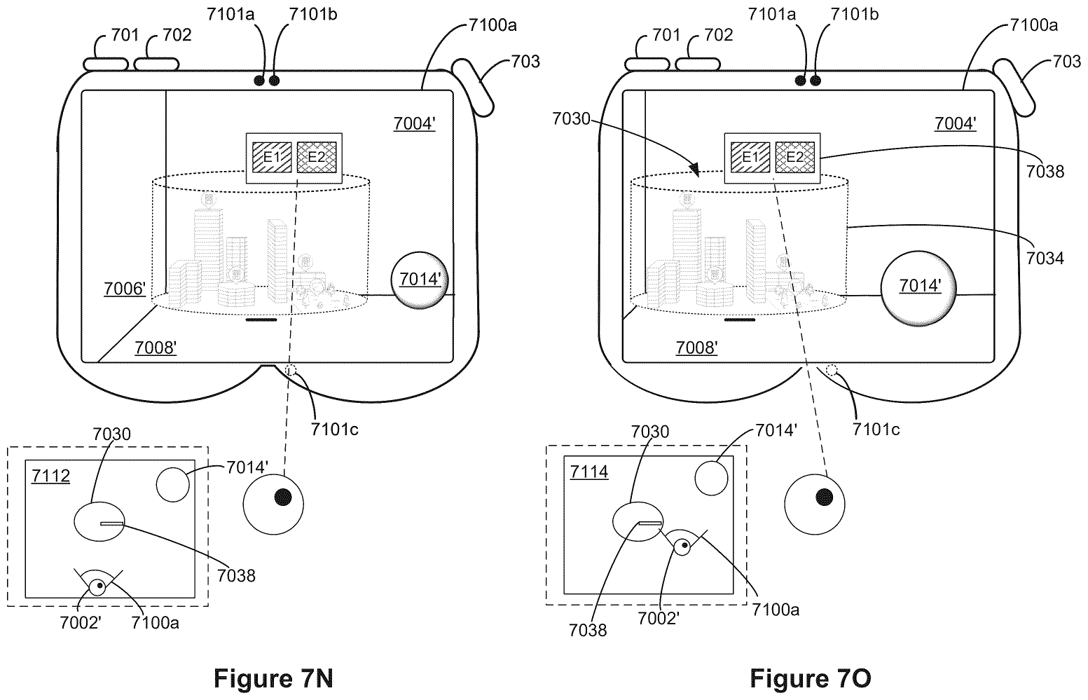

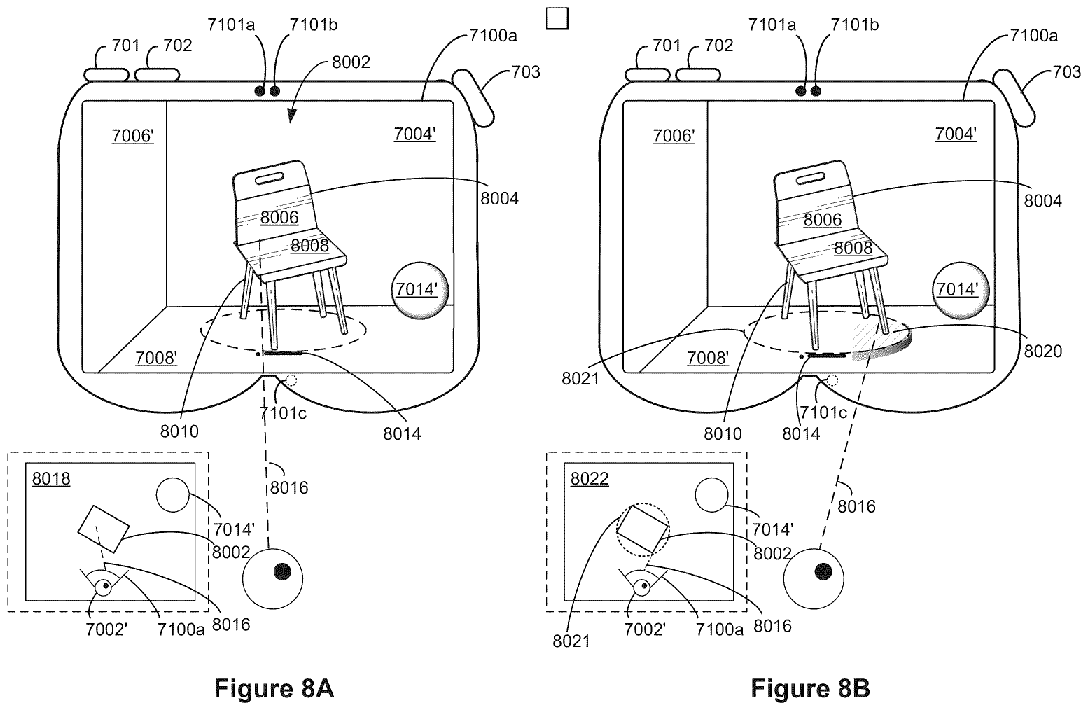

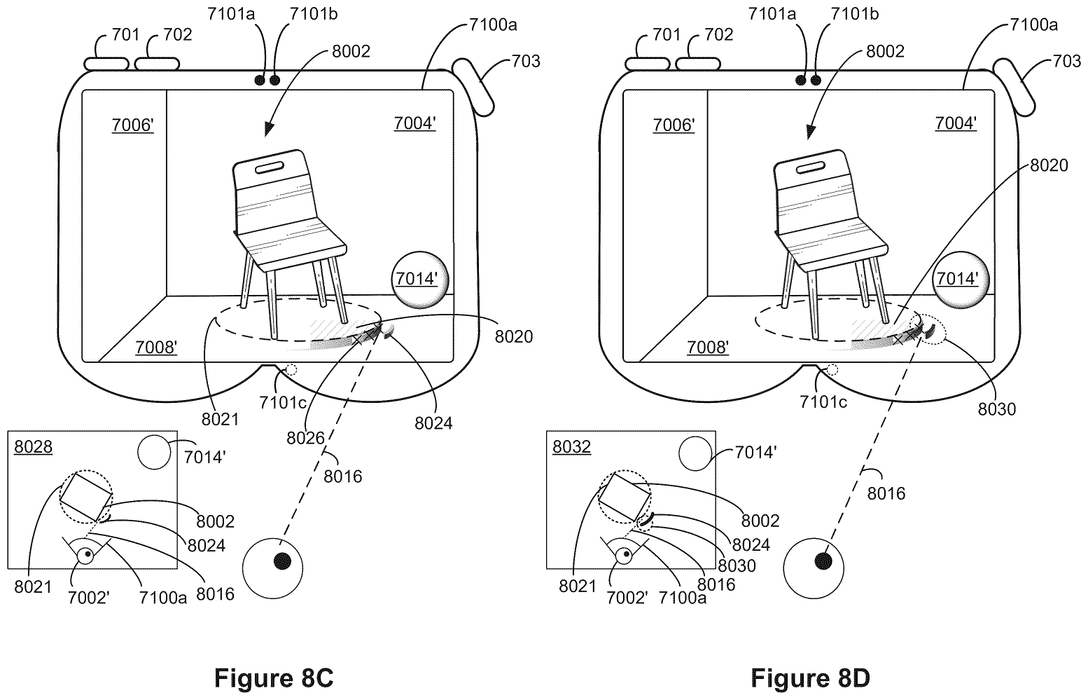

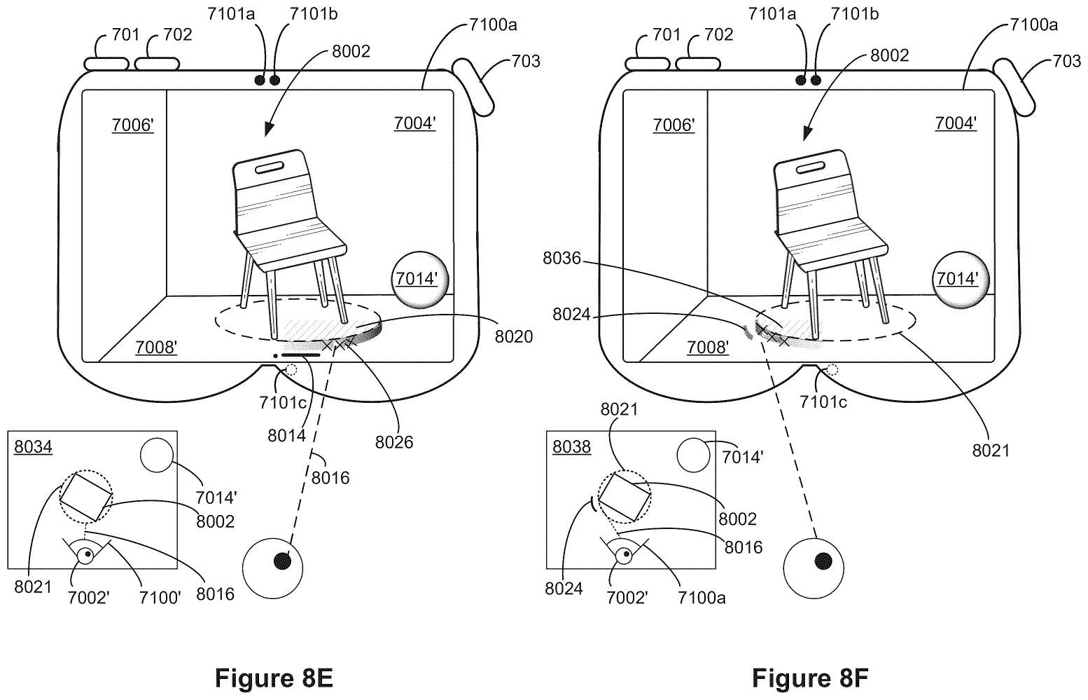

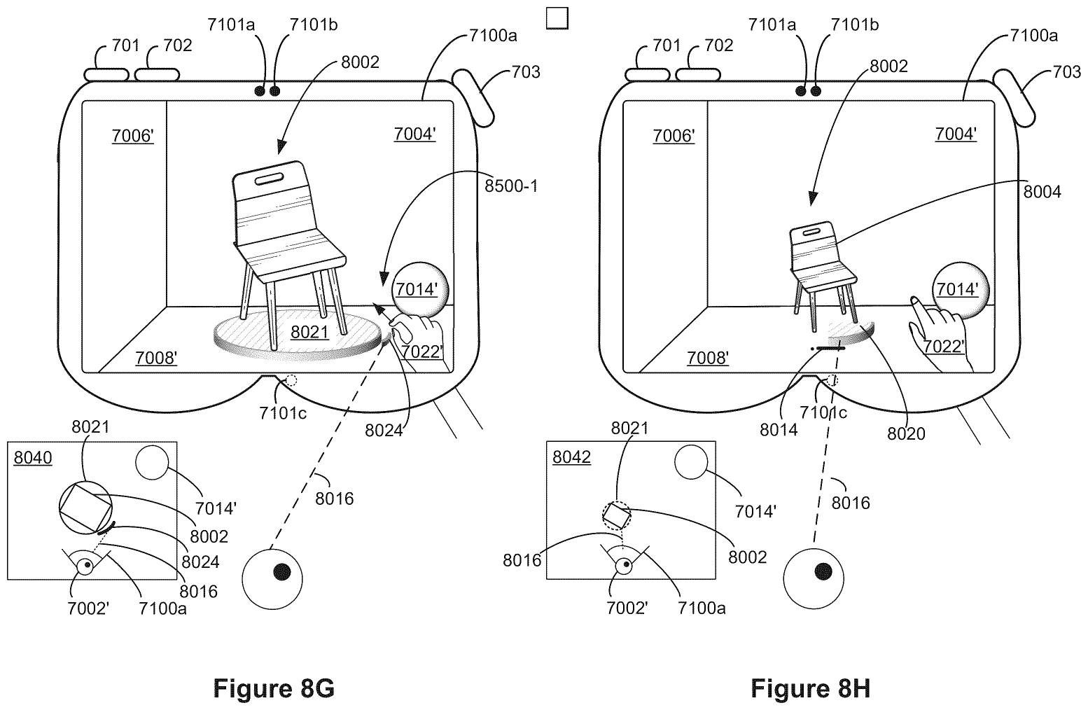

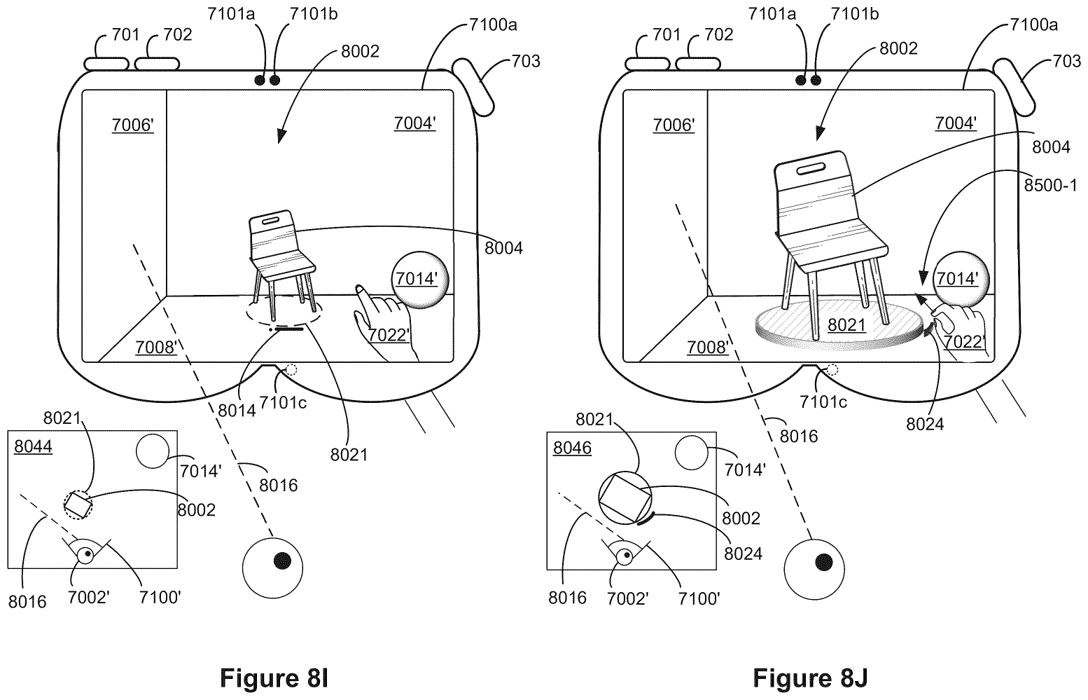

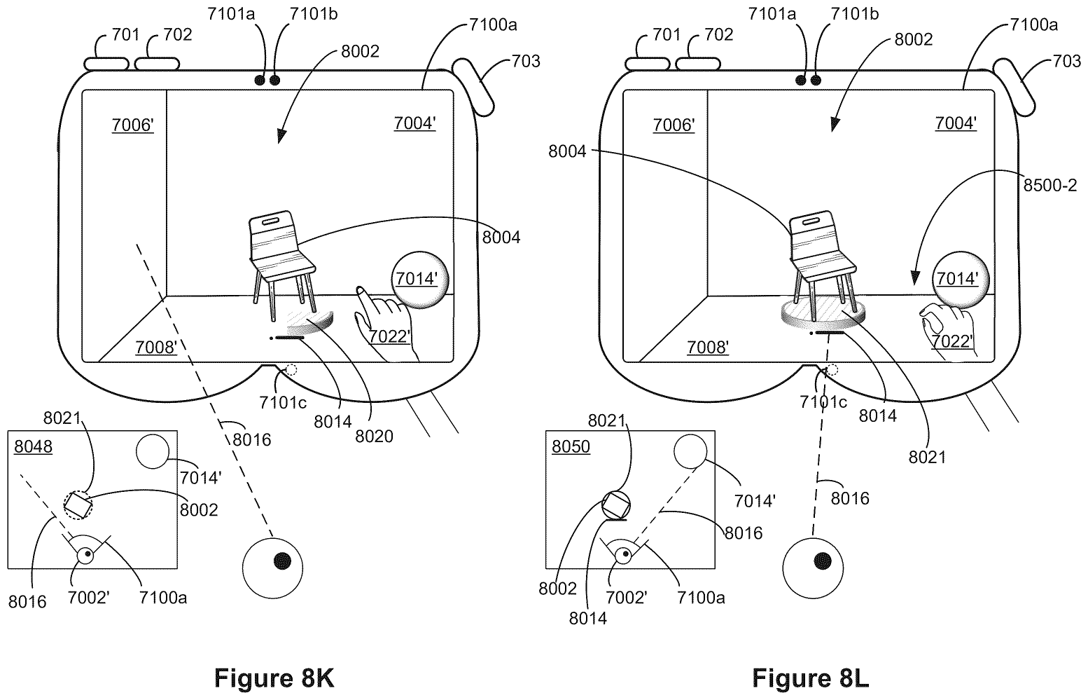

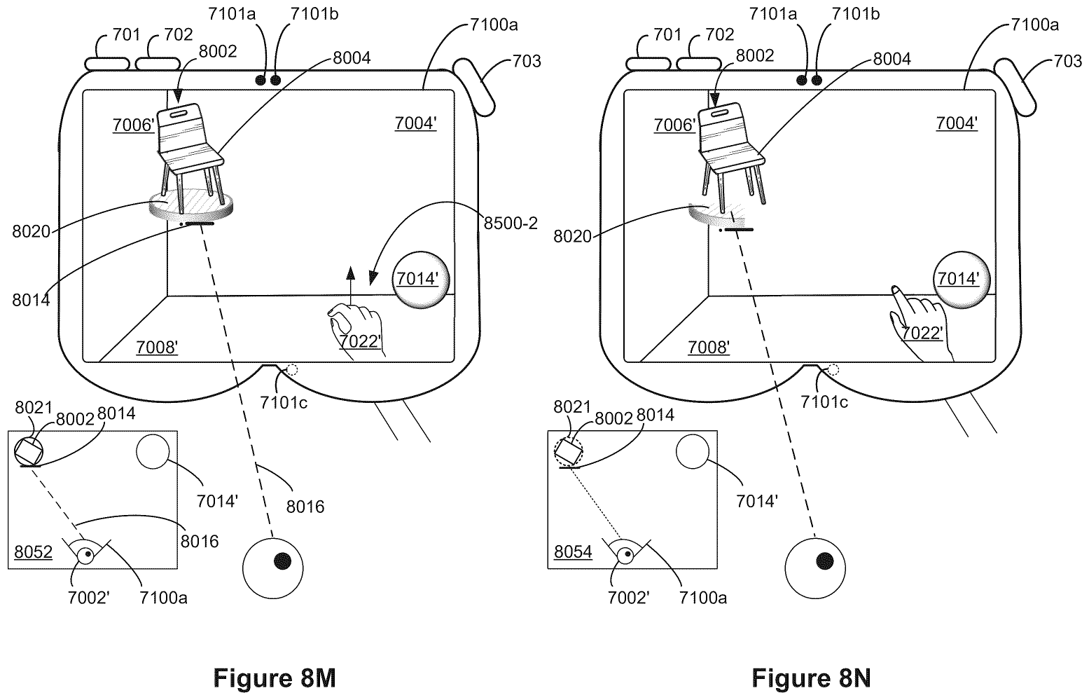

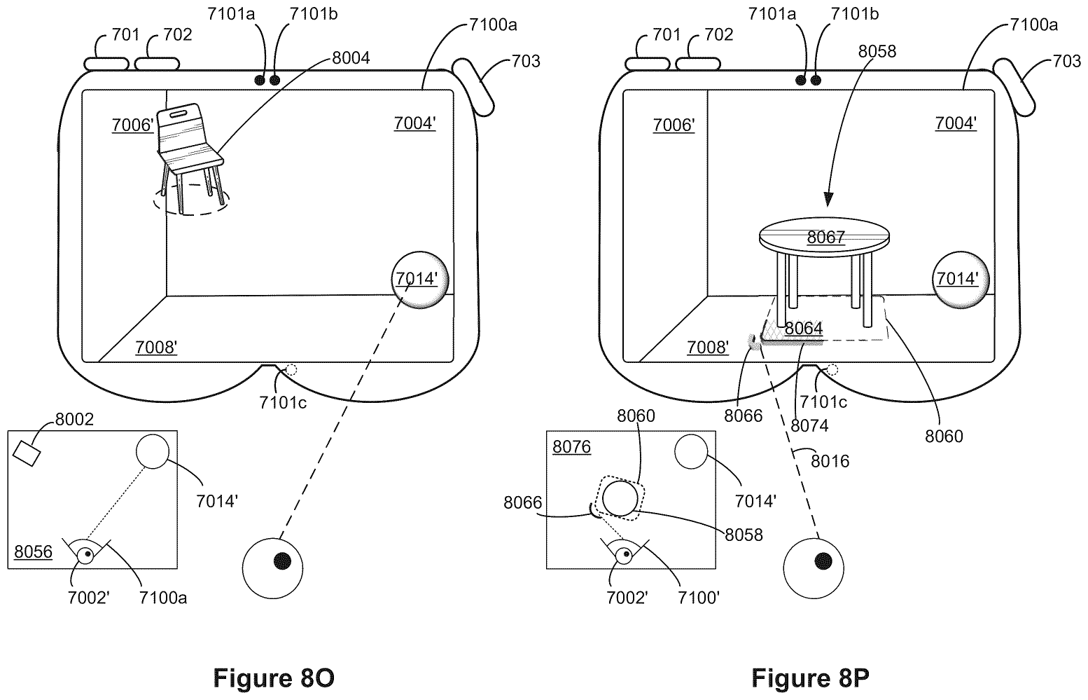

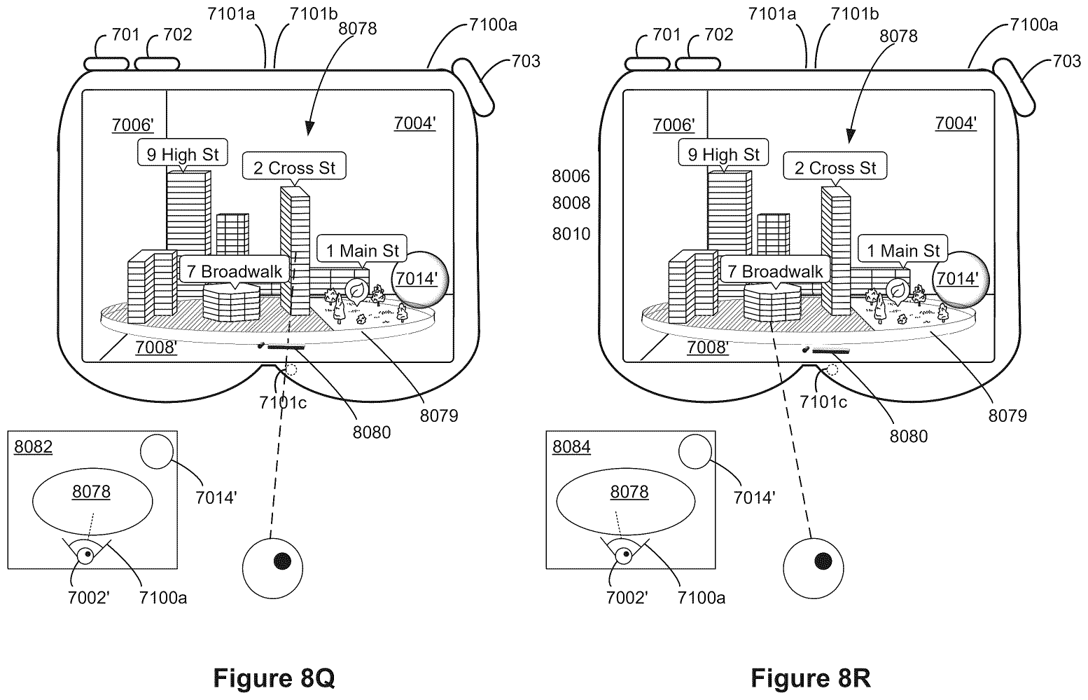

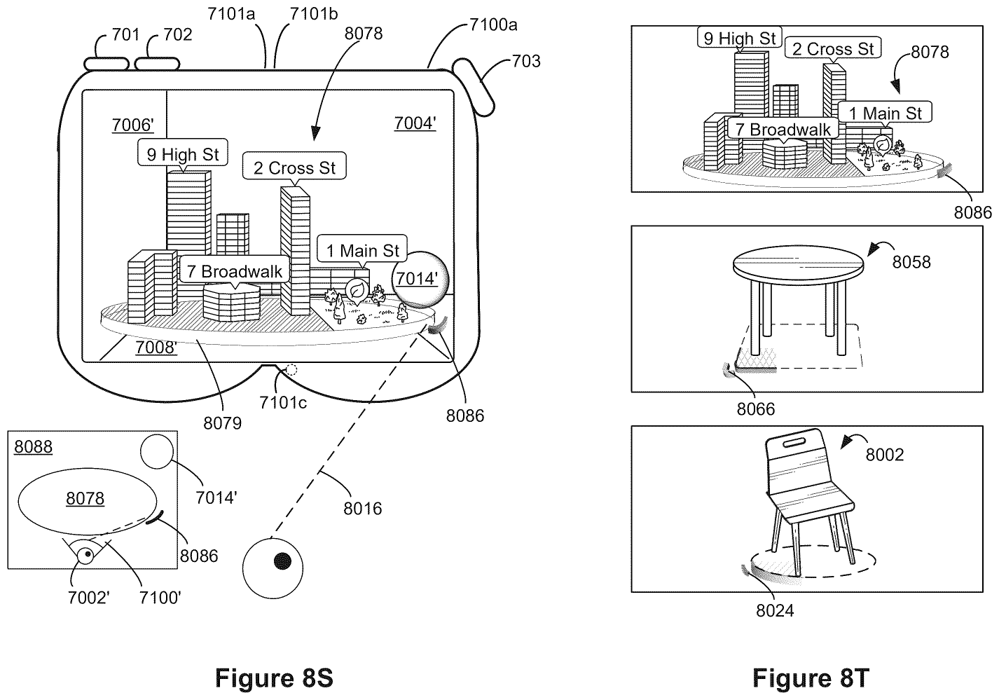

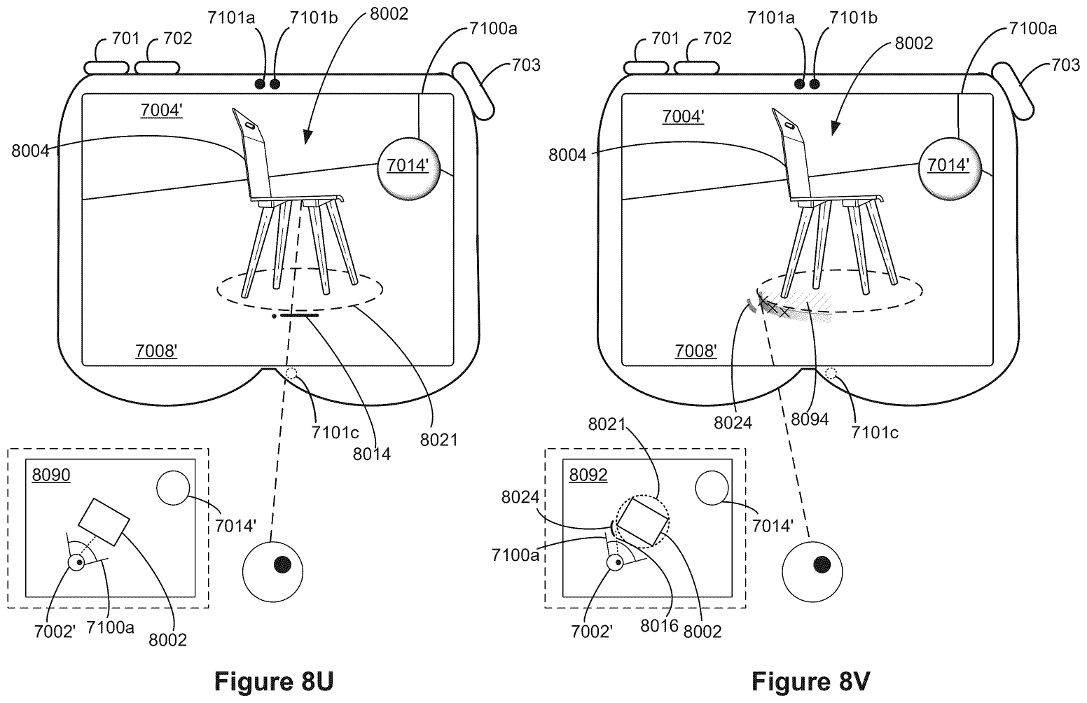

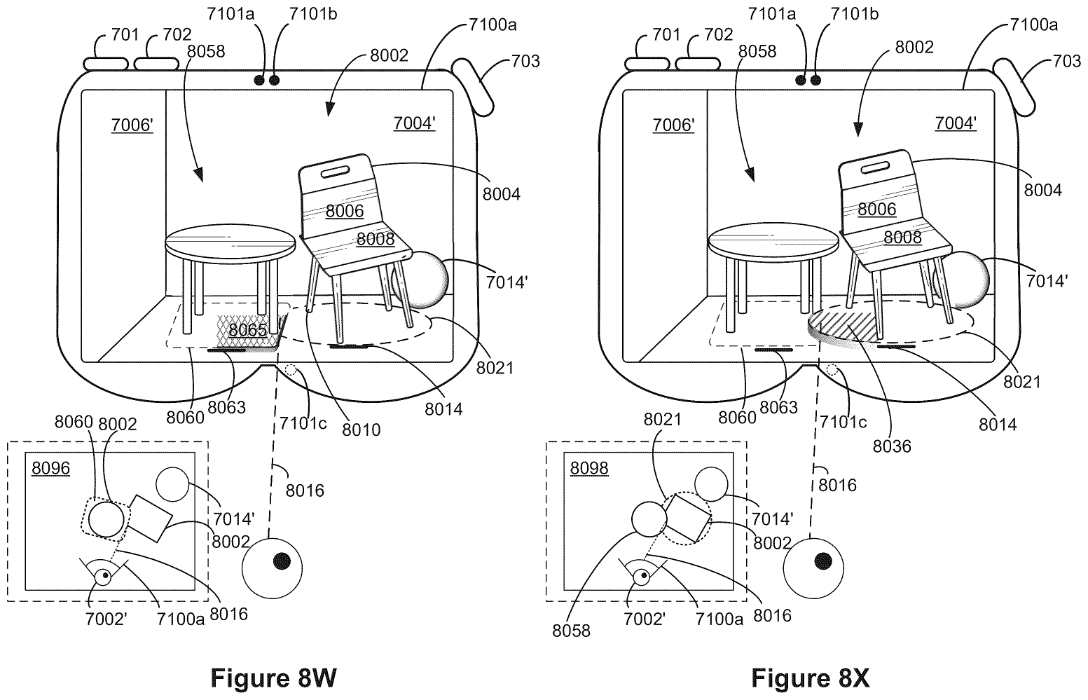

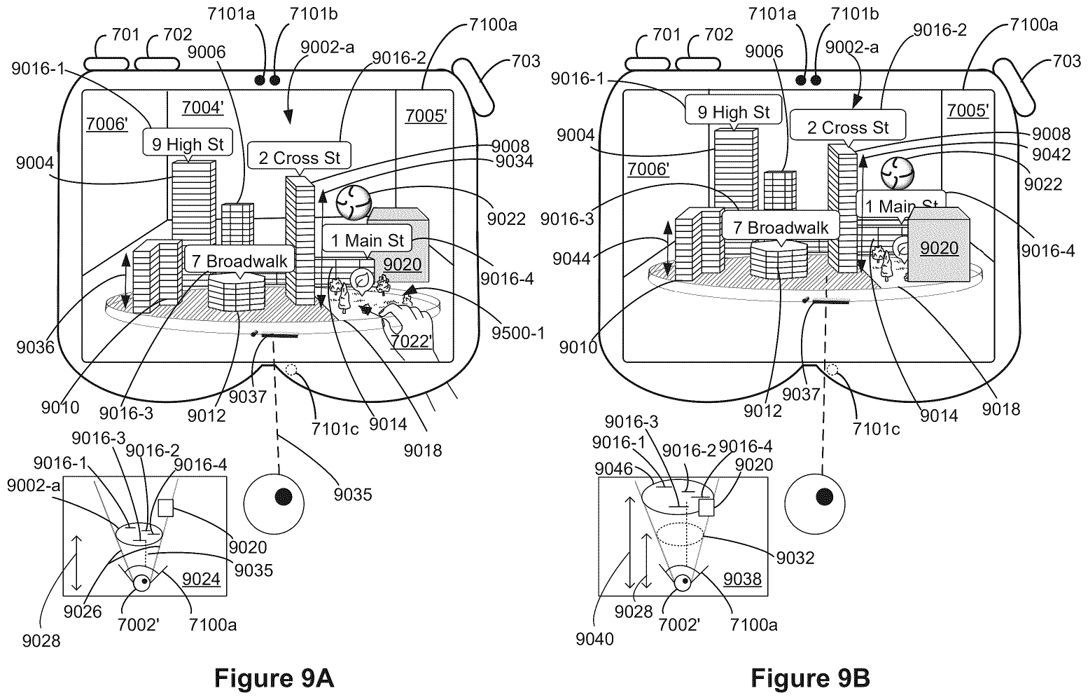

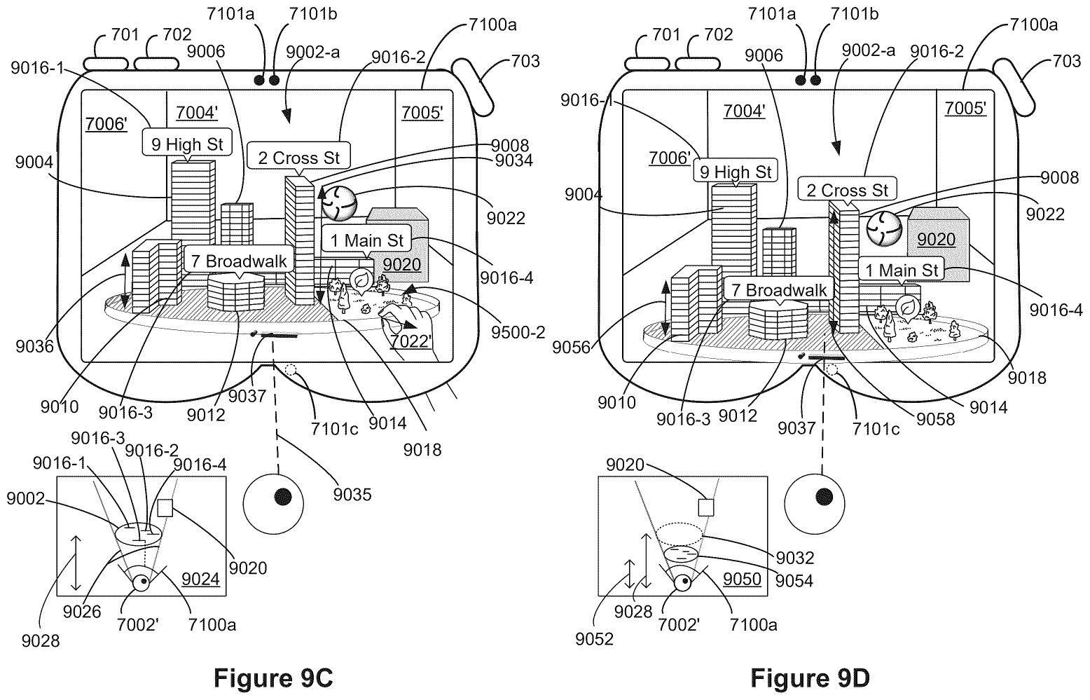

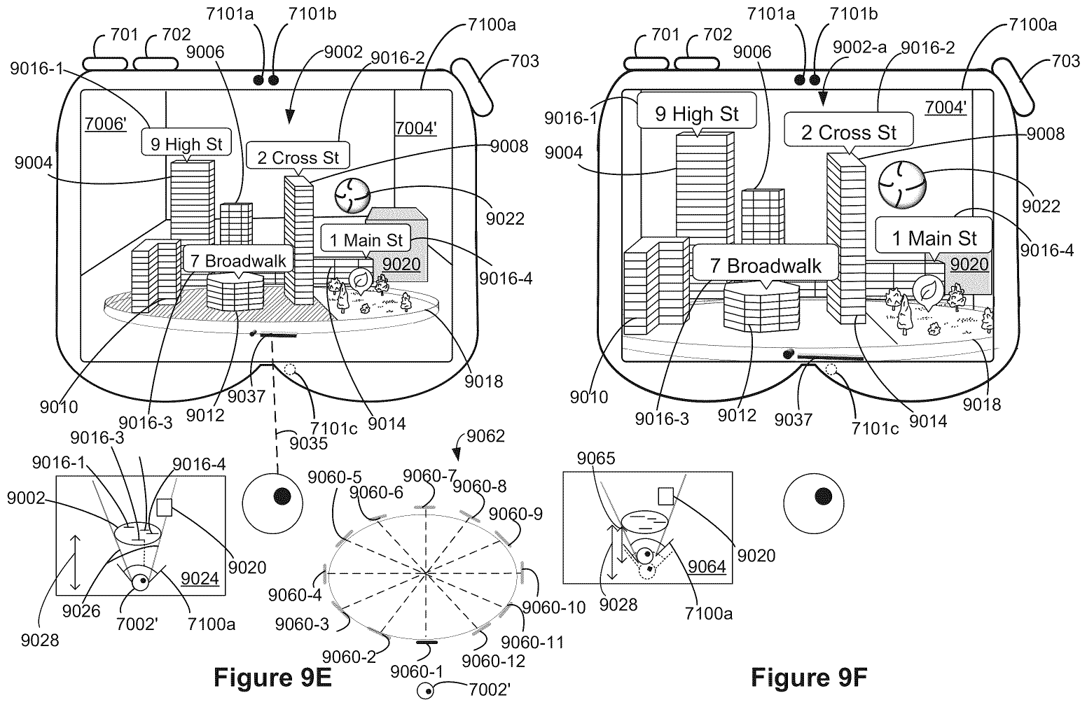

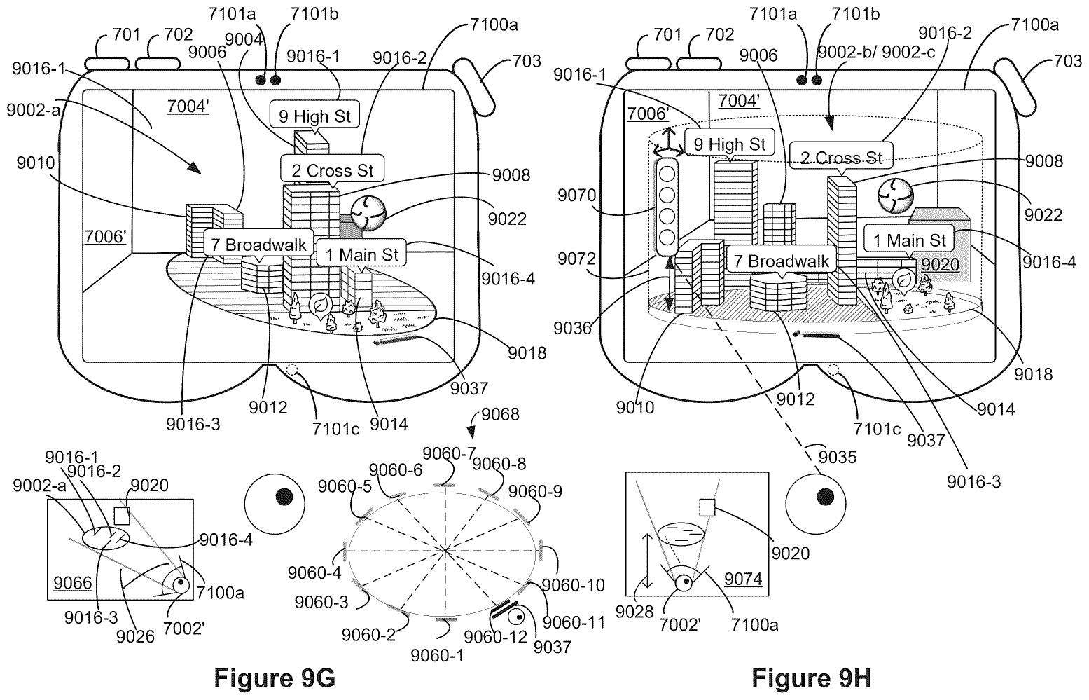

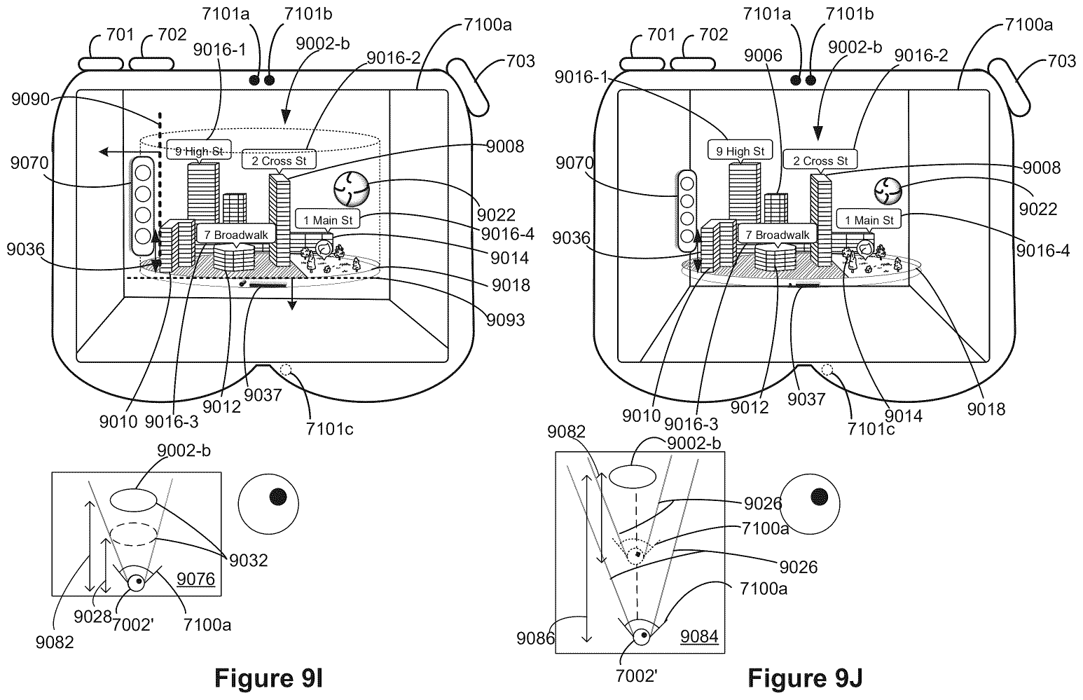

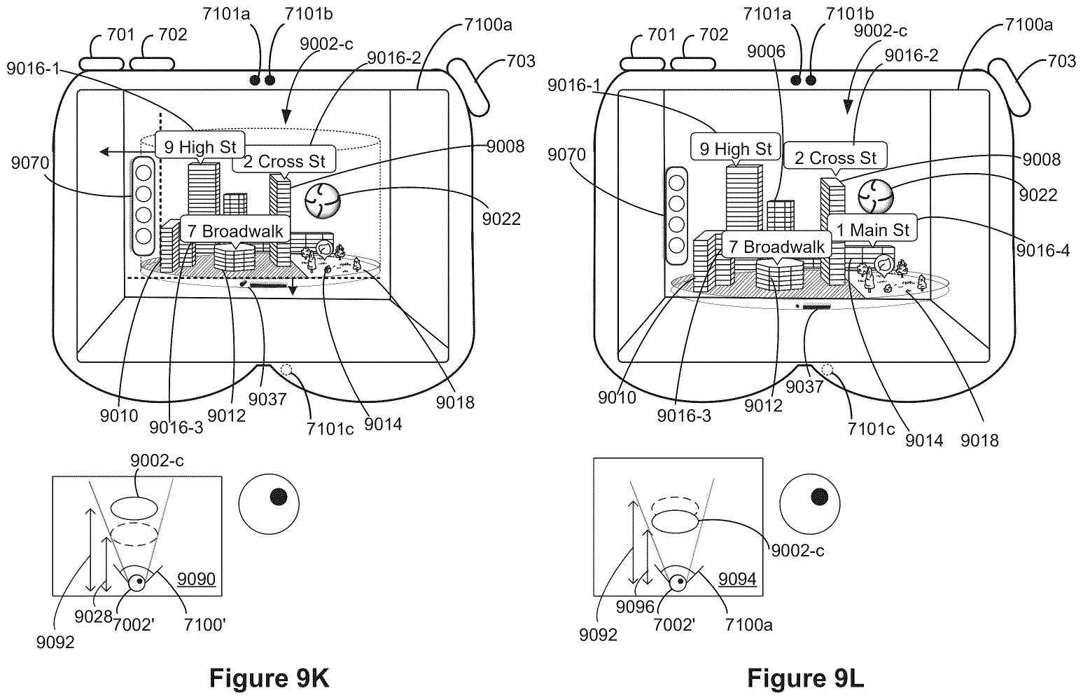

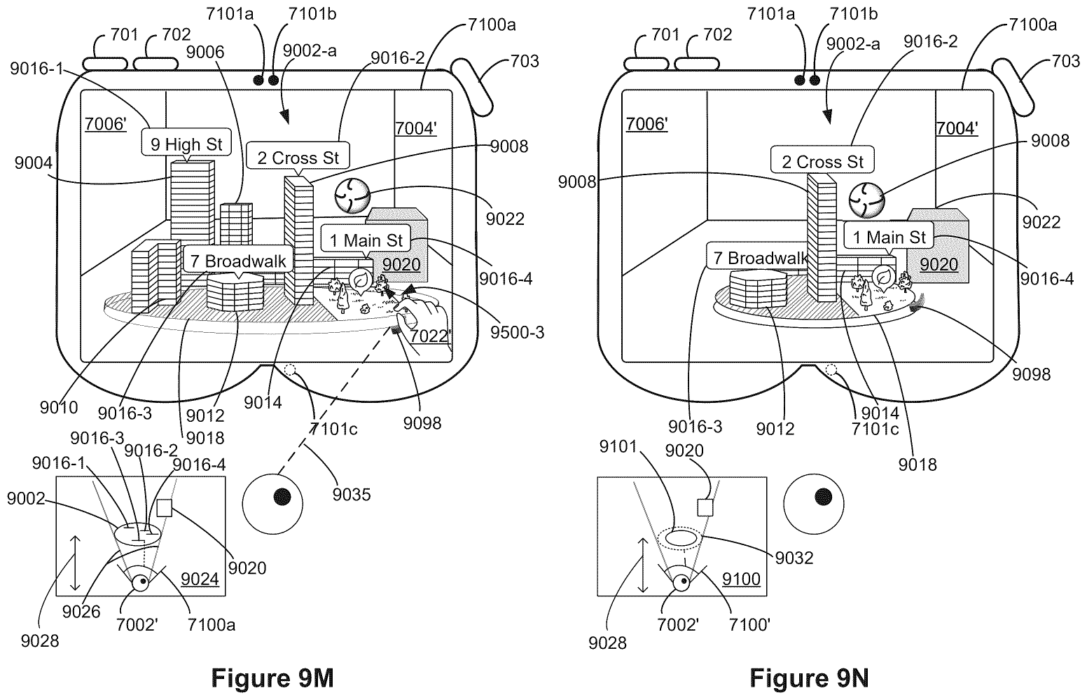

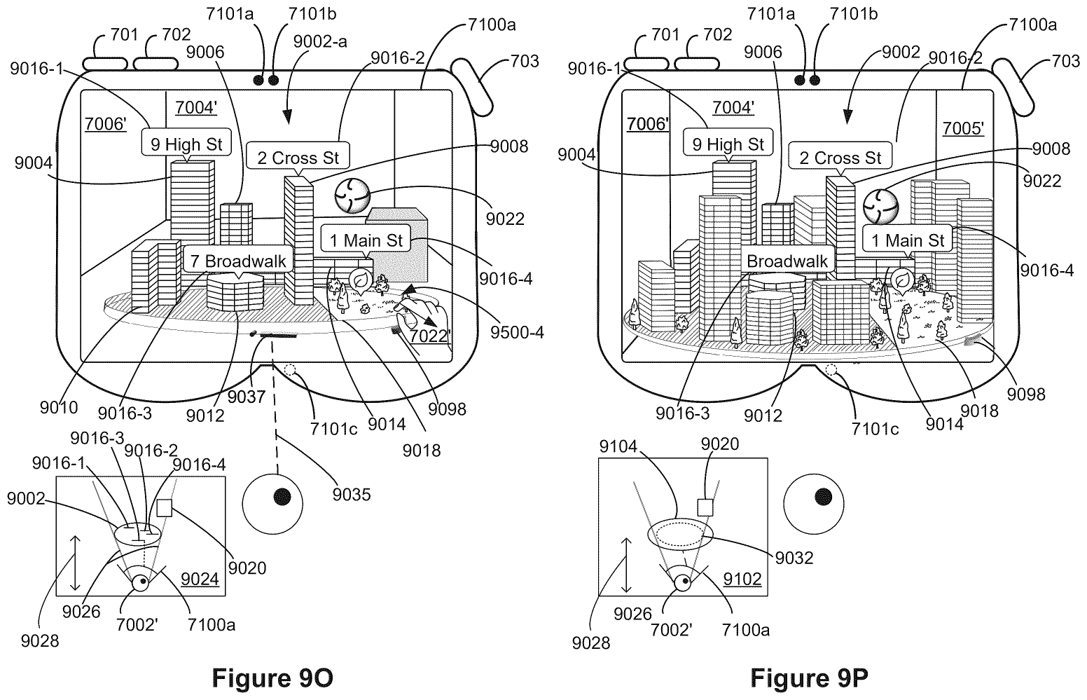

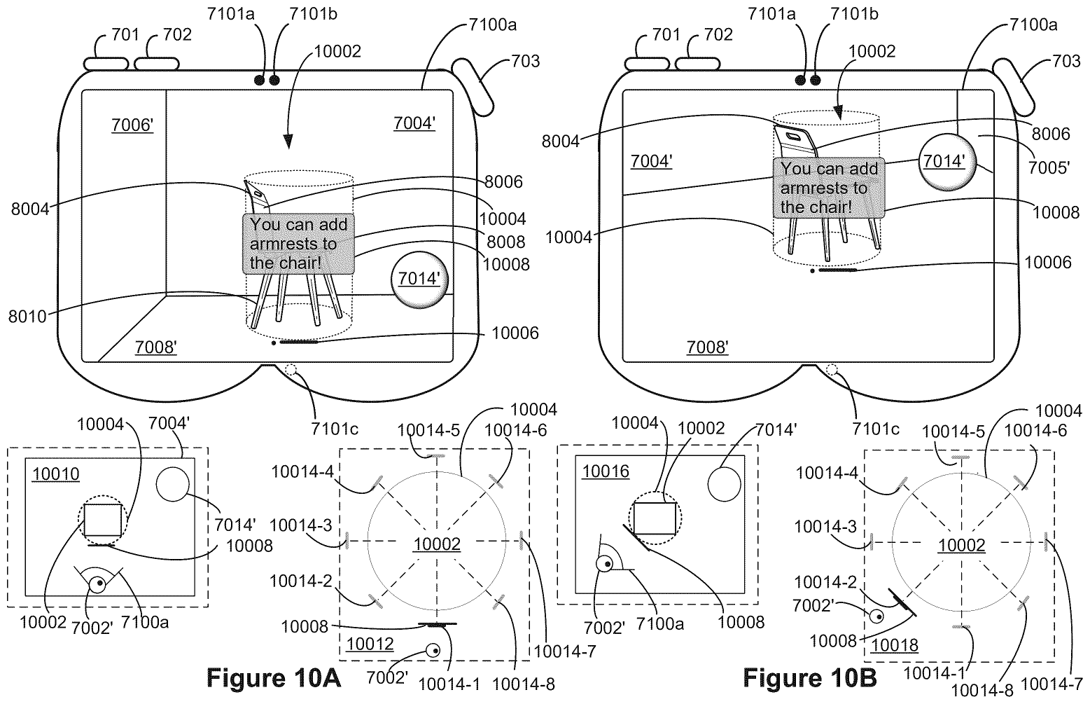

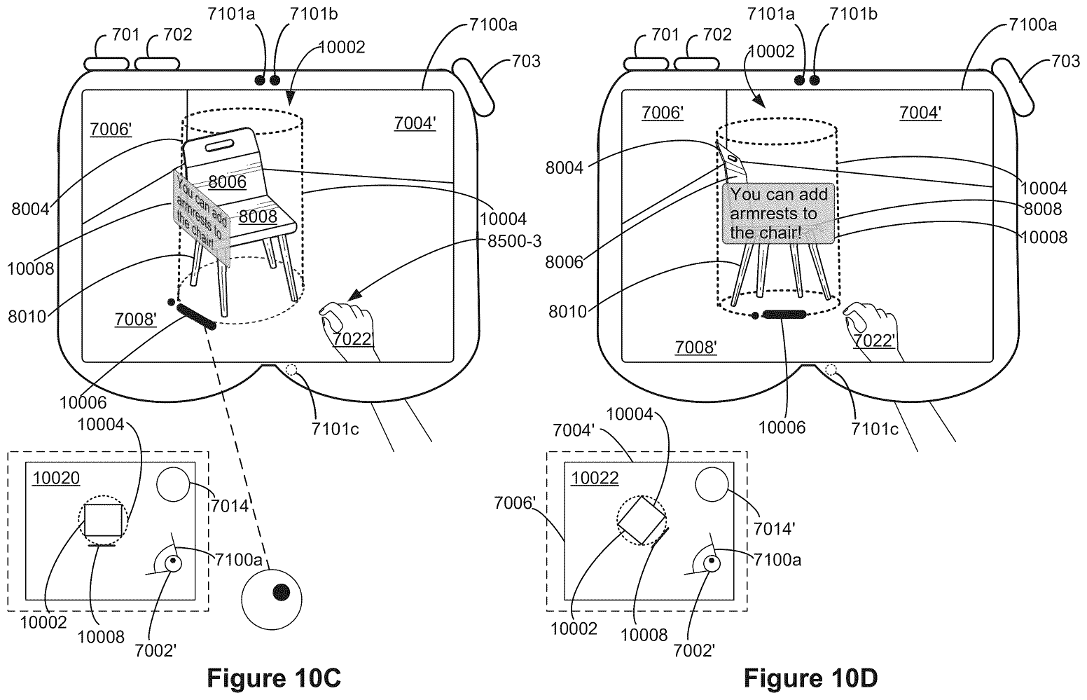

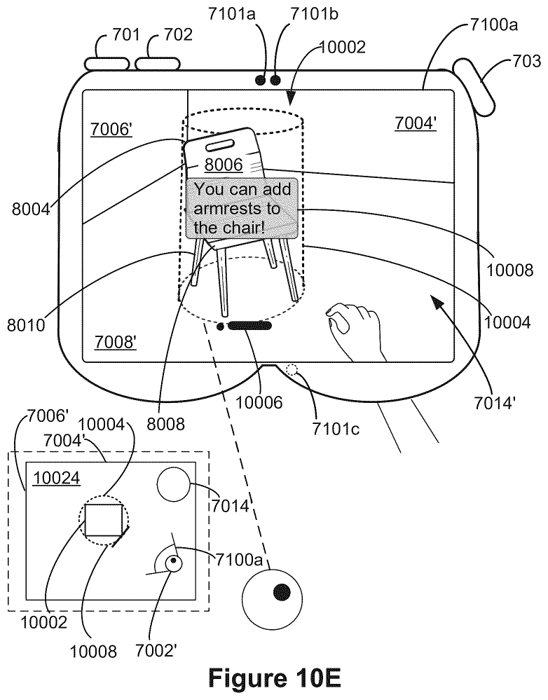

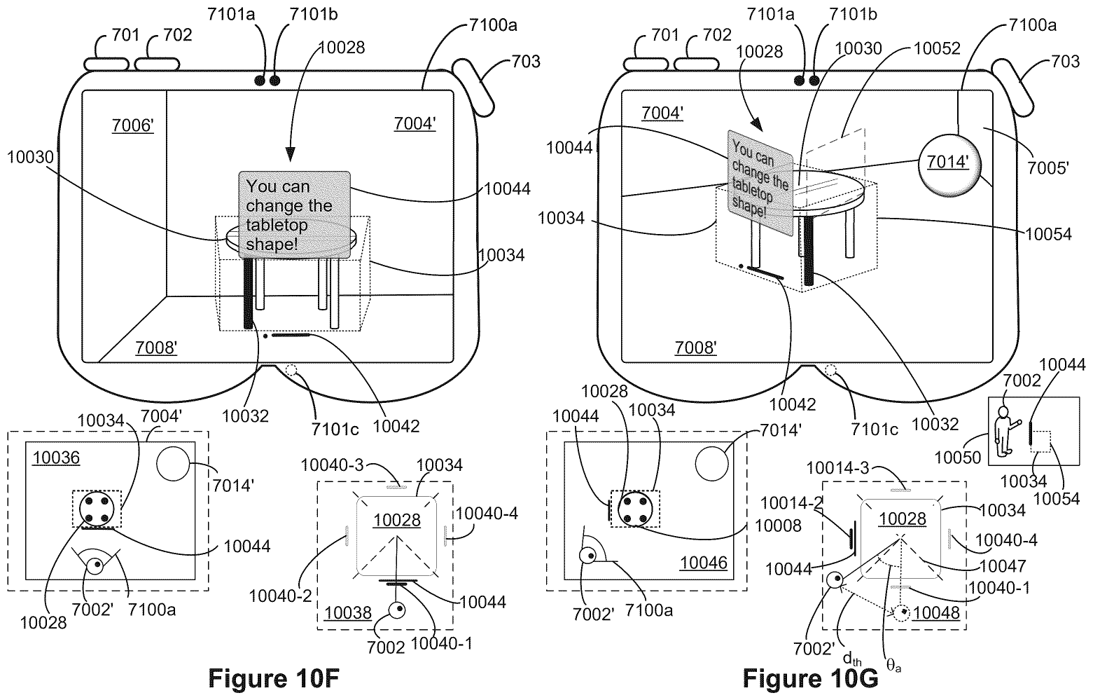

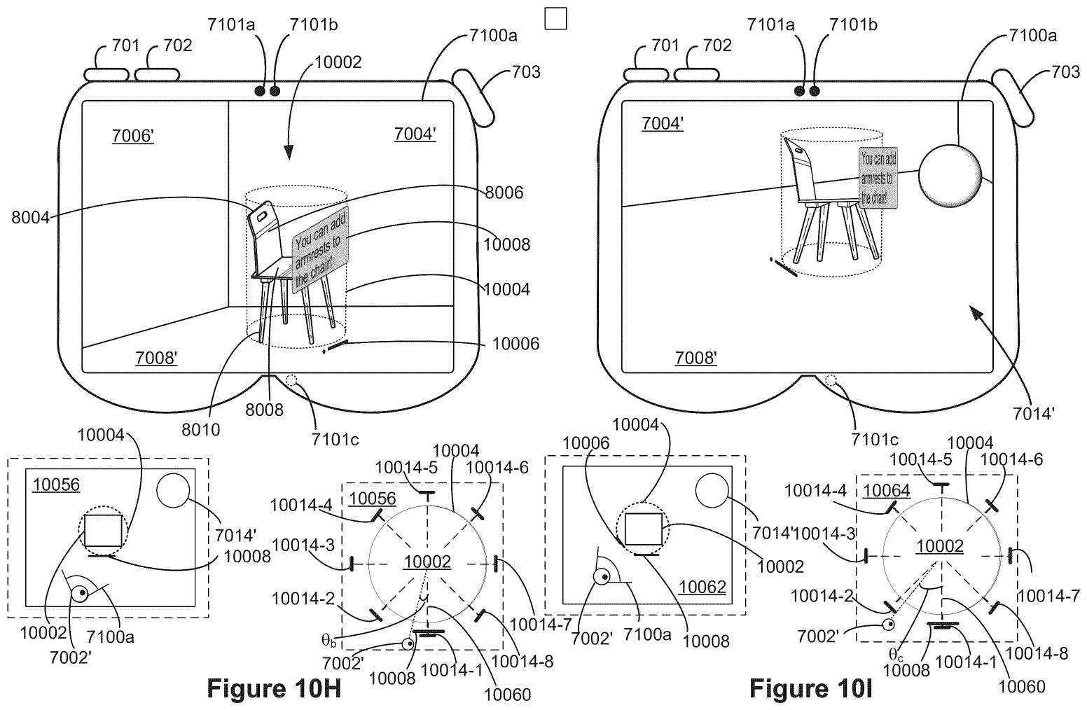

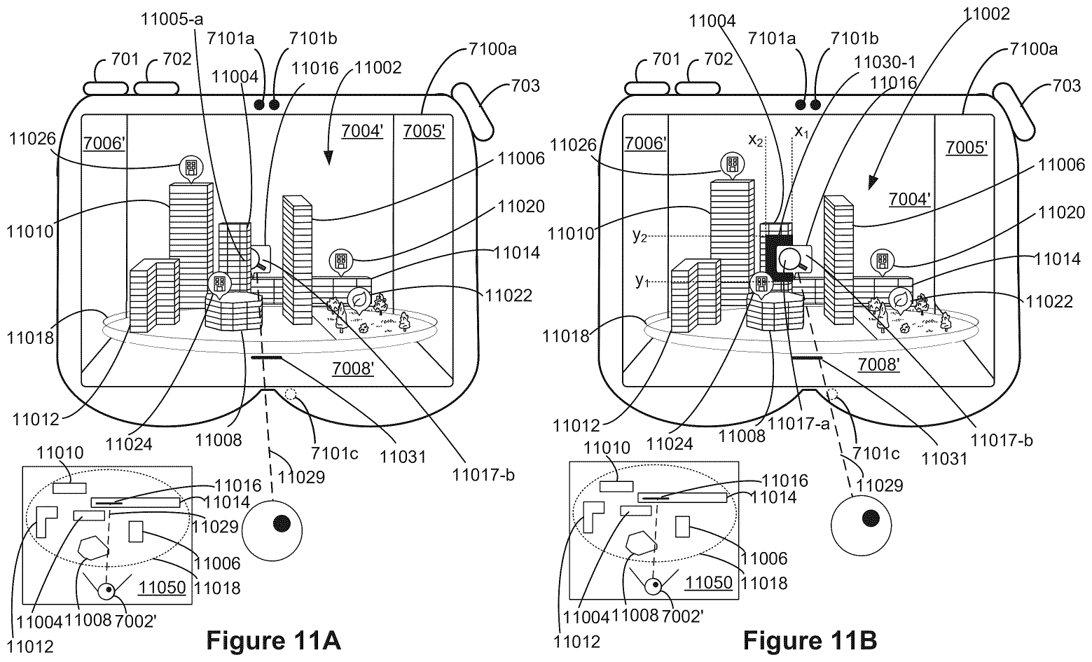

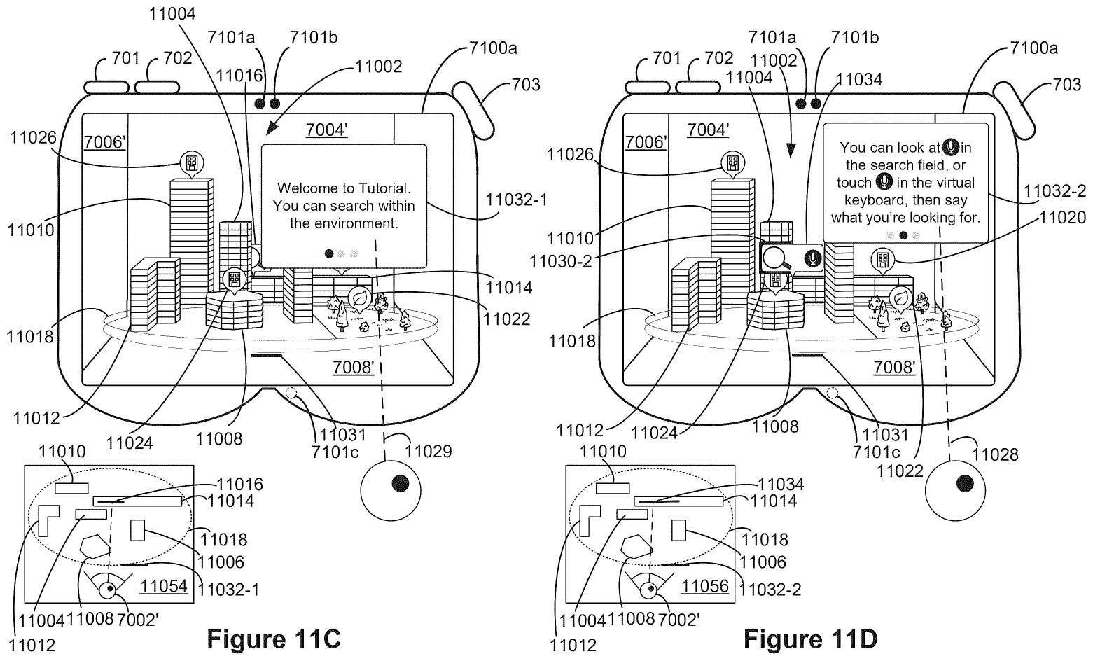

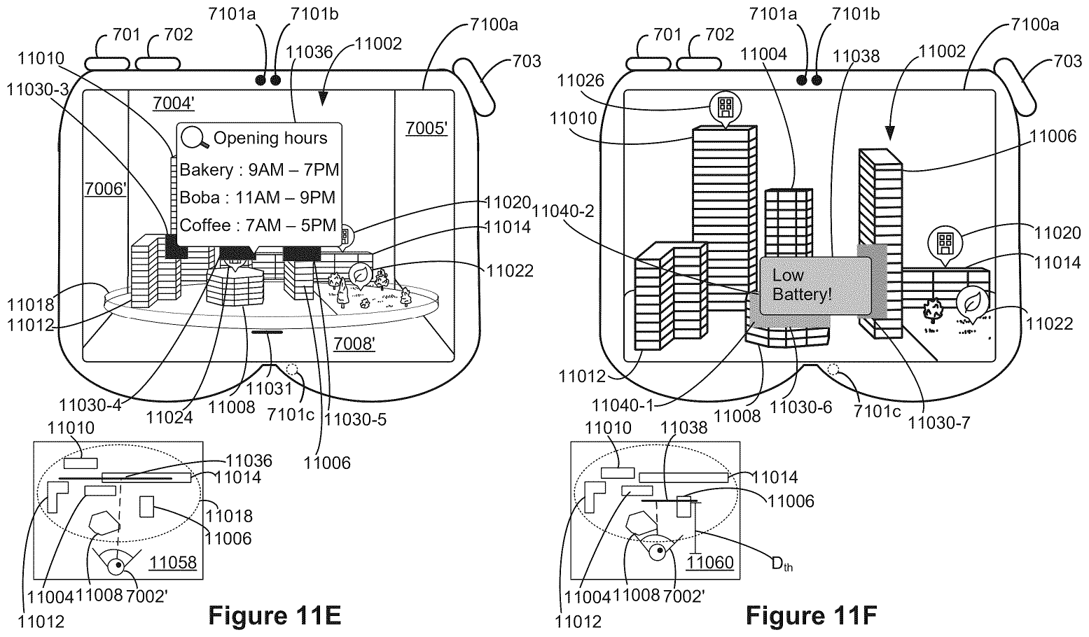

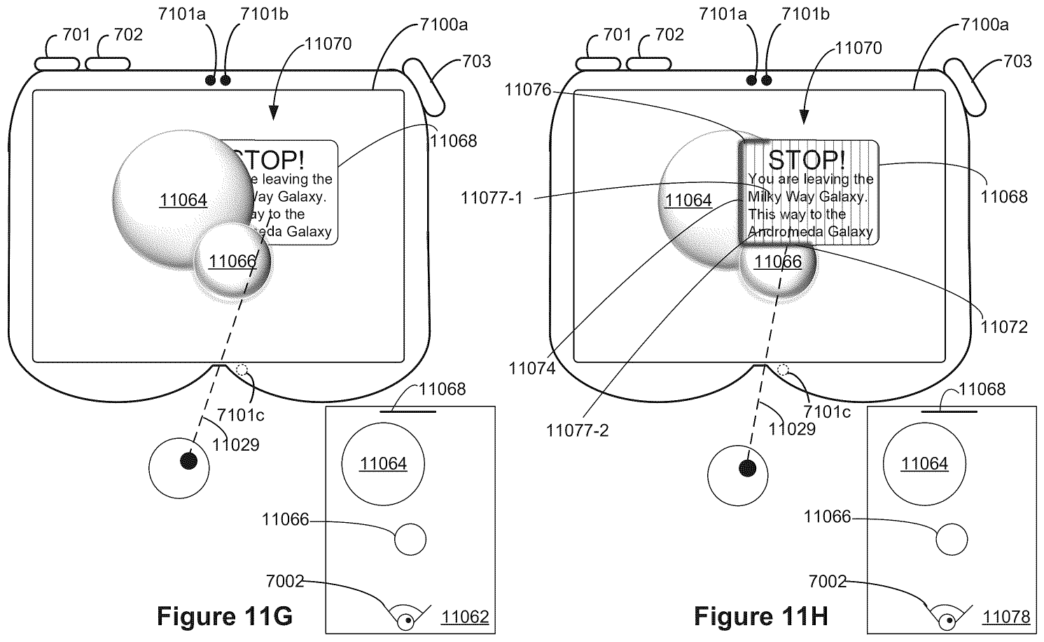

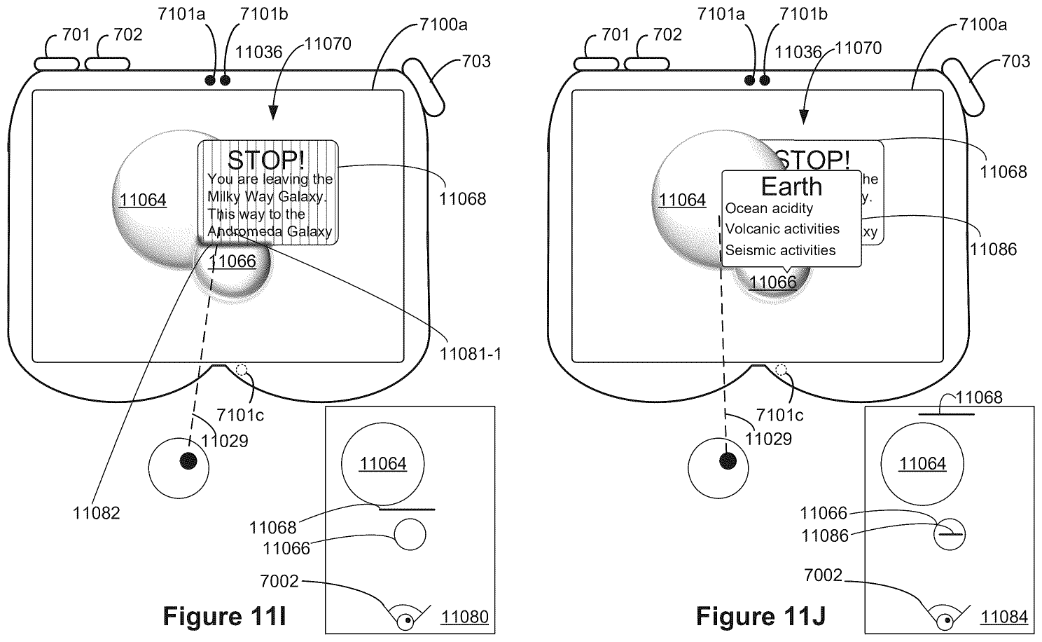

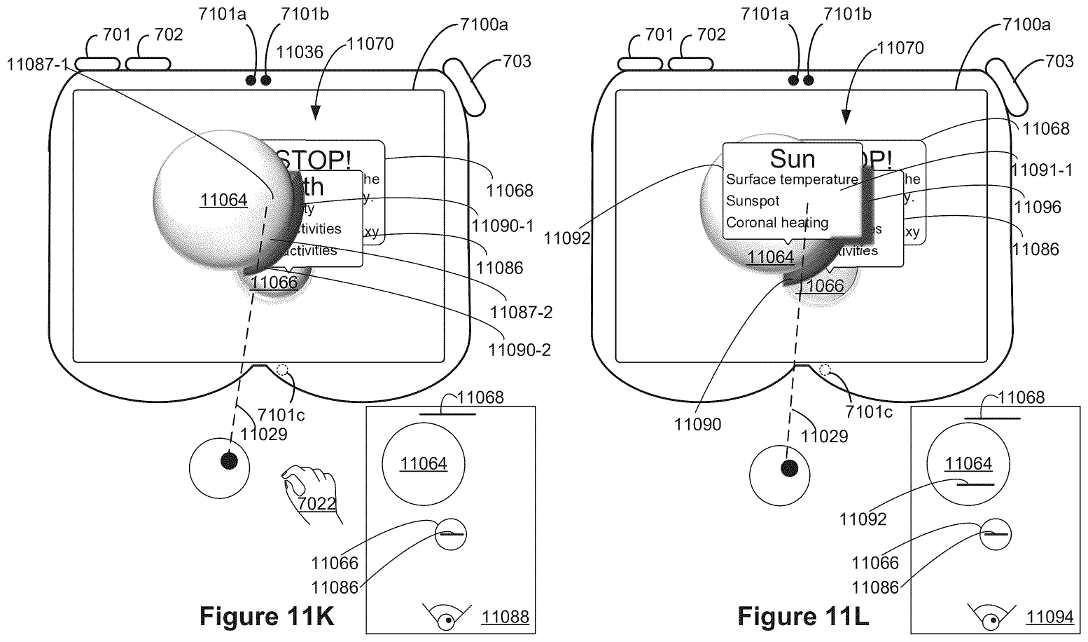

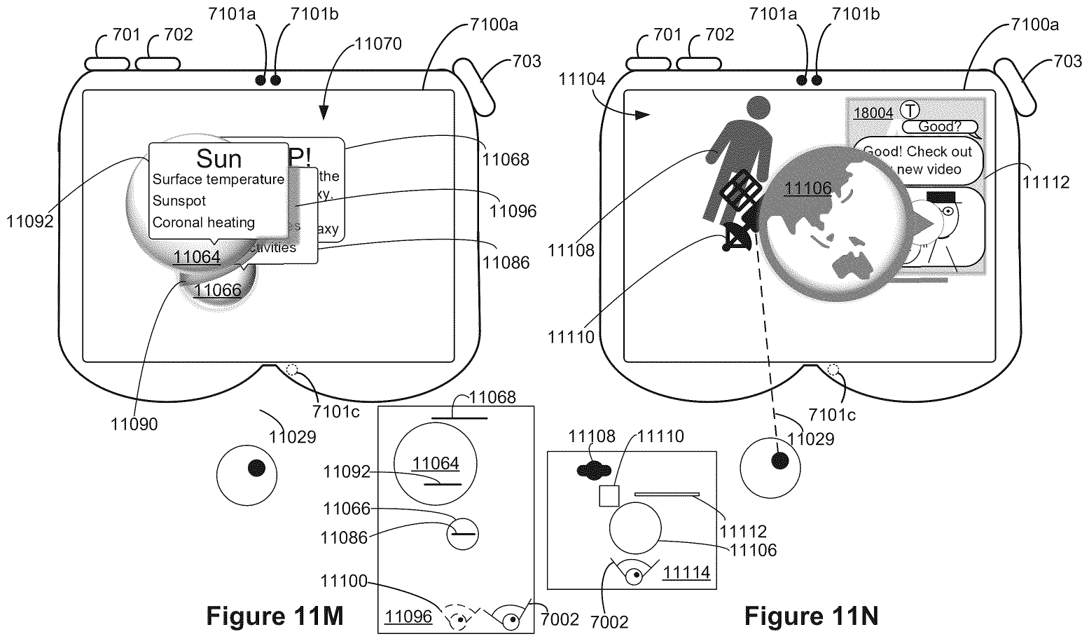

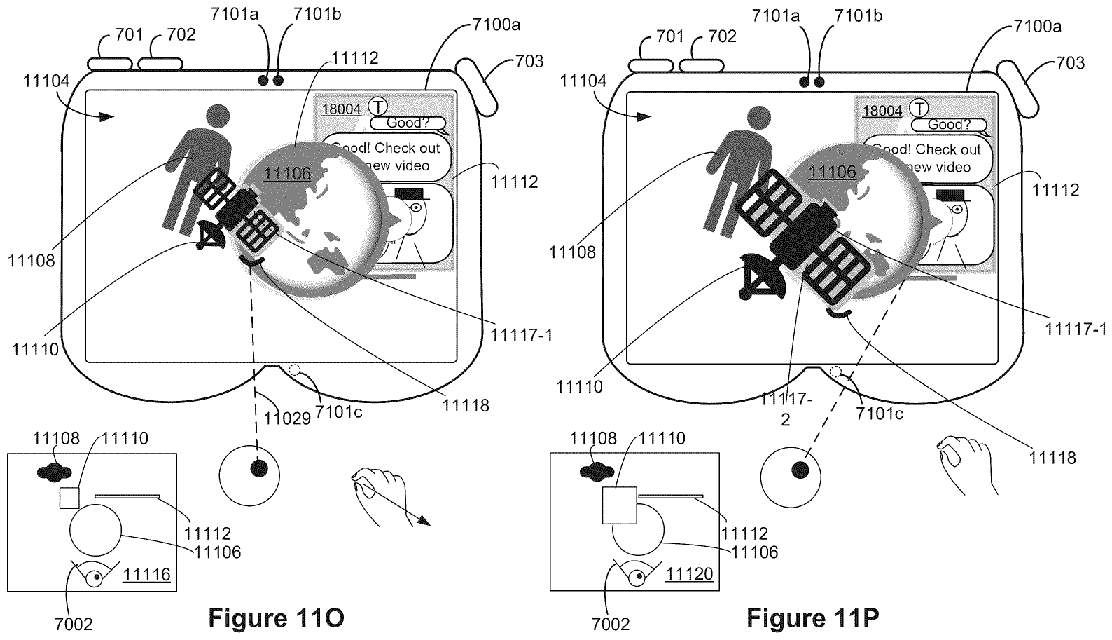

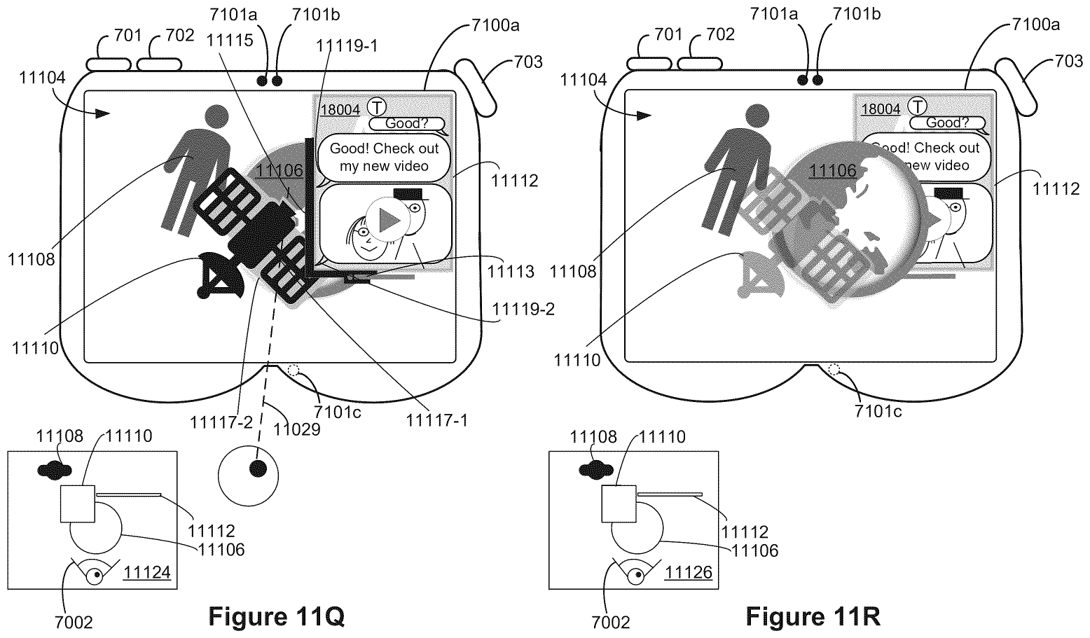

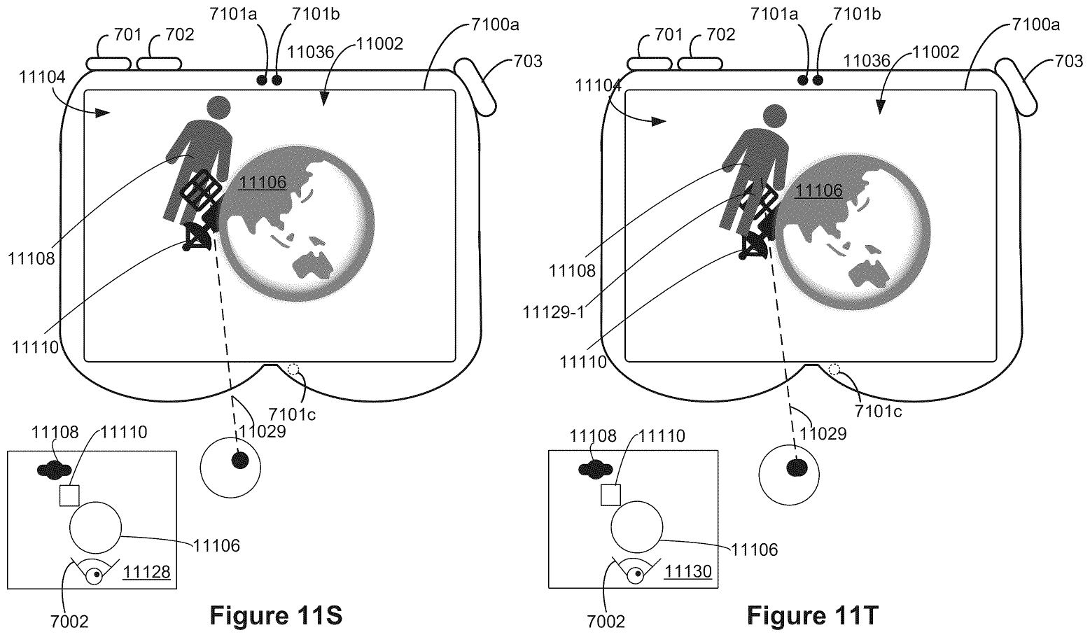

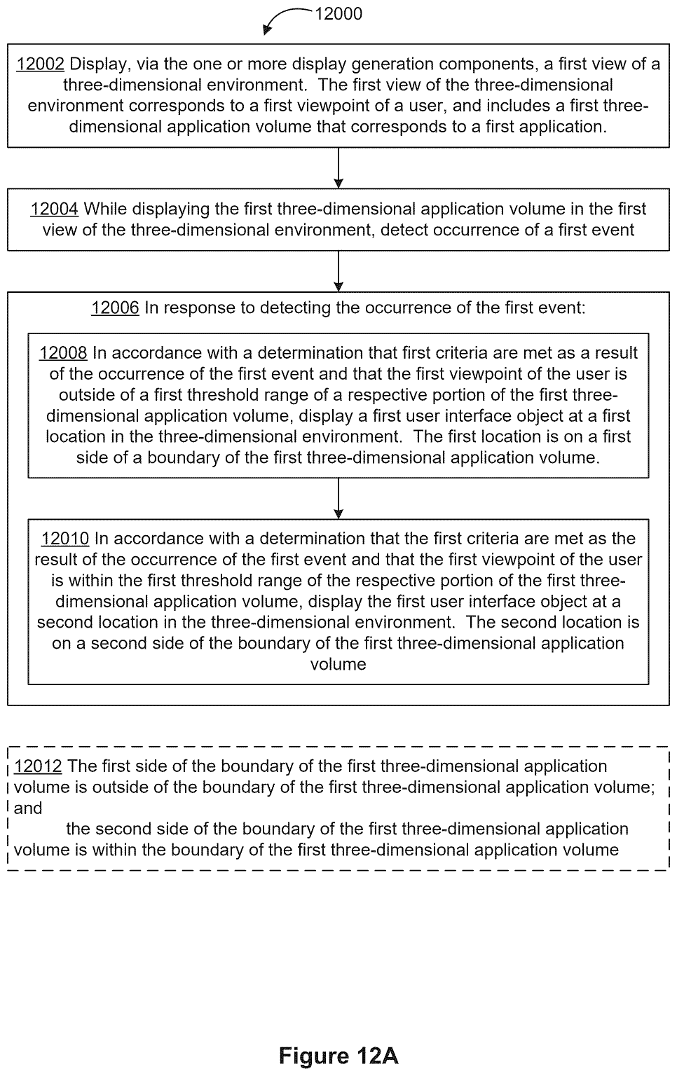

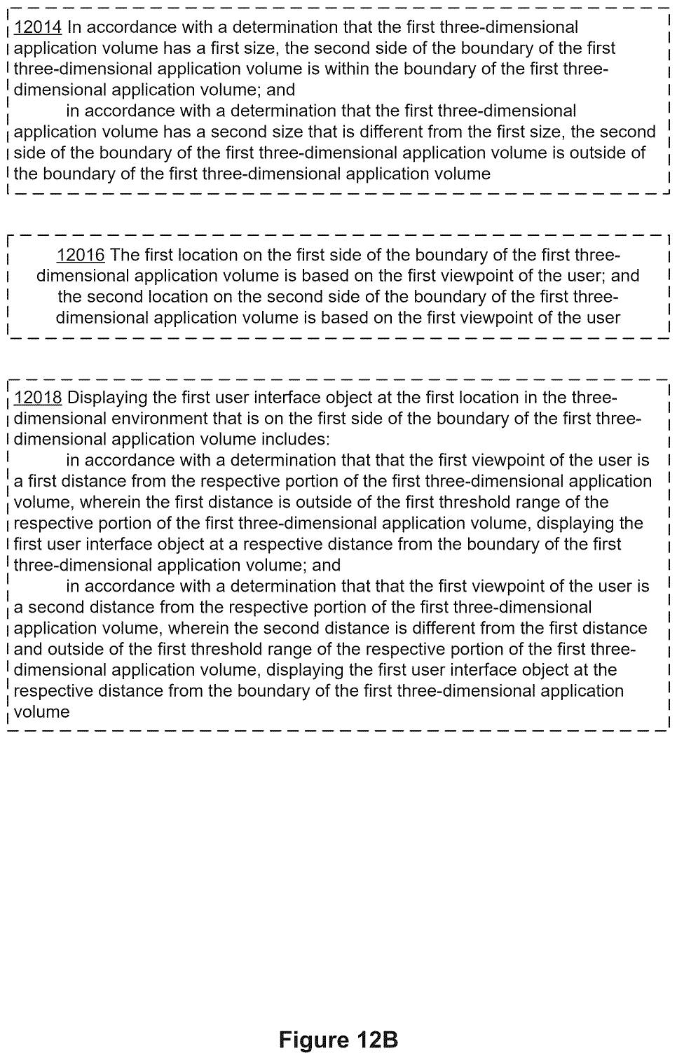

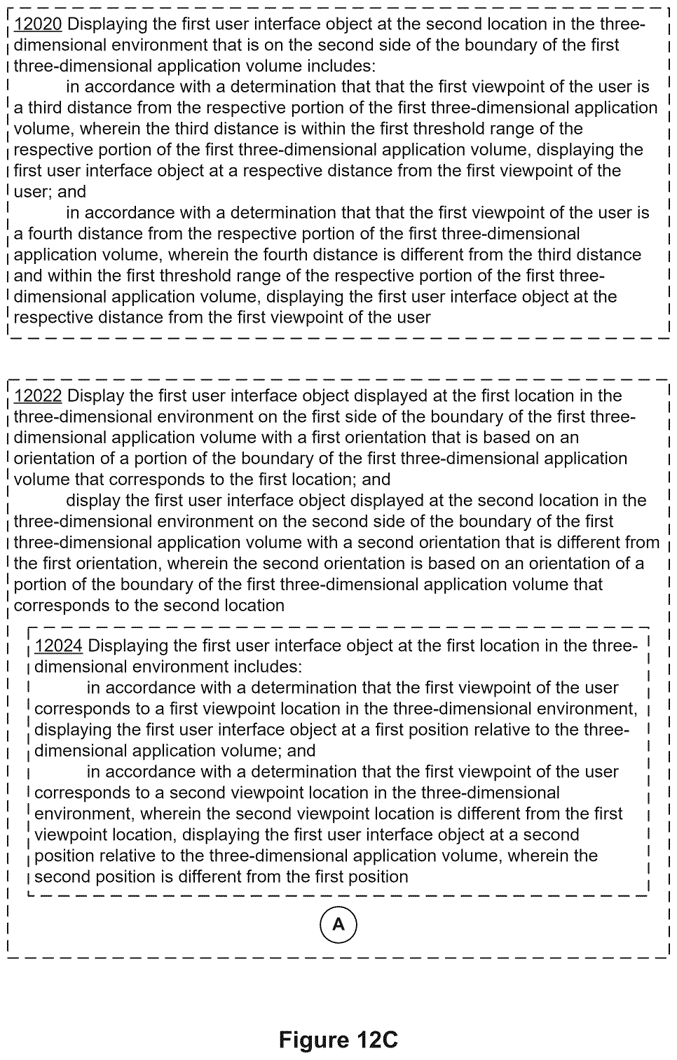

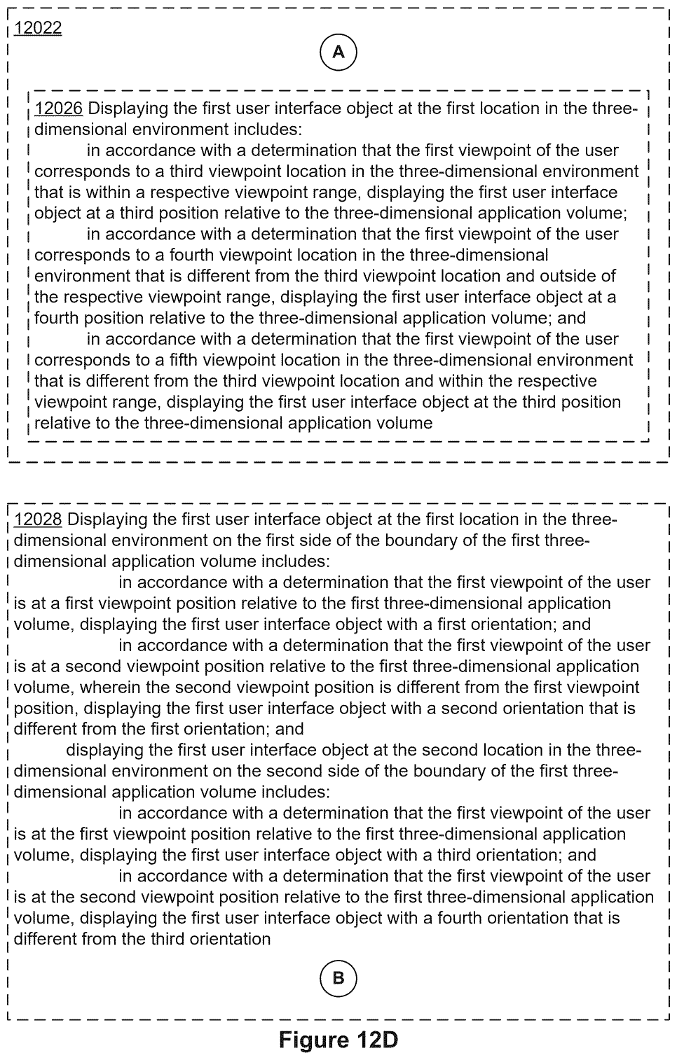

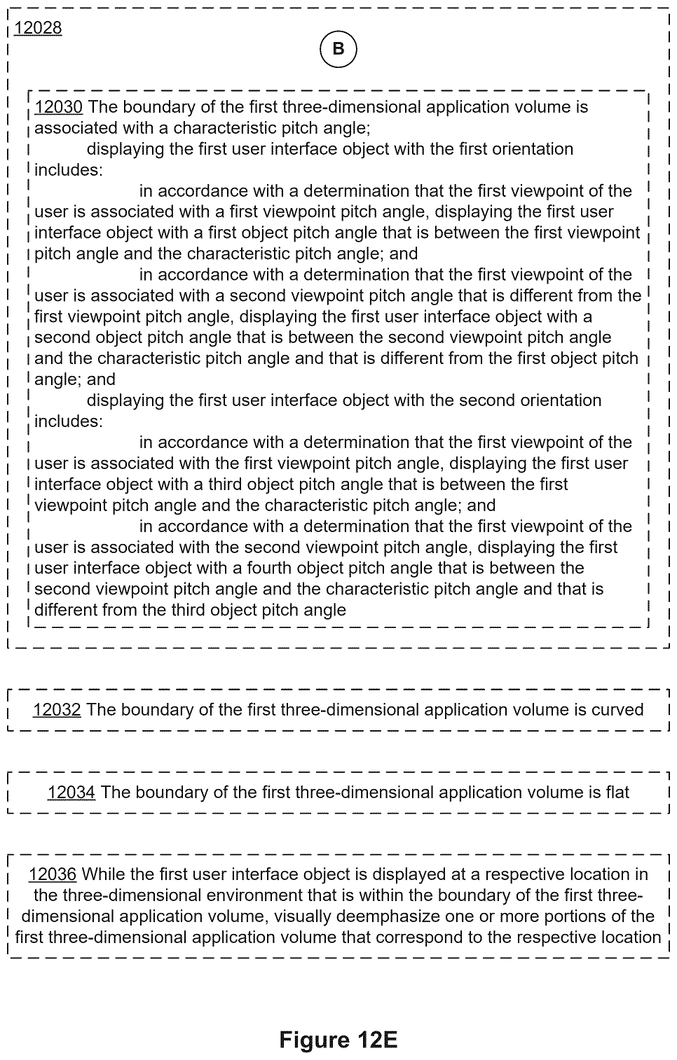

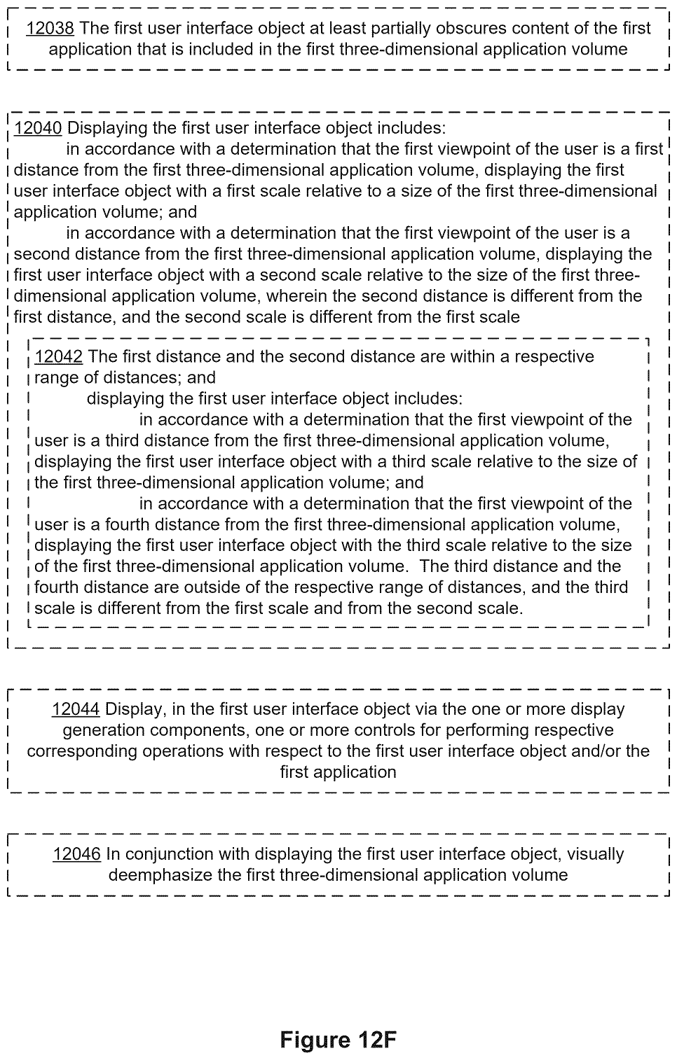

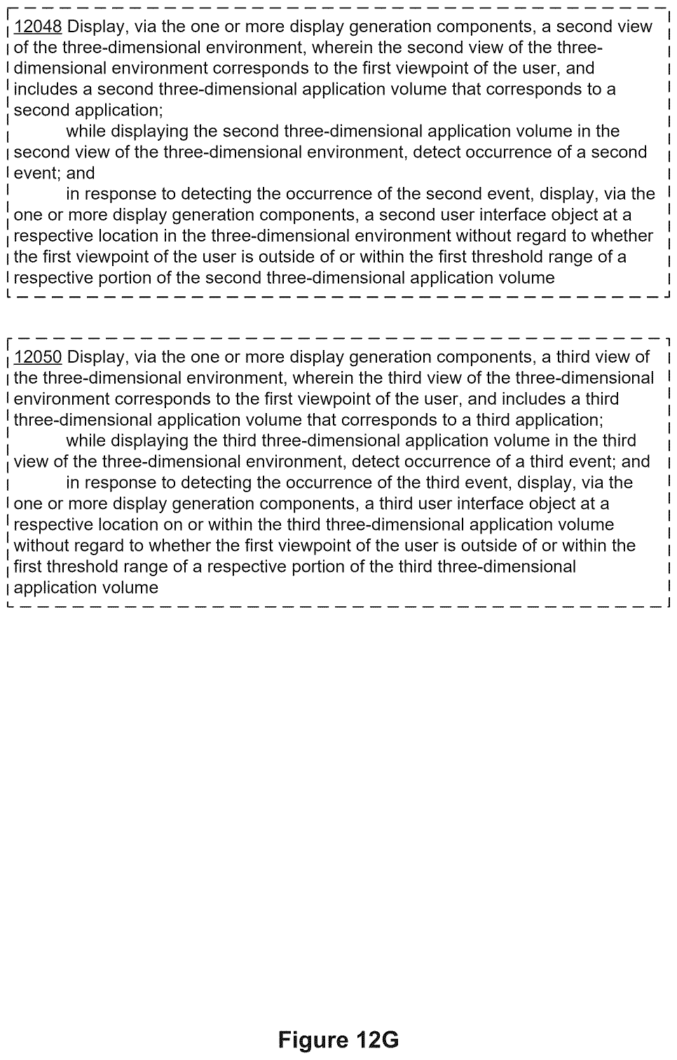

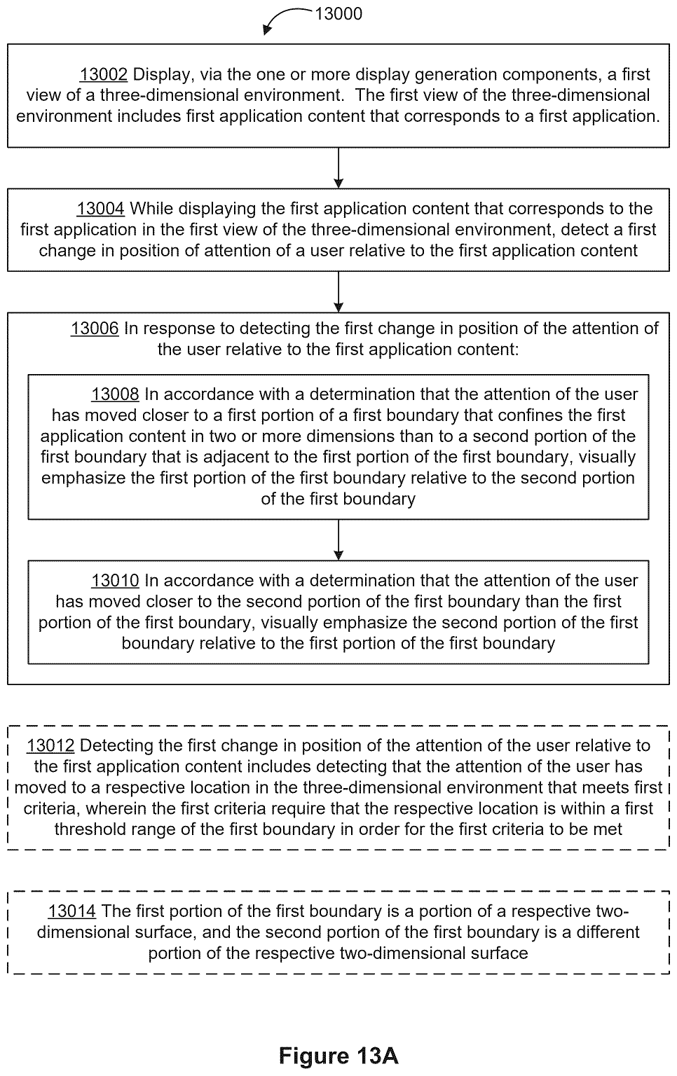

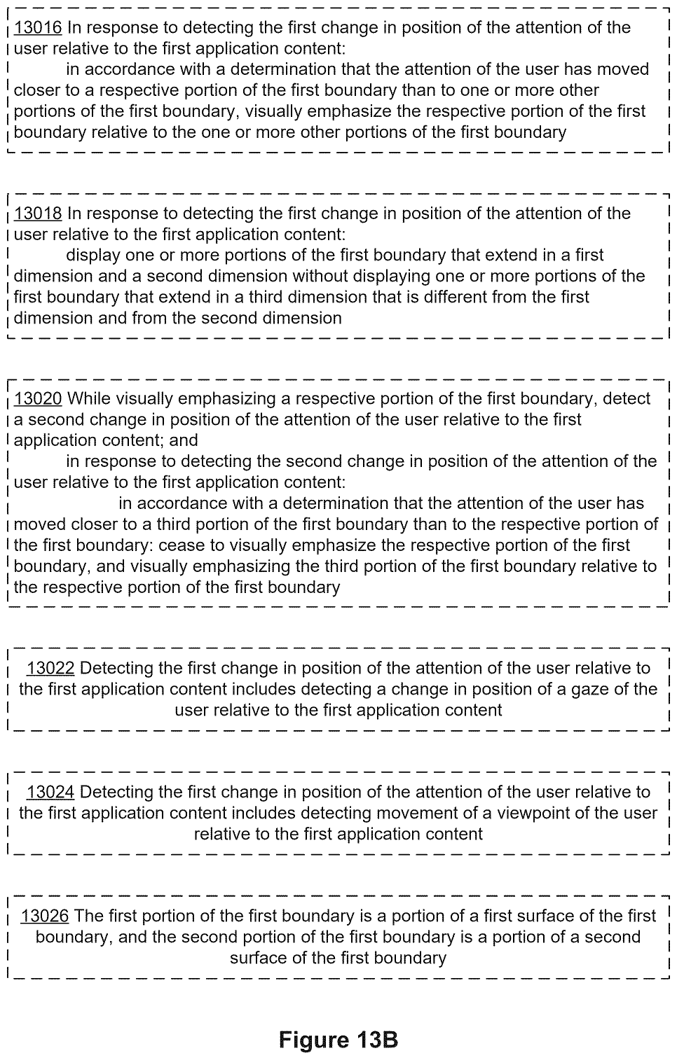

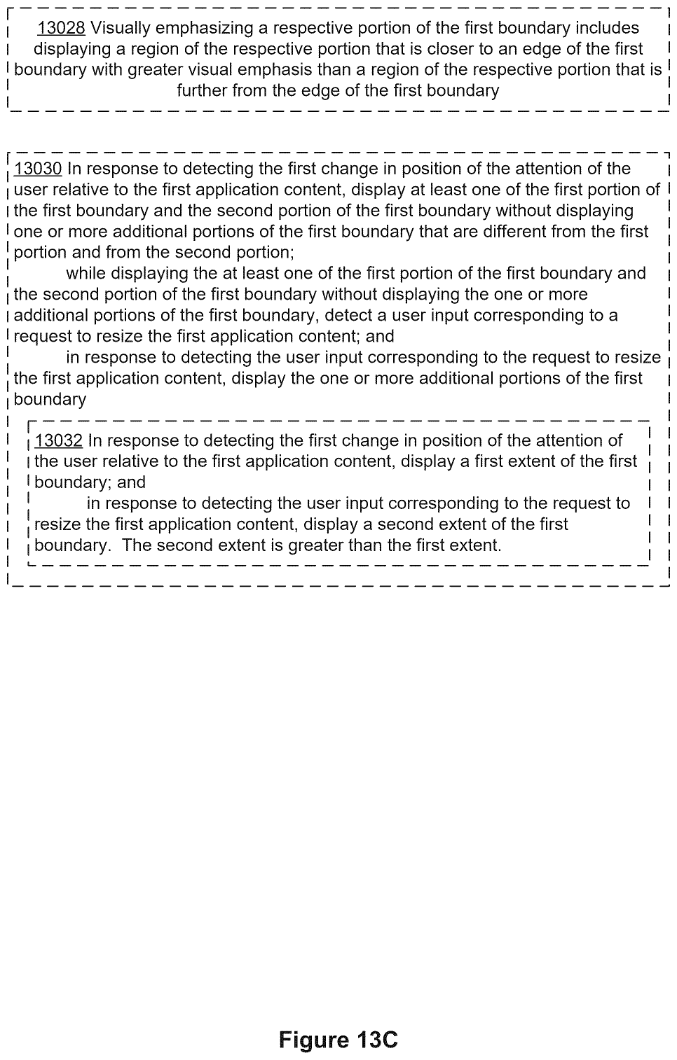

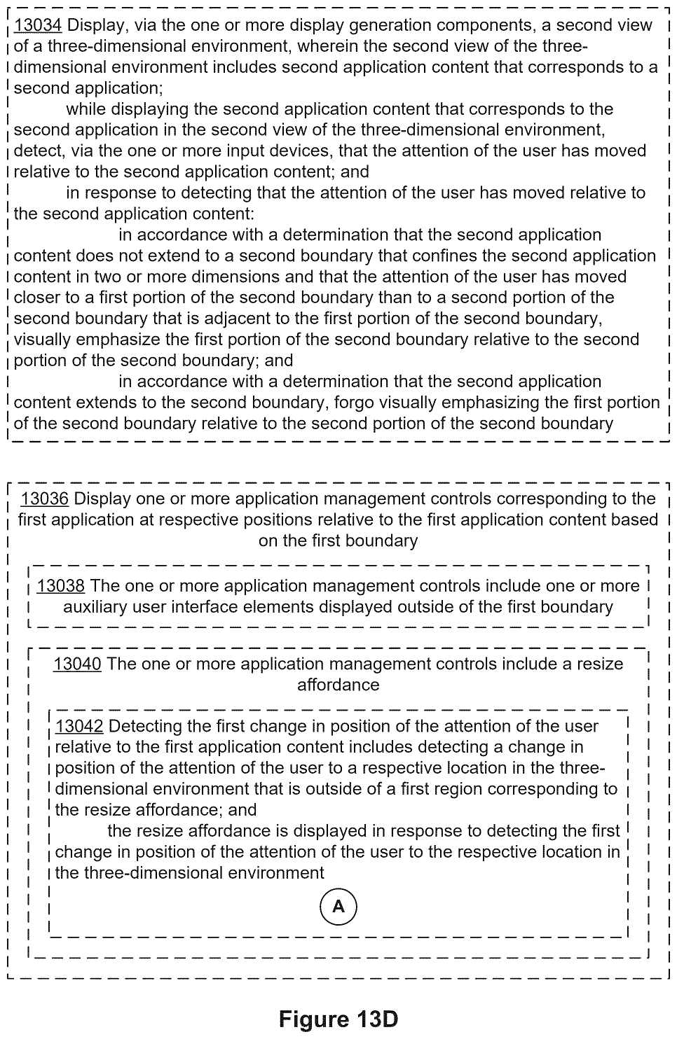

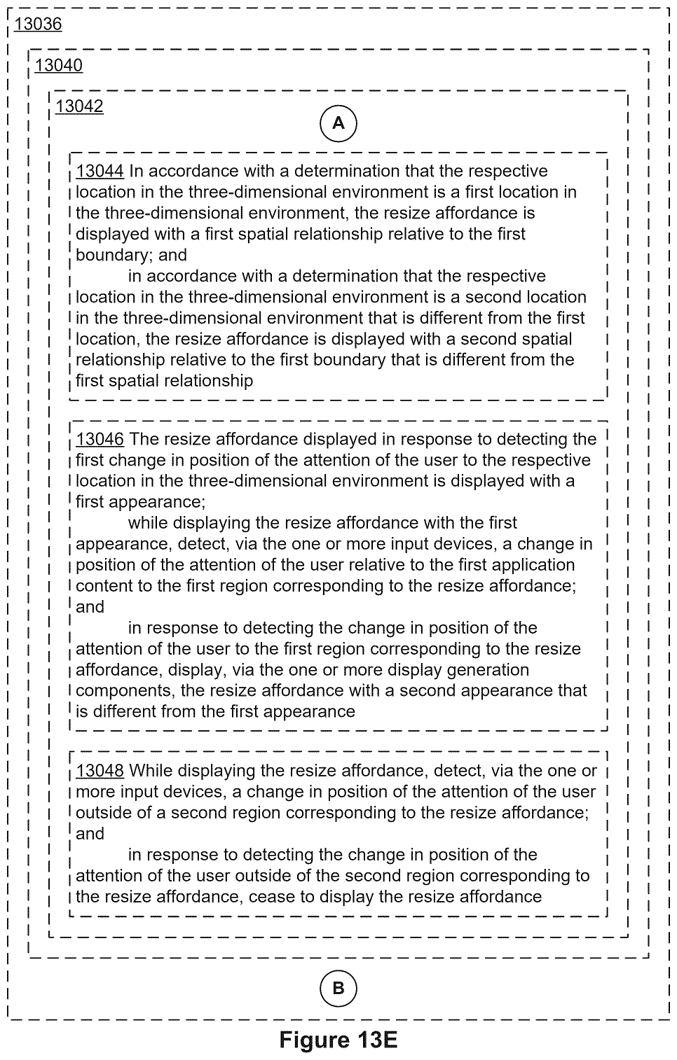

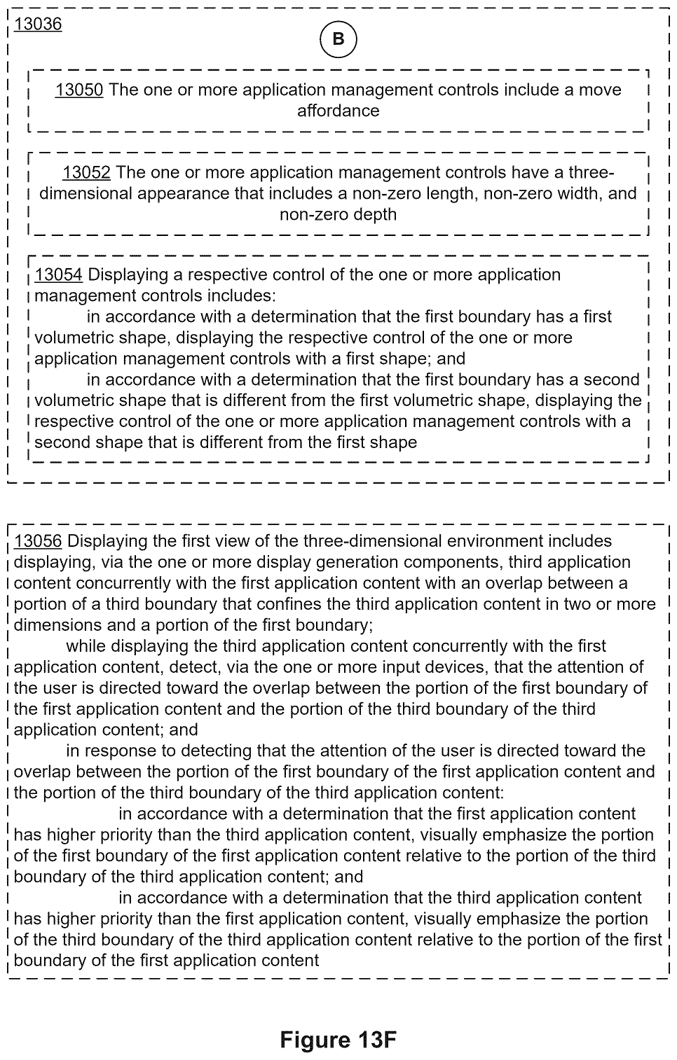

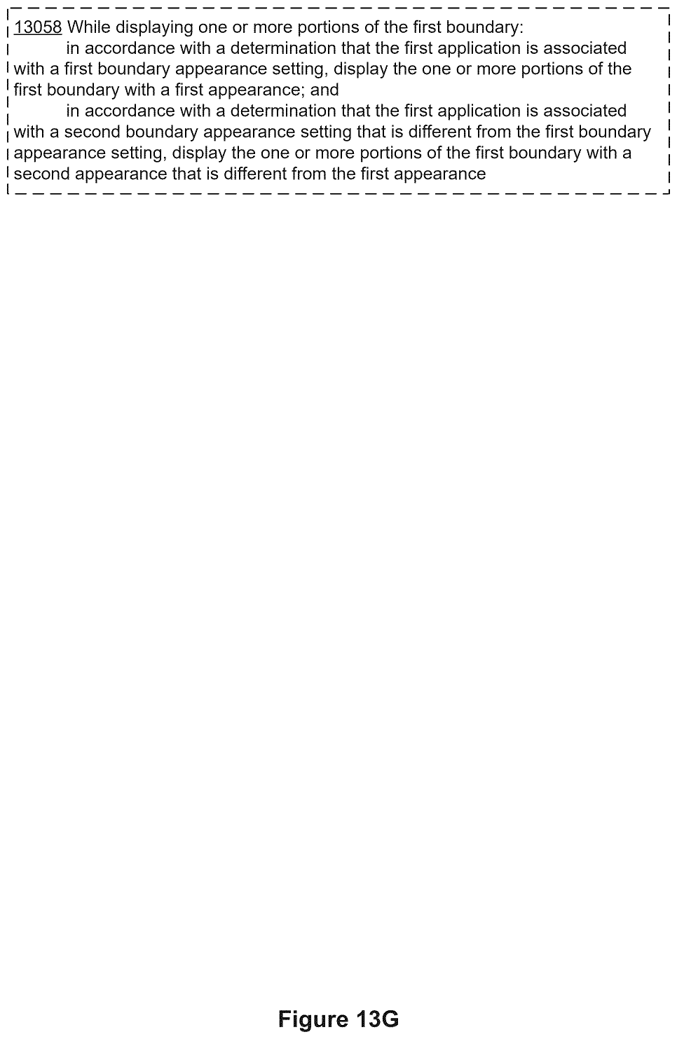

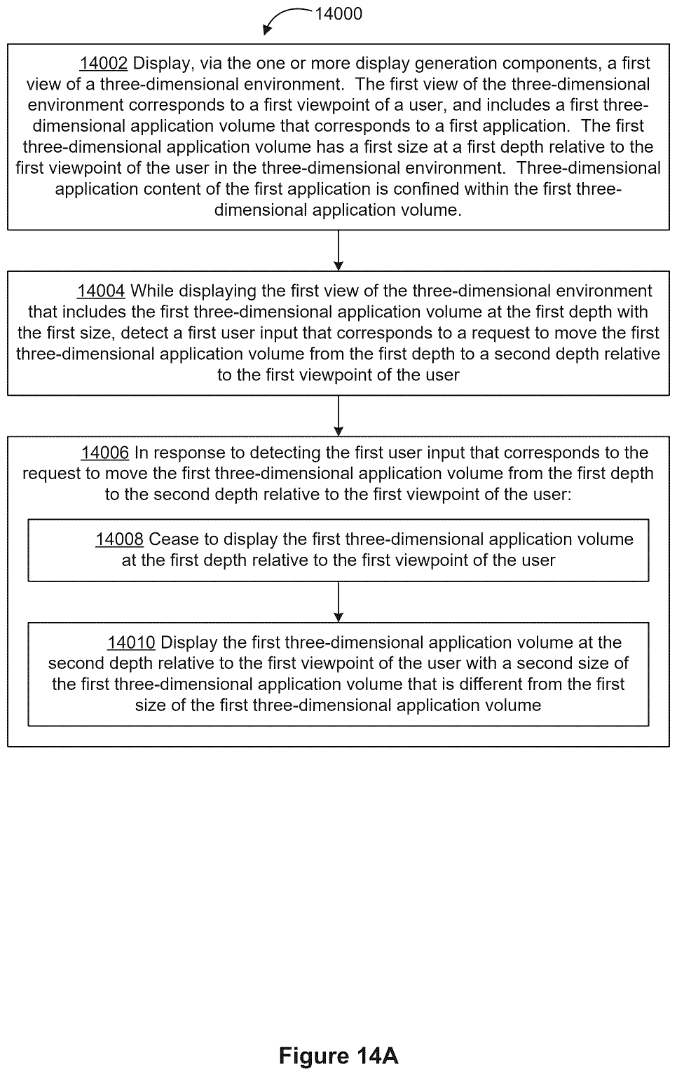

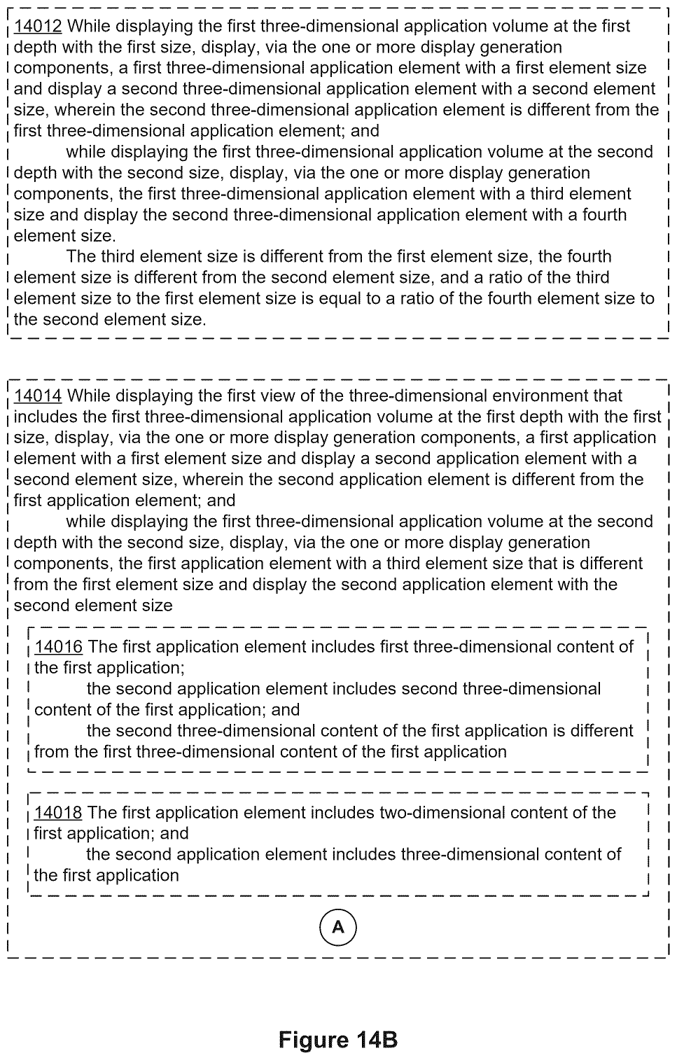

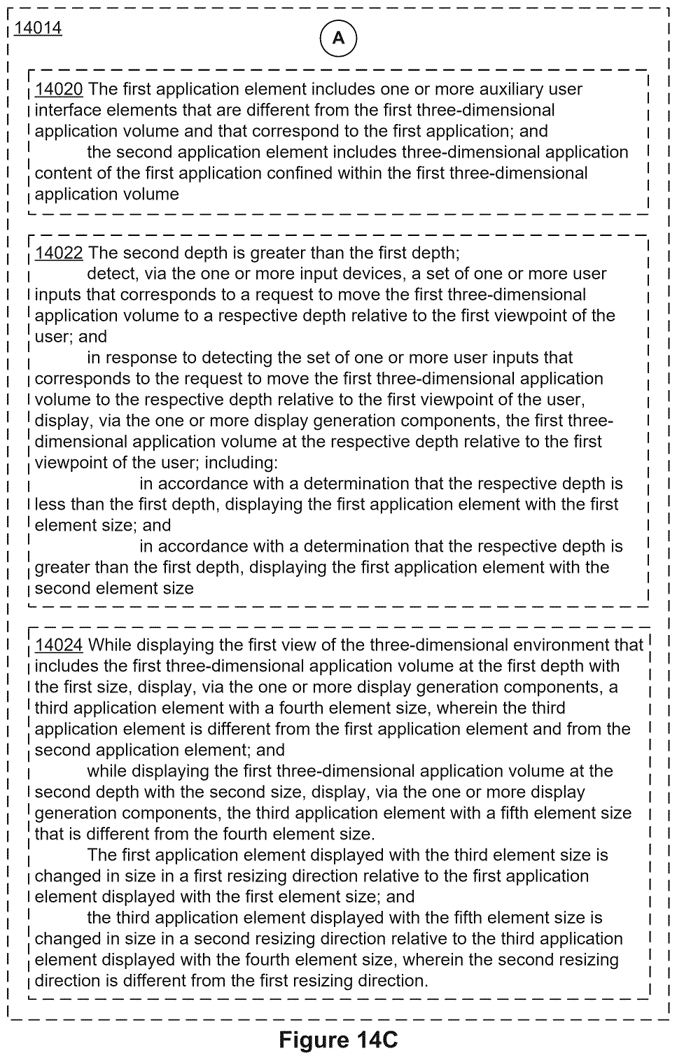

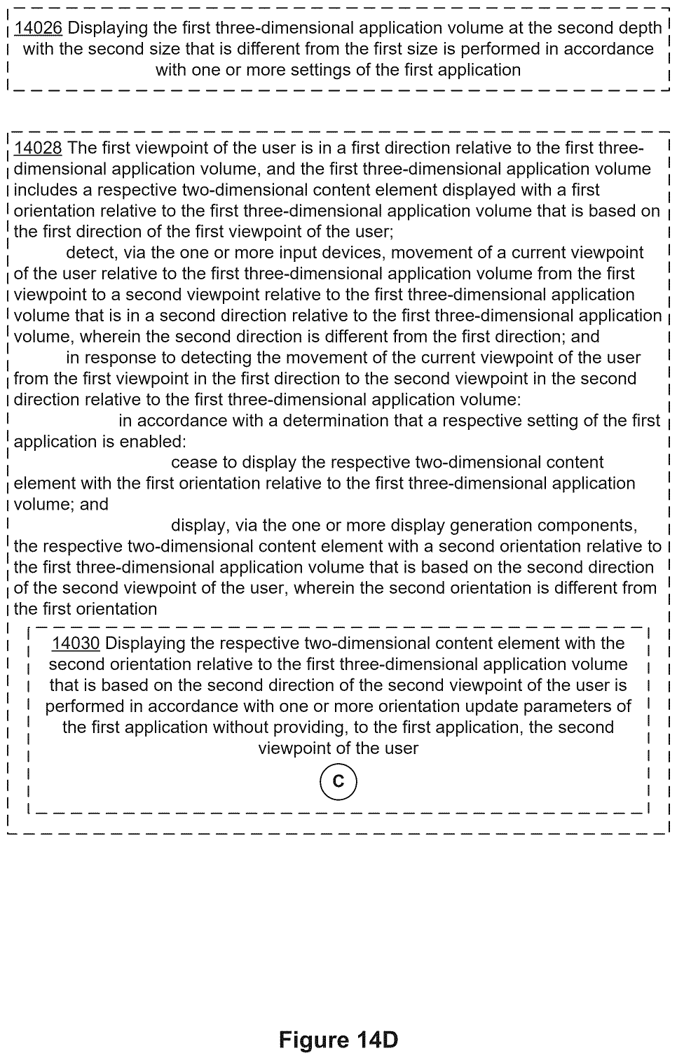

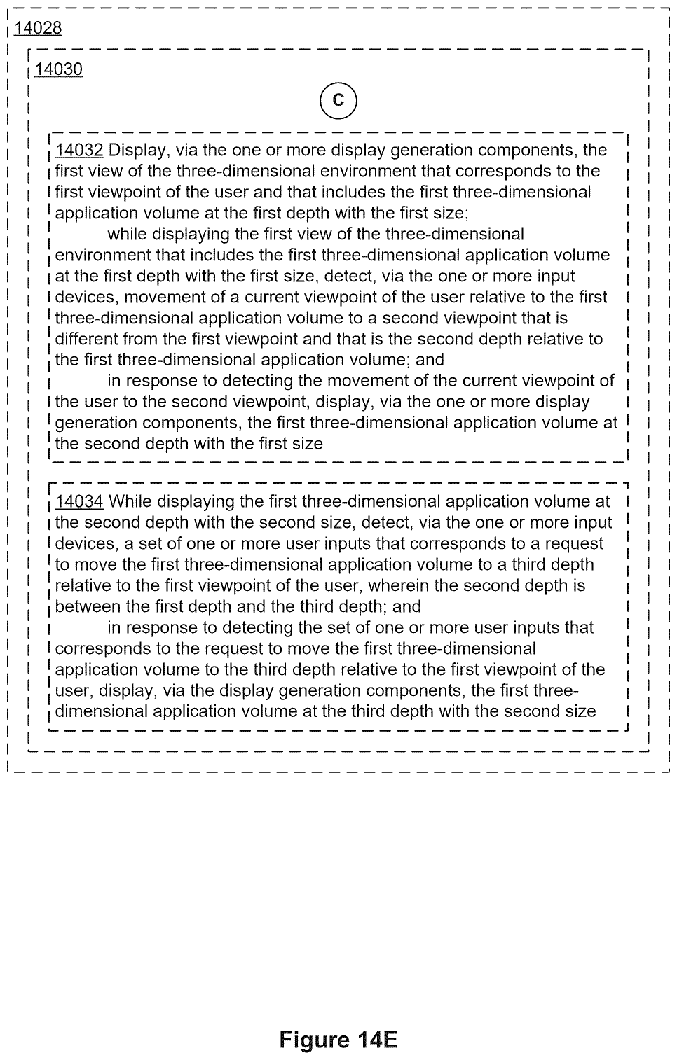

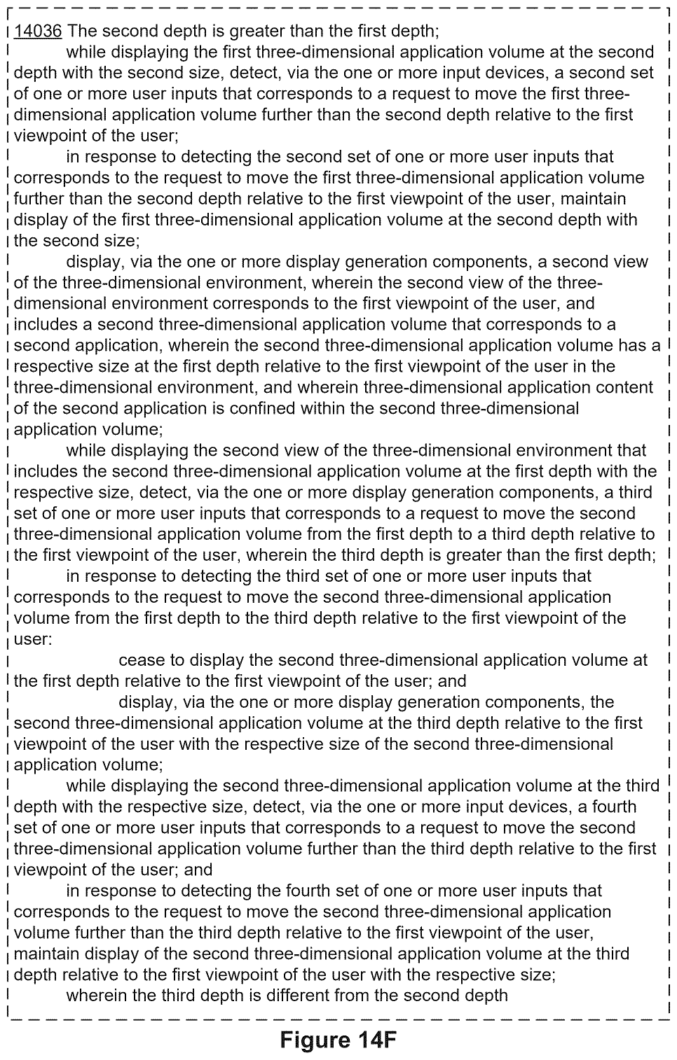

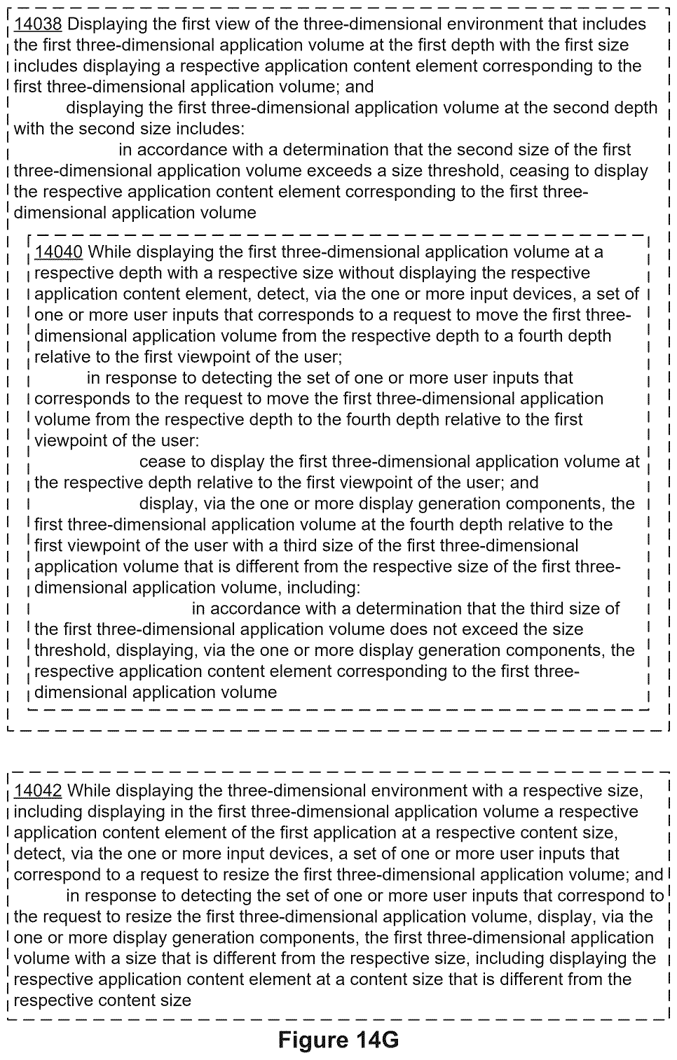

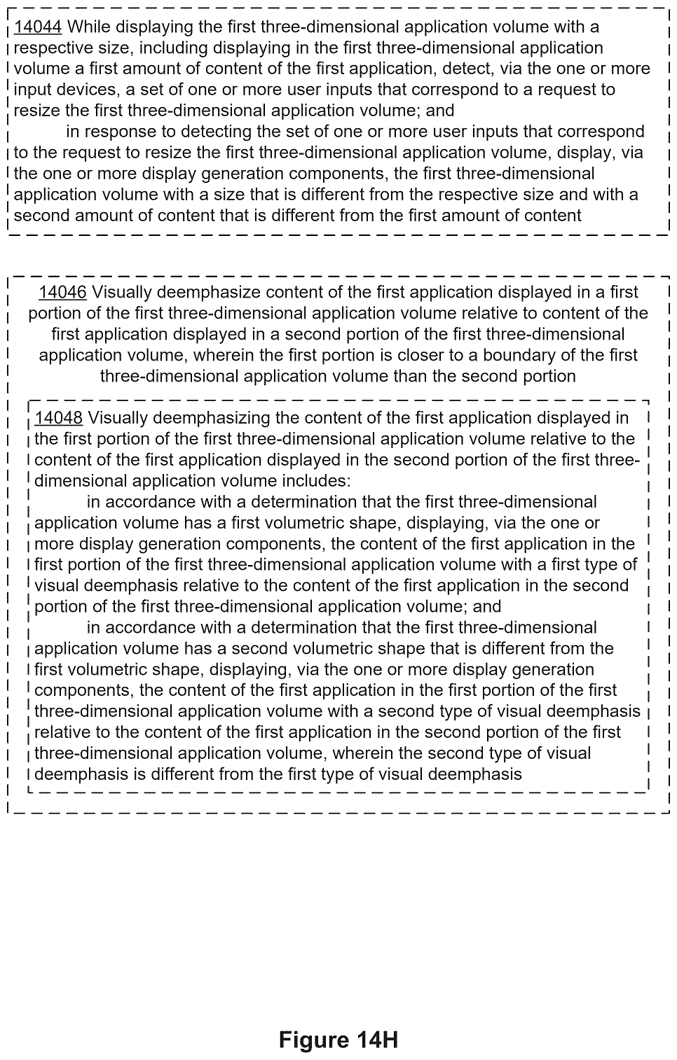

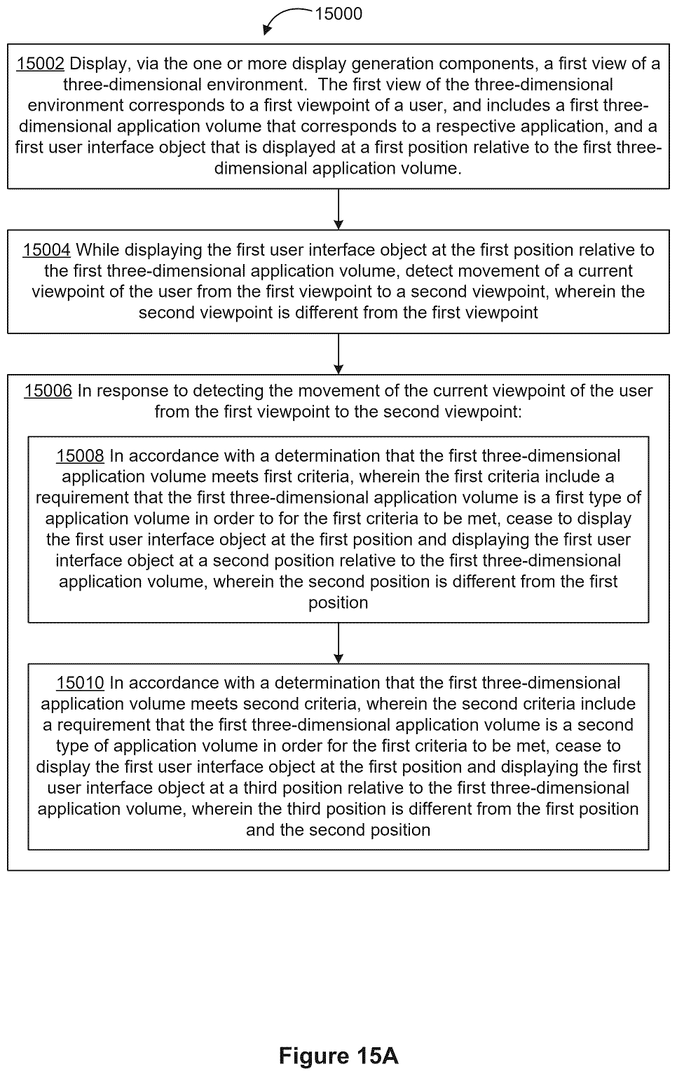

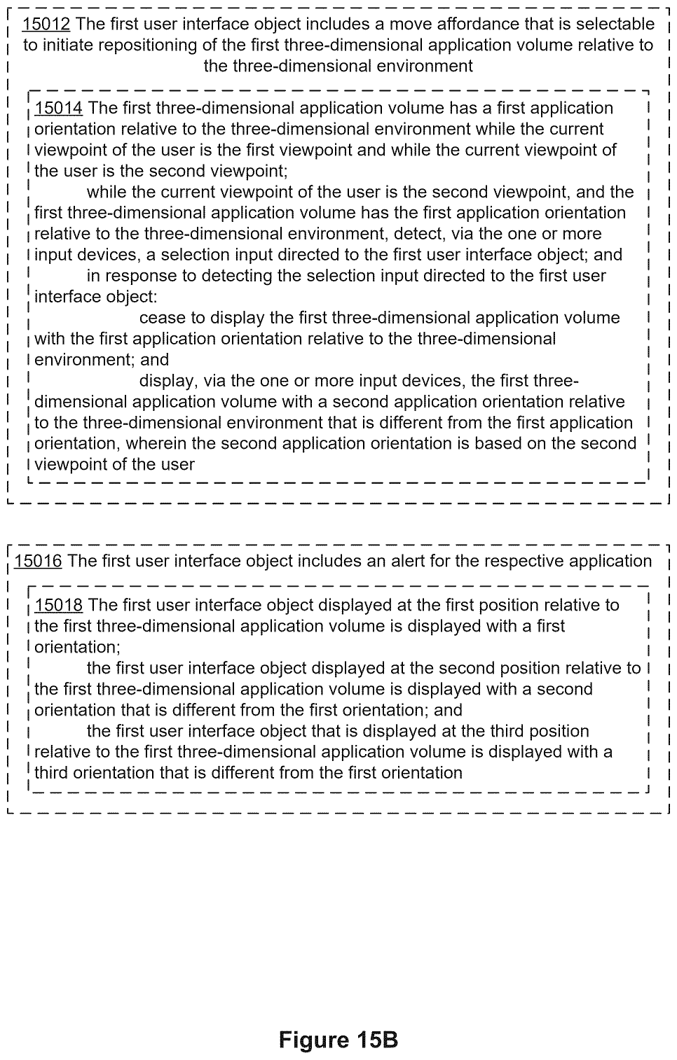

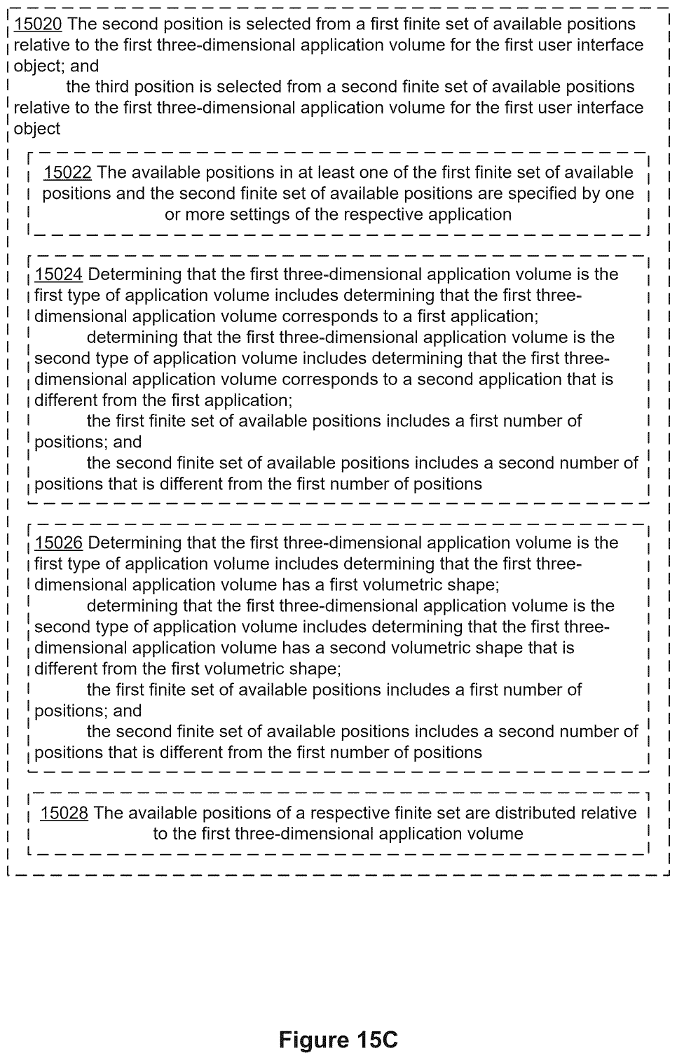

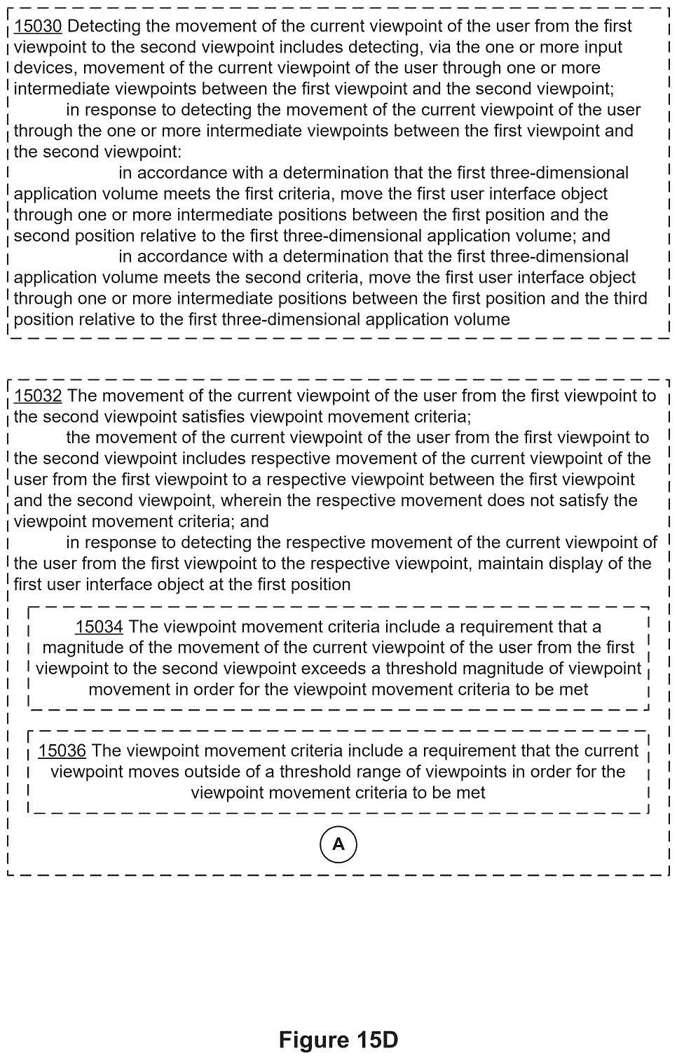

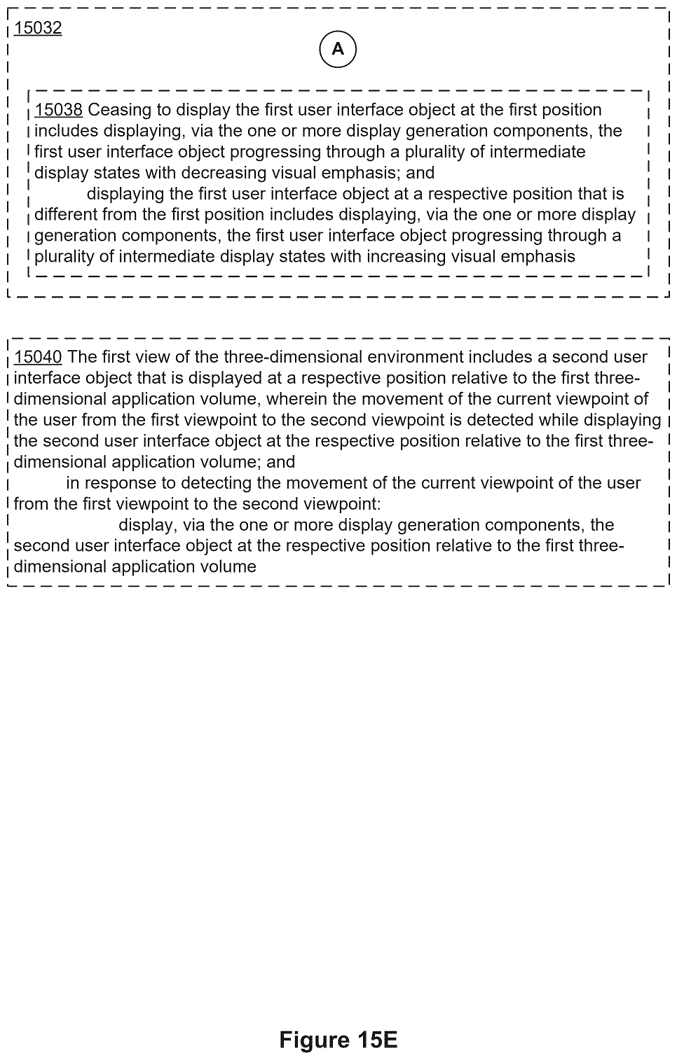

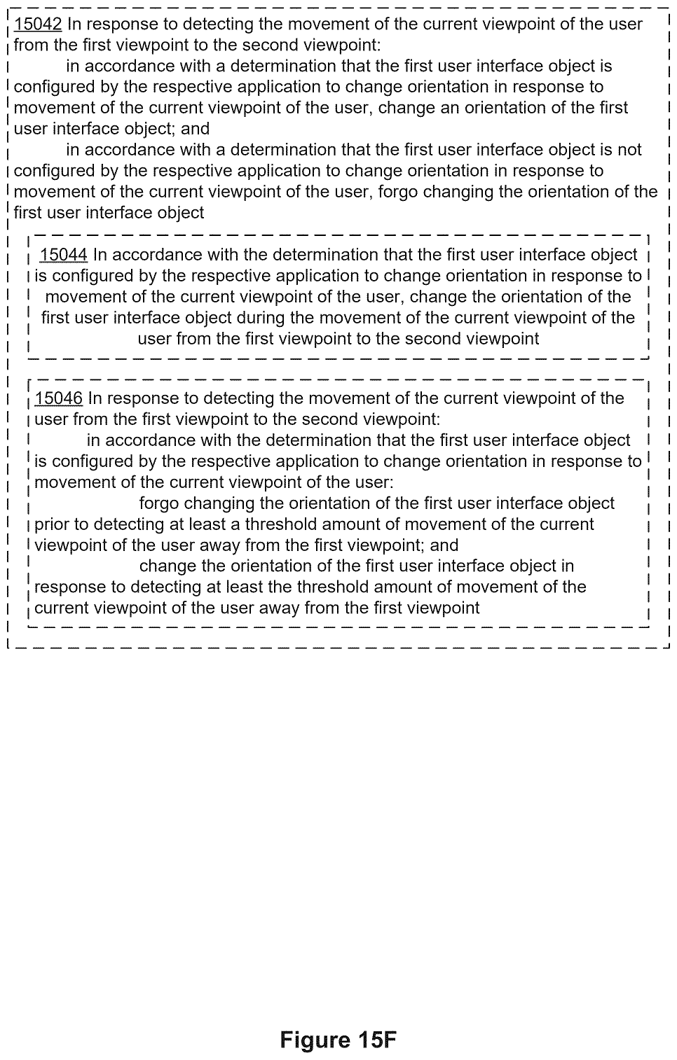

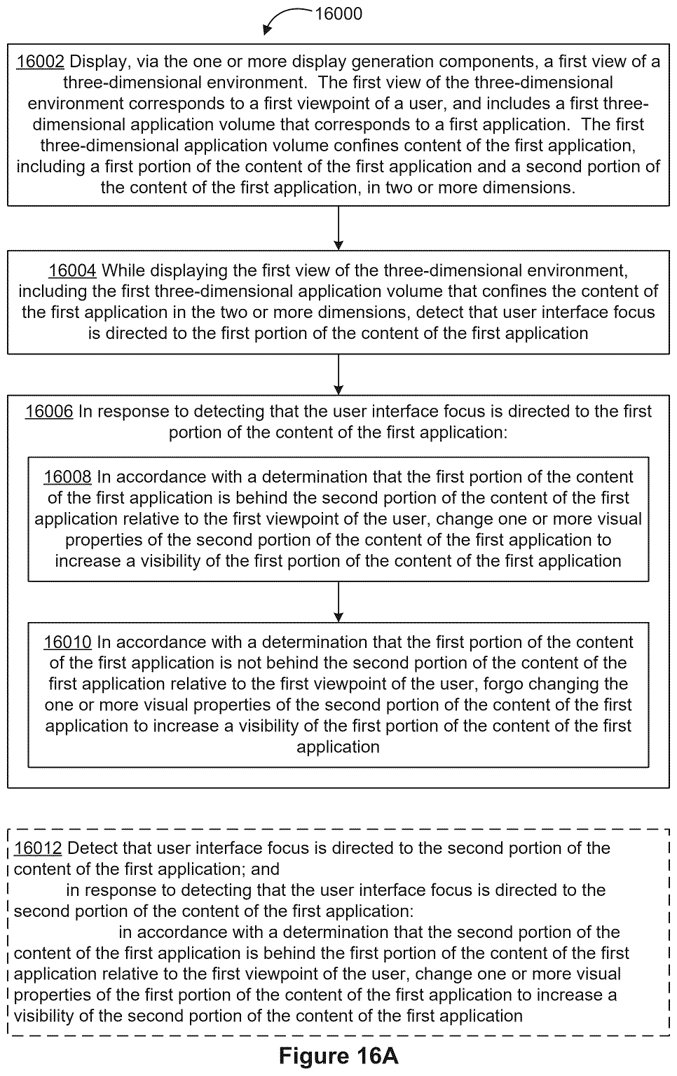

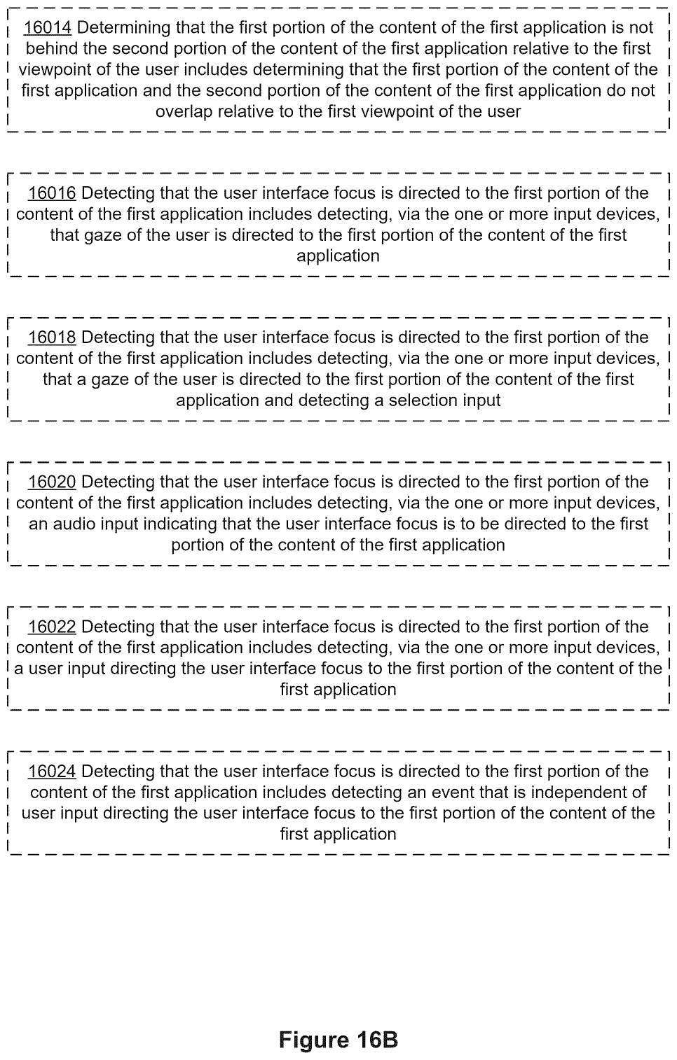

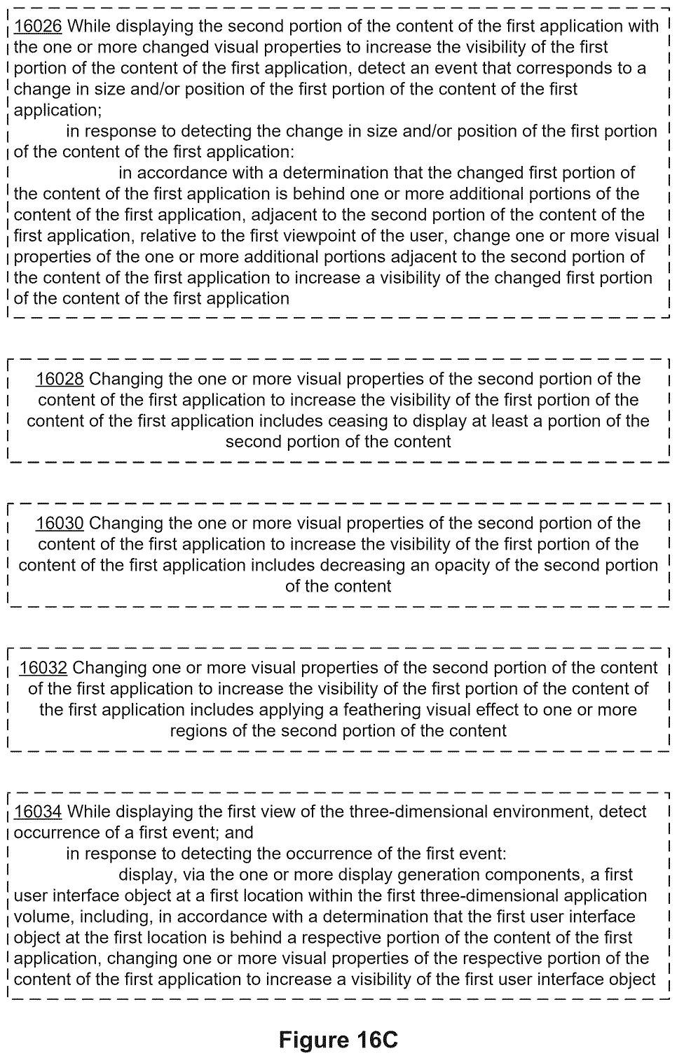

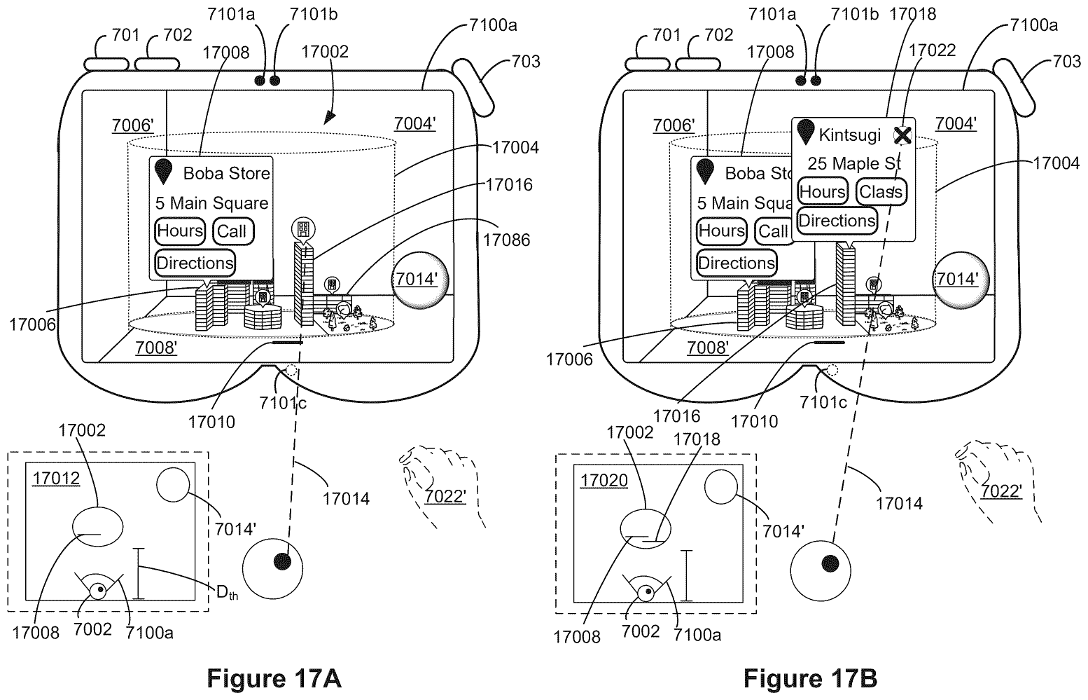

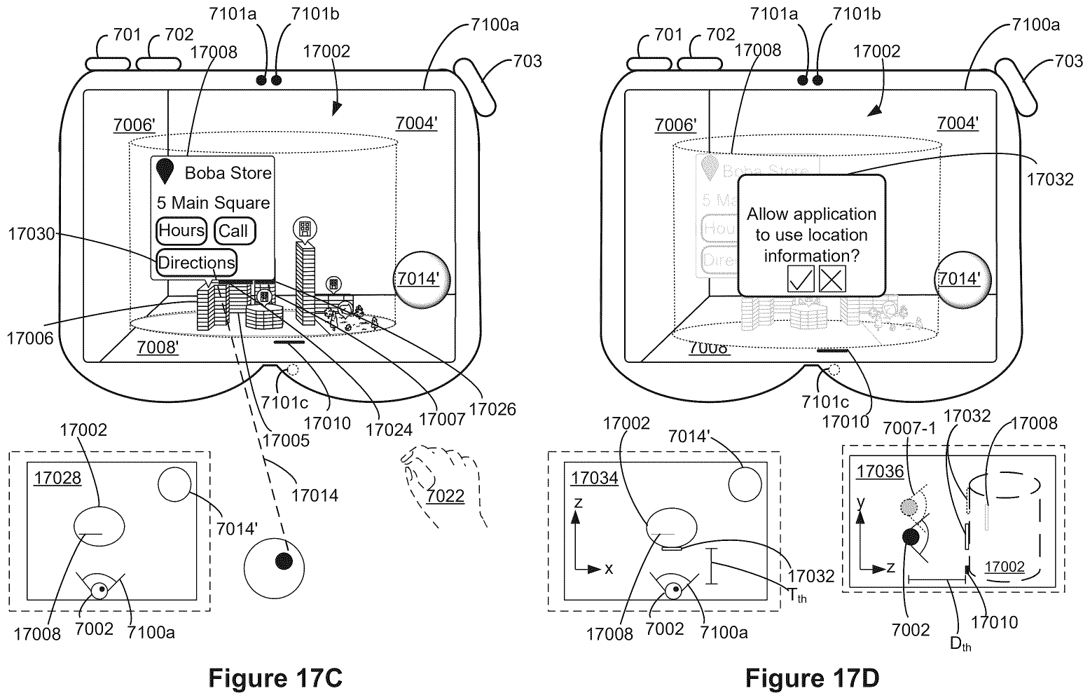

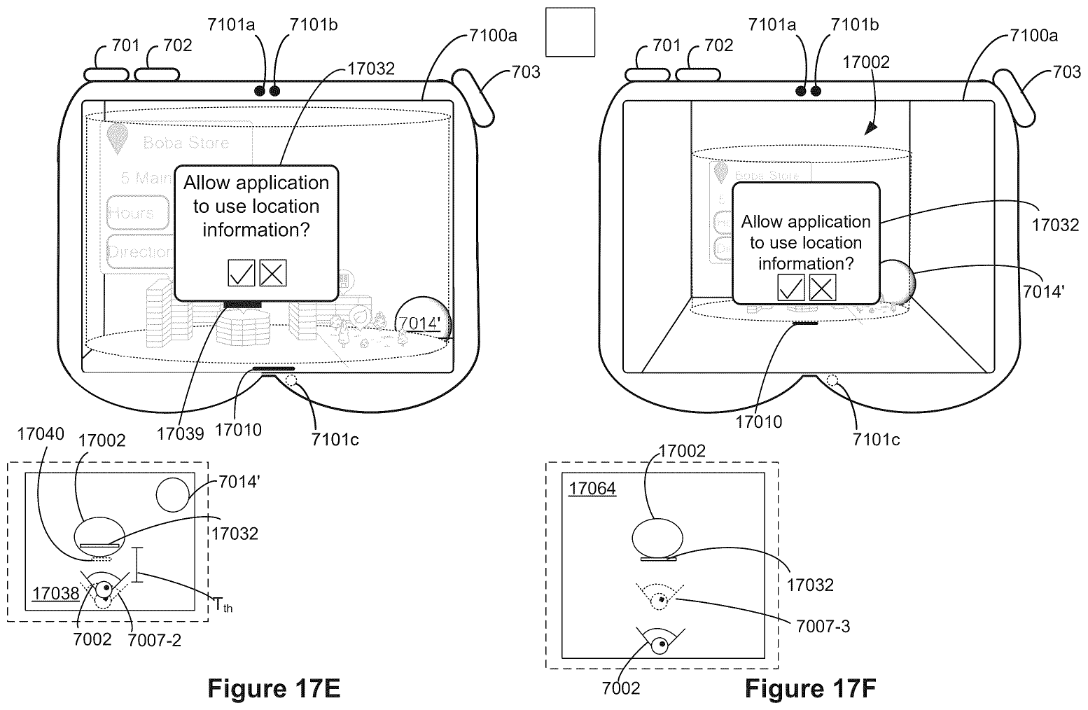

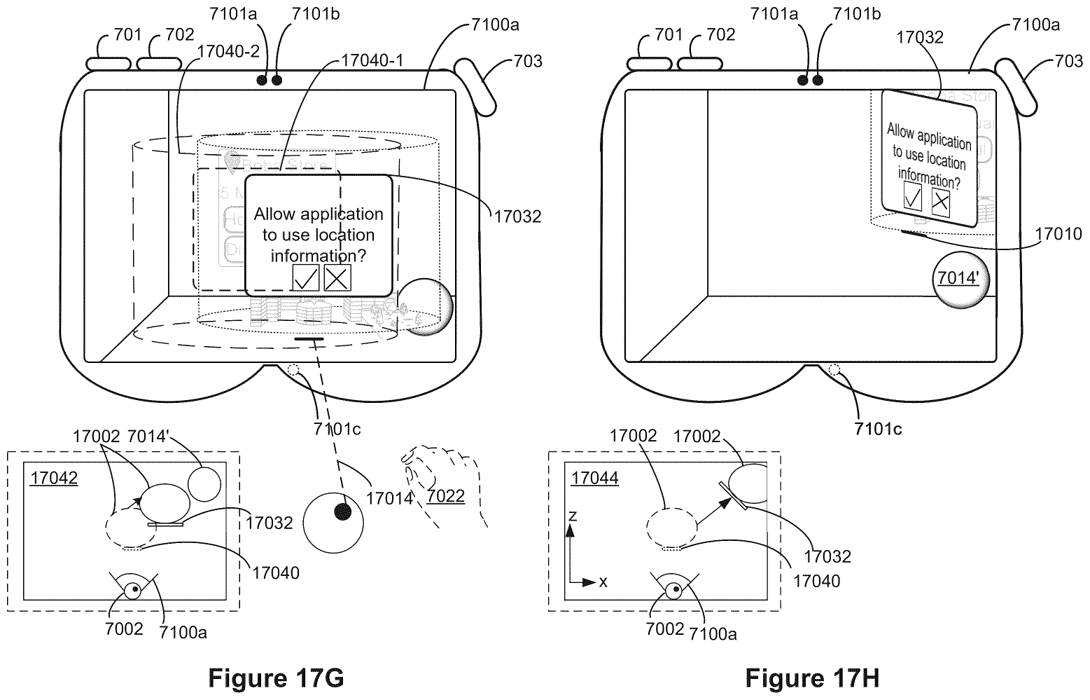

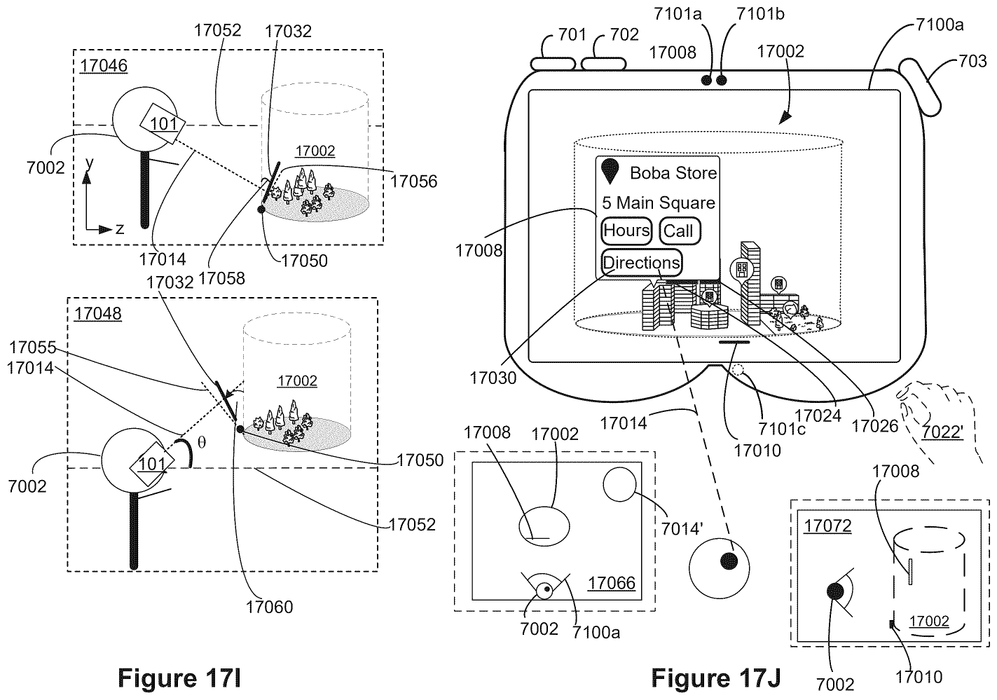

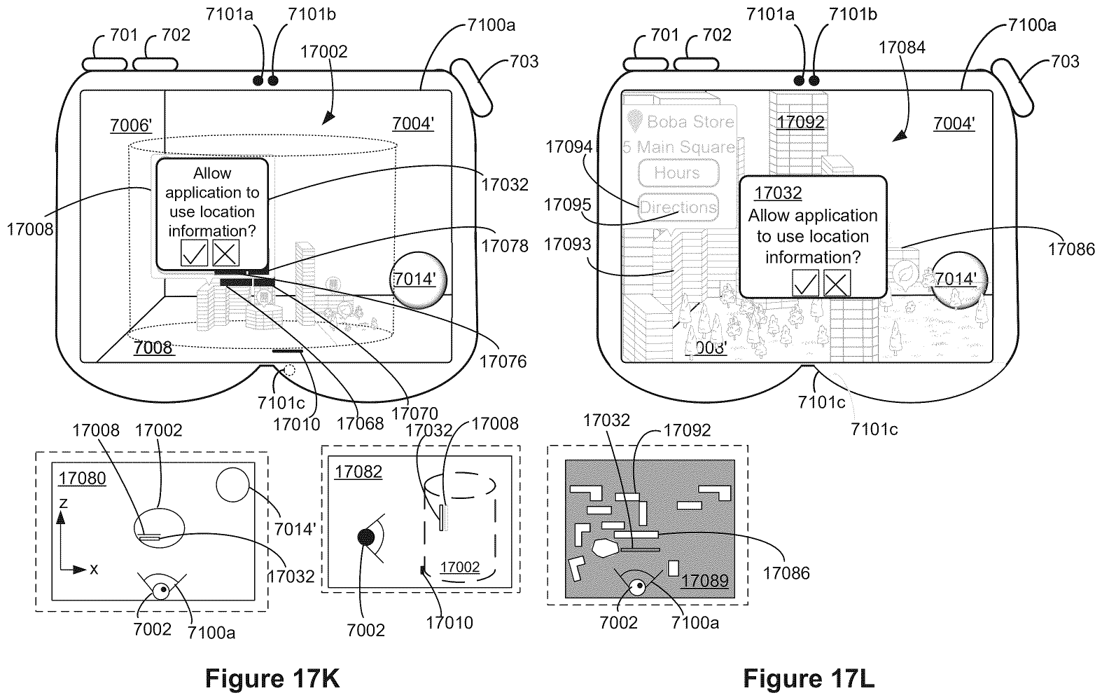

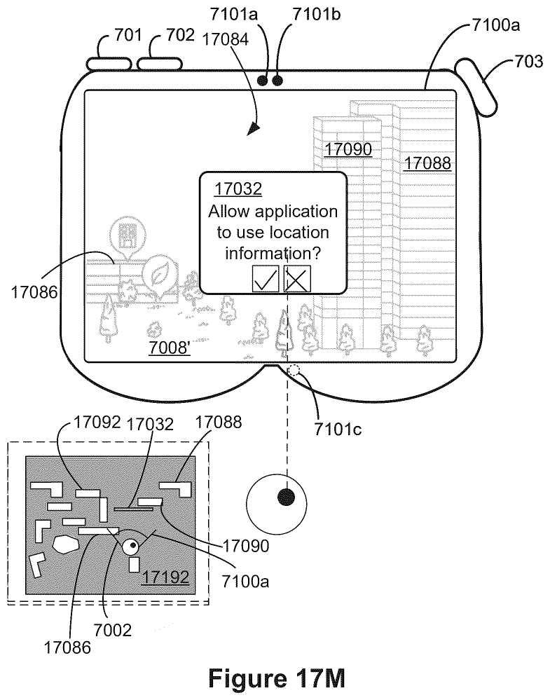

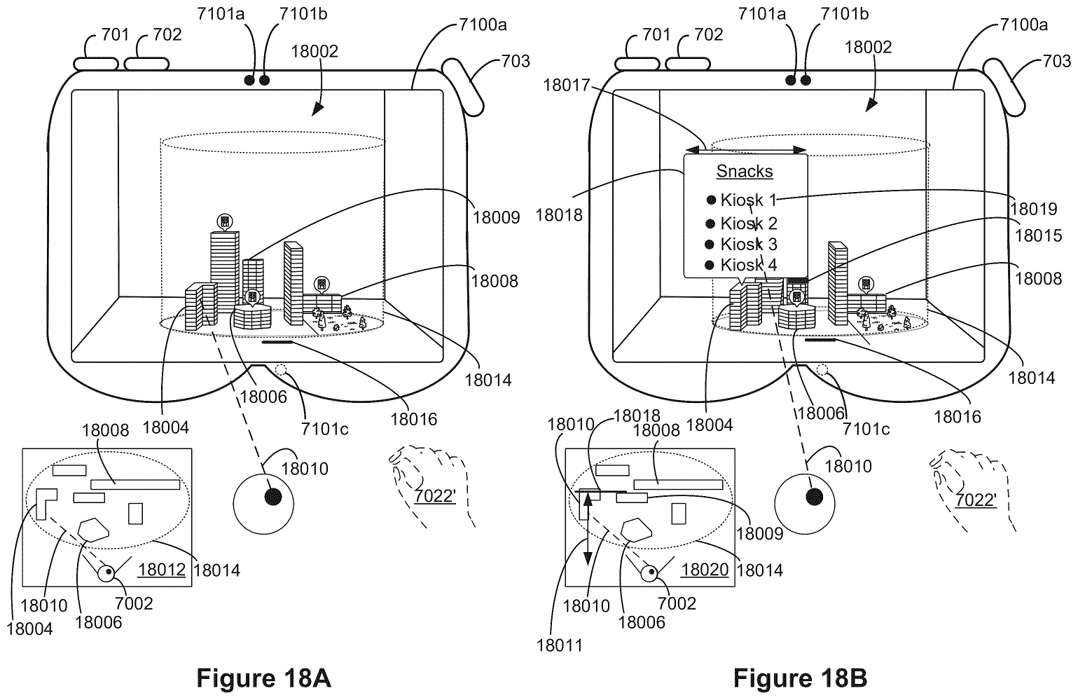

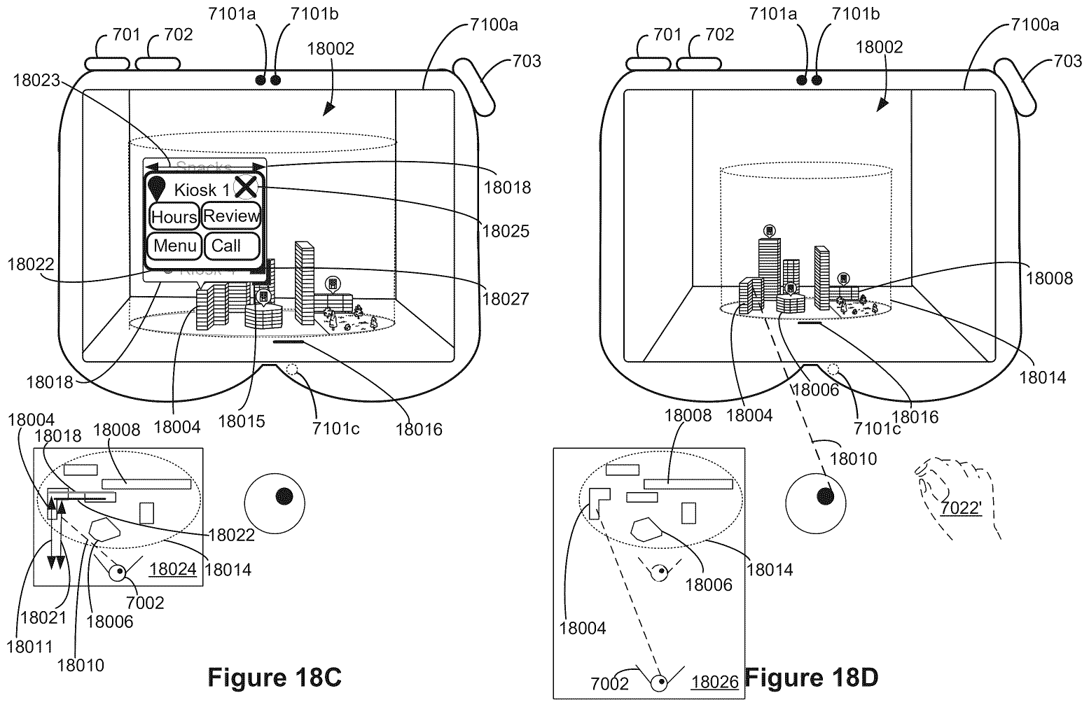

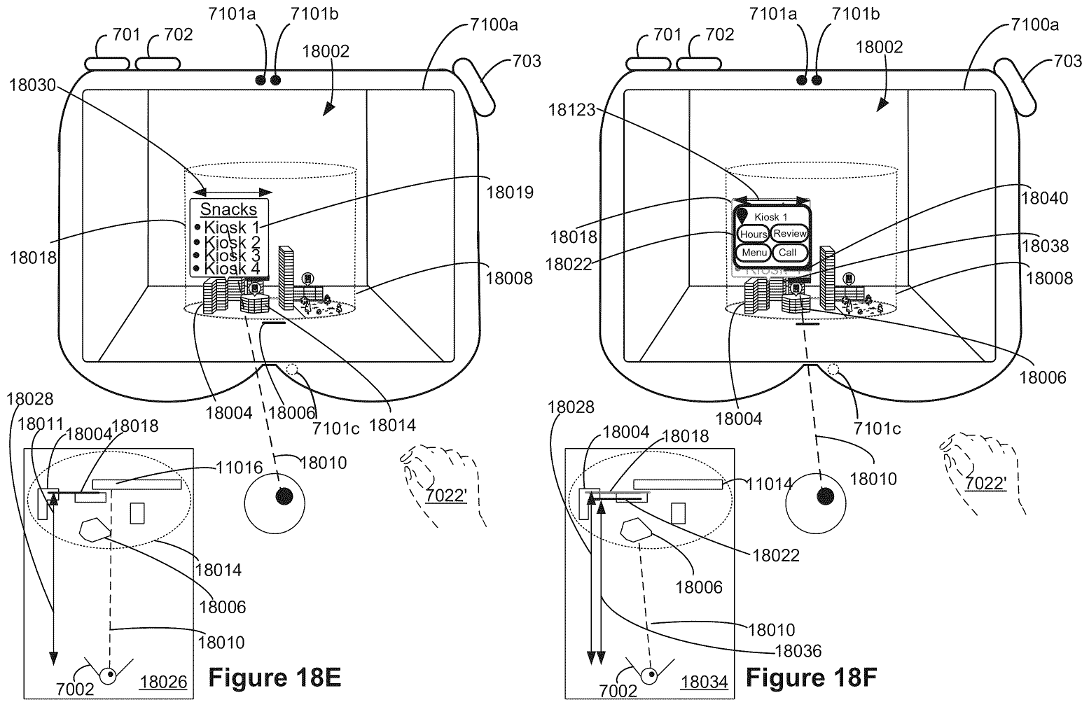

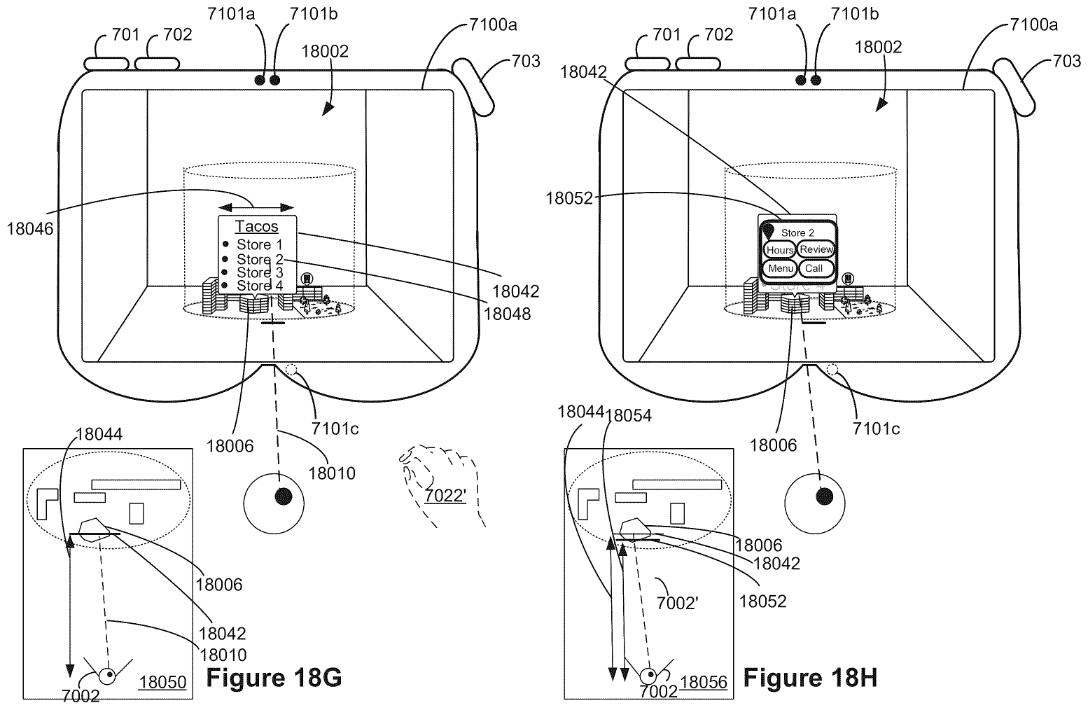

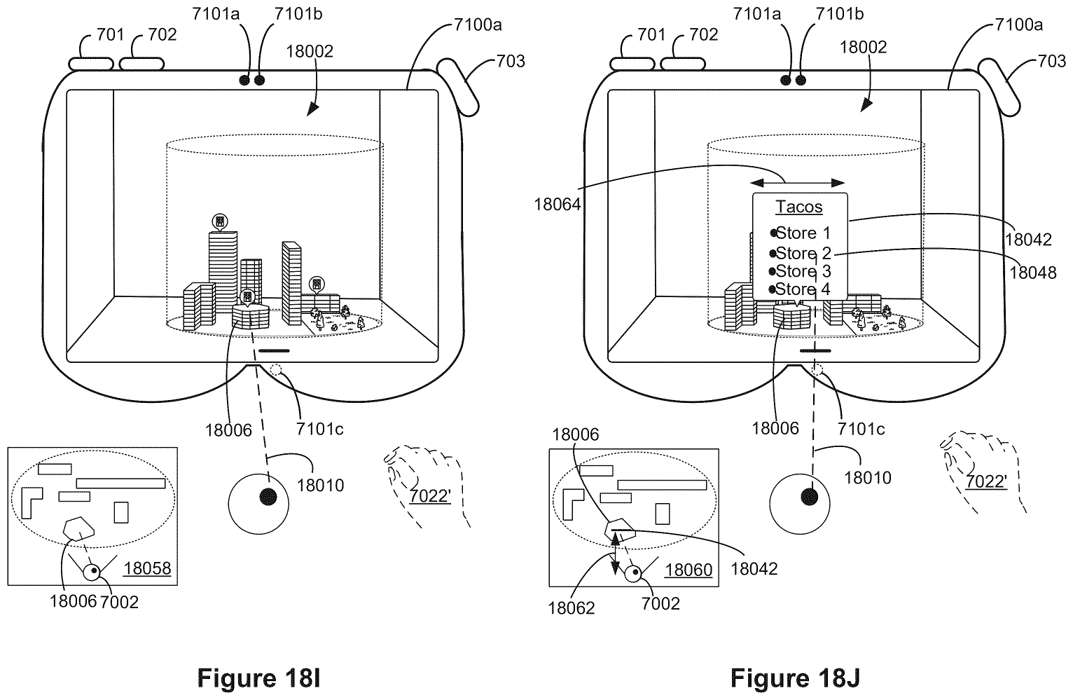

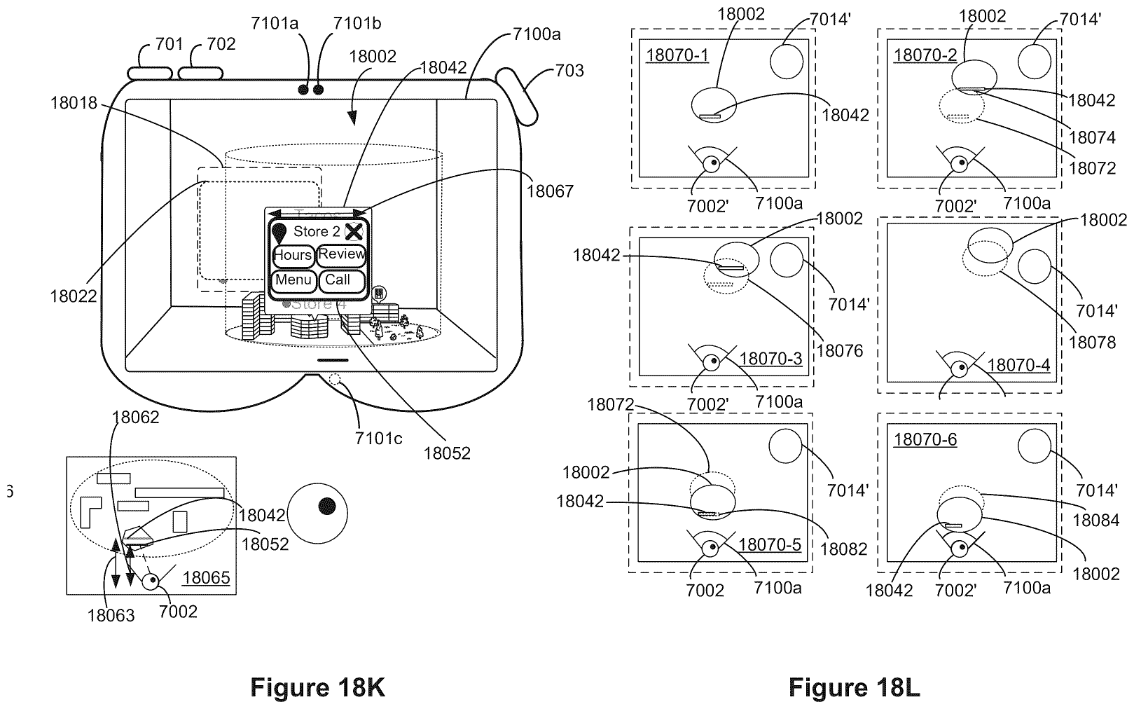

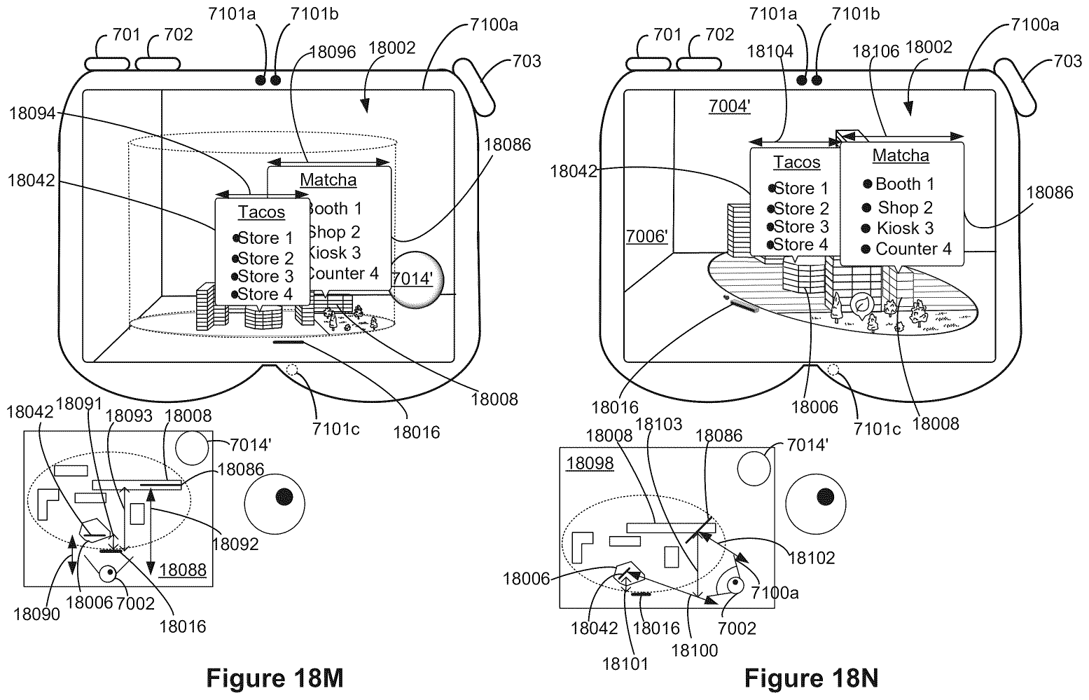

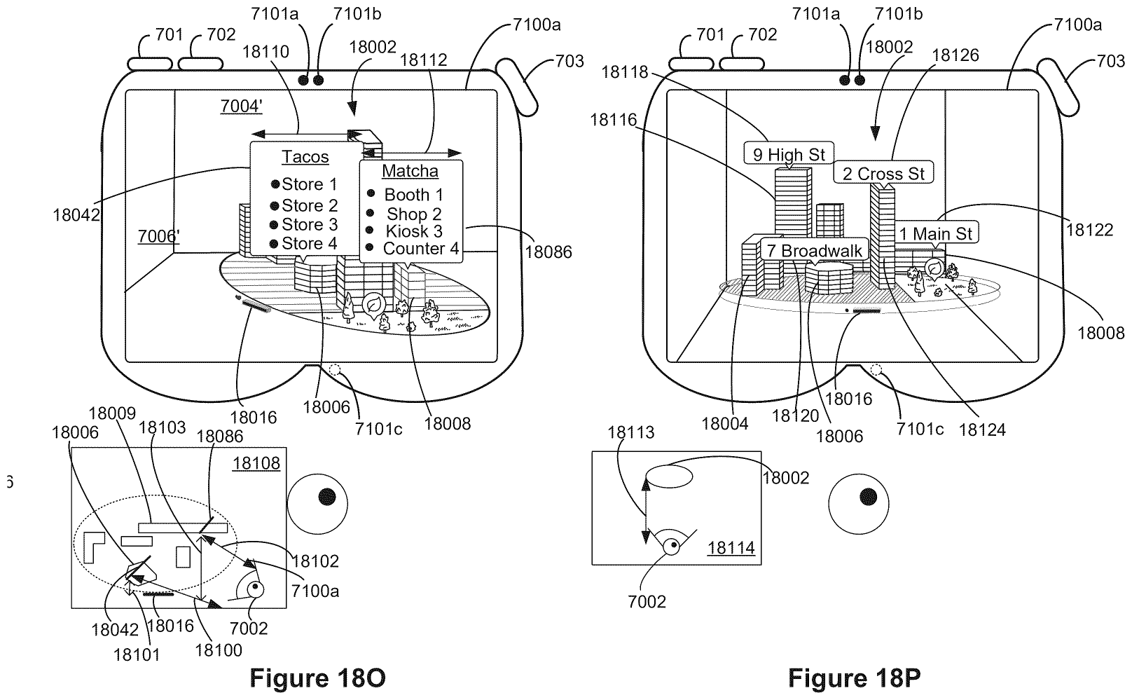

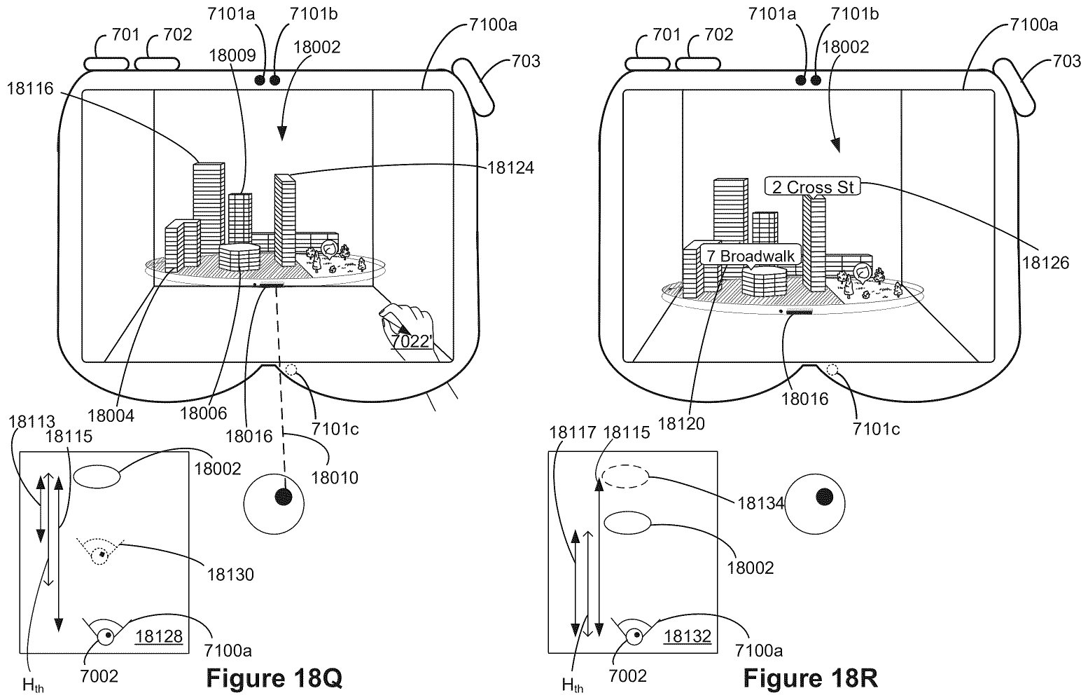

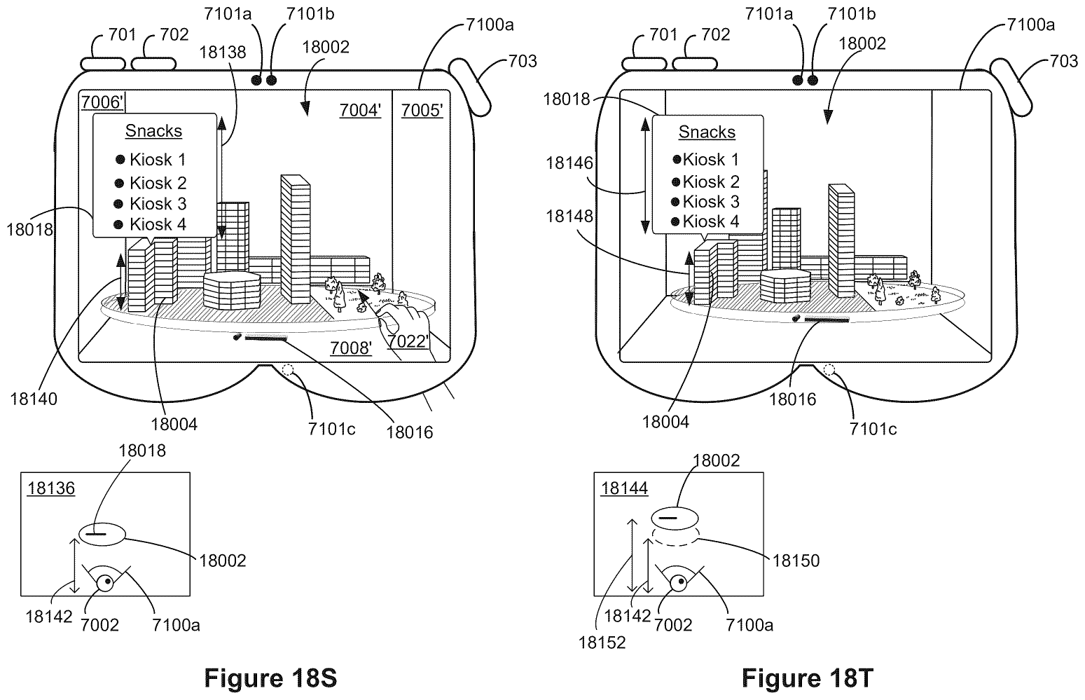

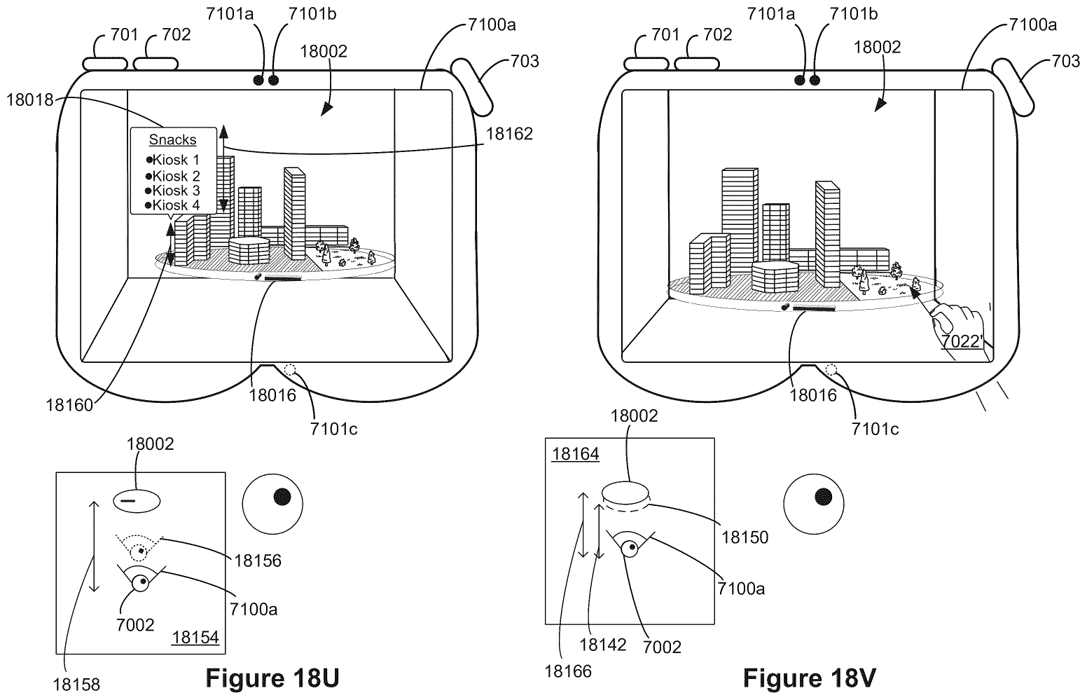

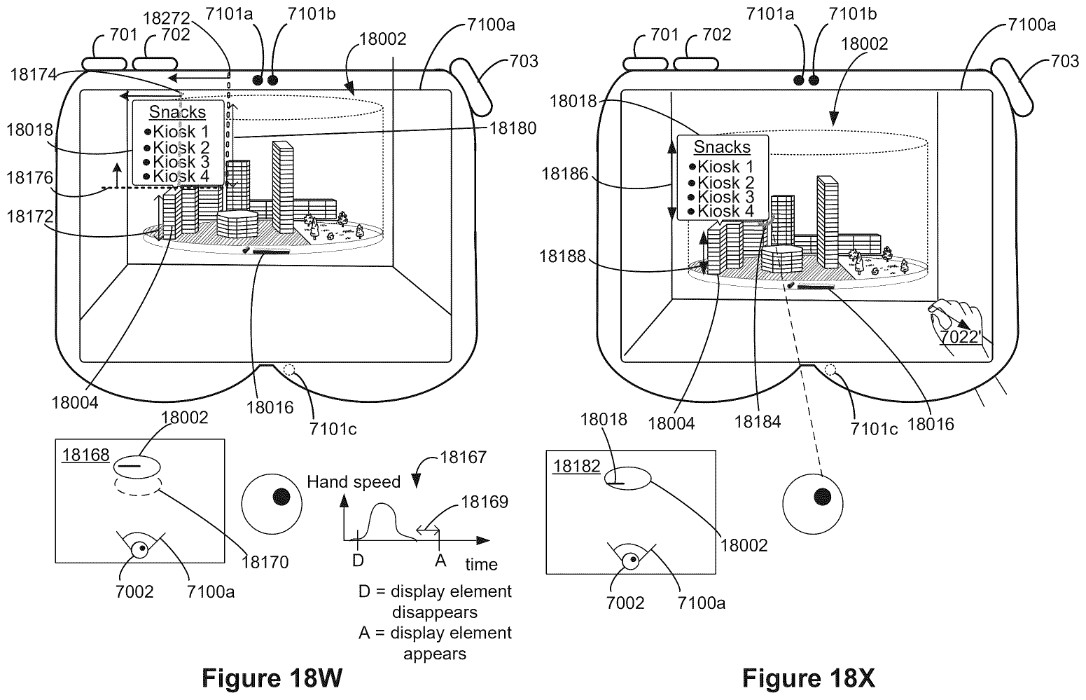

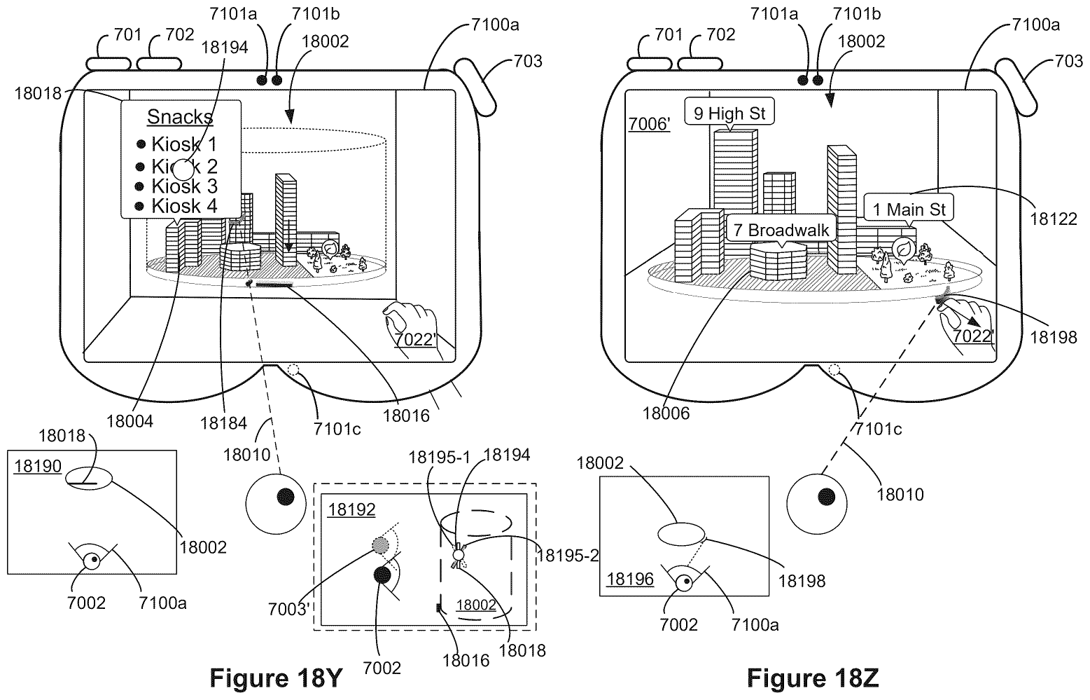

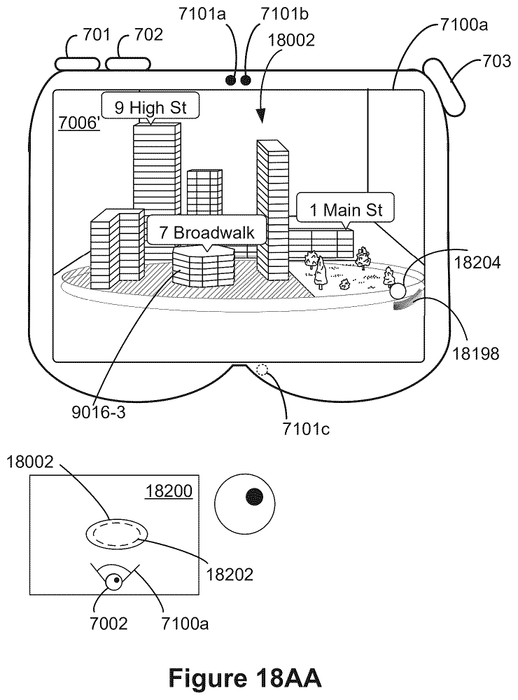

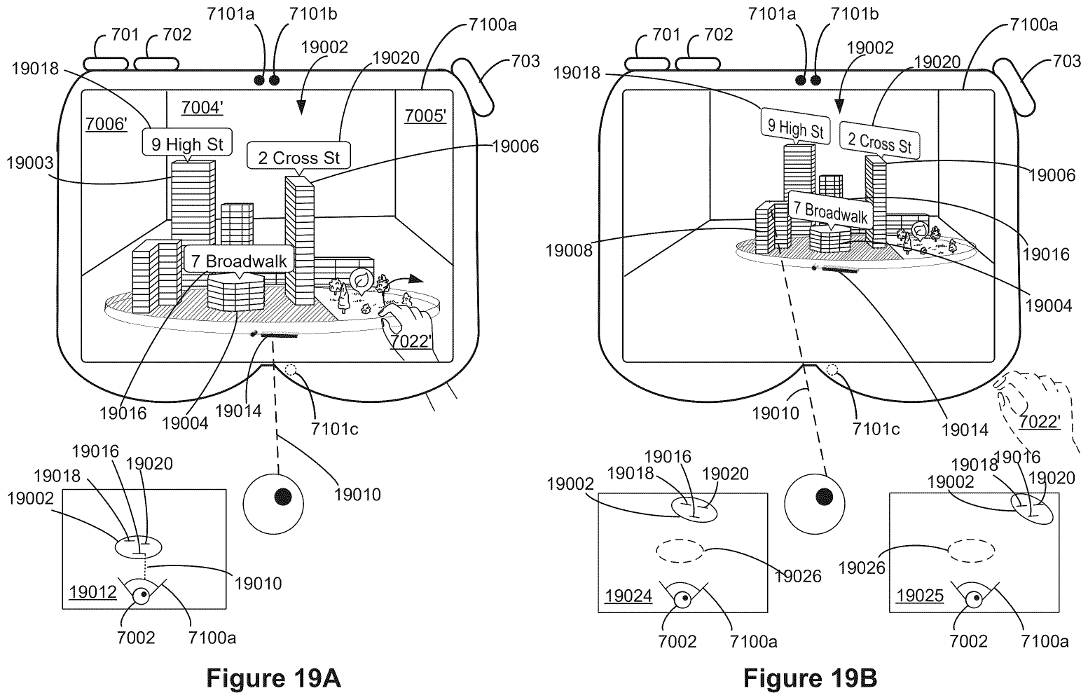

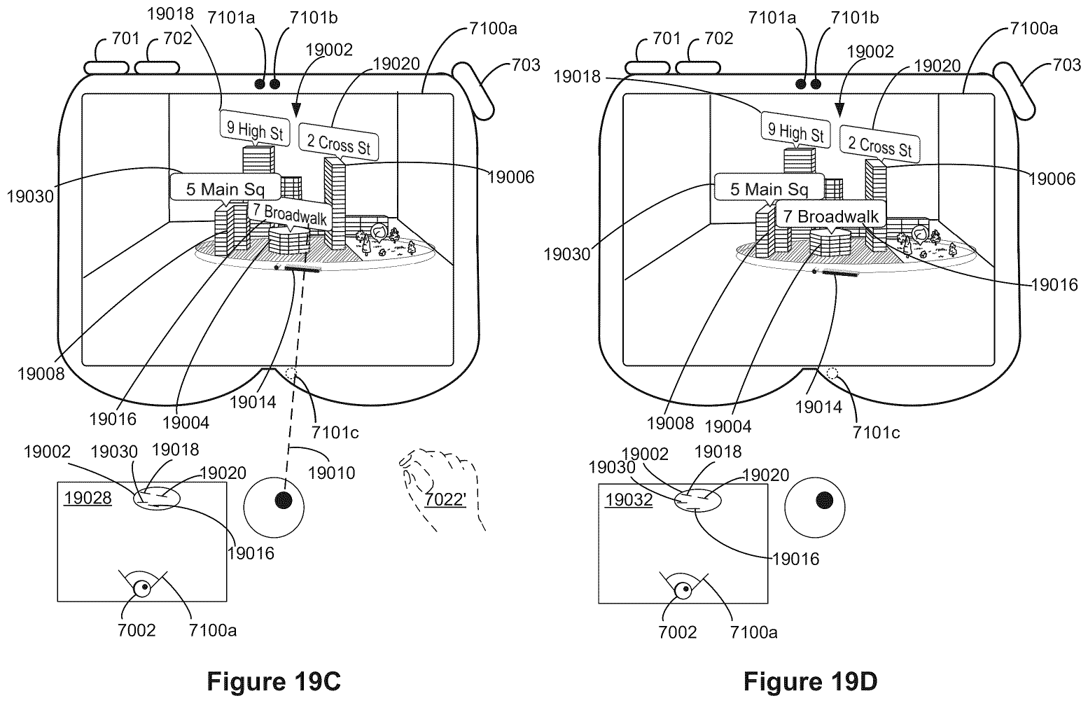

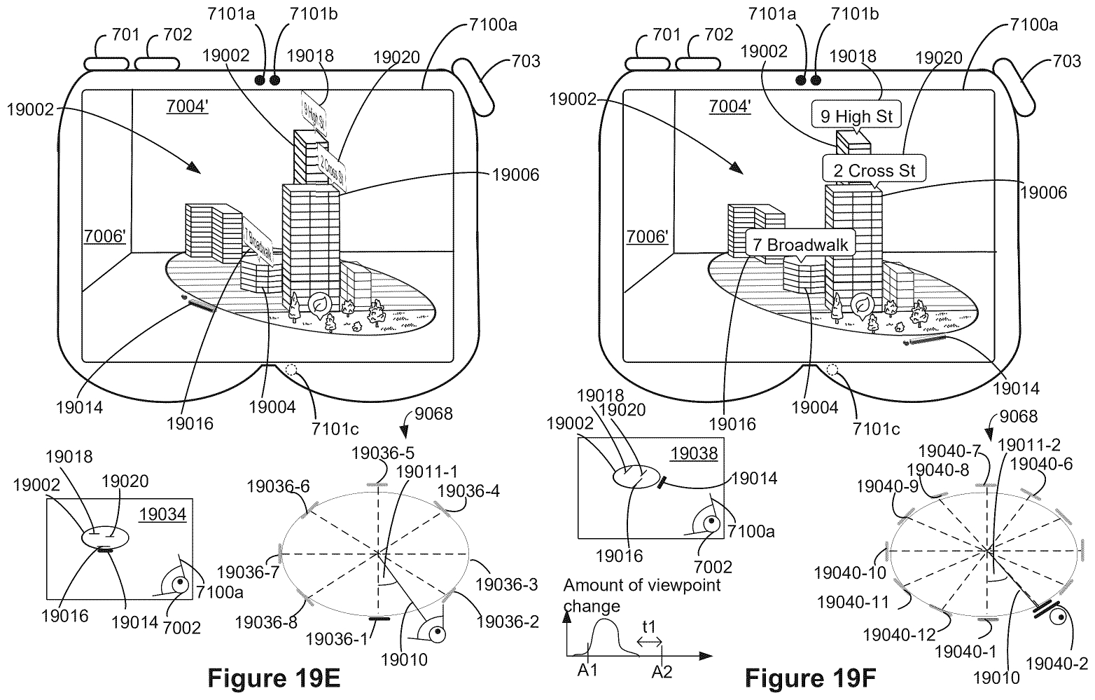

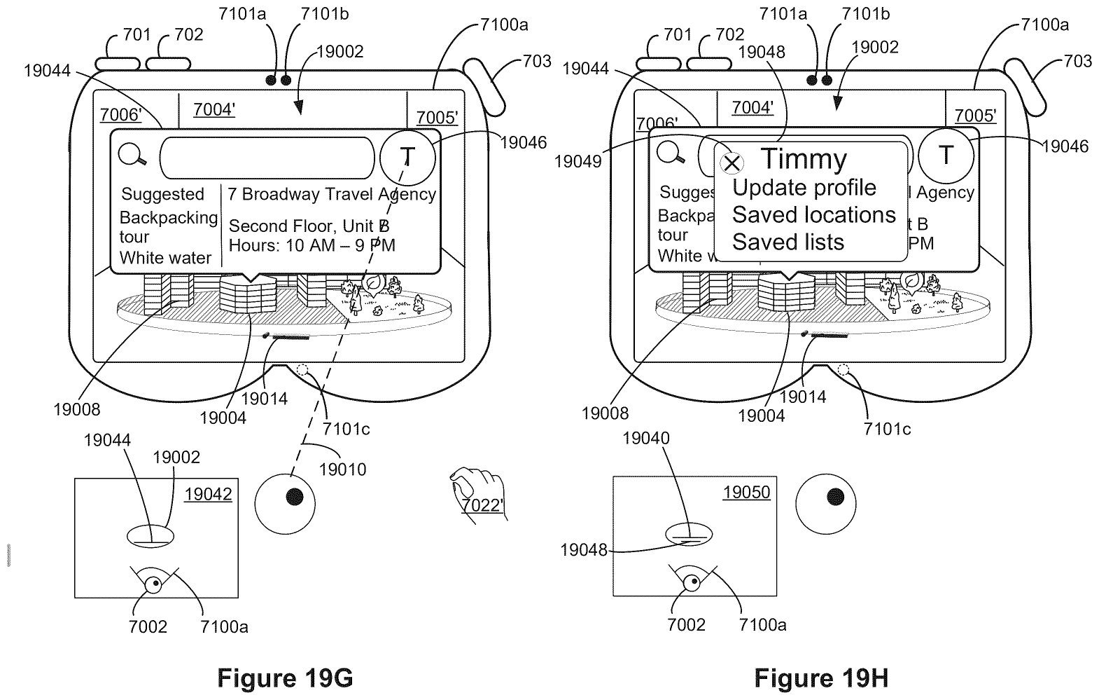

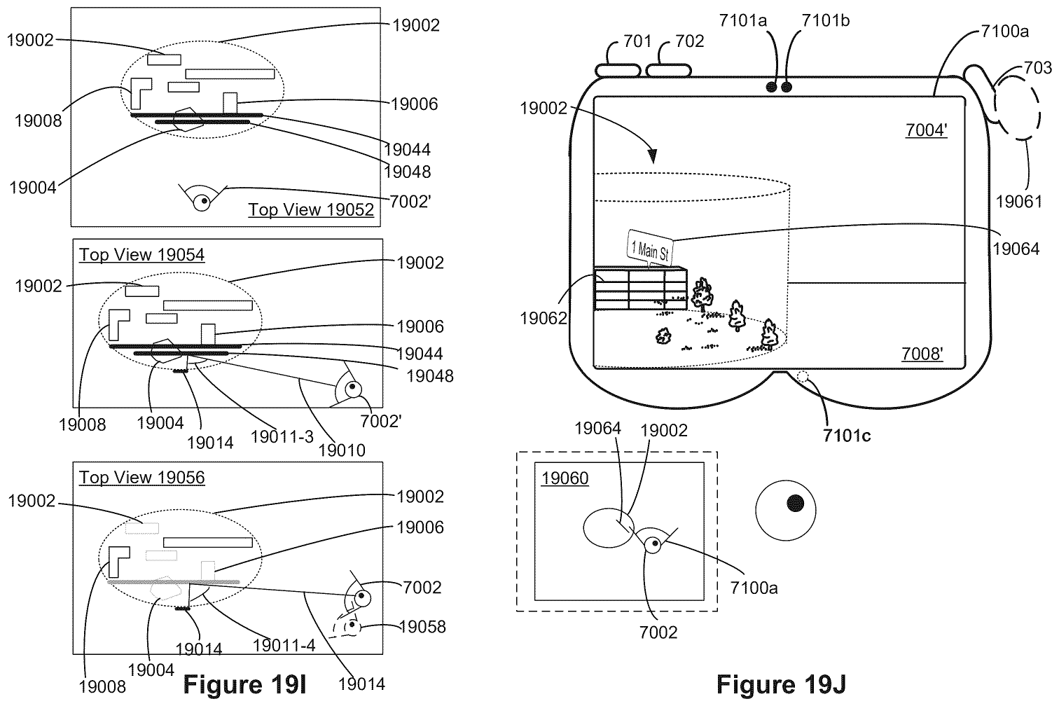

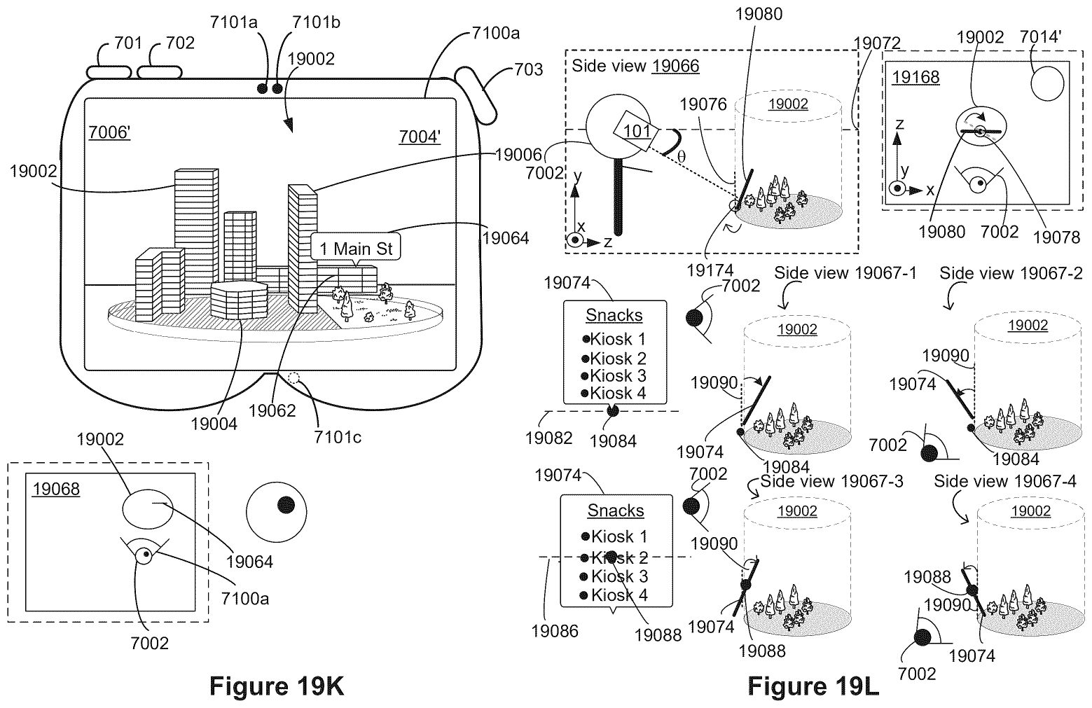

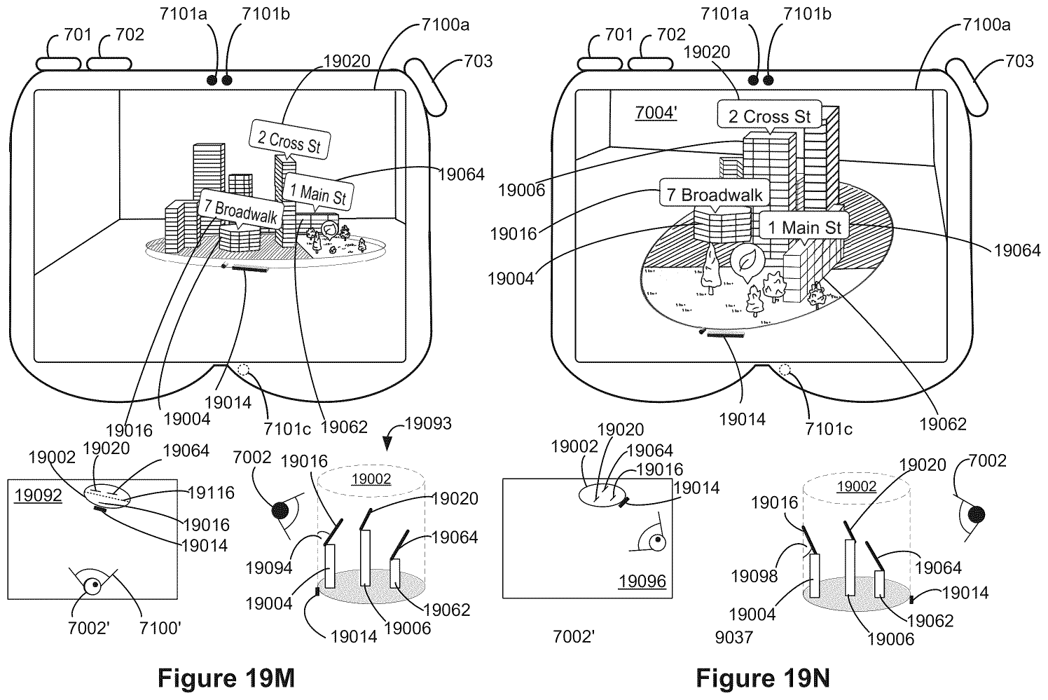

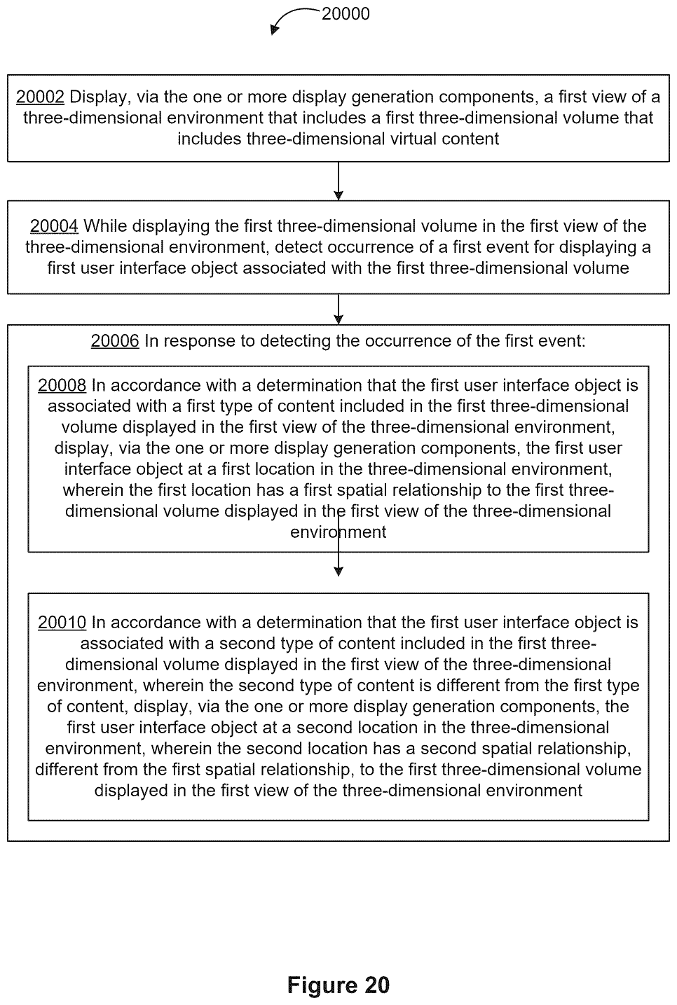

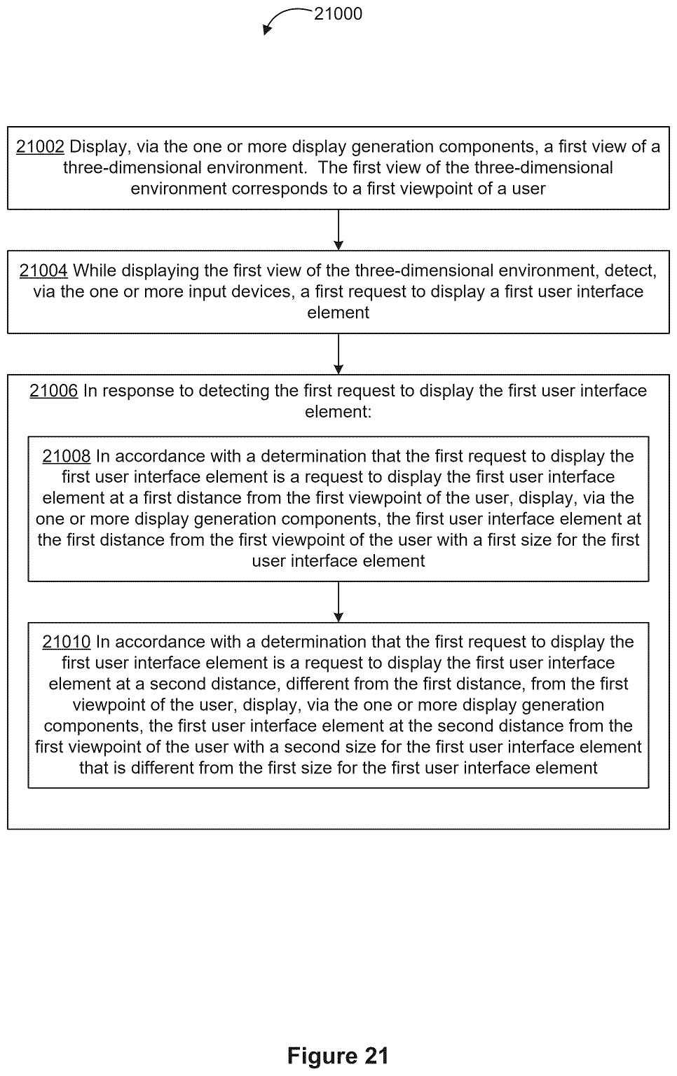

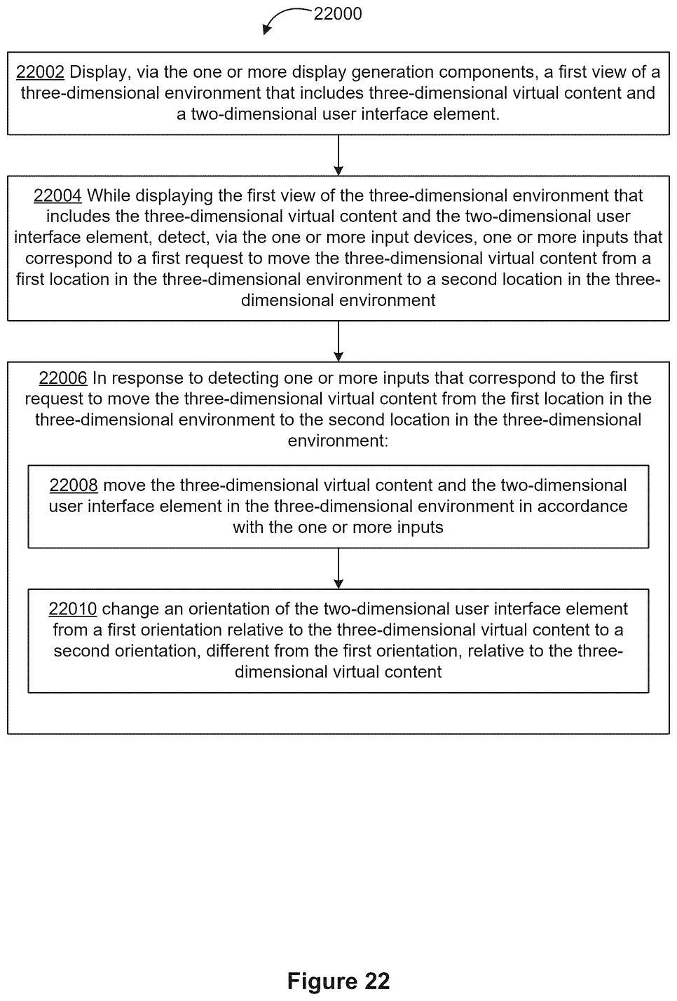

FIGS. 1A-6 provide a description of example computer systems for providing XR experiences to users (such as described below with respect to methods 12000. 13000, 14000, 15000, and/or 16000). FIGS. 7A-7O illustrate examples of displaying a user interface element while a volumetric application is displayed in the viewport. FIGS. 12A-12G are flow diagrams of an exemplary method 12000 for displaying a user interface element while a volumetric application is displayed in the viewport. The user interfaces in FIGS. 7B-7O are used to illustrate the processes described below, including the processes in FIGS. 12A-12G. FIGS. 8A-8X illustrate examples of displaying visual feedback when attention of the user is directed toward a boundary of a volumetric application. FIGS. 13A-13G are flow diagrams of an exemplary method 13000 for displaying visual feedback when attention of the user is directed toward a boundary of a volumetric application. The user interfaces in FIGS. 8A-8X are used to illustrate the processes described below, including the processes in FIGS. 13A-13G. FIGS. 9A-9P illustrate examples of scaling of a volumetric application user interface within a three-dimensional environment. FIGS. 14A-14H are flow diagrams of an exemplary method 14000 for scaling of a volumetric application user interface within a three-dimensional environment. The user interfaces in FIGS. 9A-9P are used to illustrate the processes described below, including the processes in FIGS. 14A-14H. FIGS. 10A-10I illustrate examples of changing a display location of a user interface element based on a change in a viewpoint of the user. FIGS. 15A-15F are flow diagrams of an exemplary method 12000 for changing a display location of a user interface element based on a change in a viewpoint of the user. The user interfaces in FIGS. 10A-10I are used to illustrate the processes described below, including the processes in FIGS. 15A-15F. FIGS. 11A-11F illustrate examples of resolving spatial conflicts between content elements within a three-dimensional environment with respect to a viewpoint of the user. FIGS. 16A-16C are flow diagrams of an exemplary method 16000 for resolving spatial conflicts between content elements within a three-dimensional environment with respect to a viewpoint of the user. The user interfaces in FIGS. 11A-11F are used to illustrate the processes described below, including the processes in FIGS. 16A-16C. FIGS. 17A-17M illustrate examples of example user interface elements associated with different types of contents of a volumetric application. FIG. 20 is flow diagrams of an exemplary method 20000 for displaying a user interface element with a size that is based on a distance from a viewpoint of the user and/or a distance from a respective portion of an application user interface. FIGS. 18A-18AA illustrate examples of displaying a user interface element with a size that is based on a distance from a viewpoint of the user and/or a distance from a respective portion of an application user interface. FIG. 21 is a flow diagram of an exemplary method 21000 for displaying a user interface element with a size that is based on a distance from a viewpoint of the user and/or a distance from a respective portion of an application user interface. FIGS. 19A-19N illustrate examples of orienting two-dimensional user interface elements within a three-dimensional application volume when the three-dimensional application volume is moved with respect to the three-dimensional environment. FIG. 22 is a flow diagram of an exemplary method 22000 for orienting two-dimensional user interface elements within a three-dimensional application volume when the three-dimensional application volume is moved with respect to the three-dimensional environment.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, improving privacy and/or security, providing a more varied, detailed, and/or realistic user experience while saving storage space, and/or additional techniques. These techniques also reduce power usage and improve battery life of the device by enabling the user to use the device more quickly and efficiently. Saving on battery power, and thus weight, improves the ergonomics of the device. These techniques also enable real-time communication, allow for the use of fewer and/or less precise sensors resulting in a more compact, lighter, and cheaper device, and enable the device to be used in a variety of lighting conditions. These techniques reduce energy usage, thereby reducing heat emitted by the device, which is particularly important for a wearable device where a device well within operational parameters for device components can become uncomfortable for a user to wear if it is producing too much heat.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

In some embodiments, as shown in FIG. 1A, the XR experience is provided to the user via an operating environment 100 that includes a computer system 101. The computer system 101 includes a controller 110 (e.g., processors of a portable electronic device or a remote server), a display generation component 120 (e.g., a head-mounted device (HMD), a display, a projector, a touch-screen, etc.), one or more input devices 125 (e.g., an eye tracking device 130, a hand tracking device 140, other input devices 150), one or more output devices 155 (e.g., speakers 160, tactile output generators 170, and other output devices 180), one or more sensors 190 (e.g., image sensors, light sensors, depth sensors, tactile sensors, orientation sensors, proximity sensors, temperature sensors, location sensors, motion sensors, velocity sensors, etc.), and optionally one or more peripheral devices 195 (e.g., home appliances, wearable devices, etc.). In some embodiments, one or more of the input devices 125, output devices 155, sensors 190, and peripheral devices 195 are integrated with the display generation component 120 (e.g., in a head-mounted device or a handheld device).

When describing an XR experience, various terms are used to differentially refer to several related but distinct environments that the user may sense and/or with which a user may interact (e.g., with inputs detected by a computer system 101 generating the XR experience that cause the computer system generating the XR experience to generate audio, visual, and/or tactile feedback corresponding to various inputs provided to the computer system 101). The following is a subset of these terms:

Physical environment: A physical environment refers to a physical world that people can sense and/or interact with without aid of electronic systems. Physical environments, such as a physical park, include physical articles, such as physical trees, physical buildings, and physical people. People can directly sense and/or interact with the physical environment, such as through sight, touch, hearing, taste, and smell.

Extended reality: In contrast, an extended reality (XR) environment refers to a wholly or partially simulated environment that people sense and/or interact with via an electronic system. In XR, a subset of a person's physical motions, or representations thereof, are tracked, and, in response, one or more characteristics of one or more virtual objects simulated in the XR environment are adjusted in a manner that comports with at least one law of physics. For example, an XR system may detect a person's head turning and, in response, adjust graphical content and an acoustic field presented to the person in a manner similar to how such views and sounds would change in a physical environment. In some situations (e.g., for accessibility reasons), adjustments to characteristic(s) of virtual object(s) in an XR environment may be made in response to representations of physical motions (e.g., vocal commands). A person may sense and/or interact with an XR object using any one of their senses, including sight, sound, touch, taste, and smell. For example, a person may sense and/or interact with audio objects that create a 3D or spatial audio environment that provides the perception of point audio sources in 3D space. In another example, audio objects may enable audio transparency, which selectively incorporates ambient sounds from the physical environment with or without computer-generated audio. In some XR environments, a person may sense and/or interact only with audio objects.

Examples of XR include virtual reality and mixed reality.

Virtual reality: A virtual reality (VR) environment refers to a simulated environment that is designed to be based entirely on computer-generated sensory inputs for one or more senses. A VR environment comprises a plurality of virtual objects with which a person may sense and/or interact. For example, computer-generated imagery of trees, buildings, and avatars representing people are examples of virtual objects. A person may sense and/or interact with virtual objects in the VR environment through a simulation of the person's presence within the computer-generated environment, and/or through a simulation of a subset of the person's physical movements within the computer-generated environment.

Mixed reality: In contrast to a VR environment, which is designed to be based entirely on computer-generated sensory inputs, a mixed reality (MR) environment refers to a simulated environment that is designed to incorporate sensory inputs from the physical environment, or a representation thereof, in addition to including computer-generated sensory inputs (e.g., virtual objects). On a virtuality continuum, a mixed reality environment is anywhere between, but not including, a wholly physical environment at one end and virtual reality environment at the other end. In some MR environments, computer-generated sensory inputs may respond to changes in sensory inputs from the physical environment. Also, some electronic systems for presenting an MR environment may track location and/or orientation with respect to the physical environment to enable virtual objects to interact with real objects (that is, physical articles from the physical environment or representations thereof). For example, a system may account for movements so that a virtual tree appears stationary with respect to the physical ground.

Examples of mixed realities include augmented reality and augmented virtuality.

Augmented reality: An augmented reality (AR) environment refers to a simulated environment in which one or more virtual objects are superimposed over a physical environment, or a representation thereof. For example, an electronic system for presenting an AR environment may have a transparent or translucent display through which a person may directly view the physical environment. The system may be configured to present virtual objects on the transparent or translucent display, so that a person, using the system, perceives the virtual objects superimposed over the physical environment. Alternatively, a system may have an opaque display and one or more imaging sensors that capture images or video of the physical environment, which are representations of the physical environment. The system composites the images or video with virtual objects, and presents the composition on the opaque display. A person, using the system, indirectly views the physical environment by way of the images or video of the physical environment, and perceives the virtual objects superimposed over the physical environment. As used herein, a video of the physical environment shown on an opaque display is called “pass-through video,” meaning a system uses one or more image sensor(s) to capture images of the physical environment, and uses those images in presenting the AR environment on the opaque display. Further alternatively, a system may have a projection system that projects virtual objects into the physical environment, for example, as a hologram or on a physical surface, so that a person, using the system, perceives the virtual objects superimposed over the physical environment. An augmented reality environment also refers to a simulated environment in which a representation of a physical environment is transformed by computer-generated sensory information. For example, in providing pass-through video, a system may transform one or more sensor images to impose a select perspective (e.g., viewpoint) different than the perspective captured by the imaging sensors. As another example, a representation of a physical environment may be transformed by graphically modifying (e.g., enlarging) portions thereof, such that the modified portion may be representative but not photorealistic versions of the originally captured images. As a further example, a representation of a physical environment may be transformed by graphically eliminating or obfuscating portions thereof.

Augmented virtuality: An augmented virtuality (AV) environment refers to a simulated environment in which a virtual or computer-generated environment incorporates one or more sensory inputs from the physical environment. The sensory inputs may be representations of one or more characteristics of the physical environment. For example, an AV park may have virtual trees and virtual buildings, but people with faces photorealistically reproduced from images taken of physical people. As another example, a virtual object may adopt a shape or color of a physical article imaged by one or more imaging sensors. As a further example, a virtual object may adopt shadows consistent with the position of the sun in the physical environment.

In an augmented reality, mixed reality, or virtual reality environment, a view of a three-dimensional environment is visible to a user. The view of the three-dimensional environment is typically visible to the user via one or more display generation components (e.g., a display or a pair of display modules that provide stereoscopic content to different eyes of the same user) through a virtual viewport that has a viewport boundary that defines an extent of the three-dimensional environment that is visible to the user via the one or more display generation components. In some embodiments, the region defined by the viewport boundary is smaller than a range of vision of the user in one or more dimensions (e.g., based on the range of vision of the user, size, optical properties or other physical characteristics of the one or more display generation components, and/or the location and/or orientation of the one or more display generation components relative to the eyes of the user). In some embodiments, the region defined by the viewport boundary is larger than a range of vision of the user in one or more dimensions (e.g., based on the range of vision of the user, size, optical properties or other physical characteristics of the one or more display generation components, and/or the location and/or orientation of the one or more display generation components relative to the eyes of the user). The viewport and viewport boundary typically move as the one or more display generation components move (e.g., moving with a head of the user for a head mounted device or moving with a hand of a user for a handheld device such as a tablet or smartphone). A viewpoint of a user determines what content is visible in the viewport, a viewpoint generally specfies a location and a direction relative to the three-dimensional environment, and as the viewpoint shifts, the view of the three-dimensional environment will also shift in the viewport. For a head mounted device, a viewpoint is typically based on a location and direction of the head, face, and/or eyes of a user to provide a view of the three-dimensional environment that is perceptually accurate and provides an immersive experience when the user is using the head-mounted device. For a handheld or stationed device, the viewpoint shifts as the handheld or stationed device is moved and/or as a position of a user relative to the handheld or stationed device changes (e.g., a user moving toward, away from, up, down, to the right, and/or to the left of the device). For devices that include display generation components with virtual passthrough, portions of the physical environment that are visible (e.g., displayed, and/or projected) via the one or more display generation components are based on a field of view of one or more cameras in communication with the display generation components which typically move with the display generation components (e.g., moving with a head of the user for a head mounted device or moving with a hand of a user for a handheld device such as a tablet or smartphone) because the viewpoint of the user moves as the field of view of the one or more cameras moves (and the appearance of one or more virtual objects displayed via the one or more display generation components is updated based on the viewpoint of the user (e.g., displayed positions and poses of the virtual objects are updated based on the movement of the viewpoint of the user)). For display generation components with optical passthrough, portions of the physical environment that are visible (e.g., optically visible through one or more partially or fully transparent portions of the display generation component) via the one or more display generation components are based on a field of view of a user through the partially or fully transparent portion(s) of the display generation component (e.g., moving with a head of the user for a head mounted device or moving with a hand of a user for a handheld device such as a tablet or smartphone) because the viewpoint of the user moves as the field of view of the user through the partially or fully transparent portions of the display generation components moves (and the appearance of one or more virtual objects is updated based on the viewpoint of the user).

In some embodiments a representation of a physical environment (e.g., displayed via virtual passthrough or optical passthrough) can be partially or fully obscured by a virtual environment. In some embodiments, the amount of virtual environment that is displayed (e.g., the amount of physical environment that is not displayed) is based on an immersion level for the virtual environment (e.g., with respect to the representation of the physical environment). For example, increasing the immersion level optionally causes more of the virtual environment to be displayed, replacing and/or obscuring more of the physical environment, and reducing the immersion level optionally causes less of the virtual environment to be displayed, revealing portions of the physical environment that were previously not displayed and/or obscured. In some embodiments, at a particular immersion level, one or more first background objects (e.g., in the representation of the physical environment) are visually de-emphasized (e.g., dimmed, blurred, and/or displayed with increased transparency) more than one or more second background objects, and one or more third background objects cease to be displayed. In some embodiments, a level of immersion includes an associated degree to which the virtual content displayed by the computer system (e.g., the virtual environment and/or the virtual content) obscures background content (e.g., content other than the virtual environment and/or the virtual content) around/behind the virtual content, optionally including the number of items of background content displayed and/or the visual characteristics (e.g., colors, contrast, and/or opacity) with which the background content is displayed, the angular range of the virtual content displayed via the display generation component (e.g., 60 degrees of content displayed at low immersion, 120 degrees of content displayed at medium immersion, or 180 degrees of content displayed at high immersion), and/or the proportion of the field of view displayed via the display generation component that is consumed by the virtual content (e.g., 33% of the field of view consumed by the virtual content at low immersion, 66% of the field of view consumed by the virtual content at medium immersion, or 100% of the field of view consumed by the virtual content at high immersion). In some embodiments, the background content is included in a background over which the virtual content is displayed (e.g., background content in the representation of the physical environment). In some embodiments, the background content includes user interfaces (e.g., user interfaces generated by the computer system corresponding to applications), virtual objects (e.g., files or representations of other users generated by the computer system) not associated with or included in the virtual environment and/or virtual content, and/or real objects (e.g., pass-through objects representing real objects in the physical environment around the user that are visible such that they are displayed via the display generation component and/or a visible via a transparent or translucent component of the display generation component because the computer system does not obscure/prevent visibility of them through the display generation component). In some embodiments, at a low level of immersion (e.g., a first level of immersion), the background, virtual and/or real objects are displayed in an unobscured manner. For example, a virtual environment with a low level of immersion is optionally displayed concurrently with the background content, which is optionally displayed with full brightness, color, and/or translucency. In some embodiments, at a higher level of immersion (e.g., a second level of immersion higher than the first level of immersion), the background, virtual and/or real objects are displayed in an obscured manner (e.g., dimmed, blurred, or removed from display). For example, a respective virtual environment with a high level of immersion is displayed without concurrently displaying the background content (e.g., in a full screen or fully immersive mode). As another example, a virtual environment displayed with a medium level of immersion is displayed concurrently with darkened, blurred, or otherwise de-emphasized background content. In some embodiments, the visual characteristics of the background objects vary among the background objects. For example, at a particular immersion level, one or more first background objects are visually de-emphasized (e.g., dimmed, blurred, and/or displayed with increased transparency) more than one or more second background objects, and one or more third background objects cease to be displayed. In some embodiments, a null or zero level of immersion corresponds to the virtual environment ceasing to be displayed and instead a representation of a physical environment is displayed (optionally with one or more virtual objects such as application, windows, or virtual three-dimensional objects) without the representation of the physical environment being obscured by the virtual environment. Adjusting the level of immersion using a physical input element provides for quick and efficient method of adjusting immersion, which enhances the operability of the computer system and makes the user-device interface more efficient.

Viewpoint-locked virtual object: A virtual object is viewpoint-locked when a computer system displays the virtual object at the same location and/or position in the viewpoint of the user, even as the viewpoint of the user shifts (e.g., changes). In embodiments where the computer system is a head-mounted device, the viewpoint of the user is locked to the forward facing direction of the user's head (e.g., the viewpoint of the user is at least a portion of the field-of-view of the user when the user is looking straight ahead); thus, the viewpoint of the user remains fixed even as the user's gaze is shifted, without moving the user's head. In embodiments where the computer system has a display generation component (e.g., a display screen) that can be repositioned with respect to the user's head, the viewpoint of the user is the augmented reality view that is being presented to the user on a display generation component of the computer system. For example, a viewpoint-locked virtual object that is displayed in the upper left corner of the viewpoint of the user, when the viewpoint of the user is in a first orientation (e.g., with the user's head facing north) continues to be displayed in the upper left corner of the viewpoint of the user, even as the viewpoint of the user changes to a second orientation (e.g., with the user's head facing west). In other words, the location and/or position at which the viewpoint-locked virtual object is displayed in the viewpoint of the user is independent of the user's position and/or orientation in the physical environment. In embodiments in which the computer system is a head-mounted device, the viewpoint of the user is locked to the orientation of the user's head, such that the virtual object is also referred to as a “head-locked virtual object.”

Environment-locked virtual object: A virtual object is environment-locked (alternatively, “world-locked”) when a computer system displays the virtual object at a location and/or position in the viewpoint of the user that is based on (e.g., selected in reference to and/or anchored to) a location and/or object in the three-dimensional environment (e.g., a physical environment or a virtual environment). As the viewpoint of the user shifts, the location and/or object in the environment relative to the viewpoint of the user changes, which results in the environment-locked virtual object being displayed at a different location and/or position in the viewpoint of the user. For example, an environment-locked virtual object that is locked onto a tree that is immediately in front of a user is displayed at the center of the viewpoint of the user. When the viewpoint of the user shifts to the right (e.g., the user's head is turned to the right) so that the tree is now left-of-center in the viewpoint of the user (e.g., the tree's position in the viewpoint of the user shifts), the environment-locked virtual object that is locked onto the tree is displayed left-of-center in the viewpoint of the user. In other words, the location and/or position at which the environment-locked virtual object is displayed in the viewpoint of the user is dependent on the position and/or orientation of the location and/or object in the environment onto which the virtual object is locked. In some embodiments, the computer system uses a stationary frame of reference (e.g., a coordinate system that is anchored to a fixed location and/or object in the physical environment) in order to determine the position at which to display an environment-locked virtual object in the viewpoint of the user. An environment-locked virtual object can be locked to a stationary part of the environment (e.g., a floor, wall, table, or other stationary object) or can be locked to a moveable part of the environment (e.g., a vehicle, animal, person, or even a representation of portion of the users body that moves independently of a viewpoint of the user, such as a user's hand, wrist, arm, or foot) so that the virtual object is moved as the viewpoint or the portion of the environment moves to maintain a fixed relationship between the virtual object and the portion of the environment.

In some embodiments a virtual object that is environment-locked or viewpoint-locked exhibits lazy follow behavior which reduces or delays motion of the environment-locked or viewpoint-locked virtual object relative to movement of a point of reference which the virtual object is following. In some embodiments, when exhibiting lazy follow behavior the computer system intentionally delays movement of the virtual object when detecting movement of a point of reference (e.g., a portion of the environment, the viewpoint, or a point that is fixed relative to the viewpoint, such as a point that is between 5-300 cm from the viewpoint) which the virtual object is following. For example, when the point of reference (e.g., the portion of the environment or the viewpoint) moves with a first speed, the virtual object is moved by the device to remain locked to the point of reference but moves with a second speed that is slower than the first speed (e.g., until the point of reference stops moving or slows down, at which point the virtual object starts to catch up to the point of reference). In some embodiments, when a virtual object exhibits lazy follow behavior the device ignores small amounts of movement of the point of reference (e.g., ignoring movement of the point of reference that is below a threshold amount of movement such as movement by 0-5 degrees or movement by 0-50 cm). For example, when the point of reference (e.g., the portion of the environment or the viewpoint to which the virtual object is locked) moves by a first amount, a distance between the point of reference and the virtual object increases (e.g., because the virtual object is being displayed so as to maintain a fixed or substantially fixed position relative to a viewpoint or portion of the environment that is different from the point of reference to which the virtual object is locked) and when the point of reference (e.g., the portion of the environment or the viewpoint to which the virtual object is locked) moves by a second amount that is greater than the first amount, a distance between the point of reference and the virtual object initially increases (e.g., because the virtual object is being displayed so as to maintain a fixed or substantially fixed position relative to a viewpoint or portion of the environment that is different from the point of reference to which the virtual object is locked) and then decreases as the amount of movement of the point of reference increases above a threshold (e.g., a “lazy follow” threshold) because the virtual object is moved by the computer system to maintain a fixed or substantially fixed position relative to the point of reference. In some embodiments the virtual object maintaining a substantially fixed position relative to the point of reference includes the virtual object being displayed within a threshold distance (e.g., 1, 2, 3, 5, 15, 20, 50 cm) of the point of reference in one or more dimensions (e.g., up/down, left/right, and/or forward/backward relative to the position of the point of reference).

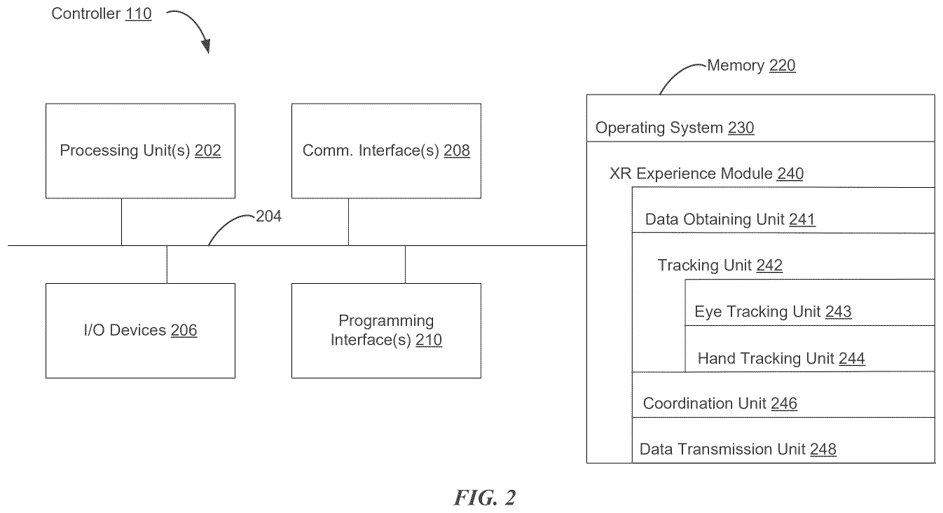

Hardware: There are many different types of electronic systems that enable a person to sense and/or interact with various XR environments. Examples include head-mounted systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head-mounted system may have one or more speaker(s) and an integrated opaque display. Alternatively, a head-mounted system may be configured to accept an external opaque display (e.g., a smartphone). The head-mounted system may incorporate one or more imaging sensors to capture images or video of the physical environment, and/or one or more microphones to capture audio of the physical environment. Rather than an opaque display, a head-mounted system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface. In some embodiments, the controller 110 is configured to manage and coordinate an XR experience for the user. In some embodiments, the controller 110 includes a suitable combination of software, firmware, and/or hardware. The controller 110 is described in greater detail below with respect to FIG. 2. In some embodiments, the controller 110 is a computing device that is local or remote relative to the scene 105 (e.g., a physical environment). For example, the controller 110 is a local server located within the scene 105. In another example, the controller 110 is a remote server located outside of the scene 105 (e.g., a cloud server, central server, etc.). In some embodiments, the controller 110 is communicatively coupled with the display generation component 120 (e.g., an HMD, a display, a projector, a touch-screen, etc.) via one or more wired or wireless communication channels 144 (e.g., BLUETOOTH, IEEE 802.11x, IEEE 802.16x, IEEE 802.3x, etc.). In another example, the controller 110 is included within the enclosure (e.g., a physical housing) of the display generation component 120 (e.g., an HMD, or a portable electronic device that includes a display and one or more processors, etc.), one or more of the input devices 125, one or more of the output devices 155, one or more of the sensors 190, and/or one or more of the peripheral devices 195, or share the same physical enclosure or support structure with one or more of the above.

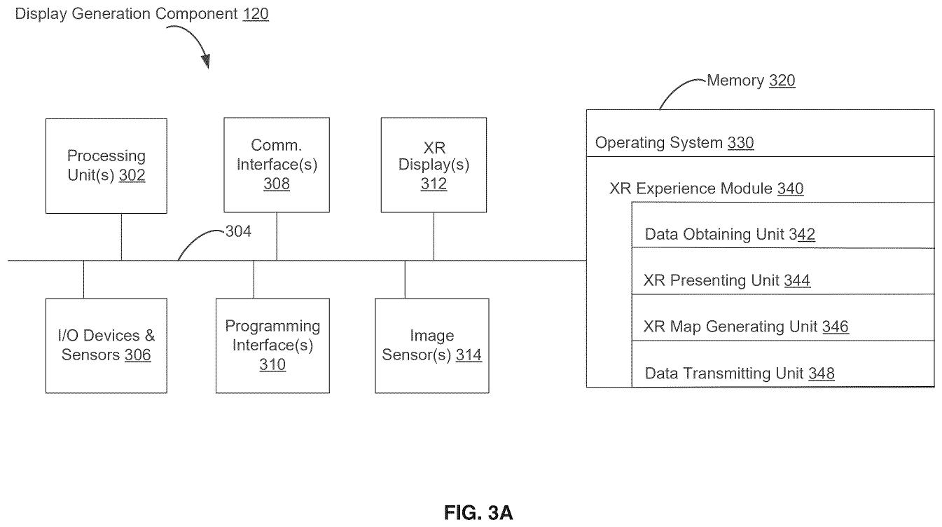

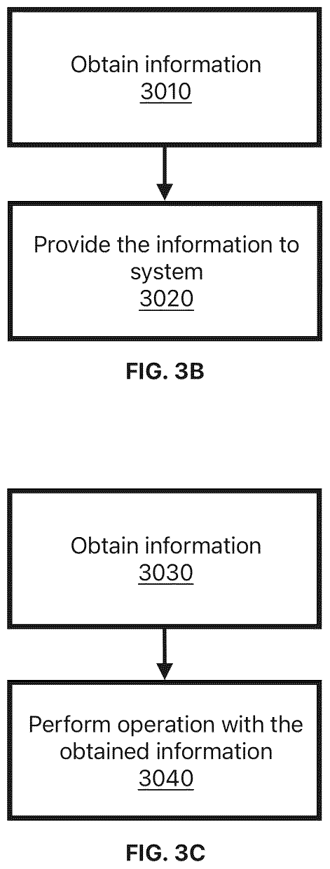

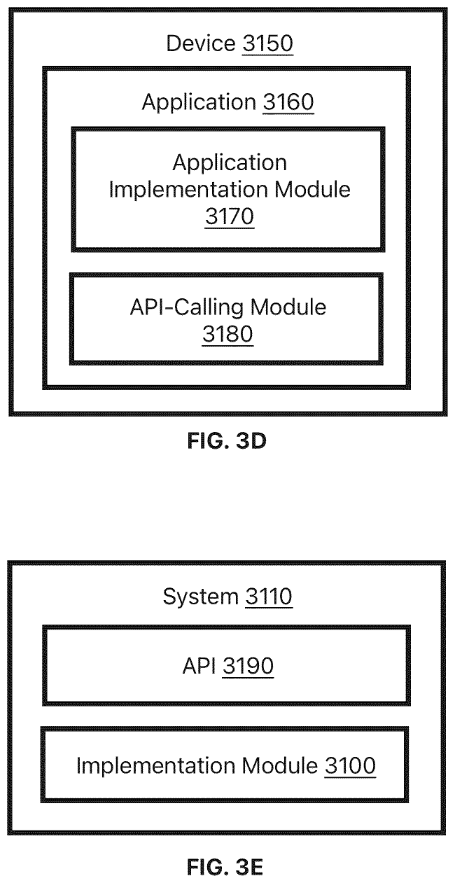

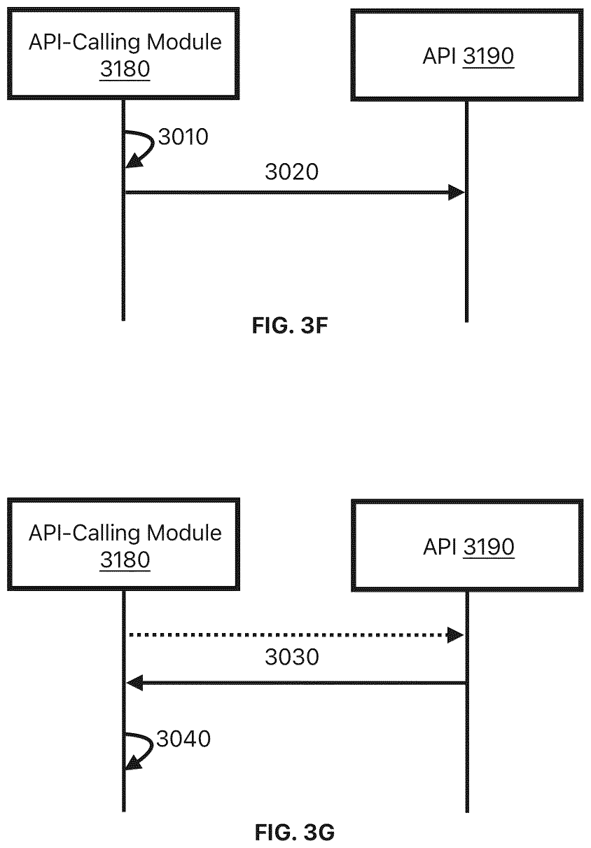

In some embodiments, the display generation component 120 is configured to provide the XR experience (e.g., at least a visual component of the XR experience) to the user. In some embodiments, the display generation component 120 includes a suitable combination of software, firmware, and/or hardware. The display generation component 120 is described in greater detail below with respect to FIG. 3A. In some embodiments, the functionalities of the controller 110 are provided by and/or combined with the display generation component 120.

According to some embodiments, the display generation component 120 provides an XR experience to the user while the user is virtually and/or physically present within the scene 105.

In some embodiments, the display generation component is worn on a part of the user's body (e.g., on his/her head, on his/her hand, etc.). As such, the display generation component 120 includes one or more XR displays provided to display the XR content. For example, in various embodiments, the display generation component 120 encloses the field-of-view of the user. In some embodiments, the display generation component 120 is a handheld device (such as a smartphone or tablet) configured to present XR content, and the user holds the device with a display directed towards the field-of-view of the user and a camera directed towards the scene 105. In some embodiments, the handheld device is optionally placed within an enclosure that is worn on the head of the user. In some embodiments, the handheld device is optionally placed on a support (e.g., a tripod) in front of the user. In some embodiments, the display generation component 120 is an XR chamber, enclosure, or room configured to present XR content in which the user does not wear or hold the display generation component 120. Many user interfaces described with reference to one type of hardware for displaying XR content (e.g., a handheld device or a device on a tripod) could be implemented on another type of hardware for displaying XR content (e.g., an HMD or other wearable computing device). For example, a user interface showing interactions with XR content triggered based on interactions that happen in a space in front of a handheld or tripod mounted device could similarly be implemented with an HMD where the interactions happen in a space in front of the HMD and the responses of the XR content are displayed via the HMD. Similarly, a user interface showing interactions with XR content triggered based on movement of a handheld or tripod mounted device relative to the physical environment (e.g., the scene 105 or a part of the user's body (e.g., the user's eye(s), head, or hand)) could similarly be implemented with an HMD where the movement is caused by movement of the HMD relative to the physical environment (e.g., the scene 105 or a part of the user's body (e.g., the user's eye(s), head, or hand)).

While pertinent features of the operating environment 100 are shown in FIG. 1A, those of ordinary skill in the art will appreciate from the present disclosure that various other features have not been illustrated for the sake of brevity and so as not to obscure more pertinent aspects of the example embodiments disclosed herein.

FIGS. 1A-1P illustrate various examples of a computer system that is used to perform the methods and provide audio, visual and/or haptic feedback as part of user interfaces described herein. In some embodiments, the computer system includes one or more display generation components (e.g., first and second display assemblies 1-120a, 1-120b and/or first and second optical modules 11.1.1-104a and 11.1.1-104b) for displaying virtual elements and/or a representation of a physical environment to a user of the computer system, optionally generated based on detected events and/or user inputs detected by the computer system. User interfaces generated by the computer system are optionally corrected by one or more corrective lenses 11.3.2-216 that are optionally removably attached to one or more of the optical modules to enable the user interfaces to be more easily viewed by users who would otherwise use glasses or contacts to correct their vision. While many user interfaces illustrated herein show a single view of a user interface, user interfaces in a HMD are optionally displayed using two optical modules (e.g., first and second display assemblies 1-120a, 1-120b and/or first and second optical modules 11.1.1-104a and 11.1.1-104b), one for a user's right eye and a different one for a user's left eye, and slightly different images are presented to the two different eyes to generate the illusion of stereoscopic depth, the single view of the user interface would typically be either a right-eye or left-eye view and the depth effect is explained in the text or using other schematic charts or views. In some embodiments, the computer system includes one or more external displays (e.g., display assembly 1-108) for displaying status information for the computer system to the user of the computer system (when the computer system is not being worn) and/or to other people who are near the computer system, optionally generated based on detected events and/or user inputs detected by the computer system. In some embodiments, the computer system includes one or more audio output components (e.g., electronic component 1-112) for generating audio feedback, optionally generated based on detected events and/or user inputs detected by the computer system. In some embodiments, the computer system includes one or more input devices for detecting input such as one or more sensors (e.g., one or more sensors in sensor assembly 1-356, and/or FIG. 1I) for detecting information about a physical environment of the device which can be used (optionally in conjunction with one or more illuminators such as the illuminators described in FIG. 1I) to generate a digital passthrough image, capture visual media corresponding to the physical environment (e.g., photos and/or video), or determine a pose (e.g., position and/or orientation) of physical objects and/or surfaces in the physical environment so that virtual objects ban be placed based on a detected pose of physical objects and/or surfaces. In some embodiments, the computer system includes one or more input devices for detecting input such as one or more sensors for detecting hand position and/or movement (e.g., one or more sensors in sensor assembly 1-356, and/or FIG. 1I) that can be used (optionally in conjunction with one or more illuminators such as the illuminators 6-124 described in FIG. 1I) to determine when one or more air gestures have been performed. In some embodiments, the computer system includes one or more input devices for detecting input such as one or more sensors for detecting eye movement (e.g., eye tracking and gaze tracking sensors in FIG. 1I) which can be used (optionally in conjunction with one or more lights such as lights 11.3.2-110 in FIG. 1O) to determine attention or gaze position and/or gaze movement which can optionally be used to detect gaze-only inputs based on gaze movement and/or dwell. A combination of the various sensors described above can be used to determine user facial expressions and/or hand movements for use in generating an avatar or representation of the user such as an anthropomorphic avatar or representation for use in a real-time communication session where the avatar has facial expressions, hand movements, and/or body movements that are based on or similar to detected facial expressions, hand movements, and/or body movements of a user of the device. Gaze and/or attention information is, optionally, combined with hand tracking information to determine interactions between the user and one or more user interfaces based on direct and/or indirect inputs such as air gestures or inputs that use one or more hardware input devices such as one or more buttons (e.g., first button 1-128, button 11.1.1-114, second button 1-132, and or dial or button 1-328), knobs (e.g., first button 1-128, button 11.1.1-114, and/or dial or button 1-328), digital crowns (e.g., first button 1-128 which is depressible and twistable or rotatable, button 11.1.1-114, and/or dial or button 1-328), trackpads, touch screens, keyboards, mice and/or other input devices. One or more buttons (e.g., first button 1-128, button 11.1.1-114, second button 1-132, and or dial or button 1-328) are optionally used to perform system operations such as recentering content in three-dimensional environment that is visible to a user of the device, displaying a home user interface for launching applications, starting real-time communication sessions, or initiating display of virtual three-dimensional backgrounds. Knobs or digital crowns (e.g., first button 1-128 which is depressible and twistable or rotatable, button 11.1.1-114, and/or dial or button 1-328) are optionally rotatable to adjust parameters of the visual content such as a level of immersion of a virtual three-dimensional environment (e.g., a degree to which virtual-content occupies the viewport of the user into the three-dimensional environment) or other parameters associated with the three-dimensional environment and the virtual content that is displayed via the optical modules (e.g., first and second display assemblies 1-120a, 1-120b and/or first and second optical modules 11.1.1-104a and 11.1.1-104b).

FIG. 1B illustrates a front, top, perspective view of an example of a head-mountable display (HMD) device 1-100 configured to be donned by a user and provide virtual and altered/mixed reality (VR/AR) experiences. The HMD 1-100 can include a display unit 1-102 or assembly, an electronic strap assembly 1-104 connected to and extending from the display unit 1-102, and a band assembly 1-106 secured at either end to the electronic strap assembly 1-104. The electronic strap assembly 1-104 and the band 1-106 can be part of a retention assembly configured to wrap around a user's head to hold the display unit 1-102 against the face of the user.

In at least one example, the band assembly 1-106 can include a first band 1-116 configured to wrap around the rear side of a user's head and a second band 1-117 configured to extend over the top of a user's head. The second strap can extend between first and second electronic straps 1-105a, 1-105b of the electronic strap assembly 1-104 as shown. The strap assembly 1-104 and the band assembly 1-106 can be part of a securement mechanism extending rearward from the display unit 1-102 and configured to hold the display unit 1-102 against a face of a user.

In at least one example, the securement mechanism includes a first electronic strap 1-105a including a first proximal end 1-134 coupled to the display unit 1-102, for example a housing 1-150 of the display unit 1-102, and a first distal end 1-136 opposite the first proximal end 1-134. The securement mechanism can also include a second electronic strap 1-105b including a second proximal end 1-138 coupled to the housing 1-150 of the display unit 1-102 and a second distal end 1-140 opposite the second proximal end 1-138. The securement mechanism can also include the first band 1-116 including a first end 1-142 coupled to the first distal end 1-136 and a second end 1-144 coupled to the second distal end 1-140 and the second band 1-117 extending between the first electronic strap 1-105a and the second electronic strap 1-105b. The straps 1-105a-b and band 1-116 can be coupled via connection mechanisms or assemblies 1-114. In at least one example, the second band 1-117 includes a first end 1-146 coupled to the first electronic strap 1-105a between the first proximal end 1-134 and the first distal end 1-136 and a second end 1-148 coupled to the second electronic strap 1-105b between the second proximal end 1-138 and the second distal end 1-140.

In at least one example, the first and second electronic straps 1-105a-b include plastic, metal, or other structural materials forming the shape the substantially rigid straps 1-105a-b. In at least one example, the first and second bands 1-116, 1-117 are formed of elastic, flexible materials including woven textiles, rubbers, and the like. The first and second bands 1-116, 1-117 can be flexible to conform to the shape of the user' head when donning the HMD 1-100.

In at least one example, one or more of the first and second electronic straps 1-105a-b can define internal strap volumes and include one or more electronic components disposed in the internal strap volumes. In one example, as shown in FIG. 1B, the first electronic strap 1-105a can include an electronic component 1-112. In one example, the electronic component 1-112 can include a speaker. In one example, the electronic component 1-112 can include a computing component such as a processor.

In at least one example, the housing 1-150 defines a first, front-facing opening 1-152. The front-facing opening is labeled in dotted lines at 1-152 in FIG. 1B because the display assembly 1-108 is disposed to occlude the first opening 1-152 from view when the HMD 1-100 is assembled. The housing 1-150 can also define a rear-facing second opening 1-154. The housing 1-150 also defines an internal volume between the first and second openings 1-152, 1-154. In at least one example, the HMD 1-100 includes the display assembly 1-108, which can include a front cover and display screen (shown in other figures) disposed in or across the front opening 1-152 to occlude the front opening 1-152. In at least one example, the display screen of the display assembly 1-108, as well as the display assembly 1-108 in general, has a curvature configured to follow the curvature of a user's face. The display screen of the display assembly 1-108 can be curved as shown to compliment the user's facial features and general curvature from one side of the face to the other, for example from left to right and/or from top to bottom where the display unit 1-102 is pressed.

In at least one example, the housing 1-150 can define a first aperture 1-126 between the first and second openings 1-152, 1-154 and a second aperture 1-130 between the first and second openings 1-152, 1-154. The HMD 1-100 can also include a first button 1-128 disposed in the first aperture 1-126 and a second button 1-132 disposed in the second aperture 1-130. The first and second buttons 1-128, 1-132 can be depressible through the respective apertures 1-126, 1-130. In at least one example, the first button 1-126 and/or second button 1-132 can be twistable dials as well as depressible buttons. In at least one example, the first button 1-128 is a depressible and twistable dial button and the second button 1-132 is a depressible button.

FIG. 1C illustrates a rear, perspective view of the HMD 1-100. The HMD 1-100 can include a light seal 1-110 extending rearward from the housing 1-150 of the display assembly 1-108 around a perimeter of the housing 1-150 as shown. The light seal 1-110 can be configured to extend from the housing 1-150 to the user's face around the user's eyes to block external light from being visible. In one example, the HMD 1-100 can include first and second display assemblies 1-120a, 1-120b disposed at or in the rearward facing second opening 1-154 defined by the housing 1-150 and/or disposed in the internal volume of the housing 1-150 and configured to project light through the second opening 1-154. In at least one example, each display assembly 1-120a-b can include respective display screens 1-122a, 1-122b configured to project light in a rearward direction through the second opening 1-154 toward the user's eyes.

In at least one example, referring to both FIGS. 1B and 1C, the display assembly 1-108 can be a front-facing, forward display assembly including a display screen configured to project light in a first, forward direction and the rear facing display screens 1-122a-b can be configured to project light in a second, rearward direction opposite the first direction. As noted above, the light seal 1-110 can be configured to block light external to the HMD 1-100 from reaching the user's eyes, including light projected by the forward facing display screen of the display assembly 1-108 shown in the front perspective view of FIG. 1B. In at least one example, the HMD 1-100 can also include a curtain 1-124 occluding the second opening 1-154 between the housing 1-150 and the rear-facing display assemblies 1-120a-b. In at least one example, the curtain 1-124 can be elastic or at least partially elastic.

Any of the features, components, and/or parts, including the arrangements and configurations thereof shown in FIGS. 1B and 1C can be included, either alone or in any combination, in any of the other examples of devices, features, components, and parts shown in FIGS. 1D-1F and described herein. Likewise, any of the features, components, and/or parts, including the arrangements and configurations thereof shown and described with reference to FIGS. 1D-1F can be included, either alone or in any combination, in the example of the devices, features, components, and parts shown in FIGS. 1B and 1C.

FIG. 1D illustrates an exploded view of an example of an HMD 1-200 including various portions or parts thereof separated according to the modularity and selective coupling of those parts. For example, the HMD 1-200 can include a band 1-216 which can be selectively coupled to first and second electronic straps 1-205a, 1-205b. The first securement strap 1-205a can include a first electronic component 1-212a and the second securement strap 1-205b can include a second electronic component 1-212b. In at least one example, the first and second straps 1-205a-b can be removably coupled to the display unit 1-202.

In addition, the HMD 1-200 can include a light seal 1-210 configured to be removably coupled to the display unit 1-202. The HMD 1-200 can also include lenses 1-218 which can be removably coupled to the display unit 1-202, for example over first and second display assemblies including display screens. The lenses 1-218 can include customized prescription lenses configured for corrective vision. As noted, each part shown in the exploded view of FIG. 1D and described above can be removably coupled, attached, re-attached, and changed out to update parts or swap out parts for different users. For example, bands such as the band 1-216, light seals such as the light seal 1-210, lenses such as the lenses 1-218, and electronic straps such as the straps 1-205a-b can be swapped out depending on the user such that these parts are customized to fit and correspond to the individual user of the HMD 1-200.

Any of the features, components, and/or parts, including the arrangements and configurations thereof shown in FIG. 1D can be included, either alone or in any combination, in any of the other examples of devices, features, components, and parts shown in FIGS. 1B, 1C, and 1E-1F and described herein. Likewise, any of the features, components, and/or parts, including the arrangements and configurations thereof shown and described with reference to FIGS. 1B, 1C, and 1E-1F can be included, either alone or in any combination, in the example of the devices, features, components, and parts shown in FIG. 1D.

FIG. 1E illustrates an exploded view of an example of a display unit 1-306 of a HMD. The display unit 1-306 can include a front display assembly 1-308, a frame/housing assembly 1-350, and a curtain assembly 1-324. The display unit 1-306 can also include a sensor assembly 1-356, logic board assembly 1-358, and cooling assembly 1-360 disposed between the frame assembly 1-350 and the front display assembly 1-308. In at least one example, the display unit 1-306 can also include a rear-facing display assembly 1-320 including first and second rear-facing display screens 1-322a, 1-322b disposed between the frame 1-350 and the curtain assembly 1-324.

In at least one example, the display unit 1-306 can also include a motor assembly 1-362 configured as an adjustment mechanism for adjusting the positions of the display screens 1-322a-b of the display assembly 1-320 relative to the frame 1-350. In at least one example, the display assembly 1-320 is mechanically coupled to the motor assembly 1-362, with at least one motor for each display screen 1-322a-b, such that the motors can translate the display screens 1-322a-b to match an interpupillary distance of the user's eyes.

In at least one example, the display unit 1-306 can include a dial or button 1-328 depressible relative to the frame 1-350 and accessible to the user outside the frame 1-350. The button 1-328 can be electronically connected to the motor assembly 1-362 via a controller such that the button 1-328 can be manipulated by the user to cause the motors of the motor assembly 1-362 to adjust the positions of the display screens 1-322a-b.

Any of the features, components, and/or parts, including the arrangements and configurations thereof shown in FIG. 1E can be included, either alone or in any combination, in any of the other examples of devices, features, components, and parts shown in FIGS. 1B-1D and 1F and described herein. Likewise, any of the features, components, and/or parts, including the arrangements and configurations thereof shown and described with reference to FIGS. 1B-1D and 1F can be included, either alone or in any combination, in the example of the devices, features, components, and parts shown in FIG. 1E.

FIG. 1F illustrates an exploded view of another example of a display unit 1-406 of a HMD device similar to other HMD devices described herein. The display unit 1-406 can include a front display assembly 1-402, a sensor assembly 1-456, a logic board assembly 1-458, a cooling assembly 1-460, a frame assembly 1-450, a rear-facing display assembly 1-421, and a curtain assembly 1-424. The display unit 1-406 can also include a motor assembly 1-462 for adjusting the positions of first and second display sub-assemblies 1-420a, 1-420b of the rear-facing display assembly 1-421, including first and second respective display screens for interpupillary adjustments, as described above.

The various parts, systems, and assemblies shown in the exploded view of FIG. 1F are described in greater detail herein with reference to FIGS. 1B-1E as well as subsequent figures referenced in the present disclosure. The display unit 1-406 shown in FIG. 1F can be assembled and integrated with the securement mechanisms shown in FIGS. 1B-1E, including the electronic straps, bands, and other components including light seals, connection assemblies, and so forth.

Any of the features, components, and/or parts, including the arrangements and configurations thereof shown in FIG. 1F can be included, either alone or in any combination, in any of the other examples of devices, features, components, and parts shown in FIGS. 1B-1E and described herein. Likewise, any of the features, components, and/or parts, including the arrangements and configurations thereof shown and described with reference to FIGS. 1B-1E can be included, either alone or in any combination, in the example of the devices, features, components, and parts shown in FIG. 1F.

FIG. 1G illustrates a perspective, exploded view of a front cover assembly 3-100 of an HMD device described herein, for example the front cover assembly 3-1 of the HMD 3-100 shown in FIG. 1G or any other HMD device shown and described herein. The front cover assembly 3-100 shown in FIG. 1G can include a transparent or semi-transparent cover 3-102, shroud 3-104 (or “canopy”), adhesive layers 3-106, display assembly 3-108 including a lenticular lens panel or array 3-110, and a structural trim 3-112. The adhesive layer 3-106 can secure the shroud 3-104 and/or transparent cover 3-102 to the display assembly 3-108 and/or the trim 3-112. The trim 3-112 can secure the various components of the front cover assembly 3-100 to a frame or chassis of the HMD device.

In at least one example, as shown in FIG. 1G, the transparent cover 3-102, shroud 3-104, and display assembly 3-108, including the lenticular lens array 3-110, can be curved to accommodate the curvature of a user's face. The transparent cover 3-102 and the shroud 3-104 can be curved in two or three dimensions, e.g., vertically curved in the Z-direction in and out of the Z-X plane and horizontally curved in the X-direction in and out of the Z-X plane. In at least one example, the display assembly 3-108 can include the lenticular lens array 3-110 as well as a display panel having pixels configured to project light through the shroud 3-104 and the transparent cover 3-102. The display assembly 3-108 can be curved in at least one direction, for example the horizontal direction, to accommodate the curvature of a user's face from one side (e.g., left side) of the face to the other (e.g., right side). In at least one example, each layer or component of the display assembly 3-108, which will be shown in subsequent figures and described in more detail, but which can include the lenticular lens array 3-110 and a display layer, can be similarly or concentrically curved in the horizontal direction to accommodate the curvature of the user's face.

In at least one example, the shroud 3-104 can include a transparent or semi-transparent material through which the display assembly 3-108 projects light. In one example, the shroud 3-104 can include one or more opaque portions, for example opaque ink-printed portions or other opaque film portions on the rear surface of the shroud 3-104. The rear surface can be the surface of the shroud 3-104 facing the user's eyes when the HMD device is donned. In at least one example, opaque portions can be on the front surface of the shroud 3-104 opposite the rear surface. In at least one example, the opaque portion or portions of the shroud 3-104 can include perimeter portions visually hiding any components around an outside perimeter of the display screen of the display assembly 3-108. In this way, the opaque portions of the shroud hide any other components, including electronic components, structural components, and so forth, of the HMD device that would otherwise be visible through the transparent or semi-transparent cover 3-102 and/or shroud 3-104.

In at least one example, the shroud 3-104 can define one or more apertures transparent portions 3-120 through which sensors can send and receive signals. In one example, the portions 3-120 are apertures through which the sensors can extend or send and receive signals. In one example, the portions 3-120 are transparent portions, or portions more transparent than surrounding semi-transparent or opaque portions of the shroud, through which sensors can send and receive signals through the shroud and through the transparent cover 3-102. In one example, the sensors can include cameras, IR sensors, LUX sensors, or any other visual or non-visual environmental sensors of the HMD device.

Any of the features, components, and/or parts, including the arrangements and configurations thereof shown in FIG. 1G can be included, either alone or in any combination, in any of the other examples of devices, features, components, and parts described herein. Likewise, any of the features, components, and/or parts, including the arrangements and configurations thereof shown and described herein can be included, either alone or in any combination, in the example of the devices, features, components, and parts shown in FIG. 1G.

FIG. 1H illustrates an exploded view of an example of an HMD device 6-100. The HMD device 6-100 can include a sensor array or system 6-102 including one or more sensors, cameras, projectors, and so forth mounted to one or more components of the HMD 6-100. In at least one example, the sensor system 6-102 can include a bracket 1-338 on which one or more sensors of the sensor system 6-102 can be fixed/secured.

FIG. 1I illustrates a portion of an HMD device 6-100 including a front transparent cover 6-104 and a sensor system 6-102. The sensor system 6-102 can include a number of different sensors, emitters, receivers, including cameras, IR sensors, projectors, and so forth. The transparent cover 6-104 is illustrated in front of the sensor system 6-102 to illustrate relative positions of the various sensors and emitters as well as the orientation of each sensor/emitter of the system 6-102. As referenced herein, “sideways,” “side,” “lateral,” “horizontal,” and other similar terms refer to orientations or directions as indicated by the X-axis shown in FIG. 1J. Terms such as “vertical,” “up,” “down,” and similar terms refer to orientations or directions as indicated by the Z-axis shown in FIG. 1J. Terms such as “frontward,” “rearward,” “forward,” backward,” and similar terms refer to orientations or directions as indicated by the Y-axis shown in FIG. 1J.

In at least one example, the transparent cover 6-104 can define a front, external surface of the HMD device 6-100 and the sensor system 6-102, including the various sensors and components thereof, can be disposed behind the cover 6-104 in the Y-axis/direction. The cover 6-104 can be transparent or semi-transparent to allow light to pass through the cover 6-104, both light detected by the sensor system 6-102 and light emitted thereby.

As noted elsewhere herein, the HMD device 6-100 can include one or more controllers including processors for electrically coupling the various sensors and emitters of the sensor system 6-102 with one or more mother boards, processing units, and other electronic devices such as display screens and the like. In addition, as will be shown in more detail below with reference to other figures, the various sensors, emitters, and other components of the sensor system 6-102 can be coupled to various structural frame members, brackets, and so forth of the HMD device 6-100 not shown in FIG. 1I. FIG. 1I shows the components of the sensor system 6-102 unattached and un-coupled electrically from other components for the sake of illustrative clarity.

In at least one example, the device can include one or more controllers having processors configured to execute instructions stored on memory components electrically coupled to the processors. The instructions can include, or cause the processor to execute, one or more algorithms for self-correcting angles and positions of the various cameras described herein overtime with use as the initial positions, angles, or orientations of the cameras get bumped or deformed due to unintended drop events or other events.

In at least one example, the sensor system 6-102 can include one or more scene cameras 6-106. The system 6-102 can include two scene cameras 6-102 disposed on either side of the nasal bridge or arch of the HMD device 6-100 such that each of the two cameras 6-106 correspond generally in position with left and right eyes of the user behind the cover 6-103. In at least one example, the scene cameras 6-106 are oriented generally forward in the Y-direction to capture images in front of the user during use of the HMD 6-100. In at least one example, the scene cameras are color cameras and provide images and content for MR video pass through to the display screens facing the user's eyes when using the HMD device 6-100. The scene cameras 6-106 can also be used for environment and object reconstruction.

In at least one example, the sensor system 6-102 can include a first depth sensor 6-108 pointed generally forward in the Y-direction. In at least one example, the first depth sensor 6-108 can be used for environment and object reconstruction as well as user hand and body tracking. In at least one example, the sensor system 6-102 can include a second depth sensor 6-110 disposed centrally along the width (e.g., along the X-axis) of the HMD device 6-100. For example, the second depth sensor 6-110 can be disposed above the central nasal bridge or accommodating features over the nose of the user when donning the HMD 6-100. In at least one example, the second depth sensor 6-110 can be used for environment and object reconstruction as well as hand and body tracking. In at least one example, the second depth sensor can include a LIDAR sensor.

In at least one example, the sensor system 6-102 can include a depth projector 6-112 facing generally forward to project electromagnetic waves, for example in the form of a predetermined pattern of light dots, out into and within a field of view of the user and/or the scene cameras 6-106 or a field of view including and beyond the field of view of the user and/or scene cameras 6-106. In at least one example, the depth projector can project electromagnetic waves of light in the form of a dotted light pattern to be reflected off objects and back into the depth sensors noted above, including the depth sensors 6-108, 6-110. In at least one example, the depth projector 6-112 can be used for environment and object reconstruction as well as hand and body tracking.

In at least one example, the sensor system 6-102 can include downward facing cameras 6-114 with a field of view pointed generally downward relative to the HMD device 6-100 in the Z-axis. In at least one example, the downward cameras 6-114 can be disposed on left and right sides of the HMD device 6-100 as shown and used for hand and body tracking, headset tracking, and facial avatar detection and creation for display a user avatar on the forward facing display screen of the HMD device 6-100 described elsewhere herein. The downward cameras 6-114, for example, can be used to capture facial expressions and movements for the face of the user below the HMD device 6-100, including the cheeks, mouth, and chin.

In at least one example, the sensor system 6-102 can include jaw cameras 6-116. In at least one example, the jaw cameras 6-116 can be disposed on left and right sides of the HMD device 6-100 as shown and used for hand and body tracking, headset tracking, and facial avatar detection and creation for display a user avatar on the forward facing display screen of the HMD device 6-100 described elsewhere herein. The jaw cameras 6-116, for example, can be used to capture facial expressions and movements for the face of the user below the HMD device 6-100, including the user's jaw, cheeks, mouth, and chin.

In at least one example, the sensor system 6-102 can include side cameras 6-118. The side cameras 6-118 can be oriented to capture side views left and right in the X-axis or direction relative to the HMD device 6-100. In at least one example, the side cameras 6-118 can be used for hand and body tracking, headset tracking, and facial avatar detection and re-creation.

In at least one example, the sensor system 6-102 can include a plurality of eye tracking and gaze tracking sensors for determining an identity, status, and gaze direction of a user's eyes during and/or before use. In at least one example, the eye/gaze tracking sensors can include nasal eye cameras 6-120 disposed on either side of the user's nose and adjacent the user's nose when donning the HMD device 6-100. The eye/gaze sensors can also include bottom eye cameras 6-122 disposed below respective user eyes for capturing images of the eyes for facial avatar detection and creation, gaze tracking, and iris identification functions.

In at least one example, the sensor system 6-102 can include infrared illuminators 6-124 pointed outward from the HMD device 6-100 to illuminate the external environment and any object therein with IR light for IR detection with one or more IR sensors of the sensor system 6-102. In at least one example, the sensor system 6-102 can include a flicker sensor 6-126 and an ambient light sensor 6-128. In at least one example, the flicker sensor 6-126 can detect overhead light refresh rates to avoid display flicker. In one example, the infrared illuminators 6-124 can include light emitting diodes and can be used especially for low light environments for illuminating user hands and other objects in low light for detection by infrared sensors of the sensor system 6-102.

In at least one example, multiple sensors, including the scene cameras 6-106, the downward cameras 6-114, the jaw cameras 6-116, the side cameras 6-118, the depth projector 6-112, and the depth sensors 6-108, 6-110 can be used in combination with an electrically coupled controller to combine depth data with camera data for hand tracking and for size determination for better hand tracking and object recognition and tracking functions of the HMD device 6-100. In at least one example, the downward cameras 6-114, jaw cameras 6-116, and side cameras 6-118 described above and shown in FIG. 1I can be wide angle cameras operable in the visible and infrared spectrums. In at least one example, these cameras 6-114, 6-116, 6-118 can operate only in black and white light detection to simplify image processing and gain sensitivity.

Any of the features, components, and/or parts, including the arrangements and configurations thereof shown in FIG. 1I can be included, either alone or in any combination, in any of the other examples of devices, features, components, and parts shown in FIGS. 1J-1L and described herein. Likewise, any of the features, components, and/or parts, including the arrangements and configurations thereof shown and described with reference to FIGS. 1J-1L can be included, either alone or in any combination, in the example of the devices, features, components, and parts shown in FIG. 1I.

FIG. 1J illustrates a lower perspective view of an example of an HMD 6-200 including a cover or shroud 6-204 secured to a frame 6-230. In at least one example, the sensors 6-203 of the sensor system 6-202 can be disposed around a perimeter of the HMD 6-200 such that the sensors 6-203 are outwardly disposed around a perimeter of a display region or area 6-232 so as not to obstruct a view of the displayed light. In at least one example, the sensors can be disposed behind the shroud 6-204 and aligned with transparent portions of the shroud allowing sensors and projectors to allow light back and forth through the shroud 6-204. In at least one example, opaque ink or other opaque material or films/layers can be disposed on the shroud 6-204 around the display area 6-232 to hide components of the HMD 6-200 outside the display area 6-232 other than the transparent portions defined by the opaque portions, through which the sensors and projectors send and receive light and electromagnetic signals during operation. In at least one example, the shroud 6-204 allows light to pass therethrough from the display (e.g., within the display region 6-232) but not radially outward from the display region around the perimeter of the display and shroud 6-204.

In some examples, the shroud 6-204 includes a transparent portion 6-205 and an opaque portion 6-207, as described above and elsewhere herein. In at least one example, the opaque portion 6-207 of the shroud 6-204 can define one or more transparent regions 6-209 through which the sensors 6-203 of the sensor system 6-202 can send and receive signals. In the illustrated example, the sensors 6-203 of the sensor system 6-202 sending and receiving signals through the shroud 6-204, or more specifically through the transparent regions 6-209 of the (or defined by) the opaque portion 6-207 of the shroud 6-204 can include the same or similar sensors as those shown in the example of FIG. 1I, for example depth sensors 6-108 and 6-110, depth projector 6-112, first and second scene cameras 6-106, first and second downward cameras 6-114, first and second side cameras 6-118, and first and second infrared illuminators 6-124. These sensors are also shown in the examples of FIGS. 1K and 1L. Other sensors, sensor types, number of sensors, and relative positions thereof can be included in one or more other examples of HMDs.

Any of the features, components, and/or parts, including the arrangements and configurations thereof shown in FIG. 1J can be included, either alone or in any combination, in any of the other examples of devices, features, components, and parts shown in FIGS. 11 and 1K-1L and described herein. Likewise, any of the features, components, and/or parts, including the arrangements and configurations thereof shown and described with reference to FIGS. 11 and 1K-1L can be included, either alone or in any combination, in the example of the devices, features, components, and parts shown in FIG. 1J.

FIG. 1K illustrates a front view of a portion of an example of an HMD device 6-300 including a display 6-334, brackets 6-336, 6-338, and frame or housing 6-330. The example shown in FIG. 1K does not include a front cover or shroud in order to illustrate the brackets 6-336, 6-338. For example, the shroud 6-204 shown in FIG. 1J includes the opaque portion 6-207 that would visually cover/block a view of anything outside (e.g., radially/peripherally outside) the display/display region 6-334, including the sensors 6-303 and bracket 6-338.

In at least one example, the various sensors of the sensor system 6-302 are coupled to the brackets 6-336, 6-338. In at least one example, the scene cameras 6-306 include tight tolerances of angles relative to one another. For example, the tolerance of mounting angles between the two scene cameras 6-306 can be 0.5 degrees or less, for example 0.3 degrees or less. In order to achieve and maintain such a tight tolerance, in one example, the scene cameras 6-306 can be mounted to the bracket 6-338 and not the shroud. The bracket can include cantilevered arms on which the scene cameras 6-306 and other sensors of the sensor system 6-302 can be mounted to remain un-deformed in position and orientation in the case of a drop event by a user resulting in any deformation of the other bracket 6-226, housing 6-330, and/or shroud.

Any of the features, components, and/or parts, including the arrangements and configurations thereof shown in FIG. 1K can be included, either alone or in any combination, in any of the other examples of devices, features, components, and parts shown in FIGS. 1I-1J and 1L and described herein. Likewise, any of the features, components, and/or parts, including the arrangements and configurations thereof shown and described with reference to FIGS. 1I-1J and 1L can be included, either alone or in any combination, in the example of the devices, features, components, and parts shown in FIG. 1K.

FIG. 1L illustrates a bottom view of an example of an HMD 6-400 including a front display/cover assembly 6-404 and a sensor system 6-402. The sensor system 6-402 can be similar to other sensor systems described above and elsewhere herein, including in reference to FIGS. 1I-1K. In at least one example, the jaw cameras 6-416 can be facing downward to capture images of the user's lower facial features. In one example, the jaw cameras 6-416 can be coupled directly to the frame or housing 6-430 or one or more internal brackets directly coupled to the frame or housing 6-430 shown. The frame or housing 6-430 can include one or more apertures/openings 6-415 through which the jaw cameras 6-416 can send and receive signals.

Any of the features, components, and/or parts, including the arrangements and configurations thereof shown in FIG. 1L can be included, either alone or in any combination, in any of the other examples of devices, features, components, and parts shown in FIGS. 1I-1K and described herein. Likewise, any of the features, components, and/or parts, including the arrangements and configurations thereof shown and described with reference to FIGS. 1I-1K can be included, either alone or in any combination, in the example of the devices, features, components, and parts shown in FIG. 1L.

FIG. 1M illustrates a rear perspective view of an inter-pupillary distance (IPD) adjustment system 11.1.1-102 including first and second optical modules 11.1.1-104a-b slidably engaging/coupled to respective guide-rods 11.1.1-108a-b and motors 11.1.1-110a-b of left and right adjustment subsystems 11.1.1-106a-b. The IPD adjustment system 11.1.1-102 can be coupled to a bracket 11.1.1-112 and include a button 11.1.1-114 in electrical communication with the motors 11.1.1-110a-b. In at least one example, the button 11.1.1-114 can electrically communicate with the first and second motors 11.1.1-110a-b via a processor or other circuitry components to cause the first and second motors 11.1.1-110a-b to activate and cause the first and second optical modules 11.1.1-104a-b, respectively, to change position relative to one another.

In at least one example, the first and second optical modules 11.1.1-104a-b can include respective display screens configured to project light toward the user's eyes when donning the HMD 11.1.1-100. In at least one example, the user can manipulate (e.g., depress and/or rotate) the button 11.1.1-114 to activate a positional adjustment of the optical modules 11.1.1-104a-b to match the inter-pupillary distance of the user's eyes. The optical modules 11.1.1-104a-b can also include one or more cameras or other sensors/sensor systems for imaging and measuring the IPD of the user such that the optical modules 11.1.1-104a-b can be adjusted to match the IPD.

In one example, the user can manipulate the button 11.1.1-114 to cause an automatic positional adjustment of the first and second optical modules 11.1.1-104a-b. In one example, the user can manipulate the button 11.1.1-114 to cause a manual adjustment such that the optical modules 11.1.1-104a-b move further or closer away, for example when the user rotates the button 11.1.1-114 one way or the other, until the user visually matches her/his own IPD. In one example, the manual adjustment is electronically communicated via one or more circuits and power for the movements of the optical modules 11.1.1-104a-b via the motors 11.1.1-110a-b is provided by an electrical power source. In one example, the adjustment and movement of the optical modules 11.1.1-104a-b via a manipulation of the button 11.1.1-114 is mechanically actuated via the movement of the button 11.1.1-114.

Any of the features, components, and/or parts, including the arrangements and configurations thereof shown in FIG. 1M can be included, either alone or in any combination, in any of the other examples of devices, features, components, and parts shown in any other figures shown and described herein. Likewise, any of the features, components, and/or parts, including the arrangements and configurations thereof shown and described with reference to any other figure shown and described herein, either alone or in any combination, in the example of the devices, features, components, and parts shown in FIG. 1M.

FIG. 1N illustrates a front perspective view of a portion of an HMD 11.1.2-100, including an outer structural frame 11.1.2-102 and an inner or intermediate structural frame 11.1.2-104 defining first and second apertures 11.1.2-106a, 11.1.2-106b. The apertures 11.1.2-106a-b are shown in dotted lines in FIG. 1N because a view of the apertures 11.1.2-106a-b can be blocked by one or more other components of the HMD 11.1.2-100 coupled to the inner frame 11.1.2-104 and/or the outer frame 11.1.2-102, as shown. In at least one example, the HMD 11.1.2-100 can include a first mounting bracket 11.1.2-108 coupled to the inner frame 11.1.2-104. In at least one example, the mounting bracket 11.1.2-108 is coupled to the inner frame 11.1.2-104 between the first and second apertures 11.1.2-106a-b.

The mounting bracket 11.1.2-108 can include a middle or central portion 11.1.2-109 coupled to the inner frame 11.1.2-104. In some examples, the middle or central portion 11.1.2-109 may not be the geometric middle or center of the bracket 11.1.2-108. Rather, the middle/central portion 11.1.2-109 can be disposed between first and second cantilevered extension arms extending away from the middle portion 11.1.2-109. In at least one example, the mounting bracket 108 includes a first cantilever arm 11.1.2-112 and a second cantilever arm 11.1.2-114 extending away from the middle portion 11.1.2-109 of the mount bracket 11.1.2-108 coupled to the inner frame 11.1.2-104.

As shown in FIG. 1N, the outer frame 11.1.2-102 can define a curved geometry on a lower side thereof to accommodate a user's nose when the user dons the HMD 11.1.2-100. The curved geometry can be referred to as a nose bridge 11.1.2-111 and be centrally located on a lower side of the HMD 11.1.2-100 as shown. In at least one example, the mounting bracket 11.1.2-108 can be connected to the inner frame 11.1.2-104 between the apertures 11.1.2-106a-b such that the cantilevered arms 11.1.2-112, 11.1.2-114 extend downward and laterally outward away from the middle portion 11.1.2-109 to compliment the nose bridge 11.1.2-111 geometry of the outer frame 11.1.2-102. In this way, the mounting bracket 11.1.2-108 is configured to accommodate the user's nose as noted above. The nose bridge 11.1.2-111 geometry accommodates the nose in that the nose bridge 11.1.2-111 provides a curvature that curves with, above, over, and around the user's nose for comfort and fit.

The first cantilever arm 11.1.2-112 can extend away from the middle portion 11.1.2-109 of the mounting bracket 11.1.2-108 in a first direction and the second cantilever arm 11.1.2-114 can extend away from the middle portion 11.1.2-109 of the mounting bracket 11.1.2-10 in a second direction opposite the first direction. The first and second cantilever arms 11.1.2-112, 11.1.2-114 are referred to as “cantilevered” or “cantilever” arms because each arm 11.1.2-112, 11.1.2-114, includes a distal free end 11.1.2-116, 11.1.2-118, respectively, which are free of affixation from the inner and outer frames 11.1.2-102, 11.1.2-104. In this way, the arms 11.1.2-112, 11.1.2-114 are cantilevered from the middle portion 11.1.2-109, which can be connected to the inner frame 11.1.2-104, with distal ends 11.1.2-102, 11.1.2-104 unattached.

In at least one example, the HMD 11.1.2-100 can include one or more components coupled to the mounting bracket 11.1.2-108. In one example, the components include a plurality of sensors 11.1.2-110a-f. Each sensor of the plurality of sensors 11.1.2-110a-f can include various types of sensors, including cameras, IR sensors, and so forth. In some examples, one or more of the sensors 11.1.2-110a-f can be used for object recognition in three-dimensional space such that it is important to maintain a precise relative position of two or more of the plurality of sensors 11.1.2-110a-f. The cantilevered nature of the mounting bracket 11.1.2-108 can protect the sensors 11.1.2-110a-f from damage and altered positioning in the case of accidental drops by the user. Because the sensors 11.1.2-110a-f are cantilevered on the arms 11.1.2-112, 11.1.2-114 of the mounting bracket 11.1.2-108, stresses and deformations of the inner and/or outer frames 11.1.2-104, 11.1.2-102 are not transferred to the cantilevered arms 11.1.2-112, 11.1.2-114 and thus do not affect the relative positioning of the sensors 11.1.2-110a-f coupled/mounted to the mounting bracket 11.1.2-108.

Any of the features, components, and/or parts, including the arrangements and configurations thereof shown in FIG. 1N can be included, either alone or in any combination, in any of the other examples of devices, features, components, and described herein. Likewise, any of the features, components, and/or parts, including the arrangements and configurations thereof shown and described herein can be included, either alone or in any combination, in the example of the devices, features, components, and parts shown in FIG. 1N.

FIG. 1O illustrates an example of an optical module 11.3.2-100 for use in an electronic device such as an HMD, including HMD devices described herein. As shown in one or more other examples described herein, the optical module 11.3.2-100 can be one of two optical modules within an HMD, with each optical module aligned to project light toward a user's eye. In this way, a first optical module can project light via a display screen toward a user's first eye and a second optical module of the same device can project light via another display screen toward the user's second eye.

In at least one example, the optical module 11.3.2-100 can include an optical frame or housing 11.3.2-102, which can also be referred to as a barrel or optical module barrel. The optical module 11.3.2-100 can also include a display 11.3.2-104, including a display screen or multiple display screens, coupled to the housing 11.3.2-102. The display 11.3.2-104 can be coupled to the housing 11.3.2-102 such that the display 11.3.2-104 is configured to project light toward the eye of a user when the HMD of which the display module 11.3.2-100 is a part is donned during use. In at least one example, the housing 11.3.2-102 can surround the display 11.3.2-104 and provide connection features for coupling other components of optical modules described herein.

In one example, the optical module 11.3.2-100 can include one or more cameras 11.3.2-106 coupled to the housing 11.3.2-102. The camera 11.3.2-106 can be positioned relative to the display 11.3.2-104 and housing 11.3.2-102 such that the camera 11.3.2-106 is configured to capture one or more images of the user's eye during use. In at least one example, the optical module 11.3.2-100 can also include a light strip 11.3.2-108 surrounding the display 11.3.2-104. In one example, the light strip 11.3.2-108 is disposed between the display 11.3.2-104 and the camera 11.3.2-106. The light strip 11.3.2-108 can include a plurality of lights 11.3.2-110. The plurality of lights can include one or more light emitting diodes (LEDs) or other lights configured to project light toward the user's eye when the HMD is donned. The individual lights 11.3.2-110 of the light strip 11.3.2-108 can be spaced about the strip 11.3.2-108 and thus spaced about the display 11.3.2-104 uniformly or non-uniformly at various locations on the strip 11.3.2-108 and around the display 11.3.2-104.

In at least one example, the housing 11.3.2-102 defines a viewing opening 11.3.2-101 through which the user can view the display 11.3.2-104 when the HMD device is donned. In at least one example, the LEDs are configured and arranged to emit light through the viewing opening 11.3.2-101 and onto the user's eye. In one example, the camera 11.3.2-106 is configured to capture one or more images of the user's eye through the viewing opening 11.3.2-101.

As noted above, each of the components and features of the optical module 11.3.2-100 shown in FIG. 1O can be replicated in another (e.g., second) optical module disposed with the HMD to interact (e.g., project light and capture images) of another eye of the user.

Any of the features, components, and/or parts, including the arrangements and configurations thereof shown in FIG. 1O can be included, either alone or in any combination, in any of the other examples of devices, features, components, and parts shown in FIG. 1P or otherwise described herein. Likewise, any of the features, components, and/or parts, including the arrangements and configurations thereof shown and described with reference to FIG. 1P or otherwise described herein can be included, either alone or in any combination, in the example of the devices, features, components, and parts shown in FIG. 1O.

FIG. 1P illustrates a cross-sectional view of an example of an optical module 11.3.2-200 including a housing 11.3.2-202, display assembly 11.3.2-204 coupled to the housing 11.3.2-202, and a lens 11.3.2-216 coupled to the housing 11.3.2-202. In at least one example, the housing 11.3.2-202 defines a first aperture or channel 11.3.2-212 and a second aperture or channel 11.3.2-214. The channels 11.3.2-212, 11.3.2-214 can be configured to slidably engage respective rails or guide rods of an HMD device to allow the optical module 11.3.2-200 to adjust in position relative to the user's eyes for match the user's interpapillary distance (IPD). The housing 11.3.2-202 can slidably engage the guide rods to secure the optical module 11.3.2-200 in place within the HMD.

In at least one example, the optical module 11.3.2-200 can also include a lens 11.3.2-216 coupled to the housing 11.3.2-202 and disposed between the display assembly 11.3.2-204 and the user's eyes when the HMD is donned. The lens 11.3.2-216 can be configured to direct light from the display assembly 11.3.2-204 to the user's eye. In at least one example, the lens 11.3.2-216 can be a part of a lens assembly including a corrective lens removably attached to the optical module 11.3.2-200. In at least one example, the lens 11.3.2-216 is disposed over the light strip 11.3.2-208 and the one or more eye-tracking cameras 11.3.2-206 such that the camera 11.3.2-206 is configured to capture images of the user's eye through the lens 11.3.2-216 and the light strip 11.3.2-208 includes lights configured to project light through the lens 11.3.2-216 to the users' eye during use.

Any of the features, components, and/or parts, including the arrangements and configurations thereof shown in FIG. 1P can be included, either alone or in any combination, in any of the other examples of devices, features, components, and parts and described herein. Likewise, any of the features, components, and/or parts, including the arrangements and configurations thereof shown and described herein can be included, either alone or in any combination, in the example of the devices, features, components, and parts shown in FIG. 1P.

FIG. 2 is a block diagram of an example of the controller 110 in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments, the controller 110 includes one or more processing units 202 (e.g., microprocessors, application-specific integrated-circuits (ASICs), field-programmable gate arrays (FPGAs), graphics processing units (GPUs), central processing units (CPUs), processing cores, and/or the like), one or more input/output (I/O) devices 206, one or more communication interfaces 208 (e.g., universal serial bus (USB), FIREWIRE, THUNDERBOLT, IEEE 802.3x, IEEE 802.11x, IEEE 802.16x, global system for mobile communications (GSM), code division multiple access (CDMA), time division multiple access (TDMA), global positioning system (GPS), infrared (IR), BLUETOOTH, ZIGBEE, and/or the like type interface), one or more programming (e.g., I/O) interfaces 210, a memory 220, and one or more communication buses 204 for interconnecting these and various other components.

In some embodiments, the one or more communication buses 204 include circuitry that interconnects and controls communications between system components. In some embodiments, the one or more I/O devices 206 include at least one of a keyboard, a mouse, a touchpad, a joystick, one or more microphones, one or more speakers, one or more image sensors, one or more displays, and/or the like.

The memory 220 includes high-speed random-access memory, such as dynamic random-access memory (DRAM), static random-access memory (SRAM), double-data-rate random-access memory (DDR RAM), or other random-access solid-state memory devices. In some embodiments, the memory 220 includes non-volatile memory, such as one or more magnetic disk storage devices, optical disk storage devices, flash memory devices, or other non-volatile solid-state storage devices. The memory 220 optionally includes one or more storage devices remotely located from the one or more processing units 202. The memory 220 comprises a non-transitory computer readable storage medium. In some embodiments, the memory 220 or the non-transitory computer readable storage medium of the memory 220 stores the following programs, modules and data structures, or a subset thereof including an optional operating system 230 and an XR experience module 240.

The operating system 230 includes instructions for handling various basic system services and for performing hardware dependent tasks. In some embodiments, the XR experience module 240 is configured to manage and coordinate one or more XR experiences for one or more users (e.g., a single XR experience for one or more users, or multiple XR experiences for respective groups of one or more users). To that end, in various embodiments, the XR experience module 240 includes a data obtaining unit 242, a tracking unit 244, a coordination unit 246, and a data transmitting unit 248.

In some embodiments, the data obtaining unit 242 is configured to obtain data (e.g., presentation data, interaction data, sensor data, location data, etc.) from at least the display generation component 120 of FIG. 1A, and optionally one or more of the input devices 125, output devices 155, sensors 190, and/or peripheral devices 195. To that end, in various embodiments, the data obtaining unit 242 includes instructions and/or logic therefor, and heuristics and metadata therefor.

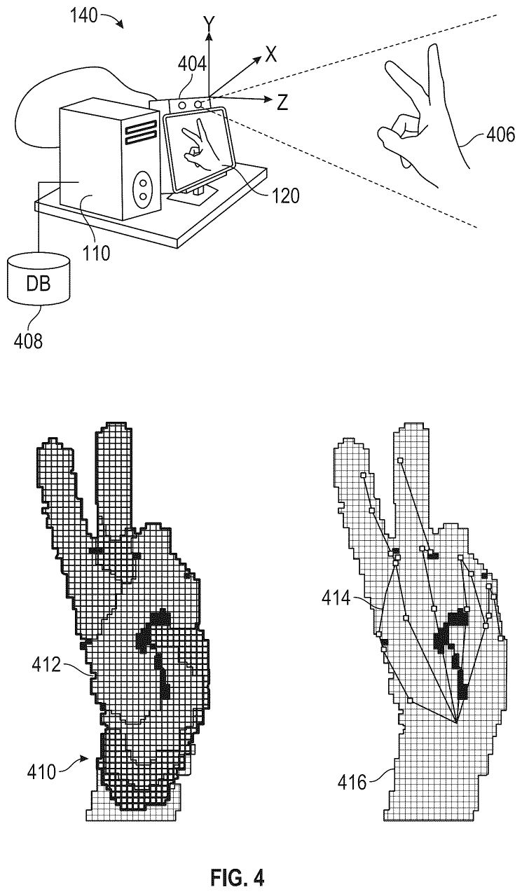

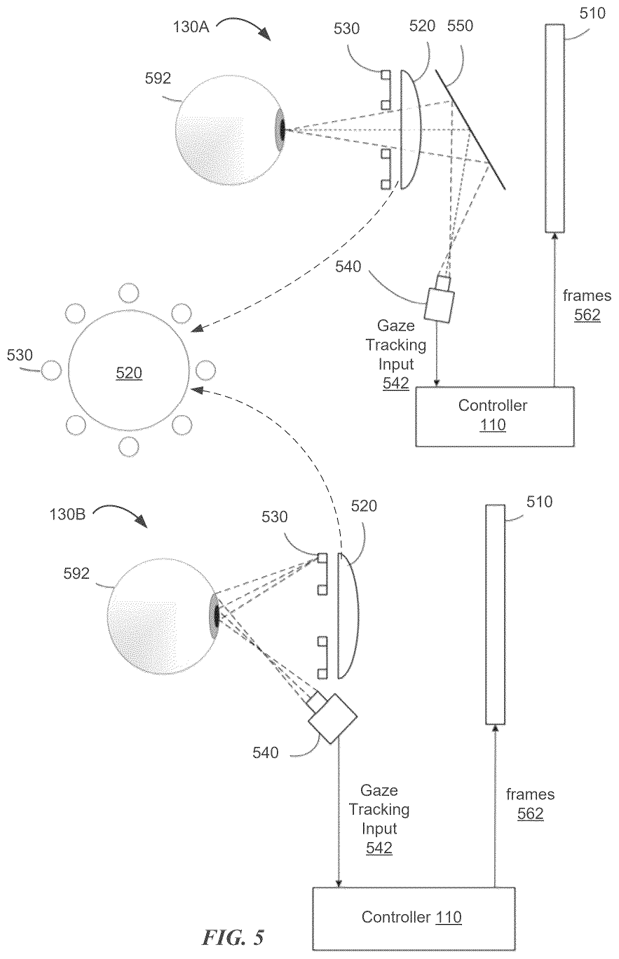

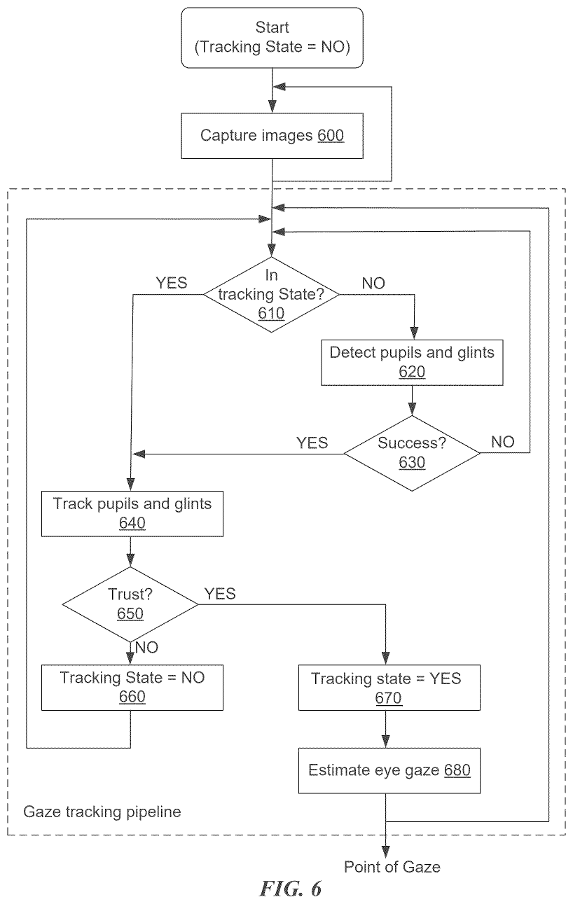

In some embodiments, the tracking unit 244 is configured to map the scene 105 and to track the position/location of at least the display generation component 120 with respect to the scene 105 of FIG. 1A, and optionally, to one or more of the input devices 125, output devices 155, sensors 190, and/or peripheral devices 195. To that end, in various embodiments, the tracking unit 244 includes instructions and/or logic therefor, and heuristics and metadata therefor. In some embodiments, the tracking unit 244 includes hand tracking unit 245 and/or eye tracking unit 243. In some embodiments, the hand tracking unit 245 is configured to track the position/location of one or more portions of the user's hands, and/or motions of one or more portions of the user's hands with respect to the scene 105 of FIG. 1A, relative to the display generation component 120, and/or relative to a coordinate system defined relative to the user's hand. The hand tracking unit 245 is described in greater detail below with respect to FIG. 4. In some embodiments, the eye tracking unit 243 is configured to track the position and movement of the user's gaze (or more broadly, the user's eyes, face, or head) with respect to the scene 105 (e.g., with respect to the physical environment and/or to the user (e.g., the user's hand)) or with respect to the XR content displayed via the display generation component 120. The eye tracking unit 243 is described in greater detail below with respect to FIG. 5.

In some embodiments, the coordination unit 246 is configured to manage and coordinate the XR experience presented to the user by the display generation component 120, and optionally, by one or more of the output devices 155 and/or peripheral devices 195. To that end, in various embodiments, the coordination unit 246 includes instructions and/or logic therefor, and heuristics and metadata therefor.

In some embodiments, the data transmitting unit 248 is configured to transmit data (e.g., presentation data, location data, etc.) to at least the display generation component 120, and optionally, to one or more of the input devices 125, output devices 155, sensors 190, and/or peripheral devices 195. To that end, in various embodiments, the data transmitting unit 248 includes instructions and/or logic therefor, and heuristics and metadata therefor.

Although the data obtaining unit 242, the tracking unit 244 (e.g., including the eye tracking unit 243 and the hand tracking unit 245), the coordination unit 246, and the data transmitting unit 248 are shown as residing on a single device (e.g., the controller 110), it should be understood that in other embodiments, any combination of the data obtaining unit 242, the tracking unit 244 (e.g., including the eye tracking unit 243 and the hand tracking unit 245), the coordination unit 246, and the data transmitting unit 248 may be located in separate computing devices.

Moreover, FIG. 2 is intended more as functional description of the various features that may be present in a particular implementation as opposed to a structural schematic of the embodiments described herein. As recognized by those of ordinary skill in the art, items shown separately could be combined and some items could be separated. For example, some functional modules shown separately in FIG. 2 could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

FIG. 3A is a block diagram of an example of the display generation component 120 in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments the display generation component 120 (e.g., HMD) includes one or more processing units 302 (e.g., microprocessors, ASICs, FPGAs, GPUs, CPUs, processing cores, and/or the like), one or more input/output (I/O) devices and sensors 306, one or more communication interfaces 308 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, and/or the like type interface), one or more programming (e.g., I/O) interfaces 310, one or more XR displays 312, one or more optional interior- and/or exterior-facing image sensors 314, a memory 320, and one or more communication buses 304 for interconnecting these and various other components.

In some embodiments, the one or more communication buses 304 include circuitry that interconnects and controls communications between system components. In some embodiments, the one or more I/O devices and sensors 306 include at least one of an inertial measurement unit (IMU), an accelerometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some embodiments, the one or more XR displays 312 are configured to provide the XR experience to the user. In some embodiments, the one or more XR displays 312 correspond to holographic, digital light processing (DLP), liquid-crystal display (LCD), liquid-crystal on silicon (LCoS), organic light-emitting field-effect transistor (OLET), organic light-emitting diode (OLED), surface-conduction electron-emitter display (SED), field-emission display (FED), quantum-dot light-emitting diode (QD-LED), micro-electro-mechanical system (MEMS), and/or the like display types. In some embodiments, the one or more XR displays 312 correspond to diffractive, reflective, polarized, holographic, etc. waveguide displays. For example, the display generation component 120 (e.g., HMD) includes a single XR display. In another example, the display generation component 120 includes an XR display for each eye of the user. In some embodiments, the one or more XR displays 312 are capable of presenting MR and VR content. In some embodiments, the one or more XR displays 312 are capable of presenting MR or VR content.

In some embodiments, the one or more image sensors 314 are configured to obtain image data that corresponds to at least a portion of the face of the user that includes the eyes of the user (and may be referred to as an eye-tracking camera). In some embodiments, the one or more image sensors 314 are configured to obtain image data that corresponds to at least a portion of the user's hand(s) and optionally arm(s) of the user (and may be referred to as a hand-tracking camera). In some embodiments, the one or more image sensors 314 are configured to be forward-facing so as to obtain image data that corresponds to the scene as would be viewed by the user if the display generation component 120 (e.g., HMD) was not present (and may be referred to as a scene camera). The one or more optional image sensors 314 can include one or more RGB cameras (e.g., with a complimentary metal-oxide-semiconductor (CMOS) image sensor or a charge-coupled device (CCD) image sensor), one or more infrared (IR) cameras, one or more event-based cameras, and/or the like.

The memory 320 includes high-speed random-access memory, such as DRAM, SRAM, DDR RAM, or other random-access solid-state memory devices. In some embodiments, the memory 320 includes non-volatile memory, such as one or more magnetic disk storage devices, optical disk storage devices, flash memory devices, or other non-volatile solid-state storage devices. The memory 320 optionally includes one or more storage devices remotely located from the one or more processing units 302. The memory 320 comprises a non-transitory computer readable storage medium. In some embodiments, the memory 320 or the non-transitory computer readable storage medium of the memory 320 stores the following programs, modules and data structures, or a subset thereof including an optional operating system 330 and an XR presentation module 340.

The operating system 330 includes instructions for handling various basic system services and for performing hardware dependent tasks. In some embodiments, the XR presentation module 340 is configured to present XR content to the user via the one or more XR displays 312. To that end, in various embodiments, the XR presentation module 340 includes a data obtaining unit 342, an XR presenting unit 344, an XR map generating unit 346, and a data transmitting unit 348.

In some embodiments, the data obtaining unit 342 is configured to obtain data (e.g., presentation data, interaction data, sensor data, location data, etc.) from at least the controller 110 of FIG. 1A. To that end, in various embodiments, the data obtaining unit 342 includes instructions and/or logic therefor, and heuristics and metadata therefor.

In some embodiments, the XR presenting unit 344 is configured to present XR content via the one or more XR displays 312. To that end, in various embodiments, the XR presenting unit 344 includes instructions and/or logic therefor, and heuristics and metadata therefor.

In some embodiments, the XR map generating unit 346 is configured to generate an XR map (e.g., a 3D map of the mixed reality scene or a map of the physical environment into which computer-generated objects can be placed to generate the extended reality) based on media content data. To that end, in various embodiments, the XR map generating unit 346 includes instructions and/or logic therefor, and heuristics and metadata therefor.

In some embodiments, the data transmitting unit 348 is configured to transmit data (e.g., presentation data, location data, etc.) to at least the controller 110, and optionally one or more of the input devices 125, output devices 155, sensors 190, and/or peripheral devices 195. To that end, in various embodiments, the data transmitting unit 348 includes instructions and/or logic therefor, and heuristics and metadata therefor.

Although the data obtaining unit 342, the XR presenting unit 344, the XR map generating unit 346, and the data transmitting unit 348 are shown as residing on a single device (e.g., the display generation component 120 of FIG. 1A), it should be understood that in other embodiments, any combination of the data obtaining unit 342, the XR presenting unit 344, the XR map generating unit 346, and the data transmitting unit 348 may be located in separate computing devices.

Moreover, FIG. 3A is intended more as a functional description of the various features that could be present in a particular implementation as opposed to a structural schematic of the embodiments described herein. As recognized by those of ordinary skill in the art, items shown separately could be combined and some items could be separated. For example, some functional modules shown separately in FIG. 3A could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

Implementations within the scope of the present disclosure can be partially or entirely realized using a tangible computer-readable storage medium (or multiple tangible computer-readable storage media of one or more types) encoding one or more computer-readable instructions. It should be recognized that computer-readable instructions can be organized in any format, including applications, widgets, processes, software, and/or components.

Implementations within the scope of the present disclosure include a computer-readable storage medium that encodes instructions organized as an application (e.g., application 3160) that, when executed by one or more processing units, control an electronic device (e.g., device 3150) to perform the method of FIG. 3B, the method of FIG. 3C, and/or one or more other processes and/or methods described herein.

It should be recognized that application 3160 (shown in FIG. 3D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 3160 is an application that is pre-installed on device 3150 at purchase (e.g., a first-party application). In some embodiments, application 3160 is an application that is provided to device 3150 via an operating system update file (e.g., a first-party application or a second-party application). In some embodiments, application 3160 is an application that is provided via an application store. In some embodiments, the application store can be an application store that is pre-installed on device 3150 at purchase (e.g., a first-party application store). In some embodiments, the application store is a third-party application store (e.g., an application store that is provided by another application store, downloaded via a network, and/or read from a storage device).

Referring to FIG. 3B and FIG. 3F, application 3160 obtains information (e.g., 3010). In some embodiments, at 3010, information is obtained from at least one hardware component of device 3150. In some embodiments, at 3010, information is obtained from at least one software module of device 3150. In some embodiments, at 3010, information is obtained from at least one hardware component external to device 3150 (e.g., a peripheral device, an accessory device, and/or a server). In some embodiments, the information obtained at 3010 includes positional information, time information, notification information, user information, environment information, electronic device state information, weather information, media information, historical information, event information, hardware information, and/or motion information. In some embodiments, in response to and/or after obtaining the information at 3010, application 3160 provides the information to a system (e.g., 3020).

In some embodiments, the system (e.g., 3110 shown in FIG. 3E) is an operating system hosted on device 3150. In some embodiments, the system (e.g., 3110 shown in FIG. 3E) is an external device (e.g., a server, a peripheral device, an accessory, and/or a personal computing device) that includes an operating system.

Referring to FIG. 3C and FIG. 3G, application 3160 obtains information (e.g., 3030). In some embodiments, the information obtained at 3030 includes positional information, time information, notification information, user information, environment information electronic device state information, weather information, media information, historical information, event information, hardware information, and/or motion information. In response to and/or after obtaining the information at 3030, application 3160 performs an operation with the information (e.g., 3040). In some embodiments, the operation performed at 3040 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 3110 based on the information.

In some embodiments, one or more steps of the method of FIG. 3B and/or the method of FIG. 3C is performed in response to a trigger. In some embodiments, the trigger includes detection of an event, a notification received from system 3110, a user input, and/or a response to a call to an API provided by system 3110.

In some embodiments, the instructions of application 3160, when executed, control device 3150 to perform the method of FIG. 3B and/or the method of FIG. 3C by calling an application programming interface (API) (e.g., API 3190) provided by system 3110. In some embodiments, application 3160 performs at least a portion of the method of FIG. 3B and/or the method of FIG. 3C without calling API 3190.

In some embodiments, one or more steps of the method of FIG. 3B and/or the method of FIG. 3C includes calling an API (e.g., API 3190) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 3D, device 3150 is illustrated. In some embodiments, device 3150 is a personal computing device, a smart phone, a smart watch, a fitness tracker, a head mounted display (HMD) device, a media device, a communal device, a speaker, a television, and/or a tablet. As illustrated in FIG. 3D, device 3150 includes application 3160 and an operating system (e.g., system 3110 shown in FIG. 3E). Application 3160 includes application implementation module 3170 and API-calling module 3180. System 3110 includes API 3190 and implementation module 3100. It should be recognized that device 3150, application 3160, and/or system 3110 can include more, fewer, and/or different components than illustrated in FIGS. 3D and 3E.

In some embodiments, application implementation module 3170 includes a set of one or more instructions corresponding to one or more operations performed by application 3160. For example, when application 3160 is a messaging application, application implementation module 3170 can include operations to receive and send messages. In some embodiments, application implementation module 3170 communicates with API-calling module 3180 to communicate with system 3110 via API 3190 (shown in FIG. 3E).

In some embodiments, API 3190 is a software module (e.g., a collection of computer-readable instructions) that provides an interface that allows a different module (e.g., API-calling module 3180) to access and/or use one or more functions, methods, procedures, data structures, classes, and/or other services provided by implementation module 3100 of system 3110. For example, API-calling module 3180 can access a feature of implementation module 3100 through one or more API calls or invocations (e.g., embodied by a function or a method call) exposed by API 3190 (e.g., a software and/or hardware module that can receive API calls, respond to API calls, and/or send API calls) and can pass data and/or control information using one or more parameters via the API calls or invocations. In some embodiments, API 3190 allows application 3160 to use a service provided by a Software Development Kit (SDK) library. In some embodiments, application 3160 incorporates a call to a function or method provided by the SDK library and provided by API 3190 or uses data types or objects defined in the SDK library and provided by API 3190. In some embodiments, API-calling module 3180 makes an API call via API 3190 to access and use a feature of implementation module 3100 that is specified by API 3190. In such embodiments, implementation module 3100 can return a value via API 3190 to API-calling module 3180 in response to the API call. The value can report to application 3160 the capabilities or state of a hardware component of device 3150, including those related to aspects such as input capabilities and state, output capabilities and state, processing capability, power state, storage capacity and state, and/or communications capability. In some embodiments, API 3190 is implemented in part by firmware, microcode, or other low level logic that executes in part on the hardware component.

In some embodiments, API 3190 allows a developer of API-calling module 3180 (which can be a third-party developer) to leverage a feature provided by implementation module 3100. In such embodiments, there can be one or more API calling modules (e.g., including API-calling module 3180) that communicate with implementation module 3100. In some embodiments, API 3190 allows multiple API calling modules written in different programming languages to communicate with implementation module 3100 (e.g., API 3190 can include features for translating calls and returns between implementation module 3100 and API-calling module 3180) while API 3190 is implemented in terms of a specific programming language. In some embodiments, API-calling module 3180 calls APIs from different providers such as a set of APIs from an OS provider, another set of APIs from a plug-in provider, and/or another set of APIs from another provider (e.g., the provider of a software library) or creator of the another set of APIs.

Examples of API 3190 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments, the sensor API is an API for accessing data associated with a sensor of device 3150. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor, and/or biometric sensor.

In some embodiments, implementation module 3100 is a system (e.g., operating system, and/or server system) software module (e.g., a collection of computer-readable instructions) that is constructed to perform an operation in response to receiving an API call via API 3190. In some embodiments, implementation module 3100 is constructed to provide an API response (via API 3190) as a result of processing an API call. By way of example, implementation module 3100 and API-calling module 3180 can each be any one of an operating system, a library, a device driver, an API, an application program, or other module. It should be understood that implementation module 3100 and API-calling module 3180 can be the same or different type of module from each other. In some embodiments, implementation module 3100 is embodied at least in part in firmware, microcode, or hardware logic.

In some embodiments, implementation module 3100 returns a value through API 3190 in response to an API call from API-calling module 3180. While API 3190 defines the syntax and result of an API call (e.g., how to invoke the API call and what the API call does), API 3190 might not reveal how implementation module 3100 accomplishes the function specified by the API call. Various API calls are transferred via the one or more application programming interfaces between API-calling module 3180 and implementation module 3100. Transferring the API calls can include issuing, initiating, invoking, calling, receiving, returning, and/or responding to the function calls or messages. In other words, transferring can describe actions by either of API-calling module 3180 or implementation module 3100. In some embodiments, a function call or other invocation of API 3190 sends and/or receives one or more parameters through a parameter list or other structure.

In some embodiments, implementation module 3100 provides more than one API, each providing a different view of or with different aspects of functionality implemented by implementation module 3100. For example, one API of implementation module 3100 can provide a first set of functions and can be exposed to third-party developers, and another API of implementation module 3100 can be hidden (e.g., not exposed) and provide a subset of the first set of functions and also provide another set of functions, such as testing or debugging functions which are not in the first set of functions. In some embodiments, implementation module 3100 calls one or more other components via an underlying API and thus is both an API calling module and an implementation module. It should be recognized that implementation module 3100 can include additional functions, methods, classes, data structures, and/or other features that are not specified through API 3190 and are not available to API-calling module 3180. It should also be recognized that API-calling module 3180 can be on the same system as implementation module 3100 or can be located remotely and access implementation module 3100 using API 3190 over a network. In some embodiments, implementation module 3100, API 3190, and/or API-calling module 3180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An application programming interface (API) is an interface between a first software process and a second software process that specifies a format for communication between the first software process and the second software process. Limited APIs (e.g., private APIs or partner APIs) are APIs that are accessible to a limited set of software processes (e.g., only software processes within an operating system or only software processes that are approved to access the limited APIs). Public APIs that are accessible to a wider set of software processes. Some APIs enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some APIs enable software processes to communicate about and/or set a state of one or more output generation components (e.g., one or more audio output generation components, one or more display generation components, and/or one or more tactile output generation components). Some APIs enable particular capabilities (e.g., scrolling, handwriting, text entry, image editing, and/or image creation) to be accessed, performed, and/or used by a software process (e.g., generating outputs for use by a software process based on input from the software process). Some APIs enable content from a software process to be inserted into a template and displayed in a user interface that has a layout and/or behaviors that are specified by the template.

Many software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. Many of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more APIs (e.g., via multiple different APIs). For example, when an input is detected the direct sensor data is frequently processed into one or more input events that are provided (e.g., via an API) to a receiving software process that makes some determination based on the input events, and then sends (e.g., via an API) information to a software process to perform an operation (e.g., change a device state and/or user interface) based on the determination. While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an API) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls between steps of interacting with the computer system (e.g., between different software components of the computer system or between a software component of the computer system and a software component of one or more remote computer systems).

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

In some embodiments, the application is an application that is pre-installed on the first computer system at purchase (e.g., a first-party application). In some embodiments, the application is an application that is provided to the first computer system via an operating system update file (e.g., a first-party application). In some embodiments, the application is an application that is provided via an application store. In some embodiments, the application store is pre-installed on the first computer system at purchase (e.g., a first-party application store) and allows download of one or more applications. In some embodiments, the application store is a third-party application store (e.g., an application store that is provided by another device, downloaded via a network, and/or read from a storage device). In some embodiments, the application is a third-party application (e.g., an app that is provided by an application store, downloaded via a network, and/or read from a storage device). In some embodiments, the application controls the first computer system to perform method 12000 (FIGS. 12A-12G), method 13000 (FIGS. 13A-13G), method 14000 (FIGS. 14A-14H), method 15000 (FIGS. 15A-15F), and/or method 16000 (FIGS. 16A-16C) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, a contact transfer API, a photos API, a camera API, and/or an image processing API.

In some embodiments, at least one API is a software module (e.g., a collection of computer-readable instructions) that provides an interface that allows a different module (e.g., an API calling module) to access and use one or more functions, methods, procedures, data structures, classes, and/or other services provided by an implementation module of the system process. The API can define one or more parameters that are passed between the API calling module and the implementation module. In some embodiments, API 3190 defines a first API call that can be provided by API-calling module 3180. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 3150) that runs the application. In some embodiments, the implementation module is included in an electronic device that is separate from the device that runs the application.

FIG. 4 is a schematic, pictorial illustration of an example embodiment of the hand tracking device 140. In some embodiments, hand tracking device 140 (FIG. 1A) is controlled by hand tracking unit 245 (FIG. 2) to track the position/location of one or more portions of the user's hands, and/or motions of one or more portions of the user's hands with respect to the scene 105 of FIG. 1A (e.g., with respect to a portion of the physical environment surrounding the user, with respect to the display generation component 120, or with respect to a portion of the user (e.g., the user's face, eyes, or head), and/or relative to a coordinate system defined relative to the user's hand. In some embodiments, the hand tracking device 140 is part of the display generation component 120 (e.g., embedded in or attached to a head-mounted device). In some embodiments, the hand tracking device 140 is separate from the display generation component 120 (e.g., located in separate housings or attached to separate physical support structures).

In some embodiments, the hand tracking device 140 includes image sensors 404 (e.g., one or more IR cameras, 3D cameras, depth cameras, and/or color cameras, etc.) that capture three-dimensional scene information that includes at least a hand 406 of a human user. The image sensors 404 capture the hand images with sufficient resolution to enable the fingers and their respective positions to be distinguished. The image sensors 404 typically capture images of other parts of the user's body, as well, or possibly all of the body, and may have either zoom capabilities or a dedicated sensor with enhanced magnification to capture images of the hand with the desired resolution. In some embodiments, the image sensors 404 also capture 2D color video images of the hand 406 and other elements of the scene. In some embodiments, the image sensors 404 are used in conjunction with other image sensors to capture the physical environment of the scene 105, or serve as the image sensors that capture the physical environment of the scene 105. In some embodiments, the image sensors 404 are positioned relative to the user or the user's environment in a way that a field of view of the image sensors or a portion thereof is used to define an interaction space in which hand movement captured by the image sensors are treated as inputs to the controller 110.

In some embodiments, the image sensors 404 output a sequence of frames containing 3D map data (and possibly color image data, as well) to the controller 110, which extracts high-level information from the map data. This high-level information is typically provided via an Application Program Interface (API) to an application running on the controller, which drives the display generation component 120 accordingly. For example, the user may interact with software running on the controller 110 by moving their hand 406 and/or changing their hand posture.

In some embodiments, the image sensors 404 project a pattern of spots onto a scene containing the hand 406 and capture an image of the projected pattern. In some embodiments, the controller 110 computes the 3D coordinates of points in the scene (including points on the surface of the user's hand) by triangulation, based on transverse shifts of the spots in the pattern. This approach is advantageous in that it does not require the user to hold or wear any sort of beacon, sensor, or other marker. It gives the depth coordinates of points in the scene relative to a predetermined reference plane, at a certain distance from the image sensors 404. In the present disclosure, the image sensors 404 are assumed to define an orthogonal set of x, y, z axes, so that depth coordinates of points in the scene correspond to z components measured by the image sensors. Alternatively, the image sensors 404 (e.g., a hand tracking device) may use other methods of 3D mapping, such as stereoscopic imaging or time-of-flight measurements, based on single or multiple cameras or other types of sensors.

In some embodiments, the hand tracking device 140 captures and processes a temporal sequence of depth maps containing the user's hand, while the user moves their hand (e.g., whole hand or one or more fingers). Software running on a processor in the image sensors 404 and/or the controller 110 processes the 3D map data to extract patch descriptors of the hand in these depth maps. The software matches these descriptors to patch descriptors stored in a database 408, based on a prior learning process, in order to estimate the pose of the hand in each frame. The pose typically includes 3D locations of the user's hand joints and fingertips.

The software may also analyze the trajectory of the hands and/or fingers over multiple frames in the sequence in order to identify gestures. The pose estimation functions described herein may be interleaved with motion tracking functions, so that patch-based pose estimation is performed only once in every two (or more) frames, while tracking is used to find changes in the pose that occur over the remaining frames. The pose, motion, and gesture information are provided via the above-mentioned API to an application program running on the controller 110. This program may, for example, move and modify images presented on the display generation component 120, or perform other functions, in response to the pose and/or gesture information.

In some embodiments, a gesture includes an air gesture. An air gesture is a gesture that is detected without the user touching (or independently of) an input element that is part of a device (e.g., computer system 101, one or more input device 125, and/or hand tracking device 140) and is based on detected motion of a portion (e.g., the head, one or more arms, one or more hands, one or more fingers, and/or one or more legs) of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments, input gestures used in the various examples and embodiments described herein include air gestures performed by movement of the user's finger(s) relative to other finger(s) or part(s) of the user's hand) for interacting with an XR environment (e.g., a virtual or mixed-reality environment), in accordance with some embodiments. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments in which the input gesture is an air gesture (e.g., in the absence of physical contact with an input device that provides the computer system with information about which user interface element is the target of the user input, such as contact with a user interface element displayed on a touchscreen, or contact with a mouse or trackpad to move a cursor to the user interface element), the gesture takes into account the user's attention (e.g., gaze) to determine the target of the user input (e.g., for direct inputs, as described below). Thus, in implementations involving air gestures, the input gesture is, for example, detected attention (e.g., gaze) toward the user interface element in combination (e.g., concurrent) with movement of a user's finger(s) and/or hands to perform a pinch and/or tap input, as described in more detail below.

In some embodiments, input gestures that are directed to a user interface object are performed directly or indirectly with reference to a user interface object. For example, a user input is performed directly on the user interface object in accordance with performing the input gesture with the user's hand at a position that corresponds to the position of the user interface object in the three-dimensional environment (e.g., as determined based on a current viewpoint of the user). In some embodiments, the input gesture is performed indirectly on the user interface object in accordance with the user performing the input gesture while a position of the user's hand is not at the position that corresponds to the position of the user interface object in the three-dimensional environment while detecting the user's attention (e.g., gaze) on the user interface object. For example, for direct input gesture, the user is enabled to direct the user's input to the user interface object by initiating the gesture at, or near, a position corresponding to the displayed position of the user interface object (e.g., within 0.5 cm, 1 cm, 5 cm, or a distance between 0-5 cm, as measured from an outer edge of the option or a center portion of the option). For an indirect input gesture, the user is enabled to direct the user's input to the user interface object by paying attention to the user interface object (e.g., by gazing at the user interface object) and, while paying attention to the option, the user initiates the input gesture (e.g., at any position that is detectable by the computer system) (e.g., at a position that does not correspond to the displayed position of the user interface object).

In some embodiments, input gestures (e.g., air gestures) used in the various examples and embodiments described herein include pinch inputs and tap inputs, for interacting with a virtual or mixed-reality environment, in accordance with some embodiments. For example, the pinch inputs and tap inputs described below are performed as air gestures.

In some embodiments, a pinch input is part of an air gesture that includes one or more of: a pinch gesture, a long pinch gesture, a pinch and drag gesture, or a double pinch gesture. For example, a pinch gesture that is an air gesture includes movement of two or more fingers of a hand to make contact with one another, that is, optionally, followed by an immediate (e.g., within 0-1 seconds) break in contact from each other. A long pinch gesture that is an air gesture includes movement of two or more fingers of a hand to make contact with one another for at least a threshold amount of time (e.g., at least 1 second), before detecting a break in contact with one another. For example, a long pinch gesture includes the user holding a pinch gesture (e.g., with the two or more fingers making contact), and the long pinch gesture continues until a break in contact between the two or more fingers is detected. In some embodiments, a double pinch gesture that is an air gesture comprises two (e.g., or more) pinch inputs (e.g., performed by the same hand) detected in immediate (e.g., within a predefined time period) succession of each other. For example, the user performs a first pinch input (e.g., a pinch input or a long pinch input), releases the first pinch input (e.g., breaks contact between the two or more fingers), and performs a second pinch input within a predefined time period (e.g., within 1 second or within 2 seconds) after releasing the first pinch input.

In some embodiments, a pinch and drag gesture that is an air gesture (e.g., an air drag gesture or an air swipe gesture) includes a pinch gesture (e.g., a pinch gesture or a long pinch gesture) performed in conjunction with (e.g., followed by) a drag input that changes a position of the user's hand from a first position (e.g., a start position of the drag) to a second position (e.g., an end position of the drag). In some embodiments, the user maintains the pinch gesture while performing the drag input, and releases the pinch gesture (e.g., opens their two or more fingers) to end the drag gesture (e.g., at the second position). In some embodiments, the pinch input and the drag input are performed by the same hand (e.g., the user pinches two or more fingers to make contact with one another and moves the same hand to the second position in the air with the drag gesture). In some embodiments, the pinch input is performed by a first hand of the user and the drag input is performed by the second hand of the user (e.g., the user's second hand moves from the first position to the second position in the air while the user continues the pinch input with the user's first hand. In some embodiments, an input gesture that is an air gesture includes inputs (e.g., pinch and/or tap inputs) performed using both of the user's two hands. For example, the input gesture includes two (e.g., or more) pinch inputs performed in conjunction with (e.g., concurrently with, or within a predefined time period of) each other. For example, a first pinch gesture is performed using a first hand of the user (e.g., a pinch input, a long pinch input, or a pinch and drag input), and, in conjunction with performing the pinch input using the first hand, a second pinch input is performed using the other hand (e.g., the second hand of the user's two hands). In some embodiments, movement between the user's two hands is performed (e.g., to increase and/or decrease a distance or relative orientation between the user's two hands).

In some embodiments, a tap input (e.g., directed to a user interface element) performed as an air gesture includes movement of a user's finger(s) toward the user interface element, movement of the user's hand toward the user interface element optionally with the user's finger(s) extended toward the user interface element, a downward motion of a user's finger (e.g., mimicking a mouse click motion or a tap on a touchscreen), or other predefined movement of the user's hand. In some embodiments a tap input that is performed as an air gesture is detected based on movement characteristics of the finger or hand performing the tap gesture movement of a finger or hand away from the viewpoint of the user and/or toward an object that is the target of the tap input followed by an end of the movement. In some embodiments the end of the movement is detected based on a change in movement characteristics of the finger or hand performing the tap gesture (e.g., an end of movement away from the viewpoint of the user and/or toward the object that is the target of the tap input, a reversal of direction of movement of the finger or hand, and/or a reversal of a direction of acceleration of movement of the finger or hand).

In some embodiments, attention of a user is determined to be directed to a portion of the three-dimensional environment based on detection of gaze directed to the portion of the three-dimensional environment (optionally, without requiring other conditions). In some embodiments, attention of a user is determined to be directed to a portion of the three-dimensional environment based on detection of gaze directed to the portion of the three-dimensional environment with one or more additional conditions such as requiring that gaze is directed to the portion of the three-dimensional environment for at least a threshold duration (e.g., a dwell duration) and/or requiring that the gaze is directed to the portion of the three-dimensional environment while the viewpoint of the user is within a distance threshold from the portion of the three-dimensional environment in order for the device to determine that attention of the user is directed to the portion of the three-dimensional environment, where if one of the additional conditions is not met, the device determines that attention is not directed to the portion of the three-dimensional environment toward which gaze is directed (e.g., until the one or more additional conditions are met).

In some embodiments, the detection of a ready state configuration of a user or a portion of a user is detected by the computer system. Detection of a ready state configuration of a hand is used by a computer system as an indication that the user is likely preparing to interact with the computer system using one or more air gesture inputs performed by the hand (e.g., a pinch, tap, pinch and drag, double pinch, long pinch, or other air gesture described herein). For example, the ready state of the hand is determined based on whether the hand has a predetermined hand shape (e.g., a pre-pinch shape with a thumb and one or more fingers extended and spaced apart ready to make a pinch or grab gesture or a pre-tap with one or more fingers extended and palm facing away from the user), based on whether the hand is in a predetermined position relative to a viewpoint of the user (e.g., below the user's head and above the user's waist and extended out from the body by at least 15, 20, 25, 30, or 50 cm), and/or based on whether the hand has moved in a particular manner (e.g., moved toward a region in front of the user above the user's waist and below the user's head or moved away from the user's body or leg). In some embodiments, the ready state is used to determine whether interactive elements of the user interface respond to attention (e.g., gaze) inputs.

In scenarios where inputs are described with reference to air gestures, it should be understood that similar gestures could be detected using a hardware input device that is attached to or held by one or more hands of a user, where the position of the hardware input device in space can be tracked using optical tracking, one or more accelerometers, one or more gyroscopes, one or more magnetometers, and/or one or more inertial measurement units and the position and/or movement of the hardware input device is used in place of the position and/or movement of the one or more hands in the corresponding air gesture(s). In scenarios where inputs are described with reference to air gestures, it should be understood that similar gestures could be detected using a hardware input device that is attached to or held by one or more hands of a user. User inputs can be detected with controls contained in the hardware input device such as one or more touch-sensitive input elements, one or more pressure-sensitive input elements, one or more buttons, one or more knobs, one or more dials, one or more joysticks, one or more hand or finger coverings that can detect a position or change in position of portions of a hand and/or fingers relative to each other, relative to the user's body, and/or relative to a physical environment of the user, and/or other hardware input device controls, where the user inputs with the controls contained in the hardware input device are used in place of hand and/or finger gestures such as air taps or air pinches in the corresponding air gesture(s). For example, a selection input that is described as being performed with an air tap or air pinch input could be alternatively detected with a button press, a tap on a touch-sensitive surface, a press on a pressure-sensitive surface, or other hardware input. As another example, a movement input that is described as being performed with an air pinch and drag (e.g., an air drag gesture or an air swipe gesture) could be alternatively detected based on an interaction with the hardware input control such as a button press and hold, a touch on a touch-sensitive surface, a press on a pressure-sensitive surface, or other hardware input that is followed by movement of the hardware input device (e.g., along with the hand with which the hardware input device is associated) through space. Similarly, a two-handed input that includes movement of the hands relative to each other could be performed with one air gesture and one hardware input device in the hand that is not performing the air gesture, two hardware input devices held in different hands, or two air gestures performed by different hands using various combinations of air gestures and/or the inputs detected by one or more hardware input devices that are described above.

In some embodiments, the software may be downloaded to the controller 110 in electronic form, over a network, for example, or it may alternatively be provided on tangible, non-transitory media, such as optical, magnetic, or electronic memory media. In some embodiments, the database 408 is likewise stored in a memory associated with the controller 110. Alternatively or additionally, some or all of the described functions of the computer may be implemented in dedicated hardware, such as a custom or semi-custom integrated circuit or a programmable digital signal processor (DSP). Although the controller 110 is shown in FIG. 4, by way of example, as a separate unit from the image sensors 404, some or all of the processing functions of the controller may be performed by a suitable microprocessor and software or by dedicated circuitry within the housing of the image sensors 404 (e.g., a hand tracking device) or otherwise associated with the image sensors 404. In some embodiments, at least some of these processing functions may be carried out by a suitable processor that is integrated with the display generation component 120 (e.g., in a television set, a handheld device, or head-mounted device, for example) or with any other suitable computerized device, such as a game console or media player. The sensing functions of image sensors 404 may likewise be integrated into the computer or other computerized apparatus that is to be controlled by the sensor output.

FIG. 4 further includes a schematic representation of a depth map 410 captured by the image sensors 404, in accordance with some embodiments. The depth map, as explained above, comprises a matrix of pixels having respective depth values. The pixels 412 corresponding to the hand 406 have been segmented out from the background and the wrist in this map. The brightness of each pixel within the depth map 410 corresponds inversely to its depth value, i.e., the measured z distance from the image sensors 404, with the shade of gray growing darker with increasing depth. The controller 110 processes these depth values in order to identify and segment a component of the image (i.e., a group of neighboring pixels) having characteristics of a human hand. These characteristics, may include, for example, overall size, shape and motion from frame to frame of the sequence of depth maps.

FIG. 4 also schematically illustrates a hand skeleton 414 that controller 110 ultimately extracts from the depth map 410 of the hand 406, in accordance with some embodiments. In FIG. 4, the hand skeleton 414 is superimposed on a hand background 416 that has been segmented from the original depth map. In some embodiments, key feature points of the hand (e.g., points corresponding to knuckles, fingertips, center of the palm, end of the hand connecting to wrist, etc.) and optionally on the wrist or arm connected to the hand are identified and located on the hand skeleton 414. In some embodiments, location and movements of these key feature points over multiple image frames are used by the controller 110 to determine the hand gestures performed by the hand or the current state of the hand, in accordance with some embodiments.

FIG. 5 illustrates an example embodiment of the eye tracking device 130 (FIG. 1A). In some embodiments, the eye tracking device 130 is controlled by the eye tracking unit 243 (FIG. 2) to track the position and movement of the user's gaze with respect to the scene 105 or with respect to the XR content displayed via the display generation component 120. In some embodiments, the eye tracking device 130 is integrated with the display generation component 120. For example, in some embodiments, when the display generation component 120 is a head-mounted device such as headset, helmet, goggles, or glasses, or a handheld device placed in a wearable frame, the head-mounted device includes both a component that generates the XR content for viewing by the user and a component for tracking the gaze of the user relative to the XR content. In some embodiments, the eye tracking device 130 is separate from the display generation component 120. For example, when display generation component is a handheld device or an XR chamber, the eye tracking device 130 is optionally a separate device from the handheld device or XR chamber. In some embodiments, the eye tracking device 130 is a head-mounted device or part of a head-mounted device. In some embodiments, the head-mounted eye-tracking device 130 is optionally used in conjunction with a display generation component that is also head-mounted, or a display generation component that is not head-mounted. In some embodiments, the eye tracking device 130 is not a head-mounted device, and is optionally used in conjunction with a head-mounted display generation component. In some embodiments, the eye tracking device 130 is not a head-mounted device, and is optionally part of a non-head-mounted display generation component.

In some embodiments, the display generation component 120 uses a display mechanism (e.g., left and right near-eye display panels) for displaying frames including left and right images in front of a user's eyes to thus provide 3D virtual views to the user. For example, a head-mounted display generation component may include left and right optical lenses (referred to herein as eye lenses) located between the display and the user's eyes. In some embodiments, the display generation component may include or be coupled to one or more external video cameras that capture video of the user's environment for display. In some embodiments, a head-mounted display generation component may have a transparent or semi-transparent display through which a user may view the physical environment directly and display virtual objects on the transparent or semi-transparent display. In some embodiments, display generation component projects virtual objects into the physical environment. The virtual objects may be projected, for example, on a physical surface or as a holograph, so that an individual, using the system, observes the virtual objects superimposed over the physical environment. In such cases, separate display panels and image frames for the left and right eyes may not be necessary.

As shown in FIG. 5, in some embodiments, eye tracking device 130 (e.g., a gaze tracking device) includes at least one eye tracking camera (e.g., infrared (IR) or near-IR (NIR) cameras), and illumination sources (e.g., IR or NIR light sources such as an array or ring of LEDs) that emit light (e.g., IR or NIR light) towards the user's eyes. The eye tracking cameras may be pointed towards the user's eyes to receive reflected IR or NIR light from the light sources directly from the eyes, or alternatively may be pointed towards “hot” mirrors located between the user's eyes and the display panels that reflect IR or NIR light from the eyes to the eye tracking cameras while allowing visible light to pass. The eye tracking device 130 optionally captures images of the user's eyes (e.g., as a video stream captured at 60-120 frames per second (fps)), analyze the images to generate gaze tracking information, and communicate the gaze tracking information to the controller 110. In some embodiments, two eyes of the user are separately tracked by respective eye tracking cameras and illumination sources. In some embodiments, only one eye of the user is tracked by a respective eye tracking camera and illumination sources.

In some embodiments, the eye tracking device 130 is calibrated using a device-specific calibration process to determine parameters of the eye tracking device for the specific operating environment 100, for example the 3D geometric relationship and parameters of the LEDs, cameras, hot mirrors (if present), eye lenses, and display screen. The device-specific calibration process may be performed at the factory or another facility prior to delivery of the AR/VR equipment to the end user. The device-specific calibration process may be an automated calibration process or a manual calibration process. A user-specific calibration process may include an estimation of a specific user's eye parameters, for example the pupil location, fovea location, optical axis, visual axis, eye spacing, etc. Once the device-specific and user-specific parameters are determined for the eye tracking device 130, images captured by the eye tracking cameras can be processed using a glint-assisted method to determine the current visual axis and point of gaze of the user with respect to the display, in accordance with some embodiments.

As shown in FIG. 5, the eye tracking device 130 (e.g., 130A or 130B) includes eye lens(es) 520, and a gaze tracking system that includes at least one eye tracking camera 540 (e.g., infrared (IR) or near-IR (NIR) cameras) positioned on a side of the user's face for which eye tracking is performed, and an illumination source 530 (e.g., IR or NIR light sources such as an array or ring of NIR light-emitting diodes (LEDs)) that emit light (e.g., IR or NIR light) towards the user's eye(s) 592. The eye tracking cameras 540 may be pointed towards mirrors 550 located between the user's eye(s) 592 and a display 510 (e.g., a left or right display panel of a head-mounted display, or a display of a handheld device, a projector, etc.) that reflect IR or NIR light from the eye(s) 592 while allowing visible light to pass (e.g., as shown in the top portion of FIG. 5), or alternatively may be pointed towards the user's eye(s) 592 to receive reflected IR or NIR light from the eye(s) 592 (e.g., as shown in the bottom portion of FIG. 5).

In some embodiments, the controller 110 renders AR or VR frames 562 (e.g., left and right frames for left and right display panels) and provides the frames 562 to the display 510. The controller 110 uses gaze tracking input 542 from the eye tracking cameras 540 for various purposes, for example in processing the frames 562 for display. The controller 110 optionally estimates the user's point of gaze on the display 510 based on the gaze tracking input 542 obtained from the eye tracking cameras 540 using the glint-assisted methods or other suitable methods. The point of gaze estimated from the gaze tracking input 542 is optionally used to determine the direction in which the user is currently looking.

The following describes several possible use cases for the user's current gaze direction, and is not intended to be limiting. As an example use case, the controller 110 may render virtual content differently based on the determined direction of the user's gaze. For example, the controller 110 may generate virtual content at a higher resolution in a foveal region determined from the user's current gaze direction than in peripheral regions. As another example, the controller may position or move virtual content in the view based at least in part on the user's current gaze direction. As another example, the controller may display particular virtual content in the view based at least in part on the user's current gaze direction. As another example use case in AR applications, the controller 110 may direct external cameras for capturing the physical environments of the XR experience to focus in the determined direction. The autofocus mechanism of the external cameras may then focus on an object or surface in the environment that the user is currently looking at on the display 510. As another example use case, the eye lenses 520 may be focusable lenses, and the gaze tracking information is used by the controller to adjust the focus of the eye lenses 520 so that the virtual object that the user is currently looking at has the proper vergence to match the convergence of the user's eyes 592. The controller 110 may leverage the gaze tracking information to direct the eye lenses 520 to adjust focus so that close objects that the user is looking at appear at the right distance.

In some embodiments, the eye tracking device is part of a head-mounted device that includes a display (e.g., display 510), two eye lenses (e.g., eye lens(es) 520), eye tracking cameras (e.g., eye tracking camera(s) 540), and light sources (e.g., illumination sources 530 (e.g., IR or NIR LEDs)), mounted in a wearable housing. The light sources emit light (e.g., IR or NIR light) towards the user's eye(s) 592. In some embodiments, the light sources may be arranged in rings or circles around each of the lenses as shown in FIG. 5. In some embodiments, eight illumination sources 530 (e.g., LEDs) are arranged around each lens 520 as an example. However, more or fewer illumination sources 530 may be used, and other arrangements and locations of illumination sources 530 may be used.

In some embodiments, the display 510 emits light in the visible light range and does not emit light in the IR or NIR range, and thus does not introduce noise in the gaze tracking system. Note that the location and angle of eye tracking camera(s) 540 is given by way of example, and is not intended to be limiting. In some embodiments, a single eye tracking camera 540 is located on each side of the user's face. In some embodiments, two or more NIR cameras 540 may be used on each side of the user's face. In some embodiments, a camera 540 with a wider field of view (FOV) and a camera 540 with a narrower FOV may be used on each side of the user's face. In some embodiments, a camera 540 that operates at one wavelength (e.g., 850 nm) and a camera 540 that operates at a different wavelength (e.g., 940 nm) may be used on each side of the user's face.

Embodiments of the gaze tracking system as illustrated in FIG. 5 may, for example, be used in computer-generated reality, virtual reality, and/or mixed reality applications to provide computer-generated reality, virtual reality, augmented reality, and/or augmented virtuality experiences to the user.

FIG. 6 illustrates a glint-assisted gaze tracking pipeline, in accordance with some embodiments. In some embodiments, the gaze tracking pipeline is implemented by a glint-assisted gaze tracking system (e.g., eye tracking device 130 as illustrated in FIGS. 1A and 5). The glint-assisted gaze tracking system may maintain a tracking state. Initially, the tracking state is off or “NO”. When in the tracking state, the glint-assisted gaze tracking system uses prior information from the previous frame when analyzing the current frame to track the pupil contour and glints in the current frame. When not in the tracking state, the glint-assisted gaze tracking system attempts to detect the pupil and glints in the current frame and, if successful, initializes the tracking state to “YES” and continues with the next frame in the tracking state.

As shown in FIG. 6, the gaze tracking cameras may capture left and right images of the user's left and right eyes. The captured images are then input to a gaze tracking pipeline for processing beginning at 610. As indicated by the arrow returning to element 600, the gaze tracking system may continue to capture images of the user's eyes, for example at a rate of 60 to 120 frames per second. In some embodiments, each set of captured images may be input to the pipeline for processing. However, in some embodiments or under some conditions, not all captured frames are processed by the pipeline.

At 610, for the current captured images, if the tracking state is YES, then the method proceeds to element 640. At 610, if the tracking state is NO, then as indicated at 620 the images are analyzed to detect the user's pupils and glints in the images. At 630, if the pupils and glints are successfully detected, then the method proceeds to element 640. Otherwise, the method returns to element 610 to process next images of the user's eyes.

At 640, if proceeding from element 610, the current frames are analyzed to track the pupils and glints based in part on prior information from the previous frames. At 640, if proceeding from element 630, the tracking state is initialized based on the detected pupils and glints in the current frames. Results of processing at element 640 are checked to verify that the results of tracking or detection can be trusted. For example, results may be checked to determine if the pupil and a sufficient number of glints to perform gaze estimation are successfully tracked or detected in the current frames. At 650, if the results cannot be trusted, then the tracking state is set to NO at element 660, and the method returns to element 610 to process next images of the user's eyes. At 650, if the results are trusted, then the method proceeds to element 670. At 670, the tracking state is set to YES (if not already YES), and the pupil and glint information is passed to element 680 to estimate the user's point of gaze.

FIG. 6 is intended to serve as one example of eye tracking technology that may be used in a particular implementation. As recognized by those of ordinary skill in the art, other eye tracking technologies that currently exist or are developed in the future may be used in place of or in combination with the glint-assisted eye tracking technology describe herein in the computer system 101 for providing XR experiences to users, in accordance with various embodiments.

In some embodiments, the captured portions of real-world environment 602 are used to provide a XR experience to the user, for example, a mixed reality environment in which one or more virtual objects are superimposed over representations of real-world environment 602.

Thus, the description herein describes some embodiments of three-dimensional environments (e.g., XR environments) that include representations of real-world objects and representations of virtual objects. For example, a three-dimensional environment optionally includes a representation of a table that exists in the physical environment, which is captured and displayed in the three-dimensional environment (e.g., actively via cameras and displays of a computer system, or passively via a transparent or translucent display of the computer system). As described previously, the three-dimensional environment is optionally a mixed reality system in which the three-dimensional environment is based on the physical environment that is captured by one or more sensors of the computer system and displayed via a display generation component. As a mixed reality system, the computer system is optionally able to selectively display portions and/or objects of the physical environment such that the respective portions and/or objects of the physical environment appear as if they exist in the three-dimensional environment displayed by the computer system. Similarly, the computer system is optionally able to display virtual objects in the three-dimensional environment to appear as if the virtual objects exist in the real world (e.g., physical environment) by placing the virtual objects at respective locations in the three-dimensional environment that have corresponding locations in the real world. For example, the computer system optionally displays a vase such that it appears as if a real vase is placed on top of a table in the physical environment. In some embodiments, a respective location in the three-dimensional environment has a corresponding location in the physical environment. Thus, when the computer system is described as displaying a virtual object at a respective location with respect to a physical object (e.g., such as a location at or near the hand of the user, or at or near a physical table), the computer system displays the virtual object at a particular location in the three-dimensional environment such that it appears as if the virtual object is at or near the physical object in the physical world (e.g., the virtual object is displayed at a location in the three-dimensional environment that corresponds to a location in the physical environment at which the virtual object would be displayed if it were a real object at that particular location).

In some embodiments, real world objects that exist in the physical environment that are displayed in the three-dimensional environment (e.g., and/or visible via the display generation component) can interact with virtual objects that exist only in the three-dimensional environment. For example, a three-dimensional environment can include a table and a vase placed on top of the table, with the table being a view of (or a representation of) a physical table in the physical environment, and the vase being a virtual object.

In a three-dimensional environment (e.g., a real environment, a virtual environment, or an environment that includes a mix of real and virtual objects), objects are sometimes referred to as having a depth or simulated depth, or objects are referred to as being visible, displayed, or placed at different depths. In this context, depth refers to a dimension other than height or width. In some embodiments, depth is defined relative to a fixed set of coordinates (e.g., where a room or an object has a height, depth, and width defined relative to the fixed set of coordinates). In some embodiments, depth is defined relative to a location or viewpoint of a user, in which case, the depth dimension varies based on the location of the user and/or the location and angle of the viewpoint of the user. In some embodiments where depth is defined relative to a location of a user that is positioned relative to a surface of an environment (e.g., a floor of an environment, or a surface of the ground), objects that are further away from the user along a line that extends parallel to the surface are considered to have a greater depth in the environment, and/or the depth of an object is measured along an axis that extends outward from a location of the user and is parallel to the surface of the environment (e.g., depth is defined in a cylindrical or substantially cylindrical coordinate system with the position of the user at the center of the cylinder that extends from a head of the user toward feet of the user). In some embodiments where depth is defined relative to viewpoint of a user (e.g., a direction relative to a point in space that determines which portion of an environment that is visible via a head mounted device or other display), objects that are further away from the viewpoint of the user along a line that extends parallel to the direction of the viewpoint of the user are considered to have a greater depth in the environment, and/or the depth of an object is measured along an axis that extends outward from a line that extends from the viewpoint of the user and is parallel to the direction of the viewpoint of the user (e.g., depth is defined in a spherical or substantially spherical coordinate system with the origin of the viewpoint at the center of the sphere that extends outwardly from a head of the user). In some embodiments, depth is defined relative to a user interface container (e.g., a window or application in which application and/or system content is displayed) where the user interface container has a height and/or width, and depth is a dimension that is orthogonal to the height and/or width of the user interface container. In some embodiments, in circumstances where depth is defined relative to a user interface container, the height and or width of the container are typically orthogonal or substantially orthogonal to a line that extends from a location based on the user (e.g., a viewpoint of the user or a location of the user) to the user interface container (e.g., the center of the user interface container, or another characteristic point of the user interface container) when the container is placed in the three-dimensional environment or is initially displayed (e.g., so that the depth dimension for the container extends outward away from the user or the viewpoint of the user). In some embodiments, in situations where depth is defined relative to a user interface container, depth of an object relative to the user interface container refers to a position of the object along the depth dimension for the user interface container. In some embodiments, multiple different containers can have different depth dimensions (e.g., different depth dimensions that extend away from the user or the viewpoint of the user in different directions and/or from different starting points). In some embodiments, when depth is defined relative to a user interface container, the direction of the depth dimension remains constant for the user interface container as the location of the user interface container, the user and/or the viewpoint of the user changes (e.g., or when multiple different viewers are viewing the same container in the three-dimensional environment such as during an in-person collaboration session and/or when multiple participants are in a real-time communication session with shared virtual content including the container). In some embodiments, for curved containers (e.g., including a container with a curved surface or curved content region), the depth dimension optionally extends into a surface of the curved container. In some situations, z-separation (e.g., separation of two objects in a depth dimension), z-height (e.g., distance of one object from another in a depth dimension), z-position (e.g., position of one object in a depth dimension), z-depth (e.g., position of one object in a depth dimension), or simulated z dimension (e.g., depth used as a dimension of an object, dimension of an environment, a direction in space, and/or a direction in simulated space) are used to refer to the concept of depth as described above.

In some embodiments, a user is optionally able to interact with virtual objects in the three-dimensional environment using one or more hands as if the virtual objects were real objects in the physical environment. For example, as described above, one or more sensors of the computer system optionally capture one or more of the hands of the user and display representations of the hands of the user in the three-dimensional environment (e.g., in a manner similar to displaying a real world object in three-dimensional environment described above), or in some embodiments, the hands of the user are visible via the display generation component via the ability to see the physical environment through the user interface due to the transparency/translucency of a portion of the display generation component that is displaying the user interface or due to projection of the user interface onto a transparent/translucent surface or projection of the user interface onto the user's eye or into a field of view of the user's eye. Thus, in some embodiments, the hands of the user are displayed at a respective location in the three-dimensional environment and are treated as if they were objects in the three-dimensional environment that are able to interact with the virtual objects in the three-dimensional environment as if they were physical objects in the physical environment. In some embodiments, the computer system is able to update display of the representations of the user's hands in the three-dimensional environment in conjunction with the movement of the user's hands in the physical environment.

In some of the embodiments described below, the computer system is optionally able to determine the “effective” distance between physical objects in the physical world and virtual objects in the three-dimensional environment, for example, for the purpose of determining whether a physical object is directly interacting with a virtual object (e.g., whether a hand is touching, grabbing, holding, etc. a virtual object or within a threshold distance of a virtual object). For example, a hand directly interacting with a virtual object optionally includes one or more of a finger of a hand pressing a virtual button, a hand of a user grabbing a virtual vase, two fingers of a hand of the user coming together and pinching/holding a user interface of an application, and any of the other types of interactions described here. For example, the computer system optionally determines the distance between the hands of the user and virtual objects when determining whether the user is interacting with virtual objects and/or how the user is interacting with virtual objects. In some embodiments, the computer system determines the distance between the hands of the user and a virtual object by determining the distance between the location of the hands in the three-dimensional environment and the location of the virtual object of interest in the three-dimensional environment. For example, the one or more hands of the user are located at a particular position in the physical world, which the computer system optionally captures and displays at a particular corresponding position in the three-dimensional environment (e.g., the position in the three-dimensional environment at which the hands would be displayed if the hands were virtual, rather than physical, hands). The position of the hands in the three-dimensional environment is optionally compared with the position of the virtual object of interest in the three-dimensional environment to determine the distance between the one or more hands of the user and the virtual object. In some embodiments, the computer system optionally determines a distance between a physical object and a virtual object by comparing positions in the physical world (e.g., as opposed to comparing positions in the three-dimensional environment). For example, when determining the distance between one or more hands of the user and a virtual object, the computer system optionally determines the corresponding location in the physical world of the virtual object (e.g., the position at which the virtual object would be located in the physical world if it were a physical object rather than a virtual object), and then determines the distance between the corresponding physical position and the one of more hands of the user. In some embodiments, the same techniques are optionally used to determine the distance between any physical object and any virtual object. Thus, as described herein, when determining whether a physical object is in contact with a virtual object or whether a physical object is within a threshold distance of a virtual object, the computer system optionally performs any of the techniques described above to map the location of the physical object to the three-dimensional environment and/or map the location of the virtual object to the physical environment.

In some embodiments, the same or similar technique is used to determine where and what the gaze of the user is directed to and/or where and at what a physical stylus held by a user is pointed. For example, if the gaze of the user is directed to a particular position in the physical environment, the computer system optionally determines the corresponding position in the three-dimensional environment (e.g., the virtual position of the gaze), and if a virtual object is located at that corresponding virtual position, the computer system optionally determines that the gaze of the user is directed to that virtual object. Similarly, the computer system is optionally able to determine, based on the orientation of a physical stylus, to where in the physical environment the stylus is pointing. In some embodiments, based on this determination, the computer system determines the corresponding virtual position in the three-dimensional environment that corresponds to the location in the physical environment to which the stylus is pointing, and optionally determines that the stylus is pointing at the corresponding virtual position in the three-dimensional environment.

Similarly, the embodiments described herein may refer to the location of the user (e.g., the user of the computer system) and/or the location of the computer system in the three-dimensional environment. In some embodiments, the user of the computer system is holding, wearing, or otherwise located at or near the computer system. Thus, in some embodiments, the location of the computer system is used as a proxy for the location of the user. In some embodiments, the location of the computer system and/or user in the physical environment corresponds to a respective location in the three-dimensional environment. For example, the location of the computer system would be the location in the physical environment (and its corresponding location in the three-dimensional environment) from which, if a user were to stand at that location facing a respective portion of the physical environment that is visible via the display generation component, the user would see the objects in the physical environment in the same positions, orientations, and/or sizes as they are displayed by or visible via the display generation component of the computer system in the three-dimensional environment (e.g., in absolute terms and/or relative to each other). Similarly, if the virtual objects displayed in the three-dimensional environment were physical objects in the physical environment (e.g., placed at the same locations in the physical environment as they are in the three-dimensional environment, and having the same sizes and orientations in the physical environment as in the three-dimensional environment), the location of the computer system and/or user is the position from which the user would see the virtual objects in the physical environment in the same positions, orientations, and/or sizes as they are displayed by the display generation component of the computer system in the three-dimensional environment (e.g., in absolute terms and/or relative to each other and the real world objects).

In the present disclosure, various input methods are described with respect to interactions with a computer system. When an example is provided using one input device or input method and another example is provided using another input device or input method, it is to be understood that each example may be compatible with and optionally utilizes the input device or input method described with respect to another example. Similarly, various output methods are described with respect to interactions with a computer system. When an example is provided using one output device or output method and another example is provided using another output device or output method, it is to be understood that each example may be compatible with and optionally utilizes the output device or output method described with respect to another example. Similarly, various methods are described with respect to interactions with a virtual environment or a mixed reality environment through a computer system. When an example is provided using interactions with a virtual environment and another example is provided using mixed reality environment, it is to be understood that each example may be compatible with and optionally utilizes the methods described with respect to another example. As such, the present disclosure discloses embodiments that are combinations of the features of multiple examples, without exhaustively listing all features of an embodiment in the description of each example embodiment.

### User Interfaces and Associated Processes

Attention is now directed towards embodiments of user interfaces (“UI”) and associated processes that may be implemented on a computer system, such as a portable multifunction device or a head-mounted device, in communication with one or more display generation components, one or more input devices, and optionally one or cameras.

FIGS. 7A-7O, FIGS. 8A-8X, FIGS. 9A-9P, FIGS. 10A-10I, and FIGS. 11A-11F include illustrations of three-dimensional environments that are visible via a display generation component (e.g., a display generation component 7100a or a display generation component 120) of a computer system (e.g., computer system 101) and interactions that occur in the three-dimensional environments caused by user inputs directed to the three-dimensional environments and/or inputs received from other computer systems and/or sensors. In some embodiments, an input is directed to a virtual object within a three-dimensional environment by a user's gaze detected in the region occupied by the virtual object, or by a hand gesture performed at a location in the physical environment that corresponds to the region of the virtual object. In some embodiments, an input is directed to a virtual object within a three-dimensional environment by a hand gesture that is performed (e.g., optionally, at a location in the physical environment that is independent of the region of the virtual object in the three-dimensional environment) while the virtual object has input focus (e.g., while the virtual object has been selected by a concurrently and/or previously detected gaze input, selected by a concurrently or previously detected pointer input, and/or selected by a concurrently and/or previously detected gesture input). In some embodiments, an input is directed to a virtual object within a three-dimensional environment by an input device that has positioned a focus selector object (e.g., a pointer object or selector object) at the position of the virtual object. In some embodiments, an input is directed to a virtual object within a three-dimensional environment via other means (e.g., voice and/or control button). In some embodiments, an input is directed to a representation of a physical object or a virtual object that corresponds to a physical object by the user's hand movement (e.g., whole hand movement, whole hand movement in a respective posture, movement of one portion of the user's hand relative to another portion of the hand, and/or relative movement between two hands) and/or manipulation with respect to the physical object (e.g., touching, swiping, tapping, opening, moving toward, and/or moving relative to). In some embodiments, the computer system displays some changes in the three-dimensional environment (e.g., displaying additional virtual content, ceasing to display existing virtual content, and/or transitioning between different levels of immersion with which visual content is being displayed) in accordance with inputs from sensors (e.g., image sensors, temperature sensors, biometric sensors, motion sensors, and/or proximity sensors) and contextual conditions (e.g., location, time, and/or presence of others in the environment). In some embodiments, the computer system displays some changes in the three-dimensional environment (e.g., displaying additional virtual content, ceasing to display existing virtual content, and/or transitioning between different levels of immersion with which visual content is being displayed) in accordance with inputs from other computers used by other users that are sharing the computer-generated environment with the user of the computer system (e.g., in a shared computer-generated experience, in a shared virtual environment, and/or in a shared virtual or augmented reality environment of a communication session). In some embodiments, the computer system displays some changes in the three-dimensional environment (e.g., displaying movement, deformation, and/or changes in visual characteristics of a user interface, a virtual surface, a user interface object, and/or virtual scenery) in accordance with inputs from sensors that detect movement of other persons and objects and movement of the user that may not qualify as a recognized gesture input for triggering an associated operation of the computer system.

In some embodiments, a three-dimensional environment that is visible via a display generation component described herein is a virtual three-dimensional environment that includes virtual objects and content at different virtual positions in the three-dimensional environment without a representation of the physical environment. In some embodiments, the three-dimensional environment is a mixed reality environment that displays virtual objects at different virtual positions in the three-dimensional environment that are constrained by one or more physical aspects of the physical environment (e.g., positions and orientations of walls, floors, surfaces, direction of gravity, time of day, and/or spatial relationships between physical objects). In some embodiments, the three-dimensional environment is an augmented reality environment that includes a representation of the physical environment. In some embodiments, the representation of the physical environment includes respective representations of physical objects and surfaces at different positions in the three-dimensional environment, such that the spatial relationships between the different physical objects and surfaces in the physical environment are reflected by the spatial relationships between the representations of the physical objects and surfaces in the three-dimensional environment. In some embodiments, when virtual objects are placed relative to the positions of the representations of physical objects and surfaces in the three-dimensional environment, they appear to have corresponding spatial relationships with the physical objects and surfaces in the physical environment. In some embodiments, the computer system transitions between displaying the different types of environments (e.g., transitions between presenting a computer-generated environment or experience with different levels of immersion, adjusting the relative prominence of audio/visual sensory inputs from the virtual content and from the representation of the physical environment) based on user inputs and/or contextual conditions.

In some embodiments, the display generation component includes a pass-through portion in which the representation of the physical environment is displayed or visible. In some embodiments, the pass-through portion of the display generation component is a transparent or semi-transparent (e.g., see-through) portion of the display generation component revealing at least a portion of a physical environment surrounding and within the field of view of a user (sometimes called “optical passthrough”). For example, the pass-through portion is a portion of a head-mounted display or heads-up display that is made semi-transparent (e.g., less than 50%, 40%, 30%, 20%, 15%, 10%, or 5% of opacity) or transparent, such that the user can see through it to view the real world surrounding the user without removing the head-mounted display or moving away from the heads-up display. In some embodiments, the pass-through portion gradually transitions from semi-transparent or transparent to fully opaque when displaying a virtual or mixed reality environment. In some embodiments, the pass-through portion of the display generation component displays a live feed of images or video of at least a portion of physical environment captured by one or more cameras (e.g., rear facing camera(s) of a mobile device or associated with a head-mounted display, or other cameras that feed image data to the computer system) (sometimes called “digital passthrough”). In some embodiments, the one or more cameras point at a portion of the physical environment that is directly in front of the user's eyes (e.g., behind the display generation component relative to the user of the display generation component). In some embodiments, the one or more cameras point at a portion of the physical environment that is not directly in front of the user's eyes (e.g., in a different physical environment, or to the side of or behind the user).

In some embodiments, when displaying virtual objects at positions that correspond to locations of one or more physical objects in the physical environment (e.g., at positions in a virtual reality environment, a mixed reality environment, or an augmented reality environment), at least some of the virtual objects are displayed in place of (e.g., replacing display of) a portion of the live view (e.g., a portion of the physical environment captured in the live view) of the cameras. In some embodiments, at least some of the virtual objects and content are projected onto physical surfaces or empty space in the physical environment and are visible through the pass-through portion of the display generation component (e.g., viewable as part of the camera view of the physical environment, or through the transparent or semi-transparent portion of the display generation component). In some embodiments, at least some of the virtual objects and virtual content are displayed to overlay a portion of the display and block the view of at least a portion of the physical environment visible through the transparent or semi-transparent portion of the display generation component.

In some embodiments, the display generation component displays different views of the three-dimensional environment in accordance with user inputs or movements that change the virtual position of the viewpoint of the currently displayed view of the three-dimensional environment relative to the three-dimensional environment. In some embodiments, when the three-dimensional environment is a virtual environment, the viewpoint moves in accordance with navigation or locomotion requests (e.g., in-air hand gestures, and/or gestures performed by movement of one portion of the hand relative to another portion of the hand) without requiring movement of the user's head, torso, and/or the display generation component in the physical environment. In some embodiments, movement of the user's head and/or torso, and/or the movement of the display generation component or other location sensing elements of the computer system (e.g., due to the user holding the display generation component or wearing the HMD), relative to the physical environment, cause corresponding movement of the viewpoint (e.g., with corresponding movement direction, movement distance, movement speed, and/or change in orientation) relative to the three-dimensional environment, resulting in corresponding change in the currently displayed view of the three-dimensional environment. In some embodiments, when a virtual object has a preset spatial relationship relative to the viewpoint (e.g., is anchored or fixed to the viewpoint), movement of the viewpoint relative to the three-dimensional environment would cause movement of the virtual object relative to the three-dimensional environment while the position of the virtual object in the field of view is maintained (e.g., the virtual object is said to be head locked). In some embodiments, a virtual object is body-locked to the user, and moves relative to the three-dimensional environment when the user moves as a whole in the physical environment (e.g., carrying or wearing the display generation component and/or other location sensing component of the computer system), but will not move in the three-dimensional environment in response to the user's head movement alone (e.g., the display generation component and/or other location sensing component of the computer system rotating around a fixed location of the user in the physical environment). In some embodiments, a virtual object is, optionally, locked to another portion of the user, such as a user's hand or a user's wrist, and moves in the three-dimensional environment in accordance with movement of the portion of the user in the physical environment, to maintain a preset spatial relationship between the position of the virtual object and the virtual position of the portion of the user in the three-dimensional environment. In some embodiments, a virtual object is locked to a preset portion of a field of view provided by the display generation component, and moves in the three-dimensional environment in accordance with the movement of the field of view, irrespective of movement of the user that does not cause a change of the field of view.

In some embodiments, the views of a three-dimensional environment sometimes do not include representation(s) of a user's hand(s), arm(s), and/or wrist(s). In some embodiments, as shown in FIGS. 7A-7O, 8A-8X, 9A-9P,10A-10I, and 11A-11F, the representation(s) of a user's hand(s), arm(s), and/or wrist(s) are included in the views of a three-dimensional environment. In some embodiments, the representation(s) of a user's hand(s), arm(s), and/or wrist(s) are included in the views of a three-dimensional environment as part of the representation of the physical environment provided via the display generation component. In some embodiments, the representations are not part of the representation of the physical environment and are separately captured (e.g., by one or more cameras pointing toward the user's hand(s), arm(s), and wrist(s)) and displayed in the three-dimensional environment independent of the currently displayed view of the three-dimensional environment. In some embodiments, the representation(s) include camera images as captured by one or more cameras of the computer system(s), or stylized versions of the arm(s), wrist(s) and/or hand(s) based on information captured by various sensors). In some embodiments, the representation(s) replace display of, are overlaid on, or block the view of, a portion of the representation of the physical environment. In some embodiments, when the display generation component does not provide a view of a physical environment, and provides a completely virtual environment (e.g., no camera view and no transparent pass-through portion), real-time visual representations (e.g., stylized representations or segmented camera images) of one or both arms, wrists, and/or hands of the user are, optionally, still displayed in the virtual environment. In some embodiments, if a representation of the user's hand is not provided in the view of the three-dimensional environment, the position that corresponds to the user's hand is optionally indicated in the three-dimensional environment, e.g., by the changing appearance of the virtual content (e.g., through a change in translucency and/or simulated reflective index) at positions in the three-dimensional environment that correspond to the location of the user's hand in the physical environment. In some embodiments, the representation of the user's hand or wrist is outside of the currently displayed view of the three-dimensional environment while the virtual position in the three-dimensional environment that corresponds to the location of the user's hand or wrist is outside of the current field of view provided via the display generation component; and the representation of the user's hand or wrist is made visible in the view of the three-dimensional environment in response to the virtual position that corresponds to the location of the user's hand or wrist being moved within the current field of view due to movement of the display generation component, the user's hand or wrist, the user's head, and/or the user as a whole.

FIGS. 7A-7O illustrate examples of displaying a user interface element while a volumetric application is displayed in the viewport. FIGS. 12A-12G are flow diagrams of an exemplary method 12000 for displaying a user interface element while a volumetric application is displayed in the viewport. The user interfaces in FIGS. 7B-7O are used to illustrate the processes described below, including the processes in FIGS. 12A-12G.

FIG. 7A illustrates an example physical environment 7000 that includes a user 7002 interacting with a computer system 101. Computer system 101 is worn on a head of the user 7002 (e.g., sometimes referred to as the user 7002's head) and typically positioned in front of user 7002. In FIG. 7A, user 7002's left hand 7020 and right hand 7022 are free to interact with computer system 101. Physical environment 7000 includes a physical object 7014, physical walls 7004 and 7006, and a physical floor 7008. As shown in the examples in FIGS. 7B-7O, display generation component 7100a of computer system 101 is a head-mounted display (TIMID) worn on user 7002's head (e.g., what is shown in FIGS. 7A-7O as being visible via display generation component 7100a of computer system 101 corresponds to user 7002's viewport into an environment when wearing a head-mounted display).

In some embodiments, the head mounted display (HMD) 7100a includes one or more displays that display a representation of a portion of the three-dimensional environment 7000′ that corresponds to the perspective of the user. While an HMD typically includes multiple displays including a display for a right eye and a separate display for a left eye that display slightly different images to generate user interfaces with stereoscopic depth, in FIGS. 7B-7O, a single image is shown that corresponds to the image for a single eye and depth information is indicated with other annotations or description of the figures. In some embodiments, HMD 7100a includes one or more sensors (e.g., one or more interior- and/or exterior-facing image sensors 314), such as sensor 7101a, sensor 7101b and/or sensor 7101c (FIG. 7B) for detecting a state of the user, including facial and/or eye tracking of the user (e.g., using one or more inward-facing sensors 7101a and/or 7101b) and/or tracking hand, torso, or other movements of the user (e.g., using one or more outward-facing sensors 7101c). In some embodiments, HMD 7100a includes one or more input devices that are optionally located on a housing of HMD 7100a, such as one or more buttons, trackpads, touchscreens, scroll wheels, digital crowns that are rotatable and depressible or other input devices. In some embodiments, input elements are mechanical input elements; in some embodiments, input elements are solid state input elements that respond to press inputs based on detected pressure or intensity. For example, in FIGS. 7B-7O, HMD 7100a includes one or more of button 701, button 702 and digital crown 703 for providing inputs to HMD 7100a. It will be understood that additional and/or alternative input devices may be included in HMD 7100a.

In some embodiments, the display generation component of computer system 101 is a touchscreen held by user 7002. In some embodiments, the display generation component is a standalone display, a projector, or another type of display. In some embodiments, the computer system is in communication with one or more input devices, including cameras or other sensors and input devices that detect movement of the user's hand(s), movement of the user's body as whole, and/or movement of the user's head in the physical environment. In some embodiments, the one or more input devices detect the movement and the current postures, orientations, and positions of the user's hand(s), face, and/or body as a whole. For example, in some embodiments, while the user's hand 7020 (e.g., a left hand) is within the field of view of the one or more sensors of HMD 7100a (e.g., within the viewport of the user), a representation of the user's hand 7020′ is displayed in the user interface displayed (e.g., as a passthrough representation and/or as a virtual representation of the user's hand 7020) on the display of HMD 7100a. In some embodiments, while the user's hand 7022 (e.g., a right hand) is within the field of view of the one or more sensors of HMD 7100a (e.g., within the viewport of the user), a representation of the user's hand 7022′ is displayed in the user interface displayed (e.g., as a passthrough representation and/or as a virtual representation of the user's hand 7022) on the display of HMD 7100a. In some embodiments, the user's hand 7020 and/or the user's hand 7022 are used to perform one or more gestures (e.g., one or more air gestures), optionally in combination with a gaze input. In some embodiments, the one or more gestures performed with the user's hand(s) 7020 and/or 7022 include a direct air gesture input that is based on a position of the representation of the user's hand(s) 7020′ and/or 7022′ displayed within the user interface on the display of HMD 7100a. For example, a direct air gesture input is determined as being directed to a user interface object displayed at a position that intersects with the displayed position of the representation of the user's hand(s) 7020′ and/or 7022′ in the user interface. In some embodiments, the one or more gestures performed with the user's hand(s) 7020 and/or 7022 include an indirect air gesture input that is based on a virtual object displayed at a position that corresponds to a position at which the user's attention is currently detected (e.g., and/or is optionally not based on a position of the representation of the user's hand(s) 7020′ and/or 7022′ displayed within the user interface). For example, an indirect air gesture is performed with respect to a user interface object while detecting the user's attention (e.g., based on gaze or other indication of user attention) on the user interface object, such as a gaze and pinch (e.g., or other gesture performed with the user's hand).

In some embodiments, user inputs are detected via a touch-sensitive surface or touchscreen. In some embodiments, the one or more input devices include an eye tracking component that detects location and movement of the user's gaze. In some embodiments, the display generation component, and optionally, the one or more input devices and the computer system, are parts of a head-mounted device that moves and rotates with the user's head in the physical environment, and changes the viewpoint of the user in the three-dimensional environment provided via the display generation component. In some embodiments, the display generation component is a heads-up display that does not move or rotate with the user's head or the user's body as a whole, but, optionally, changes the viewpoint of the user in the three-dimensional environment in accordance with the movement of the user's head or body relative to the display generation component. In some embodiments, the display generation component (e.g., a touchscreen) is optionally moved and rotated by the user's hand relative to the physical environment or relative to the user's head, and changes the viewpoint of the user in the three-dimensional environment in accordance with the movement of the display generation component relative to the user's head or face or relative to the physical environment.

In some embodiments, one or more portions of the view of physical environment 7000 that is visible to user 7002 via display generation component 7100a are digital passthrough portions that include representations of corresponding portions of physical environment 7000 captured via one or more image sensors of computer system 101. In some embodiments, one or more portions of the view of physical environment 7000 that is visible to user 7002 via display generation component 7100a are optical passthrough portions, in that user 7002 can see one or more portions of physical environment 7000 through one or more transparent or semi-transparent portions of display generation component 7100a.

FIG. 7B illustrates a view of a three-dimensional environment (e.g., corresponding at least partially to the physical environment 7000 in FIG. 7A) that is visible to the user 7002 via HMD 7100a of the computer system 101. The three-dimensional environment includes an application user interface 7030 that displays three-dimensional application content including one or more user interface elements having a non-zero length, non-zero width, and non-zero depth. The three-dimensional application content elements of the application user interface 7030 are enclosed within (e.g., bounded by) a three-dimensional volume (e.g., having a horizontal, a vertical and/or a depth dimension; and/or a radial and/or an azimuthal dimension), demarcated by a three-dimensional outline 7034 that is optionally not displayed to the user 7002. In some embodiments, the computer system 101 displays a portion of the outline 7034 (e.g., visually indicating a lower horizontal boundary of the three-dimensional application volume) while attention of the user 7002 is directed to one or more regions of the application user interface 7030, and/or while the user 7002 performs operations on the application user interface 7030, as described with reference to FIGS. 8A-8X. In some embodiments, one or more of the three-dimensional application content elements within the application user interface 7030 are responsive to user input. For example, the three-dimensional application content elements may be interactive elements. In some embodiments, the user 7002 is enabled to perform operations (e.g., a searching function) within the three-dimensional application content, and/or enabled to manipulate one or more user interface elements within the three-dimensional application content. In some embodiments, the user 7002 may be immersed in and/or be surrounded by the three-dimensional application content elements of the application user interface 7030. In the example of FIG. 7B, the outline 7034 of the application user interface 7030 has a cylindrical shape (e.g., a hollow cylinder that encloses the three-dimensional application content elements) within which the application user interface 7030 displays a number of buildings, a park, and a number of informational pins or alerts. A move affordance 7032 associated with the application user interface 7030 is optionally displayed (e.g., independently of attention of the user 7002). Top view 7036 shows the viewpoint 7002′ of the user 7002 at a threshold distance Dₜₕ (e.g., 40, 50, 60, 70, 80, 90, 100, 120 cm or another distance threshold) from the application user interface 7030.

FIG. 7C illustrates an example transition from FIG. 7B. In response to detecting an event (e.g., a system-generated event or an application-generated event, optionally an event generated in response to a user input from the user 7002) while the application user interface 7030 is displayed in the viewport of the user 7002, and in accordance with a determination that a position of the user 7002 within the three-dimensional environment when the event was detected is at or more than a threshold distance Dₜₕ from a characteristic portion of the application user interface 7030 (e.g., a portion of on the outline 7034 of the application user interface 7030, a portion of the application user interface 7030 closest to the user, a portion of the application user interface 7030 towards which the attention of the user 7002 is directed, and/or that optionally intersects the outline 7034), the computer system 101 displays a first user interface element 7038 at a respective distance from a boundary of the application user interface 7030 (e.g., at or near the boundary, tangential to and/or on an exterior surface of the outline 7034), on a first side of the boundary (e.g., on or outside of the boundary). In some embodiments, application user interface 7030 is visually deemphasized relative to the first user interface element 7038 (e.g., by increasing a degree of blurring, decreasing a brightness, decreasing a saturation, decreasing visual intensity, decreasing a contrast, decreasing an opacity, and/or other visual deemphasis) due to the computer system 101 displaying the first user interface element 7038.

In some embodiments, the first user interface element 7038 includes a first content item 7040 and a second content item 7042. In some embodiments, the first user interface element 7038 includes only the first content item 7040. In some embodiments, the first content item 7040 and/or the second content item 7042 include one or more selectable user interface elements (e.g., buttons, check-boxes, and/or other elements) for performing respective operations (e.g., dismissing the first user interface element 7038, accepting an incoming communication request, and/or other operations).

In some embodiments, an orientation of the first user interface element 7038 (e.g., represented by a vector 7039 that is parallel to a plane of the first user interface element 7038) is parallel to an edge 7041 (e.g., a vertical dimension) of the outline 7034. FIG. 7C also illustrates an alternative placement 7044 of the first user interface element 7038 if the user 7002 were to move leftwards as illustrated in top view 7046 to a second position 7048 within the three-dimensional environment, or if the user 7002 had been at the second position 7048 when the event triggering display of the first user interface element 7038 was detected. As FIG. 7C illustrates the viewport of the user 7002 while the user 7002 faces the wall 7004′, the alternative placement 7044 of the first user interface element 7038 is illustrated from the perspective of that viewport (e.g., whereas the user 7002 at the second position 7048 would be presented with the first user interface element 7038 at the alternative placement 7044 being substantially perpendicular to the user 7002's viewpoint).

FIG. 7D illustrates an alternative scenario to FIG. 7C. In response to detecting an event (e.g., a system-generated event or an application-generated event, optionally in response to user input from the user 7002) while the application user interface 7030 is displayed in the viewport of the user 7002, and in accordance with a determination that a distance 7037 of the viewpoint of the user 7002 from the characteristic portion of the application user interface 7030 when the event was detected is less than the threshold distance Dₜₕ, the computer system 101 displays the first user interface element 7038 within the three-dimensional application volume of the application user interface 7030 (e.g., the first user interface element 7038 is in some circumstances pushed in depth, away from the viewpoint of the user, with respect to the application user interface 7030 compared to the position of the first user interface element 7038 illustrated in FIG. 7B) to maintain the threshold distance Dₜₕ between the viewpoint of the user 7002 and the first user interface element 7038, optionally while visually deemphasizing application content of the application user interface 7030. For example, the user 7002 may have moved their viewpoint closer to the application user interface 7030 within the three-dimensional environment between the viewport illustrated in FIG. 7B and the viewport illustrated in FIG. 7D (or the user 7002 may have moved the application user interface 7030 toward the viewpoint of the user 7002, optionally without changing a location of the user 7002 within the three-dimensional environment). Top view 7054 shows that the first user interface element 7038 is displayed within the three-dimensional application volume of the application user interface 7030, at the threshold distance Dₜₕ away from the viewpoint 7002′ of the user 7002.

In some embodiments, in accordance with a determination that displaying the first user interface element 7038 within the three-dimensional application volume of the application user interface 7030 (e.g., at the threshold distance Dₜₕ from the viewpoint of the user 7002) causes a spatial conflict between the first user interface element 7038 and one or more application content elements (e.g., two-dimensional content elements, and/or three-dimensional content elements) of the application user interface 7030 (e.g., one or more portions of the first user interface element 7038 and one or more portions of application content of the application user interface 7030 would have been displayed at the same location in the three-dimensional environment, and/or one or more portions of the first user interface element 7038 would have been blocked from the viewpoint of the user 7002 by one or more portions of the application content elements of the application user interface 7030 if attention of the user 7002 were to be directed toward the first user interface element 7038), computer system 101 changes one or more visual properties (e.g., a visual intensity, an opacity, a degree of blurring, a contrast, and/or other visual properties) of the application content elements of the application user interface 7030 that spatially conflict with the first user interface element 7038, to increase a visibility of the first user interface element 7038 from the viewpoint of the user 7002. As illustrated in FIG. 7D, region 7050 and region 7052 represent portions of the application content of the application user interface 7030 that spatially conflict with the first user interface element 7038. By changing the one or more visual properties of the application content elements of the application user interface 7030 or at least of region 7050 and region 7052, the visibility of the first user interface element 7038 is increased, with respect to the viewpoint of the user 7002. Details about how the computer system 101 changes one or more visual properties of application content to reduce and/or resolve spatial conflicts are described with reference to FIGS. 11A-11F.

In some embodiments, an orientation of the first user interface element 7038 is based on an orientation of one or more affordances associated with the application user interface 7030 (e.g., the move affordance 7032). Details about how the computer system 101 displays the one or more affordances associated with the application user interface 7030 based on a viewpoint of the user 7002 are described with reference to FIGS. 10A-10I. For example, a plane on which the information of the first user interface element 7038 is displayed may be parallel to a plane of the move affordance 7032 that faces the viewpoint of the user.

FIG. 7E illustrates an application user interface 7056 that also displays three-dimensional application content elements. The three-dimensional application content elements of the application user interface 7056 are enclosed within (e.g., bounded by) a three-dimensional volume (e.g., having a horizontal, a vertical and/or a depth dimension; and/or a radial and/or an azimuthal dimension) having a cuboidal shape (e.g., a hollow rectangular prism), demarcated by an outline 7058 that is optionally not displayed to the user 7002. The application user interface 7056 displays a number of buildings within the outline 7058. A move affordance 7060 associated with the application user interface 7056 is optionally displayed (e.g., independently of attention of the user 7002). FIG. 7E also illustrates that, in response to detecting an event (e.g., a system-generated event or an application-generated event, optionally in response to a user input from the user 7002) while the application user interface 7056 is displayed in the viewport of the user 7002, and in accordance with a determination that a position of the user 7002 is at least the threshold distance Dₜₕ from the application user interface 7056, the computer system 101 displays the first user interface element 7038 having the first content item 7040 and the second content item 7042 at a boundary of the application user interface 7056 (e.g., parallel to a surface of the outline 7058). Top view 7062 shows the user 7002 in front of the application user interface 7056, and the first user interface element 7038 is displayed on a front surface of the application user interface 7056. In some embodiments, an orientation of the first user interface element 7038 (e.g., represented by the vector 7039 that is parallel to a plane of the first user interface element 7038) is parallel to an edge 7068 (e.g., a vertical dimension) of the outline 7058. In some embodiments, application user interface 7056 is visually deemphasized relative to the first user interface element 7038 (e.g., by increasing a degree of blurring, decreasing a brightness, decreasing a saturation, decreasing visual intensity, decreasing a contrast, decreasing an opacity, and/or other visual deemphasis) due to the computer system 101 displaying the first user interface element 7038. FIG. 7E also illustrates an alternative placement 7064 of the first user interface element 7038 if the user 7002 had been positioned at or were to move leftwards to a second position 7066 within the three-dimensional environment as illustrated in top view 7062. Like FIG. 7C, the alternative placement 7064 of the first user interface element 7038 is illustrated from the perspective of the viewport while the viewpoint of the user 7002 faces the wall 7004′, (e.g., whereas the first user interface element 7038 at the alternative placement 7064 would have been presented to the user 7002 at the second position 7066 as being substantially perpendicular to the user 7002's viewpoint). Thus, as illustrated with reference to FIGS. 7C and 7E, while the outline 7034 and the outline 7058 may not be visible to the user 7002, the shape or contour of the respective outlines determines the location and/or orientation at which the first user interface element 7038 is displayed in response to the computer system 101 detecting the occurrence of the event. For example, the first user interface element 7038 at the alternative placement 7064 is still parallel to the original placement of the first user interface element 7038 in the viewport illustrated in FIG. 7E (e.g., due to the rectangular shape of the outline 7058), whereas the first user interface element 7038 at the alternative placement 7044 is not parallel to the original placement of the first user interface element 7038 in the viewport illustrated in FIG. 7C (e.g., due to the cylindrical shape of the outline 7034).

FIG. 7F illustrates an alternative placement of the first user interface element 7038. In response to detecting an event (e.g., a system-generated event or an application-generated event, optionally in response to user input from the user 7002) while the application user interface 7030 is displayed in the viewport of the user 7002, the computer system 101 displays the first user interface element 7038 having the first content item 7040 and the second content item 7042 at a characteristic portion (e.g., at a centroid of the three-dimensional application volume, at a center of the three-dimensional application, and/or at a threshold distance from the outline 7034) within the three-dimensional application volume of the application user interface 7030, regardless of the distance, in the three-dimensional environment, between the application user interface 7030 and the viewpoint of the user 7002. Top view 7070 shows the first user interface element 7038 displayed at the same characteristic position within the application user interface 7030 whether the viewpoint of the user 7002 is at a first position closer to the application user interface 7030 (optionally greater than the threshold distance Dₜₕ), or at a second position further from the application user interface 7030 (optionally greater than the threshold distance Dₜₕ). In some embodiments, an orientation of the first user interface element 7038 (e.g., represented by the vector 7039 that is parallel to the plane of the first user interface element 7038) is parallel to the edge 7041 of the outline 7034.

FIGS. 7G-7I illustrate how the first user interface element 7038 scales based on a distance, in the three-dimensional environment, between the application user interface 7030 and the viewpoint of the user 7002. FIG. 7G shows the application user interface 7030 displayed within the viewport at a greater distance away from the viewpoint of the user 7002 than the application user interface 7030 shown in FIG. 7C. In order to maintain legibility of the information displayed on the first user interface element 7038, the computer system 101 enlarges the first user interface element 7038 (e.g., relative to the size of the application user interface 7030, compared to the size of the first user interface element 7038 displayed in FIG. 7C) that is displayed at the boundary of the application volume of the application user interface 7030, which is positioned further from the user 7002 (e.g., with respect to the application user interface 7030 displayed in FIG. 7C). In some embodiments, FIG. 7G illustrates an example transition from FIG. 7C.

For example, FIG. 7G illustrates an example transition from FIG. 7C if, while the first user interface element 7038 was displayed in the viewport (FIG. 7C), the user 7002 provided a user input (e.g., an air pinch gesture followed by a movement in depth away from the viewpoint of the user 7002 while attention of the user 7002 is directed toward the move affordance 7032) to move the application user interface 7030 in depth, away from a viewpoint of the user 7002. In some embodiments, the application user interface 7030 is a fixed scale application that does not change in size based on the distance between the viewpoint of the user 7002 and the application user interface 7030. For example, the reduction in size of the application user interface 7030 shown in the viewport illustrated in FIG. 7G is due to the application user interface 7030 being further from the viewpoint of the user 7002. In some embodiments, the first user interface element 7038 is a dynamically scaled user interface element, described in greater detail with respect to FIGS. 9A-9P. Top view 7072 shows a position 7074 of the application user interface 7030 in FIG. 7C and a position 7076 of the application user interface 7030 in FIG. 7G, the application user interface 7030 maintaining the same size at the position 7074 and the position 7076.

FIG. 7H shows the application user interface 7030 displayed within the viewport at a position within the three-dimensional environment that is closer to the viewpoint of the user 7002 than the application user interface 7030 shown in FIG. 7C. Top view 7078 shows the position 7074 of the application user interface 7030 in FIG. 7C and a position 7080 of the application user interface 7030 in FIG. 7H, the application user interface 7030 maintaining the same size at the position 7074 and the position 7080. The computer system 101 decreases a size of the first user interface element 7038 (e.g., relative to the size of the application user interface 7030, compared to the size of the first user interface element 7038 displayed in FIG. 7C) that is displayed at the boundary of the application volume of the application user interface 7030, which is positioned closer to the viewpoint of the user 7002 (e.g., with respect to the application user interface 7030 displayed in FIG. 7C). In some embodiments, FIG. 7H illustrates an example transition from FIG. 7C in response to the user 7002 providing a user input (e.g., an air pinch gesture followed by a movement in depth toward the viewpoint of the user 7002 while attention of the user 7002 is directed toward the move affordance 7032) to move the application user interface 7030 in depth, toward the viewpoint of the user 7002 while the first user interface element 7038 is displayed in the viewport (FIG. 7C).

FIG. 7I illustrates the variation in size of the first user interface element 7038 based on a distance, in the three-dimensional environment, between the application user interface 7030 and the viewpoint of the user 7002. A top view 7082-1 is analogous to top view 7046. The application user interface 7030 is further away from the viewpoint of the user 7002 in a top view 7082-2 than in the top view 7082-1 (e.g., as represented by the dashed outline indicating, for comparison, the position 7074 of the application user interface 7030 in FIG. 7C). In the top view 7082-2, the computer system 101 has enlarged the first user interface element 7038 to maintain legibility of the information displayed thereon. The shaded portion of the first user interface element 7038 in the top view 7050-2 corresponds to, and indicates for comparison, the smaller size of the first user interface element 7038 shown in the top view 7082-1.

In a top view 7082-3, the application user interface 7030 is further away from the viewpoint of the user 7002 than in the top view 7082-2. In the top view 7082-3, the computer system 101 has continued to enlarge the first user interface element 7038 to maintain legibility of the information displayed thereon. The shaded portion of the first user interface element 7038 in the top view 7082-3 corresponds to, and indicates for comparison, the smaller size of the first user interface element 7038 shown in the top view 7082-2. Similarly, the application user interface 7030 is further away from the viewpoint of the user 7002 in a top view 7082-4 than in the top view 7082-3. Due to the first user interface element 7038 reaching a maximum size in the top view 7082-3, even though the application user interface 7030 is still further from the viewpoint of the user 7002 in the top view 7082-4 than in the top view 7082-3, the first user interface element 7038 remains at the same size in the top view 7082-4 as in the top view 7082-3.

In a top view 7082-5, the application user interface 7030 is closer to the viewpoint of the user 7002 than in the top view 7082-1. In the top view 7082-5, the computer system 101 has decreased the size of the first user interface element 7038 with respect to the top view 7082-1. In a top view 7082-6, the application user interface 7030 is moved even closer to the viewpoint of the user 7002 than in the top view 7082-5. Due to the first user interface element 7038 reaching a minimum size in the top view 7082-5, even though the application user interface 7030 is closer to the viewpoint of the user 7002 in the top view 7082-6 than in the top view 7082-5, the first user interface element 7038 remains at the same size in the top view 7082-6 as in the top view 7082-5.

FIG. 7J illustrates an application user interface 7082 that also displays three-dimensional application content elements enclosed within (e.g., bounded by) a three-dimensional volume, demarcated by an outline 7084 that is optionally not displayed to the user 7002. For example, the outline 7084 of the application user interface 7082 has a cylindrical shape (e.g., a hollow cylinder that encloses the three-dimensional application content) that encloses a three-dimensional representation of a chair 7086. A move affordance 7088 associated with the application user interface 7082 is optionally displayed (e.g., independently of attention of the user 7002). A planar section 7092 (e.g., a circular, an oval, an elliptical, a quadrilateral, polygonal, or a two-dimensional section of another three-dimensional shape) of the application user interface 7082, shown in top view 7090 has a dimension (e.g., a linear length) that is small enough such that the computer system 101 displays the first user interface element 7038 at a location on a back boundary of the application user interface 7082 to maintain the requisite threshold distance Dₜₕ from the viewpoint of the user 7002, or at best to maximize the distance between the first user interface element 7038 and the viewpoint of the user 7002. Top view 7090 also shows the position 7074 of the application user interface 7030 at the size and location illustrated in top view 7046 (FIG. 7C) for comparison. In some embodiments, application user interface 7082 is visually deemphasized relative to the first user interface element 7038 (e.g., by increasing a degree of blurring, decreasing a brightness, decreasing a saturation, decreasing visual intensity, decreasing a contrast, decreasing an opacity, and/or other visual deemphasis) due to the computer system 101 displaying the first user interface element 7038.

FIG. 7K illustrates the first user interface element 7038 being displayed at an orientation that is at least partially based on a direction of the attention of the user 7002. Side view 7094 shows that the head of the user 7002 is lowered relative to a horizon 7096, as the attention of the user is directed toward (e.g., by gazing at) the first user interface element 7038. The horizon 7096 represents a fixed horizontal reference plane in the three-dimensional environment that is at an eye level of the user 7002 (e.g., typically when the user 7002 is in an upright or standing position, and even though the gaze, or proxy for gaze, of the user 7002 and/or head may be pointed in a direction other than horizontally) and that does not change with changes in the head elevation of the user 7002 (e.g., head elevation pointing up, or head elevation pointing down, and/or without vertical or other translational movement of the head of the user 7002). As illustrated in side view 7094, lowering of the head of the user 7002 results in a head direction 7098 (e.g., corresponding to the attention) that is at a head angle θ with respect to the horizon 7096. In contrast to orienting the first user interface element 7038 such that the vector 7039 is parallel to an edge of the application volume of the application user interface (e.g., edge 7041 of the application user interface 7030, as illustrated in FIG. 7C), the vector 7039 of the first user interface element 7038 is oriented at an intermediate angle between being perpendicular to the viewpoint of the user 7002 (e.g., denoted by the perpendicular line 7100) and being parallel to an edge 7102 of the application volume 7104. In some embodiments, the application volume 7104 includes one or more user interface elements (e.g., alerts, billboards, and/or other two- or three-dimensional displays of information) that are oriented parallel to the edge 7102 of the application volume 7104. For example, an alert 7106 is oriented parallel to the edge 7102 of the application volume 7104. In some embodiments, in response to detecting the attention of the user 7002 being directed toward the alert 7106, the computer system tilts the alert 7106 toward a viewpoint of the user 7002 (e.g., from being angled substantially parallel to the vector 7039 to being angled more toward the perpendicular line 7100).

FIGS. 7L-7O illustrate two different types of behavior of the first user interface element 7038 in response to detecting a change of a viewpoint of the user 7002 (e.g., due to the viewpoint of the user 7002 moving around in the three-dimensional environment, and/or due to the user 7002 changing where their attention is directed within the three-dimensional environment) while the first user interface element 7038 is displayed in the viewport. FIGS. 7L-7M illustrate the first user interface element 7038 being a viewpoint-locked virtual object. The viewport illustrated in FIG. 7L is analogous to the viewport of FIG. 7C, and top view 7108 is analogous to top view 7046.

FIG. 7M shows an example transition from FIG. 7L, in which the viewpoint of the user 7002 moves to the right, closer to the sphere 7014′. In accordance with the first user interface element 7038 being a viewpoint-locked virtual object, and in response to detecting the rightward movement of the viewpoint of the user 7002, the computer system 101 maintains the display of the first user interface element 7038 at the same position within (e.g., relative to) the viewport of the user 7002, while updating other portions of the viewport based on the new location of the viewpoint of the user 7002 in the three-dimensional environment. As a result, the first user interface element 7038 is displayed near a right boundary of the application user interface 7030 in FIG. 7M. Top view 7110 shows that the first user interface element 7038 remains displayed in front of the user 7002 after the rightward movement of the viewpoint of the user 7002.

FIGS. 7N-7O illustrate the first user interface element 7038 as an environment-locked virtual object. The viewport illustrated in FIG. 7N is analogous to the viewport of FIG. 7C except for the first user interface element 7038 being displayed above the application user interface 7030, in an environment-locked fashion. FIG. 7O shows an example transition from FIG. 7N, in which the viewpoint of the user 7002 moves to the right, closer to the sphere 7014′. In accordance with the first user interface element 7038 being an environment-locked virtual object, the computer system 101 maintains display of the first user interface element 7038 at the same location within the three-dimensional environment, such that the first user interface element 7038 appears to have shifted to the left in the viewport illustrated in FIG. 7O as a result of the rightward movement of the viewpoint of the user 7002. Top view 7112 in FIG. 7N shows that the first user interface element 7038 is displayed to the right of the viewpoint of the user 7002, whereas top view 7114 in FIG. 7O shows that the first user interface element 7038 remains at the same location within the three-dimensional environment and thus is now positioned to the left of the viewpoint of the user 7002 due to the rightward movement of the viewpoint of the user 7002.

Additional descriptions regarding FIGS. 7B-7O are provided below with reference to method 12000 described with respect to FIGS. 12A-12G.

FIGS. 8A-8V illustrate examples of displaying visual feedback when attention of the user is directed toward a boundary of a volumetric application. FIGS. 13A-13G are flow diagrams of an exemplary method 13000 for displaying visual feedback when attention of the user is directed toward a boundary of a volumetric application. The user interfaces in FIGS. 8A-8V are used to illustrate the processes described below, including the processes in FIGS. 13A-13G.

FIG. 8A illustrates a view of a three-dimensional environment (e.g., corresponding at least partially to the physical environment 7000 in FIG. 7A) that is visible to the user 7002 via HMD 7100a of the computer system 101. The three-dimensional environment includes an application user interface 8002 of a volumetric application that displays three-dimensional application content including one or more user interface elements having a non-zero length, non-zero width, and non-zero depth. For example, the application user interface 8002 displays a chair 8004 having a chair back 8006, a chair seat 8008 and four chair legs 8010. A move affordance 8014 associated with the application user interface 8002 is optionally displayed (e.g., independently of attention 8016 of the user 7002, or in response to detecting that the attention 8016 of the user 7002 is directed to a portion (e.g., a central portion) of the application user interface). FIG. 8A illustrates the attention 8016 of the user being directed toward an inner region of the chair 8004, between the chair back 8006 and the chair seat 8008, away from a boundary (e.g., top, bottom, left, or right) of the three-dimensional application content (e.g., chair 8004). In response to detecting that the attention 8016 of the user 7002 (e.g., based on gaze of the user 7002 or a proxy for gaze) is directed toward a portion of the three-dimensional application content that is more than a threshold distance from a boundary of the three-dimensional application content (e.g., 5%, 10%, 20%, 30% or another percentage of a linear length (e.g., width, height and/or depth) of the three-dimensional application content), the computer system 101 forgoes displaying the boundary of the three-dimensional application content and/or forgoes displaying any additional visual indicators associated with the boundary of the three-dimensional application content. Top view 8018 shows the user 7002 directing the attention 8016 toward the application user interface 8002.

FIG. 8B illustrates that, in response to detecting that the attention 8016 of the user 7002 is directed toward a first portion 8020 of the boundary of the three-dimensional application content (e.g., a lower right boundary, toward a lower end of the front right leg of the chair 8004), the computer system 101 visually emphasizes (e.g., highlighting with increased color, brightness, opacity, or making visible if previously not visible, hereinafter also sometimes used interchangeably referred as increasing the visual prominence by decreasing a degree of blurring, increasing a brightness, increasing a saturation, increasing visual intensity, increasing a contrast, increasing an opacity, and/or other visual emphasis) the first portion 8020 of a baseplate 8021, denoted with dotted lines to indicate other portions of the baseplate 8021 that are not visible in FIG. 8B. In some embodiments, the baseplate 8021 confines three-dimensional content of the application user interface 8002 to a three-dimensional volume above the baseplate 8021 (e.g., a baseplate defines the bottom planar boundary of a three-dimensional volume). In some embodiments, the computer system 101 visually emphasizes the first portion 8020 (e.g., a front right quadrant) of the baseplate 8021 and forgoes visually emphasizing (and/or visually deemphasizes) other portions (e.g., a front left quadrant, and/or a back half) of the baseplate 8021 in accordance with a determination that the attention 8016 is directed toward a region closer to the first portion 8020 than a second portion (e.g., adjacent to the first portion 8020). In some embodiments, computer system 101 maintains display of the move affordance 8014 in conjunction with visually emphasizing the first portion 8020 (or ceases display of the move affordance 8014 and visually emphasizes the first portion 8020). In some embodiments, the three-dimensional application content of the application user interface 8002 does not fill an entire region within the viewport (e.g., does not fill a horizontal plane in the viewport, or does not fill a planar region in the viewport). For example, no application content of the application user interface 8002 is displayed between the four chair legs 8010 in a horizontal plane defined by the ends of the four chair legs 8010. In some embodiments, displaying the first portion 8020 of the baseplate 8021 guides the user 7002 toward one or more affordances (e.g., a resize affordance) associated with the application user interface 8002, as described below. Top view 8022 shows an outline of the baseplate 8021 and the user 7002 directing the attention 8016 toward a boundary of the three-dimensional application content of the application user interface 8002.

FIG. 8C illustrates an example transition from FIG. 8B. Based on the attention 8016 of the user 7002 remaining within a vicinity of (e.g., remaining on, or moving to another region within) the first portion 8020 for a threshold period of time (optionally before the attention 8016 is directed toward a resize affordance 8024), the computer system 101 displays the resize affordance 8024, optionally by transitioning from displaying the move affordance 8014 to displaying the resize affordance 8024 (e.g., by morphing the move affordance 8014, optionally via an animation, into the resize affordance 8024 and/or ceasing to display the move affordance 8014). In some embodiments, computer system 101 further visually emphasizes an edge 8026 of the first portion 8020 (e.g., represented by the three crosses). Top view 8028 shows the resize affordance 8024 displayed prior to the user 7002 directing the attention 8016 toward the resize affordance 8024.

FIG. 8D illustrates an example transition from FIG. 8C. Based on the attention 8016 of the user 7002 moving toward a region 8030 surrounding the resize affordance 8024 for selecting the resize affordance 8024 (optionally remaining for a threshold period of time), the computer system 101 visually emphasizes the resize affordance 8024. Optionally, computer system 101 maintains the visual emphasis on the edge 8026 of the first portion 8020 in conjunction with visually emphasizing the resize affordance 8024. Top view 8032 shows the user 7002 directing the attention 8016 toward the region 8030.

FIG. 8E illustrates an example transition from FIG. 8D. Top view 8034 shows the outline of the baseplate 8021 and the user 7002 directing the attention 8016 toward a central portion of the baseplate 8021. Based on the attention 8016 of the user 7002 moving to the left along the edge 8026, away from the resize affordance 8024, by a threshold distance that is larger than the region 8030, the computer system 101 ceases display of the resize affordance 8024 (optionally while maintaining the visual emphasis on the edge 8026 of the first portion 8020). In some embodiments, requiring that the attention 8016 move by an amount that is larger than the region 8030 before the computer system 101 ceases display of the resize affordance 8024 helps to prevent inadvertent dismissal and/or flickering of the resize affordance 8024 when the attention 8016 moves near a boundary of the region 8030. Optionally, computer system 101 redisplays the move affordance 8014 in conjunction with ceasing to display the resize affordance 8024.

FIG. 8F illustrates that, in response to detecting that the attention 8016 of the user 7002 is directed toward an edge of a second portion 8036 of the boundary of the three-dimensional application content (e.g., a lower left boundary, toward lower ends of the left legs of the chair 8004), the computer system 101 visually emphasizes the second portion 8036 of the baseplate 8021 and displays the resize affordance 8024 to the left of the second portion 8036. In some embodiments, the computer system 101 forgoes visually emphasizing other portions (e.g., the first portion 8020) of the baseplate 8021 in accordance with a determination that the attention 8016 is directed toward a region closer to the second portion 8036 than the first portion 8020. In some embodiments, the second portion 8036 of the baseplate 8021 is adjacent to (e.g., contiguous with) the first portion 8020 of the baseplate 8021. Top view 8038 shows the outline of the baseplate 8021, the resize affordance 8024, and the user 7002 directing the attention 8016 toward a left portion of the baseplate 8021.

FIGS. 8G-8K show how the three-dimensional application content of the application user interface 8002 is resized, in accordance with some embodiments. FIG. 8G illustrates a user input that includes the hand 7022 performing an air pinch gesture 8500-1 (e.g., including bringing two fingers into contact) while the attention 8016 of the user 7002 is directed toward the resize affordance 8024 (e.g., an example transition from FIG. 8D). In response to detecting the air pinch gesture 8500-1 while the attention 8016 of the user 7002 is directed toward the resize affordance 8024, the computer system 101 displays additional portions of the baseplate 8021 (e.g., all of the baseplate 8021 including both the first portion 8020 and the second portion 8036) to visually indicate that the application user interface 8002 is receiving a resizing input and to visually indicate a spatial extent of the three-dimensional application content of the application user interface 8002 to the user 7002. The user input further includes movement of the air pinch gesture 8500-1 (e.g., after the two fingers are brought into contact, and while this contact is maintained, hand 7022 of user 7002 moves by more than a threshold movement amount) away from a viewpoint of the user 7002. Top view 8040 shows the baseplate 8021, the resize affordance 8024, and the user 7002 directing the attention 8016 toward the resize affordance 8024.

FIG. 8H illustrates an example transition from FIG. 8G. Based on detecting the movement of the air pinch gesture 8500-1 away from the viewpoint of the user 7002 (FIG. 8G), the computer system 101 resizes the three-dimensional application content of the application user interface 8002 by reducing a size of the chair 8004. Conversely, were the movement of the air pinch gesture 8500-1 toward the viewpoint of the user 7002 (e.g., in a different direction, such as an opposite direction, from the direction of movement of the air pinch gesture 8500-1 shown in FIG. 8G), the computer system 101 would enlarge a size of the chair 8004. In response to detecting the release of the air pinch gesture 8500-1 while the attention 8016 is directed toward a central portion of the baseplate 8021, the computer system 101 ceases display of the resize affordance 8024 and transitions to displaying the move affordance 8014, while displaying a resized (e.g., smaller) portion of the baseplate 8021 (e.g., ceasing to display the entire baseplate 8021 and displaying only the first portion 8020 of the baseplate 8021 that is resized). Top view 8042 shows an outline of the resized baseplate 8021, a resized representation of the three-dimensional application content of the application user interface 8002, and the user 7002 directing the attention 8016 toward the central portion of the resized baseplate 8021.

FIG. 8I illustrates an example transition from FIG. 8H. Based on detecting the attention 8016 of the user 7002 moving away from the application user interface 8002 after the release of the air pinch gesture 8500-1, the computer system 101 ceases display of the first portion 8020 of the baseplate 8021 and the resize affordance 8024 (e.g., no portion of the baseplate 8021 indicated by the dotted line is visible to the user 7002) and optionally displays the move affordance 8014. Top view 8044 shows the resized representation of the three-dimensional application content of the application user interface 8002, and the user 7002 directing the attention 8016 toward the wall 7006′.

FIGS. 8J-8K illustrate that, once the resizing operation is initiated (e.g., by directing the attention 8016 toward the resize affordance 8024 while the hand 7022 performs the air pinch gesture 8500-1), the attention 8016 of the user 7002 does not need to stay on the application user interface 8002 while the air pinch gesture 8500-1 is maintained (e.g., in order for the resizing operation to continue). FIG. 8J illustrates an example transition from FIG. 8G. After the computer system 101 displays additional portions of the baseplate 8021 (e.g., all of the baseplate 8021 including the first portion 8020 and the second portion 8036) to visually indicate that the application user interface 8002 is receiving a resizing input (e.g., in response to detecting the air pinch gesture 8500-1 while the attention 8016 of the user 7002 is directed toward the resize affordance 8024), subsequent movement of the air pinch gesture 8500-1 (e.g., away from or toward the viewpoint of the user 7002) results in resizing of the application user interface 8002 without requiring that the attention 8016 remain on the application user interface 8002. For example, FIG. 8J illustrates the attention 8016 directed toward the wall 7006′, away from the application user interface 8002 while the air pinch gesture 8500-1 moves away from the viewpoint of the user 7002. The computer system 101 also continues displaying the additional portions of the baseplate 8021 during the resizing input (e.g., the air pinch gesture 8500-1) even though the attention 8016 is not directed toward any portion of the baseplate 8021. Top view 8046 shows the attention 8016 of the user 7002 being directed toward the left, away from the application user interface 8002 and the baseplate 8021.

FIG. 8K illustrates an example transition from FIG. 8J. Based on detecting the movement of the air pinch gesture 8500-1 away from the viewpoint of the user 7002 (FIG. 8J), the computer system 101 reduces the size of the chair 8004. In response to detecting the release of the air pinch gesture 8500-1, the computer system 101 ceases display of the resize affordance 8024 and transitions to displaying the move affordance 8014, while displaying a smaller portion of the baseplate 8021 (e.g., ceasing to display the entire baseplate 8021 and displaying only the first portion 8020 of the baseplate 8021, such as was displayed in FIG. 8D just prior to detecting the air pinch gesture 8500-1 of FIG. 8G). Alternatively, due to the attention 8016 of the user 7002 not being directed toward the application user interface 8002, the computer system 101 ceases to display the first portion 8020 of the baseplate 8021 and the move affordance 8014 (analogous to FIG. 8I). Top view 8048 shows an outline of a resized baseplate 8021, a resized representation of the three-dimensional application content of the application user interface 8002, and the user 7002 directing the attention 8016 toward the left.

FIGS. 8L-8M show the baseplate 8021 being displayed while the three-dimensional application content of the application user interface 8002 is repositioned within the three-dimensional environment, in accordance with some embodiments. FIG. 8L illustrates a user input that includes the hand 7022 performing air pinch gesture 8500-2 (e.g., including bringing two fingers into contact) while the attention 8016 of the user 7002 is directed toward (e.g., based on user 7002 gazing at or based on another gaze proxy) the move affordance 8014. In response to detecting the air pinch gesture 8500-2 while the attention 8016 of the user 7002 is directed toward the move affordance 8014, the computer system 101 displays additional portions of the baseplate 8021 (e.g., all of the baseplate 8021 including the first portion 8020 and the second portion 8036) to visually indicate that the application user interface 8002 is receiving a movement input and to visually indicate a spatial extent of the three-dimensional application content of the application user interface 8002 to the user 7002. Top view 8050 shows the baseplate 8021, the move affordance 8014, and the user 7002 directing the attention 8016 toward the move affordance 8014.

FIG. 8M illustrates an example transition from FIG. 8L. FIG. 8M illustrates that the user input is followed by movement (e.g., upward, to the left, and/or away from the viewpoint of the user 7002) of the air pinch gesture 8500-2 (e.g., after the two fingers are brought into contact, and while this contact is maintained, the hand 7022 of user 7002 moves by more than a threshold movement amount). In response to detecting the movement of the air pinch gesture 8500-2, optionally while the attention 8016 of the user 7002 is directed toward the move affordance 8014, the computer system 101 displays the application user interface 8002, including the baseplate 8021, at an updated location in the three-dimensional environment that is based on the movement of the air pinch gesture 8500-2. Top view 8052 shows the baseplate 8021, the move affordance 8014, and the user 7002 directing the attention 8016 toward the move affordance 8014.

FIG. 8N illustrates an example transition from FIG. 8M. Based on detecting the release of the air pinch gesture 8500-2, optionally while the attention 8016 of the user 7002 remains directed toward the application user interface 8002, the computer system 101 optionally ceases to display one or more portions of the baseplate 8021 (e.g., maintaining display of the second portion 8036 of the baseplate 8021 due to the attention 8016 being directed toward the left side of the application user interface 8002, and optionally the move affordance 8014). Top view 8054 shows an outline of the baseplate 8021, a representation of the three-dimensional application content of the application user interface 8002, and the user 7002 directing the attention 8016 toward the move affordance 8014.

FIG. 8O illustrates an example transition from FIG. 8N. Based on detecting the attention 8016 of the user 7002 moving away from the application user interface 8002 after the release of the air pinch gesture 8500-2, the computer system 101 ceases display of the second portion 8036 of the baseplate 8021 and the move affordance 8014. Top view 8056 shows the representation of the three-dimensional application content of the application user interface 8002, and the user 7002 directing the attention 8016 toward the sphere 7014′ instead of toward the application user interface 8002.

In contrast to FIGS. 8A-8O, which show an example of an application user interface displaying three-dimensional application content within a cylindrical application volume positioned above a circular baseplate 8021, FIG. 8P shows an application user interface 8058 having a quadrilateral baseplate 8060 (e.g., demarcated in FIG. 8P with a dotted outline). The application user interface 8058 displays three-dimensional application content that includes a table 8067 having four table legs. In response to detecting that the attention 8016 of the user 7002 (e.g., based on gaze of the user 7002 or a proxy for gaze) is directed toward a first portion 8064 of a boundary of the three-dimensional application content (e.g., a lower left boundary, toward a lower end of the front left leg of the table 8067), the computer system 101 visually emphasizes (e.g., highlighting with increased color, brightness, opacity, or making visible if previously not visible) the first portion 8064 of the baseplate 8060. In some embodiments, the baseplate 8060 confines three-dimensional content of the application user interface 8058 to a three-dimensional volume above the baseplate 8060. In some embodiments, the computer system 101 visually emphasizes the first portion 8064 (e.g., a front left quarter) of the baseplate 8060 and forgoes visually emphasizing (and/or visually deemphasizes) other portions (e.g., a front right quarter) of the baseplate 8060 in accordance with a determination that the attention 8016 is directed toward a region closer to the first portion 8064 than a second portion (e.g., adjacent to the first portion 8064). Based on the attention 8016 of the user 7002 being within a vicinity of (e.g., remaining on, or moving to another region within) the first portion 8064 (optionally within a vicinity of an edge 8074) for a threshold period of time (optionally before the attention 8016 is directed toward a resize affordance 8066), the computer system 101 displays the resize affordance 8066. In some embodiments, computer system 101 further visually emphasizes the edge 8074 of the first portion 8064. Top view 8076 shows an outline of the baseplate 8060 and the user 7002 directing the attention 8016 toward a boundary of the three-dimensional application content of the application user interface 8058.

FIGS. 8Q-8S shows an application user interface 8078 that fills a volume within the three-dimensional environment. Unlike the application user interface 8002 which does not fill an entire region within the viewport (e.g., does not fill a horizontal plane in the viewport, or does not fill a planar region in the viewport), the application user interface 8078 fills a lower horizontal plane 8079 (e.g., where a baseplate would otherwise be) within the application user interface 8078. The application user interface 8078 displays three-dimensional application content including one or more user interface elements having a non-zero length, non-zero width, and non-zero depth. For example, the application user interface 8078 displays a number of buildings and a park within the application volume. A move affordance 8080 associated with the application user interface 8078 is optionally displayed (e.g., independently of attention 8016 of the user 7002, or in response to detecting that the attention 8016 of the user 7002 is directed to a portion (e.g., a central portion) of the application user interface 8078). FIG. 8Q illustrates the attention 8016 of the user 7002 being directed toward an inner region of the application user interface 8078, away from a boundary (e.g., top, bottom, left, or right) of the three-dimensional application content, toward a building having a pin “2 Cross St” displayed above it. In response to detecting that the attention 8016 of the user 7002 (e.g., based on gaze of the user 7002 or a proxy for gaze) is directed toward a portion of the three-dimensional application content that is more than threshold distance from a boundary of the three-dimensional application content (e.g., 5%, 10%, 20%, 30% or another percentage of a linear length (e.g., width, height and/or depth) of the three-dimensional application content), and in accordance with a determination that the application user interface 8078 is an application that fills a volume within the three-dimensional environment, the computer system 101 forgoes displaying the boundary of the three-dimensional application content and/or any additional visual indicators associated with the boundary of the three-dimensional application content. Top view 8082 shows the user 7002 directing the attention 8016 toward the application user interface 8078.

FIG. 8R illustrates that, in response to detecting that the attention 8016 of the user 7002 (e.g., based on gaze of the user 7002 or a proxy for gaze) is directed toward a boundary of the three-dimensional application content (e.g., a lower right boundary, and/or toward a lower portion of the building having a pin of “7 Broadwalk” displayed above it), and in accordance with a determination that the application user interface 8078 is an application that fills a volume within the three-dimensional environment, the computer system 101 forgoes displaying the boundary of the three-dimensional application content and/or any additional visual indicators associated with the boundary of the three-dimensional application content. Top view 8084 shows the user 7002 directing the attention 8016 toward the application user interface 8078. Accordingly, the user interface response illustrated in FIG. 8R is the same as in FIG. 8Q even though the attention 8016 in FIG. 8R is directed to a boundary portion of application user interface 8078 (e.g., in contrast to FIGS. 8A-8B illustrating different user interface responses based on the attention 8016 being directed to interior versus boundary portions of an application whose three-dimensional application content does not fill the baseplate region or the application volume).

FIG. 8S illustrates that, in response to detecting that the attention 8016 of the user 7002 (e.g., based on gaze of the user 7002 or a proxy for gaze) is directed toward a lower right edge of a boundary of the three-dimensional application content of the application user interface 8078, the computer system 101 transitions from displaying the move affordance 8080 to displaying a resize affordance 8086 (e.g., the computer system 101 morphs the display of the move affordance 8080 into the resize affordance 8086, and/or ceases displaying the move affordance 8080). Top view 8089 shows the user 7002 directing the attention 8016 toward the right edge of the application user interface 8078.

FIG. 8T shows how a curvature of the resize affordance varies based on a shape of the three-dimensional application volume. For example, the resize affordance 8086 associated with the application user interface 8078 (e.g., an elliptic cylinder) is less curved than the resize affordance 8024 associated with the application user interface 8002 (e.g., cylindrical). The resize affordance 8066 associated with the application user interface 8058 (e.g., a rectangular prism) is more angular than the resize affordance 8086 and the resize affordance 8024.

FIGS. 8U and 8V show how the boundary of a volumetric application is displayed in response to a change in a viewpoint of the user 7002. FIG. 8U shows that the viewpoint of the user 7002 has shifted to a right corner of the three-dimensional environment. In response to detecting that the attention 8016 of the user 7002 (e.g., based on gaze of the user 7002 or a proxy for gaze) is directed toward a portion of the chair 8004, greater than a threshold distance from a boundary of the application user interface 8002, the computer system 101 forgoes displaying the boundary of the application user interface 8002 and/or forgoes providing any additional visual indicators or emphasis of the boundary of the application user interface 8002 (e.g., FIG. 8U is analogous to FIG. 8A except from a different current viewpoint of the user 7002 relative to the application user interface 8002). Top view 8090 shows the user 7002 directing the attention 8016 toward a boundary of the three-dimensional application content of the application user interface 8002 while a viewpoint 7002′ of the user 7002 is located toward a right corner of the three-dimensional environment. FIG. 8V is an example transition from FIG. 8U. In response to detecting that the attention 8016 of the user 7002 (e.g., based on gaze of the user 7002 or a proxy for gaze) is directed toward a boundary of the three-dimensional application content (e.g., a lower boundary) while the viewpoint of the user 7002 is located toward a right corner of the three-dimensional environment, the computer system 101 visually emphasizes (e.g., highlighting with increased color, brightness, opacity, or making visible if previously not visible) the first portion 8094 of a baseplate 8021 (e.g., FIG. 8V is analogous to FIG. 8F except from a different current viewpoint of the user 7002 relative to the application user interface 8002). In some embodiments, in response to detecting that the attention 8016 of the user is directed to an edge of the first portion 8094, the computer system 101 displays the resize affordance 8024. Top view 8092 shows an outline of the baseplate 8021 and the user 7002 directing the attention 8016 toward a left boundary of the three-dimensional application content of the application user interface 8002.

FIGS. 8W and 8X show how respective boundaries of two volumetric applications are displayed. FIG. 8X shows two volumetric application user interfaces within the viewport. The application user interface 8002 and the application user interface 8058 may be application user interfaces of the same application (e.g., a furniture modeling application), or application user interfaces of two different applications. FIG. 8X also shows the attention 8016 of the user 7002 (e.g., based on gaze of the user 7002 or a proxy for gaze) being directed toward a region in the three-dimensional environment that is less than a threshold distance from both the boundary of the application user interface 8002 and the boundary of the application user interface 8058 (e.g., and in a region of overlap between the application user interface 8002 and the application user interface 8058). As a result, one or more portions of the baseplate 8060 of the application user interface 8058, if displayed, would spatially conflict (e.g., collide, and/or be displayed at the same location in the three-dimensional environment) with one or more portions of the baseplate 8021. In accordance with a determination that the attention 8016 of the user 7002 is directed toward a region where the display of one or more portions of a baseplate of a first application user interface would spatially conflict with the display of one or more portions of a baseplate of a second application user interface, and that application content of the application user interface 8058 has a higher priority than the application content of the application user interface 8002, the computer system 101 visually emphasizes a boundary of the baseplate 8060 of the application user interface 8058 by displaying a portion 8065 of the baseplate 8060. For example, the application content of the application user interface 8058 has a higher priority due to the user 7002 having interacted with the application user interface 8058 more recently than the application user interface 8002, because application content of the application user interface 8058 has current input focus and the application content of the application user interface 8002 does not have current input focus, because portions of the application content in the application user interface 8058 have a spatial location that is closer to a viewpoint of the user than a spatial location of application content in the application user interface 8002, because the application content in the application user interface 8058 has a higher layer order than the application content of the application user interface 8002, and/or because the computer system 101 assigns a higher priority to the application content in the application user interface 8058 due to other reasons. Top view 8096 shows an outline of the baseplate 8060 and the user 7002 directing the attention 8016 toward an overlapping region between the application user interface 8058 and the application user interface 8002.

FIG. 8X shows an example transition from FIG. 8W. In response to detecting the application content of the application user interface 8002 changing from being lower priority than the application content of the application user interface 8058 to being higher priority than the application content of the application user interface 8058, the computer ceases display of the portion 8065 of the baseplate 8060 and visually emphasizes the boundary of the application user interface 8002 by displaying the portion 8036 of the baseplate 8021 of the application user interface 8002. Top view 8098 shows an outline of the baseplate 8021 and the user 7002 directing the attention 8016 toward an overlapping region between the application user interface 8058 and the application user interface 8002 (e.g., the same region as in FIG. 8W). For example, the change in priority of the application content of the application user interface 8002 relative to the application content of the application user interface 8058 is based on one or more of a change in input focus, a change in spatial location of the application content of the application user interface 8002 and/or application content of the application user interface 8058 relative to a viewpoint of the user (e.g., due to movement of the application content of the application user interface 8002, movement of the application content of the application user interface 8058 and/or due to a change in a viewpoint of the user 7002), a change in layer order of the application content of the application user interface 8002 and/or application content of the application user interface 8058, an automatic change in priority based on the occurrence of one or more events at the application user interface 8002 and/or the application user interface 8058, and/or based on one or more inputs detected via one or more input devices of the computer system 101. The application user interface 8002 has an associated oval boundary and the application user interface 8058 has an associated rectangular boundary. The shapes of these boundaries are defined by the respective application user interface and/or by the computer system 101. In addition, the portion 8065 of the baseplate 8060 of the application user interface 8058 is shown in FIG. 8W with a different fill pattern than the portion 8036 of the baseplate 8021 of the application user interface 8002 shown in FIG. 8X, indicating that in some embodiments, different baseplates of different application user interfaces optionally have different appearances (e.g., the appearances being defined by the application(s) associated with the application user interfaces and/or by the computer system 101).

Additional descriptions regarding FIGS. 8A-8X are provided below with reference to method 13000 described with respect to FIGS. 13A-13G.

FIGS. 9A-9P illustrate examples of scaling of a volumetric application user interface within a three-dimensional environment. FIGS. 14A-14H are flow diagrams of an exemplary method 14000 for scaling of a volumetric application user interface within a three-dimensional environment. The user interfaces in FIGS. 9A-9P are used to illustrate the processes described below, including the processes in FIGS. 14A-14H.

FIG. 9A illustrates a view of a three-dimensional environment (e.g., corresponding at least partially to physical environment 7000 in FIG. 7A) that is visible to user 7002 via HMD 7100a of computer system 101. The three-dimensional environment includes a volumetric application user interface 9002-a within which a number of three-dimensional user interface elements (e.g., a building 9004, a building 9006, a building 9008, a building 9010, a building 9012, a building 9014, and a three-dimensional control 9022) having a non-zero length, non-zero width, and non-zero depth, and two-dimensional user interface elements (e.g., a billboard 9016-1 associated with the building 9004, a billboard 9016-2 associated with the building 9008, a billboard 9016-3 associated with the building 9012, and a billboard 9016-4 associated with the building 9014) are displayed. The application user interface 9002-a is bounded by an oval plane 9018 at a lower surface of the application volume. In some embodiments, an elliptic cylindrical outline (e.g., an outline 9072 illustrated in FIG. 9H) enclosing the application volume of the application user interface 9002-a (e.g., demarcating boundaries of the application volume of the application user interface 9002-a) may optionally be displayed in the viewport.

The building 9010 has a height dimension 9036 and the building 9008 has a height dimension 9034 from the viewpoint of the user 7002, as illustrated in the viewport of FIG. 9A. Top view 9024 illustrates the application user interface 9002-a being displayed over a respective extent (e.g., angular range) 9026 of a viewport of the user 7002, closer to the viewpoint 7002′ of the user 7002 in the three-dimensional environment than the box 9020 (e.g., the box 9020 is displayed behind the application user interface 9002-a in the viewport). The box 9020 may be a representation of a physical box in physical environment 7000, or it may be a virtual object the computer system 101 displays in the viewport. Top view 9024 also shows respective planes of the billboards 9016-1, 9016-2, 9016-3, and 9016-4 being displayed substantially perpendicularly to the viewpoint of the user 7002. FIG. 9A also illustrates a user input that includes the hand 7022 performing air pinch gesture 9500-1 (e.g., including bringing two fingers into contact) while the attention 9035 of the user 7002 is directed toward (e.g., based on user 7002 gazing at or based on another gaze proxy) the move affordance 9037. The user input further includes movement of the air pinch gesture 9500-1 (e.g., after the two fingers are brought into contact, and while this contact is maintained, hand 7022 of user 7002 moves by more than a threshold movement amount) away from a viewpoint of the user 7002, optionally while the attention 9035 remains directed toward the move affordance 9037.

FIG. 9B shows an example transition from FIG. 9A. Based on detecting the movement of the air pinch gesture 9500-1 in depth away from the viewpoint of the user 7002, the computer system 101 displays the application user interface 9002-a at an updated position in the three-dimensional environment that is at a greater depth from the viewpoint of the user 7002. For example, the computer system 101 optionally displays the change in position via an animation, by fading out the application user interface 9002-a at an initial distance 9028 depicted in top view 9024 of FIG. 9A and fading in the application user interface 9002-a at an updated distance 9040 (top view 9038 of FIG. 9B), and/or via a different visual effect. FIG. 9B also illustrates that the application user interface 9002-a has an application volume and application content that are configured to dynamically scale, based on a distance between the viewpoint of the user 7002 and the application user interface 9002-a. In some embodiments, application user interfaces that are not dynamically scaled have fixed scale, as described with reference to FIG. 9I. In some embodiments, an application user interface includes some application content elements that are dynamically scaled, and some application content elements that have fixed scale. In such scenarios, the application user interface may include mixed scale content elements, as described with reference to FIGS. 9I-9L.

Returning to FIG. 9B, the computer system 101 dynamically scales the application user interface 9002-a to display application content elements over substantially the same angular range within the viewport of the user, independently of a distance between the viewpoint of the user and the application user interface 9002-a. For example, top view 9038 shows the application user interface 9002-a at a size 9032 that fills an angular range at the distance 9028 away from the viewpoint of the user 7002 (e.g., as in FIG. 9A), and in response to the user input to move the application user interface 9002-a away in depth from the viewpoint of the user 7002, the computer system 101 displays the application user interface 9002-a at the distance 9040 away from the viewpoint of the user 7002 at a size 9046 (e.g., as in FIG. 9B) that fills substantially the same angular range as when the application user interface 9002-a was displayed at the distance 9028. As a result, the application user interface 9002-a appears at the same size to the user 7002 in the viewport illustrated in FIG. 9B as the size of the application user interface 9002-a in the viewport illustrated in FIG. 9A, even though the application user interface 9002-a has moved in depth, away from the viewpoint of the user 7002 (e.g., and should appear smaller due to perspective). As shown in the top view 9038, in order to display the application user interface 9002-a such that the application user interface 9002-a appears to the user 7002 at the same size even though the application user interface 9002-a is now further away in depth from the user 7002, computer system 9002-a scales up the application volume and associated application content elements of the application user interface 9002-a as illustrated in top view 9038. Further, FIG. 9B also illustrates the box 9020 being displayed in front of the application user interface 9002-a, after the application user interface 9002-a has been moved away in depth from the viewpoint of the user 7002 in response to the movement of the air pinch gesture 9500-1.

In some embodiments, one or more (e.g., a plurality, a majority, and/or all) three-dimensional application content elements within the application user interface 9002-a are scaled uniformly. When two application content elements are scaled uniformly, a ratio of their respective dimensions remain constant after the scaling. For example, a ratio of a height of the building 9008 to a height of the building 9010 (e.g., a ratio of the dimension 9034 to the dimension 9036) in FIG. 9A stays the same as the corresponding ratio (e.g., a ratio of the dimension 9042 to the dimension 9044) in FIG. 9B. In some embodiments, some three-dimensional application content elements are dynamically scaled and some three-dimensional application content elements are not dynamically scaled. For example, in FIGS. 9I and 9K, the three-dimensional control 9022, the menu bar 9070, and the three-dimensional move affordance 9037 are dynamically scaled but the three-dimensional buildings (e.g., buildings 9004, 9006, 9008, 9010, 9012, and 9014) within the application volume are fixed scale. For example, the three-dimensional control 9022 may be a rotational control for the application user interface 9002-a, or a rotational control for a position of the sun depicted in the application user interface 9002-a. In some embodiments, one or more (e.g., a plurality, a majority, and/or all) two-dimensional application content elements within the application user interface 9002-a are dynamically scaled while three-dimensional application content elements are fixed scale, as described with reference to FIGS. 9K-9L.

FIG. 9C is analogous to FIG. 9A, except that FIG. 9C illustrates a user input that includes the hand 7022 performing air pinch gesture 9500-2 while the attention 9035 of the user 7002 is directed toward the move affordance 9037. The user input further includes movement of the air pinch gesture 9500-2 toward the viewpoint of the user 7002, optionally while the attention 9035 remains directed toward the move affordance 9037. FIG. 9D shows an example transition from FIG. 9C. Based on detecting the movement of the air pinch gesture 9500-2 in depth toward the viewpoint of the user 7002, the computer system 101 displays the application user interface 9002-a at an updated position in the three-dimensional environment that is closer in depth to the viewpoint of the user 7002. For example, the computer system 101 optionally displays the change in position via an animation, by fading out the application user interface 9002-a at the initial distance 9028 depicted in top view 9024 of FIG. 9C and fading in the application user interface 9002-a at an updated distance 9052 depicted in top view 9050 of FIG. 9D, and/or via a different visual effect. Top view 9050 shows that in response to detecting the user input to move the application user interface 9002-a closer in depth toward the viewpoint of the user 7002, the computer system 101 displays the application user interface 9002-a at the distance 9052 away from the viewpoint of the user 7002 at a size 9054 that fills substantially the same angular range as when the application user interface 9002-a was displayed at the distance 9028. The application user interface 9002-a appears at the same size to the user 7002 in the viewport illustrated in FIG. 9D as in the viewport illustrated in FIG. 9C, even though the application user interface 9002-a has moved closer in depth toward the viewpoint of the user 7002 (e.g., and should appear larger due to perspective). As shown in the top view 9050, in order to display the application user interface 9002-a such that the application user interface 9002-a appears to the user 7002 at the same size even though the application user interface 9002-a is now closer in depth toward the user 7002, the computer system 101 scales down the application volume (e.g., including application content elements) of the application user interface 9002-a to a size 9054 as illustrated in top view 9050.

In some embodiments, the dynamically scaled application content elements in the application user interface 9002-a are scaled uniformly such that a ratio of their respective dimensions remain constant. For example, a ratio of a height of the building 9008 to a height of the building 9010 (e.g., a ratio of the dimension 9034 to the dimension 9036) in FIG. 9C matches the corresponding ratio (e.g., a ratio of the dimension 9058 to the dimension 9056) in FIG. 9D. In some embodiments, the computer system 101 imposes one or more limits to a scaling factor for dynamic scaling. For example, FIG. 9B may illustrate a maximum scaling factor for dynamic scaling of the application user interface 9002-a. In response to detecting an additional user input to move the application user interface 9002-a further than the distance 9040 from the viewpoint of the user 7002, the computer system 101 maintains the application user interface 9002-a at the same size 9046 while displaying the application user interface 9002-a at the greater distance (e.g., greater than the distance 9040) from the viewpoint of the user 7002 (e.g., in which case the application user interface 9002-a would appear smaller due to perspective). Similarly, FIG. 9D may illustrate a minimum scaling factor for dynamic scaling of the application user interface 9002-a. In response to detecting additional user input to move the application user interface 9002-a closer than the distance 9052 to the viewpoint of the user 7002, the computer system 101 maintains the application user interface 9002-a at the same size 9054 while displaying the application user interface 9002-a at a smaller distance (e.g., less than the distance 9052) from the viewpoint of the user 7002 (e.g., in which case the application user interface 9002-a would appear larger due to perspective).

In contrast to FIGS. 9A-9D, which show the application user interface 9002-a moving relative to the viewpoint of the user 7002, FIGS. 9E-9G show the user 7002 moving in the three-dimensional environment relative to the application user interface 9002-a (e.g., while the application user interface 9002-a remains at the same location within the three-dimensional environment). FIG. 9E is analogous to FIG. 9A, except that FIG. 9E includes a top schematic 9062 illustrating multiple positions around the oval plane 9018 (e.g., position 9060-1, position 9060-2, position 9060-3, position 9060-4, position 9060-5, position 9060-6, position 9060-7, position 9060-8, position 9060-9, position 9060-10, position 9060-11, and position 9060-12) at which the move affordance 9037 may be displayed. Top schematic 9062 also shows the move affordance 9037 being displayed at the position 9060-1, based on the location of the viewpoint of the user 7002.

FIG. 9F shows an example transition from FIG. 9E. Based on detecting the movement of the viewpoint of the user 7002 within the three-dimensional environment closer to the application user interface 9002-a, to a distance 9065 from the application user interface 9002-a as illustrated in top view 9064, user interface elements appear larger in the viewport due to the shortened distance between the viewpoint of the user 7002 and the application user interface 9002-a. Further, the computer system 101 forgoes dynamically scaling user interface elements within the application user interface 9002-a as a result of the movement of the viewpoint of the user 7002.

FIG. 9G shows an example transition from FIG. 9E. Based on detecting the movement of the viewpoint of the user 7002 rightward within the three-dimensional environment, the viewport of the user 7002 is updated (e.g., the building 9014 is closer than the building 9010 to the viewpoint of the user 7002 in FIG. 9G, in contrast to the building 9010 being closer than the building 9014 to the viewpoint of the user 7002 in FIG. 9E), and the computer system 101 changes respective orientations of the billboards 9016-1, 9016-2, 9016-3, and 9016-4 so that respective planes of the billboards are substantially perpendicular to the viewpoint of the user 7002, as illustrated in top view 9066 and in the viewport. In some embodiments, a developer of the application user interface 9002-a is enabled to specify whether respective orientations of one or more two-dimensional user interface elements within the application user interface 9002-a are changed based on a direction and/or location of the viewpoint of the user 7002 (e.g., optionally without the application user interface 9002-a receiving biometric data from the user 7002 regarding a location of a viewpoint of the user 7002). In some embodiments, the developer of the application user interface 9002-a is also enabled to specify one or more parameters of how the billboards change their respective orientation in response to a movement of the viewpoint of the user 7002. For example, the orientation may be changed continuously in response to detecting a corresponding change in the movement of the viewpoint of the user 7002. Alternatively, the orientation may be changed step-wise (e.g., in increments of 2-10°, or other magnitudes) once a movement of the viewpoint of the user 7002 meets respective movement thresholds (e.g., but not before the movement of the viewpoint of the user 7002 meets a next movement threshold). In some embodiments, the change in the respective orientation of the billboards may be dampened (e.g., lagging the change of the movement of the viewpoint of the user 7002 in time, or in angular magnitude). In addition, top schematic 9068 illustrates that in response to the rightward movement of the user 7002, computer system updates the display of the move affordance 9037 to the position 9060-12.

FIG. 9H is analogous to FIG. 9A, except that FIG. 9H illustrates a different application user interface 9002-b (or 9002-c, with reference to example transitions illustrated in FIGS. 9K and 9L), which the computer system 101 scales differently from the application user interface 9002-a illustrated in FIGS. 9A-9G. Optionally, the application user interface 9002-b is the same as the application user interface 9002-a, except for one or more application settings within the application that cause computer system 101 to scale the application user interface differently. FIG. 9H also illustrates the attention 9035 of the user 7002 being directed toward (e.g., based on user 7002 gazing at or based on another gaze proxy) a left edge of the application user interface 9002-b. In response to detecting the attention 9035 of the user 7002 being directed toward the left edge of the application user interface 9002-b, the computer system 101 displays a menu bar 9070 that is associated with the application user interface 9002-b. In some embodiments, a developer of the application user interface 9002-b is enabled to place the menu bar 9070 at any arbitrary position within the application volume, demarcated by an outline 9072 (e.g., optionally displayed to the user 7002, such as during placement or adjustment of the placement of the menu bar 9070) of the application user interface 9002-b, for example, along one or more of the three orthogonal axes depicted on a top portion of the menu bar 9070. In some embodiments, the developer is enabled to allow the user 7002 to customize the placement of the menu bar 9070 within the application volume demarcated by the outline 9072. In some embodiments, content elements closer to edges of the application volume of the application user interface 9002-b are displayed with a feathering visual effect. For example, an opacity of content elements closer to edges of the application volume gradually decreases as a distance from a center of the content (e.g., a center of the application user interface 9002-b) increases. For example, portions of the building 9010 nearer an edge of the application volume are displayed with a lower opacity (e.g., more translucent) than the portions of the building 9010 closer to the center of the application user interface 9002-b. In some embodiments, application content elements at an edge of the elliptical cylindrical application volume (e.g., application user interface 9002-b) are feathered to a different degree (e.g., more feathered, or less feathered) than application content elements at an edge of a differently shaped application volume (e.g., a rectangular prismatic application volume of application user interface 8058 in FIG. 8P, or a cylindrical application volume of application user interface 8002 in FIG. 8A).

FIG. 9I illustrates an example transition from FIG. 9H. Based on detecting a user input corresponding to a request to move the application user interface 9002-b in depth, away from the viewpoint of the user 7002, the computer system 101 displays the application user interface 9002-a at an updated position in the three-dimensional environment that is at a greater depth from the viewpoint of the user 7002. For example, the user input includes the hand 7022 performing an air pinch gesture while the attention 9035 of the user 7002 is directed toward the move affordance 9037, followed by movement of the air pinch gesture in depth away from the viewpoint of the user 7002. FIG. 9I also illustrates behavior of a fixed scale application (e.g., application user interface 9002-b). Top view 9076 shows the application user interface 9002-b being maintained at the same size 9032 when moved to a distance 9082 from the viewpoint of the user 7002 (e.g., as in FIG. 9I), from a location at the distance 9028 from the viewpoint of the user 7002 (e.g., as in FIG. 9H). Due to the increased distance between the application user interface 9002-b and the viewpoint of the user 7002, and because the application user interface 9002-b is a fixed scale application user interface, the application volume of the application user interface 9002-b is maintained at the same size 9032 and thus appears smaller in the viewport illustrated in FIG. 9I than in the viewport illustrated in FIG. 9H.

In some embodiments, some three-dimensional user interface elements, such as the move affordance 9037, the three-dimensional control 9022, and/or the menu bar 9070 are dynamically scaled even though the rest of the application user interface content elements within the application user interface 9002-b remain at fixed scale, as illustrated in FIG. 9I. The three-dimensional application user interface elements may be dynamically scaled so that they remain legible and sufficiently large to provide ease of access to the user 7002 when the application user interface 9002-b is placed further away from the viewpoint of the user 7002. Due to the different scaling behaviors of respective user interface elements, the application user interface 9002-b is a mixed scale application. In a mixed scale application, a ratio of respective dimensions of two user interface elements that are scaled differently does not stay constant when a distance between the application user interface and the viewpoint of the user 7002 is changed. For example, a ratio of the height dimension 9036 of the building 9010 to the height of the menu bar 9070 (FIG. 9H) is reduced when the application user interface 9002-b is moved in depth, away from the viewpoint of the user 7002 (e.g., a ratio of height dimension 9036 of the building 9010 to the height of the menu bar 9070 is smaller than a ratio of a height dimension 9036 of the building 9010 to the height of the menu bar 9070 in FIG. 9I, because the height of the building 9010 remained unchanged (e.g., appearing smaller merely due to perspective) whereas the height of the menu bar 9070 was increased).

Due to mixed scaled resizing, isotropic enlargement of the menu bar 9070 (e.g., to maintain a same displayed size of menu bar 9070 at an increased distance from the viewpoint of the user 7002) may cause the menu bar 9070 to collide with fixed scale application content elements (e.g., the smaller building 9010, and/or other content elements). In some embodiments, the menu bar 9070 is resized (e.g., enlarged and/or minimized) in an anisotropic fashion, such as being biased toward a first direction (e.g., left) relative to the building 9010 that is fixed scale (e.g., and/or relative to a point along the line 9090). Similarly, isotropic resizing (e.g., enlargement or reduction) of the move affordance 9037 may cause the move affordance 9037 to collide with fixed scale application content elements (e.g., the smaller building 9012, the oval plane 9018, and/or other content elements). In some embodiments, the move affordance 9037 is resized (e.g., enlarges and/or minimizes) in an anisotropic fashion, such as being biased toward a second direction (e.g., downward) relative to the building 9010 that is fixed scale (e.g., and/or relative to a point along the line 9093).

In some embodiments, the computer system 101 imposes one or more movement limits to the application user interface that depend on whether the application user interface is dynamically scaled or has fixed scale. For example, FIG. 9B may illustrate a first maximum distance from the viewpoint of the user 7002 that the application user interface 9002-a may be placed. As a result, in response to detecting an additional user input to move the application user interface 9002-a greater than the distance 9040 from the viewpoint of the user 7002, the computer system 101 maintains the application user interface 9002-a at the same size 9046 and at the same distance 9040 from the viewpoint of the user 7002. Similarly, FIG. 9I may illustrate a second maximum distance from the viewpoint of the user 7002 that the application user interface 9002-b may be placed. In response to detecting an additional user input to move the application user interface 9002-b greater than the distance 9082 from the viewpoint of the user 7002, the computer system 101 maintains the application user interface 9002-b at the same size 9032 and at the same distance 9082 from the viewpoint of the user 7002. In some embodiments, the first maximum distance for a dynamically scaled application is different (e.g., larger than, or smaller than) the second maximum distance for a fixed scale application (e.g., such that the distance 9040 would be different from the distance 9082). In some embodiments, a dynamically scaled application user interface element has a different size threshold (e.g., maximum and/or minimum size threshold) than a fixed scaled application user interface element (e.g., such user interface element would be dynamically scaled up to the maximum size threshold and thereafter be fixed scale with increasing distance from the viewpoint of the user, and/or dynamically scaled down to the minimum size threshold and thereafter be fixed scale with decreasing distance from the viewpoint of the user).

FIG. 9J shows the user 7002 moving in the three-dimensional environment relative to the application user interface 9002-b (e.g., while the application user interface 9002-b remains at the same location within the three-dimensional environment), in an example transition from FIG. 9I. Top view 9084 shows the viewpoint 7002′ of the user 7002 moving to a distance 9086, further away from the application user interface 9002-b, than the distance 9082 illustrated in FIG. 9I. As a result of the movement of the viewpoint of the user 7002, the application user interface 9002-b appears over a smaller portion of the respective extent (e.g., angular range) 9026 of the viewport of the user 7002, and appears smaller in the viewport of the user 7002, as illustrated in FIG. 9J. Due to the movement of the viewpoint of the user 7002 between FIG. 9I and FIG. 9J, the dynamically scaled three-dimensional user interface elements such as the menu bar 9070, the move affordance 9037 and/or the three-dimensional control 9022 all appear smaller in the viewport of FIG. 9J compared to the viewport illustrated in FIG. 9I (e.g., the computer system 101 forgoes dynamically scaling one or more of those three-dimensional user interface elements in response to detecting the movement in the viewpoint of the user 7002). Optionally, the ratio of the height dimension 9036 of the building 9010 to the height of the menu bar 9070 in FIG. 9I stays the same as a ratio of a height dimension 9036 of the building 9010 to the height of the menu bar 9070 in FIG. 9J).

In some embodiments, FIG. 9H illustrates an initial appearance of a different application user interface 9002-c, which the computer system 101 scales differently from the application user interface 9002-a illustrated in FIGS. 9A-9G and the application user interface 9002-b illustrated in FIGS. 9I-9J. Optionally, the application user interface 9002-c is the same as one or more of the application user interface 9002-a and the application user interface 9002-b, except for one or more application settings within the application that causes computer system 101 to scale the application user interface differently. FIG. 9K illustrates an example transition from FIG. 9H (e.g., an alternate transition to that of FIG. 9I). Based on detecting a user input corresponding to a request to move the application user interface 9002-c in depth, away from the viewpoint of the user 7002, the computer system 101 displays the application user interface 9002-c at an updated position in the three-dimensional environment that is at a greater depth (e.g., at a distance 9092) from the viewpoint of the user 7002.

FIGS. 9K-9L illustrate behaviors of an application user interface 9002-c that is another type of mixed scale application. In some embodiments, in addition to dynamically scaling some three-dimensional user interface elements (e.g., the move affordance 9037, the three-dimensional control 9022, the menu bar 9070, and/or other three-dimensional user interface elements), additional user interface elements, such as two-dimensional user interface elements billboards 9016-1, 9016-2, 9016-3 and 9016-4 are also dynamically scaled. For example, as illustrated in FIG. 9K, the two-dimensional application user interface elements may be dynamically scaled so that they remain legible and sufficiently large to provide ease of access to the user 7002 when the application user interface 9002-c is placed further away from the viewpoint of the user 7002. In some embodiments, in accordance with a determination that one or more dynamically scaled two-dimensional user interface elements would be enlarged beyond a size threshold (e.g., with respect to the fixed scale user interface elements, and/or with respect to different criteria), the computer system 101 forgoes displaying (e.g., ceases displaying) the one or more dynamically scaled two-dimensional user interface elements. For example, in accordance with a determination that the billboard 9016-4 (FIG. 9H) would be enlarged beyond the size threshold in response to a movement of the application user interface 9002-c to the distance 9092 (e.g., the billboard 9016-4 (FIG. 9H) would be enlarged beyond the size threshold in FIG. 9K, optionally colliding into one or more application content elements if it were to be displayed in the viewport), the computer system forgoes displaying the billboard 9016-4 (e.g., ceasing to display the billboard 9016-4 shown in FIG. 9H in conjunction with moving the application user interface 9002-c to the distance 9092). In some embodiments, the biased scaling of the dynamically scaled user interface elements (e.g., as described with reference to FIGS. 9I-9J for some three-dimensional user interface elements in the application user interface 9002-b) is optionally applied to one or more of the two-dimensional user interface elements and/or one or more of the three-dimensional user interface elements illustrated in FIGS. 9I-9K.

FIG. 9L illustrates an example transition from FIG. 9K. Based on detecting a user input corresponding to a request to move the application user interface 9002-c in depth, toward the viewpoint of the user 7002, the computer system 101 displays the application user interface 9002-c at an updated position in the three-dimensional environment (at a distance 9096) that is closer in depth toward the viewpoint of the user 7002. In accordance with a determination that dynamically scaling the two-dimensional user interface elements (e.g., reducing their respective sizes so that they occupy substantially the same angular extent within the viewport of the user 7002 when the application user interface 9002-c is brought closer to the viewpoint of the user 7002) reduces a displayed size of the billboard 9016-4 to below a size threshold (e.g., the size threshold for hiding a user interface element, a smaller threshold than the hiding threshold, and/or other size thresholds), the computer system redisplays the billboard 9016-4. Top view 9094 shows the application user interface 9002-c, having been moved closer in depth toward the viewpoint of the user 7002, at a distance 9092 from the viewpoint 7002′. In some embodiments, a developer of the application user interface 9002-a, 9002-b, or 9002-c is enabled to specify whether one or more application user interface elements (e.g., three-dimensional application user interface elements and/or two-dimensional application user interface elements) are to be dynamically scaled.

In contrast to FIGS. 9A-9D, which show the application user interface 9002-a being moved in depth relative to the viewpoint of the user 7002, FIGS. 9M-9P show the user 7002 resizing the application user interface 9002-a while a characteristic portion (e.g., a center portion, a centroid of the application user interface) the application user interface 9002-a remains at the same position (e.g., depth) within the three-dimensional environment. FIG. 9M is analogous to FIG. 9A, except that FIG. 9M illustrates a user input that includes the hand 7022 performing an air pinch gesture 9500-3 while the attention 9035 of the user 7002 is directed toward (e.g., based on user 7002 gazing at or based on another gaze proxy) a resize affordance 9098. In some embodiments, the computer system 101 transitions from displaying the move affordance 9037 to displaying the resize affordance 9098 (e.g., by morphing the move affordance 9037, optionally via an animation, into the resize affordance 9098 and ceasing to display the move affordance 9037) in response to detecting that the attention 9035 of the user has moved toward the right edge of the application user interface 9002-a (e.g., as described herein with reference to FIGS. 8A-8X and method 13000). The user input further includes movement of the air pinch gesture 9500-3 away from the viewpoint of the user 7002, optionally while the attention 9035 remains directed toward the resize affordance 9098.

FIG. 9N shows an example transition from FIG. 9M. Based on detecting the movement of the air pinch gesture 9500-3 in depth away from the viewpoint of the user 7002, the computer system 101 resizes the application user interface 9002-a by decreasing the application volume of the application user interface 9002-a while maintaining the characteristic portion of the application user interface 9002-a at the same location in the three-dimensional environment. For example, in FIG. 9N, the computer system 101 reduces the application volume of the application user interface 9002-a such that only the building 9012, the building 9008, and the building 9014, with their respective billboards 9016-3, 9016-2, 9016-4 are displayed. In some embodiments, in response to detecting a user input (e.g., a different user input than an air pinch gesture performed in conjunction with attention being directed to the resize affordance 9098, such as a two-handed gesture, and/or other user inputs) for resizing the application user interface 9002-a, the computer system 101 rescales the application user interface 9002-a shown in FIG. 9M at the same depth from the viewpoint of the user 7002, without decreasing the amount of application content elements displayed to the user 7002 (e.g., by applying a scaling factor less than 1 to reduce the size of the application user interface 9002-a, or by applying a scaling factor greater than 1 to enlarge the size of the application user interface 9002-a). Top view 9100 illustrates the application user interface 9002-a having a smaller size 9101 while the characteristic portion of the application user interface 9002-a remains at the distance 9028 away from the viewpoint 7002′ of the user 7002.

FIG. 9O is analogous to FIG. 9A, except that FIG. 9O illustrates a user input that includes the hand 7022 performing an air pinch gesture 9500-3 while the attention 9035 of the user 7002 is directed toward the resize affordance 9098. The user input further includes movement of the air pinch gesture 9500-4 toward the viewpoint of the user 7002, optionally while the attention 9035 remains directed toward the resize affordance 9098. FIG. 9P shows an example transition from FIG. 9O. Based on detecting the movement of the air pinch gesture 9500-4 in depth toward the viewpoint of the user 7002, the computer system 101 resizes the application user interface 9002-a by increasing the application volume of the application user interface 9002-a while maintaining the characteristic portion of the application user interface 9002-a at the same location in the three-dimensional environment. For example, in FIG. 9P, the computer system 101 increases the application volume of the application user interface 9002-a such that additional buildings and trees are revealed and displayed in the viewport. Top view 9102 illustrates the application user interface 9002-a having a larger size 9104 while the characteristic portion of the application user interface 9002-a remains at the distance 9028 away from the viewpoint 7002′ of the user 7002.

Additional descriptions regarding FIGS. 9A-9P are provided below with reference to method 14000 described with respect to FIGS. 14A-14H.

FIGS. 10A-10I illustrate examples of changing a display location of a user interface element based on a change in a viewpoint of the user. FIGS. 15A-15F are flow diagrams of an exemplary method 12000 for changing a display location of a user interface element based on a change in a viewpoint of the user. The user interfaces in FIGS. 10A-10I are used to illustrate the processes described below, including the processes in FIGS. 15A-15F.FIG. 10A illustrates a view of a three-dimensional environment (e.g., corresponding at least partially to the physical environment 7000 in FIG. 7A) that is visible to the user 7002 via HMD 7100a of the computer system 101. The three-dimensional environment includes an application user interface 10002 that displays three-dimensional application content including one or more user interface elements having a non-zero length, non-zero width, and non-zero depth. For example, the application user interface 10002 (e.g., the same as or analogous to the application user interface 8002 of FIGS. 8A-8X) is demarcated by an outline 10004 that is optionally not displayed to the user 7002. For example, the outline 10004 of the application user interface 10002 has a cylindrical shape (e.g., a hollow cylinder that encloses the three-dimensional application content) within which the computer system 101 displays a chair 8004 having a chair back 8006, a chair seat 8008 and four chair legs 8010 of the application user interface 10002. A move affordance 10006 (e.g., the same as or analogous to the move affordance 8014 of FIGS. 8A-8X) associated with the application user interface 10002 is optionally displayed (e.g., independently of attention 8016 of the user 7002, or in response to detecting that the attention 8016 of the user 7002 is directed to a portion (e.g., a central portion) of the application user interface 10002). FIG. 10A also illustrates a first user interface element 10008 that is displayed on an exterior surface of the three-dimensional outline 10004. The first user interface element 10008 optionally displays information pertaining to the application user interface 10002 (e.g., tips on how to use the application user interface 10002, information relevant to application content currently displayed in the application user interface 10002, and/or a notification or alert concerning the application user interface 10002). In some embodiments, the first user interface element 10008 displays information pertaining to system functions of the computer system 101 (e.g., information that is not specific to the application user interface 10002). In some embodiments, the first user interface element 10008 is oriented such that a plane of the first user interface element 10008 faces a viewpoint of the user 7002 (e.g., is substantially perpendicular to a viewpoint of the user 7002, and/or is within 0-10° from being perpendicular to the viewpoint of the user 7002, along at least one dimension of the first user interface element 10008 such as a lateral axis or yaw axis, and optionally tilted along one or more other dimensions such as a vertical axis or pitch axis as described herein with reference to FIG. 7K). Top view 10010 illustrates the first user interface element 10008 being displayed in front of the viewpoint 7002′ of the user 7002, on an exterior surface of the application user interface 10002, while the viewpoint 7002′ of the user 7002 faces the wall 7004′. Top schematic 10012 illustrates the first user interface element 10008 being displayed at a first position 10014-1 out of multiple positions (e.g., position 10014-1, position 10014-2, position 10014-3, position 10014-4, position 10014-5, position 10014-6, position 10014-7, or position 10014-8) arranged (e.g., optionally symmetrically, and/or evenly) around the application user interface 10002 (e.g., around an exterior of the application volume of the application user interface 10002, and/or along a surface of the three-dimensional outline 10004). In some embodiments, a developer of the application user interface 10002 is enabled to select the number of available locations (e.g., eight as in the example illustrated in FIG. 10A, ten, seven, six, five, four, three, two, or a different number) at which a user interface element (e.g., optionally a user interface element that is associated with an application, such as the application user interface 10002, or a user interface element that is non-application specific) can be displayed to the user 7002.

FIG. 10B illustrates an example transition from FIG. 10A. In response to detecting a movement of the viewpoint of the user 7002 leftward within the three-dimensional environment, the computer system 101 updates the display of the chair 8004 based on the shift in the viewpoint of the user 7002, to reveal a rear portion of the chair back 8006, while also displaying the first user interface element 10008 and the move affordance 10006 at respective updated positions. Due to the change in the position of the viewpoint of the user 7002 within the three-dimensional environment, the wall 7005′ is visible within the viewport of the user 7002. Top view 10016 illustrates that a position of the viewpoint of the user 7002 has changed within the three-dimensional environment, the first user interface element 10008 remains displayed in front of the viewpoint 7002′ of the user 7002, and a plane of the first user interface element 10008 remains oriented substantially perpendicular (e.g., along the lateral or yaw axis) to the viewpoint of the user, albeit at a new location (e.g., the position 10014-2) on an exterior surface of the application user interface 10002. Top schematic 10018 illustrates the first user interface element 10008 being currently displayed at a different position (e.g., position 10014-2), out of the multiple available positions, from the position shown in FIG. 10A.

FIG. 10C illustrates an example (e.g., an alternative) transition from FIG. 10A. In some embodiments, the computer system 101 does not automatically update the display location of the first user interface element 10008 at one of the available anchoring positions around the application user interface 10002 in response to detecting movement of the viewpoint of the user 7002 (e.g., and the associated change in the viewpoint of the user 7002). For example, the movement of the viewpoint of the user 7002 may not have reached a threshold (e.g., a linear dimension threshold, and/or an angular threshold) required for the computer system 101 to automatically update the locations for displaying the move affordance 10006 and/or the first user interface element 10008. In some embodiments, the application user interface 10002 may include an application setting configured to require the user 7002 to initiate a process for updating a display location of the move affordance 10006 and/or the first user interface element 10008, for example, by selecting a user interface element (e.g., the move affordance 10006). FIG. 10C illustrates a viewport in which the user 7002 has moved rightward from the position of the user 7002 illustrated in FIG. 10A. As a result, both the move affordance 10006 and the first user interface element 10008 appear to the left of the viewpoint of the user 7002, and a plane of the first user interface element 10008 is no longer perpendicular (e.g., along the lateral or yaw axis) to the viewpoint of the user 7002. Top view 10020 shows the viewpoint 7002′ of the user 7002 moving to a right side of the application user interface 10002 and the first user interface element 10008 remaining in the same location as depicted in FIG. 10A.

FIG. 10D shows an example transition from FIG. 10C. In response to detecting an air pinch gesture 8500-3 while the attention 8016 of the user 7002 is directed toward the move affordance 10006 (FIG. 10C), the computer system 101 reorients the move affordance 10006 to face a viewpoint of the user 7002, and the computer system 101 also reorients the application user interface 10002 to face the viewpoint of the user, such that the orientation of the chair 8004 in FIG. 10D, with respect to the viewpoint of the user 7002, is analogous to the orientation of the chair 8004 in FIG. 10A. Top view 10022 shows that the viewpoint 7002′ of the user 7002 faces a corner of the three-dimensional environment between the wall 7004′ and the wall 7006′. Top view 10022 also shows the first user interface element 10008 being displayed in front of the viewpoint of the user 7002 after the application user interface 10002 has been reoriented to face the viewpoint of the user 7002.

FIG. 10E shows an alternative transition from FIG. 10C. In response to detecting the air pinch gesture 8500-3 while the attention 8016 of the user 7002 is directed toward the move affordance 10006 (FIG. 10C), the computer system 101 reorients the move affordance 10006 to face a viewpoint of the user 7002 but does not reorient the application user interface 10002 to face the user, such that the orientation of the chair 8004 in FIG. 10E with respect to the viewpoint of the user 7002 is analogous to the orientation of the chair 8004 in FIG. 10C. The first user interface element 10008 is also repositioned to a new location on the exterior surface of the outline 10004 to face the viewpoint of the user 7002. Top view 10024 shows that the viewpoint 7002′ of the user 7002 faces a corner of the three-dimensional environment between the wall 7004′ and the wall 7006′. Top view 10024 also shows the first user interface element 10008 being displayed in front of the user 7002 and oriented to face the viewpoint of the user 7002. In contrast to top view 10022 (FIG. 10D), the orientation of the three-dimensional content of the application user interface 10002 remains the same as that shown in FIG. 10C.

FIGS. 10F-10G illustrate a three-dimensional application user interface 10028 having a different volumetric shape compared to the three-dimensional application user interface 10002 shown in FIGS. 10A-10E.

FIG. 10F illustrates an application user interface 10028 that displays three-dimensional application content including one or more user interface elements having a non-zero length, non-zero width, and non-zero depth. For example, the application user interface 10028 is demarcated by a three-dimensional outline 10034 that is optionally not displayed to the user 7002. For example, the outline 10034 of the application user interface 10028 has a cuboidal shape (e.g., a hollow rectangular prism that encloses the three-dimensional application content) within which the application user interface 10028 displays a table 10030 having four table legs 10032, one of which is black. A move affordance 10042 associated with the application user interface 10028 is optionally displayed (e.g., independently of attention 8016 of the user 7002, or in response to detecting that the attention 8016 of the user 7002 is directed to a portion (e.g., a central portion) of the application user interface 10028). FIG. 10F also illustrates a second user interface element 10044 that is displayed on an exterior surface of the three-dimensional outline 10034. The second user interface element 10044, like the first user interface element 10008, optionally displays information pertaining to the application user interface 10028 (e.g., tips on how to use the application user interface 10028, information relevant to application content currently displayed in the application user interface 10002, and/or a notification or alert concerning the application user interface 10028). In some embodiments, the second user interface element 10044 displays information pertaining to system functions of the computer system 101 (e.g., information that is not specific to the application user interface 10028). In some embodiments, the second user interface element 10044 is oriented such that a plane of the second user interface element 10044 faces a viewpoint of the user 7002 (e.g., is substantially perpendicular to a viewpoint of the user 7002, and/or is within 0-10° from being perpendicular to the viewpoint of the user 7002, along at least one dimension of the second user interface element 10044 such as a lateral axis or yaw axis, and optionally tilted along one or more other dimensions such as a vertical axis or pitch axis as described herein with reference to FIG. 7K). Top view 10036 illustrates the second user interface element 10044 being displayed in front of the viewpoint 7002′ of the user 7002, on an exterior surface of the outline 10034 for application user interface 10028, while the viewpoint of the user 7002 faces the wall 7004′. Top schematic 10038 illustrates the second user interface element 10044 being currently displayed at a first position 10040-1 out of multiple positions (e.g., position 10040-1, position 10040-2, position 10040-3, or position 10040-4) arranged (e.g., optionally symmetrically and/or evenly) around the application user interface 10028 (e.g., around the application volume of the application user interface 10028, and/or along a surface of the outline 10034).

The number of available positions for placing the second user interface element 10044 (e.g., four) with respect to the application user interface 10028 is different from the number of available positions for placing the first user interface element 10008 (e.g., eight) with respect to the application user interface 10002. For example, the difference in the number of available positions is in some embodiments due to the different shapes of the volumetric application associated with the application user interface 10002 (e.g., cylindrical) and the application user interface 10028 (e.g., rectangular prismatic). Alternatively, or in addition, the number of available positions is in some embodiments application specific (e.g., more available positions for an application displaying more intricate details, having a larger application volume, and/or due to other factors specific to the application).

FIG. 10G illustrates an example transition from FIG. 10F. In response to detecting a movement of the viewpoint of the user 7002 leftwards within the three-dimensional environment, the computer system 101 updates the display of the table 10030 according to the change in the viewpoint of the user 7002, such that the black leg 10032 of the table 10030 is displayed closest to the user 7002. The computer system 101 also updates the display locations of the second user interface element 10044 and the move affordance 10042 by moving them (e.g., optionally via an animation, by fading out the second user interface element 10044 and the move affordance 10042 at the first position 10040-1 (e.g., as indicated by the outline 10052) and fading in the second user interface element 10044 and the move affordance 10042 at the second position 10040-2, and/or via a different visual effect). Due to the change in the position of the viewpoint of the user 7002 within the three-dimensional environment, and the accompanying change in the viewpoint of the user 7002, the wall 7005′ is visible within the viewport of the user 7002. Top view 10046 illustrates that a position of the viewpoint of the user 7002 has changed (e.g., moved leftward) within the three-dimensional environment, and the second user interface element 10044 is displayed on a different surface of the outline 10034, at a new position (e.g., position 10040-2) that is to the left of the viewpoint of the user 7002. Top schematic 10048 illustrates the second user interface element 10044 being displayed at a different position (e.g., position 10040-2) out of the multiple possible positions, from the position shown in FIG. 10F.

In some embodiments, the computer system 101 updates the display of the second user interface element 10044 in accordance with a determination that a threshold associated with a movement of the viewpoint of the user 7002 is reached. For example, the threshold may be a distance threshold dₜₕ of a movement of the viewpoint of the user 7002 (e.g., along a linear dimension, such as between 5-25% of a linear dimension of the application volume of the application user interface 10028). Alternatively, or in addition, the threshold may be an angular threshold of a rotation of the viewpoint of the user 7002 (e.g., an angle θₐ between the prior viewpoint of the user 7002 (FIG. 10F) and a current viewpoint of the user 7002 (FIG. 10G) is greater than a threshold angle, θₜₕ). In some embodiments, the computer system 101 updates the display of the second user interface element 10044 in accordance with a determination that the viewpoint of the user 7002 has moved outside of a threshold range. For example, the second user interface element 10044 may be displayed at the position 10040-1 while the viewpoint is within an angular range of 0°-90° with respect to a reference line 10047, at the position 10040-2 while the viewpoint is within an angular range of 91°-180° with respect to the reference line 10047, at the position 10040-3 while the viewpoint is within an angular range of 181°-270° with respect to the reference line 10047, or the position 10040-4 while the viewpoint is within an angular range 271°-360° with respect to the reference line 10047. In some embodiments, even though the angular change associated with the movement of the viewpoint of the user 7002 may be small (e.g., a couple of degrees), the computer system 101 would update the display location of the second user interface element 10044 if the angular change crosses an angular range (e.g., the viewpoint of the user crossing from 89° to 92° would result in an update to the display location of the second user interface element even though the angular change is only 3°). Side view 10050 shows the second user interface element 10044 being displayed parallel to an edge 10054 of the three-dimensional outline 10034.

FIG. 10H illustrates an example intermediate stage of the progress between the transition from FIG. 10A to FIG. 10B. In response to detecting a movement of the viewpoint of the user 7002 leftwards within the three-dimensional environment, but before the movement of the viewpoint of the user 7002 meets a threshold requirement (e.g., distance and/or angular threshold), the computer system 101 maintains display of the first user interface element 10008 and the move affordance 10006 at the first position 10014-1. As a result, the first user interface element 10008 and the move affordance 10006 appear on a right of the user 7002. Top view 10056 shows a slight leftward movement of the viewpoint of the user 7002, while other portions of the top view 10056 are analogous to top view 10010 (FIG. 10A). Top schematic 10058 shows the viewpoint of the user 7002 changing by an angle θ_{b} with respective to a reference line 10060, where the angle θ_{b} is less than a threshold angular amount (e.g., less than 22.5°, or less than 20°, or less than another magnitude angle).

In some embodiments, as illustrated in FIGS. 10A-10G, system user interface elements such as the move affordance 10006 and the first user interface element 10008 or the second user interface element 10044 are both redisplayed at an updated location in accordance with a determination that a movement of the viewpoint of the user 7002 satisfies update criteria (e.g., by satisfying a distance or angular threshold, by being within an angular range, or based on meeting other requirements). In some embodiments, the move affordance 10006 and/or other system user interface elements move in response to movement of the viewpoint of the user 7002 while other user interfaces (e.g., an alert from the application user interface, or an alert from the system, or other notifications) remain static even when the movement of the viewpoint of the user 7002 meets update criteria. For example, FIG. 10I illustrates an example transition from FIG. 10H (e.g., resulting in a different transition from that illustrated in FIG. 10B). In FIG. 10I, the user 7002 has moved further leftward such that an angle θ_{c} that the viewpoint of the user 7002 makes with respect to the reference line 10060 is greater than the threshold angle (e.g., greater than 22.5°, greater than 20°, or greater than another magnitude angle). As a result, FIG. 10I illustrates the move affordance 10006 (e.g., or other system user interface elements) being displayed at an updated location (e.g., position 10014-2 on the left of the user 7002) while the first user interface element 10008 remains at the original location (e.g., position 10014-1 on the right side of the user 7002, and/or at the location the computer system 101 initially places the first user interface element 10008). Top view 10062 shows a leftward movement of the viewpoint of the user 7002, while the first user interface element 10008 remains at an analogous position as in top view 10010 (FIG. 10A) and in top view 10056 (FIG. 10H). Top schematic 10064 shows the user 7002 moving greater than the threshold angular amount from the position illustrated in FIG. 10A (e.g., by the angle θ_{c}).

In some embodiments, the application user interface 10002 includes one or more application settings or is otherwise configured such that a developer for the application user interface 10002 is enabled to specify which user interface elements of the application user interface 10002 have a plane that turns toward (e.g., being substantially perpendicular to) the viewpoint of the user 7002, for example, as described with reference to FIG. 9G, without the application user interface 10002 being provided with actual information about the viewpoint of the user (e.g., based on a gaze, and/or a proxy for gaze, such as a head direction of the user 7002). The tilting of the plane of the respective user interface elements may occur dynamically while the viewpoint of the user 7002 is changed, or may only be tilted after the movement of the viewpoint of the user 7002 has reached a threshold.

Additional descriptions regarding FIGS. 10A-10I are provided below in reference to method 15000 described with respect to FIGS. 15A-15F.

FIGS. 11A-11F illustrate examples of resolving spatial conflicts between content elements within a three-dimensional environment with respect to a viewpoint of the user. FIGS. 16A-16C are flow diagrams of an exemplary method 16000 for resolving spatial conflicts between content elements within a three-dimensional environment with respect to a viewpoint of the user. The user interfaces in FIGS. 11A-11F are used to illustrate the processes described below, including the processes in FIGS. 16A-16C.

FIG. 11A illustrates a view of a three-dimensional environment (e.g., corresponding at least partially to physical environment 7000 in FIG. 7A) that is visible to user 7002 via HMD 7100a of computer system 101. The three-dimensional environment includes a volumetric application user interface 11002 within which a number of three-dimensional user interface elements (e.g., a building 11004, a building 11006, a building 11008, a building 11010, a building 11012, and a building 11014) having a non-zero length, non-zero width, and non-zero depth, and two-dimensional user interface elements (e.g., a billboard 11020, a billboard 11022, a billboard 11024, and a billboard 11026) are displayed. The application volume of volumetric application user interface 11002 is demarcated by an oval 11018 in top view 11050, and boundaries of the application volume of the application user interface 11002 may optionally be displayed in the viewport.

The building 11004 and the search menu 11016 are displayed at a first position and a second position (e.g., above the building 11014), respectively, in the three-dimensional environment within the application volume of the volumetric application user interface 11002. From the viewpoint of the user 7002, a left portion 11017-a (shown in FIG. 11B) of the search menu 11016 is behind and obscured by a middle portion 11005-a of the building 11004 while a right portion 11017-b of search menu 11016 is visible from the viewpoint of user 7002 (e.g., a portion of the building 11004 is displayed in front of the search menu 11016 from the viewpoint of the user 7002).

FIG. 11A also illustrates user interface focus being directed to the search menu 11016. In some embodiments, user interface focus is directed to the search menu 11016 based on the attention 11029 of the user 7002 (e.g., a gaze, a proxy for gaze, a verbal input, a voice input, and/or a keyboard or other input that highlights the search menu 11016) being directed toward the search menu 11016. For example, in response to detecting a voice input from the user 7002 (e.g., the user 7002 speaking the word or phrase “search” or “search menu”), the computer system 101 shifts the user interface focus to the search menu 11016, optionally without the gaze of the user 7002 being directed to the search menu 11016. Alternatively, or in addition, in response to detecting that the attention of the user 7002 (e.g., gaze, or a proxy for gaze) is directed toward the search menu 11016 (optionally in conjunction with detecting a selection input, such as an air pinch gesture performed by the hand 7022 while the attention of the user 7002 is directed toward the search menu 11016), the computer system 101 shifts the user interface focus to the search menu 11016.

FIG. 11B illustrates an example transition from FIG. 11A. In response to detecting that the user interface focus is directed toward the search menu 11016, and in accordance with a determination that a portion of the building 11004 spatially conflicts with the application content (e.g., the search menu 11016) to which the attention of the user 7002 is directed, from the viewpoint of the user 7002, the computer system 101 changes, via the one or more display generation components, one or more visual properties of at least a portion of building 11004 (e.g., a middle portion 11005-a) to increase visibility of a previously obscured portion of search menu 11016 (e.g., left portion 11017-a) with respect to the viewpoint of user 7002. As a result, additional portions of search menu 11016 (e.g., the left portion 11017-a, a majority of the search menu 11016, or all of the search menu 11016) are visible from the viewpoint of user 7002 even though building 11004 remains at the first position (e.g., at a same first depth closer to the viewpoint of the user 7002), and search menu 11016 remains at the second position (e.g., at a same second depth further from the viewpoint of the user 7002) in the three-dimensional environment, as illustrated in top view 11050 (of FIGS. 11A and 11B). The computer system 101 changes one or more visual properties of the middle portion 11005-a, including one or more of: a degree of blurring, a level of brightness, a level of saturation, a level of visual intensity, a level of contrast, and/or a level of opacity to display a breakthrough region 11030-1 that allows the left portion 11017-a of search menu 11016, though positioned further in depth from the viewpoint of the user 7002 than a corresponding portion (e.g., middle portion 11005-a) of building 11004, to be rendered visible with respect to the viewpoint of user 7002, while the middle portion 11005-a is obscured from the viewpoint of user 7002 or no longer displayed. The size of the breakthrough region 11030-1 illustrated in FIG. 11B is not necessarily to scale and may be enlarged to increase legibility. In some embodiments, a size of the breakthrough region 11030-1 is aligned more closely to (e.g., exactly matching) the left portion 11017-a of the search menu 11016.

For example, the computer system 101 changes one or more visual properties of the middle portion 11005-a of the building 11004 by decreasing an opacity of the middle portion 11005-a of the building 11004 such that the left portion 11017-a of the search menu 11016 becomes visible from the viewpoint of the user 7002 through the middle portion 11005-a of the building 11004 that has become more transparent. Alternatively or in addition, the computer system 101 changes a visual property of the middle portion 11005-a by removing content from the middle portion 11005-a (e.g., forgoing displaying the middle portion 11005-a, and/or ceasing to display the middle portion 11005-a) such that the left portion 11017-a of the search menu 11016 becomes visible from the viewpoint of the user 7002 via the removal of the middle portion 11005-a.

In some embodiments, the computer system 101 only changes one or more visual properties of the portion of the application content that is blocking the application content (e.g., or user interface element) toward which the attention 11029 of the user 7002 is directed. For example, in FIG. 11B, while attention of the user 7002 is directed toward the search menu 11016, the computer system 101 only changes the visual properties of the building 11004 between the width of x₁ and x₂, and the height of y₁ and y₂ (e.g., corresponding to the middle portion 11005-a). The computer system 101 forgoes changing visual properties of portions of the building 10004 below the height of y₂, above the height y₁, to the left of x₂ and to the right of x₁. As a right portion 11017-b of the search menu 11016 is not obscured by the building 11004 from the viewpoint of the user 7002, the computer system 101 forgoes changing one or more visual properties of additional portions of the building 11004.

In some embodiments, after the breakthrough region 11030-1 is displayed, the attention 11029 of the user 7002 moves away from the search menu 11016 and is redirected toward the building 11004. In response to detecting that the attention 11029 of the user 7002 is directed toward the building 11004, and in accordance with a determination that the building 11004 is not blocked by other application content from the viewpoint of the user 7002, the computer system 101 ceases display of the breakthrough region 11030-1 (e.g., because the attention 11029 of the user 7002 is not directed to the search menu 11016), and redisplays the middle portion 11005-a of the building 11004 in front of the left portion 11017-a of the search menu 11016 (e.g., the computer system 101 transitions from displaying the viewport illustrated in FIG. 11B back to displaying the viewport illustrated in FIG. 11A).

In some embodiments, the user interface focus is directed to the search menu 11016 based on a change in where input focus is directed, optionally by an automated process. FIGS. 11C and 11D illustrate the user interface focus being shifted toward the search menu 11016 displayed within an application volume of volumetric application user interface 11002 as a tutorial (e.g., automatically) progresses, independently of the attention of the user 7002. FIG. 11C illustrates a first page 11032-1 of a tutorial displayed on the right of the building 11004. The attention 11029 of the user 7002 is directed toward the first page 11032-1 of the tutorial. Top view 11054 shows that the first page 11032-1 of the tutorial is displayed at an outside edge of the application volume of the application user interface 11002. In some embodiments, the first page 11032-1 of the tutorial is displayed at another location (e.g., within the application volume of the application user interface 11002, and/or at another location within the three-dimensional environment).

FIG. 11D illustrates an example transition from FIG. 11C. The tutorial progresses to display a second page 11032-2 while also shifting the user interface focus to an expanded search menu bar 11034 that includes a speech input function that is the subject of the second page 11032-2 of the tutorial. Optionally, the tutorial progresses to the second page 11032-2 while the attention 11029 of the user 7002 remains directed toward the tutorial. Alternatively, the tutorial progresses to a second page 11032-2 independently of the attention 11029 of the user 7002. Top view 11056 shows that the second page 11032-2 of the tutorial is displayed at the same location as the first page 11032-1 of the tutorial, on the outside edge of the application volume of the application user interface 11002. The expanded search menu bar 11034 depicted in FIG. 11D and in the top view 11056 is wider than the search menu 11016 depicted in FIG. 11C and in the top view 11054. Thus, the computer system 101 displays a breakthrough region 11030-2 that allows the expanded search menu bar 11034 (e.g., including the left portion of expanded search menu bar 11034, though positioned further in depth from the viewpoint of the user 7002 than a corresponding portion (e.g., the middle portion 11005-a) of the building 11004 and a corresponding portion of the billboard 11024) to be rendered visible with respect to the viewpoint of user 7002.

FIG. 11E illustrates an example transition after a search query is entered into the application user interface 11002 (e.g., via the search menu 11016 or the expanded search menu bar 11034) and the computer system 101 displays search results to the user 7002 in an expanded search result panel 11036. In accordance with a determination that the expanded search result panel 11036 is behind additional portions of the content of the application user interface 11002, such as one or more additional portions of the building 11004, a portion of the building 11006, and a portion of the billboard 11024 from the viewpoint of the user 7002 (e.g., in contrast to the middle portion 11005-a of the building 11004 that obscured the left portion 11017-a of the search menu 11016 prior to the display of the expanded search result panel 11034, and in contrast to the portions of the building 11004 and the billboard 11024 that were affected by the breakthrough region 11030-2), the computer system 101 changes one or more visual properties of the one or more additional portions of corresponding application content to display a breakthrough region 11032-3 affecting the building 11012, a breakthrough region 11032-4 affecting the building 11004 and the billboard 11024 (e.g., an enlarged breakthrough region that encompasses the breakthrough region 11032-1), and a breakthrough region 11032-5 affecting the building 11006) so that the expanded search result panel 11036 (e.g., the entirety of the expanded search result panel 11036) is visible from the viewpoint of the user 7002. Top view 11058 shows that the expanded search result panel 11036 is behind additional portions of the building 11004, a portion of the building 11006, and a portion of the building 11012. Due to the lower height of the building 11008, the expanded search result panel 11036 is not behind a portion of the building 11008 from the viewpoint of the user 7002, and no breakthrough region is displayed over the building 11008.

FIG. 11F illustrates the computer system 101 displaying a system user interface (e.g., a system alert, and/or other notifications) in response to detecting the occurrence of an event. In some embodiments, the placement of the system user interface is analogous to the placement of the first user interface element 7038 described with reference to FIGS. 7B-7O. FIG. 11F also illustrates the computer system 101 displaying one or more breakthrough regions (e.g., by changing one or more visual properties of content elements of the application user interface 11002) to increase a visibility of the system user interface (e.g., distinct from content elements of the application user interface 11002) with respect to a viewpoint of the user 7002 (e.g., in contrast to the computer system 101 changing one or more visual properties of content elements of the application user interface 11002, rather than a system user interface, to increase a visibility of other content elements of the application user interface 11002 having user interface focus in FIGS. 11B, 11D, and 11E).

The content elements of the application user interface 11002 in the viewport illustrated in FIG. 11F are enlarged with respect to those illustrated in the viewport of FIG. 11A due to the user 7002 being closer to the application user interface 1102. FIG. 11F also illustrates the viewpoint of the user 7002 being less than a threshold distance Dₜₕ from a characteristic portion of the oval 11018 demarcating a spatial extent of the application user interface 11002 (e.g., the portion of the oval 11018 closest to the viewpoint of the user 7002). In response to detecting that a battery level of the computer system 101 has dropped below a respective level and in accordance with a determination that the viewpoint of the user 7002 is less than the threshold distance Dₜₕ from the application user interface 11002 (e.g., as described herein with reference to FIGS. 7B-7O), the computer system 101 displays a system alert 11038 within the application volume of the application user interface 11002. Top view 11060 shows the system alert 11038 being behind the building 11008 and the building 11006 from the viewpoint of the user 7002. Because the system alert 11038 would otherwise be obscured by these content elements of the application user interface 11002, the computer system 101 changes visual properties of corresponding portions of the building 11008 and the building 11006 such that the visibility of the system alert 11038 is increased (e.g., the whole system alert 11038 is unobstructed) from the viewpoint of the user 7002. For example, the portions of the building 11008 and the building 11006 that are in front of the system alert 11038 from the viewpoint of the user 7002, as shown in top view 11060, are made more transparent, less opaque, and/or the application content is removed so that the user 7002 has a direct line of sight to (e.g., all of) the system alert 11038. Optionally, the computer system 101 moves the user interface focus to the system alert 11038 upon its display, without regard to whether attention of the user 7002 is directed toward the system alert 11038.

A breakthrough region 11030-6 indicates the portion of the building 11008 that has one or more visual properties changed by the computer system 101, and a breakthrough region 11030-7 indicates the portion of the building 11006 that has one or more visual properties changed by the computer system 101. The sizes of the breakthrough region 11030-6 and the breakthrough region 11030-7 are not necessarily to scale but may be enlarged to increase legibility. In some embodiments, the sizes of the breakthrough region 11030-6 and/or the breakthrough region 11030-7 are aligned more closely to the portions of the system alert 11038. In some embodiments, the breakthrough region 11030-6 and/or the breakthrough region 11030-7 are displayed with a feathering visual effect. For example, an opacity of the edges of the breakthrough region 11030-6 (e.g., an edge 11040-1) gradually decreases as a distance from a center of the content (e.g., a center of the system alert 11038) decreases. For example, portions of the breakthrough region 11030-6 nearer an edge 11040-2 may be less opaque (e.g., more translucent) than the portions of the breakthrough region 11030-6 nearer an edge 11040-1, due to the edge 11040-2 being closer to the center of the system alert 11038 than the edge 11040-1. Such a feathering visual effect may provide a smoother transition (e.g., reduce visual discontinuities) between different regions of the building 11004 (e.g., between regions of the building 11004 with changed visual properties and regions of the building 11004 without changed visual properties) while maintaining the display of depth information within the application user interface 11002 (e.g., reducing the loss of depth information).

FIG. 11G illustrates an application user interface 11070 that includes a three-dimensional application content element 11064 depicting the Sun, a three-dimensional application content element 11066 depicting the Earth, and a user interface element 11068 that displays information to the user 7002. For example, as illustrated in FIG. 11G, the user interface element 11068 provides an alert to the user 7002 that application content elements displayed beyond the user interface element 11068 are outside of the Milky Way galaxy. In some embodiments, the application user interface 11068 is displayed in an immersive mode such that application content from the application user interface 11070 is displayed in a viewport of the user 7002 (e.g., and content other than the application content from the application user interface 11070 is not displayed in the viewport of the user 7002). In some embodiments, the computer system 101 displays other content (e.g., a view of a three-dimensional environment, such as that corresponding at least partially to the physical environment 7000 in FIG. 7A, or application content from one or more other application user interfaces). A top view 11062 shows the user interface element 11068 being displayed furthest from the viewpoint of the user 7002, the application content element 11066 being displayed closest to the viewpoint of the user 7002, and the application content element 11064 being displayed between the application content element 11066 and the user interface element 11068 (e.g., along a depth direction from the viewpoint of the user 7002, or along a different direction from the viewpoint of the user 7002). FIG. 11G also illustrates the attention 11029 of the user 7002 being directed toward the user interface element 11068.

FIG. 11H illustrates an example transition from FIG. 11G. In response to detecting that the attention 11029 of the user 7002 (e.g., based on gaze of the user 7002 or a proxy for gaze) is directed toward the user interface element 11068 optionally in conjunction with detecting an air pinch gesture performed by the hand 7022 and in accordance with a determination that the user interface element 11068 is furthest away from the viewpoint of the user 7002 (e.g., compared to the user interface element 11064 and the user interface element 11066), the computer system 101 displays additional portions of the user interface element 11068 (e.g., that were not displayed and/or visible in FIG. 11G) by changing one or more visual properties of the intervening user interface element 11066 and user interface element 11064. In accordance with a determination that a left portion of the user interface element 11068 is behind the user interface element 11064 and a bottom left portion of the user interface element 11068 is behind both the user interface element 11066 and the user interface element 11064 (e.g., as shown in FIG. 11G) from the viewpoint of the user 7002 (e.g., in contrast to the right portion of user interface element 11066 that is not obscured by either the user interface element 11066 or the user interface element 11064), the computer system 101 changes one or more visual properties of one or more portions of the user interface element 11064 to display a breakthrough region 11077-1 so that additional portions (e.g., and/or content) of the user interface element 11068 is visible from the viewpoint of the user 7002. In some embodiments, the computer system 101 also changes one or more visual properties of one or more portions of the user interface element 11064 and the user interface element 11066 to display a breakthrough region 11077-2 so that additional portions of the user interface element 11068 (e.g., and optionally, the entirety of the user interface element 11068) is visible from the viewpoint of the user 7002. In some embodiments, as illustrated in FIG. 11H, the breakthrough region 11077-1 includes an edge 11074 that is feathered, blended, and/or smoothed to reduce a visual difference between visual properties of regions of the user interface element 11064 that have not been changed and the breakthrough region 11077-1 of the user interface element 11064. In some embodiments, as illustrated in FIG. 11H, the breakthrough region 11077-2 includes an edge 11072 that is feathered, blended, and/or smoothed to reduce a visual difference between visual properties of regions of the user interface element 11066 that have not been changed and the breakthrough region 11077-2 of both the user interface element 11066 and the user interface element 11064. In some embodiments, the same visual effect (e.g., feathering, blending and/or smoothening) to the edge 11074 and the edge 11072. In some embodiments, different visual effects (e.g., more feathered, less feathered, more blended, less blended, smoother, and/or less smooth) are applied to the edge 11074 as compared to the edge 11072. A top view 11078 shows that the user interface element 11068 remains behind both the user interface element 11064 and the user interface element 11066 when the breakthrough regions 11077-1 and 11077-2 are displayed to render additional portions of the user interface element 11068 visible from the viewpoint of the user 7002.

FIG. 11I illustrates an alternative placement of the user interface element 11068. In some embodiments, as illustrated in FIG. 11I, the user interface element 11068 is displayed in front of the user interface element 11064 and behind the user interface element 11066 from the viewpoint of the user 7002. In response to detecting that the attention 11029 of the user 7002 (e.g., based on gaze of the user 7002 or a proxy for gaze) is directed toward the user interface element 11068, optionally in conjunction with detecting an air pinch gesture performed by the hand 7022, and in accordance with a determination that the user interface 11068 is behind the user interface element 11066 from the viewpoint of the user 7002, the computer system 101 displays additional portions of the user interface element 11068 to the user 7002 by changing one or more visual properties of the user interface element 11066 without changing one of more visual properties of the user interface element 11064. In accordance with a determination that a bottom left portion of the user interface element 11068 is behind the user interface element 11066 from the viewpoint of the user 7002 (e.g., in contrast to the right portion of user interface element 11068 that is not obscured by either the user interface element 11066 or the user interface element 11064), the computer system 101 changes one or more visual properties of one or more portions of the user interface element 11066 to display a breakthrough region 11081-1 so that additional portions of the user interface element 11068 (e.g., the entirety of the user interface element 11068) is visible from the viewpoint of the user 7002. In some embodiments, as illustrated in FIG. 11H, the breakthrough region 11081-1 includes an edge 11082 that is feathered, blended, and/or smoothed to reduce a visual difference between visual properties of regions of the user interface element 11066 that have not been changed and the breakthrough region 11081-1 of the user interface element 11066. In some embodiments, as illustrated in FIG. 11I, due to the user interface element 11068 being displayed in front of the user interface element 11064 from the viewpoint of the user 7002, the computer system 101 forgoes changing visual properties of the user interface element 11064. A top view 11080 shows that the user interface element 11068 remains behind the user interface element 11066 when the breakthrough region 11081-1 is displayed to render additional portions of the user interface element 11068 visible from the viewpoint of the user 7002.

FIG. 11J illustrates a placement of various user interface elements in the application user interface 11070 that is analogous to the placement illustrated in FIG. 11G, except that a two-dimensional user interface element 11086 associated with the user interface element 11066 (e.g., a three-dimensional user interface element) is additionally displayed in the application user interface 11070. In some embodiments, the computer system 101 displays the user interface element 11086 in response to detecting that the attention 11029 of the user 7002 is directed toward the user interface element 11066, optionally in conjunction with detecting a selection input (e.g., an air pinch or other air gesture). In some embodiments, the user interface element 11086 includes a number of selectable options. For example, the user interface element 11086 includes a selectable option to provide information about ocean acidity, a selectable option to provide information about volcanic activities, and a selectable option to provide information about seismic activities. A top view 11084 shows the user interface element 11068 being displayed furthest away from the viewpoint of the user 7002, the application content element 11064 being displayed between the application content element 11066 and the user interface element 11068 (e.g., along a depth direction from the viewpoint of the user 7002, or along a different direction from the viewpoint of the user 7002), and the user interface element 11086 being displayed together with the user interface element 11066. FIG. 11J also illustrates the attention 11029 of the user 7002 being directed toward the user interface element 11064.

FIG. 11K illustrates an example transition from FIG. 11J. In response to detecting that the attention 11029 of the user 7002 (e.g., based on gaze of the user 7002 or a proxy for gaze) is directed toward the user interface element 11064 optionally in conjunction with detecting an air pinch gesture performed by the hand 7022 and in accordance with a determination that the user interface element 11064 is further away from the viewpoint of the user 7002 compared to both the user interface element 11086 and the user interface element 11066, the computer system 101 displays additional portions of the user interface element 11064 to the user 7002 by changing one or more visual properties of the intervening user interface element 11086 and user interface element 11066. In accordance with a determination that a right portion of the user interface element 11064 is behind both the user interface element 11066 and the user interface element 11086 from the viewpoint of the user 7002 (e.g., in contrast to the left portion of user interface element 11064 that is not obscured by either the user interface element 11066 or the user interface element 11086, from the viewpoint of the user 7002), the computer system 101 changes one or more visual properties of one or more portions of the user interface element 11066 to display a breakthrough region 11087-1 so that additional portions of the user interface element 11064 is visible from the viewpoint of the user 7002. In some embodiments, the computer system 101 also changes one or more visual properties of one or more portions of the user interface element 11086 to display a breakthrough region 11087-2 so that additional portions of the user interface element 11064 (e.g., the entirety of the user interface element 11064) is visible from the viewpoint of the user 7002. In some embodiments, as illustrated in FIG. 11K, the breakthrough region 11087-1 includes an edge 11090-1 that is feathered, blended, and/or smoothed to reduce a visual difference between visual properties of regions of the user interface element 11066 that have not been changed and the breakthrough region 11087-1 of the user interface element 11066. In some embodiments, as illustrated in FIG. 11K, the breakthrough region 11087-2 includes an edge 11090-2 that is feathered, blended, and/or smoothed to reduce a visual difference between visual properties of regions of the user interface element 11086 that have not been changed and the breakthrough region 11087-2 of the user interface element 11086. In some embodiments, the same visual effect (e.g., feathering, blending and/or smoothening) is applied to the edge 11090-1 and the edge 11090-2 (e.g., for portions of the edge 11090 bordering the breakthrough region 11087-2 and the breakthrough region 11087-1). In some embodiments, different visual effects (e.g., feathering, blending and/or smoothening) are applied to the edge 11090-1 and the edge 11090-2 (e.g., for portions of the edge 11090 bordering the breakthrough region 11087-2 and the breakthrough region 11087-1).

In some embodiments, the computer system 101 applies different changes to the one or more visual properties of the three-dimensional user interface element 11066 to display the breakthrough region 11087-2 compared to the changes applied to one or more visual properties of the two-dimensional user interface element 11086 to display the breakthrough region 11087-1. For example, the computer system 100 applied blending techniques to produce the breakthrough region 11087-1 for the two-dimensional user interface element 11086, and clipping techniques (e.g., without blending techniques) to produce the breakthrough region 11087-2 in the three-dimensional user interface element 11066. A top view 11088 shows that the user interface element 11064 remains behind both the user interface element 11086 and the user interface element 11066 when the breakthrough regions 11087-1 and 11087-2 are displayed to render additional portions of the user interface element 11064 visible from the viewpoint of the user 7002. FIG. 11K illustrates the attention 11029 of the user 7002 being directed toward the breakthrough region 11081-1 of the user interface element 11064 in conjunction with the hand 7022 of the user 7002 performing a selection input (e.g., an air pinch gesture or a different gesture).

FIG. 11L illustrates an example transition from FIG. 11K. In response to detecting that the attention 11029 of the user 7002 (e.g., based on gaze of the user 7002 or a proxy for gaze) is directed toward the breakthrough region 11087-1 in conjunction with detecting an air pinch gesture performed by the hand 7022 (e.g., shown in FIG. 11K), the computer system 101 displays a user interface element 11902 that provides contextual information associated with the user interface element 11064. In some embodiments, while the computer system 101 is displaying the breakthrough region 11087-1, in response to detecting a selection input that includes an air pinch gesture performed by the hand 7022 while the attention 11029 of the user 7002 is directed toward the breakthrough region 11087-1, the computer system 101 delivers the selection input to (e.g., considers the selection input to be directed toward and/or corresponding to) the user interface element 11064 that is displayed further away from the viewpoint of the user 7002, and rendered visible to the user 7002 by the breakthrough region 11087-1 (e.g., instead of delivering the selection input to the user interface element 11086 that is closer to the viewpoint of the user 7002).

In some embodiments, the contextual information includes selectable options that are associated with the user interface element 11064. For example, the user interface element 11902 includes an option to display a surface temperature, an option to display information about sunspots, and an option to display information about coronal heating. In accordance with a determination that a right portion of the user interface element 11092 is behind both the user interface element 11066 and the user interface element 11086 from the viewpoint of the user 7002 (e.g., in contrast to the left portion of user interface element 11092 that is not obscured by either the user interface element 11066 or the user interface element 11086, from the viewpoint of the user 7002), the computer system 101 changes one or more visual properties of one or more portions of the user interface element 11086 to display a breakthrough region 11091-1 so that additional portions of the user interface element 11092 (e.g., the entirety of the user interface element 11092) is visible from the viewpoint of the user 7002. In some embodiments, the computer system 101 groups related user interface elements (e.g., the user interface element 11092 and the user interface element 11064, and/or the user interface element 11086 and the user interface element 11066) together so that the grouped user interface elements are collectively rendered visible by a breakthrough region that includes portions of the grouped user interface elements that are obscured from the viewpoint of the user. In some embodiments, the computer system 101 groups user interface elements based on related content, hierarchical relationships between the user interface elements, and/or other criteria. In some embodiments, as illustrated in FIG. 11L, the breakthrough region 11091-1 includes an edge 11096 that is feathered, blended, and/or smoothed to reduce a visual difference between visual properties of regions of the user interface element 11086 that have not been changed and the breakthrough region 11091-1 of the user interface element 11086. In some embodiments, the edge 11096 and the edge 11090 are processed using different visual effects (e.g., feathered, blended, and/or smoothed), and/or different edges are processed using different visual effects. In some embodiments, the user interface element 11092 includes a close affordance that allows a selection input from the user 7002 to dismiss and/or cease display of the user interface element 11902. In some embodiments, the computer system 101 ceases to display the user interface element 11902 in response to detecting the attention 11029 of the user 7002 being directed away from the user interface element 11902, optionally for at least a threshold amount of time (e.g., 1 second, 2 seconds, 5 seconds, 10 seconds, or 30 seconds).

FIG. 11M illustrates an example transition from FIG. 11L. In response to detecting a rightward movement of the user 7002 (e.g., from a prior position 11100 of the user 7002, corresponding to the viewport illustrated in FIG. 11L, shown in a dotted outline in a top view 11096), the computer system 101 changes an opacity of the breakthrough region 11091-1 as the viewpoint of the user 7002 moves. For example, as illustrated in FIG. 11M, the edge 11096 and the edge 11090 are less opaque in FIG. 11M than the edge 11096 and the edge 11090 in FIG. 11L. In some embodiments, as the user 7002 moves away from the user interface element 11902, an opacity of the breakthrough region 11091-1 increases, decreasing the visibility of the user interface element 11902 from the viewpoint of the user 7002, and/or restoring the visibility of the user interface element 11096 that is displayed closer to the viewpoint of the user 7002.

FIG. 11N illustrates an application user interface 11104 that includes a user interface element 11106 (e.g., a three-dimensional user interface element) depicting the Earth, a user interface element 11110 (e.g., a three-dimensional user interface element) depicting a satellite, and a user interface element 11108 (e.g., a three-dimensional user interface element) depicting an astronaut. FIG. 11N also illustrates an application user interface 11112 of a messaging application. A top view 11114 shows the user interface element 11108 being displayed furthest away from the viewpoint of the user 7002, the application user interface being displayed behind the user interface element 11106, and the user interface element 11110 being displayed between the user interface element 11106 and the user interface element 11108 (e.g., along a depth direction from the viewpoint of the user 7002, or along a different direction from the viewpoint of the user 7002). FIG. 11N also illustrates the attention 11029 of the user 7002 being directed toward the user interface element 11110.

FIG. 11O illustrates an example transition from FIG. 11N. In response to detecting that the attention 11029 of the user 7002 (e.g., based on gaze of the user 7002 or a proxy for gaze) is directed toward the user interface element 11110, optionally in conjunction with detecting an air pinch gesture performed by the hand 7022, and in accordance with a determination that the user interface element 11110 is further away from the viewpoint of the user 7002 compared to the user interface element 11106, the computer system 101 displays additional portions of the user interface element 11110 to the user 7002 by changing one or more visual properties of the intervening portions of the user interface element 11106 (e.g., portions of the user interface 11106 that are between the user 7002 and the additional portions of the user interface element 11110). In accordance with a determination that a right portion of the user interface element 11110 is behind the user interface element 11106 from the viewpoint of the user 7002 (e.g., in contrast to the left portion of user interface element 11110 that is not obscured by the user interface element 11106), the computer system 101 changes one or more visual properties of the left portion of the user interface element 11106 to display a breakthrough region 11117-1 so that additional portions of the user interface element 11110 (e.g., the entirety of the user interface element 11110) is visible from the viewpoint of the user 7002. In some embodiments, the breakthrough region 11117-1 associated with the user interface element 11106 has a shape that corresponds to a shape of the portion of the user interface element 11110 that is behind the user interface element 11106. In some embodiments, the shape of the breakthrough region 11117-1 corresponds to a silhouette of the right portion of the user interface element 11110 that is behind the user interface element 11106, instead of a default shape, such as an oval or a polygonal shape, allowing more regions of the user interface element 11106 to remain visible to the user 7002. In some embodiments, the computer system 101 displays the breakthrough region 11117-1 by removing (e.g., clipping, masking, or another technique) portions of the user interface element 11106.

In some embodiments, the portions of the user interface element 11110 that are rendered visible to the user 7002 by displaying the breakthrough region 11117-1 includes one or more control elements associated with the user interface element 11110, such as a resize affordance or a movement affordance. In some embodiments, in response to detecting the attention 11029 of the user 7002 being directed toward an edge portion of the user interface element 11110, the computer system 101 displays a resize affordance 11118. In some embodiments, the computer system 101 displays the resize affordance 11118 independently of the attention 11029 of the user 7002.

In some embodiments, as illustrated in FIG. 11Q, the breakthrough regions 11119-1 and 11119-2 include an edge 11115 that is feathered, blended, and/or smoothed to reduce a visual difference between visual properties of regions of the user interface element 11066 that have not been changed and the breakthrough region 11119-1 of the user interface element 11066. In some embodiments, as illustrated in FIG. 11Q, the breakthrough region 11119-2 borders a lower left portion of the edge 11115 that is feathered, blended, and/or smoothed to reduce a visual difference between visual properties of regions of the user interface element 11110 that are themselves a part of the breakthrough region 11117-1 and other portions of the breakthrough region 11117-1 that are not changed to display the breakthrough region 11119-2 of the application user interface 11112. In some embodiments, the same visual effect (e.g., feathering, blending and/or smoothening) is applied to the edge 11115 (e.g., for portions of the edge 11090 bordering the breakthrough region 11119-1 and for portions of the edge bordering the breakthrough region 11119-2). In some embodiments, different visual effects (e.g., feathering, blending and/or smoothening) are applied to different portions of the edge 11115 (e.g., a first visual effect is applied to portions of the edge 11090 bordering the breakthrough region 11119-1 and a second visual effect different from the first visual effect is applied to portions of the edge bordering the breakthrough region 11119-2). In some embodiments, a developer of an application corresponding to the application user interface 11112 and/or the application user interface 11104 specifies the type of visual effects to apply to different breakthrough regions. In some embodiments, a first visual effect (e.g., blending, clipping, masking, or breaking through) is applied to a first type of content (e.g., two-dimensional application content, three-dimensional application content, interactive application content, non-interactive application content, content displayed in an immersive mode, and/or content displayed in a non-immersive mode) to display a first breakthrough region, and a second visual effect (e.g., the same as the first visual effect, or different from the first visual effect, such as blending, clipping, masking, or breaking through) is applied to a second type of content different from the first type of content (e.g., two-dimensional application content, three-dimensional application content, interactive application content, non-interactive application content, content displayed in an immersive mode, and/or content displayed in a non-immersive mode). In some embodiments, a user (e.g., the user 7002) is able to set the types of visual effects by configuring one or more system settings associated with a respective application user interface. In some embodiments, a developer of the application associated with a respective application user interface is able to set the types of visual effects by configuring one or more system settings associated with the respective application user interface. A top view 11124 shows that the application user interface 11112 remains behind both the user interface element 11106 and the user interface element 11110 when the breakthrough regions 11119-1 and 11119-2 are displayed to render additional portions of the application user interface 11112 visible from the viewpoint of the user 7002. FIG. 11Q illustrates the attention 11029 of the user 7002 being directed toward the user interface element 11064, optionally in conjunction with the hand of the user 7002 performing a selection input (e.g., an air pinch gesture or a different gesture).

FIG. 11P illustrates an example transition from FIG. 11O. In response to detecting that the attention 11029 of the user 7002 (e.g., based on gaze of the user 7002 or a proxy for gaze) is directed toward the resize affordance 11118 while the user 7002 performs an air pinch gesture that includes movement rightward toward the viewpoint of the user 7002, the computer system 101 enlarges a size of the user interface element 11110. In some embodiments, the user interface element 11110 is changed in size by an amount that is proportional to an amount of movement and/or speed of movement of the air pinch gesture. In accordance with a determination that the enlarged user interface element 11110 is behind additional portions of the user interface element 11106, such as a bottom portion of the user interface element 11106, from the viewpoint of the user 7002 (e.g., in contrast to the top and/or right portions of the user interface element 11106 that remains visible), the computer system 101 changes one or more visual properties of one or more additional portions of corresponding portions of the user interface element 11106 to display a breakthrough region 11117-2 affecting the bottom portion of the user interface element 11106 (e.g., an enlarged breakthrough portion that encompasses the breakthrough region 11117-1 and the breakthrough region 11117-2) so that the enlarged user interface element 11110 (e.g., the entirety of the enlarged user interface element 11110) is visible from the viewpoint of the user 7002. In some embodiments, the breakthrough region 11117-2 associated with the enlarged user interface element 11106 has a shape that corresponds to a shape of the portion of the user interface element 11110 that is behind the enlarged user interface element 11106. In some embodiments, the shape of the breakthrough region 11117-2 corresponds to a silhouette of the right portion of the enlarged user interface element 11110 that is behind the user interface element 11106. A top view 11120 shows that the enlarged user interface element 11110 is behind the left portion of the user interface element 11106. FIG. 11O also illustrates the attention 11029 of the user 7002 being directed toward the application user interface 11112 while the user 7002 performs an air pinch gesture.

FIG. 11Q illustrates an example transition from FIG. 11P. In response to detecting that the attention 11029 of the user 7002 (e.g., based on gaze of the user 7002 or a proxy for gaze) is directed toward the application user interface 11112 while the user 7002 performs an air pinch gesture, and in accordance with a determination that the application user interface 11112 is further away from the viewpoint of the user 7002 compared to the user interface element 11106 and the user interface element 11110, the computer system 101 displays additional portions of the application user interface 11112 to the user 7002 by changing one or more visual properties of the intervening portions of the user interface element 11106 and the user interface element 11110. In accordance with a determination that a left portion of the application user interface 11112 is behind the user interface element 11106 and the enlarged user interface element 11110 from the viewpoint of the user 7002, the computer system 101 changes one or more visual properties of the right portion of the user interface element 11106 to display a breakthrough region 11119-1, and the computer system also changes one or more visual properties of the right portion of the enlarged user interface element 11110 to display a breakthrough region 11119-2 so that additional portions of the application user interface 11112 (e.g., the entirety of the application user interface 11112) is visible from the viewpoint of the user 7002. In some embodiments, the portions of the application user interface 11112 that are rendered visible to the user 7002 by displaying the breakthrough region 111192-1 includes one or more application management control elements associated with the application user interface 11112, such as a movement affordance 11113, a close affordance and/or a resize affordance. In some embodiments, the breakthrough region 11119-1 associated with the user interface element 11106 has a shape that corresponds to a shape of the portion of the application user interface 11112 that is behind the user interface element 11106. In some embodiments, the computer system 101 displays the breakthrough regions 11119-1 and the 11119-2 while maintaining display of the breakthrough regions 11117-1 and 11117-2. As a result, in some embodiments, the breakthrough regions displayed within the application user interface 111104 are maintained while the computer system 101 renders application content from the application user interface 11112 visible by displaying additional breakthrough regions 11119-1 and 11119-2.

FIG. 11R illustrates an example transition from FIG. 11O. In response to detecting that the attention 11029 of the user 7002 (e.g., based on gaze of the user 7002 or a proxy for gaze) is directed toward the user interface element 11064, optionally in conjunction with the hand of the user 7002 performing a selection input, the computer system 101 at least partially reverses some changes made to the user interface element 11110. In some embodiments, in response to detecting that the attention 11029 of the user 7002 is directed away from the application user interface 11112 and/or the user interface element 11110, the computer system 101 decreases an opacity of the breakthrough regions 11119-1 and 11119-2, and/or an opacity of the breakthrough regions 11117-1 and 11117-2, respectively, so that the user interface element 11106 which is closer to the viewpoint of the user 7002, and to which the attention 11029 of the user 7002 is directed toward increases in visual prominence of the user interface element 11106 compared to both the user interface element 11110 and the application user interface 11112. In some embodiments, an opacity of the application user interface 11112 reduces (e.g., fades out, or reduces in visual prominence) as time elapses from the user's last interaction with the application user interface 11112. In some embodiments, the application user interface 11112 is moved to an updated location that does not overlap with the user interface element 11106, from the viewpoint of the user 7002. In some embodiments, as the application user interface 11112 reduces in opacity (e.g., gradually fades out), the breakthrough regions 11119-1 and 11119-2 also gradually decrease in opacity so that additional portions of the user interface element 11106 become more visible from the viewpoint of the user 7002, as illustrated in FIG. 11R. In some embodiments, the breakthrough regions 11119-1 and 11119-2 decreases in opacity over time and/or as the application user interface 11112 fades out. A top view 11126 shows that the enlarged user interface element 11110 remains behind the left portion of the user interface element 11106 as the enlarged user interface element 11110 becomes less opaque.

FIG. 11S illustrates the application user interface 11104 that includes the user interface element 11106, the user interface element 11110, and the user interface element 11108. A top view 11062 shows the user interface element 11108 being displayed furthest from the viewpoint of the user 7002, and the application content element 11110 being displayed between the user interface element 11106 and the user interface element 11108 (e.g., along a depth direction from the viewpoint of the user 7002, or along a different direction from the viewpoint of the user 7002). FIG. 11S also illustrates the attention 11029 of the user 7002 being directed toward a region in which the user interface element 11110 and the user interface element 11108 overlaps, optionally in conjunction with detecting an air pinch gesture performed by the hand 702.

FIG. 11T illustrates an example alternative transition from FIG. 11S that is different from the transition between FIGS. 11N and 11O. In response to detecting that the attention 11029 of the user 7002 (e.g., based on gaze of the user 7002 or a proxy for gaze) is directed toward a region in which the user interface element 11110 and the user interface element 11108 overlap, optionally in conjunction with detecting an air pinch gesture performed by the hand 7022, and in accordance with a determination that the user interface element 11108 is further away from the viewpoint of the user 7002 compared to the user interface element 11110, the computer system 101 displays additional portions of the user interface element 11108 to the user 7002 by changing one or more visual properties of the intervening portions of the user interface element 11106. In some embodiments, the user interface element that is furthest away from the viewpoint of the user 7002 has the highest priority, and is selected to be rendered visible to the user by the computer system 101 changing one of more visual properties of portions of intervening user interface elements (e.g., over and in lieu of portions of other user interface elements which are also occluded and/or obscured by other user interface elements relative to the viewpoint of the user 7002). In some embodiments, the priority of different user interface elements may be preconfigured by the developer, and/or configured by the user.

In some embodiments, as illustrated in FIG. 11T, in accordance with a determination that the user interface element 11108 is behind the user interface element 11110 from the viewpoint of the user 7002 and has a higher priority than the user interface element 11110, the computer system 101 changes one or more visual properties of the user interface element 11110 to display a breakthrough region 11129-1 so that portions of the user interface element 11108 (e.g., the entirety of the user interface element 11108) that would otherwise be obscured are visible from the viewpoint of the user 7002. In some embodiments, the breakthrough region 11129-1 associated with the user interface element 11110 has a shape that corresponds to a shape of the portion of the user interface element 11108 that is behind the user interface element 11110. A top view 11130 shows the user interface element 11108 remains positioned behind the user interface element 11110 while the breakthrough region 11129-1 renders the portion of the user interface element 11108 visible to the user 7002. Additional descriptions regarding FIGS. 11A-11T are provided below in reference to method 16000 described with respect to FIGS. 16A-16C.

FIGS. 17A-17M illustrate user interface elements associated with different types of contents of a volumetric application. FIG. 20 is flow diagram of an exemplary method 20000 for displaying user interface elements associated with different types of contents of a volumetric application. The user interfaces in FIGS. 17A-17M are used to illustrate the processes described below, including the processes in FIG. 20.

FIG. 17A illustrates a view of a three-dimensional environment (e.g., corresponding at least partially to the physical environment 7000 in FIG. 7A) that is visible to the user 7002 via HMD 7100a of the computer system 101. The three-dimensional environment includes an application user interface 17002 of a volumetric application that displays three-dimensional application content including one or more user interface elements having a non-zero length, non-zero width, and non-zero depth. In some embodiments, the one or more user interface elements having a non-zero length, non-zero width, and non-zero depth are displayed within a volume enclosed by an outline 17004, that is optionally not displayed. In some embodiments, the application user interface 17002 displays a building 17006, a building 17016, and a building 17086, amongst other buildings. An application management control 17010 (e.g., a move affordance) associated with the application user interface 17002 is optionally displayed (e.g., independently of attention 17014 of the user 7002, or in response to detecting that the attention 17014 of the user 7002 is directed toward a portion, such as a central portion, of the application user interface 17002). FIG. 17A illustrates a user interface element 17008 displayed above, and associated with, the building 17006. In some embodiments, the user interface element 17008 displays information associated with the building 17006 while (e.g., and/or if) the attention of the user 7002 is directed toward the building 17006. In some embodiments, as illustrated in FIG. 17A, the computer system 101 displays the user interface element 17008 above the building 17006 while the attention 17014 of the user 7002 is directed toward the building 17016 (e.g., a building other than the building 17006). A top view 17012 shows the user interface element 17008 being displayed at a distance greater than a threshold distance Dₜₕ (e.g., 40, 50, 60, 70, 80, 90, 100, 120 cm or another distance threshold) relative to a viewpoint of the user 7002. The user interface element 17008 is displayed in a right portion of the application user interface 17002, a first distance behind the movement affordance 17010. FIG. 17A also illustrates the attention 17014 of the user being directed toward the building 17016, optionally in conjunction with the hand 7022 of the user 7002 performing an air pinch gesture.

FIG. 17B illustrates an example transition from FIG. 17A. In response to detecting that the attention 17014 of the user 7002 (e.g., based on gaze of the user 7002 or a proxy for gaze) is directed toward the building 17016 optionally in conjunction with detecting an air pinch gesture performed by the hand 7022, the computer system 101 displays a user interface element 17018 above the building 17016 that displays information associated with the building 17016. A top view 17020 shows locations of the user interface element 17008 and the user interface element 17018 relative to the viewpoint of the user 7002. FIG. 17B illustrates the attention 17014 being directed toward a close affordance 17022 associated with the user interface element 17018.

FIG. 17C illustrates an example transition from FIG. 17B. In response to detecting that the attention 17014 of the user 7002 (e.g., based on gaze of the user 7002 or a proxy for gaze) is directed toward the close affordance 17022 associated with the user interface element 17018 (e.g., as shown in FIG. 17B), optionally in conjunction with detecting an air pinch gesture performed by the hand 7022, the computer system 101 ceases to display the user interface element 17018. In some embodiments, the computer system 101 ceases to display the user interface element 17018 in response to detecting that the attention 17014 of the user 7002 has moved away from the building 17016 (e.g., without the user 7002 having to provide a selection input via an air pinch gesture while attention 17014 of the user 7002 is directed toward the close affordance 17022 associated with the user interface element 17018). In some embodiments (e.g., after ceasing to display the user interface element 17018), the user interface element 17018 is redisplayed in response to detecting a selection input via an air pinch gesture while the attention 17014 of the user 7002 is directed toward the building 17016.

FIG. 17C illustrates the attention 17014 of the user 7002 being directed toward a selectable user interface element 17030 displayed on the user interface element 17008. For example, the selectable user interface element 17030 enables the computer system 101 to provide directions to the user 7002 for navigating to the building 17006 from a current location of the user 7002. In some embodiments, the user interface element 17008 is displayed at a location that spatially conflicts with one or more three-dimensional application content elements, such as a building 17005, and a building 17007, from the viewpoint of the user 7002 (e.g., coincides with, intersects with or is behind the building 17005 and or building 17007 from the viewpoint of the user 7002). In some embodiments, as described with reference to FIGS. 11A-11T, the computer system 100 changes, via the one or more display generation components, one or more visual properties of at least a portion (e.g., a portion 17024) of the building 17005 to increase visibility of a portion of the user interface element 17008 that would otherwise be obscured with respect to the viewpoint of user 7002. As a result, in FIG. 17C, additional portions of the user interface element 17008 (e.g., a bottom left portion, a majority of the user interface element 17008, or all of the user interface element 17008) are visible from the viewpoint of user 7002 even though building 17005 remains at a same position (e.g., at a same first depth closer to the viewpoint of the user 7002), and the user interface element 17008 remains at a second position (e.g., at a same second depth further from the viewpoint of the user 7002) in the three-dimensional environment. The computer system 101 changes one or more visual properties of the portion 17024, including one or more of: a degree of blurring, a level of brightness, a level of saturation, a level of visual intensity, a level of contrast, and/or a level of opacity to display a breakthrough region that allows the user interface element 17008 to be rendered visible with respect to the viewpoint of user 7002. In some embodiments, the computer system 101 changes one or more visual properties of a similar portion 17024 to resolve a spatial conflict between the user interface element 17008 and the building 17007 with respect to the viewpoint of user 7002 (e.g., in an analogous fashion as described above with reference to the portion 17024 and the building 17005).

FIG. 17D illustrates an example transition from FIG. 17C. In response to detecting that the attention 17014 of the user 7002 (e.g., based on gaze of the user 7002 or a proxy for gaze) is directed toward the selectable user interface element 17030, optionally in conjunction with detecting an air pinch gesture performed by the hand 7022, and in accordance with a determination that a user interface element 17032 is associated with three-dimensional application content within the volumetric application of the application user interface 17002, the computer system 101 displays the user interface element 17032 at a predefined location with respect to an application management control (e.g., at a predefined distance from and/or with a predefined spatial relationship to the application management control). For example, the application management control 17010 is a move affordance for moving the application user interface 17002 as a whole and the user interface element 17032 is displayed in a same plane (e.g., along the z-direction) with respect to a viewpoint of the user 7002. In some embodiments, the user interface element 17032 is an alert that provides time-sensitive information to the user 7002 regarding a current issue that arises from a user-initiated input or selection, such as the possibility of data being deleted, the use of location information or other personal information, an opportunity to confirm a purchase and/or another user-initiated action. In some embodiments, application content (e.g., three-dimensional application content and/or two-dimensional application content) within the volumetric application associated with the application user interface 17002 is visually deemphasized and/or rendered unavailable for user interaction while the user interface element 17032 is displayed (e.g., prior to the user 7002 dismissing and/or performing an operation, such as a selection operation, on the user interface element 17032) to help direct the user 7002 to the information displayed on the user interface element 17032. A top view 17034 shows the user interface element 17008 being displayed at an analogous position as in the top view 17028, and is optionally visually deemphasized. The user interface element 17032 is displayed at a predefined position with respect to the application management control 17010 at the threshold distance Tₜₕ (e.g., 40, 50, 60, 70, 80, 90, 100, 120 cm or another distance threshold) along the z-axis relative to the viewpoint of the user 7002. A side view 17036 shows the user interface element 17032 being displayed at a height (e.g., along the y-direction) that is based on a height of the viewpoint of the user 7002. For example, the computer system 101 displays the user interface element 17032 at a greater height (showed with a dotted outline) when the viewpoint of the user 7002 is higher (shown with a dotted outline at a position 7007-1). In contrast, the computer system 101 displays the user interface element 17032 at a lower height (showed with a solid outline) when the viewpoint of the user 7002 is lower (shown with a solid outline). The user interface element 17032 maintains an analogous spatial relationship with respect to the application management control 17010 (e.g., displayed at the same z-position) when the computer system 101 displays the user interface element 17032 at different heights. In some embodiments, the computer system 101 displays the user interface element 17032 at an orientation that faces the user 7002 (e.g., a two-dimensional surface of the user interface element 17032 is perpendicular to the viewpoint of the user 7002). In some embodiments, the computer system 101 displays the user interface element 17032 while maintaining a position of the application user interface 17002 within the three-dimensional environment. For example, the top view 17028 and the top view 17034 show that application user interface 17002 is maintained at the same position when the user interface element 17032 is displayed (e.g., displaying the user interface element 17032 does not result in the application user interface 17002 being pushed back).

FIG. 17E illustrates an example transition from FIG. 17D. In response to detecting that the viewpoint of the user 7002 has moved closer to the application user interface 17002 and the user interface element 17032, the computer system 101 updates (e.g., changes) a size of the user interface element 17032. A top view 17038 shows a previous position 7007-2 of the user 7002 with a dotted outline. In some embodiments, as illustrated in FIG. 17E, the computer system 101 maintains the threshold distance Tₜₕ between the user interface element 17032 and the viewpoint of the user 7002 by displaying the user interface element 17032 within the volumetric application associated with the application user interface 17002. In some embodiments, this ensures that the user interface element 17032 remains visible to the user 7002 as the viewpoint of the user 7002 changes within the three-dimensional environment 7000 (e.g., preventing issues associated with the user interface element 17032 being displayed behind, or otherwise out of view of, the user 7002, such as if the user 7002 moves past and/or through the user interface element 17032, while application contents of the application user interface 17002 are visually deemphasized and/or do not permit user interaction). In some embodiments, the user interface element 17032 spatially conflicts with one or more application content elements visible from the viewpoint of the user 7002 (e.g., coincides with, intersects with or is behind other application content from the viewpoint of the user 7002) when the computer system 101 displays the user interface element 17032 within the volumetric application associated with the application user interface 17002. In some embodiments, the computer system 100 changes, via the one or more display generation components, one or more visual properties of the application content (e.g., a portion 17039) to increase visibility of a portion of the user interface element 17032 that would otherwise be obscured with respect to the viewpoint of user 7002. As a result, additional portions of the user interface element 17032 (e.g., a bottom portion, a majority of the user interface element 17032, or all of the user interface element 17032) are visible from the viewpoint of user 7002 even though application content of the application user interface 17002 and the user interface element 17032 remain at the same positions in the three-dimensional environment. In some embodiments, a size of the user interface element 17032 increases as the user 7002 moves closer to the application user interface 17002 (e.g., for distances between the user interface element 17032 and the viewpoint of the user that are equal to or greater than Tₜₕ). In some embodiments, the size of the user interface element 17032 decreases as the user 7002 moves closer to the application user interface 17002 (e.g., for distances between the user interface element 17032 and the viewpoint of the user that are equal to or greater than Tₜₕ). In some embodiments, the computer system 101 displays the user interface element 17032 at a modified location with respect to the application management control 17010 in order to maintain the threshold distance Tₜₕ between the user interface element 17032 and the current viewpoint of the user 7002. In some embodiments, the computer system 101 maintains the visual deemphasis of the application content of the application user interface 17002 while the viewpoint of the user 7002 changes and/or is changing. The top view 17038 shows the user interface element 17032 being displayed at a location that maintains the threshold distance Tₜₕ with the viewpoint of the user 7002, while updating a size of the user interface element 17032 (e.g., the user interface element 17032 is enlarged when the viewpoint of the user 7002 moves closer to the application user interface 17002. The prior position and size of the user interface element 17032 (e.g., as illustrated in the top view 17034 of FIG. 17D) is shown in a dotted outline in the top view 17038.

FIG. 17F illustrates an example alternative transition from FIG. 17D. In response to detecting that the viewpoint of the user 7002 has moved further away from the application user interface 17002 and the user interface element 17032, the computer system 101 updates a size of the user interface element 17032. A top view 17064 shows a previous position 7007-3 of the user 7002 with a dotted outline. In some embodiments, as described in greater detail below with reference to in FIG. 17J, the computer system 101 increases a size of the user interface element 17032 as the user 7002 moves away from the application user interface 17002 to maintain legibility of the information displayed on the user interface element 17032. Analogous to the behavior illustrated in FIG. 17E, in some embodiments, the computer system 101 maintains the visual deemphasis of the application content of the application user interface 17002 while the viewpoint of the user 7002 changes. A top view 17064 shows the user interface element 17032 being displayed at an updated size (e.g., the user interface element 17032 is enlarged when the viewpoint of the user 7002 moves away from the application user interface 17002). In some embodiments, in contrast to the behavior illustrated in FIG. 17E, as the distance between current viewpoint of the user 7002 and the user interface element 17032 is greater than the threshold Tₜₕ, the user interface element 17032 is displayed at same size to the user even when the user 7002 is moving away from the application user interface 17002.

FIG. 17G illustrates an example transition based on a movement input (e.g., to move the application user interface 17002) provided by the user 7002. In response to detecting that the attention 17014 of the user 7002 (e.g., based on gaze of the user 7002 or a proxy for gaze) is directed toward the application management control 17010, optionally in conjunction with detecting an air pinch gesture performed by the hand 7022 followed by rightward movement of the hand 7022, the computer system 101 displays the application user interface 17002 at an updated location that is further from the viewpoint of the user 7002 and to the right of the prior location (shown in dotted outline in FIG. 17G). In some embodiments, the user interface element 17032 is displayed at an updated location of the three-dimensional environment based on the movement of the volumetric application corresponding to the application user interface 17002, to which the user interface element 17032 is associated. In FIG. 17G, the prior location of the user interface element 17032 is indicated by a rectangular outline 17040. In some embodiments, due to the amount of movement of the application user interface 17002 being less than a threshold amount of movement (e.g., 30 mm, 25 mm, 20 mm, 10 mm, or another threshold amount), an orientation of the user interface element 17032 does not change (e.g., a plane of the user interface element 17032 at the updated location is parallel to a plane of the user interface element 17032 at the prior location as indicated by the rectangular outline 17040). In some embodiments, due to the movement of the application user interface 17002 away from the viewpoint of the user 7002, the computer system 101 displays an enlarged user interface element 17032 at the updated location. A top view 17042 shows the user interface element 17032 being enlarged with respect to the user interface element 17032 displayed at the prior location as indicated by the outline 17040. The prior location of the application user interface 17002 is also indicated in dotted outline.

FIG. 17H illustrates an example transition based on a movement input provided by the user 7002 that is larger than (e.g., includes more movement and/or movement over a greater net distance than) the movement input illustrated in FIG. 17G (e.g., but along a same direction of motion). In response to detecting a movement input (e.g., the attention of the user 7002, based on gaze of the user 7002 or a proxy for gaze, is directed toward the application management control 17010, optionally in conjunction with detecting an air pinch gesture performed by the hand 7022 followed by rightward movement of the hand 7022), the computer system 101 displays the application user interface 17002 at an updated location that is further from the viewpoint of the user 7002 and to the right of the prior location (shown in dotted outline). In some embodiments, the user interface element 17032 is displayed at an updated location of the three-dimensional environment based on the movement of the volumetric application corresponding to the application user interface 17002, to which the user interface element 17032 is associated. In some embodiments, as illustrated in FIG. 17H, due to the amount of movement of the application user interface 17002 being greater than a threshold amount of movement (e.g., 30 mm, 25 mm, 20 mm, 10 mm, or another threshold amount), an orientation of the user interface element 17032 changes (e.g., a plane of the user interface element 17032 at the updated location is rotated to better align with the viewpoint of the user 7002, as shown FIG. 17H. In some embodiments, due to the movement of the application user interface 17002 away from the viewpoint of the user 7002, the computer system 101 displays an enlarged user interface element 17032 at the updated location. A top view 17044 shows the user interface element 17032 being enlarged with respect to the user interface element 17032 displayed at the prior location as indicated by the outline 17040.

FIG. 17I illustrates two example rotations of the user interface element 17032 based on a location of the application user interface 17002 relative to a current viewpoint of the user 7002. A side view 17046 shows that a large portion of the application user interface 17002 is displayed at a position that is below a reference horizontal plane 17052 located at an eye level of the user 7002. In some embodiments, the application user interface 17002 is displayed at a position that is below the reference horizontal plane 17052 in response to detecting an air pinch gesture that is followed by a movement input, analogous to those described with reference to FIGS. 17G and 17H, initiated by the user 7002. In some embodiments, the application user interface 17002 is displayed at a position that is below the reference horizontal plane 17052 in response to detecting a recentering input (e.g., a press input directed toward a hardware input device, such as the digital crown 703) while the head of the user 7002 is pointed downward. In some embodiments, the application user interface 17002 is displayed at a position that is below the reference horizontal plane 17052 in response to detecting a selection input to launch the volumetric application corresponding to the application user interface 17002 (e.g., a selection input directed toward an icon of the volumetric application on a home menu user interface) while the head of the user 7002 is pointed downward. In some embodiments, as illustrated in the side view 17046, instead of displaying the user interface element 17032 along (e.g., and/or parallel to) a vertical edge of the volumetric application (e.g., along the y-axis, as shown for example, in FIG. 17H), the computer system 101 rotates a plane of the user interface element 17032 by an angle 17058 (e.g., clockwise) about a pivot point 17050. In some embodiments, the pivot point 17050 is outside the plane of the user interface element 17032, for example, at the application management control 17010, or in front of the application user interrace 17002.

In some embodiments, even though orienting the plane of the user interface element 17032 to a plane 17056 would allow the viewpoint to be perpendicular to a direction along which the attention 17014 of the user 7002 is directed, the angle 17058 is a maximum rotation angle (e.g., 15°, 20°, 40°, 50°, or another angular threshold) and the computer system 101 forgoes rotating the plane of the user interface element 17032 by an angle that is larger than the angle 17058 (e.g., the plane of the user interface 17032 cannot be rotated beyond the maximum angle 17058).

A side view 17048 shows the that application user interface 17002 is displayed at a position that is above the reference horizontal plane 17052. In some embodiments, the application user interface 17002 is displayed at a position that is above the reference horizontal plane 17052 in response to the computer system 101 detecting an air pinch gesture that is followed by a movement input, analogous to those described with reference to FIGS. 17G and 17H, initiated by the user 7002, in response to detecting a recentering input (e.g., a press input directed toward a hardware input device, such as the digital crown 703) while the head of the user 7002 is pointed upward, or in response to detecting a selection input to launch the volumetric application corresponding to the application user interface 17002 (e.g., a selection input directed toward an icon of the volumetric application on a home menu user interface) while the head of the user 7002 is pointed upward. In some embodiments, as illustrated in the side view 17048, instead of displaying the user interface element 17032 along (e.g., and/or parallel to) the vertical edge of the volumetric application (e.g., along the y-axis, as shown for example, in FIG. 17G), the computer system 101 rotates the plane of the user interface element 17032 by an angle 17060 (e.g., counter-clockwise) about the pivot point 17050 (e.g., the same pivot point 17050 in the side view 17046). In some embodiments, even though orienting the plane of the user interface element 17032 to a plane 17055 would allow the viewpoint to be perpendicular to a direction along which the attention 17014 of the user 7002 is directed, the angle 17060 is a minimum rotation angle (e.g., −15°, −20°, −40°, −50°, or another angular threshold) and the computer system 101 forgoes rotating the plane of the user interface element 17032 by an angle that is smaller than the angle 17060 (e.g., the plane of the user interface 17032 cannot be rotated beyond the minimum angle 17060).

In some embodiments, the application user interface 17002 includes an application setting that enables the rotation of the plane of the user interface element 17032 based on an occurrence of a specified event (e.g., movement of the application user interface 17002, recentering of the application user interface 17002, launching of the application user interface 17002, and/or when application content of the application user interface 17002 rotates). In some embodiments, a developer who designs the application user interface 17002 selects the application setting to be used, and/or a user of the application user interface 17002 selects the application setting to be used.

FIG. 17J is analogous to FIG. 17C, and a top view 17066 is analogous to the top view 17028 of FIG. 17C. A side view 17072 shows a position of the user interface element 17008 within the volumetric application corresponding to the application user interrace 17002. FIG. 17J illustrates the attention 17014 of the user 7002 being directed toward a selectable user interface element 17030 displayed on the user interface element 17008.

FIG. 17K illustrates an example transition from FIG. 17J. In response to detecting that the attention 17014 of the user 7002 (e.g., based on gaze of the user 7002 or a proxy for gaze) is directed toward the selectable user interface element 17030, optionally in conjunction with detecting an air pinch gesture performed by the hand 7022, the computer system 101 displays the user interface element 17032. In some embodiments, and in accordance with a determination that a user interface element 17032 is associated with two-dimensional application content within the volumetric application of the application user interface 17002 (e.g., the two-dimensional user interface element 17008), the computer system 101 displays the user interface element 17032 at a predefined location with respect to the user interface element 17008. For example, the user interface element 17032 is displayed parallel to the user interface element 17008, spaced part along the z-direction (e.g., and optionally, centered relative to the user interface element 17008 in the x-direction and y-direction). In some embodiments (e.g., in contrast to when the user interface element 17032 is associated with three-dimensional content, as described above with reference to FIG. 17D), application content (e.g., three-dimensional application content and/or two-dimensional application content) within the volumetric application associated with the application user interface 17002 is not visually deemphasized and/or is available for user interaction while the user interface element 17032 is displayed (e.g., prior to the user 7002 dismissing and/or performing an operation, such as a selection operation, on the user interface element 17032). For example, the top view 17066 and a top view 17080 show that application user interface 17002 is maintained at the same position when the user interface element 17032 is displayed (e.g., displaying the user interface element 17032 does not result in the application user interface 17002 being pushed back). In some embodiments, as shown in the top view 17080 and a side view 17082, the computer system 101 displays the user interface element 17032 at a previous location of the user interface element 17008, which is pushed back and/or away from the viewpoint of the user 7002. In some embodiments, pushing back a display location of the user interface element 17008 (e.g., along the direction, and/or further from the viewpoint of the user 7002) enlarges a region where the user interface element 17008 spatially conflicts with one or more three-dimensional application content elements (e.g., coincides with, intersects with or is behind the building 17007 from the viewpoint of the user 7002, as a result of being pushed back). In some embodiments, the computer system 100 changes, via the one or more display generation components, one or more visual properties of additional portions of the building 17005 (e.g., a portion 17068) and the building 17007 (e.g., a portion 17070) to increase visibility of a portion of the user interface element 17008 that would otherwise be obscured with respect to the viewpoint of user 7002. As a result, additional portions of the user interface element 17008 (e.g., a bottom left portion, a majority of the user interface element 17008, or all of the user interface element 17008) are visible from the viewpoint of user 7002. The computer system 101 changes one or more visual properties of the portion 17068 and the portion 17070, including one or more of: a degree of blurring, a level of brightness, a level of saturation, a level of visual intensity, a level of contrast, and/or a level of opacity to display a breakthrough region that allows the user interface element 17008 to be rendered visible with respect to the viewpoint of user 7002.

FIG. 17L illustrates a view of a three-dimensional environment associated with an immersive application user interface that is visible to the user 7002 via HMD 7100a of the computer system 101. The three-dimensional environment includes an application user interface 17084 of a volumetric application that displays three-dimensional application content including one or more user interface elements having a non-zero length, non-zero width, and non-zero depth in an immersive mode (e.g., only application content associated with the application user interface 17084 is visible to the user 7002, and/or content associated with the physical environment 7000 in FIG. 7A is not displayed). In some embodiments, the application user interface 17084 displays a building 17092, a building 17093, and a building 17086, amongst other buildings. FIG. 17L illustrates a user interface element 17094 displayed above and associated with the building 17093. In some embodiments, the user interface element 17094 displays information associated with the building 17093, analogous to the user interface element 17008 that displays information associated with the building 17006 (FIG. 17A). In response to detecting that the attention 17014 of the user 7002 (e.g., based on gaze of the user 7002 or a proxy for gaze) is directed toward a selectable user interface element 17095 on the user interface element 17094, optionally in conjunction with detecting an air pinch gesture performed by the hand 7022, and in accordance with a determination that the application user interface 17084 is displayed in an immersive mode, the computer system 101 displays the user interface element 17032 at a predefined location with respect to the viewpoint of the user 7002 (e.g., in a central portion of the viewport of the user 7002, at a predefined location within the viewport of the user 7002, and/or with a predefined spatial relationship to the viewport of the user 7002). In some embodiments, application content (e.g., three-dimensional application content and/or two-dimensional application content) within the volumetric application associated with the application user interface 17084 is visually deemphasized and is not available for user interaction while the user interface element 17032 is displayed (e.g., prior to the user 7002 dismissing and/or performing an operation, such as a selection operation, on the user interface element 17032). In some embodiments, in contrast (e.g., FIG. 17J), application content (e.g., three-dimensional application content and/or two-dimensional application content) within the volumetric application associated with the application user interface 17002 are not visually deemphasized and are available for user interaction while the user interface element 17008 is displayed. A top view 17089 shows that the user interface element 17032 is displayed in front of the user 7002.

FIG. 17M illustrates an example transition from FIG. 17L. In response to detecting rightward movement of the user 7002 while the application user interface 17084 displayed in the immersive mode, the computer system 101 updates the viewport of the user 7002 to display a building 17090 and a building 17088, and displays the user interface element 17032 at an updated location within the immersive application user interface 17084 that remains viewpoint-locked within the viewport of the user 7002 (e.g., in the central portion of the viewport of the user 7002, at the same predefined location within the viewport of the user 7002, and/or with the same predefined spatial relationship to the viewport of the user 7002, as in FIG. 17L), analogous to the position of the user interface element 17032 illustrated in FIG. 17L. A top view 17192 shows that the user interface element 17032 is displayed in front of the user 7002, who has moved to a right portion of the immersive application user interface 17084.

Additional descriptions regarding FIGS. 17A-17M are provided below in reference to method 20000 described with respect to FIG. 20.

FIGS. 18A-18AA illustrate examples of displaying a user interface element with a size that is based on a distance from a viewpoint of the user and/or a distance from a respective portion of an application user interface. FIG. 21 is flow diagram of an exemplary method 21000 for displaying a user interface element with a size that is based on a distance from a viewpoint of the user and/or a distance from a respective portion of an application user interface. The user interfaces in FIGS. 18A-18AA are used to illustrate the processes described below, including the processes in FIG. 21.

FIG. 18A illustrates a view of a three-dimensional environment (e.g., corresponding at least partially to the physical environment 7000 in FIG. 7A) that is visible to the user 7002 via HMD 7100a of the computer system 101. The three-dimensional environment includes an application user interface 18002 of a volumetric application that displays three-dimensional application content including one or more user interface elements having a non-zero length, non-zero width, and non-zero depth. In some embodiments, the one or more user interface elements having a non-zero length, non-zero width, and non-zero depth are displayed within a volume enclosed by an outline 18014, that is optionally not displayed. In some embodiments, the application user interface 18002 includes a building 18004, a building 18006, a building 18008, and a building 18009, amongst other buildings. An application management control 18016 (e.g., a move affordance) associated with the application user interface 18002 is optionally displayed (e.g., independently of attention 17014 of the user 7002, or in response to detecting that attention 18010 of the user 7002 is directed toward a portion, such as a central portion, of the application user interface 18002). FIG. 18A also illustrates attention 18010 of the user 7002 being directed toward the building 18004. A top view 18012 shows the attention 18010 of the user 7002 being directed toward the building 18004.

FIG. 18B illustrates an example transition from FIG. 18A. In response to detecting that the attention 18010 of the user 7002 (e.g., based on gaze of the user 7002 or a proxy for gaze) is directed toward the building 18004, optionally in conjunction with detecting an air pinch gesture performed by the hand 7022, the computer system 101 displays a user interface element 18018 at a distance 18011 away from the viewpoint of the user 7002, and at a first size (e.g., having a width 18017) above the building 18004. In some embodiments, the user interface element 18018 displays information associated with the building 18004 (e.g., while and/or as long as the attention 18010 of the user 7002 is directed toward the building 18004). In some embodiments, the user interface element 18018 is displayed at a location that spatially conflicts with one or more three-dimensional application content elements, such as the building 18009 from the viewpoint of the user 7002 (e.g., the user interface element 18018 coincides with, intersects with or is behind the building 18009 from the viewpoint of the user 7002, as shown in a top view 18020). In some embodiments, as described with reference to FIGS. 11A-11T, the computer system 101 changes, via the one or more display generation components, one or more visual properties of at least a portion of the building 18009 (e.g., a portion 18015) to increase visibility of a portion of the user interface element 18018 that would otherwise be obscured with respect to the viewpoint of the user 7002. As a result, portions of the user interface element 18018 (e.g., a bottom right portion, a majority of the user interface element 18018, or all of the user interface element 18018) that would otherwise be obscured are visible from the viewpoint of the user 7002 even though building 18009 remains at a same position (e.g., at a same first depth closer to the viewpoint of the user 7002), and the user interface element 18018 remains at a second position (e.g., at a same second depth further from the viewpoint of the user 7002) in the three-dimensional environment. The computer system 101 changes one or more visual properties of the portion 18015, including one or more of: a degree of blurring, a level of brightness, a level of saturation, a level of visual intensity, a level of contrast, and/or a level of opacity to display a breakthrough region that allows the user interface element 18018 to be rendered visible with respect to the viewpoint of user 7002. FIG. 18B also illustrates the attention 18010 of the user 7002 being directed toward a selectable option 18019 associated with the user interface element 18018. In some embodiments, the selectable option 18019 provides more information about a kiosk in the building 18004 that sells snacks. The top view 18020 shows the user interface element 18018 displayed at the distance 18011 relative to the viewpoint of the user 7002.

FIG. 18C illustrates an example transition from FIG. 18B. In response to detecting that the attention 18010 of the user 7002 (e.g., based on gaze of the user 7002 or a proxy for gaze) is directed toward the selectable option 18019 associated with the user interface element 18018 (e.g., as shown in FIG. 18B), optionally in conjunction with detecting an air pinch gesture performed by the hand 7022, the computer system 101 displays a user interface element 18022 at a distance 18021 away from the viewpoint of the user 7002 at a size having a second width 18023, in front of the user interface element 18018 (e.g., from the viewpoint of the user 7002), above the building 18004. In some embodiments, the user interface element 18022 is associated with the two-dimension user interface element 18018, and provides selectable options that are associated with the user interface element 18018. For example, the selectable options enable the computer system 101 to provide directions to the user 7002, to call the kiosk, to provide a user interface for leaving a review for the kiosk, and to display a list of display a menu of items offered by the kiosk. In some embodiments, the user interface element 18022 includes a close affordance 18025 that allows a selection input from the user 7002 to dismiss and/or cease display of the user interface element 18022.

In some embodiments, as illustrated in FIG. 18C, the user interface element 18022 is displayed in front of, and optionally parallel to, the user interface element 18018, and the user interface element 18002 is displayed at a location that also spatially conflicts with one or more three-dimensional application content elements, such as the building 18009, from the viewpoint of the user 7002 (e.g., the user interface element 18022 coincides with, intersects with, and/or is behind the building 18009 from the viewpoint of the user 7002). In some embodiments, as described with reference to FIGS. 11A-11T, the computer system 101 changes, via the one or more display generation components, one or more visual properties of at least a portion of the building 18009 (e.g., a portion 18015) to increase visibility of a portion of the user interface element 18022 that would otherwise be obscured with respect to the viewpoint of the user 7002. As a result, portions of the user interface element 18022 (e.g., a bottom right portion, a majority of the user interface element 18022, or all of the user interface element 18022) that would otherwise be obscured are visible from the viewpoint of the user 7002 even though building 18009 remains at a same position (e.g., at a same first depth closer to the viewpoint of the user 7002), and the user interface element 18022 remains at a third position (e.g., at a same third depth further from the viewpoint of the user 7002, such as the distance 18021) in the three-dimensional environment. The computer system 101 changes one or more visual properties of the portion 18027, including one or more of: a degree of blurring, a level of brightness, a level of saturation, a level of visual intensity, a level of contrast, and/or a level of opacity to display a breakthrough region that allows the user interface element 18022 to be rendered visible with respect to the viewpoint of user 7002. A top view 18024 shows the user interface element 18018 displayed at the distance 18011 relative to the viewpoint of the user 7002 and the user interface element 18022 displayed parallel to the user interface element 18018 at the distance 18021 (e.g., which is less than the distance 18011) relative to the viewpoint of the user 7002.

FIG. 18D illustrates a view of a three-dimensional environment that is visible to the user 7002 via HMD 7100a of the computer system 101 when the user 7002 is further away from the application user interface 18002 compared to the view illustrated in FIG. 18A. FIG. 18D also illustrates the attention 18010 of the user 7002 being directed toward the building 18004. A top view 18026 shows a prior position of the user 7002 in dotted outline (e.g., at the position shown in FIG. 18A) and the attention 18010 of the user 7002 being directed toward the building 18004 while the user 7002 is positioned further away from the application user interface 18002.

FIG. 18E illustrates an example transition from FIG. 18D. In response to detecting that the attention 18010 of the user 7002 (e.g., based on gaze of the user 7002 or a proxy for gaze) is directed toward the building 18004, optionally in conjunction with detecting an air pinch gesture performed by the hand 7022, the computer system 101 displays a user interface element 18018 at a distance 18028 away from the viewpoint of the user 7002 at a size having a width 18030 above the building 18004. In some embodiments, the user interface element 18018 is displayed at a location that spatially conflicts with one or more three-dimensional application content elements, such as the building 18009, from the viewpoint of the user 7002 (e.g., the user interface element 18018 coincides with, intersects with or is behind the building 18009 from the viewpoint of the user 7002, as shown in a top view 18026). In some embodiments, as described with reference to FIGS. 11A-11T, the computer system 101 changes, via the one or more display generation components, one or more visual properties of at least a portion of building 18009 (e.g., a portion 18032) to increase visibility of a portion of the user interface element 18018 that would otherwise be obscured with respect to the viewpoint of the user 7002. As a result, portions of the user interface element 18018 (e.g., a bottom right portion, a majority of the user interface element 18018, or all of the user interface element 18018) that would otherwise be obscured are visible from the viewpoint of the user 7002, even though the building 18009 remains at a same position (e.g., at a same depth closer to the viewpoint of the user 7002), and the user interface element 18018 remains at a second position (e.g., at a same depth further from the viewpoint of the user 7002) in the three-dimensional environment. The computer system 101 changes one or more visual properties of the portion 18032, including one or more of: a degree of blurring, a level of brightness, a level of saturation, a level of visual intensity, a level of contrast, and/or a level of opacity to display a breakthrough region that allows the user interface element 18018 to be rendered visible with respect to the viewpoint of user 7002. FIG. 18E also illustrates the attention 18010 being directed toward a selectable option 18019 associated with the user interface element 18018. The top view 18026 shows the user interface element 18018 displayed at the distance 18028 relative to the viewpoint of the user 7002.

FIG. 18F illustrates an example transition from FIG. 18E. In response to detecting that the attention 18010 of the user 7002 (e.g., based on gaze of the user 7002 or a proxy for gaze) is directed toward the selectable option 18019 associated with the user interface element 18018 (e.g., as shown in FIG. 18E), optionally in conjunction with detecting an air pinch gesture performed by the hand 7022, the computer system 101 displays a user interface element 18022 at a distance 18036 away from the viewpoint of the user 7002 at a size having a width 18123 that is different from the width 18023 (FIG. 18C), in front of the user interface element 18018 (e.g., relative to the viewpoint of the user 7002), above the building 18004. In some embodiments, as illustrated in FIG. 18F, the user interface element 18022 is displayed at a location that also spatially conflicts with one or more three-dimensional application content elements, such as the building 18009 from the viewpoint of the user 7002 (e.g., the user interface element 18022 coincides with, intersects with or is behind the building 18009 from the viewpoint of the user 7002). In some embodiments, the computer system 101 changes, via the one or more display generation components, one or more visual properties of at least a portion of building 18009 (e.g., a portion 18040) to increase visibility of a portion of the user interface element 18022 that would otherwise be obscured with respect to the viewpoint of the user 7002. As a result, portions of the user interface element 18022 (e.g., a bottom right portion, a majority of the user interface element 18022, or all of the user interface element 18022) that would otherwise be obscured are visible from the viewpoint of the user 7002 even though building 18009 remains at a same position (e.g., at a same depth closer to the viewpoint of the user 7002), and the user interface element 18022 remains at a position (e.g., at a same depth further from the viewpoint of the user 7002, such as the distance 18036) in the three-dimensional environment. The computer system 101 changes one or more visual properties of the portion 18040, including one or more of: a degree of blurring, a level of brightness, a level of saturation, a level of visual intensity, a level of contrast, and/or a level of opacity to display a breakthrough region that allows the user interface element 18022 to be rendered visible with respect to the viewpoint of user 7002. A top view 18034 shows the user interface element 18018 displayed at the distance 18028 relative to the viewpoint of the user 7002 and the user interface element 18022 displayed parallel to the user interface element 18018 at the distance 18036 relative to the viewpoint of the user 7002.

FIG. 18G illustrates an example transition from FIG. 18F. In response to detecting that the attention 18010 of the user 7002 (e.g., based on gaze of the user 7002 or a proxy for gaze) is directed toward the building 18006 (e.g., as shown in FIG. 18F), optionally in conjunction with detecting an air pinch gesture performed by the hand 7022, the computer system 101 displays a user interface element 18042 at a distance 18044 away from the viewpoint of the user 7002 at a size having a width 18046 above the building 18006. FIG. 18G also illustrates the attention 18010 of the user 7002 being directed toward a selectable option 18048 associated with the user interface element 18042. A top view 18050 shows the user interface element 18042 displayed at the distance 18044 relative to the viewpoint of the user 7002.

FIG. 18H illustrates an example transition from FIG. 18G. In response to detecting that the attention 18010 of the user 7002 (e.g., based on gaze of the user 7002 or a proxy for gaze) is directed toward the selectable option 18048 associated with the user interface element 18042 (e.g., as shown in FIG. 18G), optionally in conjunction with detecting an air pinch gesture performed by the hand 7022, the computer system 101 displays a user interface element 18052 at a distance 18054 away from the viewpoint of the user 7002, in front of the user interface element 18042 (e.g., relative to the viewpoint of the user 7002), above the building 18006. A top view 18056 shows the user interface element 18042 displayed at the distance 18044 relative to the viewpoint of the user 7002 and the user interface element 18052 displayed parallel to the user interface element 18042 at the distance 18054 relative to the viewpoint of the user 7002.

FIG. 18I illustrates a view of a three-dimensional environment that is visible to the user 7002 via HMD 7100a of the computer system 101 when the user 7002 is closer to the application user interface 18002, as compared to the view illustrated in FIG. 18D (e.g., and optionally at the same distance from the application user interface 18002 as in FIG. 18A). FIG. 18I also illustrates the attention 18010 of the user 7002 being directed toward the building 18004. A top view 18058 shows the attention 18010 of the user 7002 being directed toward the building 18006 while the user 7002 is positioned closer to the application user interface 18002, as compared to the top view 18026 shown in FIG. 18D.

FIG. 18J illustrates an example transition from FIG. 18I. In response to detecting that the attention 18010 of the user 7002 (e.g., based on gaze of the user 7002 or a proxy for gaze) is directed toward the building 18006 (e.g., as shown in FIG. 18I), optionally in conjunction with detecting an air pinch gesture performed by the hand 7022, the computer system 101 displays the user interface element 18042 (e.g., the same user interface element 18042 described above with reference to FIG. 18G) at a distance 18062 away from the viewpoint of the user 7002 at a size having a width 18064 above the building 18006. FIG. 18J also illustrates the attention 18010 of the user 7002 being directed toward the selectable option 18048 associated with the user interface element 18042. A top view 18060 shows the user interface element 18042 displayed at the distance 18062 (e.g., which is optionally the same as the distance 18011) relative to the viewpoint of the user 7002. FIG. 18K also illustrates, in dotted outlines, the sizes and positions of the user interface element 18018 and the user interface element 18022, illustrated in FIG. 18C. In some embodiments, due to the difference in the distance 18021 (FIG. 18C) between the user interface element 18022 and the viewpoint of the user 7002, and the distance 18062 (FIG. 18K) between the user interface element 18052 and the viewpoint of the user 7002, a size of the user interface 18022 (e.g., having the width 18023 as shown in FIG. 18C) is different from a size of the user interface element 18052 (having a width 18067 as shown in FIG. 18K). Similarly, in some embodiments, due to the difference in the distance 18011(FIG. 18C) between the user interface element 18018 and the viewpoint of the user 7002, and the distance 18063 (FIG. 18K) between the user interface element 18042 and the viewpoint of the user 7002, a size of the user interface 18018 is different from a size of the user interface element 18042.

FIG. 18K illustrates an example transition from FIG. 18J. In response to detecting that the attention 18010 of the user 7002 (e.g., based on gaze of the user 7002 or a proxy for gaze) is directed toward the selectable option 18048 associated with the user interface element 18042 (e.g., as shown in FIG. 18J), optionally in conjunction with detecting an air pinch gesture performed by the hand 7022, the computer system 101 displays the user interface element 18052 (e.g., the same user interface element 18052 described above with reference to FIG. 18H) at the seventh distance 18062 away from the viewpoint of the user 7002, in front of the user interface element 18042 (e.g., relative to the viewpoint of the user 7002), which is pushed backwards to an eighth distance 18063 from the viewpoint of the user 7002. A top view 18065 shows the user interface element 18042 displayed at the eighth distance 18063 relative to the viewpoint of the user 7002 and the user interface element 18052 displayed parallel to the user interface element 18042, at the distance 18062 relative to the viewpoint of the user 7002.

FIG. 18L illustrates variations in size of the user interface element 18042 based on a distance, in the three-dimensional environment, between the application user interface 18002 (e.g., associated with and/or corresponding to the user interface element 18042) and the viewpoint of the user 7002. A top view 18070-1 is analogous to the top view 18060 illustrated in FIG. 18J. The application user interface 18002 is further away from the viewpoint of the user 7002 in a top view 18070-2 than in the top view 18070-1 (e.g., as represented by the dashed outline indicating, for comparison, a position 18072 of the application user interface 18002 in the top view 18070-1). In the top view 18070-2, the computer system 101 has enlarged the user interface element 18042 (e.g., as compared to the size of the user interface element 18042 in the top view 18070-1) to maintain legibility of the information displayed thereon. The shaded portion of the user interface element 18042 in the top view 18070-2 corresponds to, and indicates for comparison, the smaller size of the user interface element 18042 shown in the top view 18070-1.

In a top view 18070-3, the application user interface 18002 is further away from the viewpoint of the user 7002 than in the top view 18070-2. Due to the first user interface element 18042 reaching a maximum size (e.g., in the top view 18070-2), even though the application user interface 18002 is further from the viewpoint of the user 7002 in the top view 18070-3 than in the top view 18070-2, the user interface element 18042 remains at the same size in the top view 18070-3 as in the top view 18070-2 (e.g., the size of the user interface element 18042 cannot be increased beyond the maximum size shown in the top view 18070-2).

In a top view 18070-4, the application user interface 18002 is further away from the viewpoint of the user 7002 than in the top view 18070-3 (e.g., as represented by the dashed outline indicating, for comparison, a position 18076 of the application user interface 18002 in the top view 18070-2). As shown in the top view 18070-4, the computer system 101 ceases to display the user interface element 18042 (e.g., in accordance with a determination that a distance between the application user interface 18002 and the viewpoint of the user 7002 in the top view 18070-4 is greater than a display distance threshold).

In a top view 18070-5, the application user interface 18002 is closer to the viewpoint of the user 7002 than in the top view 18070-1. In the top view 18070-5, the computer system 101 has decreased the size of the user interface element 18042 with respect to the size of the user interface element 18042 in top view 18070-1 (e.g., denoted by a dotted outline 18082). In a top view 18070-6, the application user interface 18002 is moved even closer to the viewpoint of the user 7002 than in the top view 18070-5. Due to the user interface element 18042 reaching a minimum size in the top view 18070-5, even though the application user interface 18002 is closer to the viewpoint of the user 7002 in the top view 18070-6 than in the top view 18070-5, the user interface element 18042 remains at the same size in the top view 18070-6 as in the top view 18070-5 (e.g., the size of the user interface element 18042 cannot be decreased beyond the minimum size shown in the top view 18070-5).

FIG. 18M illustrates display of two user interface elements in the application user interface 18002, in accordance with some embodiments. In FIG. 18M, the computer system 101 displays the user interface element 18042 at a distance 18090 away from the viewpoint of the user 7002 at a size having a width 18094 above the building 18006, and a user interface element 18086 at a distance 18102 away from the viewpoint of the user 7002 at a size having a width 18096, larger than the width 18094, above the building 18008. In some embodiments, the user interface element 18086 displays information associated with the building 18008. In some embodiments, the user interface element 18086 includes information associated with the building 18008, and is optionally displayed even when the attention 18010 of the user 7002 is not directed toward the building 18008.

In some embodiments, as illustrated in FIG. 18M, the computer system 101 displays the user interface element 18042 at a distance 18091 away from the movement affordance 18016 at the size having the width 18094 above the building 18006, and the user interface element 18086 at a distance 18093 away from the movement affordance 18016 at the size having the width 18096 above the building 18008. In some embodiments, as illustrated in FIG. 18M, a displayed size of a user interface element increases with a distance between the user interface element and the viewpoint of the user 7002 and/or a distance between the user interface element and the movement affordance 18016. In some embodiments, a displayed size of a user interface element decreases with a distance between the user interface element and the viewpoint of the user 7002 and/or a distance between the user interface element and the movement affordance 18016. A top view 18088 shows the user interface element 18042 displayed at the distance 18090 relative to the viewpoint of the user 7002 and the user interface element 18086 displayed at the distance 18092 relative to the viewpoint of the user 7002. The top view 18088 shows the user interface element 18042 displayed at the distance 18091 relative to the movement affordance 18016 and the user interface element 18086 displayed at the distance 18093 relative to the movement affordance 18016.

FIG. 18N illustrates an example transition from FIG. 18M. In response to detecting a movement of the viewpoint of the user 7002 rightward within the three-dimensional environment (e.g., from an original viewpoint to a new viewpoint), the computer system 101 updates an orientation of user interface element 18042 and an orientation of first user interface 18086, based on the new viewpoint of the user 7002 (e.g., normal to a vector extending from the new viewpoint of the user through a reference point in the user interface element, such as a centroid, and/or rotated toward the viewpoint of the user). In some embodiments, as illustrated in FIG. 18N, a position (e.g., and/or orientation) of the movement affordance 18016 is not updated in conjunction with the updating of the orientation of the user interface element 18042 and an orientation of user interface element 18086.

In some embodiments, as illustrated in FIG. 18N, in response to detecting a movement of the viewpoint of the user 7002 rightward within the three-dimensional environment (e.g., closer to the building 18008, and/or away from the movement affordance 18016), the computer system 101 displays the user interface element 18042 at a distance 18100 away from the viewpoint of the user 7002 at a size having a width 18104 above the building 18006, and the user interface element 18086 at a distance 18102 away from the viewpoint of the user 7002 at a size having a width 18106 above the building 18008. In some embodiments, the width 18104 is determined based on a distance 18101 between the user interface element 18042 and the movement affordance 18016, and displayed at the distance 18100 from the viewpoint of the user 7002. In some embodiments, the width 18106 is determined based on a distance 18103 between the user interface element 18086 and the movement affordance 18016, and displayed at the distance 18102 from the viewpoint of the user 7002. In some embodiments, the distance 18103 accounts for horizontal shifts between the user interface element 18086 and the movement affordance 18016. In some embodiments, the distance 18103 is measured between the closest point on the user interface element (e.g., to the viewpoint of the user) and the movement affordance. In some embodiments, the distance 18103 is measured between a center point on the user interface element and the movement affordance. As a result, even though the distance 18102 is smaller than the distance 18101 (e.g., the user interface element 18086 is closer to the viewpoint of the user 7002 than the user interface element 18042), the size of the user interface element 18086 is larger than the size of the user interface element 18042 (e.g., because the user interface element 18086 is further from the movement affordance 18016 than the user interface element 18042).

In some scenarios, instead of the viewpoint of the user 7002 changing from that the viewpoint illustrated in FIG. 18M to the viewpoint illustrated in FIG. 18N, the user 7002 directly invokes the display of the user interface element 18042 (e.g., by performing a selection option while the attention 18010 of the user 7002 is directed toward the building 18006) and the user interface element 18086 (e.g., by performing a selection option while the attention 18010 of the user 7002 is directed toward the building 18009) from the viewpoint illustrated in FIG. 18N.

FIG. 18O illustrates an example alternative transition from FIG. 18M. In response to detecting that the viewpoint of the user 7002 (e.g., based on gaze of the user 7002 or a proxy for gaze) has moved rightward within the three-dimensional environment (e.g., as shown in FIG. 18M), the computer system 101 updates the orientation of user interface element 18042 and the orientation of first user interface 18086 based on the new viewpoint of the user 7002. In some embodiments, analogous to the alternative transition illustrated in FIG. 18N, the position (e.g., and/or orientation) of the movement affordance 18016 is not updated in conjunction with the updating of the orientation of the user interface element 18042 and an orientation of user interface element 18086.

In FIG. 18O, in response to detecting a movement of the viewpoint of the user 7002 rightward within the three-dimensional environment (e.g., closer to the building 18008, and/or away from the movement affordance 18016), the computer system 101 displays the user interface element 18042 at the distance 18100 away from the viewpoint of the user 7002 at a size having a width 18110 above the building 18006, and the user interface element 18086 at the distance 18102 away from the viewpoint of the user 7002 at a size having a width 18112 above the building 18008. In some embodiments, in contrast to the transition illustrated in FIG. 18N, in FIG. 18O, the width 18110 is determined based (e.g., solely based) on the distance 18100 from the viewpoint of the user 7002 (e.g., and not on the distance of the user interface element 18042 from the movement affordance 18016). In some embodiments, in contrast to the transition illustrated in FIG. 18N, the width 18110 is determined based both on the distance 18100 from the viewpoint of the user 7002 and the distance 18101 from the movement affordance 18016 (e.g., instead of solely based on the distance 18101 from the movement affordance 18016). In some embodiments, the width 18110 is determined based on a weighted sum (e.g., equally weighted, or unequally weighted) of the distance 18100 from the viewpoint of the user 7002 and the distance 18101 from the movement affordance 18016.

Similarly, in some embodiments, the width 18112 is determined based (e.g., solely based) on the distance 18102 from the viewpoint of the user 7002. In some embodiments, in contrast to the transition illustrated in FIG. 18N, the width 18112 is determined based both on the distance 18102 from the viewpoint of the user 7002 and the distance 18103 from the movement affordance 18016. In some embodiments, the width 18112 is determined based on a weighted sum (e.g., equally weighted, or unequally weighted) of the distance 18102 from the viewpoint of the user 7002 and the distance 18103 from the movement affordance 18016 (e.g., instead of solely based on the distance 18103 from the movement affordance 18016). In some embodiments, a developer who designs the application user interface 18002 selects whether the displayed size of the user interface element is determined based on a distance between the user interface element and the movement affordance 18016 or based on a distance between the user interface element and the viewpoint of the user 7002. In some embodiments, the width 18110 and the width 18112 are determined using the same basis (e.g., a distance from a viewpoint of the user, a distance from a portion of the application user interface, such as the movement affordance 18016, or a combination of both the distance from the viewpoint of the user and the distance from a portion of the application user interface). For example, as illustrated in FIG. 18O, in contrast to FIG. 18N, the user interface element 18086, which is closer to the viewpoint of the user 7002, has a smaller width 18112 than the width 18110 associated with the user interface element 18042, which is further from the viewpoint of the user 7002. In FIG. 18N, the user interface element 18086 has a larger width 18106 than the width 18104 associated with the user interface element 18042, due to the user interface element 18086 being further away from the movement affordance 180816, even though the user interface element 18086 is closer to the viewpoint of the user 7002.

In some scenarios, instead of changing the viewpoint of the user 7002 from the viewpoint illustrated in FIG. 18M to the viewpoint illustrated in FIG. 18O, the user 7002 directly invokes the display of the user interface element 18042 (e.g., by performing a selection option while the attention 18010 of the user 7002 is directed toward the building 18006) and the user interface element 18086 (e.g., by performing a selection option while the attention 18010 of the user 7002 is directed toward the building 18009) from the viewpoint illustrated in FIG. 18O. A top view 18108 shows the user interface element 18042 displayed at the distance 18100 relative to the viewpoint of the user 7002 and the user interface element 18086 displayed at the distance 18102 relative to the viewpoint of the user 7002. The top view 18108 also shows the user interface element 18042 displayed at the distance 18101 relative to the movement affordance 18016 and the user interface element 18086 displayed at the distance 18103 relative to the movement affordance 18016.

FIG. 18P illustrates an example display of four user interface elements in the application user interface 18002, in accordance with some embodiments. In some embodiments, as illustrated in FIG. 18P, the computer system 101 displays a user interface element 18118 above a building 18116, a user interface element 18120 above the building 18006, a user interface element 18122 above a building 18008, and a user interface element 18126 above a building 18124. In some embodiments, the user interface elements 18118, 18120, 18122, and 18126 are billboards that include information associated with the building 18116, the building 18006, the building 18008, and the building 18124, respectively. In some embodiments, the user interface elements 18118, 18120, 18122, and 18126 include information associated with the building 18116, the building 18006, the building 18008, and the building 18124, even when the attention 18010 of the user 7002 is not directed toward those buildings (e.g., one or more of those buildings). In some embodiments, as illustrated in a top view 18114 of FIG. 18P, the computer system 101 displays the application user interface 18002 at a distance 18113 away from the viewpoint of the user 7002.

FIG. 18Q illustrates an example transition from FIG. 18P. In response to detecting that the user 7002 has moved further away from the application user interface 18002 (e.g., as compared to the distance of the user 7002 from the application user interface 18002 in FIG. 18P), and that a distance between the application user interface 18002 and the user 7002 is larger than a threshold distance Hₜₕ, the computer system 101 ceases to display the user interface elements 18118, 18120, 18122, and 18126. A top view 18128 shows a prior position 18130 of the user 7002 in dotted outline (e.g., at the position shown in FIG. 18P, at the distance 18113 away from the application user interface 18002), and a current position of the user 7002 at a distance of 18115 away from the application user interface 18002. FIG. 18Q also illustrates the attention 18010 being directed toward the movement affordance 18016 while the user 7002 performs an air pinch gesture that includes movement toward the viewpoint of the user 7002.

FIG. 18R illustrates an example transition from FIG. 18Q. In response to detecting that the attention 18010 is directed toward the movement affordance 18016 while detecting an air pinch gesture that includes movement toward the viewpoint of the user 7002 (e.g., as shown in FIG. 18Q), the computer system 101 displays the application user interface 18002 at a distance 18117 that is closer to the viewpoint of the user 7002 (e.g., as compared to the distance 18115 from the viewpoint of the user 7002 in FIG. 18Q), which optionally includes displaying an animation that shows intermediate positions of the application user interface 18002 (e.g., moving from a prior position 18134 of the application user interface 18002 in dotted outline, to a position that is a distance 18117 away from the user 7002) during the movement of the air pinch gesture. In accordance with a determination that, while the application user interface 18002 is displayed at the distance 18117 from the viewpoint of the user 7002, at least some user interface elements (e.g., the user interface element 18120, and the user interface element 18126) would be displayed at distances that are less than the threshold distance Hₜₕ and in accordance with a determination that at least some user interface elements (e.g., the user interface element 18118, and the user interface element 18122) would be displayed at distances that are greater than the threshold distance Dₜₕ, the computer system 101 displays (e.g., redisplays) the user interface element 18120, and the user interface element 18126 at distances that are less than the threshold distance Dₜₕ, and the computer system 101 forgoes displaying (e.g., forgoes redisplaying) the user interface element 18118, and the user interface element 18122 (e.g., user interface elements that would be displayed at distances that are greater than the threshold distance Htₕ are not displayed). A top view 18132 shows the prior position 18134 (e.g., at the position shown in FIG. 18Q) at the distance 18115 away from the application user interface 18002, and a current position of the application user interface 18002 at a distance 18117 away from the viewpoint of the user 7002.

FIG. 18S illustrates an example display of the user interface element 18018 having a height 18138, above the building 18004 that has a height 18140. FIG. 18Q also illustrates the attention 18010 of the user 7002 being directed toward the movement affordance 18016 while the user 7002 performs an air pinch gesture that includes movement away from the viewpoint of the user 7002. A top view 18136 shows the application user interface 18002 being displayed at a distance of 18142 from the viewpoint of the user 7002.

FIG. 18T illustrates an example transition from FIG. 18S. In response to detecting the air pinch gesture that includes movement away from the viewpoint of the user 7002 while the attention 18010 is directed toward the movement affordance 18016 (e.g., as shown in FIG. 18S), the computer system 101 displays the application user interface 18002 at a location in the three-dimensional environment that is further away from the viewpoint of the user 7002 (as compared to FIG. 18S), which optionally includes displaying an animation that shows intermediate positions of the application user interface 18002 (e.g., moving from a prior position 18150 of the application user interface 18002 in dotted outline, to a position that is a distance 18152 away from the user 7002) in accordance with the movement of the air pinch gesture. In some embodiments, the computer system 101 dynamically changes a size of the user interface element 18018 within the application user interface 18002 that dynamically. In response to detecting the air pinch gesture that includes movement away from the viewpoint of the user 7002, and in accordance with a determination that the user interface element 18018 is a dynamic element, the computer system 101 dynamically changes a size of the user interface element 18018 as the application user interface 18002 is moved (e.g., in accordance with movement of the application user interface 18002). For example, as illustrated in FIG. 18T, the computer system 101 dynamically scales the user interface element 18018 to increase a size (e.g., increasing the height of the user interface element 18018 from the height 18138 to a height 18146) of the user interface element 18018, as the application user interface 18002 is moved away from the viewpoint of the user 7002. In some embodiments, as the application user interface 18002 is moved away from the viewpoint of the user 7002, the size of the application user interface is not dynamically scaled. As a result, a ratio of the height 18146 to a height 18148 of the building 18004 in FIG. 18T is different from a ratio of the height 18138 to a height 18140 of the building 18004 in FIG. 18S. In some embodiments, the height 18148 is smaller than the height 18140 as the three-dimensional content elements within the application user interface 18002 are not resized during movement of the application user interface 18002 (e.g., the distance 18152 is larger than the distance 18142 and the building 18004 appears smaller to the user 7002). A top view 18144 shows the application user interface 18002 being displayed at a distance of 18152 and the prior position 18150 of the application user interface 18002 in dotted outline (e.g., at the position shown in FIG. 18S, the distance 18142 away from the viewpoint of the user 7002).

FIG. 18U illustrates an example alternative transition from FIG. 18S. In contrast to FIG. 18T, in response to detecting that the user 7002 has moved further away from the application user interface 18002 without selecting the application user interface 18002 (e.g., as shown in FIG. 18S), the computer system 101 maintains display of the user interface element 18018 and the application user interface 18002 at the same positions in the three-dimensional environment at the same sizes, which appear smaller to the user 7002 due to a larger distance 18158 from the application user interface 18002 to the viewpoint of the user 7002. In some embodiments, a ratio of a height 18162 of the user interface element 18018 to a height 18160 of the building 18004 illustrated in FIG. 18U is the same as the ratio of the height 18138 of user interface element 18018 to the height 18140 of the building 18004 in FIG. 18S. A top view 18154 shows a prior position 18156 of the user 7002 in dotted outline (e.g., at the position shown in FIG. 18S), and a current position of the user 7002 a distance of 18158 away from the application user interface 18002. In some embodiments, the application user interface 18002 includes an application setting that enables the resizing of the user interface elements (e.g., user interface element 18018) based on an occurrence of a specified event (e.g., movement of the application user interface 18002, movement of a viewpoint of the user, selection input directed to the user interface element, display of related content associated with the user interface element and/or other events that change to the user interface elements). In some embodiments, the application user interface 18002 includes an application setting that enables continuous (e.g., dynamic) resizing of the user interface elements as the user interface elements are moved. In some embodiments, a developer who designs the application user interface 18002 selects the application setting to be used, and/or a user of the application user interface 18002 selects the application setting to be used.

FIG. 18V illustrates an example alternative transition from FIG. 18S. In response to detecting the air pinch gesture that includes movement away from the viewpoint of the user 7002 while the attention 18010 is directed toward the movement affordance 18016 (e.g., as shown in FIG. 18S), and while the user 7002 maintains the air pinch gesture (e.g., as shown in FIG. 18V), the computer system 101 displays the application user interface 18002 at a location in the three-dimensional environment that is further away from the viewpoint of the user 7002, which optionally includes displaying an animation that shows intermediate positions of the application user interface 18002 (e.g., moving from a prior position 18150 of the application user interface 18002 in dotted outline, to a position a distance 18152 away from the user 7002) during the movement of the air pinch gesture. In some embodiments, the computer system 101 ceases to display the user interface element 18018 while application user interface 18002 is moved (e.g., and/or being moved) within the three-dimensional environment in response to (e.g., and while and/or as long as the computer system 101 continues to detect) the air pinch gesture that include movement (e.g., movement away from the viewpoint of the user 7002, movement toward the viewpoint of the user 7002, and/or movement relative to the viewpoint of the user 7002). In some embodiments, in response to detecting movement of the air pinch gesture that is larger than a predetermined amount (e.g., movement larger than 2 mm, 5 mm, 10 mm, 20 mm, or another value), optionally while movement above the predetermined amount is maintained for a threshold amount of time (e.g., longer than 0.2 s, 1 s, 2 s, 3 s, or another value), the computer system 101 ceases to display the user interface element 18018. A top view 18164 shows the application user interface 18002 being displayed at a distance of 18166 and the prior position 18150 of the application user interface 18002 in dotted outline (e.g., at the position shown in FIG. 18S, the distance 18142 away from the viewpoint of the user 7002).

FIG. 18W illustrates an example transition from FIG. 18V. In response to detecting termination of the air pinch gesture (e.g., shown in FIGS. 18S and 18T), and in accordance with a determination that a movement of the hand of the user 7002 has ceased (e.g., movement of the hand of the user 7002 is less than a threshold amount of, for example, 5 mm, 4 mm, 1 mm, or a different threshold amount) for at least a threshold amount of time (e.g., 0.2 s, 0.5 s, 1 s, or another threshold value), the computer system 101 displays (e.g., redisplays) the user interface element 18018 within the application user interface 18002, which is placed at a location in the three-dimensional environment that is further away from the viewpoint of the user 7002, based on the location of the air pinch gesture at the termination of the air pinch gesture. A graph 18167 illustrates an example time sequence for the display of the user interface element 18018 as the application user interface 18002 is moved in response to a movement of the hand of the user 7002 while the air pinch gesture is maintained. The graph 18167 illustrates that the computer system 101 ceases to display the user interface element 18018 in response to detecting that the speed of the hand of the user 7002 increases above a threshold speed. After the hand of the user 7002 has stopped moving, the computer system 101 redisplays the user interface element 18018 a threshold amount of time 18169 (e.g., 0.2 s, 0.5 s, 1 s, or another threshold value) has elapsed.

In some embodiments, the user interface element 18018 is displayed, as illustrated in FIG. 18W, at a location within the application user interface 18002 that maintains the same spatial relationship to the movement affordance 18016 as the spatial relationship illustrated in FIG. 18S. In some embodiments, the computer system 101 displays the user interface element 18018 at a different size than an original size of the user interface element 18018 as the application user interface 18002 is moved. In some embodiments, the computer system 101 scales the user interface element 18018 to increase a size (e.g., increasing a height 18180) of the user interface element 18018 as the application user interface 18002 is moved away from the viewpoint of the user 7002. In some embodiments, a ratio of the height 18180 to a height 18172 of the building 18004 in FIG. 18W is different from a ratio of the height 18138 to a height 18140 of the building 18004 in FIG. 18S.

In some embodiments, isotropic enlargement of the user interface element 18018 may cause the user interface element 18018 to collide with application content elements (e.g., one or more buildings displayed in the application user interface 18002, and/or other content elements). In some embodiments, the user interface element 18018 is resized (e.g., enlarged and/or minimized) in an anisotropic fashion, such as being biased away from a line 18272 (e.g., or along a first direction relative to one or more application content elements, such as the user interface element 18018, the building 18006, or another content element of the application user interface 18002), a line 18176, or a line 18174, and/or about a reference point on the line 18176, the line 18174 or another line. In some embodiments, a developer who designs the application user interface 18002 selects a reference point (e.g., optionally on the line 18176 or a line 18174) about which the user interface element 18018 is resized. A top view 18168 shows the application user interface 18002 and a prior position 18170 of the application user interface 18002 in dotted outline (e.g., at the position shown in FIG. 18S, the distance 18142 away from the viewpoint of the user 7002).

FIG. 18X illustrates display of the user interface element 18018 in the application user interface 18002, in accordance with some embodiments. In some embodiments, as illustrated in FIG. 18X, the computer system 101 displays the user interface element 18018 having a height 18186, and above a building 18004 having a height 18188. A top view 18182 shows the user interface element 18018 associated with the application user interface 18002 at a distance away from the viewpoint of the user 7002. FIG. 18X also illustrates the attention 18010 being directed toward a resize affordance 18184 of the user interface element 18018 while the user 7002 performs an air pinch gesture that includes movement toward the viewpoint of the user 7002. In some embodiments, the computer system 101 displays the resize affordance 18184 in response to detecting the attention 18010 of the user 7002 being directed toward an edge (e.g., a bottom right edge) of the user interface element 18018, optionally for at least a threshold amount of time.

FIG. 18Y illustrates an example transition from FIG. 18X. In response to detecting that the air pinch gesture includes movement away from a portion of the user interface element 18018 while the attention 18010 is directed toward the resize affordance 18184 (e.g., movement away from a lower right corner of the user interface element 18018 while a resize affordance is displayed at the lower right corner of the user interface element 18018, as shown in FIG. 18X), the computer system 101 enlarges a size of the user interface element 18018, in conjunction with enlarging a size of the resize affordance 18184. In some embodiments, isotropic resizing (e.g., enlargement or reduction) of the user interface element 18018 is centered about a reference point 18194. In some embodiments, the reference point 18194 is in the central portion of the user interface element 18018, and a size of the user interface element 18018 is changed while a portion of the user interface element 18018 closest to the reference point 18194 remains in a substantially fixed position relative to the reference point 18194. In some embodiments, a location of the reference point 18194 is selected by the computer system 101. In some embodiments, a developer who designs the application user interface 18002 selects the location of the reference point 18194. A top view 18190 shows the user interface element 18018 displayed within the application user interface 18002, in front of the user 7002. A side view 18192 shows the reference point 18194 serving, in addition to being a reference point for resizing the user interface element 18018, a pivot point for rotating a plane of the user interface element 18018. An anti-clockwise rotation rotates a plane of the user interface element 18018 to an orientation 18195-1, while a clockwise rotation rotates the plane of the user interface element 18018 to an orientation 18195-2. In some embodiments, the orientation 18195-2 allows the plane of the user interface element 18018 to be displayed substantially perpendicular to a viewpoint of the user 7002 positioned at 7003′.

FIG. 18Z illustrates an example display of the application user interface 18002, in accordance with some embodiments. In response to detecting the attention 18010 being directed toward an edge (e.g., a right edge, or another edge) of the application user interface 18002 (e.g., as shown in FIG. 18Z), the computer system 101 displays a resize affordance 18198 for the application user interface 18002, which optionally includes displaying an animation of a transformation of the movement affordance 18016 (e.g., shown in FIG. 18Y) into the resize affordance 18198 (e.g., shown in FIG. 18Z). A top view 18196 shows the resize affordance 18198 at a right edge of the application user interface 18002 displayed in front of the user 7002. FIG. 18X also illustrates the user 7002 performs an air pinch gesture that includes movement toward the viewpoint of the user 7002 while the attention 18010 of the user 7002 is directed toward the resize affordance 18198.

FIG. 18AA illustrates an example transition from FIG. 18Z. In response to detecting the air pinch gesture that includes movement toward the viewpoint of the user 7002 while the attention 18010 of the user 7002 is directed toward the resize affordance 18198 (e.g., movement away from a right edge of the application user interface 18002 while the resize affordance 18198 is displayed at the right edge of the application user interface 18002, as shown in FIG. 18Z), the computer system 101 enlarges a size of the application user interface 18002, in conjunction with enlarging a size of the resize affordance 18198 (e.g., as compared to the size of the resize affordance 18198 in FIG. 18Z). In some embodiments, isotropic resizing (e.g., enlargement or reduction) of the resize affordance 18198 is centered about a reference point 18204. In some embodiments, the reference point 18204 is in a central portion (e.g., a center portion, or another portion) of a circle or ellipse associated with an arc of the resize affordance 18198. In some embodiments, a location of the reference point 18204 is selected by the computer system 101. In some embodiments, a developer who designs the application user interface 18002 selects the location of the reference point 18204. A top view 18200 shows the enlarged application user interface 18002, compared with a previous size 18202 of the application user interface 18002 illustrated in FIG. 18Z.

Additional descriptions regarding FIGS. 18A-18AA are provided below in reference to method 21000 described with respect to FIG. 21.

FIGS. 19A-19N illustrate examples of orienting two-dimensional user interface elements within a three-dimensional application volume when the three-dimensional application volume is moved with respect to the three-dimensional environment. FIG. 22 is flow diagram of an exemplary method 22000 for orienting two-dimensional user interface elements within a three-dimensional application volume when the three-dimensional application volume is moved with respect to the three-dimensional environment. The user interfaces in FIGS. 19A-19N are used to illustrate the processes described below, including the processes in FIG. 22.

FIG. 19A illustrates display of various user interface elements in an application user interface 19002, in accordance with some embodiments. In some embodiments, as illustrated in FIG. 19A, the computer system 101 displays within the application user interface 19002 a two-dimensional user interface element 19018 above a three-dimensional building 19003, a two-dimensional user interface element 19016 above a three-dimensional building 19004, and a two-dimensional user interface element 19020 above a three-dimensional building 19006. In some embodiments, the user interface elements 19018, 19020, and 19016 include information (e.g., address, name, point of interest, or other information) associated with the building 19003, the building 19006, and the building 19004, respectively, even when an attention 19010 of the user 7002 is not directed toward those buildings (e.g., one or more of the building 19003, the building 19006, and/or the building 19004). In some embodiments, one or more of the user interface elements 19018, 19020, and 19016 are displayed in response to the user 7002 directing the attention 19010 of the user 7002 toward three-dimensional application content (e.g., the building 19003, the building 19006, and the building 19004, respectively) associated with the user interface elements 19018, 19020, and 19016, for at least a threshold amount of time, and/or directs a selection input toward the three-dimensional application content of the application user interface 19002 (e.g., an air pinch gesture while the attention 19010 of the user 7002 is directed toward the three-dimensional application content). A top view 19012 shows the two-dimensional user interface elements 19018, 19020, and 19016 displayed within the application user interface 19002 at respective distances away from the viewpoint of the user 7002. FIG. 19A also illustrates the attention 19010 of the user 7002 being directed toward a movement affordance 19014 of the application user interface 19002, while the user 7002 performs an air pinch gesture that includes rightward and slight clockwise movement away the viewpoint of the user 7002.

FIG. 19B illustrates an example transition from FIG. 19A. In response to detecting that the air pinch gesture includes rightward movement and slight rotation toward the viewpoint of the user 7002 while the attention 19010 of the user 7002 is directed toward the move affordance 19014 (e.g., as shown in FIG. 19A), the computer system 101 displays the application user interface 19002 at an updated location further to the right, at a greater distance from the viewpoint of the user 7002, and rotated slightly toward the viewpoint of the user 7002 compared to the display location of the application user interface 19002 illustrated in FIG. 19A. In some embodiments, the slight rotation toward the viewpoint of the user 7002 is described as a clockwise rotation, about a vertical axis, viewed from above (e.g., as viewed in a top view 19012 or an analogous top view). In some embodiments, as illustrated in FIG. 19B, an orientation of the two-dimensional user interface elements 19018, 19020, and 19016 are not changed from a first orientation relative to the three-dimensional virtual content (FIG. 19A) to a second orientation relative to the three-dimensional virtual content (e.g., are not rotated to face a viewpoint of the user 7002, optionally in accordance with a determination that a change in a respective portion, such as a centroid, of the application user interface 19002, is less than an angular threshold, from the viewpoint of the user 7002). In some embodiments, the computer system 101 maintains a plane of the two-dimensional user interface element with respect to a portion of the application user interface 19002 (e.g., the movement affordance 19014, such that the two-dimensional user interface element 19018 remain parallel to a plane of the movement affordance 19014). A top view 19024 shows a prior position 19026 of the application user interface 19002 in a dotted outline, and the application two-dimensional 19002 is rotated with respect to the prior position 19026, in addition to being moved further away and rightward from the user 7002. The user interface elements 19018, 19020, and 19016 are maintained at the same orientation with respect to the application user interface 19002 but are rotated clockwise with respect to the orientation illustrated in FIG. 19A from the viewpoint of the user 7002. FIG. 19B also illustrates the attention 19010 of the user 7002 being directed toward a three-dimensional building 19008 of the application user interface 19002 while the user 7002 optionally performs a selection input (e.g., an air pinch gesture, or another gesture).

In some embodiments, in response to detecting that the air pinch gesture includes rightward movement and rotation toward the viewpoint of the user 7002 while the attention 19010 of the user 7002 is directed toward the move affordance 19014 (e.g., as shown in FIG. 19A) that is larger than an angular threshold, an alternative top view 19025 shows that the computer system 101 displays the application user interface 19002 at an updated location further to the right, at a greater distance from the viewpoint of the user 7002, and rotated toward the viewpoint of the user 7002 compared to the display location of the application user interface 19002 illustrated in FIG. 19A and the computer system 101 changes an orientation of the user interface elements 19018, 19020, and 19016 relative to the three-dimensional virtual content elements of the application user interface 19002 (e.g., so that the user interface elements 19018, 19020, and 19016 are substantially perpendicular to a direction along which the attention 19010 of the user 7002 is directed).

FIG. 19C illustrates an example transition from FIG. 19B. In response to detecting that the attention 19010 is directed toward the building 19008 optionally in conjunction with detecting a selection input performed by the user, the computer system 101 displays a two-dimensional user interface element 19030 associated with the building 19008. In some embodiments, as illustrated in FIG. 19C, the user interface element 19030 includes an abbreviated address associated with the building 19008. In some embodiments, as illustrated in FIG. 19C, a plane of the two-dimensional user interface element 19030 is oriented to face a viewpoint of the user 7002 head-on (e.g., because the user interface element 19030 was displayed after the changing in position and orientation of the application user interface 9002), based on the viewpoint at the time the two-dimensional user interface element 19030 is invoked. In some embodiments, an orientation of a plane of the two-dimensional user interface element 19030 is parallel to the orientation of planes of one or more other two-dimensional user interface elements currently displayed (e.g., and optionally, all other two-dimensional user interface elements currently displayed). A top view 19028 shows the user interface element 19030 being displayed to face a viewpoint of the user 7002, at a different orientation from the user interface elements 19018, 19020, and 19016. FIG. 19C also illustrates the attention 19010 being directed toward the user interface element 19016 while the user 7002 optionally provides a selection input (e.g., an air pinch gesture, or another gesture).

FIG. 19D illustrates an example transition from FIG. 19C. In response to detecting that the selection input performed by the user while the attention 19010 is directed toward the user interface element 19016, the computer system 101 rotates the plane of the user interface element 19016 (e.g., and optionally, only the user interface element 19016, towards which the attention 19010 of the user 7002 is directed) to face the viewpoint of the user 7002 head-on. For example, as illustrated in FIG. 19D, after the plane of the user interface element 19016 has been rotated, the plane of the user interface element 19016 is no longer parallel to a plane of the move affordance 19014 (e.g., or the user interface elements 19018, and 19020). A top view 19032 shows the user interface element 19016 is rotated to a different orientation from the user interface elements 19018, and 19020.

FIGS. 19E and 19F illustrate two example transitions from FIG. 19A. In FIG. 19E, in response to detecting that the user 7002 has moved relative to the movement affordance 19014, and in accordance with a determination that an angle 19011-1 between a direction of the attention 19010 of the user 7002 to a respective portion (e.g., a centroid, or another portion) of the application user interface 19002 and a line from the movement affordance 19014 to the respective portion of the application user interface 19002 is less than a threshold angle, the computer system 101 maintains the orientations of the user interface element 19018, the user interface element 19018, and the user interface element 19018 (e.g., the orientation of each of the user interface elements 19018, 19020, and 19016 remain parallel to the movement affordance 19014, and are not changed relative to the three-dimensional environment), and forgoes rotating the user interface elements to face the viewpoint of the user 7002. In some embodiments, the application user interface 19002 is configured with a number of predefined anchoring points 19036-1 (the position the movement affordance 19014 is displayed at, along a border and/or boundary of the application user interface 19002), 19036-2, 19036-3, 19036-4, 19036-5, 19036-6, 19036-7, and 19036-8, arranged at approximately 450 intervals. In FIG. 19E, the user 7002 is positioned between the anchoring point 19036-1 and the anchoring point 19036-2. A top view 19034 shows the position of the user 7002 relative to the application user interface 19002, and the user interface elements 19016, 19018, and 19020 are (e.g., and remain) oriented parallel to the movement affordance 19014.

In contrast to FIG. 19E, in FIG. 19F, in response to detecting that the user 7002 has moved relative to the movement affordance 19014, and in accordance with a determination that an angle 19011-2 between a direction of the attention 19010 of the user 7002 to a respective portion (e.g., a centroid, or another portion) of the application user interface 19002 and a line from the movement affordance 19014 to the respective portion of the application user interface 19002 is greater than a threshold angle (e.g., a different threshold from that illustrated in FIG. 19E), the computer system 101 displays the movement affordance 19014 at an updated position with respect to the application user interface 19002 and rotates the planes of the user interface element 19018, the user interface element 19020, and the user interface element 19016 (e.g., the orientation of each of the user interface elements 19018, 19020, and 19016 are updated so the user interface elements remain parallel to the movement affordance 19014 at its updated position) to face the viewpoint of the user 7002. In some embodiments, the application user interface 19002 is configured with a number of predefined anchoring points 19040-1 (the position the movement affordance 19014 is displayed at), 19040-2, 19040-3, 19040-4, 19040-5, 19040-6, 19040-7, 19040-8, 19040-9, 19040-10, 19040-11, and 19040-12 (e.g., at approximately 300 intervals, along the border and/or boundary of the application user interface 19002). In FIG. 19F, the user 7002 is positioned near the anchoring point 19040-2 (e.g., is closer to the anchoring point 19040-w than any other anchoring point), and the computer system 101 updates the movement affordance 19014 to be displayed at the anchoring point 19040-2. In some embodiments, the computer system 101 ceases to display the movement affordance 19014 in response to detecting a movement of the viewpoint of the user 7002 that is above a threshold (e.g., at a timepoint A1), the computer system 101 ceases to display the movement affordance 19014. After an amount of time t1 (e.g., 5 ms, 50 ms, 500 ms, 1 s, 2 s, or another time value) has elapsed after the movement of the viewpoint of the user 7002 has dropped below a movement threshold (e.g., less than 50 mm, 40 mm, 30 mm, 20 mm, 10 mm, or another value) or stopped (e.g., since the viewpoint of the user 7002 has remained substantially stationary), the computer system 101 redisplays the movement affordance 19014 at an updated anchoring point (e.g., the anchoring point 19040-2, at a time A2). A top view 19038 shows the position of the user 7002 relative to the application user interface 19002, and that the user interface elements 19016, 19018, and 19020 are (e.g., and remain) oriented parallel to the movement affordance 19014 at the new anchoring point 19040-2, which is closer (e.g., and/or closest) to the user 7002.

FIGS. 19G-19I illustrate example user interfaces associated with different two-dimensional user interface elements, in accordance with some embodiments. FIG. 19G illustrates display of a user interface element 19044 in the application user interface 19002. In some embodiments, the computer system 101 displays the user interface element 19044 in response to detecting a selection input that is directed toward the user interface element 19016 (FIGS. 19A-19F) or detecting a selection input (e.g., a long air pinch gesture or another gesture) that is directed toward the building 19004 (e.g., the building corresponding to the user interface element 19016), while the attention 19010 of the user 7002 is directed toward the building 19004 or the user interface element 19016. In some embodiments, the user interface element 19044 includes information for a point-of-interest corresponding to a user selected portion of the application user interface 19002 (e.g., the building 19004). For example, a search bar may be provided to receive user input, and information such as opening hours, location, and recommended services may be displayed on the user interface element 19044. In some embodiments, the user interface element 19044 is displayed above (e.g., in a vertical direction) and/or in front of (e.g., in a depth direction) the associated application content. In some embodiments, the computer system 101 maintains display of the user interface element 19044 while (e.g., and optionally, as long as) the attention 19010 of the user 7002 is directed toward the user interface element 19044. A top view 19042 shows the two-dimensional user interface element 19044 displayed within the application user interface 19002 at a distance away from the viewpoint of the user 7002. FIG. 19G also illustrates the attention 19010 of the user 7002 being directed toward a user settings icon 19046 while the user 7002 performs a selection operation (e.g., an air pinch gesture).

FIG. 19H illustrates an example transition from FIG. 19G. In response to detecting that the selection input performed by the user while the attention 19010 of the user 7002 is directed toward the user settings icon 19046 (e.g., as shown in FIG. 19G), the computer system 101 displays a user interface element 19048 that is associated with the two-dimension user interface element 19046, and provides a number of selectable options that are associated with the user settings icon 19046. For example, the user interface element 19048 provides selectable options that include an option to update profile information of a current user (e.g., the user 7002), an option to access locations saved by the current user, and/or an option to access other saved lists. In some embodiments, the user interface element 19048 includes a close affordance 19049 that allows a selection input from the user 7002 to dismiss and/or cease display of the user interface element 19048. In some embodiments, in response to detecting the attention 19010 of the user 7002 being directed away from the user interface element 19048, the computer system 101 dismisses (e.g., ceases to display) the user interface element 19408. In some embodiments, while displayed, the user interface element 19044 and/or the user interface element 19048 exhibit analogous behavior to the user interface element 19016 (e.g., with respect to a displayed orientation and updated orientation behavior, as previously described with reference to the user interface element 19016). A top view 19050 shows the user interface element 19048 being displayed in front of the user interface element 19040.

FIG. 19I illustrates movement of the viewpoint of the user 7002 while the user interface element 19044 and the user interface element 19048 are displayed, in accordance with some embodiments. In FIG. 19H, a top view 19502 shows the user 7002 at a first position relative to the application user interface 19002. The top view 19052 shows that the user interface element 19048 is displayed in front of, and parallel to the user interface element 19044 (e.g., the user interface element 19048 is displayed between the user interface element 19044 and the user 7002). A top view 19054 shows the user 7002 at second position that is different from the first position, relative to the application user interface 19002, compared to the top view 19052. In some embodiments, in accordance with a determination that an angle 19011-3 between a direction of the attention 19010 of the user 7002 to a respective portion of the user interface element 19048 and a line between the respective portion of the user interface element 19048 to a respective portion of the application user interface 19002 (e.g., the movement affordance 19014) is less than a threshold value (e.g., 30°, 20°, 10°, 5°, or another angular value), the computer system 101 maintains display of the user interface element 19048 in front of, and parallel to the user interface element 19044, as illustrated in the top view 19054, analogous to the arrangement of the user interface element 19048 and the user interface element 19044 illustrated in the top view 19052. A top view 19056 shows the user 7002 at third position that is different from the second position (e.g., and the first position), compared to the top view 19054 (denoted by a prior position 19058 illustrated with a dotted outline). In some embodiments, in accordance with a determination that an angle 19011-4 between a direction of the attention 19010 of the user 7002 to a respective portion of the user interface element 19044 and a line between the respective portion of the user interface element 19044 to a respective portion of the application user interface 19002 (e.g., the movement affordance 19014) is greater or equal a threshold value (e.g., 30°, 20°, 10°, 5°, or another angular value), the computer system 101 ceases to display the user interface element 19048, as illustrated in the top view 19056. In some embodiments, in accordance with a determination that the angle 19011-4 is greater or equal to the threshold value, the computer system 101 ceases to display the user interface element 19048 and the two-dimensional user interface element 19044 that is associated with the user interface element 19048 is also visually deemphasized (e.g., becoming more translucence, dimmer or reduced in visual prominence).

FIG. 19J illustrates the application user interface 19002 positioned on a left portion of the viewport. In some embodiments, the application user interface 19002 is positioned on a left portion of the viewport due to the user 7002 moving towards a right portion of the three-dimensional environment after the application user interface 19002 is invoked and displayed in the three-dimensional environment. The computer system 101 displays a portion of the building 19062, and the user interface element 19064 in the right portion of the application user interface 19002 that is visible in the viewport. In some embodiments, as illustrated in FIG. 19J, an orientation of a user interface element 19064 (e.g., a user interface element analogous to the user interface elements 19016, 19018, and 19020) does not update with a movement of the viewpoint of the user 7002 or a movement of the user 7002 within the three-dimensional environment, after the user interface element 19064 is displayed, to face the viewpoint of the user 7002 head-on (does not update in an analogous fashion to the user interface elements 19016, 19018, and 19020, as described with reference to FIG. 19F). A top view 19060 shows the two-dimensional user interface element 19064 displayed within the application user interface 19002 does not face the user 7002 head on. The top view 19060 shows the user 7002 positioned to the right of the application user interface 19002. FIG. 19J also illustrates a user input 19061 directed toward the digital crown 703.

FIG. 19K illustrates an example transition from FIG. 19J. In response to detecting the user input 19061 directed toward the digital crown 703 (e.g., in FIG. 19J), the computer system 101 recenters the application user interface 19002 within the viewport of the user 7002 (e.g., moves the application user interface 19002 relative to the three-dimensional environment to a location that causes the application user interface 19002 to appear in substantially a center region of the viewport of the user 7002). In some embodiments, as illustrated in FIG. 19K, an orientation of the user interface element 19064 (e.g., and the application user interface 19002) is rotated to face the viewpoint of the user 7002 head-on when the application user interface 19002 is recentered in response to the user input 19061 (e.g., a press input directed toward the digital crown 703). A top view 19068 shows the two-dimensional user interface element 19064 displayed within the application user interface 19002, and with an orientation that faces the user 7002 head-on. The top view 19068 shows the application user interface 19002 being repositioned in front of the user 7002 (e.g., and with an orientation that faces the user 7002 head-on).

FIG. 19L illustrates a side view 19066 in which a viewpoint of the user makes an angle θ below a reference plane 19072 (e.g., a horizon), and a user interface element 19080 that is pivoted about a reference point 19174, from a default position 19076 that is parallel to a vertical edge of the application user interface 19002, to an orientation that faces the viewpoint of the user 7002 (e.g., a plane of the user interface element 19080 is substantially perpendicular to a direction along which the attention 17014 of the user 7002 is directed). In some embodiments, the plane of the user interface element 19080 rotates or billboards about the x-axis, and does not rotate or billboard about the y-axis. In some embodiments, the user interface element 19080 does not pivot beyond a maximum (e.g., clockwise rotation, in the side view 19066) angle or a minimum (e.g., anti-clockwise rotation) angle. A top view 19168 shows the user interface element 19080 being rotated around a reference point 19078. In some embodiments, the user interface element 19080 does not have a maximum or minimum limit to the amount of rotation about the reference point 19078 (e.g., about the y axis). Side views 19067-1 and 19067-2 relate to the user interface element 19074 having the reference point 19084 along a reference axis 19082 (e.g., an axis parallel to the x-axis). The side view 19067-1 shows that when the viewpoint of the user 7002 is located at or above an upper portion of the application user interface 19002, the user interface element 19074 is rotated clockwise (as viewed in the side view 19067-1) from a default position 19090 (e.g., parallel to a vertical edge of the application user interface 19002) about the reference point 19084 so that a plane of the user interface element 19074 is substantially perpendicular to a direction along which the attention 17014 of the user 7002 is directed. The side view 19067-2 shows that when the viewpoint of the user 7002 is located at or below a lower portion of the application user interface 19002, the user interface element 19074 is rotated anti-clockwise (e.g., as viewed in the side view 19067-2) from the default position 19090 (e.g., parallel to the vertical edge of the application user interface 19002) about the reference point 19084, so that a plane of the user interface element 19074 is substantially perpendicular to a direction along which the attention 17014 of the user 7002 is directed. In some embodiments, the reference point 19084 is positioned in front of and/or offset from the application user interface 19002 (e.g., outside of a boundary of the application user interface 19002 and/or a boundary of the user interface element 19074).

Side views 19067-3 and 19067-4 relate to the user interface element 19074 having a reference point 19088 along a reference axis 19086 (e.g., an axis parallel to the x-axis and the reference axis 19082, but at a different vertical position along the y-axis as compared to the reference axis 19082). The side view 19067-3 shows that when the viewpoint of the user 7002 is located at or above an upper portion of the application user interface 19002, the user interface element 19074 is rotated clockwise (e.g., as viewed in the side view 19067-3) from the default position 19090 (e.g., parallel to the vertical edge of the application user interface 19002) about the reference point 19088 so that a plane of the user interface element 19074 is substantially perpendicular to a direction along which the attention 17014 of the user 7002 is directed. The side view 19067-4 shows that when the viewpoint of the user 7002 is located at or below a lower portion of the application user interface 19002, the user interface element 19074 is rotated anti-clockwise (e.g., as viewed in the side view 19067-4) from the default position 19090 (e.g., parallel to the vertical edge of the application user interface 19002) about the reference point 19088 so that a plane of the user interface element 19074 is substantially perpendicular to a direction along which the attention 17014 of the user 7002 is directed. In some embodiments, the reference point 19084 is positioned in front of and/or offset from the application user interface 19002 (e.g., outside of a boundary of the application user interface 19002 and/or a boundary of the user interface element 19074). In some embodiments, a location of the reference point (e.g., whether the reference point 19088 or the reference point 19084 is selected) is selected by the computer system 101. In some embodiments, a developer who designs the application user interface 19002 selects the location of the reference point.

FIG. 19M illustrates display of various user interface elements in an application user interface 19002, in accordance with some embodiments. The user interface 19016, the user interface 19020, and the user interface element 19064 are oriented at an angle (e.g., rotated anti-clockwise, as viewed in a top view 19092) 19094 from the vertical edge of the application user interface 19002. The top view 19092 shows the user interface elements 19016, 19018, 19020 oriented parallel to a long axis 19116 of the application user interface 19002. A side view 19093 shows the user interface element 19016, the user interface element 19020, and the user interface element 19064 are oriented at an angle 19094 (e.g., rotated anti-clockwise, as viewed in the top view 19092) from the vertical edge of the application user interface 19002, above the building 19004, the building 19006, and the building 19062, respectively.

FIG. 19N illustrates an example transition from FIG. 19M. In some embodiments, in response to detecting that the viewpoint of the user 7002 has moved with respect to the three-dimensional environment, the computer system 101 updates a position of the movement affordance 19014 (e.g., from being in front of the building 19004 in FIG. 19M, be being adjacent to a park in FIG. 19N, relative to a respective viewpoint of the user 7002), and rotates (e.g., about the y-axis) the planes of the user interface element 19016, the user interface element 19020, and the user interface element 19064 to face the user 7002 at the updated position of the user 7002, while keeping a tilt (e.g., rotation about the x-axis) of the user interface element 19016, the user interface element 19020, and the user interface element 19064 at an angle 19098 (e.g., analogous to the angle 19094, rotated anti-clockwise from a vertical edge of the application user interface 19002, as viewed in a top view 19096). The top view 19096 shows the user interface elements 19016, 19018, 19020 oriented (e.g., about the y-axis) to be (e.g., remain) parallel to the movement affordance 19014 and the application user interface 19002.

Additional descriptions regarding FIGS. 19A-19N are provided below in reference to method 22000 described with respect to FIG. 22.

FIGS. 12A-12G are flow diagrams of an exemplary method 12000 for displaying a user interface element while a volumetric application is displayed in the viewport, in accordance with some embodiments. In some embodiments, method 12000 is performed at a computer system (e.g., computer system 101 in FIG. 1) that is in communication with one or more display generation components (e.g., a head-mounted display (HMD), a heads-up display, a display, a touchscreen, a projector, or other types of display) (e.g., display generation component 120 in FIGS. 1A, 3A, and 4, or the display generation component 7100a in FIGS. 7A-7O), and one or more input devices (e.g., sensors, hardware controls for detecting user inputs, one or more optical sensors such as cameras (e.g., color sensors, infrared sensors, structured light scanners, and/or other depth-sensing cameras) that points downward at a user's hand or a camera that points forward from the user's head, eye-tracking devices, touch sensors, touch-sensitive surfaces, proximity sensors, motion sensors, buttons, crowns, joysticks, user-held and/or user-worn controllers, and/or other sensors and input devices) (e.g., one or more input devices 125 and/or one or more sensors 190 in FIG. 1A, or sensors 7101a-7101c and/or the digital crown 703 in FIGS. 7A-7O). In some embodiments, the method 12000 is governed by instructions that are stored in a non-transitory (or transitory) computer-readable storage medium and that are executed by one or more processors of a computer system, such as the one or more processors 202 of computer system 101 (e.g., control 110 in FIG. 1A). Some operations in method 12000 are, optionally, combined and/or the order of some operations is, optionally, changed.

The computer system displays (12002) a first view of a three-dimensional environment. The first view of the three-dimensional environment corresponds to a first viewpoint of a user, and includes a first three-dimensional application volume (e.g., an application window and/or application content that is bounded by a three-dimensional volume with a finite boundary (e.g., visible boundary, or invisible boundary) in one or more dimensions (e.g., in the horizontal dimension, in the vertical dimension, and/or in the depth dimension; and/or in the radial dimension and/or in the azimuthal dimension), such as a three-dimensional volumetric window of a cylindrical shape, a rectangular prism shape, a spherical shape, and/or other volumetric shapes) that corresponds to a first application (e.g., a system application, such as an application or experience launcher application, a system control application, a settings application, and/or an application switcher application, or a user-installed application, such as a communication application, a telephony application, a gaming application, an exercise application, a meditation application, or other types of applications).

While displaying the first three-dimensional application volume in the first view of the three-dimensional environment, the computer system detects (12004) occurrence of a first event (e.g., the first event is associated with the first application, the first event is a system-generated event, detecting occurrence of a first event includes detecting a change in contextual conditions, and/or one or more user inputs that are associated with the first application such as an input or event that causes generation of a pop-up alert, new content, new window, modal window, banner, and/or navigation to another user interface of the first application).

In response to detecting (12006) the occurrence of the first event: in accordance with a determination that first criteria are met as a result of the occurrence of the first event (e.g., criteria for displaying an alert indicative of the occurrence of the first event, such as the computer system being in a respective context and/or a respective mode in which display of alerts is enabled or not suppressed) and that the first viewpoint of the user is outside of a first threshold range (e.g., a threshold distance in the depth dimension relative to the first viewpoint, and/or respective threshold distances in two or more dimensions) of a respective portion of (e.g., a center of or a boundary of) the first three-dimensional application volume (e.g., the first viewpoint is outside of a bounding surface of the first three-dimensional application volume and is at least a first threshold distance away from the bounding surface of the first three-dimensional application volume; the first viewpoint is at least a first threshold distance away from the content of the first application displayed in the first three-dimensional application volume; and/or the first viewpoint is separated from the application volume by respective threshold distances in one or more dimensions), the computer system displays (12008) a first user interface object (e.g., an alert, a system user interface object, such as a notification, a modal window, a banner, a pop-up, a user interface object that requires user input in order to be dismissed) at a first location in the three-dimensional environment. The first location is on a first side of a boundary of (e.g., at or outside of the boundary of) the first three-dimensional application volume (e.g., at the edge or bounding surface of the first three-dimensional application volume that is the closest to the first viewpoint, at the edge or surface of the first three-dimensional application volume that has the smallest depth relative to the first viewpoint, and/or at a location between the closest edge or bounding surface of the first three-dimensional application volume and the first viewpoint).

In response to detecting (12006) the occurrence of the first event: in accordance with a determination that the first criteria are met as the result of the occurrence of the first event and that the first viewpoint of the user is within the first threshold range (e.g., a threshold distance in the depth dimension relative to the first viewpoint, and/or respective threshold distances in two or more dimensions) of the respective portion of the first three-dimensional application volume (e.g., the first viewpoint is outside of the bounding surface of the first three-dimensional application volume and is less than the first threshold distance away from the bounding surface of the first three-dimensional application volume; the first viewpoint is within the bounding surface of the three-dimensional application volume; the first viewpoint is less than the first threshold distance away from the content of the first application displayed in the first three-dimensional application volume; and/or the first viewpoint is separated from the application volume by less than the respective threshold distance in one or more dimensions), the computer system displays (12010) the first user interface object (e.g., an alert, a system user interface object, such as a notification, a modal window, a banner, a pop-up, a user interface object that requires user input in order to be dismissed) at a second location in the three-dimensional environment. The second location is on a second side of the boundary of (e.g., within the boundary of) the first three-dimensional application volume. In some embodiments, in response to detecting the occurrence of the first event and in accordance with a determination that the first criteria are not met as a result of the occurrence of the first event, the computer system forgoes displaying the first user interface object.

As described herein, method 12000 provides a system for displaying a representation of a three-dimensional application (e.g., also referred to herein as a three-dimensional application volume) in a three-dimensional environment, and determining whether to display an alert or other user interface object for a user near an edge of the three-dimensional application or within the three-dimensional application based on a position of the user in the three-dimensional environment. For example, as described with reference to FIGS. 7C and 7D, in accordance with a determination that a position of the user 7002 within the three-dimensional environment when an event was detected is at or more than a threshold distance Dₜₕ from a characteristic portion of the application user interface 7030, the computer system 101 displays the first user interface element 7038 on a first side of the boundary (e.g., at or near the boundary, tangential to and/or on an exterior surface of the outline 7034). In accordance with a determination that a position of the user 7002 when an event was detected is less than the threshold distance Dₜₕ from the characteristic portion of the application user interface 7030, the computer system 101 displays the first user interface element 7038 on a second side of the boundary (e.g., within the three-dimensional application volume of the application user interface 7030) to maintain the threshold distance Dₜₕ between the viewpoint of the user 7002 and the first user interface element 7038. Automatically determining a position at which to display an alert or other user interface object relative to a displayed three-dimensional application makes it easier for the user to view and/or interact with the alert or other user interface object without requiring the user to change the user's viewpoint of the three-dimensional environment, thereby improving the visibility of the alert or other user interface element and providing the user with additional information and/or control options without visually obscuring the three-dimensional application unnecessarily.

In some embodiments, the first side of the boundary of the first three-dimensional application volume is (12012) outside of the boundary of the first three-dimensional application volume; and the second side of the boundary of the first three-dimensional application volume is within the boundary of the first three-dimensional application volume. In some embodiments, the first side is the outside of the boundary, or at the surface of the boundary (e.g., the outside surface of the boundary), and the second side is the inside of the boundary. For example, as described with reference to FIGS. 7C and 7D, in accordance with a determination that a position of the user 7002 when an event was detected is at or more than the threshold distance Dₜₕ from the characteristic portion of the application user interface 7030, the computer system 101 displays the first user interface element 7038 on an exterior surface of the outline 7034. In accordance with a determination that a position of the user 7002 when the event was detected is less than the threshold distance Dₜₕ from the characteristic portion of the application user interface 7030, the computer system 101 displays the first user interface element 7038 within the three-dimensional application volume of the application user interface 7030. Automatically determining a position at which to display an alert or other user interface object relative to a displayed three-dimensional application based on a current viewpoint of the user, including whether to display the alert or other user interface object outside or inside of a boundary of the three-dimensional application, makes it easier for the user to view and/or interact with the alert or other user interface object without requiring the user to change the user's viewpoint of the three-dimensional environment, thereby improving the visibility and legibility of the alert or other user interface object without visually obscuring the three-dimensional application.

In some embodiments, in accordance with a determination that the first three-dimensional application volume has a first size (e.g., a size greater than a respective size threshold), the second side of the boundary of the first three-dimensional application volume is (12014) within the boundary of the first three-dimensional application volume; and in accordance with a determination that the first three-dimensional application volume has a second size that is different from the first size (e.g., a size less than the respective size threshold), the second side of the boundary of the first three-dimensional application volume is outside of the boundary of the first three-dimensional application volume. In some embodiments, if the first three-dimensional application volume is smaller than the respective size threshold, both the first side of the boundary and the second side of the boundary are outside of the boundary of the first three-dimensional application, where the second side is on an opposite side of the first three-dimensional application volume from the first side of the boundary (e.g., the first side is a side of the first three-dimensional application volume facing a viewpoint of the user, whereas the second side is a side of the first three-dimensional application volume facing away from the viewpoint of the user). For example, as described with reference to FIGS. 7D and 7J, in accordance with a determination that a position of the user 7002 when an event was detected is less than the threshold distance Dₜₕ from the characteristic portion of the application user interface 7030, the computer system 101 displays the first user interface element 7038 within the three-dimensional application volume of the application user interface 7030. In contrast, a planar section 7092 of the application user interface 7082, shown in top view 7090 of FIG. 7J, has a dimension (e.g., a linear length) that is small enough such that the computer system 101 displays the first user interface element 7038 at a location on a back boundary of the application user interface 7082 to maintain the requisite threshold distance Dₜₕ from the viewpoint of the user 7002. Automatically determining whether to display the alert or other user interface object outside or inside of a boundary of the three-dimensional application based on a size of the three-dimensional application while the viewpoint of the user is close to the three-dimensional application improves the visibility and legibility of the alert or other user interface object without requiring user input or adjustment.

In some embodiments, the first location on the first side of the boundary of the first three-dimensional application volume is (12016) based on the first viewpoint of the user (e.g., based on a spatial relationship between the first viewpoint of the user and the first three-dimensional application volume, including based on whether the first viewpoint of the user is within or outside of the first threshold range from the respective portion of the first three-dimensional application volume, and/or based on lateral and/or vertical positioning (or azimuthal and/or elevational positioning) of the first viewpoint relative to the first three-dimensional application volume); and the second location on the second side of the boundary of the first three-dimensional application volume is based on the first viewpoint of the user. In some embodiments, the coordinates (e.g., lateral and vertical coordinates or azimuth and elevation) of the first viewpoint of the user relative to the first three-dimensional application volume are used to determine the coordinates of the first user interface object relative to the first three-dimensional application volume (e.g., if the first viewpoint were at a different set of coordinates relative to the first three-dimensional application volume when the occurrence of the first event was detected, the first user interface object would be displayed at a different set of coordinates relative to the first three-dimensional application volume). In some embodiments, as described in more detail herein with reference to method 15000, once the first user interface object is displayed at a respective location based on the first viewpoint of the user when the occurrence of the first event was detected, the first user interface object may or may not be automatically repositioned relative to the first three-dimensional application volume based on a current viewpoint of the user as the current viewpoint of the user moves relative to the first three-dimensional application volume. For example, as described with reference to FIGS. 7C and 7D, in accordance with a determination that a position of the user 7002 when an event was detected is at or more than the threshold distance Dₜₕ from the characteristic portion of the application user interface 7030, the computer system 101 displays the first user interface element 7038 on a first side of the boundary. In accordance with a determination that the position of the user 7002 when an event was detected is less than the threshold distance Dₜₕ from the characteristic portion of the application user interface 7030, the computer system 101 displays the first user interface element 7038 on a second side of the boundary. Determining the position at which to display the alert or other user interface element at a time that the event that causes display of the alert or other user interface element occurs, based on the viewpoint of the user at that time improves the visibility and legibility of the alert or other user interface element by selecting the position at which to display the alert or other user interface element based on the viewpoint of the user.

In some embodiments, displaying the first user interface object at the first location in the three-dimensional environment that is on the first side of the boundary of the first three-dimensional application volume includes: in accordance with a determination that that the first viewpoint of the user is a first distance from the respective portion of the first three-dimensional application volume, wherein the first distance is outside of the first threshold range of the respective portion of the first three-dimensional application volume, the computer system displays (12018) the first user interface object at a respective distance from the boundary of the first three-dimensional application volume (e.g., at an edge, or at a respective distance from the edge, of the boundary); and in accordance with a determination that that the first viewpoint of the user is a second distance from the respective portion of the first three-dimensional application volume, wherein the second distance is different from the first distance and outside of the first threshold range of the respective portion of the first three-dimensional application volume, the computer system displays the first user interface object at the respective distance from the boundary of the first three-dimensional application volume (e.g., the first user interface object is displayed at a fixed distance from the boundary of the three-dimensional application volume). For example, as described with reference to FIG. 7C, in accordance with a determination that a position of the user 7002 when an event was detected is at or more than the threshold distance Dₜₕ from a characteristic portion of the application user interface 7030, the computer system 101 displays the first user interface element 7038 on a first side of the boundary (e.g., at or near the boundary, tangential to and/or on an exterior surface of the outline 7034). Automatically displaying the alert or other user interface object at a same fixed position relative to a boundary of the three-dimensional application while the user is at a position that is outside a threshold distance from the displayed three-dimensional application, regardless of how far outside of the threshold distance the user is positioned, provides improved visual feedback for the alert or other user interface object and improves the visibility of the alert or other user interface object by displaying it at the fixed position relative to the boundary of the three-dimensional application.

In some embodiments, displaying the first user interface object at the second location in the three-dimensional environment that is on the second side of the boundary of the first three-dimensional application volume includes: in accordance with a determination that that the first viewpoint of the user is a third distance from the respective portion of the first three-dimensional application volume, wherein the third distance is within the first threshold range of the respective portion of the first three-dimensional application volume, the computer system displays (12020) the first user interface object at a respective distance from the first viewpoint of the user (e.g., 0.1 m, 0.2 m, 0.5 m, 0.8 m, 1 m, 1.2 m, 1.5 m, or other distance from the first viewpoint); and in accordance with a determination that that the first viewpoint of the user is a fourth distance from the respective portion of the first three-dimensional application volume, wherein the fourth distance is different from the third distance and within the first threshold range of the respective portion of the first three-dimensional application volume, the computer system displays the first user interface object at the respective distance from the first viewpoint of the user (e.g., the first user interface object is displayed at a fixed distance from the first viewpoint of the user). For example, as described with reference to FIG. 7D, in accordance with a determination that a position of the user 7002 when an event was detected is less than the threshold distance Dₜₕ from the characteristic portion of the application user interface 7030, the computer system 101 displays the first user interface element 7038 on a second side of the boundary (e.g., within the three-dimensional application volume of the application user interface 7030) to maintain the threshold distance Dₜₕ between the viewpoint of the user 7002 and the first user interface element 7038. Automatically displaying the alert or other user interface object at a same fixed distance relative to a viewpoint of the while the user is at a position that is within a threshold distance from the displayed three-dimensional application, regardless of how close the user is positioned to the three-dimensional application, improves the visibility and legibility of the alert or other user interface object by displaying it at the fixed distance relative to the user's viewpoint without requiring the user to move or adjust the user's viewpoint.

In some embodiments, the computer system displays (12022) the first user interface object displayed at the first location in the three-dimensional environment on the first side of the boundary of the first three-dimensional application volume with a first orientation that is based on an orientation of a portion of the boundary of the first three-dimensional application volume that corresponds to the first location (e.g., tangential to, or parallel to a tangent to, the boundary of the first three-dimensional application volume at a first reference point corresponding to (e.g., at or near) the first location (e.g., if the first location is not on the boundary, a point corresponding to a projection of the first location onto the boundary, such as an intersection point between the boundary and a line from the first location to a reference point in the first three-dimensional application volume, such as the centroid, or a line from the first location that is perpendicular to the boundary, or other first reference point), along one or more axes (e.g., along a length and/or width) of the first user interface object); and the computer system displays the first user interface object displayed at the second location in the three-dimensional environment on the second side of the boundary of the first three-dimensional application volume with a second orientation that is different from the first orientation. In some embodiments, the second orientation is based on an orientation of a portion of the boundary of the first three-dimensional application volume that corresponds to the second location (e.g., tangential to, or parallel to a tangent to, the boundary of the first three-dimensional application volume at a second reference point corresponding to (e.g., at or near) the second location (e.g., if the second location is not on the boundary, a point corresponding to a projection of the second location onto the boundary, such as an intersection point between the boundary and a line from the second location to the reference point in the first three-dimensional application volume or a line from the second location that is perpendicular to the boundary, or other second reference point), along one or more axes (e.g., along a length and/or width, or lateral axis and/or vertical axis) of the first user interface object). For example, as described with reference to FIG. 7E, an orientation of the first user interface element 7038 represented by the vector 7039 that is parallel to the plane of the first user interface element 7038 is parallel to the edge 7041 of the three-dimensional outline 7058 that encloses three-dimensional application content elements of the application user interface 7056. Automatically displaying the alert or other user interface object with a respective orientation, that is based on the orientation of a boundary of the three-dimensional application corresponding to the position at which the alert or other user interface object is displayed, improves the visibility and legibility of the alert or other user interface object.

In some embodiments, displaying the first user interface object at the first location in the three-dimensional environment includes: in accordance with a determination that the first viewpoint of the user corresponds to a first viewpoint location in the three-dimensional environment, the computer system displays (12024) the first user interface object at a first position relative to (e.g., on the first side of the boundary of) the three-dimensional application volume; and in accordance with a determination that the first viewpoint of the user corresponds to a second viewpoint location in the three-dimensional environment, wherein the second viewpoint location is different from the first viewpoint location, the computer system displays the first user interface object at a second position relative to (e.g., on the first side of the boundary of) the three-dimensional application volume, wherein the second position is different from the first position (e.g., the first location in the three-dimensional environment is selected (e.g., dynamically) based on a current viewpoint of the user). In some embodiments, if the occurrence of the first event were detected while displaying the first three-dimensional application volume in a different (e.g., second) view of the three-dimensional environment corresponding to a second viewpoint of the user that is different from the first viewpoint (e.g., and if the first criteria were met as a result of the occurrence of the first event and the second viewpoint of the user were outside of the first threshold range of a respective portion of the first three-dimensional application volume), the first user interface object would be displayed at a third location in the three-dimensional environment on the first side of the boundary of the first three-dimensional application volume (e.g., the third location being dynamically selected based on the second viewpoint of the user). For example, as described with reference to FIGS. 10A-10B, the computer system 101 updates a display location of the first user interface element 10008 and the move affordance 10006 at respective updated positions that correspond to one of eight positions (e.g., position 10014-1, position 10014-2, position 10014-3, position 10014-4, position 10014-5, position 10014-6, position 10014-7, and position 10014-8) arranged around the cylindrical application user interface 10002, based on a viewpoint of the user 7002. Dynamically selecting a position, optionally along an edge of the three-dimensional application, at which to display the alert or other user interface object relative to the three-dimensional application based on the viewpoint of the user improves the visibility and legibility of the alert or other user interface object without requiring the user to provide additional inputs or change the user's viewpoint.

In some embodiments, displaying the first user interface object at the first location in the three-dimensional environment includes: in accordance with a determination that the first viewpoint of the user corresponds to a third viewpoint location in the three-dimensional environment that is within a respective viewpoint range (e.g., distance and/or angle), the computer system displays (12026) the first user interface object at a third position relative to (e.g., on the first side of the boundary of) the three-dimensional application volume; in accordance with a determination that the first viewpoint of the user corresponds to a fourth viewpoint location in the three-dimensional environment that is different from the third viewpoint location and outside of the respective viewpoint range, the computer system displays the first user interface object at a fourth position relative to the three-dimensional application volume; and in accordance with a determination that the first viewpoint of the user corresponds to a fifth viewpoint location in the three-dimensional environment that is different from the third viewpoint location and within the respective viewpoint range, the computer system displays the first user interface object at the third position relative to the three-dimensional application volume (e.g., the first location in the three-dimensional environment is selected from a finite set of available positions on the first side of the boundary of the first three-dimensional application volume, as described herein in more detail with reference to method 15000). In some embodiments, the second location is selected from a finite set of available positions on the second side of the boundary of the first three-dimensional application volume (e.g., a different set of available positions than from which the first location is selected). For example, as described with reference to FIGS. 10A-10B, the computer system 101 updates a display location of the first user interface element 10008 and the move affordance 10006 at respective updated positions that correspond to one of eight positions (e.g., position 10014-1, position 10014-2, position 10014-3, position 10014-4, position 10014-5, position 10014-6, position 10014-7, and position 10014-8) arranged around the cylindrical application user interface 10002, based on a viewpoint of the user 7002. Dynamically selecting a position from a plurality of possible positions around the edge of the three-dimensional application at which to display the alert or other user interface object relative to the three-dimensional application based on the viewpoint of the user, improves the visibility and legibility of the alert or other user interface object without requiring the user to provide additional inputs or change the user's viewpoint.

In some embodiments, displaying the first user interface object at the first location in the three-dimensional environment on the first side of the boundary of the first three-dimensional application volume includes: in accordance with a determination that the first viewpoint of the user is at a first viewpoint position (e.g., a first elevation) relative to the first three-dimensional application volume, the computer system displays (12028) the first user interface object with a first orientation; and in accordance with a determination that the first viewpoint of the user is at a second viewpoint position (e.g., a second elevation) relative to the first three-dimensional application volume, wherein the second viewpoint position is different from the first viewpoint position, the computer system displays the first user interface object with a second orientation that is different from the first orientation. In some embodiments, the orientation of the first user interface object on the first side of the boundary is based on an orientation of the first viewpoint of the user (e.g., facing the first viewpoint of the user (e.g., normal to a vector extending from the first viewpoint of the user through a reference point in the first user interface object, such as a centroid) or rotated toward the first viewpoint of the user relative to being tangential to, or parallel to a plane tangent to, the boundary of the first three-dimensional application volume at a first reference point corresponding to (e.g., at or near) the first location). In some embodiments, displaying the first user interface object at the second location in the three-dimensional environment on the second side of the boundary of the first three-dimensional application volume includes: in accordance with a determination that the first viewpoint of the user is at the first viewpoint position relative to the first three-dimensional application volume, the computer system displays the first user interface object with a third orientation. In some embodiments, the third orientation is the same as or different from the first orientation. In accordance with a determination that the first viewpoint of the user is at the second viewpoint position relative to the first three-dimensional application volume, the computer system displays the first user interface object with a fourth orientation that is different from the third orientation. In some embodiments, the fourth orientation is the same as or different from the second orientation. In some embodiments, the orientation of the first user interface object on the second side of the boundary is based on the orientation of the first viewpoint of the user (e.g., facing the first viewpoint of the user (e.g., normal to a vector extending from the first viewpoint of the user through a reference point in the first user interface object, such as a centroid) or rotated toward the first viewpoint of the user relative to being tangential to, or parallel to a plane tangent to, the boundary of the first three-dimensional application volume at a second reference point corresponding to (e.g., at or near) the second location). For example, as described with reference to FIGS. 7C and 7K, the first user interface element 7038 is oriented based on a viewpoint of the user 7002. Automatically displaying the alert or other user interface object with a respective orientation that is based on the orientation of the user's viewpoint relative to the three-dimensional application improves the visibility and legibility of the alert or other user interface object without requiring the user to tilt or otherwise change the user's viewpoint to view the alert or other user interface object.

In some embodiments, the boundary of the first three-dimensional application volume (e.g., at a reference point corresponding to the respective location of the first user interface object, such as a point on the boundary corresponding to a projection of the respective location onto the boundary) is (12030) associated with a characteristic pitch angle (e.g., a tilt angle at which to display objects, determined based on the orientation of the boundary). In some embodiments, an object displayed at the characteristic pitch angle is parallel to (e.g., tangential to or parallel to a plane tangent to) the boundary (e.g., along a pitch axis of the object). In some embodiments, displaying the first user interface object with the first orientation (e.g., that is based on an orientation of the first viewpoint of the user and optionally also based on an orientation of a portion of the boundary of the first three-dimensional application volume that corresponds to the first location of the first user interface object) includes: in accordance with a determination that the first viewpoint of the user is associated with a first viewpoint pitch angle (e.g., a respective tilt angle at which to display objects, determined based on an elevation of the first viewpoint of the user relative to a reference plane in the three-dimensional environment or a user's head elevation relative to the horizon), the computer system displays the first user interface object with a first object pitch angle that is between the first viewpoint pitch angle and the characteristic pitch angle. In some embodiments, an object displayed at the first viewpoint pitch angle is perpendicular to a vector extending from the first viewpoint of the user (e.g., along a z-dimension, a depth dimension, and/or a radial direction), so as to directly face the viewpoint of the user. In accordance with a determination that the first viewpoint of the user is associated with a second viewpoint pitch angle that is different from the first viewpoint pitch angle, the computer system displays the first user interface object with a second object pitch angle that is between the second viewpoint pitch angle and the characteristic pitch angle and that is different from the first object pitch angle. In some embodiments, displaying the first user interface object with the second orientation (e.g., that is based on an orientation of the first viewpoint of the user and optionally also based on an orientation of a portion of the boundary of the first three-dimensional application volume that corresponds to the second location of the first user interface object) includes: in accordance with a determination that the first viewpoint of the user is associated with the first viewpoint pitch angle, the computer system displays the first user interface object with a third object pitch angle that is between the first viewpoint pitch angle and the characteristic pitch angle; and in accordance with a determination that the first viewpoint of the user is associated with the second viewpoint pitch angle, the computer system displays the first user interface object with a fourth object pitch angle that is between the second viewpoint pitch angle and the characteristic pitch angle and that is different from the third object pitch angle. In some embodiments, the first object pitch angle is the same as or different from the third object pitch angle. In some embodiments, the second object pitch angle is the same as or different from the fourth object pitch angle. For example, as described with reference to FIG. 7K, the vector 7039 representing an orientation of the first user interface element 7038 is oriented at an intermediate angle between being perpendicular to the viewpoint of the user 7002 (e.g., denoted by the perpendicular line 7100) and being parallel to an edge 7102 of the application volume 7104. Automatically displaying the alert or other user interface object with a respective pitch angle that is based on the pitch angle of the viewpoint of the user improves the visibility and legibility of the alert or other user interface object.

In some embodiments, the boundary of the first three-dimensional application volume (e.g., at least within a region of the boundary corresponding to the respective location (e.g., the first or second location) at which the first user interface object is displayed) is (12032) curved (e.g., a curved surface, such as a cylindrical or spherical surface). For example, as described with reference to FIG. 7C, the three-dimensional outline 7034 that encloses three-dimensional application content elements of the application user interface 7030 is cylindrical. Displaying the three-dimensional application as having a curved edge provides visual feedback about the three-dimensional application by creating a rounded boundary without visually obscuring or detracting from the surrounding three-dimensional environment.

In some embodiments, the boundary of the first three-dimensional application volume (e.g., at least within a region of the boundary corresponding to the respective location (e.g., the first or second location) at which the first user interface object is displayed) is (12034) flat (e.g., a flat surface, such as a rectangular or prismatic or other polyhedral surface). For example, as described with reference to FIG. 7E, the three-dimensional outline 7058 that encloses three-dimensional application content elements of the application user interface 7056 is a rectangular prism. Displaying the three-dimensional application as having a straight edge provides visual feedback about the three-dimensional application by creating a flat boundary without visually obscuring or detracting from the surrounding three-dimensional environment.

In some embodiments, while the first user interface object is displayed at a respective location in the three-dimensional environment that is within the boundary of the first three-dimensional application volume (e.g., on the second side of the boundary), the computer system visually deemphasizes (12036) one or more portions of the first three-dimensional application volume (e.g., that include content of the first application) that correspond to the respective location. For example, as described with reference to FIG. 7D, the computer system 101 changes one or more visual properties of the application content elements of the application user interface 7030 that spatially conflict with the first user interface element 7038 to increase a visibility of the first user interface element 7038 from the viewpoint of the user 7002. Automatically visually deemphasizing portions of the three-dimensional application that overlap with the alert or other user interface object improves the visibility and legibility of the alert or other user interface object without requiring additional user input.

In some embodiments, the first user interface object at least partially obscures (12038) (e.g., replaces, is displayed in front of, and/or is overlaid on) content of the first application that is included in (e.g., was displayed in) the first three-dimensional application volume. For example, as described with reference to FIG. 7D, the computer system 101 changes one or more visual properties of the application content elements of the application user interface 7030 that spatially conflict with the first user interface element 7038, to increase a visibility of the first user interface element 7038 from the viewpoint of the user 7002 by allowing the first user interface element 7038 to at least partially obscure one or more application content elements of the application user interface 7030. Displaying the alert or other user interface object in front of and/or on top of a portion of the three-dimensional application visually obscures the portion of the three-dimensional application, thereby improving the visibility and legibility of the alert or other user interface object.

In some embodiments, displaying the first user interface object includes (12040): in accordance with a determination that the first viewpoint of the user is a first distance (e.g., in the depth dimension and/or one or more other directions) from (e.g., the boundary of) the first three-dimensional application volume, the computer system displays the first user interface object with a first scale relative to a size of the first three-dimensional application volume; and in accordance with a determination that the first viewpoint of the user is a second distance (e.g., in the depth dimension and/or one or more other directions) from (e.g., the boundary of) the first three-dimensional application volume, the computer system displays the first user interface object with a second scale relative to the size of the first three-dimensional application volume. In some embodiments, the second distance is different from the first distance, and the second scale is different from the first scale (e.g., as described herein in more detail with reference to method 14000). For example, if the second distance is greater than the first distance, the second scale is larger, relative to the size of the first three-dimensional application volume, than the first scale. Stated another way, if the scale of the first user interface object relative to the first three-dimensional application volume were maintained, when the viewpoint of the user is further from the first three-dimensional application volume, due to perspective, the first three-dimensional application volume and the first user interface object would both appear smaller (e.g., by analogous degrees) to the user than when the viewpoint of the user is closer to the first three-dimensional application volume. In contrast, where the scale of the first user interface object is increased relative to the first three-dimensional application volume when the viewpoint of the user is further from the first three-dimensional application volume, the first three-dimensional application volume appears smaller to the user when the viewpoint of the user is further from the first three-dimensional application volume, whereas the first user interface object will not appear to the user to be reduced in size to an analogous degree as the first three-dimensional application volume (e.g., the first user interface object optionally appears to be reduced in size by a lesser degree, unchanged in size, or increased in size, depending on the amount of increase in scale of the first user interface object relative to the first three-dimensional application volume). For example, as described with reference to FIG. 7I, the computer system 101 enlarges the first user interface element 7038 in the top view 7082-3 to maintain legibility of the information displayed thereon when the distance the application user interface element 7038 and the viewpoint of the user 7002 increases. Automatically scaling a size of the alert or other user interface object based on a distance between the viewpoint of the user and the alert or other user interface object improves the visibility and legibility of the alert or other user interface object such that it is displayed with a size that is visible from the user's current viewpoint.

In some embodiments, the first distance and the second distance are within a respective range of distances (e.g., a range of distances for which the scale of the first user interface object relative to the size of the first three-dimensional application volume is dynamically adjusted based on distance of the first viewpoint of the user from the first three-dimensional application volume); and displaying the first user interface object includes (12042): in accordance with a determination that the first viewpoint of the user is a third distance (e.g., in the depth dimension and/or one or more other directions) from (e.g., the boundary of) the first three-dimensional application volume, the computer system displays the first user interface object with a third scale relative to the size of the first three-dimensional application volume; and in accordance with a determination that the first viewpoint of the user is a fourth distance (e.g., in the depth dimension and/or one or more other directions) from (e.g., the boundary of) the first three-dimensional application volume, the computer system displays the first user interface object with the third scale relative to the size of the first three-dimensional application volume. In some embodiments, the third distance and the fourth distance are outside of the respective range of distances (e.g., and thus different from the first distance and from the second distance), and the third scale is different from the first scale and from the second scale. In some embodiments, the third scale is a first scale limit, such as a maximum scale or a minimum scale, for the first user interface object, and the first user interface object is displayed at the first scale limit for distances between the first viewpoint of the user and the first three-dimensional application volume that are greater than a upper threshold distance or less than a lower threshold distance, respectively. In some embodiments, the scale of the first user interface object is subject to one or more scale limits (e.g., at least the first scale limit and optionally at least a second scale limit such as both minimum and maximum scales). Accordingly, in some embodiments, for fifth and sixth distances that are outside of the respective range of distances on an opposite side from the third and fourth distances (e.g., where the third and fourth distances are larger than the respective range of distances, and the fifth and sixth distances are smaller than the respective range of distances, or vice versa), the first user interface object has a scale relative to the size of the first three-dimensional application volume that is different from the third scale whether the first viewpoint of the user is the fifth distance or the sixth distance from the first three-dimensional application volume. For example, as described with reference to FIG. 7I, the first user interface element 7038 reaches a maximum size in the top view 7082-3, and the first user interface element 7038 remains at the same size in the top view 7082-4 even though the application user interface 7030 is further from the viewpoint of the user 7002 in the top view 7082-4 than in the top view 7082-3. The first user interface element 7038 reaches a minimum size in the top view 7082-5, and the first user interface element 7038 remains at the same size even though the application user interface 7030 is closer to the viewpoint of the user 7002 in the top view 7082-6 than in the top view 7082-5. Limiting a size of the alert or other user interface object up to a maximum and/or minimum size, where the size of the alert or other user interface object is based on a distance between the viewpoint of the user and the alert or other user interface object, improves the visibility and legibility of the alert or other user interface object without visually obscuring a large portion of the three-dimensional environment (e.g., by being displayed with a size beyond the maximum size) and/or without being difficult to view (e.g., by being displayed with a size smaller than the minimum size).

In some embodiments, the computer system displays (12044), in the first user interface object via the one or more display generation components, one or more controls for performing respective corresponding operations with respect to the first user interface object and/or the first application (e.g., a control to dismiss the first user interface object, a control to perform a respective operation of the first application (e.g., to view or compose a message using a messaging application; to stop a timer using a clock application, to accept or decline an incoming call using a telephony application), and/or other controls). In some embodiments, the computer system detects an input directed to a respective control of the one or more controls and, in response, performs an operation corresponding to the respective control. For example, as described with reference to FIG. 7C, a first content item 7040 and/or a second content item 7042 of the first user interface element 7038 include one or more selectable user interface elements (e.g., buttons, checkboxes, and/or other elements) for performing respective operations (e.g., dismissing the first user interface element 7038, accepting an incoming communication request, and/or other operations). Displaying one or more control options in the alert or other user interface object provides additional control options for the user and reduces the amount of time and number of inputs needed to perform operations associated with the alert or other user interface object.

In some embodiments, in conjunction with (e.g., concurrently with, before, and/or after) displaying the first user interface object, the computer system visually deemphasizes (12046) the first three-dimensional application volume (e.g., relative to an appearance of the first three-dimensional application volume before the first user interface object is displayed). In some embodiments, in addition to visually deemphasizing the first three-dimensional application volume as a whole, one or more portions of the first three-dimensional application volume that correspond to where the first user interface object is displayed are further visually deemphasized relative to other portions of the first three-dimensional application volume that do not correspond to where the first user interface object is displayed. For example, as described with reference to FIGS. 7B-7C, application user interface 7030 is visually deemphasized relative to the first user interface element 7038 (e.g., by increasing a degree of blurring, decreasing a brightness, decreasing a saturation, decreasing visual intensity, decreasing a contrast, decreasing an opacity, and/or other visual deemphasis) due to the computer system 101 displaying the first user interface element 7038. Reducing a visual prominence of the three-dimensional application volume while displaying the alert or other user interface object makes it easier for the user to view the alert or other user interface object without being distracted or having the alert or other user interface object obscured by the three-dimensional application volume.

In some embodiments, the computer system displays (12048), via the one or more display generation components, a second view of the three-dimensional environment. In some embodiments, the second view of the three-dimensional environment corresponds to the first viewpoint of the user, and includes a second three-dimensional application volume (e.g., an application window and/or application content that is bounded by a three-dimensional volume with a finite boundary (e.g., visible boundary, or invisible boundary) in one or more dimensions (e.g., in the horizontal dimension, in the vertical dimension, and/or in the depth dimension; and/or in the radial dimension and/or in the azimuthal dimension), such as a three-dimensional volumetric window of a cylindrical shape, a rectangular prism shape, a spherical shape, and/or other volumetric shapes) that corresponds to a second application (e.g., a system application, such as an application or experience launcher application, a system control application, a settings application, and/or an application switcher application, or a user-installed application, such as a communication application, a telephony application, a gaming application, an exercise application, a meditation application, or other types of applications). In some embodiments, while displaying the second three-dimensional application volume in the second view of the three-dimensional environment, the computer system detects occurrence of a second event (e.g., an event associated with the second application, a system-generated event, a change in contextual conditions, and/or one or more user inputs that are associated with the second application such as an input or event that causes generation of a pop-up alert, new content, new window, modal window, banner, and/or navigation to another user interface of the second application); and in response to detecting the occurrence of the second event, the computer system displays, via the one or more display generation components, a second user interface object (e.g., an alert, a system user interface object, such as a notification, a modal window, a banner, a pop-up, a user interface object that requires user input in order to be dismissed) at a respective location in the three-dimensional environment (e.g., with a respective spatial relationship to a viewport of the user into the three-dimensional environment) without regard to whether the first viewpoint of the user is outside of or within the first threshold range of a respective portion of the second three-dimensional application volume (e.g., the second user interface object is viewpoint-locked or world-locked, without being dynamically positioned based on the relationship of the first viewpoint of the user to the second three-dimensional application volume). In some embodiments, displaying the second user interface object is performed in accordance with a determination that the first criteria are met as a result of the occurrence of the second event. In some embodiments, alternatively to the behavior described in operations 12002-12010 of method 12000, the first user interface object corresponding to the first three-dimensional application volume exhibits the behavior described herein for the second user interface object corresponding to the second three-dimensional application volume. For example, as described with reference to FIGS. 7L-7O, in accordance with the first user interface element 7038 being a viewpoint-locked virtual object, and in response to detecting the rightward movement of the viewpoint of the user 7002, the computer system 101 maintains the display of the first user interface element 7038 at the same position within (e.g., relative to) the viewport of the user 7002 without regard to whether the viewpoint of the user is greater or less than the threshold distance Dₜₕ. Similarly, in accordance with the first user interface element 7038 being an environment-locked virtual object, the computer system 101 maintains display of the first user interface element 7038 at the same location within the three-dimensional environment, such that the first user interface element 7038 appears to have shifted to the left in the viewport illustrated in FIG. 7O as a result of the rightward movement of the viewpoint of the user 7002 without regard to whether the viewpoint of the user is greater or less than the threshold distance Dₜₕ. Displaying an alert or other user interface object in front of the user within the three-dimensional environment regardless of a position of the user's viewpoint relative to a three-dimensional application volume provides improved visual feedback for the user.

In some embodiments, the computer system displays (12050), via the one or more display generation components, a third view of the three-dimensional environment. In some embodiments, the third view of the three-dimensional environment corresponds to the first viewpoint of the user, and includes a third three-dimensional application volume (e.g., an application window and/or application content that is bounded by a three-dimensional volume with a finite boundary (e.g., visible boundary, or invisible boundary) in one or more dimensions (e.g., in the horizontal dimension, in the vertical dimension, and/or in the depth dimension; and/or in the radial dimension and/or in the azimuthal dimension), such as a three-dimensional volumetric window of a cylindrical shape, a rectangular prism shape, a spherical shape, and/or other volumetric shapes) that corresponds to a third application (e.g., a system application, such as an application or experience launcher application, a system control application, a settings application, and/or an application switcher application, or a user-installed application, such as a communication application, a telephony application, a gaming application, an exercise application, a meditation application, or other types of applications). In some embodiments, while displaying the third three-dimensional application volume in the third view of the three-dimensional environment, the computer system detects occurrence of a third event (e.g., an event associated with the third application, a system-generated event, a change in contextual conditions, and/or one or more user inputs that are associated with the third application such as an input or event that causes generation of a pop-up alert, new content, new window, modal window, banner, and/or navigation to another user interface of the third application); and in response to detecting the occurrence of the third event, the computer system displays, via the one or more display generation components, a third user interface object (e.g., an alert, a system user interface object, such as a notification, a modal window, a banner, a pop-up, a user interface object that requires user input in order to be dismissed) at a respective location on or within the third three-dimensional application volume (e.g., with a respective spatial relationship to a viewport of the user into the three-dimensional environment) without regard to whether the first viewpoint of the user is outside of or within the first threshold range of a respective portion of the third three-dimensional application volume (e.g., the third user interface object is displayed at a characteristic position within the third three-dimensional application volume, such as a centroid, without being dynamically positioned based on the relationship of the first viewpoint of the user to the third three-dimensional application volume). In some embodiments, displaying the third user interface object is performed in accordance with a determination that the first criteria are met as a result of the occurrence of the third event. In some embodiments, alternatively to the behavior described in operations 12002-12010 of method 12000, the first user interface object corresponding to the first three-dimensional application volume exhibits the behavior described herein for the third user interface object corresponding to the third three-dimensional application volume. For example, as described with reference to FIG. 7F, the first user interface element 7038 is displayed at a characteristic portion (e.g., at a centroid of the three-dimensional application volume, at a center of the three-dimensional application, and/or at a threshold distance from the outline 7034) within the three-dimensional application volume of the application user interface 7030, regardless of the distance, in the three-dimensional environment, between the application user interface 7030 and the viewpoint of the user 7002. Displaying an alert or other user interface object within a three-dimensional application volume regardless of a position of the user's viewpoint relative to the three-dimensional application volume provides improved visual feedback for the user by displaying the alert or other user interface object at a same relative position within the three-dimensional application volume without requiring the user to search for the alert or other user interface object.

In some embodiments, aspects/operations of methods 13000, 14000, 15000, and 16000 may be interchanged, substituted, and/or added between these methods. For brevity, these details are not repeated here.

FIGS. 13A-13G are flow diagrams of an exemplary method 13000 for displaying visual feedback when attention of the user is directed toward a boundary of a volumetric application, in accordance with some embodiments. In some embodiments, method 13000 is performed at a computer system (e.g., computer system 101 in FIG. 1) that is in communication with one or more display generation components (e.g., a head-mounted display (HMD), a heads-up display, a display, a touchscreen, a projector, or other types of display) (e.g., display generation component 120 in FIGS. 1A, 3A, and 4, or the display generation component 7100a in FIGS. 8A-8X), and one or more input devices (e.g., sensors and hardware controls for detecting user inputs, one or more optical sensors such as cameras (e.g., color sensors, infrared sensors, structured light scanners, and/or other depth-sensing cameras) that points downward at a user's hand or a camera that points forward from the user's head, eye-tracking devices, touch sensors, touch-sensitive surfaces, proximity sensors, motion sensors, buttons, crowns, joysticks, user-held and/or user-worn controllers, and/or other sensors and input devices) (e.g., one or more input devices 125 and/or one or more sensors 190 in FIG. 1A, or sensors 7101a-7101c and/or the digital crown 703 in FIGS. 8A-8X). In some embodiments, the method 13000 is governed by instructions that are stored in a non-transitory (or transitory) computer-readable storage medium and that are executed by one or more processors of a computer system, such as the one or more processors 202 of computer system 101 (e.g., control 110 in FIG. 1A). Some operations in method 13000 are, optionally, combined and/or the order of some operations is, optionally, changed.

The computer system displays (13002), via the one or more display generation components, a first view of a three-dimensional environment. The first view of the three-dimensional environment includes first application content (e.g., an application window and/or application content that is bounded by a three-dimensional volume with a finite boundary (e.g., visible or invisible boundary) in one or more dimensions (e.g., in the horizontal dimension, in the vertical dimension, and/or in the depth dimension; and/or in the radial dimension and/or in the azimuthal dimension), such as a three-dimensional volumetric window of a cylindrical shape, a rectangular prism shape, a spherical shape, and/or other volumetric shapes) that corresponds to a first application (e.g., a system application, such as an application or experience launcher application, a system control application, a settings application, and/or an application switcher application, or a user-installed application, such as a communication application, a telephony application, a gaming application, an exercise application, a meditation application, or other types of applications).

While displaying the first application content that corresponds to the first application in the first view of the three-dimensional environment, the computer system detects (13004), via the one or more input devices, a first change in position of attention of a user (e.g., a gaze of a user, a pointer input, a pointing gesture of the user, and/or other types of user input that indicates the location of the user's attention) relative to the first application content.

In response to detecting (13006) the first change in position of the attention of the user relative to the first application content: in accordance with a determination that the attention of the user has moved closer to a first portion of a first boundary (e.g., an invisible or reduced visibility boundary of a three-dimensional volume, a platform, a container, or a two-dimensional surface or window) that confines (e.g., in accordance with the instructions of the first application and/or the operating system) the first application content in two or more dimensions (e.g., horizontal dimension, vertical dimension, and/or depth dimension) than to a second portion of the first boundary that is adjacent to the first portion of the first boundary, the computer system visually emphasizes (13008) (e.g., highlighting with increased color, brightness, opacity, or making visible if previously not visible) the first portion of the first boundary relative to the second portion of the first boundary (e.g., the portion of the boundary surface of the application volume and/or support platform that is closer to the location of the user's attention is highlighted and/or revealed relative to the portions of the boundary surfaces of the application volume and/or support platform that are farther away from the location of the user's attention).

In response to detecting (13006) the first change in position of the attention of the user relative to the first application content: in accordance with a determination that the attention of the user has moved closer to the second portion of the first boundary than the first portion of the first boundary, the computer system visually emphasizes (13010) (e.g., highlighting with increased color, brightness, opacity, or making visible if previously not visible) the second portion of the first boundary relative to the first portion of the first boundary (e.g., the portion of the boundary surface of the application volume and/or support platform that is closer to the location of the user's attention is highlighted and/or revealed relative to the portions of the boundary surfaces of the application volume and/or support platform that are farther away from the location of the user's attention).

In some embodiments, when the first portion of the first boundary is visually emphasized relative to the second portion of the first boundary, the first portion of the boundary is visible and the second portion of the boundary is not visible even though the regions of the three-dimensional environment occupied by the first portion and the second portion of the first boundary are both within the field of view of the user and are not blocked by other objects in the currently displayed view of the three-dimensional environment. Similarly, when the second portion of the first boundary is visually emphasized relative to the first portion of the first boundary, the second portion of the first boundary is visible and the first portion of the boundary is not visible even though the regions of the three-dimensional environment occupied by the first portion and the second portion of the first boundary are both within the field of view of the user and are not blocked by other objects in the currently displayed view of the three-dimensional environment. In some embodiments, the first and/or second portion of the first boundary includes a location designated for a resize affordance, a close affordance, or a move affordance of the application volume enclosing the first application content (e.g., when the first location is in the bottom region or corner region of the application volume), and at least a portion of the boundary that is not designated for any affordances. In some embodiments, the first and/or second portion of the first boundary does not include a location designated for a resize affordance, a close affordance, or a move affordance of the application volume enclosing the first application content (e.g., when the first location is not in the bottom region or corner region of the application volume). In some embodiments, the first application content extends to (e.g., fills) the first boundary (e.g., in two or more dimensions). In some embodiments, the first application content does not extend to the first boundary (e.g., there is empty space between the first application content and the first boundary in two or more dimensions). In some embodiments, whether one portion of the first boundary is visually emphasized relative to another portion of the first boundary is based on whether the first application content reaches or extends to the first boundary, as described in more detail herein with reference to operation 13036.

As described herein, method 13000 provides a system for displaying application content in a three-dimensional environment such that, in response to detecting the user's attention being directed to and/or near a portion of the application content, the system displays visual emphasis of a boundary of the application content to provide the user with improved visual feedback that the user's attention is detected near the application content. For example, as described with reference to FIGS. 8A-8B, the computer system 101 visually emphasizes the first portion 8020 (e.g., a front right quadrant) of the baseplate 8021 and forgoes visually emphasizing (and/or visually deemphasizes) other portions (e.g., a front left quadrant, and/or a back half) of the baseplate 8021 in accordance with a determination that the attention 8016 is directed toward a region closer to the first portion 8020 than a second portion (e.g., adjacent to the first portion 8020). Automatically displaying visual emphasis of at least a portion of the boundary of the application content in response to detecting the user's attention directed to the application content improves the visibility of the application content and defines the boundary of the application content such that the user is aware of where the application content begins and/or ends without requiring additional user inputs for the user to explore the application content within the three-dimensional environment. Additionally, visually emphasizing a portion of a boundary relative to another portion of the boundary based on the user's attention moving closer to the portion of the boundary reduces the number of inputs and amount of time needed for the user to locate one or more affordances that perform different operations on the application user interface without displaying additional controls.

In some embodiments, detecting the first change in position of the attention of the user relative to the first application content includes (13012) detecting that the attention of the user has moved to a respective location in the three-dimensional environment that meets first criteria (e.g., boundary-reveal criteria, and/or boundary-highlight criteria). In some embodiments, the first criteria require that the respective location is within a first threshold range of the first boundary in order for the first criteria to be met. In some embodiments, the first criteria further require that the first application content does not reach the first boundary of the application volume that encloses the first application content in two or more dimensions in order for the first criteria to be met. In some embodiments, if the attention of the user moves to a respective location that does not meet the first criteria (e.g., is not within the first threshold range of the first boundary), the first portion of the first boundary is not visually emphasized relative to the second portion, and the second portion of the first boundary is not visually emphasized relative to the first portion (e.g., and in some embodiments no portion of the first boundary is visually emphasized relative to another portion of the first boundary). In some embodiments, the respective location can be a location within the boundary of the application volume enclosing the first application content, or a location outside of the boundary of the application volume but within a threshold distance of the boundary of the application volume of the first application. In some embodiments, the first criteria require that the first application content does not reach the first boundary of the application volume that encloses the first application content in the two or more dimensions, and that there is a gap or unoccupied space between the first application content and the first boundary of the application volume, in order for the first criteria to be met. In some embodiments, the first criteria require that the first boundary is not made discernable to a user because the first application content does not fill the entirety of the application volume, in order for the first criteria to be met. For example, as described with reference to FIG. 8A, the computer system 101 forgoes displaying the boundary of the three-dimensional application content in response to detecting that the attention 8016 of the user 7002 is directed toward a portion of the three-dimensional application content that is more than a threshold distance from a boundary of the three-dimensional application content. In contrast, as described with reference to FIG. 8B, the computer system 101 visually emphasizes the first portion 8020 in accordance with a determination that the attention 8016 is directed toward a region closer to the first portion 8020 (e.g., within the threshold distance from the boundary). Visually emphasizing a portion of a boundary relative to another portion of the boundary in accordance with the user's attention moving within a threshold distance of the portion of the boundary reduces the number of inputs and amount of time needed for the user to locate one or more affordances that perform different operations on the application user interface without displaying additional controls.

In some embodiments, the first portion of the first boundary is (13014) a portion of a respective two-dimensional surface (e.g., that confines the first application content in one or more dimensions), and the second portion of the first boundary is a different portion of the respective two-dimensional surface (e.g., the first portion and the second portion are different portions of the same surface that confines the first application content). For example, as described with reference to FIGS. 8E-8F, the first portion 8020 of the baseplate 8021 is a two-dimensional surface, and the second portion 8036 of the baseplate 8021 is also a two-dimensional surface. Visually emphasizing a portion of a boundary that represents a two-dimensional surface in accordance with the user's attention moving closer to the portion of the boundary provides visual feedback that confines the three-dimensional application content within the boundary set along the two-dimensional surface.

In some embodiments, in response to detecting the first change in position of the attention of the user relative to the first application content: in accordance with a determination that the attention of the user has moved closer to a respective portion (e.g., the first portion or the second portion) of the first boundary than to one or more other portions of the first boundary, the computer system visually emphasizes (13016) the respective portion of the first boundary relative to the one or more other portions of the first boundary. In some embodiments, in response to detecting the first change in position of the attention of the user relative to the first application content, in accordance with a determination that the attention of the user has moved further from the respective portion (e.g., the first portion or the second portion) of the first boundary, the computer system visually deemphasizes the respective portion of the first boundary (e.g., relative to an appearance of the respective portion of the first boundary prior to detecting the firs change in position of the attention of the user relative to the first application content). For example, as described with reference to FIG. 8C, the computer system 101 further visually emphasizes an edge 8026 of the first portion 8020 (e.g., represented by the three crosses) based on the attention 8016 of the user having moved closer to the edge 8026 than to other portions of the first portion 8020. Displaying a greater amount of visual emphasis on a portion of a boundary to which the user is gazing relative to other portions of the boundary that are visually emphasized to a lesser degree reduces the number of inputs and amount of time needed for the user to locate one or more controls that are available while the user is gazing at the respective portion of the boundary.

In some embodiments, in response to detecting the first change in position of the attention of the user relative to the first application content: the computer system displays (13018) one or more portions of (e.g., a respective face of) the first boundary that extend in a first dimension and a second dimension without displaying one or more portions (e.g., any portion) of the first boundary that extend in a third dimension that is different from the first dimension and from the second dimension (e.g., the first portion of the first boundary and the second portion of the first boundary are both portions of the same two-dimensional face of the first boundary). For example, where the first boundary is a three-dimensional boundary that confines the first application content in three-dimensions, one or more portions of a respective face, such as a bottom face (sometimes called a baseplate) that extends in lateral and depth dimensions) of the first boundary are displayed in response to detecting a change in position of the attention of the user without displaying portions of one or more sides (e.g., that extend at least partially in a vertical dimension) and/or a top of the first boundary (e.g., that is separated from the respective face in the vertical dimension). For example, as described with reference to FIGS. 8E-8F, the computer system 101 displays the first portion 8020 or the second portion 8036 of the baseplate 8021 without displaying one or more sides of the cylindrical application user interface 8002. Visually emphasizing a portion of a boundary that represents a bottom surface of the three-dimensional application content, without displaying boundaries along one or more side surfaces of the application content, provides visual feedback indicating the bottom surface without visually obscuring the application content.

In some embodiments, while visually emphasizing a respective portion (e.g., the first portion or the second portion) of the first boundary (e.g., relative to a different portion of the first boundary), the computer system detects (13020) a second change in position of the attention of the user relative to the first application content; and in response to detecting the second change in position of the attention of the user relative to the first application content: in accordance with a determination that the attention of the user has moved closer to a third portion of the first boundary (e.g., that is adjacent to the respective portion of the first boundary) than to the respective portion of the first boundary: the computer system ceases to visually emphasize the respective portion of the first boundary, and visually emphasizes the third portion of the first boundary relative to the respective portion of the first boundary. For example, if the first portion of the first boundary is visually emphasized relative to the second portion of the first boundary because the attention of the user is closer to the first portion than to the second portion, and the attention of the user moves closer to the second portion than to the first portion, the computer system ceases to visually emphasize the first portion relative to the second portion, and instead visually emphasizes the second portion relative to the first portion. In another example, if the first portion of the first boundary is visually emphasized relative to the second portion of the first boundary and a third portion of the first boundary (e.g., different from the second portion, such as adjacent to and on a different side of the first portion from the second portion) because the attention of the user is closer to the first portion than to the second portion or the third portion, and the attention of the user moves closer to the third portion than to the first portion or the second portion, the computer system ceases to visually emphasize the first portion relative to the second and third portions, and instead visually emphasizes the third portion relative to the first and second portions. In some embodiments, in accordance with a determination that the attention of the user has moved closer to a fourth portion of the first boundary (e.g., that is adjacent to the respective portion of the first boundary and different from the third portion of the first boundary) than to the respective portion of the first boundary, the computer system ceases to visually emphasize the respective portion of the first boundary, and visually emphasizes the fourth portion of the first boundary relative to the respective portion of the first boundary. For example, as described with reference to FIGS. 8E-8F, in response to detecting that the attention 8016 of the user 7002 is directed toward an edge of a second portion 8036 of the boundary of the three-dimensional application content, the computer system 101 visually emphasizes the second portion 8036 of the baseplate 8021 and displays the resize affordance 8024 to the left of the second portion 8036, and forgoes visually emphasizing the first portion 8020 of the baseplate 8021 in accordance with a determination that the attention 8016 is directed toward a region closer to the second portion 8036 than the first portion 8020. Updating display of the visual emphasis to a different respective portion of a boundary in accordance with the user's attention moving from a first portion of the boundary to the respective portion of the boundary reduces the number of inputs and amount of time needed for the user to locate one or more affordances, even as the user's attention moves to different portions of the boundary, that perform different operations on the application user interface without displaying additional controls.

In some embodiments, detecting the first change in position of the attention of the user relative to the first application content includes (13022) detecting a change in position of a gaze of the user relative to the first application content. For example, as described with reference to FIG. 8C, based on the attention 8016 of the user 7002 moving to a boundary of the first portion 8020, computer system 101 further visually emphasizes an edge 8026 of the first portion 8020 (e.g., represented by the three crosses). Changing display of the visual emphasis to a different respective portion of a boundary in accordance with the user's gaze moving to the respective portion of the boundary reduces the number of inputs and amount of time needed for the user to locate one or more affordances, even as the user's gaze moves to different portions of the boundary, that perform different operations on the application user interface without displaying additional controls.

In some embodiments, detecting the first change in position of the attention of the user relative to the first application content includes (13024) detecting movement (e.g., a change in position) of a viewpoint of the user relative to the first application content. For example, as described with reference to FIGS. 8U and 8V, in response to detecting the movement of the viewpoint of the user 7002 relative to the application user interface 8002 and detecting that the attention 8016 of the user is directed to an edge of the first portion 8094, the computer system 101 visually emphasizes the edge of the first portion 8094. Changing display of the visual emphasis to a different respective portion of a boundary in accordance with the user's viewpoint moving relative to the application content reduces the number of inputs and amount of time needed for the user to locate one or more affordances, even as the user's viewpoint moves to different portions of the application content, that perform different operations on the application user interface without displaying additional controls.

In some embodiments, the first portion of the first boundary is (13026) a portion of a first surface of the first boundary, and the second portion of the first boundary is a portion of a second surface of the first boundary (e.g., the first surface and the second surface are the same or different surfaces or faces of the first boundary). For example, as described with reference to FIGS. 8E-8F, the computer system 101 displays the first portion 8020 or the second portion 8036 of the baseplate 8021 in response to detecting that the attention 8016 of the user is directed to respective locations near a boundary of the application user interface 8002. Displaying a respective portion of a respective surface that corresponds to a boundary of the application content in accordance with the user's attention moving to different respective portions of the boundary provides visual feedback that confines the three-dimensional application content within the boundary set along the respective surfaces.

In some embodiments, visually emphasizing a respective portion (e.g., the first portion or the second portion) of the first boundary includes (13028) displaying a region of the respective portion that is closer to an edge of the first boundary with greater visual emphasis than a region of the respective portion that is further from the edge of the first boundary. In some embodiments, the edge of the first boundary within the respective portion is visually distinguished from other regions of the respective portion (e.g., by highlighting, brightening, outlining, increasing in line thickness, and/or other visual effect). For example, as described with reference to FIG. 8C, the computer system 101 further visually emphasizes an edge 8026 of the first portion 8020 (e.g., represented by the three crosses. Displaying a greater visual emphasis at the edges of the surface that corresponds to a boundary of the application content than the portions of the surface that are farther from the edges of the surface provides visual feedback about the surface edges without visually occluding the application content that appears behind the surface portions that are farther from the edges.

In some embodiments, in response to detecting the first change in position of the attention of the user relative to the first application content, the computer system displays (13030) at least one of the first portion of the first boundary and the second portion of the first boundary without displaying one or more additional portions of the first boundary that are different from the first portion and from the second portion (e.g., in conjunction with visually emphasizing the first portion of the first boundary relative to the second portion of the first boundary or the second portion of the first boundary relative to the first portion of the first boundary, depending on whether the user's attention has moved closer to the first portion or to the second portion, respectively); and while displaying the at least one of the first portion of the first boundary and the second portion of the first boundary without displaying the one or more additional portions of the first boundary, the computer system detects a user input corresponding to a request to resize the first application content (e.g., an air pinch gesture, an air pinch and drag gesture, or other input, in some embodiments directed to a resize affordance). In some embodiments, in response to detecting the user input corresponding to the request to resize the first application content, the computer system displays the one or more additional portions of the first boundary. For example, as described with reference to FIG. 8G, in response to detecting the air pinch gesture 8500-1 while the attention 8016 of the user 7002 is directed toward the resize affordance 8024, the computer system 101 displays additional portions of the baseplate 8021 to visually indicate that the application user interface 8002 is receiving a resizing input and to visually indicate a spatial extent of the three-dimensional application content of the application user interface 8002 to the user 7002. Displaying additional portions of the boundary of the application content while the application content is being resized provides visual feedback to the user about how the resizing inputs are changing the size, as indicated by a change in location of the boundary, of the application content.

In some embodiments, in response to detecting the first change in position of the attention of the user relative to the first application content, the computer system displays (13032) a first extent of the first boundary (e.g., including the at least one of the first portion of the first boundary and the second portion of the first boundary and not including the one or more additional portions of the first boundary); and in response to detecting the user input corresponding to the request to resize the first application content, the computer system displays a second extent of the first boundary. In some embodiments, the second extent is greater than the first extent (e.g., displaying the at least one of the first portion and the second portion of the first boundary concurrently with the one or more additional portions of the first boundary that were not displayed prior to detecting the resizing input, the one or more additional portions optionally being visually deemphasized relative to the at least one of the first portion and the second portion, or optionally with a same appearance without any relative visual emphasis or deemphasis). For example, as described with reference to FIGS. 8B and 8G, in response to detecting the air pinch gesture 8500-1 while the attention 8016 of the user 7002 is directed toward the resize affordance 8024, the computer system 101 displays additional portions of the baseplate 8021 to visually indicate that the application user interface 8002 is receiving a resizing input and to visually indicate a spatial extent of the three-dimensional application content of the application user interface 8002 to the user 7002. In contrast, in FIG. 8B, in response to detecting that the attention 8016 of the user 7002 is directed toward a first portion 8020 of the boundary of the three-dimensional application content, the computer system 101 displays only the first portion 8020 but not the second portion 8036 of a baseplate 8021 (e.g., in FIG. 8B, less of the baseplate 8021 is displayed than in FIG. 8G). Displaying additional portions of the boundary of the application content while the application content is being resized relative to the portion of the boundary that is displayed while detecting the user's attention is directed to the application content without resizing the content, provides visual feedback to the user about how the resizing inputs are changing the size, as indicated by a change in location of the boundary, of the application content.

In some embodiments, the computer system displays (13034), via the one or more display generation components, a second view of a three-dimensional environment. In some embodiments, the second view of the three-dimensional environment includes second application content that corresponds to a second application. In some embodiments, while displaying the second application content that corresponds to the second application in the second view of the three-dimensional environment, the computer system detects, via the one or more input devices, that the attention of the user has moved relative to the second application content; and in response to detecting that the attention of the user has moved relative to the second application content: in accordance with a determination that the second application content does not extend to (e.g., does not fill, in two or more dimensions) a second boundary that confines the second application content in two or more dimensions and that the attention of the user has moved closer to a first portion of the second boundary than to a second portion of the second boundary that is adjacent to the first portion of the second boundary, the computer system visually emphasizes the first portion of the second boundary relative to the second portion of the second boundary. In some embodiments, if the second application content does not extend to the second boundary and the attention of the user has moved closer to the second portion of the second boundary than to the first portion of the second boundary, the computer system visually emphasizes the second portion of the second boundary relative to the first portion of the second boundary. In accordance with a determination that the second application content extends to (e.g., fills, in two or more dimensions) the second boundary, the computer system forgoes visually emphasizing the first portion of the second boundary relative to the second portion of the second boundary (e.g., without regard to where on the second boundary the attention of the user has moved, for example without regard to whether the attention of the user has moved closer to the first portion of the second boundary than to the second portion of the second boundary, or closer to the second portion of the second boundary than to the first portion of the second boundary). In some embodiments, the first boundary that confines the first application content corresponding to the first application exhibits analogous behavior to the second boundary that confines the second application corresponding to the second application (e.g., different portions of the first boundary are visually emphasized based on where the attention of the user has moved on the first boundary if the first application content does not extend (e.g., in two or more dimensions) to the first boundary, but not if the first application content extends to the first boundary (e.g., in two or more dimensions). For example, as described with reference to FIGS. 8Q and 8R, the application user interface 8078 fills a lower horizontal plane 8079 within the application user interface 8078, and the computer system 101 forgoes displaying the boundary of the three-dimensional application content and/or any additional visual indicators associated with the boundary of the three-dimensional application content in response to detecting that the attention 8016 of the user 7002 is directed toward a boundary of the three-dimensional application content user interface 8078. Determining whether or not to visually emphasize a portion of the boundary of the application content in accordance with the user's attention being directed to the application content based on whether or not a size of the application content fills the area up to the boundary, including forgoing visually emphasizing the boundary if the application content fills the area up to the boundary, provides the user with visual feedback without requiring additional user inputs and improves the visibility of the application content without unnecessarily displaying a boundary that coincides with the edge of the application content.

In some embodiments, the computer system displays (13036) one or more application management controls corresponding to the first application at respective positions relative to the first application content based on the first boundary (e.g., with respective spatial relationships to the first boundary, such as at respective distances from and/or with respective alignments relative to the first boundary). In some embodiments, the one or more application management controls include window management controls (for two-dimensional application windows) or volume management controls (for three-dimensional application volumes), such as a move affordance, a close affordance, a document name affordance (e.g., a title bar, or another user interface object displaying the window name or document name of the document opened inside the application window or volume), and/or an application section navigation affordance (e.g., a “back” button, a “forward” button, a “root” or “home” button, a “upper” button, a “lower” button, a “previous” button, a “next” button, and/or other navigation affordances for navigating within the hierarchy of user interfaces or states of the first application, optionally, inside the boundary of the first application window or volume). In some embodiments, if the attention of the user moves to a portion of the first boundary that is not associated with an application management control, the computer system visually emphasizes that portion of the first boundary without displaying at least some of the one or more application management controls (e.g., if the attention of the user moves to an intervening portion of the first boundary that is between a portion associated with a move affordance and a portion associated with a resize affordance, the computer system visually emphasizes the intervening portion without displaying the resize affordance and/or the move affordance). For example, as described with reference to FIG. 8T, the resize affordance 8086 is displayed at a location outside of the elliptic cylindrical shaped volume of the application user interface 8078, the resize affordance 8024 is displayed at a location outside of the cylindrical shaped volume of the application user interface 8002, and the resize affordance 8066 is displayed at a location outside of the rectangular prismatic shaped volume of the application user interface 8058. Displaying one or more controls for the application near the application content provides additional control options for the user without requiring the user to navigate complex menu hierarchies.

In some embodiments, the one or more application management controls include (13038) one or more auxiliary user interface elements displayed outside of the first boundary (e.g., different and separate from the first application content). For example, as described with reference to FIGS. 8G and 8L, the resize affordance 8024 and the move affordance 8014 are application management controls that are displayed outside the baseplate 8021. Displaying one or more controls for the application outside of the application content provides additional control options for the user without visually obscuring the application content.

In some embodiments, the one or more application management controls include (13040) a resize affordance (e.g., that is activatable to resize the first application content, and which in some embodiments, when activated, triggers display of additional portions of the first boundary). In some embodiments, the resize affordance is displayed near a vertex of the first boundary and/or at one of a finite set of available locations relative to the first boundary (e.g., as described herein with reference to method 15000). For example, as described with reference to FIGS. 8G-8H, the user 7072 is enabled to resize the application user interface 8002 by directing attention to the resize affordance 8024 in conjunction with an air pinch gesture 8500-1. Displaying a resize affordance for the application near the application content provides additional control options for the user without requiring the user to navigate complex menu hierarchies.

In some embodiments, the computer system detects (13042) the first change in position of the attention of the user relative to the first application content includes detecting a change in position of the attention of the user to a respective location in the three-dimensional environment (e.g., in the first portion or the second portion of the first boundary) that is outside of a first region (e.g., a selection region) corresponding to (and optionally including) the resize affordance. In some embodiments, the first region corresponding to the resize affordance includes part of the first boundary or is outside of (e.g., and adjacent to) the first boundary, and optionally includes locations that are within a first threshold distance of the resize affordance. The resize affordance is displayed in response to detecting the first change in position of the attention of the user to the respective location in the three-dimensional environment. For example, as described with reference to FIG. 8C, the computer system 101 displays the resize affordance 8024 before the attention 8016 is directed toward the resize affordance 8024, based on the attention 8016 of the user 7002 remaining within a vicinity of the first portion 8020 for a threshold period of time. Displaying a resize affordance for the application near a boundary of the application content, even before the user's attention is directed to the region that includes the resize affordance, enables the user to see that the resize affordance is accessible within the region, thereby providing additional control options for the user without requiring the user to navigate complex menu hierarchies.

In some embodiments, in accordance with a determination that the respective location in the three-dimensional environment is a first location in the three-dimensional environment, the resize affordance is (13044) displayed with a first spatial relationship relative to the first boundary (e.g., corresponding to a first vertex, a first azimuthal angle, a first area, a first relative location, or other portion of the first boundary); and in accordance with a determination that the respective location in the three-dimensional environment is a second location in the three-dimensional environment that is different from the first location, the resize affordance is displayed with a second spatial relationship relative to the first boundary that is different from the first spatial relationship (e.g., corresponding to a second vertex, a second azimuthal angle, a second area, a second relative location, or other portion of the first boundary). For example, as described with reference to FIGS. 8E-8F, in response to detecting that the attention 8016 of the user 7002 is directed toward an edge of a second portion 8036 of the boundary of the three-dimensional application content, the computer system 101 displays the resize affordance 8024 to the left of the second portion 8036, and forgoes visually emphasizing the first portion 8020 of the baseplate 8021 in accordance with a determination that the attention 8016 is directed toward a region closer to the second portion 8036 than the first portion 8020, in contrast to the resize affordance 8024 being displayed to the right of the first portion 8020 of the baseplate 8021 while the attention 8016 of the user 7002 is directed toward the first portion 8020, as described herein with reference to FIG. 8C. Displaying one or more controls for the application near the application content at a position that is based on a location to which the user's attention is directed provides additional control options for the user based on the user's gaze without requiring the user to navigate complex menu hierarchies.

In some embodiments, the resize affordance displayed in response to detecting the first change in position of the attention of the user to the respective location in the three-dimensional environment is (13046) displayed with a first appearance, while displaying the resize affordance with the first appearance (e.g., in response to detecting the first change in position of the attention of the user to the respective location in the three-dimensional environment that is outside of the first region corresponding to the resize affordance), the computer system detects, via the one or more input devices, a change in position of the attention of the user relative to the first application content to the first region corresponding to the resize affordance (e.g., from outside of the first region corresponding to the resize affordance); and in response to detecting the change in position of the attention of the user to the first region corresponding to the resize affordance, the computer system displays, via the one or more display generation components, the resize affordance with a second appearance that is different from the first appearance (e.g., that is visually emphasized relative to the first appearance, such as with highlighting, brightening, outlining, and/or other visual effect). For example, as described with reference to FIGS. 8C and 8D, the computer system 101 visually emphasizes the resize affordance 8024 based on the attention 8016 of the user 7002 moving toward a region 8030 surrounding the resize affordance 8024. Updating display of the resize affordance in response to detecting that the user's attention is directed to the resize affordance to emphasize the resize affordance indicates that the resize affordance is selectable, provides visual feedback that the computer system detects the user's attention directed to the resize affordance, and provides additional control options for selecting the resize affordance while the user's attention is directed to the resize affordance.

In some embodiments, while displaying the resize affordance (e.g., with the first appearance in response to detecting the first change in position of the attention of the user to the respective portion of the first boundary, or with the second appearance in response to detecting the change in position of the attention of the user to the first region corresponding to the resize affordance, and optionally while continuing to detect that the attention of the user is directed to or toward the respective portion of the first boundary or to the first region, respectively), the computer system detects (13048), via the one or more input devices, a change in position of the attention of the user outside of a second region corresponding to the resize affordance (e.g., and also outside of the first region corresponding to the resize affordance); and in response to detecting the change in position of the attention of the user outside of the second region corresponding to the resize affordance, the computer system ceases to display the resize affordance. In some embodiments, the second region corresponding to the resize affordance is a different size (e.g., larger, or alternatively smaller) than the first region corresponding to the resize affordance. For example, as described with reference to FIGS. 8D and 8E, the computer system 101 ceases display of the resize affordance 8024 based on the attention 8016 of the user 7002 moving to the left along the edge 8026, away from the resize affordance 8024, by a threshold distance that is larger than the region 8030. In FIG. 8D, the computer system 101 displays the resize affordance 8024 in response to detecting the attention 8016 of the user 7002 being directed toward the region 8030. Automatically displaying the resize affordance in accordance with a determination that the user's attention is directed to a first region and automatically ceasing display of the resize affordance in accordance with a determination that the user's attention moves outside of a second region that is a different size than the first region, provides additional control options for the user and dismisses control options without requiring additional user input.

In some embodiments, the one or more application management controls include (13050) a move affordance (e.g., that is activatable to begin moving the first application content relative to the three-dimensional environment, such as by detecting an input that includes an air pinch and drag gesture initiated while the attention of the user is directed toward the move affordance, and which in some embodiments, when activated, triggers display of additional portions of the first boundary). For example, as described with reference to FIGS. 8L-8N, the user 7002 is enabled to move the application user interface 8002 by directing the attention 8016 to the move affordance 8014 in conjunction with performing an air pinch gesture 8500-2. Displaying a move affordance for the application content in accordance with a determination that the user's attention is directed to the application content provides additional control options for the user without requiring the user to navigate complex hierarchies.

In some embodiments, the one or more application management controls have (13052) a three-dimensional appearance that includes a non-zero length, non-zero width, and non-zero depth. For example, as described with reference to FIGS. 8Q, 8R, and 8T, the move affordance 8080 and the resize affordances 8086, 8066, and 8024 have a non-zero length, non-zero width, and non-zero depth. Displaying a plurality of controls as three-dimensional controls improves the visibility of the controls and provides additional control options for the user without requiring the user to navigate complex hierarchies.

In some embodiments, displaying a respective control of the one or more application management controls includes: in accordance with a determination that the first boundary (e.g., that confines the first application content of the first application) has a first volumetric shape (e.g., cylindrical, spherical, hemispherical, or other shape), the computer system displays (13054) the respective control of the one or more application management controls with a first shape (e.g., including a first curvature in one or more dimensions, optionally based on the first volumetric shape); and in accordance with a determination that the first boundary has a second volumetric shape that is different from the first volumetric shape (e.g., rectangular, prismatic, or other shape), the computer system displays the respective control of the one or more application management controls with a second shape that is different from the first shape (e.g., including a second curvature in the one or more dimensions that is different from the first curvature, optionally based on the second volumetric shape). For example, a resize affordance corresponding to a volume with a more curved footprint (e.g., a cylinder) is more rounded than a resize affordance corresponding to a volume with a more angular footprint (e.g., a rectangular prism or cuboid) because in some embodiments the resize affordance corresponding to the volume with the more angular footprint is displayed near a vertex of the volume. For example, as described with reference to FIG. 8T, the resize affordance 8086 associated with the application user interface 8078 (e.g., an elliptic cylinder) is less curved than the resize affordance 8024 associated with the application user interface 8002 (e.g., cylindrical). The resize affordance 8066 associated with the application user interface 8058 (e.g., a rectangular prism) is more angular than the resize affordance 8086 and the resize affordance 8024. Displaying a control with a first shape for application content that has a first shape and displaying the control with a second shape for application content that has a second shape improves the visibility of the control by automatically displaying the control with a shape that complements the shape of the application content and provides additional control options for the user.

In some embodiments, displaying the first view of the three-dimensional environment includes (13056) displaying, via the one or more display generation components, third application content (e.g., that corresponds to the first application or to a third application that is different from the first application) concurrently with the first application content with an overlap between a portion of a third boundary that confines the third application content in two or more dimensions and a portion of the first boundary (e.g., that confines the first application content), while displaying the third application content concurrently with the first application content, the computer system detects, via the one or more input devices, that the attention of the user is directed toward the overlap between the portion of the first boundary of the first application content and the portion of the third boundary of the third application content; and in response to detecting that the attention of the user is directed toward the overlap between the portion of the first boundary of the first application content and the portion of the third boundary of the third application content: in accordance with a determination that the first application content has higher priority than the third application content (e.g., because the first application content has current input focus and the third application content does not have current input focus, because the first application content has a spatial location that is closer to a viewpoint of the user than a spatial location of the third application content and/or because the first application content has a higher layer order than the third application content), the computer system visually emphasizes (13056) the portion of the first boundary of the first application content relative to the portion of the third boundary of the third application content (e.g., including optionally forgoing displaying or ceasing to display the third boundary); and in accordance with a determination that the third application content has higher priority than the first application content (e.g., because the third application content has current input focus and the first application content does not have current input focus, because the third application content has a spatial location that is closer to a viewpoint of the user than a spatial location of the first application content and/or because the third application content has a higher layer order than the first application content), the computer system visually emphasizes the portion of the third boundary of the third application content relative to the portion of the first boundary of the first application content (e.g., including optionally forgoing displaying or ceasing to display the first boundary). In some embodiments, the device detects a change in priority of the first application content relative to the third application content and changes which boundary gets visual emphasis. In some embodiments, a change in priority of the first application content relative to the third application content includes the first application content changing from being lower priority than the third application content to being higher priority than the third application content. In some embodiments, a change in priority of the first application content relative to the third application content includes the first application content changing from being higher priority than the third application content to being lower priority than the third application content. In some embodiments, the change in priority of the first application content relative to the third application content is based on one or more of a change in input focus, a change in spatial location of the first application content and/or third application content relative to a viewpoint of the user (e.g., due to movement of the first application content, movement of the third application content and/or due to a change in a viewpoint of the user), and/or a change in layer order of the first application content relative to the third application content. These changes in priority of the first application content relative to the third application content are optionally caused automatically based on the occurrence of one or more events at the first application content or the second application content or based on one or more inputs detected via one or more input devices of the computer system (e.g., one or more touch inputs, mouse or controller inputs, air gestures and/or gaze inputs). For example, as described with reference to FIGS. 8W-8X, in accordance with a determination that the attention 8016 of the user 7002 is directed at toward a region where the display of one or more portions of a baseplate of the application user interface 8058 would spatially conflict with the display of one or more portions of a baseplate of an application user interface 8002, and that application content of the application user interface 8058 has a higher priority than the application content of the application user interface 8002, the computer system 101 visually emphasizes a boundary of the baseplate 8060 of the application user interface 8058 by displaying a portion 8065 of the baseplate 8060 (e.g., without displaying a portion of the baseplate of the application user interface 8002). Visually emphasizing application content for an application that has a higher priority, without visually emphasizing application content for an application that has a lower priority, while the user's attention is directed to both applications, improves the visibility of the application content for the application that is more important based on application priority without distracting the user with the less important application content.

In some embodiments, while displaying one or more portions of the first boundary (e.g., while visually emphasizing the first portion of the first boundary relative to the second portion of the first boundary, if the attention of the user has moved closer to the first portion than to the second portion, or while visually emphasizing the second portion relative to the first portion, if the attention of the user has moved closer to the second portion than to the first portion): in accordance with a determination that the first application is associated with a first boundary appearance setting (e.g., a first value for a boundary appearance setting), the computer system displays (13058) the one or more portions of the first boundary with a first appearance (e.g., defined by the first boundary appearance setting); and in accordance with a determination that the first application is associated with a second boundary appearance setting that is different from the first boundary appearance setting (e.g., a different, second value for the boundary appearance setting), the computer system displays the one or more portions of the first boundary with a second appearance (e.g., defined by the second boundary appearance setting) that is different from the first appearance. In some embodiments, visual emphasis of one portion of the first boundary relative to another portion is displayed in addition to whichever underlying appearance is being used for the first boundary based on the associated boundary appearance setting. For example, as described with reference to FIGS. 8W-8X, the portion 8065 of the baseplate 8060 has a first appearance that is different from a second appearance of the portion 8036 of the baseplate 8021. Displaying the boundary with an appearance that is based on a setting associated with the first application provides additional options for displaying the boundary with different visual properties based on a value of a boundary appearance setting.

In some embodiments, aspects/operations of methods 12000, 14000, 15000, and 16000 may be interchanged, substituted, and/or added between these methods. For brevity, these details are not repeated here.

FIGS. 14A-14H are flow diagrams of an exemplary method 14000 for scaling of a volumetric application user interface within a three-dimensional environment, in accordance with some embodiments. In some embodiments, method 14000 is performed at a computer system (e.g., computer system 101 in FIG. 1) that is in communication with one or more display generation components (e.g., a head-mounted display (HMD), a heads-up display, a display, a touchscreen, a projector, or other types of display) (e.g., display generation component 120 in FIGS. 1A, 3A, and 4, or the display generation component 7100a in FIGS. 9A-9P), and one or more input devices (e.g., sensors, hardware controls for detecting user inputs, one or more optical sensors such as cameras (e.g., color sensors, infrared sensors, structured light scanners, and/or other depth-sensing cameras) that points downward at a user's hand or a camera that points forward from the user's head, eye-tracking devices, touch sensors, touch-sensitive surfaces, proximity sensors, motion sensors, buttons, crowns, joysticks, user-held and/or user-worn controllers, and/or other sensors and input devices) (e.g., one or more input devices 125 and/or one or more sensors 190 in FIG. 1A, or sensors 7101a-7101c and/or the digital crown 703 in FIGS. 9A-9P). In some embodiments, the method 14000 is governed by instructions that are stored in a non-transitory (or transitory) computer-readable storage medium and that are executed by one or more processors of a computer system, such as the one or more processors 202 of computer system 101 (e.g., control 110 in FIG. 1A). Some operations in method 14000 are, optionally, combined and/or the order of some operations is, optionally, changed.

The computer system displays (14002), via the one or more display generation components, a first view of a three-dimensional environment. The first view of the three-dimensional environment corresponds to a first viewpoint of a user, and includes a first three-dimensional application volume (e.g., an application window and/or application content that is bounded by a three-dimensional volume with a finite boundary (e.g., visible or invisible boundary) in one or more dimensions (e.g., in the horizontal dimension, in the vertical dimension, and/or in the depth dimension; and/or in the radial dimension and/or in the azimuthal dimension), such as a three-dimensional volumetric window of a cylindrical shape, a rectangular prism shape, a spherical shape, and/or other volumetric shapes) that corresponds to a first application (e.g., a system application, such as an application or experience launcher application, a system control application, a settings application, and/or an application switcher application, or a user-installed application, such as a communication application, a telephony application, a gaming application, an exercise application, a meditation application, or other types of applications). The first three-dimensional application volume has a first size (e.g., the intrinsic size in one or more dimensions (e.g., the size relative to the three-dimensional environment, as opposed to the perceived size from the viewpoint of the user) and the angular extent of the first three-dimensional application volume, as opposed to the displayed size of the first three-dimensional application volume as perceived by a user from the first viewpoint) at a first depth relative to the first viewpoint of the user in the three-dimensional environment. Three-dimensional application content of the first application (e.g., and optionally two-dimensional application content of the first application) is confined within the first three-dimensional application volume (e.g., the three-dimensional application content may reach or not reach the boundary of the three-dimensional application volume in one or more dimensions of the three-dimensional application volume in various scenarios).

While displaying the first view of the three-dimensional environment that includes the first three-dimensional application volume at the first depth with the first size, the computer system detects (14004) a first user input (e.g., an air pinch gesture, an air pinch and drag gesture, or other input, in some embodiments directed to a move affordance corresponding to the first three-dimensional application volume) that corresponds to a request to move the first three-dimensional application volume (e.g., in the three-dimensional environment) from the first depth to a second depth relative to the first viewpoint of the user (e.g., as opposed to a user input that corresponds to a request to zoom the application content within the three-dimensional application volume, a request to zoom the three-dimensional application volume at the current location and depth, a request to resize the three-dimensional application volume as a whole, and one or more user inputs that correspond to a request to close and redisplay the three-dimensional application volume).

In response to detecting (14006) the first user input that corresponds to the request to move the first three-dimensional application volume from the first depth to the second depth relative to the first viewpoint of the user: the computer system ceases (14008) to display the first three-dimensional application volume at the first depth relative to the first viewpoint of the user (e.g., including fading out the first three-dimensional application volume as a whole at its initial location, or moving the first three-dimensional application volume as a whole away from its initial location); and the computer system displays (14010) the first three-dimensional application volume at the second depth relative to the first viewpoint of the user (e.g., redisplaying the first three-dimensional application volume after having faded it out at its original location, or moving the three-dimensional application volume as a whole from its initial location to another location at the second depth in accordance with the first user input, such as through a plurality of intermediate depths between the first depth and the second depth) with a second size of the first three-dimensional application volume that is different from the first size of the first three-dimensional application volume (e.g., the second size of the three-dimensional application volume is determined in accordance with the second depth, a difference between the first depth and the second depth, the first size of the first three-dimensional application volume, the information density of the application content within the first three-dimensional application volume, and/or one or more other attributes that are associated with the application content and the first three-dimensional application volume). In some embodiments, in contrast with a three-dimensional application volume that remains unchanged in size with changes in depth relative to the viewpoint of the user (e.g., and would appear smaller when further from the viewpoint of the user due to perspective), the computer system changes the size of the first three-dimensional application volume during the movement of the first three-dimensional application volume from the first depth to the second depth, such that the actual displayed size of the first three-dimensional application volume at the second depth relative to the viewpoint of the user would appear to be larger or smaller than the displayed size of the first three-dimensional application volume at the second depth if the size of the first three-dimensional application volume had not been changed. In some embodiments, although the first size of the first three-dimensional application volume at the first depth is different from the second size of the first three-dimensional application volume at the second depth, the first three-dimensional application volume appears unchanged in size from the perspective of the user at the first viewpoint (e.g., in embodiments in which the respective size of the first three-dimensional application volume is increased proportionally with increasing distance from the viewpoint of the user). In some embodiments, the size of a three-dimensional application volume (e.g., content and/or application elements within the boundary, and optionally the boundary itself, of the three-dimensional application volume) does not change with depth; whereas application elements (e.g., system elements or controls) outside of the boundary change in size with depth. As described herein, method 14000 provides a system for displaying a three-dimensional application volume in a three-dimensional environment with a different size based on moving the three-dimensional application volume to a different depth relative to the user's viewpoint. For example, as described with reference to FIGS. 9A-9B, in response to detecting a request to move the application user interface 9002 of the volumetric application from a first depth 9028 with a first size 9032 (FIG. 9A) to a second depth 9040 (FIG. 9B) relative to the first viewpoint of the user 7002, the computer system 101 displays the application user interface 9002 at the second depth 9040 with a second size 9046 that is different from (e.g., larger than) the first size 9032 of the application user interface 9002. As described with reference to FIGS. 9C-9D, in response to detecting a request to move the application user interface 9002 of the volumetric application from the first depth 9028 with the first size 9032 (FIG. 9C) to a third depth 9052 (FIG. 9D) relative to the first viewpoint of the user 7002, the computer system 101 displays the application user interface 9002 at the third depth 9052 with a third size 9054 that is different from (e.g., smaller than) the first size 9032 of the application user interface 9002. Reducing the size of the first user interface element 7038 when it is displayed closer to the viewpoint of the user 7002 keeps the angle subtended by the first user interface element 7038 at a constant value from the viewpoint of the user 7002, and reduces a chance of the first user interface element 7038 blocking other user interface elements in the field of view of the user 7002. Displaying the first three-dimensional application volume at the second depth relative to the first viewpoint of the user with a second size of the first three-dimensional application volume that is different from the first size of the first three-dimensional application volume causes the computer system to automatically maintain the three-dimensional application volume at a size that is conducive for user interaction. For example, moving the three-dimensional application volume to a depth in the three-dimensional environment that is farther away from the user's viewpoint causes the system to increase a size of the three-dimensional application volume while the three-dimensional application volume is displayed at the increased depth. Automatically updating a size of the three-dimensional application volume in response to a change in the depth at which the three-dimensional application volume is displayed improves the visibility and legibility of the application volume without requiring additional user input.

In some embodiments, while displaying the first three-dimensional application volume at the first depth with the first size, the computer system displays (14012), via the one or more display generation components, a first three-dimensional application element (e.g., within or corresponding to the first three-dimensional application volume) with a first element size and displays a second three-dimensional application element (e.g., within or corresponding to the first three-dimensional application volume) with a second element size. In some embodiments, the second three-dimensional application element is different from the first three-dimensional application element. In some embodiments, while displaying the first three-dimensional application volume at the second depth with the second size, the computer system displays, via the one or more display generation components, the first three-dimensional application element with a third element size and displays the second three-dimensional application element with a fourth element size. In some embodiments, the third element size is different from the first element size, the fourth element size is different from the second element size, and a ratio of the third element size to the first element size (e.g., a change in scale of the first three-dimensional application element) is equal to a ratio of the fourth element size to the second element size (e.g., a change in scale of the second three-dimensional application element). In some embodiments, one or more (and optionally all) three-dimensional and/or two-dimensional application elements (e.g., content) of the first three-dimensional application volume scale proportionally as the first three-dimensional application volume changes in size with changes in depth. For example, as described with reference to FIGS. 9A-9B, the building 9008 has a first dimension 9034 and the building 9010 has a second dimension 9036 when displayed at the first depth 9028 (FIG. 9A). The building 9008 has a third dimension 9042 and the building 9010 has a fourth dimension 9044 when displayed at the second depth 9040 (FIG. 9B). A ratio of the fourth dimension 9044 to the second dimension 9036 is the same as a ratio of the third dimension 9042 to the first dimension 9034. Keeping a ratio of the third element size to the first element size equal to a ratio of the fourth element size to the second element size causes the computer system to automatically maintain spatial information between application user interface elements within the three-dimensional application volume.

In some embodiments, while displaying the first view of the three-dimensional environment that includes the first three-dimensional application volume at the first depth with the first size, the computer system displays (14014), via the one or more display generation components, a first application element (e.g., two-dimensional application content, three-dimensional application content, or an application management control, within or corresponding to the first three-dimensional application volume) with a first element size and displays a second application element (e.g., two-dimensional application content, three-dimensional application content, or an application management control, within or corresponding to the first three-dimensional application volume) with a second element size. In some embodiments, the second application element is different from the first application element. In some embodiments, while displaying the first three-dimensional application volume at the second depth with the second size, the computer system displays, via the one or more display generation components, the first application element with a third element size that is different from the first element size (e.g., the first application element, displayed within or corresponding to the first three-dimensional application volume, changes in size with changes in depth of the first three-dimensional application volume from the viewpoint of the user) and displays the second application element with the second element size (e.g., the second application element, displayed within or corresponding to the first three-dimensional application volume, does not change in size with changes in depth of the first three-dimensional application volume from the viewpoint of the user). In some embodiments, multiple application elements change in size with changes in depth, optionally at different scaling rates or with different scaling progressions (e.g., different, and optionally non-linear, mappings of scaling to depth). For example, where the first three-dimensional application volume includes a third application element, which has a fourth element size at the first depth and a different, fifth element size at the second depth, a ratio of the fifth element size to the fourth element size (e.g., the change in scale of the third application element) is optionally different from a ratio of the third element size to the first element size (e.g., the change in scale of the first application element. For example, as described with reference to FIGS. 9H-9I, the application user interface 9002-b is a mixed scale application in which respective user interface elements have different scaling behaviors. A ratio of the height dimension 9036 of the building 9010 to the height of the menu bar 9070 (FIG. 9H) is reduced when the application user interface 9002-b is moved in depth, away from the viewpoint of the user 7002 because the height of the building 9010 remained unchanged whereas the height of the dynamically scaled menu bar 9070 is increased. Automatically scaling some application content with a first scale and scaling other application content with a second scale that is different from the first scale after changing a size of the application volume enables content to be scaled differently when the size of the application volume changes, thereby improving the visibility of some of the application content without distorting the size of other application content and without displaying additional controls.

In some embodiments, the first application element (e.g., which changes in size with changes in depth) includes (14016) first three-dimensional content of the first application (e.g., optionally without including two-dimensional content of the first application); the second application element (e.g., which does not change in size with changes in depth) includes second three-dimensional content of the first application (e.g., optionally without including two-dimensional content of the first application); and the second three-dimensional content of the first application is different from the first three-dimensional content of the first application. For example, as described with reference to FIGS. 9H-9I, the height of the dynamically scaled menu bar 9070 is increased whereas the heights of the buildings 9004, 9006, 9008, 9010, 9012, and 9014 remain unchanged. Automatically scaling some three-dimensional application content with a first scale and scaling other three-dimensional application content with a second scale that is different from the first scale after changing a size of the application volume enables content to be scaled differently when the size of the application volume changes, thereby improving the visibility of some of the three-dimensional application content without distorting the size of other application content.

In some embodiments, the first application element includes (14018) two-dimensional content of the first application (e.g., at least some, and optionally all, two-dimensional content of the first application, optionally without including three-dimensional content of the first application); and the second application element includes three-dimensional content of the first application (e.g., optionally without including two-dimensional content of the first application). For example, as described with reference to FIG. 9K, the two-dimensional user interface elements billboards 9016-1, 9016-2, 9016-3 and 9016-4 are dynamically scaled so that they remain legible whereas the heights of the three-dimensional buildings 9004, 9006, 9008, 9010, 9012 and 9014 remain unchanged. Automatically scaling two-dimensional application content with a first scale and scaling three-dimensional application content with a second scale that is different from the first scale after changing a size of the application volume enables content to be scaled differently when the size of the application volume changes, thereby improving the visibility of two-dimensional and three-dimensional application content without distorting the size of other application content and without displaying additional controls.

In some embodiments, the first application element (e.g., which changes in size with changes in depth relative to the viewpoint of the user) includes (14020) one or more auxiliary user interface elements that are different from (e.g., distinct from, separate from, and optionally displayed outside of) the first three-dimensional application volume and that correspond to the first application (e.g., one or more application management controls, such as a title bar, a move affordance, a resize affordance, a close affordance, navigation controls, system controls, and/or other controls); and the second application element (e.g., which does not change in size with changes in depth relative to the viewpoint of the user) includes three-dimensional application content of the first application confined within the first three-dimensional application volume. For example, as described with reference to FIG. 9K, the three-dimensional user interface elements menu bar 9070, the move affordance 9037 and the three-dimensional control 9022 are dynamically scaled whereas the heights of the three-dimensional buildings 9004, 9006, 9008, 9010, 9012 and 9014 remain unchanged. Automatically scaling control elements for the application volume without scaling three-dimensional application content of the application volume in accordance with a change in size of the application volume improves the accessibility and visibility of the control elements for the application volume, without displaying additional controls.

In some embodiments, the second depth is greater than the first depth, and the computer system detects (14022), via the one or more input devices, a set of one or more user inputs that corresponds to a request to move the first three-dimensional application volume to a respective depth relative to the first viewpoint of the user (e.g., an air pinch gesture, or air pinch and drag gesture, initiated or performed while the attention of the user is directed toward a move affordance corresponding to the first three-dimensional application volume, or other input). In some embodiments, in response to detecting the set of one or more user inputs that corresponds to the request to move the first three-dimensional application volume to the respective depth relative to the first viewpoint of the user, the computer system displays, via the one or more display generation components, the first three-dimensional application volume at the respective depth relative to the first viewpoint of the user; including: in accordance with a determination that the respective depth is less than the first depth, displaying the first application element with the first element size (e.g., and displaying the second application element with the second element size); and, in accordance with a determination that the respective depth is greater than the first depth, displaying the first application element with the second element size (e.g., and displaying the second application element with the second element size). For example, the respective depth is less than both the first depth and the second depth, yet the first application element is limited to the same first element size as when the first three-dimensional application volume is at the first depth (e.g., the first element size has reached a first threshold size such as a minimum (or maximum) size). In another example, the respective depth is greater than both the first depth and the second depth, yet the first application element is limited to the same second element size as when the first three-dimensional application volume is at the second depth (e.g., the first element size has reached a second threshold size such as a maximum (or minimum) size). For example, as described with reference to FIGS. 9B and 9I, a dynamically scaled application user interface element has a different size threshold (e.g., maximum and/or minimum size threshold) than a fixed scaled application user interface element. Scaling a first type of application content, such as dynamic content, to a first minimum and/or maximum size regardless of the depth at which the application volume is moved, while scaling a second type of application content, such as fixed content, by a different scale that has a second minimum and/or maximum size, provides visual feedback for different types of content displayed in the application volume without displaying additional controls.

In some embodiments, while displaying the first view of the three-dimensional environment that includes the first three-dimensional application volume at the first depth with the first size, the computer system displays (14024), via the one or more display generation components, a third application element (e.g., two-dimensional application content or three-dimensional application content) with a fourth element size. In some embodiments, the third application element is different from the first application element and from the second application element. In some embodiments, while displaying the first three-dimensional application volume at the second depth with the second size, the computer system displays, via the one or more display generation components, the third application element with a fifth element size that is different from the fourth element size. In some embodiments, the first application element displayed with the third element size is changed in size in a first resizing direction relative to the first application element displayed with the first element size (e.g., scaled up or down in the first resizing direction, with a reference point, such as the centroid, in the first application element at the third element size being offset in the first resizing direction from the reference point in the first application element at the first element size, for example relative to the second application element, which is maintained at the second element size). In some embodiments, the third application element displayed with the fifth element size is changed in size in a second resizing direction relative to the third application element displayed with the fourth element size (e.g., scaled up or down in the second resizing direction, with a reference point, such as the centroid, in the third application element at the fifth element size being offset in the second resizing direction from the reference point in the third application element at the fourth element size, for example relative to the second application element, which is maintained at the second element size), wherein the second resizing direction is different from (e.g., orthogonal to or opposite, or more than a threshold angle different from) the first resizing direction. In some embodiments, the first application element is scaled up or down in the first resizing direction relative to a first scaling point, the third application element is scaled up or down in the second resizing direction relative to a second scaling point, and a spatial relationship (e.g., being to the left of, to the right of, above, or below) between the first scaling point and the first application element (e.g., or more specifically a reference point, such as the centroid, in the first application element) is different from a spatial relationship between the second scaling point and the third application element (e.g., or more specifically a reference point, such as the centroid, in the third application element). For example, the first scaling point is on or near a right edge of the first application element (e.g., to the right of the centroid of the first application element), whereas the second scaling point is on or near a left edge of the third application element (e.g., to the left of the centroid of the third application element). For example, as described with reference to FIG. 9I, the menu bar 9070 is resized in an anisotropic fashion, such as being biased toward a first direction (e.g., left) relative to the building 9010 that is fixed scale (e.g., and/or relative to a point along the line 9090). The move affordance 9037 is resized in an anisotropic fashion, such as being biased toward a second direction (e.g., downward) relative to the building 9010 that is fixed scale (e.g., and/or relative to a point along the line 9093).Automatically scaling application content that is biased to a first direction, e.g., based on a first reference point, and scaling other application content that is biased to a second direction, e.g., based on a second reference point, allows for scaling different application content elements in different manners, thereby improving the visibility of application content elements without requiring the user to manually adjust the scaling of the different application content elements.

In some embodiments, displaying the first three-dimensional application volume at the second depth with the second size that is different from the first size is performed (14026) in accordance with one or more settings of the first application (e.g., established by the developer of the application and/or user of the computer system). In some embodiments, the first three-dimensional application volume includes a respective three-dimensional content element displayed with a first content size while the first three-dimensional application volume is displayed at the first depth with the first size. In some embodiments, in response to detecting the first user input that corresponds to the request to move the first three-dimensional application volume from the first depth to the second depth relative to the first viewpoint of the user: in accordance with a determination that a respective setting of the first application is enabled (e.g., established by the developer of the application and/or user of the computer system), the computer system displays the respective three-dimensional content element with a second content size that is different from the first content size, whereas in some embodiments, in accordance with a determination that the respective setting of the first application is not enabled, the computer system maintains display of the respective three-dimensional content element with the first content size. For example, as described with reference to FIGS. 9K-9L, a developer of the application user interface 9002-a, 9002-b, or 9002-c is enabled to specify whether one or more three-dimensional application user interface elements are to be dynamically scaled. Automatically scaling the application volume in response to a user input to move the application volume to a different depth if a setting for the application allows for scaling, without scaling the application volume if the setting for the application does not allow for scaling, provides additional control options to enable or disable automatic scaling of three-dimensional content.

In some embodiments, the first viewpoint of the user is in a first direction relative to the first three-dimensional application volume (e.g., a first azimuth relative to a reference point, such as a centroid or origin, in the first three-dimensional application volume), the first three-dimensional application volume includes a respective two-dimensional content element displayed with a first orientation relative to the first three-dimensional application volume that is based on the first direction of the first viewpoint of the user, the computer system detects (14028), via the one or more input devices, movement of a current viewpoint of the user relative to the first three-dimensional application volume from the first viewpoint to a second viewpoint (e.g., different from the first viewpoint) relative to the first three-dimensional application volume that is in a second direction relative to the first three-dimensional application volume, wherein the second direction is different from the first direction (e.g., a different, second azimuth relative to the reference point in the first three-dimensional application volume). In some embodiments, in response to detecting the movement of the current viewpoint of the user from the first viewpoint in the first direction to the second viewpoint in the second direction relative to the first three-dimensional application volume: in accordance with a determination that a respective setting of the first application is enabled (e.g., established by the developer of the application and/or user of the computer system): the computer system ceases to display the respective two-dimensional content element with the first orientation relative to the first three-dimensional application volume; and the computer system displays, via the one or more display generation components, the respective two-dimensional content element with a second orientation relative to the first three-dimensional application volume that is based on the second direction of the second viewpoint of the user, wherein the second orientation is different from the first orientation (e.g., changing the orientation of the respective two-dimensional content element relative to the first three-dimensional application volume, without moving the first three-dimensional application volume relative to the three-dimensional environment, or in other words while maintaining display of the first three-dimensional application volume at a same application orientation relative to the three-dimensional environment). In some embodiments, in accordance with a determination that the respective setting of the first application is not enabled, the computer system maintains display of the respective two-dimensional content element with the first element orientation relative to the first three-dimensional application volume. For example, as described with reference to FIGS. 9G and 10A, a developer for the application user interface 9002-a and/or the application user interface 10002 is enabled to specify which user interface elements of the application user interface 9002-a and/or the application user interface 10002 have a plane that turns toward (e.g., being substantially perpendicular to) the viewpoint of the user 7002, for example, as described with reference to FIG. 9G. Automatically turning (e.g., billboarding), or not turning, two-dimensional application content to face the user based on a setting for the application, provides additional control options to enable or disable automatic turning of two-dimensional content.

In some embodiments, displaying the respective two-dimensional content element with the second orientation relative to the first three-dimensional application volume that is based on the second direction of the second viewpoint of the user is performed (14030) in accordance with one or more orientation update parameters of the first application (e.g., established by the developer of the application and/or user of the computer system) without providing, to the first application, the second viewpoint of the user. In some embodiments, the updating of the orientation of the respective two-dimensional content element relative to the first three-dimensional application volume is performed by system software different from the first application, or by the first application using information (e.g., received from the system software) that indicates how the respective two-dimensional content element should be oriented but that does not include the location of the second viewpoint of the user. In some embodiments, the one or more orientation update parameters of the first application (e.g., established by the developer) specify displaying the orientation of the respective two-dimensional content element relative to the first three-dimensional application volume progressing through a plurality of intermediate orientations as the current viewpoint of the user moves relative to the first three-dimensional application volume between the first viewpoint and the second viewpoint. In some embodiments, the one or more orientation update parameters specify updating the orientation of the respective two-dimensional content element (e.g., to the second orientation) relative to the first three-dimensional application volume in accordance with a determination that the second viewpoint is at least a threshold difference (e.g., in distance, azimuth, and/or other measure of change in viewpoint) from the first viewpoint (e.g., and not updating the orientation of the respective two-dimensional content element prior to the current viewpoint of the user reaching the threshold difference from the first viewpoint). In some embodiments, the one or more orientation update parameters specify updating the orientation of the respective two-dimensional content element relative to the first three-dimensional application volume with damping and/or delay relative to the movement of the current viewpoint of the user. For example, as described with reference to FIG. 9G, the change in the respective orientation of the billboards may be dampened (e.g., lagging the change of the movement of the viewpoint of the user 7002 in time, or in angular magnitude), be changed continuously in response to detecting a corresponding change in the movement of the viewpoint of the user 7002 or be changed step-wise (e.g., in increments of 2-10°, or other magnitudes) once a movement of the viewpoint of the user 7002 meets respective movement thresholds, and such parameters may be specified by a developer for the application user interface 9002-a. Automatically turning (e.g., billboarding), or not turning, two-dimensional application content to face the user based on one or more settings, including settings that specify parameters for how to modify the two-dimensional application content for the application, without providing the application with information about the user's viewpoint, provides additional control options to specify how to perform the automatic turning of two-dimensional content and improves the privacy and security of the device by limiting the information shared with the application.

the computer system displays (14032), via the one or more display generation components, the first view of the three-dimensional environment that corresponds to the first viewpoint of the user and that includes the first three-dimensional application volume at the first depth with the first size; while displaying the first view of the three-dimensional environment that includes the first three-dimensional application volume at the first depth with the first size, the computer system detects, via the one or more input devices, movement of a current viewpoint of the user relative to the first three-dimensional application volume to a second viewpoint that is different from the first viewpoint and that is the second depth relative to the first three-dimensional application volume; and in response to detecting the movement of the current viewpoint of the user to the second viewpoint, the computer system displays, via the one or more display generation components, the first three-dimensional application volume at the second depth with the first size (e.g., the first three-dimensional application volume remains at a same location relative to the three-dimensional environment, and at the same first size relative to the three-dimensional environment). For example, as described with reference to FIGS. 9F and 9J, user interface elements appear larger in the viewport due to the shortened distance between the viewpoint of the user 7002 and the application user interface 9002-a (FIG. 9F) or smaller in the viewport due to the increased distance between the viewpoint of the user 7002 and the application user interface 9002-a (FIG. 9J), and the computer system 101 forgoes dynamically scaling user interface elements within the application user interface 9002-a as a result of the movement of the viewpoint of the user 7002 (FIG. 9F). The computer system 101 also forgoes dynamically scaling one or more of: the move affordance 9037 and/or the three-dimensional control 9022 in response to detecting the movement in the viewpoint of the user 7002 (FIG. 9J). Automatically scaling the application volume in response to detecting a change in position of the application volume, without automatically scaling the application volume in response to detecting a movement of the viewpoint of the user, maintains the application volume at a same size as the user moves in the three-dimensional environment without requiring additional user input.

In some embodiments, while displaying the first three-dimensional application volume at the second depth with the second size, the computer system detects (14034), via the one or more input devices, a set of one or more user inputs that corresponds to a request to move the first three-dimensional application volume (e.g., in the three-dimensional environment) to a third depth relative to the first viewpoint of the user. In some embodiments, the second depth is between the first depth and the third depth (e.g., the third depth is the largest and the first depth is the smallest of the first, second, and third depths, or vice versa). In some embodiments, the third depth is outside of a respective range of depths that includes the first depth and the second depth. In some embodiments, in response to detecting the set of one or more user inputs that corresponds to the request to move the first three-dimensional application volume to the third depth relative to the first viewpoint of the user, the computer system displays, via the display generation component, the first three-dimensional application volume at the third depth with the second size (e.g., the second size is a maximum or minimum size to which the first three-dimensional application volume can be rescaled). In some embodiments, in response to detecting a user input (e.g., a set of one or more user inputs) that corresponds to a request to move the first three-dimensional application volume to a fourth depth relative to the first viewpoint of the user, wherein the first depth is between the second depth and the fourth depth (e.g., the third depth is the largest and the fourth depth is the smallest of the first, second, third, and fourth depths, or vice versa), the computer system displays the first three-dimensional application volume at the fourth depth with the first size (e.g., the first size is a minimum size and the second size is a maximum size, or vice versa, to which the first three-dimensional application volume can be rescaled). In some embodiments, the third depth is a maximum (or minimum) depth from the first viewpoint of the user to which the first three-dimensional application volume can be moved in the three-dimensional environment. In some embodiments, the fourth depth is a minimum (or maximum) depth from the first viewpoint of the user to which the first three-dimensional application volume can be moved in the three-dimensional environment. For example, as described with reference to FIG. 9B, in response to detecting an additional user input to move the application user interface 9002-a further than the distance 9040 from the viewpoint of the user 7002, the computer system 101 maintains the application user interface 9002-a at the same size 9046 while displaying the application user interface 9002-a at the greater distance (e.g., greater than the distance 9040) from the viewpoint of the user 7002 due to a maximum scaling factor for dynamic scaling of the application user interface 9002-a. In another example, as described with reference to FIG. 9D, in response to detecting additional user input to move the application user interface 9002-a closer than the distance 9052 toward to the viewpoint of the user 7002, the computer system 101 maintains the application user interface 9002-a at the same size 9054 while displaying the application user interface 9002-a at a smaller distance due to a minimum scaling factor for dynamic scaling of the application user interface 9002-a. Automatically scaling the application volume in response to detecting a change in position of the application volume up to a maximum or minimum scaling limit reduces the computational resources needed to scale the application volume beyond the scaling limit while improving visibility of the application volume by scaling the application volume up to the scaling limit.

In some embodiments, the second depth is greater than the first depth. In some embodiments, while displaying the first three-dimensional application volume at the second depth with the second size, the computer system detects (14036), via the one or more input devices, a second set of one or more user inputs that corresponds to a request to move the first three-dimensional application volume (e.g., in the three-dimensional environment) further than the second depth relative to the first viewpoint of the user. In some embodiments, in response to detecting the second set of one or more user inputs that corresponds to the request to move the first three-dimensional application volume further than the second depth relative to the first viewpoint of the user, the computer system maintains display of the first three-dimensional application volume at the second depth with the second size (e.g., the second depth is a maximum depth to which the first three-dimensional application volume can be moved). In some embodiments, the computer system displays, via the one or more display generation components, a second view of the three-dimensional environment (e.g., in response to a change in position of a current viewpoint of the user to correspond to the second view of the three-dimensional environment, in accordance with the second three-dimensional application volume being included in the same three-dimensional environment as the first three-dimensional application volume, and/or in response to one or more inputs corresponding to a request to display the second three-dimensional application volume by launching a different, second application to which the second three-dimensional application volume corresponds). In some embodiments, the second view of the three-dimensional environment corresponds to the first viewpoint of the user, and includes a second three-dimensional application volume that corresponds to a second application; the second three-dimensional application volume has a respective size at the first depth relative to the first viewpoint of the user in the three-dimensional environment; and three-dimensional application content of the second application is confined within the second three-dimensional application volume. In some embodiments, while displaying the second view of the three-dimensional environment that includes the second three-dimensional application volume at the first depth with the respective size, the computer system detects, via the one or more display generation components, a third set of one or more user inputs that corresponds to a request to move the second three-dimensional application volume (e.g., in the three-dimensional environment) from the first depth to a third depth relative to the first viewpoint of the user, wherein the third depth is greater than the first depth. In some embodiments, in response to detecting the third set of one or more user inputs that corresponds to the request to move the second three-dimensional application volume from the first depth to the third depth relative to the first viewpoint of the user: the computer system ceases to display the second three-dimensional application volume at the first depth relative to the first viewpoint of the user; and the computer system displays, via the one or more display generation components, the second three-dimensional application volume at the third depth relative to the first viewpoint of the user with the respective size of the second three-dimensional application volume (e.g., the second three-dimensional application volume does not change in size with changing depth). In some embodiments, while displaying the second three-dimensional application volume at the third depth with the respective size, the computer system detects, via the one or more input devices, a fourth set of one or more user inputs that corresponds to a request to move the second three-dimensional application volume (e.g., in the three-dimensional environment) further than the third depth relative to the first viewpoint of the user; and in response to detecting the fourth set of one or more user inputs that corresponds to the request to move the second three-dimensional application volume further than the third depth relative to the first viewpoint of the user, the computer system maintains display of the second three-dimensional application volume at the third depth relative to the first viewpoint of the user with the respective size (e.g., the third depth is a maximum depth to which the second three-dimensional application volume can be moved). In some embodiments, the third depth is different from (e.g., greater than or less than) the second depth (e.g., the second three-dimensional application volume has a different maximum depth than the first three-dimensional application volume). For example, as described with reference to FIGS. 9B and 9I, the first maximum distance for a dynamically scaled application is different (e.g., larger than, or smaller than) the second maximum distance for a fixed scale application (e.g., such that the distance 9040 would be different from the distance 9082). Enabling a user input to move a fixed scale application volume up to a first amount away from the viewpoint of the user, and enabling a user input to move a dynamic scale application volume to a second amount away from the viewpoint of the user that is different form the first amount, provides the user with control options to move the respective application volumes away from the viewpoint of the user while reducing the computation resources required by preventing the user from moving the respective application volumes past the movement limit away from the viewpoint of the user.

In some embodiments, displaying the first view of the three-dimensional environment that includes the first three-dimensional application volume at the first depth with the first size includes (14038) displaying a respective application content element (e.g., at a respective content size) corresponding to the first three-dimensional application volume (e.g., two-dimensional application content or three-dimensional application content in or otherwise associated with the first three-dimensional application content). In some embodiments, the respective application content element is displayed concurrently with one or more other application content elements corresponding to the first three-dimensional application volume. In some embodiments, displaying the first three-dimensional application volume at the second depth with the second size includes: in accordance with a determination that the second size of the first three-dimensional application volume exceeds a size threshold, the computer system ceases to display the respective application content element corresponding to the first three-dimensional application volume (e.g., while continuing to display one or more other application content elements corresponding to the first three-dimensional application volume). In some embodiments, in accordance with a determination that the second size of the first three-dimensional application volume does not exceed the size threshold, the respective application content element corresponding to the first three-dimensional application volume continues to be displayed (e.g., at the same respective content size if the respective application content element is fixed scale content, or at a different content size if the respective application content element is dynamic scale content, optionally while continuing to display one or more other application content elements corresponding to the first three-dimensional application volume). In some embodiments, one or more respective application content elements cease to be displayed if the second size exceeds the size threshold. For example, as described with reference to FIGS. 9K-9L, in accordance with a determination that the billboard 9016-4 (FIG. 9H) would be enlarged beyond the size threshold in response to a movement of the application user interface 9002-c to the distance 9092, the computer system forgoes displaying the billboard 9016-4. Ceasing display of at least some application content, if the application volume is moved in a way that causes the application volume to be enlarged beyond the threshold size, improves the visibility of the application volume without crowding the user interface with additional application content and without requiring the user to manually remove application content while the application volume is enlarged.

In some embodiments, while displaying the first three-dimensional application volume at a respective depth (e.g., the second depth) with a respective size (e.g., the second size) without displaying the respective application content element (e.g., in accordance with ceasing to display the respective application content element corresponding to the first three-dimensional application volume, such as in accordance with the determination that the second size of the first three-dimensional application volume exceeds the size threshold), the computer system detects (14040), via the one or more input devices, a set of one or more user inputs that corresponds to a request to move the first three-dimensional application volume (e.g., in the three-dimensional environment) from the respective depth to a fourth depth relative to the first viewpoint of the user. In response to detecting the set of one or more user inputs that corresponds to the request to move the first three-dimensional application volume from the respective depth to the fourth depth relative to the first viewpoint of the user: the computer system ceases to display the first three-dimensional application volume at the respective depth relative to the first viewpoint of the user (e.g., including fading out the first three-dimensional application volume as a whole at its initial location, or moving the first three-dimensional application volume as a whole away from its initial location); and the computer system displays, via the one or more display generation components, the first three-dimensional application volume at the fourth depth relative to the first viewpoint of the user with a third size of the first three-dimensional application volume that is different from the respective size of the first three-dimensional application volume, including: in accordance with a determination that the third size of the first three-dimensional application volume does not exceed the size threshold, the computer system displays (e.g., redisplays), via the one or more display generation components, the respective application content element corresponding to the first three-dimensional application volume (e.g., at the same respective content size as before if the respective application content element is fixed scale content, or at a different content size if the respective application content element is dynamic scale content, optionally while continuing to display one or more other application content elements corresponding to the first three-dimensional application volume). In some embodiments, in accordance with a determination that the third size of the first three-dimensional application volume exceeds the size threshold, the respective application content element corresponding to the first three-dimensional application volume continues to not be displayed (e.g., while continuing to display one or more other application content elements corresponding to the first three-dimensional application volume). In some embodiments, one or more respective application content elements that ceased to be displayed are redisplayed if the third size does not exceed the size threshold. For example, as described with reference to FIGS. 9K-9L, in accordance with a determination that dynamically scaling the two-dimensional user interface elements reduces a displayed size of the billboard 9016-4 to below a size threshold, the computer system redisplays the billboard 9016-4. Automatically redisplaying application content, if the application volume is moved in a way that causes the application volume to shrink below a threshold size, provides the user with additional control options and other application content without requiring the user to manually request the application content.

In some embodiments, while displaying the three-dimensional environment with a respective size (e.g., the first size, the second size, or another size, and at a respective depth, such as the first depth, the second depth, or another depth), including displaying in the first three-dimensional application volume a respective application content element of the first application at a respective content size, the computer system detects (14042), via the one or more input devices, a set of one or more user inputs that correspond to a request to resize the first three-dimensional application volume (e.g., as described herein with reference to method 13000, such as a request to increase or decrease a scale or size of the three-dimensional application volume relative to the three-dimensional environment, and/or one or more user inputs that correspond to a request to close and redisplay the three-dimensional application volume, where the three-dimensional application volume has a different size when redisplayed than when the three-dimensional application volume was closed). In response to detecting the set of one or more user inputs that correspond to the request to resize the first three-dimensional application volume, the computer system displays, via the one or more display generation components, the first three-dimensional application volume with a size that is different from (e.g., greater than or less than) the respective size (e.g., and ceasing to display the first three-dimensional application volume with the respective size), including displaying the respective application content element at a content size that is different from (e.g., greater than or less than) the respective content size (e.g., and ceasing to display the respective application content element with the respective content size). For example, as described with reference to FIG. 9N, in some embodiments the computer system 101 rescales the application user interface 9002-a shown in FIG. 9M at the same depth from the viewpoint of the user 7002, without decreasing the amount of application content elements displayed to the user 7002 (e.g., by applying a scaling factor less than 1 to reduce the size of the application user interface 9002-a, or by applying a scaling factor greater than 1 to enlarge the size of the application user interface 9002-a). Automatically scaling content of the application in response to one or more user inputs to resize the application volume, improves the visibility and legibility of the content of the application after the application volume has been resized.

In some embodiments, while displaying the first three-dimensional application volume with a respective size (e.g., the first size, the second size, or another size, and at a respective depth, such as the first depth, the second depth, or another depth), including displaying in the first three-dimensional application volume a first amount of content of the first application, the computer system detects (14044), via the one or more input devices, a set of one or more user inputs that correspond to a request to resize the first three-dimensional application volume (e.g., as described herein with reference to method 13000). In some embodiments, in response to detecting the set of one or more user inputs that correspond to the request to resize the first three-dimensional application volume, the computer system displays, via the one or more display generation components, the first three-dimensional application volume with a size that is different from (e.g., greater than or less than) the respective size and with a second amount of content that is different from (e.g., greater than or less than) the first amount of content. For example, as described with reference to FIGS. 9M-9P, based on detecting the movement of the air pinch gesture 9500 in depth away from or toward the viewpoint of the user 7002, the computer system 101 resizes the application user interface 9002-a by decreasing or increasing, respectively, the application volume of the application user interface 9002-a (e.g., and the amount of application content hat is displayed) while maintaining the characteristic portion of the application user interface 9002-a at the same location in the three-dimensional environment. Displaying the three-dimensional application volume with a size that is different from the respective size and with a second amount of content that is different from the first amount of content reduces the number of inputs and amount of time needed to display relevant information to the user while maintaining display of depth information within the volumetric application, without displaying additional controls.

In some embodiments, the computer system visually deemphasizes (14046) (e.g., feathering, blurring, dimming, clipping, and/or other visual deemphasis) content of the first application displayed in a first portion of the first three-dimensional application volume relative to content of the first application displayed in a second portion of the first three-dimensional application volume. In some embodiments, the first portion is closer to a boundary of the first three-dimensional application volume than the second portion (e.g., the first portion includes an edge portion, and the second portion includes an interior portion). For example, as described with reference to FIG. 9H, application content elements at an edge of the elliptical cylindrical application volume (e.g., application user interface 9002-b) are feathered to a different degree (e.g., more feathered, or less feathered) than application content elements at an edge of a differently shaped application volume (e.g., a rectangular prismatic application volume of application user interface 8058 in FIG. 8P, or a cylindrical application volume of application user interface 8002 in FIG. 8A). Applying a feathering visual effect to one or more edges of the application volume (e.g., by gradually decreasing an opacity of the edges of the first three-dimensional application volume as a distance from a center of the first three-dimensional application volume increases) reduces visual discontinuities and helps to maintain the display of depth information of content in the volumetric application, without displaying additional controls.

In some embodiments, visually deemphasizing the content of the first application displayed in the first portion of the first three-dimensional application volume relative to the content of the first application displayed in the second portion of the first three-dimensional application volume includes (14048): in accordance with a determination that the first three-dimensional application volume has a first volumetric shape (e.g., cylindrical, spherical, or hemispherical), the computer system displays, via the one or more display generation components, the content of the first application in the first portion of the first three-dimensional application volume with a first type of visual deemphasis (e.g., a first degree of visual deemphasis and/or with a first visual effect) relative to the content of the first application in the second portion of the first three-dimensional application volume; and in accordance with a determination that the first three-dimensional application volume has a second volumetric shape that is different from the first volumetric shape (e.g., rectangular or prismatic), the computer system displays, via the one or more display generation components, the content of the first application in the first portion of the first three-dimensional application volume with a second type of visual deemphasis relative to the content of the first application in the second portion of the first three-dimensional application volume. In some embodiments, the second type of visual deemphasis is different from the first type of visual deemphasis (e.g., a second degree of visual deemphasis that is greater than or less than the first degree, and/or with a second visual effect that is different from the first visual effect. In some embodiments, different degrees of visual deemphasis and/or different visual effects selected from, for example, feathering, blurring, dimming, clipping and/or other visual deemphasis, and/or other differences in visual deemphasis, are used for different types of volumetric shapes. For example, as described with reference to FIG. 9H, application content elements at an edge of the elliptical cylindrical application volume (e.g., application user interface 9002-b) are feathered to a different degree (e.g., more feathered, or less feathered) than application content elements at an edge of a differently shaped application volume (e.g., a rectangular prismatic application volume of application user interface 8058 in FIG. 8P, or a cylindrical application volume of application user interface 8002 in FIG. 8A). Applying a first level of feathering visual effect to one or more edges of an application volume of a first shape and applying a second level of feathering visual effect to one or more edges of an application volume of a second shape, where the amount of feathering visual effect is based on the shape of the application volume, reduces visual discontinuities and helps to maintain the display of depth information of content in the volumetric application depending on the shape of the application volume, without displaying additional controls.

In some embodiments, aspects/operations of methods 12000, 13000, 15000, and 16000 may be interchanged, substituted, and/or added between these methods. For brevity, these details are not repeated here.

FIGS. 15A-15F are flow diagrams of an exemplary method 15000 for changing a display location of a user interface element based on a change in a viewpoint of the user, in accordance with some embodiments. In some embodiments, method 15000 is performed at a computer system (e.g., computer system 101 in FIG. 1) that is in communication with one or more display generation components (e.g., a head-mounted display (HMD), a heads-up display, a display, a touchscreen, a projector, or other types of display) (e.g., display generation component 120 in FIGS. 1A, 3A, and 4, or the display generation component 7100a in FIGS. 10A-10I), and one or more input devices (e.g., sensors, hardware controls for detecting user inputs, one or more optical sensors such as cameras (e.g., color sensors, infrared sensors, structured light scanners, and/or other depth-sensing cameras) that points downward at a user's hand or a camera that points forward from the user's head, eye-tracking devices, touch sensors, touch-sensitive surfaces, proximity sensors, motion sensors, buttons, crowns, joysticks, user-held and/or user-worn controllers, and/or other sensors and input devices) (e.g., one or more input devices 125 and/or one or more sensors 190 in FIG. 1A, or sensors 7101a-7101c and/or the digital crown 703 in FIGS. 10A-10I). In some embodiments, the method 15000 is governed by instructions that are stored in a non-transitory (or transitory) computer-readable storage medium and that are executed by one or more processors of a computer system, such as the one or more processors 202 of computer system 101 (e.g., control 110 in FIG. 1A). Some operations in method 15000 are, optionally, combined and/or the order of some operations is, optionally, changed.

The computer system displays (15002), via the one or more display generation components, a first view of a three-dimensional environment. The first view of the three-dimensional environment corresponds to a first viewpoint of a user, and includes a first three-dimensional application volume (e.g., an application window and/or application content that is bounded by a three-dimensional volume with a finite boundary (e.g., visible or invisible boundary) in one or more dimensions (e.g., in the horizontal dimension, in the vertical dimension, and/or in the depth dimension; and/or in the radial dimension and/or in the azimuthal dimension), such as a three-dimensional volumetric window of a cylindrical shape, a rectangular prism shape, a spherical shape, and/or other volumetric shapes) that corresponds to a respective application (e.g., a system application, such as an application or experience launcher application, a system control application, a settings application, and/or an application switcher application, or a user-installed application, such as a communication application, a telephony application, a gaming application, an exercise application, a meditation application, or other types of applications), and a first user interface object (e.g., a user interface object that is associated with the first three-dimensional application volume) that is displayed at a first position (e.g., and with a first orientation) relative to the first three-dimensional application volume (e.g., the first user interface object includes a system alert, a pop-up window, a modal window, a title bar, a resize affordance, a platform, a close affordance, a menu, and/or other control objects and/or window management objects of the respective application that are associated with the first three-dimensional application volume).

While displaying the first user interface object at the first position (e.g., and with the first orientation) relative to the first three-dimensional application volume, the computer system detects (15004) movement of a current viewpoint of the user from the first viewpoint to a second viewpoint. The second viewpoint is different from the first viewpoint (e.g., such that the user's perspective relative to the first three-dimensional application volume is changed, and a different view of the three-dimensional environment is visible).

In response to detecting (15006) the movement of the current viewpoint of the user from the first viewpoint to the second viewpoint (and in accordance with a determination that the movement of the current viewpoint meets object-repositioning criteria for the first three-dimensional application volume): in accordance with a determination that the first three-dimensional application volume meets first criteria (e.g., the first criteria are based on the shape and/or size of the three-dimensional application volume, and/or the settings of the three-dimensional application volume established by the developer of the application and/or user of the computer system), the computer system ceases (15008) to display the first user interface object at the first position and displays the first user interface object at a second position (e.g., with a second orientation) relative to the first three-dimensional application volume. The first criteria include a requirement that the first three-dimensional application volume is a first type of application volume in order to for the first criteria to be met. The second position is different from the first position (e.g., and the second orientation is different from the first orientation).

In response to detecting (15006) the movement of the current viewpoint of the user from the first viewpoint to the second viewpoint: in accordance with a determination that the first three-dimensional application volume meets second criteria (e.g., the second criteria are based on the shape and/or size of the three-dimensional application volume, and/or the settings of the three-dimensional application volume established by the developer of the application and/or user of the computer system), the computer system ceases (15010) to display the first user interface object at the first position and displays the first user interface object at a third position (e.g., with a third orientation) relative to the first three-dimensional application volume. The second criteria include a requirement that the first three-dimensional application volume is a second type of application volume in order for the first criteria to be met. The third position is different from the first position and the second position (e.g., and the third orientation is different from the first orientation and the second orientation).

In some embodiments, the first user interface object is not a viewpoint locked object in that it does not need to maintain a substantially fixed spatial relationship with the viewpoint as the viewpoint moves in the three-dimensional environment relative to the first three-dimensional application volume in one or more directions; instead, the first user interface object is generally locked to the location of the first three-dimensional application volume and moves along the surface of the first three-dimensional application volume and changes its orientation to face toward the current viewpoint of the user as the viewpoint of the user moves in the three-dimensional environment relative to the first three-dimensional application volume in one or more directions.

For example, as described with reference to FIGS. 10A-10B, the computer system 101 updates the display of the chair 8004 based on the shift in the viewpoint of the user 7002, to reveal a rear portion of the chair back 8006, while also displaying the first user interface element 10008 and the move affordance 10006 at respective updated positions that correspond to one of eight positions (e.g., position 10014-1, position 10014-2, position 10014-3, position 10014-4, position 10014-5, position 10014-6, position 10014-7, and position 10014-8) arranged around the cylindrical application user interface 10002.

Automatically repositioning an alert or other user interface object relative to a displayed three-dimensional application based on a current viewpoint of the user, including to different positions for different types of application volumes, makes it easier for the user to continue to view and/or interact with the alert or other user interface object even as the user's viewpoint moves relative to the three-dimensional application, thereby improving the visibility of the alert or other user interface element and providing the user with additional information and/or control options.

In some embodiments, the first user interface object includes (15012) a move affordance that is selectable to initiate repositioning of the first three-dimensional application volume relative to the three-dimensional environment. In some embodiments, while the first user interface object is selected by an input performed using an input element (e.g., a user's gaze, a user's hand, a controller, a mouse, a button, or other input element), the first three-dimensional application volume is moved in accordance with movement of the input element (e.g., with a greater magnitude of movement of the first application volume for a greater magnitude of movement of the input element, and a lesser magnitude of movement of the first application volume for a lesser magnitude of movement of the input element). For example, as described with reference to FIGS. 10A-10B, the computer system 101 updates the display of the chair 8004 based on the shift in the viewpoint of the user 7002, to reveal a rear portion of the chair back 8006, while also moving the move affordance 10006 to an updated position. Automatically repositioning a move affordance for a displayed three-dimensional application based on a current viewpoint of the user improves the visibility of and makes it easier for the user to access the move affordance even as the viewpoint of the user moves relative to the three-dimensional application, which reduces the amount of time and extent of inputs needed for the user to access control options for the three-dimensional application even from a different viewpoint relative to the three-dimensional application.

In some embodiments, the first three-dimensional application volume has (15014) a first application orientation relative to the three-dimensional environment while the current viewpoint of the user is the first viewpoint and while the current viewpoint of the user is the second viewpoint (e.g., before, after, and during the movement of the current viewpoint of the user from the first viewpoint to the second viewpoint). In some embodiments, the application orientation of the first three-dimensional application volume relative to the three-dimensional environment does not change based on movement of the current viewpoint of the user alone (e.g., the first three-dimensional application volume is world-locked while the user is merely moving their current viewpoint). In some embodiments, while the current viewpoint of the user is the second viewpoint, and the first three-dimensional application volume has the first application orientation relative to the three-dimensional environment, the computer system detects, via the one or more input devices, a selection input (e.g., an air pinch gesture, an air long pinch gesture, an air tap gesture, or other input) directed to the first user interface object (e.g., the first user interface object displayed at the second position and optionally with a second object orientation if the first criteria are met, or at the third position and optionally with a third object orientation if the second criteria are met). In some embodiments, in response to detecting the selection input directed to the first user interface object: the computer system ceases to display the first three-dimensional application volume with the first application orientation relative to the three-dimensional environment; and the computer system displays, via the one or more input devices, the first three-dimensional application volume with a second application orientation relative to the three-dimensional environment that is different from the first application orientation. In some embodiments, the second application orientation is based on the second viewpoint of the user (e.g., and the first user interface object continues to be displayed at the second position if the first criteria are met, or at the third position if the second criteria are met, optionally with a current orientation of the first user interface object updated from the second object orientation or third object orientation to a respective orientation that corresponds to the second application orientation of the first three-dimensional application volume). In some embodiments, while the selection input continues to be directed to the first user interface object, the first three-dimensional application volume is reoriented relative to the three-dimensional environment as the current viewpoint of the user moves (e.g., the application orientation of the first three-dimensional application volume is viewpoint-locked during the selection input). For example, as described with reference to FIGS. 10C-10D, in response to detecting the an air pinch gesture 8500-3 while the attention 8016 of the user 7002 is directed toward the move affordance 10006 (FIG. 10C), the computer system 101 reorients the move affordance 10006 to face a viewpoint of the user 7002, and the computer system 101 also reorients the application user interface 10002 to face the viewpoint of the user, such that the orientation of the chair 8004 in FIG. 10D, with respect to the viewpoint of the user 7002, is analogous to the orientation of the chair 8004 in FIG. 10A. Automatically shifting an orientation of the application while a moving affordance (e.g., grabber bar) is selected makes it easier for the user to view the application while the user is interacting with the moving affordance, thereby increasing visibility and legibility of the application and decreasing a number of user inputs required without requiring the user to readjust the user's viewpoint.

In some embodiments, the first user interface object includes (15016) an alert for the respective application (e.g., a notification or system alert). For example, as described with reference to FIGS. 10A-10B, the computer system 101 updates the display of the chair 8004 based on the shift in the viewpoint of the user 7002, to reveal a rear portion of the chair back 8006, while also moving the first user interface element 10008 to an updated position. Automatically repositioning an alert relative to a displayed three-dimensional application based on a current viewpoint of the user makes it easier for the user to continue to view and/or interact with the alert even as the user's viewpoint moves relative to the three-dimensional application, thereby improving the visibility and legibility of the alert and providing the user with additional information and/or control options.

In some embodiments, the first user interface object displayed at the first position relative to the first three-dimensional application volume is (15018) displayed with a first orientation. In some embodiments, the first user interface object displayed at the second position relative to the first three-dimensional application volume is displayed with a second orientation that is different from the first orientation. In some embodiments, the first user interface object that is displayed at the third position relative to the first three-dimensional application volume is displayed with a third orientation that is different from the first orientation (e.g., and from the second orientation). For example, as described with reference to FIGS. 10A-10B, the computer system 101 updates the display of the chair 8004 based on the shift in the viewpoint of the user 7002, to reveal a rear portion of the chair back 8006, while also displaying the first user interface element 10008 at an updated position that includes rotating the plane of the first user interface element 10008 so that the first user interface element 10008 remains oriented substantially perpendicular to the viewpoint of the user 7002. Automatically rotating and/or tilting an alert while repositioning the alert relative to a displayed three-dimensional application based on a current viewpoint of the user makes it easier for the user to continue to view and/or interact with the alert in an ergonomic manner even as the user's viewpoint moves relative to the three-dimensional application, thereby improving the visibility and legibility of the alert and providing the user with additional information and/or control options.

In some embodiments, the second position is (15020) selected from a first finite set of available positions relative to the first three-dimensional application volume for the first user interface object (e.g., the first set includes a finite number of positions); and the third position is selected from a second finite set of available positions relative to the first three-dimensional application volume for the first user interface object (e.g., the first finite set includes the first position, and the second finite set also includes the first position). In some embodiments, the first finite set and the second finite set are the same set. In some embodiments, the first finite set and the second finite set are different sets. In some embodiments, different sets are used for different types of application volume and/or for different applications. For example, as described with reference to FIG. 10A, the move affordance 10006 may be positioned at any of eight positions (e.g., position 10014-1, position 10014-2, position 10014-3, position 10014-4, position 10014-5, position 10014-6, position 10014-7, and position 10014-8) arranged around the application user interface 10002. Dynamically selecting a position from a plurality of possible positions at which to display a user interface object, and displaying the user interface object at the respective position, improves the visibility and legibility of the user interface object without requiring the user to provide additional inputs.

In some embodiments, the available positions in at least one of the first finite set of available positions and the second finite set of available positions are (15022) specified by one or more settings of the respective application (e.g., established by a developer of the application and/or user of the computer system, where the developer or user selects how many positions are to be included in the first finite set and/or the second finite set). For example, as described with reference to FIG. 10A, a developer of the application user interface 10002 is enabled to select the number of available locations at which a user interface element can be displayed to the user 7002. Enabling a setting to define the positions in the plurality of possible positions provides additional control options for a developer or user to select the plurality of possible positions, and improves the visibility and legibility of user interface objects displayed at respective positions of the plurality of possible positions without requiring additional user input.

In some embodiments, determining that the first three-dimensional application volume is the first type of application volume includes (15024) determining that the first three-dimensional application volume corresponds to a first application (e.g., a system application, such as an application or experience launcher application, a system control application, a settings application, and/or an application switcher application, or a user-installed application, such as a communication application, a telephony application, a gaming application, an exercise application, a meditation application, or other types of applications). In some embodiments, determining that the first three-dimensional application volume is the second type of application volume includes determining that the first three-dimensional application volume corresponds to a second application (e.g., a system application, such as an application or experience launcher application, a system control application, a settings application, and/or an application switcher application, or a user-installed application, such as a communication application, a telephony application, a gaming application, an exercise application, a meditation application, or other types of applications) that is different from the first application. In some embodiments, the first finite set of available positions (e.g., for an application volume corresponding to the first application) includes a first number of positions; and in some embodiments the second finite set of available positions (e.g., for an application volume corresponding to the second application) includes a second number of positions that is different from (e.g., greater than or less than) the first number of positions. In some embodiments, the number of available positions differs for different applications and/or for different volumetric shapes of the application volume corresponding to a respective application (e.g., an application volume with the first volumetric shape and corresponding to the first application has a first number of available positions, an application volume with the second volumetric shape and corresponding to the first application has a second number of available positions, an application volume with the first volumetric shape and corresponding to the second application has a third number of available positions, and/or an application volume with the second volumetric shape and corresponding to the second application has a fourth number of available positions). For example, as described with reference to FIG. 10A and FIG. 10F, the application user interface 10002 includes eight positions (e.g., position 10014-1, position 10014-2, position 10014-3, position 10014-4, position 10014-5, position 10014-6, position 10014-7, and position 10014-8) arranged around the application user interface 10002 at which the first user interface element 10008 may be displayed (FIG. 10A), whereas application user interface 10028 includes four positions (e.g., position 10040-1, position 10040-2, position 10040-3, and position 10040-4) arranged around the application user interface 10028 at which the second user interface element 10044 may be displayed (FIG. 10F). Providing a different set of possible positions at which to display respective user interface objects for different application volumes associated with different applications improves the visibility and legibility of the respective user interface objects for the respective application volume without requiring the user to provide additional inputs.

In some embodiments, determining that the first three-dimensional application volume is the first type of application volume includes (15026) determining that the first three-dimensional application volume has a first volumetric shape (e.g., cylindrical, spherical, or hemispherical). In some embodiments, determining that the first three-dimensional application volume is the second type of application volume includes determining that the first three-dimensional application volume has a second volumetric shape that is different from the first volumetric shape (e.g., rectangular or prismatic). In some embodiments, the first finite set of available positions (e.g., for the first volumetric shape) includes a first number of positions; and in some embodiments the second finite set of available positions (e.g., for the second volumetric shape) includes a second number of positions that is different from (e.g., greater than or less than) the first number of positions. For example, a cylindrical volume optionally has more (or alternatively fewer) available positions than a rectangular volume. In some embodiments, the number of available positions is based on a shape of a boundary of the application volume (e.g., in a respective plane, such as a baseplate of the application volume); for example, application volumes with rectangular baseplates optionally have fewer (or alternatively more) available positions than application volumes with circular baseplates. For example, as described with reference to FIG. 10A and FIG. 10F, the cylindrical application user interface 10002 includes eight positions (e.g., position 10014-1, position 10014-2, position 10014-3, position 10014-4, position 10014-5, position 10014-6, position 10014-7, and position 10014-8) arranged around the application user interface 10002 at which the first user interface element 10008 may be displayed (FIG. 10A), whereas the rectangular prismatic application user interface 10028 includes four positions (e.g., position 10040-1, position 10040-2, position 10040-3, and position 10040-4) arranged around the application user interface 10028 at which the second user interface element 10044 may be displayed (FIG. 10F). Providing a different set of possible positions at which to display respective user interface objects for different application volumes, including application volumes of different shapes, reduces the burden of the user to view the user interface object by displaying the user interface object at a position selected based at least in part on the shape of the application volume, thereby improving the visibility and legibility of the user interface object.

In some embodiments, the available positions of a respective finite set (e.g., the first finite set and/or the second finite set) are (15028) distributed relative to the first three-dimensional application volume (e.g., evenly, at regular or irregular intervals, or otherwise spaced apart from each other around a boundary of the first three-dimensional application volume). For example, as described with reference to FIG. 10A, top schematic 10012 illustrates the first user interface element 10008 being displayed at a first position 10014-1 out of multiple positions (e.g., position 10014-1, position 10014-2, position 10014-3, position 10014-4, position 10014-5, position 10014-6, position 10014-7, or position 10014-8) arranged around the application user interface 10002. Enabling a user interface object to be displayed at a respective position from a set of possible positions that are distributed around the application volume improves the visibility and legibility of the user interface object and reduces the visual discontinuities of displaying the user interface object with the application volume, without requiring the user to provide additional inputs and/or change the user's viewpoint.

In some embodiments, detecting the movement of the current viewpoint of the user from the first viewpoint to the second viewpoint includes (15030) detecting, via the one or more input devices, movement of the current viewpoint of the user through one or more (e.g., a plurality of) intermediate viewpoints between the first viewpoint and the second viewpoint. In some embodiments, in response to detecting the movement of the current viewpoint of the user through the one or more intermediate viewpoints between the first viewpoint and the second viewpoint: in accordance with a determination that the first three-dimensional application volume meets the first criteria, the computer system moves the first user interface object through one or more intermediate positions between the first position and the second position relative to the first three-dimensional application volume (e.g., the one or more intermediate positions between the first position and the second position corresponding respectively to the one or more intermediate viewpoints); and in accordance with a determination that the first three-dimensional application volume meets the second criteria, the computer system moves the first user interface object through one or more intermediate positions between the first position and the third position relative to the first three-dimensional application volume (e.g., the one or more intermediate positions between the first position and the third position corresponding respectively to the one or more intermediate viewpoints). In some embodiments, ceasing to display the first user interface object at the first position and display the first user interface object at a resulting position (e.g., the second position or the third position, depending on whether the first three-dimensional application volume meets the first criteria or the second criteria, respectively) includes or is achieved by the moving of the first user interface object through the one or more intermediate positions between the first position and the resulting position. For example, as described with reference to FIGS. 10A and 10B, the computer system 101 updates the display of the first user interface element 10008 gradually based on a movement of the viewpoint of the user 7002. Gradually updating a position of the user interface object as the viewpoint of the user changes over time allows the user to easily view and/or access the user interface object without requiring additional user inputs, thereby providing additional control options for the user as the user's viewpoint changes and reducing the number of inputs required for the user to interact with the user interface object.

In some embodiments, the movement of the current viewpoint of the user from the first viewpoint to the second viewpoint satisfies (15032) viewpoint movement criteria. In some embodiments, the movement of the current viewpoint of the user from the first viewpoint to the second viewpoint includes respective movement of the current viewpoint of the user from the first viewpoint to a respective viewpoint (e.g., an intermediate viewpoint) between the first viewpoint and the second viewpoint, wherein the respective movement does not satisfy the viewpoint movement criteria. In some embodiments, in response to detecting the respective movement of the current viewpoint of the user from the first viewpoint to the respective viewpoint, the computer system maintains display of the first user interface object at the first position. In some embodiments, ceasing to display the first user interface object at the first position and displaying the first user interface object at a respective position that is different from the first position (e.g., the second position if the first criteria are met, or the third position if the second criteria are met) is performed in accordance with a determination that the movement of the current viewpoint of the user from the first viewpoint to the second viewpoint satisfies the viewpoint movement criteria, and is not performed in accordance with a determination that the movement of the current viewpoint of the user from the first viewpoint to the second viewpoint does not satisfy the viewpoint movement criteria (e.g., even if the first criteria or the second criteria are met). For example, as described with reference to FIG. 10G, the computer system 101 updates the display of the second user interface element 10044 in accordance with a determination that a threshold associated with a movement of the viewpoint of the user 7002 is reached. The threshold may be a distance threshold dₜₕ of a movement of the viewpoint of the user 7002 (e.g., along a linear dimension, such as between 5-25% of a linear dimension of the application volume of the application user interface 10028). Automatically updating a position of the user interface object in response to detecting that the viewpoint of the user has moved in a way that satisfies viewpoint movement criteria allows the user to easily view and/or access the user interface object, even after the viewpoint of the user has changed, thereby providing additional control options for the user as the user's viewpoint changes and reducing the number of inputs required for the user to interact with the user interface object.

In some embodiments, the viewpoint movement criteria include (15034) a requirement that a magnitude of the movement of the current viewpoint of the user from the first viewpoint to the second viewpoint exceeds a threshold magnitude of viewpoint movement in order for the viewpoint movement criteria to be met (e.g., the second viewpoint is more than a threshold linear or angular distance from the first viewpoint). For example, as described with reference to FIG. 10G, the computer system 101 updates the display of the second user interface element 10044 in accordance with a determination that a threshold associated with a movement of the viewpoint of the user 7002 is reached. The threshold may be a distance threshold dₜₕ of a movement of the viewpoint of the user 7002 (e.g., along a linear dimension, such as between 5-25% of a linear dimension of the application volume of the application user interface 10028). Automatically updating a position of the user interface object in response to detecting that the viewpoint of the user has moved by at least a threshold amount of movement allows the user to easily view and/or access the user interface object, even after the viewpoint of the user has moved by at least the threshold amount of movement, thereby providing additional control options for the user as the user's viewpoint changes and reducing the number of inputs required for the user to interact with the user interface object.

In some embodiments, the viewpoint movement criteria include (15036) a requirement that the current viewpoint moves outside of a threshold range of viewpoints in order for the viewpoint movement criteria to be met (e.g., in moving to the second viewpoint, the current viewpoint of the user moves outside of the threshold one-, two-, or three-dimensional range of viewpoints, even if the current viewpoint has not moved more than a threshold linear or angular distance from the first viewpoint). For example, as described with reference to FIG. 10G, the second user interface element 10044 is displayed at the position 10040-1 while the viewpoint is within an angular range of 0°-90° with respect to a reference line 10047, at the position 10040-2 while the viewpoint is within an angular range of 91°-180° with respect to the reference line 10047, at the position 10040-3 while the viewpoint is within an angular range of 181°-270° with respect to the reference line 10047, or the position 10040-4, while the viewpoint is within an angular range 271°-360° with respect to the reference line 10047. Automatically updating a position of the user interface object in response to detecting that the viewpoint of the user has moved outside of a threshold range of viewpoints allows the user to easily view and/or access the user interface object, even after the viewpoint of the user has moved, thereby providing additional control options for the user as the user's viewpoint changes and reducing the number of inputs required for the user to interact with the user interface object.

In some embodiments, the computer system ceases (15038) to display the first user interface object at the first position includes displaying, via the one or more display generation components, the first user interface object progressing through a plurality of intermediate display states with decreasing visual emphasis (e.g., fading, blurring, increasing transparency, changing color, and/or other visual deemphasis, optionally until the first user interface object is no longer displayed). In some embodiments, displaying the first user interface object at a respective position that is different from the first position (e.g., at the second position or at the third position) includes displaying, via the one or more display generation components, the first user interface object progressing through a plurality of intermediate display states with increasing visual emphasis (e.g., brightening, sharpening, increasing opacity, changing color, and/or other visual emphasis, optionally until the first user interface object is fully displayed). In some embodiments, ceasing to display the first user interface object at the first position and displaying the first user interface object at a respective position of the second position or the third position is performed without displaying the first user interface object at an intermediate position that is different from the first position and from the respective position (e.g., without displaying the first user interface object at any position other than the first position or the respective position). For example, as described with reference to FIGS. 10F-10G, the computer system 101 updates the display locations of the second user interface element 10044 and the move affordance 10042 by fading out the second user interface element 10044 and the move affordance 10042 at the first position 10040-1 (e.g., as indicated by the outline 10052) and fading in the second user interface element 10044 and the move affordance 10042 at the second position 10040-2. Displaying the user interface object as fading out before redisplaying the user interface object as fading in at the updated position to move the user interface object in the three-dimensional environment reduces the computational power required to move the user interface object and provides improved visual feedback for the user.

In some embodiments, the first view of the three-dimensional environment includes (15040) a second user interface object (e.g., a user interface object that is associated with the first three-dimensional application volume) that is displayed at a respective position relative to the first three-dimensional application volume (e.g., the second user interface object includes a system alert, a pop-up window, a modal window, a title bar, a resize affordance, a platform, a close affordance, a menu, and/or other control objects and/or window management objects of the respective application that are associated with the first three-dimensional application volume). In some embodiments, the movement of the current viewpoint of the user from the first viewpoint to the second viewpoint is detected while displaying the second user interface object at the respective position relative to the first three-dimensional application volume. In some embodiments, in response to detecting the movement of the current viewpoint of the user from the first viewpoint to the second viewpoint: the computer system displays, via the one or more display generation components, the second user interface object at the respective position relative to the first three-dimensional application volume (e.g., whether the first three-dimensional application volume meets the first criteria or the second criteria). In some embodiments, in accordance with the determination that the first three-dimensional application volume meets the first criteria, the second user interface object is displayed at the respective position relative to the first three-dimensional application volume; and, in accordance with the determination that the first three-dimensional application volume meets the second criteria, the second user interface object is displayed also at the respective position relative to the first three-dimensional application volume. For example, as described with reference to FIGS. 10H-10I, the user 7002 has moved further leftward such that an angle θ_{c} that the viewpoint of the user 7002 makes with respect to the reference line 10060 is greater than the threshold angle, the computer system 101 displays the move affordance 10006 displayed at an updated location (e.g., position 10014-2 on the left of the user 7002) while the first user interface element 10008 remains at the original location at the position 10014-1 on the right side of the user 7002. Automatically moving a position of a first user interface object in response to detecting a change in viewpoint of the user, without moving a position of a second user interface object that is displayed at a position selected based on the user's viewpoint at the time of initially displaying the second user interface object, enables the user to easily access the first user interface object even as the viewpoint of the user changes and reduces the computational resources required by not moving the second user interface object.

In some embodiments, in response to detecting the movement of the current viewpoint of the user from the first viewpoint to the second viewpoint: in accordance with a determination that the first user interface object is (e.g., has been) configured by the respective application to change orientation in response to movement of the current viewpoint of the user, the computer system changes (15042) an orientation of the first user interface object; and in accordance with a determination that the first user interface object is not configured by the respective application to change orientation in response to movement of the current viewpoint of the user, the computer system forgoes changing the orientation of the first user interface object. In some embodiments, the respective application configures the first user interface object (or more generally, a set of one or more user interface objects that includes the first user interface object) to move in response to movement of the current viewpoint of the user (e.g., the respective application designates the first user interface object as movable in response to movement of the current viewpoint of the user). In some embodiments, the moving of the first user interface object and/or other user interface objects in the set based on the movement of the current viewpoint of the user is performed without providing information about the current viewpoint of the user to the respective application. For example, as described with reference to FIGS. 9G and 10A, a developer for the application user interface 9002-a and/or the application user interface 10002 is enabled to specify which user interface elements of the application user interface 9002-a and/or the application user interface 10002 have a plane that turns toward (e.g., being substantially perpendicular to) the viewpoint of the user 7002, for example, as described with reference to FIG. 9G, without the application user interface 9002-a and/or the application user interface 10002 being provided with actual information about the viewpoint of the user 7002. Enabling a setting of the application to control whether or not respective user interface objects dynamically turn and/or rotate to face the viewpoint of the user as the user's viewpoint changes, without providing the application with information about the user's viewpoint, provides additional control options to specify how to perform the automatic turning of user interface objects and improves the privacy and security of the device by limiting the information shared with the application.

In some embodiments, in accordance with the determination that the first user interface object is configured by the respective application to change orientation in response to movement of the current viewpoint of the user, the computer system changes (15044) the orientation of the first user interface object (e.g., transitioning the first user interface object through a plurality of intermediate orientations) during the movement of the current viewpoint of the user from the first viewpoint to the second viewpoint (e.g., or at least in response to detecting the movement of the current viewpoint away from the first viewpoint). For example, as described with reference to FIG. 9G, the respective orientation of the billboards 9016-1, 9016-2, 9016-3, and 9016-4 may be changed continuously in response to detecting a corresponding change in the movement of the viewpoint of the user 7002. Automatically updating user interface objects to dynamically turn and/or rotate as the user's viewpoint changes improves the legibility and visibility of the user interface objects without requiring additional user inputs.

In some embodiments, in response to detecting the movement of the current viewpoint of the user from the first viewpoint to the second viewpoint: in accordance with the determination that the first user interface object is configured by the respective application to change orientation in response to movement of the current viewpoint of the user: the computer system forgoes (15046) changing the orientation of the first user interface object prior to detecting at least a threshold amount of movement of the current viewpoint of the user away from the first viewpoint; and the computer system changes the orientation of the first user interface object in response to detecting at least the threshold amount of movement of the current viewpoint of the user away from the first viewpoint (e.g., optionally the same or different threshold as the threshold magnitude of viewpoint movement discussed herein with respect to operation 15034). For example, as described with reference to FIG. 10G, the computer system 101 updates the display of the second user interface element 10044 in accordance with a determination that a threshold associated with a movement of the viewpoint of the user 7002 is reached. Automatically updating user interface objects to dynamically turn and/or rotate as the user's viewpoint changes by at least a threshold amount of movement improves the legibility and visibility of the user interface objects after the viewpoint of the user has moved by at least the threshold amount of movement without requiring additional user inputs.

In some embodiments, in response to detecting the movement of the current viewpoint of the user from the first viewpoint to the second viewpoint, and in accordance with a determination that the movement of the current viewpoint of the user from the first viewpoint to the second viewpoint includes less than a threshold amount of movement during a threshold amount of time (e.g., 0.5 seconds, 1 second, 2 seconds, 5 seconds, 10 seconds, or 30 seconds), displaying the first user interface object at a respective position of the second position and the third position (e.g., where the respective position is determined in accordance with whether the first three-dimensional application meets the first criteria or the second criteria). In some embodiments, in response to detecting the movement of the current viewpoint of the user from the first viewpoint to the second viewpoint, and in accordance with a determination that the movement of the current viewpoint of the user from the first viewpoint to the second viewpoint includes more than a threshold amount of movement during a threshold amount of time, the computer system maintains displays of the first user interface object at the first position. For example, in FIG. 19F, after an amount of time t1 (e.g., 5 ms, 50 ms, 500 ms, 1 s, 2 s, or another time value) has elapsed after the movement of the viewpoint of the user 7002 has dropped below a movement threshold (e.g., less than 50 mm, 40 mm, 30 mm, 20 mm, 10 mm, or another value) or has stopped (e.g., since the viewpoint of the user 7002 has remained substantially stationary), the computer system 101 redisplays the movement affordance 19014 at an updated anchoring point (e.g., the anchoring point 19040-2, at a time A2).

In some embodiments, aspects/operations of methods 12000, 13000, 14000, and 16000 may be interchanged, substituted, and/or added between these methods. For brevity, these details are not repeated here.

FIGS. 16A-16C are flow diagrams of an exemplary method 16000 for resolving spatial conflicts between content elements within a three-dimensional environment with respect to a viewpoint of the user, in accordance with some embodiments. In some embodiments, method 16000 is performed at a computer system (e.g., computer system 101 in FIG. 1) that is in communication with one or more display generation components (e.g., a head-mounted display (HMD), a heads-up display, a display, a touchscreen, a projector, or other types of display) (e.g., display generation component 120 in FIGS. 1A, 3A, and 4, or the display generation component 7100a in FIGS. 11A-11F), and one or more input devices (e.g., sensors, hardware controls for detecting user inputs, one or more optical sensors such as cameras (e.g., color sensors, infrared sensors, structured light scanners, and/or other depth-sensing cameras) that points downward at a user's hand or a camera that points forward from the user's head, eye-tracking devices, touch sensors, touch-sensitive surfaces, proximity sensors, motion sensors, buttons, crowns, joysticks, user-held and/or user-worn controllers, keyboards, audio input devices (e.g., microphone), and/or other sensors and input devices) (e.g., one or more input devices 125 and/or one or more sensors 190 in FIG. 1A, or sensors 7101a-7101c and/or the digital crown 703 in FIGS. 11A-11F). In some embodiments, the method 16000 is governed by instructions that are stored in a non-transitory (or transitory) computer-readable storage medium and that are executed by one or more processors of a computer system, such as the one or more processors 202 of computer system 101 (e.g., control 110 in FIG. 1A). Some operations in method 16000 are, optionally, combined and/or the order of some operations is, optionally, changed.

The computer system displays (16002), via the one or more display generation components, a first view of a three-dimensional environment. The first view of the three-dimensional environment corresponds to a first viewpoint of a user, and includes a first three-dimensional application volume (e.g., an application window and/or application content that is bounded by a three-dimensional volume with a finite boundary (e.g., visible or invisible boundary) in one or more dimensions (e.g., in the horizontal dimension, in the vertical dimension, and/or in the depth dimension; and/or in the radial dimension and/or in the azimuthal dimension), such as a three-dimensional volumetric window of a cylindrical shape, a rectangular prism shape, a spherical shape, and/or other volumetric shapes) that corresponds to a first application (e.g., a system application, such as an application or experience launcher application, a system control application, a settings application, and/or an application switcher application, or a user-installed application, such as a communication application, a telephony application, a gaming application, an exercise application, a meditation application, or other types of applications). The first three-dimensional application volume confines content of the first application, including a first portion of the content of the first application and a second portion of the content of the first application, in two or more dimensions (e.g., horizontal dimension, vertical dimension, and/or depth dimension, or radial dimension and azimuthal dimension).

While displaying the first view of the three-dimensional environment, including the first three-dimensional application volume that confines the content of the first application in the two or more dimensions, the computer system detects (16004) that user interface focus (e.g., based on a location of attention of the user and/or based on a change in where input focus is directed) is directed to the first portion of the content of the first application. In some embodiments, the user interface focus is directed to the first portion of the content of the first application based on the user's gaze being directed to or toward the first portion of the content, a selection input, a voice input, and/or a keyboard or controller input, or based on an automatic event (e.g., highlighting a search field either automatically or in response to the equivalent of a “tab” input).

In response to detecting (16006) that the user interface focus is directed to the first portion of the content of the first application: in accordance with a determination that the first portion of the content of the first application is behind the second portion of the content of the first application relative to the first viewpoint of the user, the computer system changes (16008) one or more visual properties of the second portion of the content of the first application to increase a visibility of the first portion of the content of the first application.

In response to detecting (16006) that the user interface focus is directed to the first portion of the content of the first application: in accordance with a determination that the first portion of the content of the first application is not behind the second portion of the content of the first application relative to the first viewpoint of the user (e.g., the first portion and the second portion do not overlap, or the first portion is in front of the second portion, as would be perceived from the first viewpoint of the user), the computer system forgoes (16010) changing the one or more visual properties of the second portion of the content of the first application to increase a visibility of the first portion of the content of the first application. In some embodiments, in accordance with a determination that the first portion of the content of the first application is not behind the second portion of the content of the first application (e.g., if the second portion of the content of the first application is behind the first portion of the content of the first application), the computer system optionally changes one or more visual properties of the first portion of the content of the first application to increase a visibility of the first portion of the content of the first application relative to the second portion of the content of the first application.

For example, as described with reference to FIGS. 11A-11B, in response to detecting that the attention 11029 of the user 7002 is directed to a search menu 11016 within the application user interface 11002 and that the search menu 11016 is displayed behind a building 11004 from a viewpoint of the user 7002, the computer system 101 changes a visual property of a portion of the building 11004 such that a left portion 11017-a of the search menu 11016 that is behind (e.g., obscured by) the building 11044 (in FIG. 11A) becomes visible from the viewpoint of the user 7002.

Changing one or more visual properties of a first portion of the content of a volumetric application to increase a visibility of another portion of the content of the volumetric application that has user interface focus and is behind the first portion of the content from a viewpoint of the user reduces the number of inputs and amount of time needed to display relevant information to the user while maintaining display of depth information within the volumetric application, without displaying additional controls.

In some embodiments, the computer system detects (16012) that user interface focus (e.g., based on a location of attention of the user and/or based on a change in where input focus is directed, such as by highlighting a search field either automatically or in response to the equivalent of a “tab” input) is directed to the second portion of the content of the first application. In some embodiments, the user interface focus is directed to the second portion of the content of the first application based on the user's gaze being directed to or toward the second portion of the content, a selection input, a voice input, and/or a keyboard or controller input, or based on an automatic event. In response to detecting that the user interface focus is directed to the second portion of the content of the first application: in accordance with a determination that the second portion of the content of the first application is behind the first portion of the content of the first application relative to the first viewpoint of the user, the computer system changes one or more visual properties of the first portion of the content of the first application to increase a visibility of the second portion of the content of the first application. In some embodiments, in response to detecting that the user interface focus is directed to the second portion of the content of the first application, in accordance with a determination that the second portion of the content of the first application is not behind the first portion of the content of the first application relative to the first viewpoint of the user (e.g., the first portion and the second portion do not overlap, or the second portion is in front of the first portion, as would be perceived from the first viewpoint of the user), the computer system forgoes changing the one or more visual properties of the first portion of the content of the first application to increase a visibility of the second portion of the content of the first application. For example, as described with reference to FIGS. 11A-11B, in response to detecting that the user interface focus is directed toward the search menu 11016, and in accordance with a determination that a portion of the building 11004 spatially conflicts, from the viewpoint of the user 7002, with the search menu 11016 to which the attention of the user 7002 is directed, the computer system 101 changes, via the one or more display generation components, one or more visual properties of a middle portion 11005-a of the building 11004 to increase visibility of a previously obscured portion of search menu 11016 (e.g., left portion 11017-a) with respect to the viewpoint of user 7002. As user interface focus moves to different portions of the content of a volumetric application, changing one or more visual properties of other portions of the content of the volumetric application to increase a visibility of the portion of the content of the volumetric application that has user interface focus, if positioned behind the other portions of the content from a viewpoint of the user, reduces the number of inputs and amount of time needed to display relevant information to the user while maintaining display of depth information within the volumetric application, without displaying additional controls.

In some embodiments, determining that the first portion of the content of the first application is not behind the second portion of the content of the first application relative to the first viewpoint of the user includes (16014) determining that the first portion of the content of the first application and the second portion of the content of the first application do not overlap relative to (e.g., from the perspective of) the first viewpoint of the user. For example, as described with reference to FIGS. 11A-11B, a right portion 11017-b of the search menu 11016 is not obscured by the building 11004 from the viewpoint of the user 7002, so the computer system 101 forgoes changing one or more visual properties of additional portions of the building 11004. Forgoing changing one or more visual properties of other portions of the content of the volumetric application that do not impact a visibility of the portion of the content of the volumetric application that has user interface focus, for example if already positioned in front of the other portions of the content from a viewpoint of the user, reduces the number of inputs, amount of time, and computational resources needed to display relevant information to the user while maintaining display of depth information within the volumetric application.

In some embodiments, the computer system detects (16016) that the user interface focus is directed to the first portion of the content of the first application includes the computer system detecting, via the one or more input devices, that gaze of the user is directed to the first portion of the content of the first application (e.g., gaze having a dwell time that meets a time threshold). For example, as described with reference to FIGS. 11A-11B, in response to detecting the gaze of the user 7002 being directed to the search menu 11016 within the application user interface 11002, the computer system 101 shifts the user interface focus to the search menu 11016. Changing where user interface focus is directed in a volumetric application based on where the gaze of the user is directed reduces physical strain on the user and reduces the number of inputs and amount of time needed to display relevant information to the user while maintaining display of depth information within the volumetric application.

In some embodiments, the computer system detects (16018) that the user interface focus is directed to the first portion of the content of the first application includes the computer system detecting, via the one or more input devices, that a gaze of the user is directed to the first portion of the content of the first application and detecting a selection input (e.g., an air pinch gesture, an input from a controller, and/or a movement of a portion of the user's body). In some embodiments, the selection input is (e.g., must be) performed concurrently with the gaze of the user being directed to the first portion of the content, while the gaze of the user is directed to the first portion of the content, or optionally after a dwell time of the gaze meets a time threshold. For example, as described with reference to FIGS. 11A-11B, in response to detecting the gaze of the user 7002 being directed to the search menu 11016 within the user interface 11002 of the volumetric application in conjunction with detecting a selection input, the computer system 101 shifts the user interface focus to the search menu 11016. Changing where user interface focus is directed in a volumetric application based on where the gaze of the user is directed in combination with a selection input reduces physical strain on the user while also requiring an indication of user intent to reduce mistakes in changing in user interface focus.

In some embodiments, the computer system detects (16020) that the user interface focus is directed to the first portion of the content of the first application includes the computer system detecting, via the one or more input devices, an audio input (e.g., a voice input) indicating that the user interface focus is to be directed to the first portion of the content of the first application. For example, as described with reference to FIGS. 11A-11B, user interface focus is optionally directed to the search menu 11016 based on a verbal input or a voice input that highlights the search menu 11016. Changing one or more visual properties of the second portion of the content of the volumetric application to increase the visibility of the first portion of the content of the volumetric application that has user interface focus and is behind the second portion of the content from a viewpoint of the user reduces the number of inputs and amount of time needed to display relevant information to the user while maintaining display of depth information within the volumetric application, without displaying additional controls.

In some embodiments, the computer system detects (16022) that the user interface focus is directed to the first portion of the content of the first application includes the computer system detecting, via the one or more input devices (e.g., a keyboard, controller, or other input device), a user input directing the user interface focus (e.g., moving the user interface focus or otherwise causing the user interface focus to be directed) to the first portion of the content of the first application (e.g., a tab key input, an arrow key input, a next button press, or other input). For example, as described with reference to FIGS. 11A-11B, user interface focus is directed to the search menu 11016 based on a keyboard or other input that highlights the search menu 11016. Changing one or more visual properties of the second portion of the content of the volumetric application to increase the visibility of the first portion of the content of the volumetric application that has user interface focus and is behind the second portion of the content from a viewpoint of the user reduces the number of inputs and amount of time needed to display relevant information to the user while maintaining display of depth information within the volumetric application, without displaying additional controls.

In some embodiments, the computer system detects (16024) that the user interface focus is directed to the first portion of the content of the first application includes the computer system detecting an event (e.g., an automatic event) that is independent of user input (e.g., during a tutorial or a preset system transition, and/or an alert generated by the first application) directing the user interface focus (e.g., moving the user interface focus or otherwise causing the user interface focus to be directed) to the first portion of the content of the first application. For example, as described with reference to FIGS. 11C and 11D, user interface focus automatically shifts to the search menu bar 11034 as the tutorial progresses from a first page 11032-1 to a second page 11032-2. Changing one or more visual properties of the second portion of the content of the volumetric application to increase the visibility of the first portion of the content of the volumetric application that has user interface focus and is behind the second portion of the content from a viewpoint of the user reduces the number of inputs and amount of time needed to display relevant information to the user while maintaining display of depth information within the volumetric application, without displaying additional controls.

In some embodiments, while displaying the second portion of the content of the first application with the one or more changed visual properties to increase the visibility of the first portion of the content of the first application (e.g., in accordance with the determination that the first portion of the content is behind the second portion of the content), the computer system detects (16026) an event that corresponds to a change in size and/or position of the first portion of the content of the first application (e.g., the change to the first portion of the content of the first application includes an increase in size of the first portion of the content, the increase in size is due to additional application content being included in the first portion of the content of the first application, such as returned search results, or other output generated by the computer system). In response to detecting the change in size and/or position of the first portion of the content of the first application: in accordance with a determination that the changed first portion of the content of the first application is behind one or more additional portions of the content of the first application, adjacent to the second portion of the content of the first application, relative to the first viewpoint of the user, the computer system changes one or more visual properties of the one or more additional portions adjacent to the second portion of the content of the first application to increase a visibility of the changed first portion of the content of the first application. In some embodiments, in accordance with a determination that the changed first portion of the content of the first application is not behind one or more additional portions of the content of the first application, adjacent to the second portion of the content of the first application, relative to the first viewpoint of the user, maintaining one or more visual properties of the one or more additional portions adjacent to the second portion of the content of the first application. For example, as described with reference to FIG. 11E, in accordance with a determination that the expanded search bar 11036 is behind additional portions of the content of the application user interface 11002 of the volumetric application, the computer system 101 adds new breakthrough regions 11032-3 and 11032-5 adjacent to the expanded search bar 11036 and changes a visual property of the breakthrough region 11032-4 adjacent to the expanded search bar 11036 such that the breakthrough region 11032-4 is an enlarged breakthrough region that encompasses breakthrough region 11032-1. Changing one or more visual properties of the one or more additional portions adjacent to the second portion of the content of the first application reduces the number of inputs and amount of time needed to display updated information that is of relevance to the user while maintaining display of depth information within the volumetric application, without displaying additional controls.

In some embodiments, the computer system changes (16028) the one or more visual properties of the second portion of the content of the first application to increase the visibility of the first portion of the content of the first application includes ceasing to display at least a portion of the second portion of the content (e.g., that overlaps with or blocks the first portion of the content of the first application relative to the first viewpoint of the user). In some embodiments, regions of the second portion of the content that do not obscure the first portion of the content relative to the first viewpoint of the user remain displayed. For example, as described with reference to FIG. 11B, the computer system 101 changes a visual property of the middle portion 11005-a of the building 11004 that would otherwise occlude part of the search menu 11016 by removing content from the middle portion 11005-a (e.g., forgoing displaying the middle portion 11005-a, and/or ceasing to display the middle portion 11005-a) such that the left portion 11017-a of the search menu 11016 becomes visible from the viewpoint of the user 7002 via the removal of the middle portion 11005-a. Removing a part of the second portion of the content of the volumetric application reduces the number of inputs and amount of time needed to display relevant information to the user while maintaining display of depth information within the volumetric application, without displaying additional controls.

In some embodiments, ceasing to display at least the portion of the second portion of the content includes ceasing to display a portion of the second portion of the content that conforms to (e.g., overlaps, corresponds to a silhouette and/or follows an outline/border of, and/or is a scaled replica of the first portion that includes a buffer border around its original silhouette) at least a portion of a shape of the first portion. For example, in FIG. 11P, the shape of the breakthrough region 11117-2 corresponds to a silhouette of the right portion of the enlarged user interface element 11110 that is behind the user interface element 11106.

In some embodiments, the computer system changes (16030) the one or more visual properties of the second portion of the content of the first application to increase the visibility of the first portion of the content of the first application includes the computer system decreasing an opacity of (e.g., one or more regions of) the second portion of the content (e.g., to increase the visibility of the first portion of the content through the reduced opacity region(s) of the second portion of the content, that for example overlaps with or blocks the first portion of the content of the first application relative to the first viewpoint of the user). For example, as described with reference to FIGS. 11A-11B, the computer system 101 changes a visual property of a portion of the building 11004 by decreasing an opacity of the portion of the building 11004 such that the left portion 11017-a of the search menu 11016 becomes visible from the viewpoint of the user 7002 through the portion of the building 11004 that has become more transparent. Decreasing the opacity of the second portion of the content of the volumetric application reduces the number of inputs and amount of time needed to display relevant information to the user while maintaining display of depth information within the volumetric application, without displaying additional controls.

In some embodiments, decreasing the opacity of the second portion of the content includes decreasing the opacity of the second portion of the content in accordance with a change in viewpoint of the user from the first viewpoint of the user to a second viewpoint of the user that is different from the first viewpoint of the user. In some embodiments, in accordance with a determination that the first viewpoint changes from a first viewpoint position to a second viewpoint position, decreasing the opacity of the second portion by a first amount (e.g., that has an increased magnitude of the decrease in opacity compared to the decrease in opacity at the first viewpoint position); in accordance with a determination that the first viewpoint changes from the first viewpoint position to a third viewpoint position different from the second viewpoint position, decreasing the opacity of the second portion by a second amount different from the first amount (e.g., that has a decreased magnitude of the decrease in opacity compared to the decrease in opacity at the first viewpoint position). In some embodiments, the second viewpoint position is closer to the second portion of the content than the first viewpoint position, and the third viewpoint position is further from the second portion of the content than the first viewpoint position, and the second amount is smaller than the first amount. In some embodiments, the second viewpoint position is closer to the second portion of the content than the first viewpoint position, and the third viewpoint position is further from the second portion of the content than the first viewpoint position, and the second amount is larger than the first amount. For example, in FIG. 11M, the computer system 101 changes an opacity of the breakthrough region 11091-1 as the viewpoint of the user 7002 moves. The edge 11096 and the edge 11090 are less opaque in FIG. 11M than the edge 11096 and the edge 11090 in FIG. 11L.

In some embodiments, the computer system changes (16032) one or more visual properties of the second portion of the content of the first application to increase the visibility of the first portion of the content of the first application includes the computer system applying a feathering visual effect to one or more regions (e.g., peripheral regions, borders, and/or edges) of the second portion of the content (e.g., by gradually decreasing an opacity of the second portion of the content as a distance to a center of the first portion of the content decreases, to soften edges of the second portion of the content to provide a smoother transition to content of the first application adjacent to the second portion of the content (e.g., including the first portion of the content), and/or to soften edges of the second portion of the content to provide a smoother transition between different regions of the second portion of the content, such as between regions of the second portion of the content with changed visual properties and regions without changed visual properties). In some embodiments, the one or more (e.g., feathered) regions of the second portion of the content are further decreased in opacity relative to other regions of the second portion of the content. For example, as described with reference to FIG. 11F, an opacity of the edges of the breakthrough region 11032-6 (e.g., an edge 11040-1) gradually decreases as a distance from a center of the content (e.g., a center of the system alert 11038) decreases. Portions of the breakthrough region 11032-6 nearer an edge 11040-2 are less opaque (e.g., more translucent) than the portions of the breakthrough region 11032-6 nearer an edge 11040-1, due to the edge 11040-2 being closer to the center of the system alert 11038 than the edge 11040-1. Applying a feathering visual effect to one or more regions of the second portion of the content reduces visual discontinuities and helps to maintain the display of depth information of content within the volumetric application, without displaying additional controls.

In some embodiments, while displaying the first view of the three-dimensional environment, the computer system detects (16034) occurrence of a first event (e.g., the first event is associated with the first application, a system-generated event, a change in contextual conditions, and/or one or more user inputs that are associated with the first application, such as an input or event that causes generation of a pop-up alert, new content, new window, modal window, banner, and/or navigation to another user interface of the first application); and in response to detecting the occurrence of the first event: the computer system displays, via the one or more display generation components, a first user interface object (e.g., an alert, a system user interface object, such as a notification, a modal window, a banner, a pop-up, a user interface object that requires user input in order to be dismissed) at a first location within the first three-dimensional application volume, including, in accordance with a determination that the first user interface object at the first location is behind a respective portion of the content of the first application (e.g., displayed in the first three-dimensional application volume), changing one or more visual properties of the respective portion of the content of the first application to increase a visibility of the first user interface object. In some embodiments, the first user interface object is displayed in accordance with a determination that various criteria are met as described herein with reference to method 12000. In some embodiments, in accordance with a determination that the first user interface object at the first location is not behind the respective portion of the content of the first application, the computer system forgoes changing one or more visual properties of the respective portion of the content of the first application to increase the visibility of the first user interface object. For example, as described with reference to FIG. 11F, in response to detecting that a battery level of the computer system 101 has dropped below a preset level, the computer system 101 displays a system alert 11038 within the application user interface 11002. Due to respective portions of the system alert 11038 being positioned behind (e.g., obscured by) corresponding portions of content of the application user interface 11002 from the viewpoint of the user 7002, the computer system 101 changes visual properties of corresponding portions of the content of the application user interface 11002 such that the respective portions of the system alert 11038 become visible from the viewpoint of the user 7002. Changing one or more visual properties of a respective portion of the content of the volumetric application to increase a visibility of the first user interface object that has user interface focus and is behind the respective portion of the content from the viewpoint of the user reduces the number of inputs and amount of time needed to display relevant information to the user while maintaining display of depth information of the content within the volumetric application, without displaying additional controls.

In some embodiments, after changing the one or more visual properties of the second portion of the content of the first application to increase the visibility of the first portion of the content of the first application, and while displaying the second portion of the first application with the changed visual properties that increase the visibility of the first portion of the content of the first application, detecting, via the one or more input devices, a user input directed toward the first portion of the content of the first application that is behind the second portion of the content of the first application relative to the first viewpoint; and in response to detecting the user input directed toward the first portion of the content of the first application that is behind the second portion of the content of the first application relative to the first viewpoint, performing an operation associated with the first portion of the content of the first application that is behind the second portion of the content of the first application relative to the first view (e.g., and forgoing performing an operation associated with the second portion of the first application that is closer to the first viewpoint of the user). For example, in FIG. 11L, in response to detecting a selection input directed toward the breakthrough region 11087-1, the computer system 101 delivers the selection input to (e.g., considers the selection input to be directed toward and/or corresponding to) the user interface element 11064 that is displayed further away from the viewpoint of the user 7002, and rendered visible to the user 7002 by the breakthrough region 11087-1 (e.g., instead of delivering the selection input to the user interface element 11086 that is closer to the viewpoint of the user 7002).

In some embodiments, changing one or more visual properties of the second portion of the content of the first application to increase the visibility of the first portion of the content of the first application includes: in accordance with a determination that one or more application content elements of the first application are displayed in front of the first portion of the content of the first application relative to the first viewpoint of the user, changing one or more visual properties of the one or more application content elements of the first application to increase the visibility of the first portion of the content of the first application; and in accordance with a determination that one or more application content elements of the first application are displayed behind the first portion of the content of the first application relative to the first viewpoint of the user (e.g., the first portion and the one or more application content elements of the first application do not overlap, or the first portion is in front of the one or more application content elements of the first application, as would be perceived from the first viewpoint of the user), forgoing changing the one or more visual properties of the one or more application content elements of the first application to increase the visibility of the first portion of the content of the first application. In some embodiments, in accordance with a determination that the one or more application content elements of the first application are not behind the first portion of the content of the first application (e.g., if the one or more application content elements of the first application are behind the first portion of the content of the first application), the computer system optionally changes one or more visual properties of the first portion of the content of the first application to increase a visibility of the first portion of the content of the first application relative to the one or more application content elements of the first application. For example, in FIG. 11I, the user interface element 11068 is displayed in front of the user interface element 11064 and behind the user interface element 11066 from the viewpoint of the user 7002. In response to detecting that the attention 11029 of the user 7002 (e.g., based on gaze of the user 7002 or a proxy for gaze) is directed toward the user interface element 11068, the computer system 101 displays additional portions of the user interface element 11068 to the user 7002 by changing one or more visual properties of the user interface element 11066 without changing one of more visual properties of the user interface element 11064.

In some embodiments, changing the one or more visual properties of the second portion of the content of the first application to increase a visibility of the first portion of the content of the first application includes: in accordance with a determination that the second portion of the content of the first application includes two-dimensional content, changing one or more visual properties of the second portion of the content of the first application by applying a first visual effect (e.g., blending, such as alpha blending with a background to create an appearance of partial or full transparency of the two-dimensional content) to reduce visibility of the two-dimensional content; and in accordance with a determination that the second portion of the content of the first application includes three-dimensional content, changing one or more visual properties of the second portion of the content of the first application by applying a second visual effect that is different from the first visual effect (e.g., clipping, removing, or truncating the three-dimensional content, optionally, to reduce visibility of the three-dimensional content). For example, in FIG. 11Q, a first visual effect (e.g., blending, clipping, masking, or breaking through) is applied to a first type of content (e.g., two-dimensional application content, three-dimensional application content, interactive application content, non-interactive application content, content displayed in an immersive mode, and/or content displayed in a non-immersive mode) to display a first breakthrough region, and a second visual effect (e.g., the same as the first visual effect, or different from the first visual effect, such as blending, clipping, masking, or breaking through) is applied to a second type of content different from the first type of content (e.g., two-dimensional application content, three-dimensional application content, interactive application content, non-interactive application content, content displayed in an immersive mode, and/or content displayed in a non-immersive mode).

In some embodiments, applying the second visual effect to reduce visibility of the three-dimensional content that is different from applying the first visual effect to reduce visibility of the two-dimensional content is performed in accordance with one or more settings of the first application (e.g., established by the developer of the application and/or user of the computer system). In some embodiments, in response to detecting that the user interface focus is directed to the first portion of the content of the first application: in accordance with a determination that a respective setting of the first application is enabled (e.g., established by the developer of the application and/or user of the computer system), the computer system applies the second visual effect to reduce visibility of the three-dimensional content, whereas in some embodiments, in accordance with a determination that the respective setting of the first application is not enabled, the computer system maintains applies a third visual effect (e.g., breakthrough) to reduce visibility of the three-dimensional content. For example, in FIG. 11Q, a developer of the application associated with a respective application user interface is able to set the types of visual effects by configuring one or more system settings associated with the respective application user interface.

In some embodiments, prior to detecting that the user interface focus is directed to the first portion of the content of the first application, displaying, via the one or more display generation components, a second three-dimensional application volume that corresponds to a second application (e.g., a system application, such as an application or experience launcher application, a system control application, a settings application, and/or an application switcher application, or a user-installed application, such as a communication application, a telephony application, a gaming application, an exercise application, a meditation application, or other types of applications) that is different from the first application, wherein the second three-dimensional application volume confines content of the second application; after changing the one or more visual properties of the second portion of the content of the first application to increase a visibility of the first portion of the content of the first application, detecting that the user interface focus (e.g., based on a location of attention of the user and/or based on a change in where input focus is directed) is directed to a portion of the content of the second application; in response to detecting that the user interface focus is directed to (e.g., has changed to) the portion of the content of the second application: in accordance with a determination that the portion of the content of the second application is behind a portion of the content of the first application (e.g., different from the first portion of the content of the first application and different from the second portion of the content of the first application) relative to the first viewpoint of the user: changing one or more visual properties of the portion of the content of the first application to increase a visibility of the portion of the content of the second application; and maintaining the changes to the one or more visual properties of the second portion of the content of the first application to increase the visibility of the first portion of the content of the first application while the portion of the content of the second application remains behind the portion of the content of the first application. In some embodiments, in accordance with a determination that the portion of the content of the second application is not behind the portion of the content of the first application (e.g., different from the first portion of the content of the first application and different from the second portion of the content of the first application) relative to the first viewpoint of the user, forgoing changing one or more visual properties of the portion of the content of the first application to increase a visibility of the portion of the content of the second application and maintaining the one or more visual properties of the second portion of the content of the first application that were changed to increase the visibility of the first portion of the content of the first application.

In some embodiments, while maintaining the changes to the one or more visual properties of the second portion of the content of the first application to increase the visibility of the first portion of the content of the first application, the computer system detects that the portion of the content of the second application is no longer behind the portion of the content of the first application. In response to detecting that the portion of the content of the second application is no longer behind the “portion of the content of the first application, the computer system 100 at least partially reverses the changes to the one or more visual properties of the portion of the content of the first application. For example, in FIG. 11Q, regions of the user interface element 11110 that are themselves a part of the breakthrough region 11117-1 and other portions of the breakthrough region 11117-1 that are not changed to display the breakthrough region 11119-2 of the application user interface 11112.

In some embodiments, displaying, via the one or more display generation components, a third portion of the content of the first application in the first view of the three-dimensional environment, wherein the first portion of the content, the second portion of the content, and the third portion of the content are each displayed at distinct distances relative to the first viewpoint of the user; while displaying the first view of the three-dimensional environment, detecting that the user interface focus (e.g., based on a location of attention of the user and/or based on a change in where input focus is directed) is directed to (e.g., has changed to) the third portion of the content of the first application (e.g., the user interface focus moves from the first portion of the content of the first application to the third portion of the content of the first application); and in response to detecting that the user interface focus is directed to the third portion of the content of the first application: in accordance with a determination that the third portion of the content of the first application is behind both the first portion of the content of the first application and the second portion of the content of the first application relative to the first viewpoint of the user, and that a priority of the third portion of the content is higher than a priority of the second portion of the content and higher than a priority of the first portion of the content, changing one or more visual properties of the second portion of the content and the first portion of the content to increase a visibility of the third portion of the content of the first application. In some embodiments, in accordance with a determination that the priority of the third portion of the content is lower than the priority of the second portion of the content and that the third priority is higher than a first priority of the first portion of the content, changing one or more visual properties of the first portion of the content to increase a visibility of the third portion of the content and forgoing changing one or more visual properties of the second portion of the content. For example, in FIG. 11T, in accordance with a determination that the user interface element 11108 is behind the user interface element 11110 from the viewpoint of the user 7002 and has a higher priority than the user interface element 11110, the computer system 101 changes one or more visual properties of the user interface element 11110 to display a breakthrough region 11129-1 so that portions of the user interface element 11108 that would otherwise be obscured are visible from the viewpoint of the user 7002.

In some embodiments, displaying a third portion of the content of the first application in the first view of the three-dimensional environment, wherein the first portion of the content, the second portion of the content, and the third portion of the content are displayed at different distances relative to the first viewpoint of the user (e.g., the first portion of the content is displayed at a first distance from the first viewpoint of the user, the second portion of the content is displayed at a second distance from the first viewpoint of the user different from the first distance, and the third portion of the content is displayed at a third distance from the first viewpoint of the user different from the first distance and the second distance); while displaying the first view of the three-dimensional environment, detecting that the user interface focus (e.g., based on a location of attention of the user and/or based on a change in where input focus is directed) is directed to the third portion of the content of the first application (e.g., the user interface focus moves from the first portion of the content of the first application to the third portion of the content of the first application); and in response to detecting that the user interface focus is directed to the third portion of the content of the first application: in accordance with a determination that the first portion of the content of the first application and the second portion of the content of the first application has a first spatial relationship relative to the first viewpoint of the user (e.g., the first portion of the content of the first application is in front of the second portion of the content of the first application relative to the first viewpoint of the user, the first portion of the content of the first application is behind the second portion of the content of the first application relative to the first viewpoint of the user, or the first portion of the content of the first application and the second portion of the content of the first application are at a same distance from the first viewpoint of the user), and that the third portion of the content of the first application has a second spatial relationship relative to the first viewpoint of the user, different from the first spatial relationship (e.g., the second spatial relationship corresponds to a distance of the third portion of the content from the first viewpoint of the user that is larger than a distance between the second portion of the content and the first viewpoint of the user, and a distance between the first portion of the content and the first viewpoint of the user), changing one or more visual properties of the second portion of the content and the first portion of the content to increase a visibility of the third portion of the content of the first application. In some embodiments, in accordance with a determination that a distance between the third portion of the content and the first viewpoint of the user is smaller than a distance between the second portion of the content from the first viewpoint of the user, forgoing changing one or more visual properties of the second portion of the content to increase a visibility of the third portion of the content of the first application. For example, in FIG. 11H, in accordance with a determination that the user interface element 11068 is furthest away from the viewpoint of the user 7002 (e.g., compared to the user interface element 11064 and the user interface element 11066), the computer system 101 displays additional portions of the user interface element 11068 (e.g., that were not displayed and/or visible in FIG. 11G) by changing one or more visual properties of the intervening user interface element 11066 and user interface element 11064.

In some embodiments, the first portion of the content of the first application includes a plurality of content elements; and changing the one or more visual properties of the second portion of the content of the first application to increase the visibility of the first portion of the content of the first application includes changing the one or more visual properties of the second portion of the content of the first application to increase the visibility of the plurality of content elements (e.g. increase visibility of each content element of the plurality of content elements). For example, in FIG. 11L, the computer system 101 groups related user interface elements (e.g., the user interface element 11092 and the user interface element 11064, and/or the user interface element 11086 and the user interface element 11066) together so that the grouped user interface elements are collectively rendered visible by a breakthrough region that includes portions of the grouped user interface elements that are obscured from the viewpoint of the user.

In some embodiments, changing the one or more visual properties of the second portion of the content of the first application to increase a visibility of the first portion of the content of the first application includes: in accordance with a determination that the second portion of the content of the first application has a first degree of opacity prior to changing the one or more visual properties of the second portion of the content of the first application, changing the one or more visual properties of the second portion of the content of the first application by a first amount; and in accordance with a determination that the second portion of the content of the first application has a second degree of opacity, different from the first degree of opacity, prior to changing the one or more visual properties of the second portion of the content of the first application, changing the one or more visual properties of the second portion of the content of the first application by a second amount different from the first amount. In some embodiments, the second degree of opacity is higher than the first degree of opacity and the one or more visual properties of the second portion of the content of the first application are changed by the second amount that is higher than the first amount. In some embodiments, the second degree of opacity is lower than the first degree of opacity and the one or more visual properties of the second portion of the content of the first application are changed by the second amount that is lower than the first amount. For example, in FIG. 11R, an opacity of the application user interface 11112 reduces (e.g., fades out, or reduces in visual prominence) as time elapses from the user's last interaction with the application user interface 11112. As the application user interface 11112 reduces in opacity (e.g., gradually fades out), the breakthrough regions 11119-1 and 11119-2 also gradually decrease in opacity so that additional portions of the user interface element 11106 become more visible from the viewpoint of the user 7002.

In some embodiments, after changing the one or more visual properties of the second portion of the content of the first application to increase the visibility of the first portion of the content of the first application, detecting an event corresponding to a change in one or more visual properties of the first portion of the content of the first application (e.g., the event corresponding to the change is detected directly or is the result of another event such as a user input that changes input focus, an ordering of application user interfaces, or an event within an application user interface such as an alert or a notification, or due to a user interacting with other applications, and/or other portions of the first application, and/or changes in content of the first portion of the content of the first application); and in response to detecting the event corresponding to the change in the one or more visual properties of the first portion of the content of the first application, at least partially reversing the changes to the one or more visual properties of the second portion of the content of the first application (e.g., made in response to detecting that the user interface focus is directed to the first portion of the content of the first application). In some embodiments, displaying the corresponding change occurs concurrently with detecting the change in the one or more visual properties of the first portion of the content of the first application. In some embodiments, displaying the corresponding change occurs over a predetermined (e.g., user or system specified) time period. For example, in FIG. 11R, an opacity of the application user interface 11112 reduces (e.g., fades out, or reduces in visual prominence) as time elapses from the user's last interaction with the application user interface 11112. As the application user interface 11112 reduces in opacity (e.g., gradually fades out), the breakthrough regions 11119-1 and 11119-2 also gradually decrease in opacity so that additional portions of the user interface element 11106 become more visible from the viewpoint of the user 7002.

In some embodiments, the first portion of the content of the first application (e.g., that is behind the second portion of the content of the first application relative to the first viewpoint of the user) includes one or more affordances for performing operations corresponding to the three-dimensional application volume, the method includes: detecting, via the one or more input devices, a user input selecting a first affordance of the one or more affordance for performing operations corresponding to the three-dimensional application volume; and (e.g., detecting a user input that includes a sequence of one or more inputs such as an air pinch gesture while attention is directed toward the first affordance, a button press that optionally includes the attention of the user being directed toward the first affordance, a verbal request to perform an operation with respect to the first affordance, and/or a selection input performed by a hand of the user to resize, move, and/or interact with one or more selectable user interface component associated with the first affordance). In some embodiments, in response to detecting the user input selecting the first affordance, performing a first operation corresponding to three-dimensional application volume based on the first affordance. In some embodiments, the first operation corresponding to moving, resizing, closing and/or minimizing the three-dimensional application volume. In some embodiments, in response to detecting that the user interface focus is directed to the application management control user interface, and in accordance with a determination that the application management control user interface of the three-dimensional application volume is behind the second portion of the content of the first application relative to the first viewpoint of the user, the computer system changes one or more visual properties of the second portion of the content of the first application to increase a visibility of the application management control user interface of the three-dimensional application volume. For example, in FIG. 11Q, the portions of the application user interface 11112 that are rendered visible to the user 7002 by displaying the breakthrough region 111192-1 includes one or more application management control elements associated with the application user interface 11112, such as a movement affordance 11113, a close affordance and/or a resize affordance.

In some embodiments, the first portion of the content of the first application includes one or more affordances for performing operations corresponding to a content element of the first application, the method includes: detecting, via the one or more input devices, a user input selecting a first affordance of the one or more affordance for performing operations corresponding to the content element of the first application; and (e.g., detecting a user input that includes a sequence of one or more inputs such as an air pinch gesture while attention is directed toward the first affordance, a button press that optionally includes the attention of the user being directed toward the first affordance, a verbal request to perform an operation with respect to the first affordance, and/or a selection input performed by a hand of the user to resize, move, and/or interact with one or more selectable user interface component associated with the first affordance). In some embodiments, in response to detecting the user input selecting the first affordance, performing a first operation corresponding to the content element of the first application based on the first affordance. In some embodiments, the first operation corresponding to moving, resizing, deleting, and/or editing the content element of the first application. In some embodiments, in response to detecting that the user interface focus is directed to the application management control user interface, and in accordance with a determination that the application content control user interface of the content element of the first application is behind the second portion of the content of the first application relative to the first viewpoint of the user, the computer system changes one or more visual properties of the second portion of the content of the first application to increase a visibility of the application management control user interface of the three-dimensional application volume). For example, in FIG. 11O, in response to detecting the attention 11029 of the user 7002 being directed toward an edge portion of the user interface element 11110, the computer system 101 displays a resize affordance 11118.

In some embodiments, the first portion of the content of the first application (e.g., that is behind the second portion of the content of the first application relative to the first viewpoint of the user) includes a content element associated with a third portion of the content of the first application (e.g., a user interface element that displays content associated with the third portion of the content of the first application, such as contextual information, a two-dimensional user interface element that includes a contextual menu with one or more selectable user interface objects for performing different operations and/or popover). In some embodiments, in response to detecting that the user interface focus is directed to the content element associated with the third portion of the content of the first application, and in accordance with a determination that the content element associated with the third portion of the content of the first application is behind the second portion of the content of the first application relative to the first viewpoint of the user, the computer system changes one or more visual properties of the second portion of the content of the first application to increase a visibility of the content of the first application relative to the first viewpoint of the user. For example, in FIG. 11M, the user interface element 11902 includes an option to display a surface temperature, an option to display information about sunspots, and an option to display information about coronal heating, which are contextual information that are associated with the user interface element 11064.

In some embodiments, aspects/operations of methods 12000, 13000, 14000, and 15000 may be interchanged, substituted, and/or added between these methods. For brevity, these details are not repeated here.

FIG. 20 is a flow diagram illustrating a method 20000 for displaying user interface elements associated with different types of contents of a volumetric application, in accordance with some embodiments. In some embodiments, method 20000 is performed at a computer system (e.g., computer system 101 in FIG. 1) that is in communication with one or more display generation components (e.g., a head-mounted display (HMD), a heads-up display, a display, a touchscreen, a projector, or other types of display) (e.g., display generation component 120 in FIGS. 1A, 3A, and 4, or the display generation component 7100a in FIGS. 17A-17M), and one or more input devices (e.g., sensors and hardware controls for detecting user inputs, one or more optical sensors such as cameras (e.g., color sensors, infrared sensors, structured light scanners, and/or other depth-sensing cameras) that points downward at a user's hand or a camera that points forward from the user's head, eye-tracking devices, touch sensors, touch-sensitive surfaces, proximity sensors, motion sensors, buttons, crowns, joysticks, user-held and/or user-worn controllers, and/or other sensors and input devices) (e.g., one or more input devices 125 and/or one or more sensors 190 in FIG. 1A, or sensors 7101a-7101c and/or the digital crown 703 in FIGS. 17A-17M). In some embodiments, the method 20000 is governed by instructions that are stored in a non-transitory (or transitory) computer-readable storage medium and that are executed by one or more processors of a computer system, such as the one or more processors 202 of computer system 101 (e.g., control 110 in FIG. 1A). Some operations in method 20000 are, optionally, combined and/or the order of some operations is, optionally, changed.

The devices, methods, and/or computer-readable storage mediums described below enhance the operability of the device and makes the user-device interface more efficient (e.g., by helping the user to provide proper inputs and reducing user mistakes when operating/interacting with the device) which, additionally, reduces power usage and/or improves battery life of the device by enabling the user to use the device more quickly and efficiently. As described herein, the method 20000 includes displaying a first user interface object, associated with a first type of content, at a first location in the three-dimensional environment that has a first spatial relationship to a three-dimensional volume displayed in the three-dimensional environment. The method includes displaying the first user interface object, associated with a second type of content, at a second location in the three-dimensional environment that has a second spatial relationship to the three-dimensional volume displayed in the three-dimensional environment. Providing improved feedback (such as by displaying the first user interface object at either the first location or the second location, depending on whether the first user interface object is associated with the first type of content or the second type of content) enhances the operability of the device by ensuring that the first user interface object is displayed at a location that is more likely to be viewed by the user, reducing accidental and mistaken inputs, reducing energy usage by the device. Performing an operation when a set of conditions has been met without requiring further user input (such as by automatically displaying the first user interface object to provide pertinent, optionally time-sensitive, information to the user) enhances the operability of the device by reducing unnecessary inputs and/or steps to navigate through different user interfaces or sets of controls, reducing energy usage by the device. Conditionally displaying additional control options and details, reduces clutter in the UI and enhances the operability of the device by reducing unnecessary inputs and/or steps to navigate through different user interfaces or sets of controls, reducing energy usage by the device.

The computer system displays (20002), via the one or more display generation components, a first view of a three-dimensional environment that includes a first three-dimensional volume (e.g., an application window and/or application content that is bounded by a three-dimensional volume with a finite boundary that may be a visible boundary, or an invisible boundary in one or more dimensions, such as in the horizontal dimension, in the vertical dimension, in the depth dimension, in the radial dimension and/or in the azimuthal dimension, such as a three-dimensional volumetric window of a cylindrical shape, a rectangular prism shape, a spherical shape, and/or other volumetric shapes, in FIGS. 17A-17M, the computer system displays the application user interface 17002) that includes three-dimensional virtual content (e.g., the three-dimensional virtual content corresponds to a first application, such as a system application, an application or experience launcher application, a system control application, a settings application, and/or an application switcher application, or a user-installed application, such as a communication application, a telephony application, a gaming application, an exercise application, a meditation application, or other types of applications, in FIGS. 17A-17M, the computer system displays the building 17006, the building 17008, a building 17106).

While displaying the first three-dimensional volume in the first view of the three-dimensional environment, the computer system detects (20004) occurrence of a first event for displaying a first user interface object associated with the first three-dimensional volume (e.g., the first event is associated with the first application, the first event is a system-generated event, detecting occurrence of a first event includes detecting a change in contextual conditions, and/or one or more user inputs that are associated with the first application such as an input or event that causes generation of a pop-up alert, new content, new window, modal window, banner, and/or navigation to another user interface of the first application, in FIGS. 17A-17M, the computer system displays the user interface element 17018 and the user interface element 17008).

In response to detecting (20006) the occurrence of the first event: in accordance with a determination that the first user interface object is associated with a first type of content (e.g., the first type of content includes content having a first characteristic, such as a geometrical characteristic, and/or content that is enclosed by a bounding surface of at least a portion of the three-dimensional volume, in FIGS. 17D, the user interface element 17032 is associated with the application user interface 17002) included in the first three-dimensional volume displayed in the first view of the three-dimensional environment, the computer system displays (20008), via the one or more display generation components, the first user interface object at a first location in the three-dimensional environment, wherein the first location has a first spatial relationship to the first three-dimensional volume (e.g., and/or a portion of the first three-dimensional volume, in FIGS. 17D, the user interface element 17032 is associated with the application user interface 17002 and is at a predefined location with respect to an application management control) displayed in the first view of the three-dimensional environment (e.g., the first location is a predefined region on or within the first three-dimensional volume, and/or the first location may be anchored relative to a user interface element of the first three-dimensional application volume).

In accordance with a determination that the first user interface object is associated with a second type of content (e.g., the second type of content includes content having a second characteristic, such as a geometrical characteristic, and/or content that is anchored to an user interface element enclosed by a bounding surface of at least a portion of the three-dimensional volume, in FIGS. 17K, the user interface element 17032 is associated with the user interface element 17008) included in the first three-dimensional volume displayed in the first view of the three-dimensional environment, wherein the second type of content is different from the first type of content, the computer system displays (20010), via the one or more display generation components, the first user interface object at a second location in the three-dimensional environment, wherein the second location has a second spatial relationship, different from the first spatial relationship, to the first three-dimensional volume (e.g., and/or a portion of the first three-dimensional volume, the user interface element 17032 is displayed parallel to the user interface element 17008, spaced part along the z-direction (e.g., and optionally, centered relative to the user interface element 17008 in the x-direction and y-direction) displayed in the first view of the three-dimensional environment (e.g., the second location is a predefined region on or within the first three-dimensional volume, and/or the second location may be anchored relative to a user interface element of the first three-dimensional volume). In some embodiments, the first user interface object is, an alert, a system user interface object, such as a notification, a modal window, a banner, a pop-up, or a user interface object that requires user input in order to be dismissed.

In some embodiments, the first user interface object has the first spatial relationship to an application management control of the first three-dimensional volume (e.g., a movement affordance (sometimes called a grabber) associated with the three-dimensional volume, a resize affordance associated with the three-dimensional volume, or another management control associated with the three-dimensional volume). In some embodiments, the first type of content is enclosed by a bounding surface (e.g., defining a three-dimensional volume) of at least a portion of the three-dimensional volume (e.g., the entire three-dimensional volume). For example, in FIGS. 17C and 17D, in response to detecting that the attention 17014 of the user 7002 is directed toward the selectable user interface element 17030, optionally in conjunction with detecting an air pinch gesture performed by the hand 7022, and in accordance with a determination that a user interface element 17032 is associated with three-dimensional application content within the volumetric application of the application user interface 17002, the computer system 101 displays the user interface element 17032 at a predefined location with respect to an application management control.

In some embodiments, the first view of the three-dimensional environment (e.g., that includes the first three-dimensional volume that includes the three-dimensional virtual content) corresponds to a first viewpoint of a user; and the first user interface object is displayed with a first orientation with respect to the first viewpoint of the user. In some embodiments, the first orientation orients a plane and/or face of the first user interface object to face the user head-on, and/or a surface normal of the first user interface object is parallel to a viewing and/or depth direction associated with the first viewpoint of the user. For example, in the top view of 17034 and in FIG. 17D, the computer system 101 displays the user interface element 17032 at an orientation that faces the user 7002 (e.g., a two-dimensional surface of the user interface element 17032 is perpendicular to the viewpoint of the user 7002).

In some embodiments, prior to detecting the occurrence of the first event for displaying the first user interface object associated with the first three-dimensional volume, the first three-dimensional volume is displayed, via the one or more display generation components, at a third location in the three-dimensional environment; and displaying the first user interface object at the first location in the three-dimensional environment (e.g., in response to detecting the occurrence of the first event for displaying the first user interface object associated with the first three-dimensional volume) includes maintaining display of the first three-dimensional volume at the third location in the three-dimensional environment (e.g., forgoing pushing back the first three-dimensional volume in a depth dimension and/or forgoing changing a location of the first three-dimensional volume while the first user interface object is displayed). For example, the top view 17028 in FIG. 17C and the top view 17034 in FIG. 17D show that application user interface 17002 is maintained at the same position when the user interface element 17032 is displayed (e.g., displaying the user interface element 17032 does not result in the application user interface 17002 being pushed back).

In some embodiments, in accordance with a determination that displaying the first user interface object at the first location in the three-dimensional environment would result in a portion of the first user interface object and a portion of the three-dimensional virtual content of the first three-dimensional volume being displayed at a same location in the three-dimensional environment (e.g., the first user interface object intersects with the three-dimensional virtual content, and/or the three-dimensional virtual content obscures the first user interface object from a first viewpoint of a user), changing, via the one or more display generation components, one or more visual properties of at least one of the portion of the first user interface object or the portion of the three-dimensional virtual content (e.g., changing the one or more visual properties includes displaying a depth mitigation effect by increasing a visibility of a portion of the first user interface object by optionally ceasing to display at least a portion of the three-dimensional virtual content and/or decreasing an opacity of at least a portion of the three-dimensional virtual content to increase the visibility of a portion of the first user interface object through the reduced opacity region(s) of the three-dimensional virtual content, that for example intersects, overlaps with or blocks the portion of the first user interface object relative to the first viewpoint). For example, in FIG. 17E, the user interface element 17032 spatially conflicts with one or more application content elements from the viewpoint of the user 7002 (e.g., coincides with, intersects with or is behind other application content from the viewpoint of the user 7002) when the computer system 101 displays the user interface element 17032 within the volumetric application associated with the application user interface 17002. The computer system 100 changes, via the one or more display generation components, one or more visual properties of the application content (e.g., a portion 17039) to increase visibility of a previously obscured portion of the user interface element 17032 with respect to the viewpoint of user 7002. In some embodiments, the user interface element 17032 is displayed outside the volumetric application and is tilted with respect to the volumetric application, as illustrated in FIG. 17I. In some embodiments, in accordance with a determination that the tilted user interface element 17032 spatially conflicts with one or more application content elements from the viewpoint of the user 7002 (e.g., coincides with, intersects with or is behind other application content from the viewpoint of the user 7002), the computer system 101 changes, via the one or more display generation components, one or more visual properties of the application content to increase visibility of a previously obscured portion of the user interface element 17032 with respect to the viewpoint of user 7002.

In some embodiments, the second type of content is a two-dimensional user interface element within the first three-dimensional volume and the first user interface object has the second spatial relationship to the two-dimensional user interface element (e.g., the second spatial relationship is defined relative to the two-dimensional user interface element). For example, in FIGS. 17J and 17K, in response to detecting that the attention 17014 of the user 7002 is directed toward the selectable user interface element 17030, optionally in conjunction with detecting an air pinch gesture performed by the hand 7022, and in accordance with a determination that a user interface element 17032 is associated with two-dimensional application content within the volumetric application of the application user interface 17002 (e.g., the two-dimensional user interface element 17008), the computer system 101 displays the user interface element 17032 at a predefined location with respect to the user interface element 17008.

In some embodiments, a plane of the first user interface object is parallel to a plane of the two-dimensional user interface element (e.g., a spacing, along a depth dimension, between the first user interface element and the two-dimensional user interface element is substantially constant across a plane of the first user interface element). For example, the top view 17080 in FIG. 17K shows that the user interface element 17032 is displayed parallel to the user interface element 17008, spaced part along the z-direction).

In some embodiments, prior to detecting the occurrence of the first event for displaying the first user interface object associated with the first three-dimensional volume, the two-dimensional user interface element within the first three-dimensional volume is displayed, via the one or more display generation components, at a fourth location in the three-dimensional environment, and displaying the first user interface object at the second location in the three-dimensional environment includes changing a location of the two-dimensional user interface element (e.g., to an updated location that is different from the fourth location) in the three-dimensional environment (e.g., pushing the two-dimensional user interface element away from the first viewpoint of the user, away from the fourth location along a depth dimension, optionally while maintaining display of the first three-dimensional volume at a same location). In some embodiments, the first user interface element is displayed at a same distance from the first viewpoint of the user as the two-dimensional user interface element prior to display of the first user interface element (e.g., the first user interface object is displayed at the fourth location in the three-dimensional environment). For example, the top view 17080 and a side view 17082 in FIG. 17K, the computer system 101 displays the user interface element 17032 at a previous location of the user interface element 17008, which is pushed back away from a viewpoint of the user 7002.

In some embodiments, in accordance with a determination that displaying the two-dimensional user interface element within the first three-dimensional volume would result in a portion of the two-dimensional user interface element and a portion of the three-dimensional virtual content of the first three-dimensional volume being displayed at a same location in the three-dimensional environment (e.g., the two-dimensional user interface element intersecting with the three-dimensional virtual content, optionally the first user interface object which is parallel to the two-dimensional user interface element also intersects with the three-dimensional virtual content), changing, via the one or more display generation components, one or more visual properties of at least one of the portion of the two-dimensional user interface element or the portion of the three-dimensional virtual content (e.g., changing the one or more visual properties includes displaying a depth mitigation effect by increasing a visibility of a portion of the two-dimensional user interface element and optionally the first user interface object by ceasing to display at least a portion of the three-dimensional virtual content and/or decreasing an opacity of at least a portion of the three-dimensional virtual content to increase the visibility of a portion of the two-dimensional user interface element and/or the first user interface object through the reduced opacity region(s) of the three-dimensional virtual content, that for example overlaps with or blocks the portion of the two-dimensional user interface element and/or the first user interface object relative to the first viewpoint). For example, in FIG. 17K, in accordance with a determination that the user interface element 17032 spatially conflicts with one or more three-dimensional application content elements (e.g., coincides with, intersects with or is behind the building 17007 from the viewpoint of the user 7002), the computer system 101 changes one or more visual properties of additional portions of the building 17005 (e.g., a portion 17076) and the building 17007 (e.g., a portion 17078) to increase visibility of a previously obscured portion of the user interface element 17032 with respect to the viewpoint of user 7002. As a result, additional portions of the user interface element 17032 (e.g., a bottom right portion, a majority of the user interface element 17032, or all of the user interface element 17032) are visible from the viewpoint of user 7002.

In some embodiments, in accordance with a determination that the first user interface object is associated with a third type of content (e.g., the third type of content includes content having a third characteristic, such as immersive content that spans 180 degrees surrounding a first viewpoint of a user) included in the first three-dimensional volume displayed in the first view of the three-dimensional environment, wherein the third type of content is different from the first type of content and the second type of content, displaying, via the one or more display generation components, the first user interface object at a respective location in the three-dimensional environment, wherein the respective location has a fixed spatial relationship to a viewpoint of a user. In some embodiments, the fixed spatial relationship includes a fixed distance and a fixed angle between the respective location and the viewpoint of the user. In some embodiments, while the first user interface object is displayed, the first user interface object is reoriented relative to the first three-dimensional volume as a current viewpoint of the user moves (e.g., the first user interface object is viewpoint-locked). For example, in FIGS. 17L and 17M, in response to detecting that the attention 17014 of the user 7002 is directed toward a selectable user interface element 17095, optionally in conjunction with detecting an air pinch gesture performed by the hand 7022, and in accordance with a determination that the application user interface 17084 is displayed in an immersive mode, the computer system 101 displays the user interface element 17032 at a predefined location with respect to the viewpoint of the user 7002 (e.g., in a central portion of the viewport of the user 7002, and/or at a predefined location within the viewport of the user 7002).

In some embodiments, the first view of the three-dimensional environment that includes the first three-dimensional volume that includes the three-dimensional virtual content corresponds to a first viewpoint of a user. In some embodiments, while displaying the first user interface object at a respective location in the three-dimensional environment, detecting, via the one or more input devices, a change in a viewpoint of the user from the first viewpoint of the user to a second viewpoint of the user; and in response to detecting the change in the viewpoint of the user, displaying, via the one or more display generation components, the first user interface object at an updated location that has the fixed spatial relationship to the second viewpoint of the user. In some embodiments, the first user interface object is displayed at a fixed distance and at a fixed angle away from the changed viewpoint of the user. For example, in FIGS. 17L and 17M, in response to detecting a rightward movement of the user 7002 within the application user interface 17084 displayed in the immersive mode, the computer system 101 displays the user interface element 17032 at an updated location within the immersive application user interface 17084 that remains viewpoint-locked within the viewport of the user 7002 (e.g., in a central portion of the viewport of the user 7002, and/or at a predefined location within the viewport of the user 7002).

In some embodiments, the determination that the first user interface object is associated with the first type of content includes a determination that the first three-dimensional volume is displayed in a first mode (e.g., a non-immersive mode of operation, such that the first user interface object, when displayed, has the first spatial relationship to the application management control of the first three-dimensional volume); and the determination that the first user interface object is associated with the third type of content includes a determination that the first three-dimensional volume is displayed in a second mode (e.g., an immersive mode of operation), different from the first mode. For example, in FIGS. 17L and 17M, in response to detecting that the attention 17014 of the user 7002 is directed toward a selectable user interface element 17095, optionally in conjunction with detecting an air pinch gesture performed by the hand 7022, and in accordance with a determination that the application user interface 17084 is displayed in an immersive mode, the computer system 101 displays the user interface element 17032 at a predefined location with respect to the viewpoint of the user 7002 (e.g., in a central portion of the viewport of the user 7002, and/or at a predefined location within the viewport of the user 7002). In contrast, in FIGS. 17C and 17D, in response to detecting that the attention 17014 of the user 7002 is directed toward the selectable user interface element 17030, and in accordance with a determination that a user interface element 17032 is associated with three-dimensional application content within the volumetric application of the application user interface 17002, the computer system 101 displays the user interface element 17032 at a predefined location with respect to an application management control.

In some embodiments, in accordance with a determination that one or more settings of the computer system has a first configuration, associating the first user interface object with the first type of content; and in accordance with a determination that one or more settings of the computer system has a second configuration, different from the first configuration, associating the first user interface object with the second type of content (e.g., the one or more settings of the computer system are established by the developer of an application of the computer system and/or by a user of the computer system). In some embodiments, in response to detecting the occurrence of the first event: in accordance with a determination that a respective setting of the one or more settings is configured such that the first event associates the first user interface object with the first type of content (e.g., the developer of the application and/or the user of the computer system configures the respective setting such that the first event associates the first user interface object with the first type of content), the computer system displays the first user interface object at the first location in the three-dimensional environment, and in accordance with a determination that the respective setting of the one or more settings is configured such that the first event associates the first user interface object with the second type of content, the computer system displays the first user interface object at the second location in the three-dimensional environment. For example, the application user interface 17002 includes an application setting that enables the user interface element 17032 to be associated with an application management control of a three-dimensional application volume, or to be associated with a two-dimensional user interface element (e.g., the user interface element 17008) within the three-dimensional application volume. In some embodiments, a developer who designs the application user interface 17002 selects the application setting to be used, and/or a user of the application user interface 17002 selects the application setting to be used.

In some embodiments, while displaying the first user interface object at a respective location in the three-dimensional environment, detecting an event corresponding to a change in application content (e.g., application content that is associated with the first user interface object) of the first three-dimensional volume (e.g., a movement input, optionally involving a pinch and drag input, causes the change in the application content, a recentering input, optionally involving a press input directed toward a hardware crown or button, causes the change in the application content and/or a change in a rotational position of the two-dimensional user interface element causes the change in application content). In response to detecting the event corresponding to the change in application content (e.g., application content that is associated with the first user interface object) of the first three-dimensional volume, updating, via the one or more display generation components, the display of the first three-dimensional volume to reflect the change in application content, including displaying the first user interface object at an updated location in the three-dimensional environment (e.g., that is based on the change in the application content of the three-dimensional volume). In some embodiments, the first user interface object at the updated location maintains the same spatial relationship with respect to the two-dimensional user interface element and/or the application management control of the first three-dimensional volume. For example, in FIGS. 17G and 17H, in response to detecting that the attention of the user 7002 is directed toward the application management control 17010, optionally in conjunction with detecting an air pinch gesture performed by the hand 7022 followed by rightward movement of the hand 7022, the computer system 101 displays the application user interface 17002 at an updated location that is further from the viewpoint of the user 7002 and to the right of the prior location and the user interface element 17032 is displayed at an updated location of the three-dimensional environment based on the movement of the volumetric application having the application user interface 17002, to which the user interface element 17032 is associated.

In some embodiments, while displaying the first user interface object at a respective location in the three-dimensional environment, detecting an event corresponding to a change in application content (e.g., application content that is associated with the first user interface object) of the first three-dimensional volume (e.g., a movement input, optionally involving a pinch and drag input, causes the change in the application content, a recentering input, optionally involving a press input directed toward a hardware crown or button, causes the change in the application content and/or a change in a rotational position of the two-dimensional user interface element causes the change in application content). In some embodiments, in response to detecting the event corresponding to the change in application content (e.g., application content that is associated with the first user interface object) of the first three-dimensional volume, in accordance with a determination that an orientation of the first user interface object in a current view of the three-dimensional environment has changed from a time when the first user interface object was initially displayed (e.g., because the current view of the three-dimensional environment is different from the first view of the three-dimensional environment, and/or because the first user interface object has been moved and/or rotated in the first view of the three-dimensional environment, such that the first user interface object has a different orientation at a time when the change in application content was detected, relative to when the first user interface object was initially displayed), changing, via the one or more display generation components, an orientation of the first user interface object from a first orientation to a second orientation that is different from the first orientation (e.g., such that a plane of the first user interface object is aligned with a viewpoint of the user). In some embodiments, in accordance with a determination that the orientation of the first user interface object in the current view of the three-dimensional environment is the same at the time when the first user interface object was initially displayed (e.g., the current view of the three-dimensional environment is the first view of the three-dimensional environment, and the first user interface object has not been moved and/or rotated in the first view of the three-dimensional environment, such that the first user interface object has the same orientation at both the time when the first user interface was initially displayed and when the change in application content was detected), maintaining display of the first user interface object without changing the orientation of the first user interface object from the first orientation to the second orientation (e.g., maintaining display of the first user interface object with the same orientation as when the first user interface object was initially displayed). In some embodiments, the plane of the first user interface object is oriented to face the user head-on, a surface normal of the first user interface object is parallel to a viewing direction of the user. In some embodiments, the first user interface object at the updated rotational position maintains the same angle between a viewpoint of the user and the application content of the three-dimensional volume associated with the first user interface object. For example, in FIGS. 17G and 17H, in response to detecting that the attention of the user 7002 is directed toward the application management control 17010, optionally in conjunction with detecting an air pinch gesture performed by the hand 7022 followed by rightward movement of the hand 7022, the computer system 101 changes an orientation of the user interface element 17032 (e.g., a plane of the user interface element 17032 at the updated location is rotated to better align with the viewpoint of the user 7002, as shown FIG. 17H) due to the amount of movement of the application user interface 17002.

In some embodiments, in accordance with a determination that the orientation of the first user interface object has changed by a first amount from the time when the first user interface object was initially displayed, the first orientation and the second orientation differ by the first amount (e.g., a first angle in a plane of rotation corresponding to the change in orientation). In some embodiments, in accordance with a determination that the orientation of the first user interface object has changed by a second amount, larger than the first amount, from the time when the first user interface object was initially displayed, the first orientation and the second orientation differ by the first amount (e.g., a second angle in a plane of rotation that is less than the change in orientation because the first amount is the maximum amount of rotation). In some embodiments, in accordance with a determination that the orientation of the first user interface object has changed by a third amount, larger than the second amount, from the time when the first user interface object was initially displayed, the first orientation and the second orientation differ by a second amount that is larger than the first amount (e.g., the first user interface object is rotated by a larger angle in the plane of rotation); and in accordance with a determination that the orientation of the first user interface object has changed by a fourth amount, larger than the third amount, from the time when the first user interface object was initially displayed, the first orientation and the second orientation differ by the second amount. For example, in the side view 17046 of FIG. 17I, even though orienting the plane of the user interface element 17032 to a plane 17056 would allow the viewpoint to be perpendicular to the viewpoint of the user 7002 (e.g., denoted by a line 17054), the angle 17058 is a maximum rotation angle and the computer system 101 forgoes rotating the plane of the user interface element 17032 by an angle that is larger than the angle 17058. In side view 17048 of FIG. 17I, even though orienting the plane of the user interface element 17032 to a plane 17055 would allow the viewpoint to be perpendicular to the viewpoint of the user 7002 (e.g., denoted by the line 17054), the angle 17060 is a minimum rotation angle and the computer system 101 forgoes rotating the plane of the user interface element 17032 by an angle that is smaller than the angle 17060.

In some embodiments, while displaying the first user interface object at a respective location in the three-dimensional environment at a respective rotational position, detecting a change in orientation of the first user interface object relative to a viewpoint corresponding to the first view of the three-dimensional environment; in response to detecting the change in orientation of the first user interface object relative to the viewpoint corresponding to the first view of the three-dimensional environment: in accordance with a determination that one or more settings of the computer system has a first setting with respect to a characteristic of the first user interface object, further changing an orientation the first user interface object to reduce a difference in orientation of the first user interface object relative to the viewpoint (e.g., at least partially reversing the detected change in orientation of the first user interface object relative to the viewpoint) corresponding to the first view of the three-dimensional environment (e.g., partially reversing the detecting change in orientation includes billboarding the first user interface object toward a viewpoint of the user by rotating a plane of the first user interface object so that the plane of the first user interface object is displayed substantially perpendicularly to the viewpoint of the user, based on a characteristic associated with the change in the angle between the viewpoint of the user and the first user interface object, the characteristics relating to an event causing the change in the angle); and in accordance with a determination that one or more settings of the computer system has a second setting, different from the first setting, with respect to the characteristic of the first user interface object, maintaining display of the first user interface object without further changing the orientation of the first user interface object (e.g., the one or more settings of the computer system are established by the developer of an application of the computer system and/or by a user of the computer system). In some embodiments, in response to detecting the change in the angle between the viewpoint of the user and the first user interface object: in accordance with a determination that a respective setting of the one or more settings is configured such that the first user interface object is configured to billboard when the change in the angle is caused by a first type of event, wherein billboarding includes rotating a plane of the first user interface object so that the plane of the first user interface object is displayed substantially perpendicularly to the viewpoint of the user, the computer system displays the first user interface object at the updated rotational position when the first type of event occurs, and in accordance with a determination that the respective setting of the first application is configured such that the first user interface object is configured to billboard when the change in the angle is caused by a second type of event, the computer system forgoes billboarding the first user interface object when the first type of event is detected, and the computer system billboards the first user interface object when the second type of event is detected. For example, the application user interface 17002 includes an application setting that enables the rotation of the plane of the user interface element 17032 based on an occurrence of a specified event (e.g., movement of the application user interface 17002, recentering of the application user interface 17002, launching of the application user interface 17002, and/or when application content of the application user interface 17002 rotates). In some embodiments, a developer who designs the application user interface 17002 selects the application setting to be used, and/or a user of the application user interface 17002 selects the application setting to be used.

In some embodiments, displaying the first user interface object at a respective location in the three-dimensional environment of the first location in the three-dimensional environment and the second location in the three-dimensional environment includes displaying, via the one or more display generation components, the first user interface object at a first size at the respective location in the three-dimensional environment. In some embodiments, while displaying the first user interface object at the first size at the respective location in the three-dimensional environment, detecting, via the one or more input devices, a change in position of a viewpoint of the user (e.g., movement of the viewpoint of the user and/or changes in a position of attention of the user that includes a change in a view of the three-dimensional environment) relative to the first user interface object (e.g. optionally without a change of the viewpoint of the user with relative to the three-dimensional environment, for example, by moving the three-dimensional volume) from a first viewpoint position to a second viewpoint position; and in response to detecting the first change in the position of the viewpoint of the user relative to the first user interface object: in accordance with a determination that a distance between the first user interface object and the second viewpoint position is different than a distance between the first user interface object and the first viewpoint position, changing a size of the first user interface object from the first size to a second size that is different from the first size (e.g., for a distance between first user interface object and the second viewpoint position that is larger than a distance between the first user interface object and the first viewpoint position, the second size is larger than the first size, and/or for a distance between first user interface object and the second viewpoint position that is smaller than a distance between the first user interface object and the first viewpoint position, the second size is smaller than the first size). In some embodiments, the method includes, in accordance with a determination that a distance between first user interface object and the second viewpoint position equals to a distance between the first user interface object and the first viewpoint position, maintaining (e.g., by the computer system) a size of the first user interface object at the first size. For example, in FIG. 17E, in response to detecting that the viewpoint of the user 7002 has moved closer to the user interface element 17032, the computer system 101 updates a size of the user interface element 17032 and maintains the threshold distance Tₜₕ between the user interface element 17032 and the viewpoint of the user 7002 by displaying the user interface element 17032 within the volumetric application associated with the application user interface 17002.

In some embodiments, displaying the first user interface object at a respective location that has a respective spatial relationship to the first three-dimensional volume, includes: in accordance with a determination that a viewpoint corresponding to the first view of the three-dimensional environment has a first elevation relative to a reference plane (e.g., a detected or estimated floor plane or ground plane) in the three-dimensional environment (e.g., a first head elevation of a user is detected using a gyroscope, using an inertia measurement unit, or other sensor housed within the computer system), the respective location in the three-dimensional environment has a first vertical position, relative to the reference plane, that is selected in accordance with the first elevation (e.g., the respective location is a selected based on the first elevation, and/or to ensure visibility of the first user interface object at the respective location in the first view of the three-dimensional environment); and in accordance with a determination that the viewpoint corresponding to the first view of the three-dimensional environment has a second elevation relative to the reference plane in the three-dimensional environment, the respective location in the three-dimensional environment has a second vertical position, relative to the reference plane, that is selected in accordance with the second elevation, wherein the second elevation is different from the first elevation, and wherein the second vertical position, relative to the reference plane, is different from the first vertical position, relative to the reference plane. For example, in the side view 17036 of FIG. 17D, the user interface element 17032 is displayed at a height (e.g., along the y-direction) that is based on a height of the viewpoint of the user 7002. The user interface element 17032 maintains a similar spatial relationship with respect to the application management control 17010 (e.g., displayed in the same z-position) when the computer system 101 displays the user interface element 17032 at different heights.

In some embodiments, in conjunction with (e.g., concurrently with, before, and/or after) displaying the first user interface object, visually deemphasizing (e.g., dimming, blurring, changing a color of, changing a size of, and/or changing a shape of) at least a portion of application content associated with the first three-dimensional application volume, wherein the portion of the application content is further from a viewpoint of a user than the first user interface object (e.g., relative to an appearance of the portion of the application content associated with the first three-dimensional application volume before the first user interface object is displayed). In some embodiments, visually deemphasizing at least a portion of application content associated with the first three-dimensional application volume includes visually deemphasizing the whole first three-dimensional application volume. In some embodiments, visually deemphasizing at least a portion of application content associated with the first three-dimensional application volume includes visually deemphasizing a two-dimensional content element to which the first user interface object is associated, optionally without visually deemphasizing other portions of the first three-dimensional application volume. For example, in FIG. 17L, application content within the volumetric application associated with the application user interface 17084 is visually deemphasized and are not available for user interaction while the user interface element 17032 is displayed (e.g., prior to the user 7002 dismissing and/or performing an operation, such as a selection operation, on the user interface element 17032). In FIG. 17D, application content (e.g., three-dimensional application content and/or two-dimensional application content) within the volumetric application associated with the application user interface 17002 (e.g., application content displayed on a reference horizontal surface or platter) is visually deemphasized and/or rendered unavailable for user interaction while the user interface element 17032 is displayed.

In some embodiments, while displaying the first user interface object at a respective location in the three-dimensional environment, detecting, via the one or more input devices, a first change in position of a viewpoint of a user (e.g., movement of the viewpoint of the user and/or changes in a position of attention of the user that includes a change in a view of the three-dimensional environment)from a first viewpoint position to a second viewpoint position; and in response to detecting the first change in the position of the viewpoint of the user: in accordance with a determination that a distance between the first user interface object and the second viewpoint position is less than a threshold distance, displaying (e.g., redisplaying), via the one or more display generation components, the first user interface object at an updated location in the three-dimensional environment having the threshold distance to the second viewpoint position, wherein the updated location is different from the respective location (e.g., optionally after a threshold time period has elapsed after the viewpoint of the user has stopped changing, display of the first user interface object at the respective location in the three-dimensional environment is maintained for a time period during movement of the viewpoint of the user and for the threshold time period after the viewpoint of the user has stopped changing, ceasing display of the first user interface object when a movement of the viewpoint of the user greater than a threshold amount is detected for a time duration greater than a threshold detection period, and/or ceasing display of the first user interface object when a distance between the first user interface object is below the threshold distance); and in accordance with a determination that a distance between the first user interface object and the second viewpoint position is equal to or greater than the threshold distance, maintaining display, via the one or more display generation components, of the first user interface object at the respective location (e.g., at which the first user interface object was displayed prior to detecting the first change in the position of the viewpoint of the user). For example, in FIG. 17E, in response to detecting that the viewpoint of the user 7002 has moved closer to the application user interface 17002 and the user interface element 17032, the computer system 101 maintains the threshold distance Tₜₕ between the user interface element 17032 and the viewpoint of the user 7002 by displaying the user interface element 17032 within the volumetric application associated with the application user interface 17002.

In some embodiments, while displaying the first user interface object, detecting, via the one or more input devices, a user input directed toward application content associated with the first three-dimensional volume; in response to detecting the user input directed toward the application content (e.g., three-dimensional virtual content, and/or two-dimensional content optionally associated with the three-dimensional virtual content) associated with the first three-dimensional volume: in accordance with a determination that the first user interface object is associated with the second type of content, performing an operation (e.g., associated with the three-dimensional volume) with respect to the application content associated with the first three-dimensional volume (e.g., based on the user input directed toward the application content); and in accordance with a determination that the first user interface object is associated with the first type of content, forgoing performing the operation (e.g., or any operation) with respect to the application content associated with the first three-dimensional volume (e.g., display of the first user interface element associated with the first type of content prevents other interactions with the first three-dimensional volume). For example, in FIG. 17L, application content within the volumetric application associated with the application user interface 17084 are visually deemphasized and are not available for user interaction while the user interface element 17032 is displayed (e.g., prior to the user 7002 dismissing and/or performing an operation, such as a selection operation, on the user interface element 17032). In contrast, in FIG. 17J, application content (e.g., three-dimensional application content and/or two-dimensional application content) within the volumetric application associated with the application user interface 17002 are not visually deemphasized and are available for user interaction while the user interface element 17008 is displayed.

In some embodiments, aspects/operations of methods 12000, 13000, 14000, 15000, 21000, and 22000 may be interchanged, substituted, and/or added between these methods. For brevity, these details are not repeated here.

FIG. 21 is a flow diagram illustrating a method 21000 for displaying a user interface element with a size that is based on a distance from a viewpoint of the user and/or a distance from a respective portion of an application user interface, in accordance with some embodiments. In some embodiments, method 21000 is performed at a computer system (e.g., computer system 101 in FIG. 1) that is in communication with one or more display generation components (e.g., a head-mounted display (HMD), a heads-up display, a display, a touchscreen, a projector, or other types of display) (e.g., display generation component 120 in FIGS. 1A, 3A, and 4, or the display generation component 7100a in FIGS. 18A-18AA), and one or more input devices (e.g., sensors and hardware controls for detecting user inputs, one or more optical sensors such as cameras (e.g., color sensors, infrared sensors, structured light scanners, and/or other depth-sensing cameras) that points downward at a user's hand or a camera that points forward from the user's head, eye-tracking devices, touch sensors, touch-sensitive surfaces, proximity sensors, motion sensors, buttons, crowns, joysticks, user-held and/or user-worn controllers, and/or other sensors and input devices) (e.g., one or more input devices 125 and/or one or more sensors 190 in FIG. 1A, or sensors 7101a-7101c and/or the digital crown 703 in FIGS. 18A-18AA). In some embodiments, the method 21000 is governed by instructions that are stored in a non-transitory (or transitory) computer-readable storage medium and that are executed by one or more processors of a computer system, such as the one or more processors 202 of computer system 101 (e.g., control 110 in FIG. 1A). Some operations in method 21000 are, optionally, combined and/or the order of some operations is, optionally, changed.

The devices, methods, and/or computer-readable storage mediums described below enhance the operability of the device and makes the user-device interface more efficient (e.g., by helping the user to provide proper inputs and reducing user mistakes when operating/interacting with the device) which, additionally, reduces power usage and/or improves battery life of the device by enabling the user to use the device more quickly and efficiently. As described herein, the method 21000 includes displaying a first user interface element at a first distance from a first viewpoint of the user with a first size for the first user interface element. The method includes displaying the first user interface element a second distance from the first viewpoint of the user with a second size for the first user interface element. Providing improved feedback (such as by displaying the first user interface object at either the first distance or the second distance with the first size or the second size, respectively) enhances the operability of the device by ensuring that the first user interface element is displayed at a size based on distance from the viewpoint of the user that allows the first user interface element to be more easily viewed by the user, at a size that is more intuitive for interactions in the three-dimensional environment, reducing accidental and mistaken inputs, reducing energy usage by the device. Performing an operation when a set of conditions has been met without requiring further user input (such as by automatically displaying the first user interface element at either the first distance or the second distance with the first size or the second size, respectively to provide relevant information to the user that is more easily viewed by the user) enhances the operability of the device by reducing unnecessary inputs and/or steps to navigate through different user interfaces or sets of controls, reducing energy usage by the device.

The computer system displays (21002), via the one or more display generation components, a first view of a three-dimensional environment, wherein the first view of the three-dimensional environment corresponds to a first viewpoint of a user. While displaying the first view of the three-dimensional environment, the computer system detects (21004), via the one or more input devices, a first request to display a first user interface element (e.g., an air pinch gesture, initiated or performed while the attention of the user is directed toward an affordance or a user interface element for initiating display of the first user interface element, or other user input, in FIGS. 18A-18B, in response to detecting the selection input directed toward the building 18004, the computer system 101 displays the user interface element 18018).

In response to detecting (21006) the first request to display the first user interface element: in accordance with a determination that the first request to display the first user interface element is a request to display the first user interface element at a first distance from the first viewpoint of the user, the computer system displays (21008), via the one or more display generation components, the first user interface element at the first distance from the first viewpoint of the user with a first size for the first user interface element (e.g., a size in one or more dimensions relative to the three-dimensional environment or a perceived size from the first viewpoint of the user, an angular extent of the first user interface element, and/or a displayed size of the first user interface element as perceived by a user from the first viewpoint, in FIG. 18B, the user interface element 18018 is displayed at a distance 18011 from the viewpoint of the user at a size having a width 18017).

In accordance with a determination that the first request to display the first user interface element is a request to display the first user interface element at a second distance, different from the first distance, from the first viewpoint of the user, the computer system displays (21010), via the one or more display generation components, the first user interface element at the second distance from the first viewpoint of the user with a second size for the first user interface element that is different from the first size for the first user interface element (e.g., the second size of the first user interface element is determined in accordance with the second distance, a difference between the first distance and the second distance, the first size of the first user interface element, the information density of the application content within the first user interface element, and/or one or more other attributes that are associated with displayed content and/or the first user interface element). In some embodiments, although the first size of the first user interface element at the first distance from the first viewpoint of the user is different from the second size of the first user interface element at the second distance from the viewpoint of the user, the first user interface element appear to have the same size from the perspective of the user at the first viewpoint (e.g., in embodiments in which the respective size of the first three-dimensional application volume is increased proportionally with increasing distance from the viewpoint of the user) at both distances in FIG. 18E, the user interface element 18018 is displayed at a distance 18028 from the viewpoint of the user at a size having a width 18030.

In some embodiments, the first user interface element includes a two-dimensional user interface element that is associated with a portion of three-dimensional virtual content included in a first three-dimensional application volume of a first application; and the first three-dimensional application volume of the first application is displayed, via the one or more display generation components, prior to detecting the first request to display the first user interface element. In some embodiments, the two-dimensional user interface element is a popover that is displayed above or over the first-dimensional user interface element of the three-dimensional virtual content to which the popover is associated. For example, in FIG. 17B, in response to detecting that the attention 18010 of the user 7002 is directed toward the building 18004 optionally in conjunction with detecting an air pinch gesture performed by the hand 7022, the computer system 101 displays a user interface element 18018 at a first distance 18011 away from the viewpoint of the user 7002 at a first size above the building 18004. The user interface element 18018 displays information associated with the building 18004 which has a non-zero length, non-zero width, and non-zero depth.

In some embodiments, the first user interface element includes a two-dimensional user interface element that is associated with a portion of two-dimensional content included in a first three-dimensional application volume of a first application; and the first three-dimensional application volume of the first application is displayed, via the one or more display generation components, prior to detecting the first request to display the first user interface element. In some embodiments, the first user interface element is a menu associated with the portion of the two-dimensional content. In some embodiments, the menu includes selectable user interface elements corresponding to features associated with the two-dimensional content. In some embodiments, the first three-dimensional application volume includes both three-dimensional virtual content and the two-dimensional content. For example, in FIG. 18C, the user interface element 18022 is associated with the two-dimension user interface element 18018, and provides a number of selectable options that are associated with the user interface element 18018. The selectable options enable the computer system 101 to provide directions to the user 7002, to call the kiosk, to provide a user interface for leaving a review for the kiosk, and to display a list of display a menu of items offered by the kiosk.

while displaying the first view of the three-dimensional environment, detecting, via the one or more input devices, a sequence of one or more inputs corresponding to a second request to display a second user interface element (e.g., the sequence of one or more inputs includes an air pinch gesture that optionally includes the attention of the user being directed to an application content element associated with the second user interface element, a button press that optionally includes attention of the user being directed to an application content element associated with the second user interface element, and/or a verbal request to display the second user interface element, the second request is the same as the first request, the second request is different from the first request, the second request is detected prior to the display of the first user interface element, or the second request is detected after the display of the first user interface element, the second request is initiated or performed while the attention of the user is directed toward an affordance or a user interface element for initiating display of the second user interface element, or other user input); in response to detecting the sequence of one or more inputs corresponding to the second request to display the second user interface element: in accordance with a determination that the second request to display the second user interface element is a request to display the second user interface element at a third distance from the first viewpoint of the user, displaying, via the one or more display generation components, the second user interface element at the third distance from the first viewpoint of the user with a first size for the second user interface element (e.g., a size in one or more dimensions relative to the three-dimensional environment or a perceived size from the first viewpoint of the user, an angular extent of the second user interface element, and/or a displayed size of the second user interface element as perceived by a user from the first viewpoint); and in accordance with a determination that the second request to display the second user interface element is a request to display the second user interface element at a fourth distance, different from the third distance, from the first viewpoint of the user, displaying, via the one or more display generation components, the second user interface element at the fourth distance from the first viewpoint of the user with a second size for the second user interface element that is different from the first size for the second user interface element (e.g., the fourth size of the second user interface element is determined in accordance with the fourth distance, a difference between the third distance and the fourth distance, the third size of the second user interface element, the information density of the application content within the second user interface element, and/or one or more other attributes that are associated with displayed content and/or the second user interface element). In some embodiments, a ratio between the first size of the first user interface element and the first distance is equal to a ratio between the third size of the second user interface element and the third distance. In some embodiments, a ratio between the second size of the first user interface element and the second distance is equal to a ratio between the fourth size of the second user interface element and the fourth distance. In some embodiments, although the third size of the second user interface element at the third distance from the first viewpoint of the user is different from the fourth size of the first user interface element at the fourth distance from the viewpoint of the user, the second user interface element appear to have the same size from the perspective of the user at the first viewpoint (e.g., in embodiments in which the respective size of the first three-dimensional application volume is increased proportionally with increasing distance from the viewpoint of the user) at both distances. In some embodiments, the first distance is the same as the third distance, and the first size is the same as the third size. In some embodiments, the second distance is the same as the fourth distance, and the second size is the same as the fourth size. For example, in FIG. 18J, in response to detecting that the attention 18010 of the user 7002 is directed toward the building 18006 optionally in conjunction with detecting an air pinch gesture performed by the hand 7022, the computer system 101 displays the user interface element 18042 at a distance 18062 away from the viewpoint of the user 7002 at a size having a width of 18064 above the building 18006.

In some embodiments, the first user interface element and the second first user interface element are user interface elements of a first type; in accordance with a determination that the first distance between the first user interface element and the first viewpoint of the user is different from the third distance between the second user interface element and the first viewpoint of the user, the first size of the first user interface element is different from the first size of the second user interface element; and in accordance with a determination that the second distance between the first user interface element and the first viewpoint of the user is different from the fourth distance between the second user interface element and the first viewpoint of the user, the second size of the first user interface element is different from the second size of the second user interface element.

In some embodiments, in accordance with a determination that the first distance between the first user interface element and the first viewpoint of the user is the same as from the third distance between the second user interface element and the first viewpoint of the user, the first size of the first user interface element is the same as the first size of the second user interface element. In some embodiments, in accordance with a determination that the second distance between the first user interface element and the first viewpoint of the user is the same as the fourth distance between the second user interface element and the first viewpoint of the user, the second size of the first user interface element is the same as the second size of the second user interface element. In some embodiments, the method includes: while displaying the first view of the three-dimensional environment, detecting, via the one or more input devices, a third request to display a third user interface element; in response to detecting the third request to display the third user interface element: in accordance with a determination that the third request to display the third user interface element is a request to display the third user interface element at a fifth distance from the first viewpoint of the user; and in accordance with a determination that the third user interface element is a user interface element of a second type that is different from the first type; displaying, via the one or more display generation components, the third user interface element at the distance from the first viewpoint of the user with a first size of the third user interface element (e.g., a size in one or more dimensions relative to the three-dimensional environment or a perceived size). A ratio between the first size of the first user interface element and the first distance is different from a ratio between the first size of the third user interface element and the fifth distance. For example, in FIG. 18B, in response to detecting that the attention 18010 of the user 7002 is directed toward the building 18004 optionally in conjunction with detecting an air pinch gesture performed by the hand 7022, the computer system 101 displays a user interface element 18018 at a first distance 18011 away from the viewpoint of the user 7002 at a first size above the building 18004. The user interface element 18018 displays information associated with the building 18004 which has a non-zero length, non-zero width, and non-zero depth. For example, in FIG. 18J, in response to detecting that the attention 18010 of the user 7002 is directed toward the building 18006 optionally in conjunction with detecting an air pinch gesture performed by the hand 7022, the computer system 101 displays the user interface element 18042 at a distance 18062 away from the viewpoint of the user 7002 at a size having a width of 18064 above the building 18006. In some embodiments, the user interface element 18042 and the user interface element 18018 are the same type of user interface elements (e.g., user interface elements that provide information about application content elements of the application user interface).

In some embodiments, prior to detecting the first request to display the first user interface element, displaying, via the one or more display generation components, a first three-dimensional application volume of a first application that includes three-dimensional virtual content in the first view of the three-dimensional environment; while displaying the first view of the three-dimensional environment, detecting, via the one or more input devices, a sequence of one or more inputs corresponding to a third request to display a third user interface element (e.g., an air pinch gesture that optionally includes the attention of the user being directed to an application content element associated with the third user interface element, a button press that optionally includes attention of the user being directed to an application content element associated with the third user interface element, and/or a verbal request to display the third user interface element); in response to detecting the third request to display the third user interface element: in accordance with a determination that the third request to display the third user interface element is a request to display the third user interface element at a first distance from a respective portion of the first three-dimensional application volume (e.g., the third user interface element is associated with the respective portion of the first three-dimensional application volume based on one or more application settings, the respective portion is an application management control of the first three-dimensional application volume, a movement affordance (sometimes called a grabber) associated with the three-dimensional volume, a resize affordance associated with the three-dimensional volume, or another management control associated with the three-dimensional volume), displaying, via the one or more display generation components, the third user interface element at the first distance from the respective portion of the first three-dimensional application volume with a first size for the third user interface element (e.g., the fifth size is based on the first distance from the respective portion of the first three-dimensional application volume); and in accordance with a determination that the third request to display the third user interface element is a request to display the third user interface element at a second distance from the respective portion of the first three-dimensional application volume, displaying, via the one or more display generation components, the third user interface element at the second distance from the respective portion of the first three-dimensional application volume with a second size for the third user interface element that is different from the first size for the third user interface element. In some embodiments, the first size of the third user interface element is additionally determined based on a distance between the respective portion of the first three-dimensional application volume from the first viewpoint of the user (e.g., a size in one or more dimensions relative to the three-dimensional environment or a perceived size). In some embodiments, different weights are applied to the first distance from the respective portion of the first three-dimensional application volume and a distance between the respective portion of the first three-dimensional application volume from the first viewpoint of the user to determine the first size of the third user interface element). For example, in FIG. 18M, the computer system 101 displays the user interface element 18042 at a distance 18091 away from the movement affordance 18016 at the first size having the width of 18094, and the user interface element 18086 at a distance 18093 away from the movement affordance 18016 at the second size having the width of 18096. A displayed size of the user interface element increases with a distance between the user interface element and the movement affordance 18016. In some embodiments, the user interface element 18042 and the user interface element 18086 are the same type of user interface elements (e.g., user interface elements that provide information about application content elements of the application user interface).

In some embodiments, the first size of the third user interface element is determined based at least in part on: the first distance from the respective portion of the first three-dimensional application volume and a distance between the first viewpoint of the user and the respective portion of the first three-dimensional application volume. In some embodiments, the second size for the third user interface element is determined based at least in part on the second distance from the respective portion of the first three-dimensional application volume and at least in part on the distance between the first viewpoint of the user and the respective portion of the first three-dimensional application volume. For example, in FIG. 18N, the width 18110 is determined based both on the distance 18100 from the viewpoint of the user 7002 and the distance 18101 from the movement affordance 18016 (e.g., instead of solely based on the distance 18101 from the movement affordance 18016).

In some embodiments, the first three-dimensional application volume includes one or more user interface elements of a first type and one or more user interface elements of a second type, different from the first type; a respective user interface element of the first type has a size that is determined based on a distance between the respective user interface element of the first type and a viewpoint of the user (optionally without regard to a distance between the respective user interface element and a respective portion of the first three-dimensional application volume such as an application movement affordance); and a respective user interface element of the second type has a size that is determined based on a distance between the respective user interface element of the second type and a respective portion of the first three-dimensional application volume (such as an application movement affordance, optionally without regard to a distance between the respective user interface element of the second type and a viewpoint of the user). In some embodiments, one or more objects have sizes based on both the distance from the portion of the first three-dimensional application volume and the distance from the viewpoint of the user. In some embodiments, a first plurality of user interface elements are of the first type and a second plurality of user interface elements are of the second type, where sizes of the first plurality of user interface elements are determined based on the distance between the respective user interface element of the plurality of first user interface elements of first type and a viewpoint of the user, and sizes of the second plurality of user interface elements are determined based on the on a distance between the respective user interface element of the second plurality of user interface elements and a respective portion of the first three-dimensional application volume.

In some embodiments, one or more settings of the first user interface element are set to a first value (e.g., established by the developer of the application and/or user of the computer system such that a displayed size of the first user interface element is determined based on a distance of the first user interface element from a respective portion of the first three-dimensional application volume and one or more settings of the third user interface element are set to a second value, different from the first value, such that a displayed size of the third user interface element is determined based on a distance from the first viewpoint of the user. For example, in FIG. 18M, the computer system 101 displays the user interface element 18042 at a distance 18091 away from the movement affordance 18016 at the first size having the width of 18094, and the user interface element 18086 at a distance 18093 away from the movement affordance 18016 at the second size having the width of 18096. A displayed size of the user interface element increases with a distance between the user interface element and the movement affordance 18016. In FIG. 18B, the computer system 101 displays a user interface element 18018 at a first distance 18011 away from the viewpoint of the user 7002 at a first size above the building 18004. In FIG. 18J, the computer system 101 displays the user interface element 18042 at a distance 18062 away from the viewpoint of the user 7002 at a size having a width of 18064 above the building 18006. In some embodiments, a developer who designs the application user interface 18002 selects whether the displayed size of the user interface element is determined based on a distance between the user interface element and the movement affordance 18016 or based on a distance between the user interface element and the viewpoint of the user 7002.

In some embodiments, prior to detecting the first request to display the first user interface element, displaying, via the one or more display generation components, a first three-dimensional application volume of a first application that includes three-dimensional virtual content in the first view of the three-dimensional environment, wherein: the first user interface element is associated with a portion of the three-dimensional virtual content; and the portion of the three-dimensional virtual content is displayed with an initial size in the first view of the three-dimensional environment; while displaying, via the one or more display generation components, the first user interface element with a respective size and at a respective distance from the first viewpoint of the user, detecting, via the one or more input devices, a sequence of one or more inputs corresponding to a request to move the portion of the three-dimensional virtual content (e.g., an air pinch gesture that optionally includes movement of the air drag gesture while attention is directed toward the three-dimensional virtual content, a button press that optionally includes movement of the attention of the user, a verbal request to move the portion of the three-dimensional virtual content, and/or movement of the attention of the user while a selection input is performed by a hand of the user for moving the portion of the three-dimensional virtual content), wherein a ratio between the respective size of the first user interface element and the initial size of the portion of the three-dimensional virtual content is a first value; and in response to detecting the sequence of one or more inputs corresponding to the request to move the portion of the three-dimensional virtual content: displaying, via the one or more display generation components, the portion of the three-dimensional virtual content (e.g., and including the first three-dimensional application volume) at an updated location and with a new size; and displaying (e.g., redisplaying), via the one or more display generation components, the first user interface element with an updated size (e.g., while maintaining a fixed spatial relationship to the portion of the three-dimensional virtual content), wherein a ratio between the updated size of the first user interface element and the new size of the portion of the three-dimensional virtual content is the first value (e.g., the scale of the first user interface element to the portion of the three-dimensional is fixed, and/or does not change in response to a movement input). For example, in FIG. 18U, the computer system 101 maintains display of the user interface element 18018 and the application user interface 18002 at the same sizes, which appear smaller to the user 7002 due to a larger distance 18158 from the application user interface 18002 to the viewpoint of the user 7002. A ratio of a height 18162 of the user interface element 18018 to a height 18160 of the building 18004 illustrated in FIG. 18U is the same as the ratio of the height 18138 of user interface element 18018 to the height 18140 of the building 18004 in FIG. 18S.

In some embodiments, prior to detecting the first request to display the first user interface element, displaying, via the one or more display generation components, a first three-dimensional application volume of a first application that includes three-dimensional virtual content in the first view of the three-dimensional environment, wherein the first user interface element is associated with a portion of the three-dimensional virtual content; while displaying, via the one or more display generation components, the first user interface element at a respective distance with a respective size, from the first viewpoint of the user, detecting, via the one or more input devices, a sequence of one or more inputs that corresponds to a request to move the portion of the three-dimensional virtual content (e.g., an air pinch gesture that optionally includes movement of the air drag gesture while attention is directed toward the three-dimensional virtual content, a button press that optionally includes movement of the attention of the user, a verbal request to move the portion of the three-dimensional virtual content, and/or movement of the attention of the user while a selection input is performed by a hand of the user for moving the portion of the three-dimensional virtual content, and/or a request to move the three-dimensional application volume) relative to the first viewpoint of the user; and in response to detecting the sequence of one or more inputs corresponding to the request to move the portion of the three-dimensional virtual content relative to the first viewpoint of the user, ceasing display of the first user interface element (e.g., optionally after a threshold time period has elapsed after movement between the portion of the three-dimensional virtual content relative to the viewpoint of the user has begun, and/or ceasing display of the first user interface element when a movement between the portion of the three-dimensional virtual content relative to the viewpoint of the user greater than a threshold amount is detected for a time duration greater than a threshold detection period). For example, in FIGS. 18U and 18V, the computer system 101 ceases to display the user interface element 18018 while application user interface 18002 is moved within the three-dimensional environment in response to the air pinch gesture that include movement relative to the viewpoint of the user 7002.

In some embodiments, after ceasing display of the first user interface element, and while detecting (e.g., continuing to detect) the request to move the portion of the three-dimensional virtual content relative to the first viewpoint of the user, detecting termination of sequence of one or more inputs corresponding to the request to move the portion of the three-dimensional virtual content relative to the first viewpoint of the user (e.g., a release of the air pinch gesture that optionally included movement of the air drag gesture while attention is directed toward the three-dimensional virtual content, a release of the button press that optionally included movement of the attention of the user, a conclusion of the verbal request to move the portion of the three-dimensional virtual content, and/or a termination or release of a selection input is performed by the hand of the user for moving the portion of the three-dimensional virtual content); in response to detecting termination of the sequence of one or more inputs corresponding to the request to move the portion of the three-dimensional virtual content relative to the first viewpoint of the user, displaying (e.g., redisplaying), via the one or more display generation components, the first user interface element (e.g., redisplaying the first user interface element at a redisplay size based on a distance from the first user interface element to the first viewpoint of the user, and/or a ratio between the redisplay size of the first user interface element and a size of the portion of the three-dimensional virtual content at the updated location is maintained). For example, in FIG. 18W, in accordance with a determination that a movement of the hand of the user 7002 has ceased for at least a threshold amount of time, the computer system 101 displays the user interface element 18018 within the application user interface 18002, which is placed at a location in the three-dimensional environment that is further away from the viewpoint of the user 7002, based on the location of the air pinch gesture at the termination of the gesture.

In some embodiments, while displaying the first user interface element at a respective distance from the first viewpoint of the user, detecting, via the one or more input devices, a sequence of one or more inputs corresponding to a request to move a portion of the three-dimensional virtual content relative to the first viewpoint of the user to an updated location in the three-dimensional environment (e.g., an air pinch gesture that optionally includes movement of the air drag gesture while attention is directed toward the portion of the three-dimensional virtual content, a button press that optionally includes movement of the attention of the user, a verbal request to move the portion of the three-dimensional virtual content, and/or movement of the attention of the user while a selection input is performed by a hand of the user for moving the portion of the three-dimensional virtual content), and in response to detecting the sequence of one or more inputs corresponding to the request to move the portion of the three-dimensional virtual content relative to the first viewpoint of the user to an updated location in the three-dimensional environment: in accordance with a determination that one or more settings of the computer system has a first configuration, changing a size of the first user interface element in a first direction (e.g., resizing, expanding, contracting, and/or otherwise changing a size of the first user interface element in the first direction) from a first reference point (e.g., a first reference point about which the first user interface element is resized and/or the first user interface element is rescaled along a first direction, optionally away from other three-dimensional virtual content) in accordance with the first configuration of the one or more settings of the computer system; and in accordance with a determination that one or more settings of the computer system has a second configuration that is different from the first configuration, changing the size of the first user interface element in a second direction, different from the first direction, from a second reference point that is different from the first reference point, (e.g., a second reference point, different from the first reference point, about which the first user interface element is resized, the first user interface element is rescaled along a second direction, different from the first direction, optionally away from other three-dimensional virtual content; scaled up or down in the second direction, with the second reference point, such as the centroid, in the portion of the three-dimensional virtual content) in accordance with the second configuration of the one or more settings of the computer system. In some embodiments, the first application element is scaled up or down in the first direction relative to a first reference point. For example, the first reference point is on or near a right edge of the first user interface element (e.g., to the right of the centroid of the first user interface element), whereas the second reference point is on or near a left edge of the first user interface element (e.g., to the left of the centroid of the first user interface element. For example, in FIG. 18W, the user interface element 18018 is resized (e.g., enlarged and/or minimized) in an anisotropic fashion, such as being biased away from a line 18272 (e.g., or along a first direction relative to one or more application content elements, such as the user interface element 18018, the building 18006, or another content element of the application user interface 18002), a line 18176, or a line 18174.

In some embodiments, the first reference point (e.g., and/or the second reference point) is a fixed reference point (e.g., selected or preconfigured by the computer system, selected or preconfigured by a developer of the first application of the computer system, and/or selected or preconfigured by a user of the computer system via the one or more settings of the computer system). For example, in FIG. 18W, a developer who designs the application user interface 18002 selects a reference point (e.g., optionally on the line 18176 or a line 18174) about which the user interface element 18018 is resized.

In some embodiments, the second distance from the viewpoint of the user is greater than the first distance from the viewpoint of the user. In some embodiments, in response to detecting the sequence of one or more inputs corresponding to the first request to display the first user interface element: in accordance with a determination that the first request to display the first user interface element is a request to display the first user interface element at a third distance from the first viewpoint of the user that is less than the first distance from the first viewpoint of the user, displaying, via the one or more display generation components, the first user interface element at the third distance from the first viewpoint of the user with the first size for the first user interface element; and in accordance with a determination that the first request to display the first user interface element is a request to display the first user interface element at a fourth distance from the first viewpoint of the user that is greater than the second distance from the viewpoint of the user, displaying, via the one or more display generation components, the first user interface element at the fourth distance from the first viewpoint of the user with the second size for the first user interface element. For example, in the top view 18070-2 and the top view 18070-3, due to the first user interface element 18042 reaching a maximum size in the top view 18070-2, even though the application user interface 18002 is still further from the viewpoint of the user 7002 in the top view 18070-3 than in the top view 18070-2, the user interface element 18042 remains at the same size in the top view 18070-3 as in the top view 18070-2. In the top view 18070-5 and the top view 18070-6, due to the user interface element 18042 reaching a minimum size in the top view 18070-5, even though the application user interface 18002 is closer to the viewpoint of the user 7002 in the top view 18070-6 than in the top view 18070-5, the user interface element 18042 remains at the same size in the top view 18070-6 as in the top view 18070-5.

In some embodiments, prior to detecting the first request to display the first user interface element, displaying, via the one or more display generation components, a first three-dimensional application volume in the first view of the three-dimensional environment (e.g., the first three-dimensional application volume includes three-dimensional virtual content that corresponds to a first application); while displaying the first user interface element at a respective distance from the first viewpoint of the user with a respective size, detecting, via the one or more input devices, a change in viewpoint of the user from the first viewpoint of the user (e.g., movement of the viewpoint of the user and/or changes in a position of attention of the user that includes a change in a view of the three-dimensional environment) to a second viewpoint of the user; and in response to detecting the change in the viewpoint of the user from the first viewpoint of the user to the second viewpoint of the user: in accordance with a determination that a portion of the first three-dimensional application volume associated with the first user interface element (e.g., the first user interface element) is more than a threshold distance from the second viewpoint of the user, ceasing display of the first user interface element (e.g., and a portion of the three-dimensional application volume, optionally after a threshold time period has elapsed after the viewpoint of the user has stopped changing, display of the first user interface element at the respective location in the three-dimensional environment is maintained for a time period during movement of the viewpoint of the user and for the threshold time period after the viewpoint of the user has stopped changing, and/or ceasing display of the first user interface element when a movement of the viewpoint of the user greater than a threshold amount is detected for a time duration greater than a threshold detection period). In some embodiments, in accordance with a determination that a distance between the first user interface element at the respective location and the second position of the viewpoint of the user is less than or equal to the threshold distance, maintaining display of the first user interface element in the three-dimensional environment. For example, in FIG. 18Q, in response to detecting that the user 7002 has moved further away from the application user interface 18002 and that a distance between the application user interface 18002 and the user 7002 is larger than a threshold distance Hₜₕ, the computer system 101 ceases to display the user interface elements 18118, 18120, 18122, and 18126.

In some embodiments, the first three-dimensional application volume includes one or more user interface elements of a first type and one or more user interface elements of a second type, different from the first type. In some embodiments, while displaying the first user interface element at a respective distance (e.g., one of the first distance or the second distance) from the first viewpoint of the user, and with a respective size (e.g., one of the first size or the second size), detecting, via the one or more input devices, a first change in a viewpoint of the user from a first viewpoint corresponding to the first view of the three-dimensional environment to a second viewpoint corresponding to a second view of the three-dimensional environment; in response to detecting the first change in the viewpoint of the user; maintaining a size of one or more user interface elements of the first type as the viewpoint of the user changes in distance from the one or more user interface elements of the first type; and changing a size of one or more user interface elements of the second type based on a change in a distance of a viewpoint of the user from the one or more user interface elements of the second type; and after changing the size of the one or more user interface elements of the second type and maintaining a size of the one or more user interface elements of the first type, detecting a sequence of one or more inputs corresponding to a request to interact with the first user interface element (e.g., the sequence of one or more inputs includes an air pinch gesture while attention is directed toward the first user interface element, a button press that optionally includes the attention of the user being directed toward the first user interface element, a verbal request to perform an operation with respect to the first user interface element, and/or a selection input performed by a hand of the user to resize, move, and/or interact with one or more selectable user interface component associated with the first user interface element, while the first user interface element is displayed with the respective size); in response to detecting the sequence of one or more inputs corresponding to the request to interact with the first user interface element, changing a size of one or more user interface elements of the first type based on a change in a distance of a viewpoint of the user from the one or more user interface elements of the first type (optionally while maintaining a size of one or more user interface elements of the second type because the size of the one or more user interface elements of the second type has already changed based on a change in a distance of a viewpoint of the user from the one or more user interface elements of the second type). For example, in FIG. 18U, the application user interface 18002 includes an application setting that enables the resizing of the user interface elements (e.g., user interface element 18018) based on an occurrence of a specified event (e.g., movement of the application user interface 18002, movement of a viewpoint of the user, selection input directed to the user interface element, display of related content associated with the user interface element and/or other events that change to the user interface elements). In some embodiments, a developer who designs the application user interface 18002 selects the application setting to be used, and/or a user of the application user interface 18002 selects the application setting to be used. The application user interface 18002 includes an application setting that enables continuous (e.g., dynamic) resizing of the user interface elements as the user interface elements are moved.

In some embodiments, prior to detecting the first request to display the first user interface element, displaying, via the one or more display generation components, a first three-dimensional application volume at a first position in the three-dimensional environment (e.g., the first three-dimensional application volume includes three-dimensional virtual content of a first application); while displaying, via the one or more display generation components, the first user interface element at a respective distance from the first viewpoint of the user, detecting, via the one or more input devices, a sequence of one or more inputs that corresponds to a request to move the first three-dimensional application volume (e.g., in the three-dimensional environment) from the first position to a second position in the three-dimensional environment (e.g., an air pinch gesture that optionally includes movement of the air drag gesture while attention is directed toward a movement affordance of the first three-dimensional application volume, a button press that optionally includes movement of the attention of the user, a verbal request to move the portion of the first three-dimensional application volume, and/or movement of the attention of the user while a selection input is performed by a hand of the user for moving the first three-dimensional application volume); in response to detecting the sequence of one or more inputs that corresponds to the request to move the first three-dimensional application volume: displaying, via the one or more display generation components, the first three-dimensional application volume at the second position in the three-dimensional environment; in accordance with a determination that the second position is more than a threshold distance from the first viewpoint of the user, ceasing to display the first user interface element; and in accordance with a determination the second position is less than (e.g., or equal to) a threshold distance from the first viewpoint of the user, maintaining display, via the one or more display generation components, of the first user interface element (e.g., at an updated distance from the first viewpoint of the user, based at least in part on the movement of the first three-dimensional application volume from the first position to the second position). For example, in FIGS. 18P and 18R, in accordance with a determination that, while the application user interface 18002 is displayed at the distance 18117 from the viewpoint of the user 7002, the user interface element 18120, and the user interface element 18126 would be displayed at distances that are less than the threshold distance Hₜₕ, and in accordance with a determination that the user interface element 18118, and the user interface element 18122 would be displayed at distances that are greater than the threshold distance Hₜₕ, the computer system 101 displays the user interface element 18120, and the user interface element 18126 at distances that are less than the threshold distance Hₜₕ, and the computer system 101 forgoes displaying the user interface element 18118, and the user interface element 18122 at distances that are greater than the threshold distance Hₜₕ.

In some embodiments, prior to detecting the first request to display the first user interface element, displaying, via the one or more display generation components, a first three-dimensional application volume of a first application at a first position in the three-dimensional environment; while displaying the first user interface element at the first position in the three-dimensional environment, detecting, via the one or more input devices, an event corresponding to a change in size of the first user interface element (e.g., an air pinch gesture that optionally includes movement of the air drag gesture while attention is directed toward a resize affordance of the first user interface element, a button press that optionally includes movement of the attention of the user, a verbal request to resize the first user interface element, and/or movement of the attention of the user while a selection input is performed by a hand of the user for resizing the first user interface element); and in response to detecting the event corresponding to the change in size of the first user interface element: in accordance with a determination that a first reference point has been set for resizing the first user interface element, resizing the first user interface element from the first reference point; and in accordance with a determination that a second reference point, different from the first reference point, has been set for resizing the first user interface element, resizing the first user interface element from the second reference point. In some embodiments, resizing the first user interface element from a reference point includes changing a size of the first user interface element while maintaining a portion of the first user interface element closest to the reference point in a substantially fixed position relative to the reference point. For example, in FIG. 18AA, the enlargement of the resize affordance 18198 is centered about a reference point 18204, that is in a central portion (e.g., a center portion, or another portion) of a circle or ellipse associated with an arc of the resize affordance 18204. In some embodiments, a location of the reference point 18204 is selected by the computer system 101. In some embodiments, a developer who designs the application user interface 18002 selects the location of the reference point 18204.

In some embodiments, prior to detecting the first request to display the first user interface element, displaying, via the one or more display generation components, a first three-dimensional application volume of a first application at a first position in the three-dimensional environment; while displaying the first user interface element at the first position in the three-dimensional environment, detecting, via the one or more input devices, a sequence of one or more inputs corresponding to a request to change a size of the first three-dimensional application volume (e.g., an air pinch gesture that optionally includes movement of the air drag gesture while attention is directed toward a resize affordance of the three-dimensional application volume, a button press that optionally includes movement of the attention of the user, a verbal request to resize the three-dimensional application volume, and/or movement of the attention of the user while a selection input is performed by a hand of the user for resizing the three-dimensional application volume); and in response to detecting the sequence of one or more inputs corresponding to the request to change the size of the first three-dimensional application volume: in accordance with a determination that a third reference point has been set for resizing the first three-dimensional application volume, resizing the first three-dimensional application volume from the third reference point; and in accordance with a determination that a fourth reference point, different from the third reference point, has been set for resizing the first three-dimensional application volume, resizing the first three-dimensional application volume from the fourth reference point. In some embodiments, the third reference point is the same as the first reference point, and the fourth reference point is the same as the second reference point. In some embodiments, the first reference point and the third reference point are the same, and/or the first user interface element and the first three-dimensional application volume are resized in the same manner with respect to the same reference point. In some embodiments, the first reference point and the second reference point are different, and/or the first user interface element and the first three-dimensional application volume are resized in different manners and/or with respect to distinct reference points. In some embodiments, the third reference point and/or the fourth reference point are preconfigured using one or more settings of the first application (e.g., established by the developer of the application and/or user of the computer system). For example, in FIG. 18Y, the enlargement of the user interface element 18018 is centered about a reference point 18194, that is in a central portion of the user interface element 18018. In some embodiments, a location of the reference point 18194 is selected by the computer system 101. In some embodiments, a developer who designs the application user interface 18002 selects the location of the reference point 18194.

In some embodiments, while displaying the first user interface element at a respective distance of the first distance and the second distance from the first viewpoint of the user, and at a respective size of the first size and the second size, detecting, via the one or more input devices, a change in the first view of the three-dimensional environment (e.g., a change in positions and/or sizes of one or more displayed user interface elements visible in the first view of the three-dimensional environment, and/or a change in viewpoint of the user such that the first view of the three-dimensional environment is replaced by a different view of the three-dimensional environment that is visible from the changed viewpoint of the user); in response to detecting the change in the first view of the three-dimensional environment: in accordance with a determination that a distance between a current viewpoint of the user and the first user interface element in the current view of the three-dimensional environment has changed as a result of the change in the first view of the three-dimensional environment (e.g., because the current view of the three-dimensional environment is different from the first view of the three-dimensional environment, and/or because the first user interface element has been moved and/or rotated in the first view of the three-dimensional environment, such that the first user interface element has a different orientation at a time when the change in application content was detected, relative to when the first user interface element was initially displayed), changing a size of the first user interface element from a first reference point (e.g., in a first direction from the first reference point, optionally, such that the first user interface element is scaled up or down relative to the reference point; and in accordance with a determination that an orientation of the first user interface element as visible from a current viewpoint of the user has changed as a result of the change in the first view of the three-dimensional environment, changing an orientation of the first user interface element about an axis that intersects with the first reference point. In some embodiments, such that a plane of the first user interface element is aligned with a viewpoint of the user, and/or the reference point is a pivot point for rotating the first user interface element. In some embodiments, as described in more detail herein with reference to method 22000, the first user interface object pivots about the first reference point to change an orientation of the first user interface object from a first orientation relative to the three-dimensional virtual content to a second orientation, different from the first orientation, relative to the three-dimensional virtual content up based on the movement of the three-dimensional virtual content from a first location in the three-dimensional environment to a second location in the three-dimensional environment. For example, the top view 18190 in FIG. 18Y, shows the user interface element 18018 displayed within the application user interface 18002, in front of the user 7002. A side view 18192 shows the reference point 18194 serving, in addition to being a reference point for resizing the user interface element 18018, a pivot point for rotating a plane of the user interface element 18018.

In some embodiments, aspects/operations of methods 12000, 13000, 14000, 15000, 20000, and 22000 may be interchanged, substituted, and/or added between these methods. For brevity, these details are not repeated here.

FIG. 22 is a flow diagram illustrating a method 22000 for orienting two-dimensional user interface elements within a three-dimensional application volume when the three-dimensional application volume is moved with respect to the three-dimensional environment, in accordance with some embodiments. In some embodiments, method 22000 is performed at a computer system (e.g., computer system 101 in FIG. 1) that is in communication with one or more display generation components (e.g., a head-mounted display (HMD), a heads-up display, a display, a touchscreen, a projector, or other types of display) (e.g., display generation component 120 in FIGS. 1A, 3A, and 4, or the display generation component 7100a in FIGS. 19A-19N), and one or more input devices (e.g., sensors and hardware controls for detecting user inputs, one or more optical sensors such as cameras (e.g., color sensors, infrared sensors, structured light scanners, and/or other depth-sensing cameras) that points downward at a user's hand or a camera that points forward from the user's head, eye-tracking devices, touch sensors, touch-sensitive surfaces, proximity sensors, motion sensors, buttons, crowns, joysticks, user-held and/or user-worn controllers, and/or other sensors and input devices) (e.g., one or more input devices 125 and/or one or more sensors 190 in FIG. 1A, or sensors 7101a-7101c and/or the digital crown 703 in FIGS. 19A-19N). In some embodiments, the method 22000 is governed by instructions that are stored in a non-transitory (or transitory) computer-readable storage medium and that are executed by one or more processors of a computer system, such as the one or more processors 202 of computer system 101 (e.g., control 110 in FIG. 1A). Some operations in method 22000 are, optionally, combined and/or the order of some operations is, optionally, changed.

The devices, methods, and/or computer-readable storage mediums described below enhance the operability of the device and makes the user-device interface more efficient (e.g., by helping the user to provide proper inputs and reducing user mistakes when operating/interacting with the device) which, additionally, reduces power usage and/or improves battery life of the device by enabling the user to use the device more quickly and efficiently. As described herein, the method 22000 includes changing an orientation of a two-dimensional user interface element from a first orientation relative to the three-dimensional virtual content to a second orientation relative to the three-dimensional virtual content in response to the movement of the three-dimensional virtual content. Providing improved feedback (such as by changing an orientation of the two-dimensional user interface element from the first orientation relative to the three-dimensional virtual content to the second orientation relative to the three-dimensional virtual content in response to the movement of the three-dimensional virtual content) enhances the operability of the device by ensuring that two-dimensional user interface element is displayed at an orientation that allows the first user interface element to be more easily viewed by the user), reducing accidental and mistaken inputs, reducing energy usage by the device. Performing an operation when a set of conditions has been met without requiring further user input (such as by changing an orientation of the two-dimensional user interface element from the first orientation relative to the three-dimensional virtual content to the second orientation relative to the three-dimensional virtual content in response to the movement of the three-dimensional virtual content to provide relevant information to the user that is more easily viewed by the user) enhances the operability of the device by reducing unnecessary inputs and/or steps to navigate through different user interfaces or sets of controls, reducing energy usage by the device.

The computer system displays (22002), via the one or more display generation components, a first view of a three-dimensional environment that includes three-dimensional virtual content (e.g., the three-dimensional virtual content is non-passthrough content and/or virtual content that is computer-generated content that lacks a physical analog within an environment of the computer system, in FIG. 19A, the computer system 101 displays the building 19006, the building 19004 in the application user interface 19002)and a two-dimensional user interface element (e.g., with a first orientation relative to the three-dimensional virtual content, in FIG. 19A, the computer system 101 displays the user interface element 19016 and the user interface element 19020).

While displaying the first view of the three-dimensional environment that includes the three-dimensional virtual content and the two-dimensional user interface element, the computer system detects (22004), via the one or more input devices, one or more inputs (e.g., detecting an air pinch gesture, an air pinch and drag gesture, or other user input, optionally directed to a move affordance for moving the three-dimensional virtual content) that correspond to a first request to move the three-dimensional virtual content (e.g., confined within and/or corresponding to the first three-dimensional application volume) from a first location in the three-dimensional environment to a second location in the three-dimensional environment (e.g., in FIG. 19A, the user provides a movement input while attention is directed to the move affordance 19014); and

In response to detecting (22006) one or more inputs that correspond to the first request to move the three-dimensional virtual content (e.g., moving the move the three-dimensional virtual content includes moving the three-dimensional application volume in the three-dimensional environment) from the first location in the three-dimensional environment to the second location in the three-dimensional environment (e.g., as opposed to a user input that corresponds to a request to zoom the application content within the three-dimensional application volume, a request to zoom the three-dimensional application volume at the current location and depth, a request to resize the three-dimensional application volume as a whole, and one or more user inputs that correspond to a request to close and redisplay the three-dimensional application volume): the computer system moves (22008) the three-dimensional virtual content and the two-dimensional user interface element in the three-dimensional environment (e.g., from the first location in the three-dimensional environment to the second location in the three-dimensional environment that is different from the first location in the three-dimensional input) in accordance with the one or more inputs (e.g., redisplaying the three-dimensional virtual content after having faded it out at the first location, or moving the three-dimensional virtual content or the three-dimensional application volume as a whole from the first location to the second location in accordance with the first user input, such as through a plurality of intermediate locations between the first location and the second location, in FIG. 19B, the computer system 101 displays the application user interface 19002 at an updated location); and changes (22010) an orientation of the two-dimensional user interface element from a first orientation relative to the three-dimensional virtual content to a second orientation, different from the first orientation, relative to the three-dimensional virtual content (e.g., the orientation of the two-dimensional user interface element changes such that the two-dimensional user interface element faces a viewpoint of a user (e.g., changing the orientation of the respective two-dimensional content element relative to the three-dimensional virtual content displayed at the second location includes changing the orientation of the respective two-dimensional content element without moving the first three-dimensional application volume relative to the three-dimensional environment from the second location, or in other words while maintaining display of the first three-dimensional application volume at a same application orientation relative to the three-dimensional environment at the second location, as shown in the top view 19025 in FIG. 19B). In some embodiments, the two-dimensional content element is moved to maintain a spatial relationship to the moved three-dimensional virtual content, the computer system 101 changes an orientation of the user interface elements 19018, 19020, and 19016 relative to the three-dimensional virtual content elements of the application user interface 19002 (e.g., so that the user interface elements 19018, 19020, and 19016 are substantially perpendicular to a direction along which the attention 19010 of the user 7002 is directed).

In some embodiments, while displaying the two-dimensional user interface element with a respective orientation of the first orientation or the second orientation, detecting, via the one or more input devices, a first change in position of a viewpoint of a user (e.g., movement of the viewpoint of the user and/or changes in a position of attention of the user that includes a change in a view of the three-dimensional environment) from a first viewpoint to a second viewpoint; in response to detecting the first change in the viewpoint of the user: in accordance with a determination that first criteria are met (e.g., settings of the application indicating that the two-dimensional user interface element will not billboard, optionally, in accordance with a determination that the first change in the position of the viewpoint of the user is below a threshold): displaying, via the one or more display generation components, a second view of the three-dimensional environment (different from the first view of the three-dimensional environment) that corresponds to the second viewpoint; and maintaining display, via the one or more display generation components, of the two-dimensional user interface element with the respective orientation of the two-dimensional user interface element relative to the three-dimensional virtual content in the second view of the three-dimensional environment (e.g., maintaining the respective orientation of the two-dimensional user interface element displayed while the viewpoint of the user is at the first viewpoint). For example, in FIG. 19E, the computer system 101 maintains the orientations of the user interface element 19018, the user interface element 19018, and the user interface element 19018 (e.g., the orientation of each of the user interface elements 19018, 19020, and 19016 remain parallel to the movement affordance 19014, and are not changed relative to the three-dimensional environment), and forgoes rotating the user interface elements to face the viewpoint of the user 7002.

In some embodiments, in accordance with a determination that the first criteria are not met, wherein the first criteria are not met when the first change in the position of the viewpoint of the user from the first viewpoint to the second viewpoint does not satisfy an angular criterion of the first criteria (e.g., an angular criterion that is satisfied when a normal to a plane of the two-dimensional user interface element is at an angle less than a threshold, such as 70 degrees, 60 degrees, 50 degrees, 40 degrees or another angle, with respect to the second viewpoint), ceasing to display the two-dimensional user interface element. For example, in the top view 19056 of FIG. 19I, in accordance with a determination that an angle 19011-4 between a direction of the attention 19010 of the user 7002 to a respective portion of the user interface element 19044 and a line between the respective portion of the user interface element 19044 to a respective portion of the application user interface 19002 (e.g., the movement affordance 19014) is greater or equal a threshold value (e.g., 30°, 20°, 10°, 5°, or another angular value), the computer system 101 ceases to display the user interface element 19048.

In some embodiments, in accordance with the determination that the first criteria are not met, wherein the first criteria are not met when the first change in the position of the viewpoint of the user from the first viewpoint to the second viewpoint does not satisfy the angular criterion of the first criteria, changing a visual characteristic of at least a portion of the three-dimensional virtual content to reduce a visual emphasis of the portion of the three-dimensional virtual content (e.g., dimming, blurring, changing a color of, changing a size of, and/or changing a shape of at least the portion of the three-dimensional virtual content) that is associated with the two-dimensional user interface element (e.g., the two-dimensional user interface element is displayed in response to a selection input directed toward the portion of the three-dimensional virtual content). For example, in the top view 19056 of FIG. 19I, in accordance with a determination that the angle 19011-4 is greater or equal to the threshold value, the computer system 101 ceases to display the user interface element 19048 and the two-dimensional user interface element 19044 that is associated with the user interface element 19048 is also visually deemphasized (e.g., becoming more translucence, dimmer or reduced in visual prominence).

In some embodiments, changing the orientation of the two-dimensional user interface element from the first orientation relative to the three-dimensional virtual content to the second orientation relative to the three-dimensional virtual content includes changing an orientation of the two-dimensional user interface element with respect to a first axis (e.g., rotating the two-dimensional user interface element around the first axis), more than changing an orientation of the two-dimensional user interface element with respect to a second axis that is different from the first axis (e.g., without rotating the two-dimensional user interface element around the second axis or rotating the two-dimensional user interface element around the second axis by an amount that is less than an amount of rotation of the two-dimensional user interface element around the first axis). For example, in the side view 19066 of FIG. 19L, the plane of the user interface element 19080 rotates or billboards about the x-axis, and does not rotate or billboard about the y-axis.

In some embodiments, the first view of the three-dimensional environment corresponds to a first viewpoint of a user (e.g., the three-dimensional virtual content is off-centered in the first view of the three-dimensional environment); and the first request to move the three-dimensional virtual content from the first location in the three-dimensional environment to the second location in the three-dimensional environment includes a request to center the three-dimensional virtual content with respective to the first viewpoint of the user. In some embodiments, recentering the three-dimensional virtual content causes a central portion of the three-dimensional virtual content to be displayed head on from the first viewpoint of the user. In some embodiments, the request to recenter the three-dimensional virtual content with respect to the first viewpoint of the user is a press of a digital crown or button or a verbal request to recenter the three-dimensional virtual content with respect to the first viewpoint of the user. For example, in FIG. 19K, in response to detecting the user input 19061 directed toward the digital crown 703 (e.g., in FIG. 19J), the computer system 101 recenters the application user interface 19002 within the viewport of the user 7002 (e.g., moves the application user interface 19002 relative to the three-dimensional environment to a location that causes the application user interface 19002 to appear in substantially a center region of the viewport of the user 7002). An orientation of the user interface element 19064 (e.g., and the application user interface 19002) is rotated to face the viewpoint of the user 7002 head-on when the application user interface 19002 is recentered in response to the user input 19061 (e.g., a press input directed toward the digital crown 703).

In some embodiments, the first request to move the three-dimensional virtual content from the first location in the three-dimensional environment to the second location in the three-dimensional environment includes a movement input after detecting a selection input (e.g., a button press or an air pinch gesture, and the movement is part of an air drag gesture). In some embodiments, the second location in the three-dimensional environment is determined based on a termination location of the selection input (e.g., an end of an air pinch gesture or a release of a button input). In some embodiments, the selection input is detected while attention is directed toward the three-dimensional virtual content. For example, in FIG. 19A, the attention 19010 of the user 7002 is directed toward a movement affordance 19014 of the application user interface 19002, while the user 7002 performs an air pinch gesture that includes rightward and slight clockwise movement away the viewpoint of the user 7002.

In some embodiments, prior to displaying the two-dimensional user interface element in the first view of the three-dimensional environment that includes the three-dimensional virtual content, detecting, via the one or more input devices, a sequence of one or more inputs corresponding to a request to display the two-dimensional user interface element (e.g., the sequence of one or more inputs corresponding to the request to display the two-dimensional user interface element corresponds to a user selection of three-dimensional virtual content associated with the two-dimensional user interface element, the request to display the two-dimensional user interface element corresponds to user attention being directed to a region of the three-dimensional virtual content associated with the two-dimensional user interface element, an air pinch gesture that optionally includes the attention of the user being directed to an application content element associated with the two-dimensional user interface element, a button press that optionally includes attention of the user being directed to an application content element associated with the two-dimensional user interface element, and/or a verbal request to display the two-dimensional user interface element); in response to detecting the sequence of one or more inputs corresponding to the request to display the two-dimensional user interface element, displaying, via the one or more display generation components, the two-dimensional user interface element with an orientation that is based at least in part on the a location of the two-dimensional user interface element relative to a viewpoint corresponding to the first view (e.g., by rotating the two-dimensional user interface element about a first axis from an initial orientation). In some embodiments, the initial orientation is parallel to an edge of the three-dimensional virtual content. In some embodiments, displaying the two-dimensional user interface element includes displaying the two-dimensional user interface element at an orientation based on a viewpoint of the user when the display request for the two-dimensional user interface element is detected. In some embodiments, the method includes, in response to detecting the sequence of one or more inputs corresponding to the request to display the two-dimensional user interface element: in accordance with a determination that the viewpoint of the user corresponds to a first viewpoint, displaying, via the one or more display generation components (e.g., by the computer system), the two dimensional user interface element with a first updated orientation that is based at least in part on the first viewpoint; and in accordance with a determination that the viewpoint of the user corresponds to a second viewpoint, different from the first viewpoint, displaying, via the one or more display generation components (e.g., by the computer system), the two dimensional user interface element with a second updated orientation, different from the first updated orientation, that is based at least in part on the second viewpoint. For example, in FIG. 19C, a plane of the two-dimensional user interface element 19030 is oriented to face a viewpoint of the user 7002 head-on (e.g., because the user interface element 19030 was displayed after the changing in position and orientation of the application user interface 9002), based on the viewpoint at the time the two-dimensional user interface element 19030 is invoked.

In some embodiments, while displaying the first view of the three-dimensional environment that includes the three-dimensional virtual content, detecting, via the one or more input devices, a sequence of one or more inputs corresponding to a request to redisplay the two-dimensional user interface element (e.g., which is no longer displayed, and/or to redisplay the two-dimensional user interface element at a different location and/or with a different orientation, the sequence of the one or more inputs includes an air pinch gesture that optionally includes the attention of the user being directed to an application content element associated with the two-dimensional user interface element, a button press that optionally includes attention of the user being directed to an application content element associated with the two-dimensional user interface element, and/or a verbal request to redisplay the two-dimensional user interface element); in response to detecting the sequence of one or more inputs corresponding to the request to redisplay the two-dimensional user interface element, displaying (e.g., redisplaying) the two-dimensional user interface element with an orientation that is based at least in part on the location of the two-dimensional user interface element relative to a viewpoint corresponding to the first view (e.g., by rotating the two-dimensional user interface element about a first axis from an initial orientation). In some embodiments, the initial orientation is parallel to an edge of the three-dimensional virtual content. In some embodiments, redisplaying the two-dimensional user interface element includes redisplaying the two-dimensional user interface element at an orientation based on a viewpoint of the user when the redisplay request for the two-dimensional user interface element is detected. In some embodiments, the orientation of the two-dimensional user interface when the cessation request for ceasing display of the two-dimensional user interface element is different from the orientation of the two-dimensional user interface displayed when the two-dimensional user interface element is redisplayed. In some embodiments, the method includes in response to detecting the sequence of one or more inputs corresponding to the request to redisplay the two-dimensional user interface element: in accordance with a determination that the viewpoint of the user corresponds to a first viewpoint, displaying, via the one or more display generation components (e.g., by the computer system), the two dimensional user interface element with a first updated orientation that is based at least in part on the first viewpoint; and in accordance with a determination that the viewpoint of the user corresponds to a second viewpoint, different from the first viewpoint, displaying, via the one or more display generation components (e.g., by the computer system), the two dimensional user interface element with a second updated orientation, different from the first updated orientation, that is based at least in part on the second viewpoint. For example, in FIG. 19D, in response to detecting that the selection input performed by the user while the attention 19010 is directed toward the user interface element 19016, the computer system 101 rotates the plane of the user interface element 19016 (e.g., and optionally, only the user interface element 19016, towards which the attention 19010 of the user 7002 is directed) to face the viewpoint of the user 7002 head-on.

In some embodiments, while displaying the two-dimensional user interfacecontent element with the second orientation relative to the three-dimensional virtual content (e.g., the three-dimensional virtual content is displayed at the second location in the three-dimensional environment), detecting, via the one or more input devices, a change in viewpoint of a user (e.g., movement of the viewpoint of the user and/or changes in a position of attention of the user that includes a change in a view of the three-dimensional environment) from a first viewpoint to a second viewpoint; and in response to detecting the change in the viewpoint of the user from the first viewpoint to the second viewpoint, (e.g., in accordance with a determination that the change in the viewpoint of the user meets first criteria (e.g., the change in the viewpoint of the user is more than a threshold amount, of for example, 2 degree, 5 degree, 10 degree, 15 degree, or another value) changing, via the one or more display generation components, an orientation of the two-dimensional user interface element from the second orientation to a third orientation different from the second orientation, relative to the three-dimensional virtual content (e.g., the orientation of the two-dimensional user interface element changes to the third orientation such that the two-dimensional user interface element faces a viewpoint of a user (e.g., without moving the first three-dimensional application volume relative to the three-dimensional environment from the second location, or in other words while maintaining display of the first three-dimensional application volume at a same application orientation relative to the three-dimensional environment at the second location)). For example, in FIG. 19F, in response to detecting that the user 7002 has moved relative to the movement affordance 19014, the computer system 101 rotates the planes of the user interface element 19018, the user interface element 19020, and the user interface element 19016 (e.g., the orientation of each of the user interface elements 19018, 19020, and 19016 are updated so the user interface elements remain parallel to the movement affordance 19014 at its updated position) to face the viewpoint of the user 7002.

In some embodiments, displaying the first view of the three-dimensional environment includes displaying, via the one or more display generation components, a first user interface object that is associated with controlling the three-dimensional environment (e.g., an application management control of a first three-dimensional volume that encloses the three-dimensional virtual content, such as a movement affordance (sometimes called a grabber) associated with the three-dimensional volume, a resize affordance associated with the three-dimensional volume, or another management control associated with the three-dimensional volume, a move affordance that is selectable to initiate repositioning of the first three-dimensional volume relative to the three-dimensional environment) corresponding to the a first three-dimensional application volume, and moving the three-dimensional virtual content and the two-dimensional user interface element in the three-dimensional environment in accordance with the one or more inputs includes moving the first user interface object (e.g., relative to the first three-dimensional application volume) in the three-dimensional environment in accordance with the one or more inputs (e.g., the one or more inputs includes movement of the viewpoint to a different portion of the three-dimensional volume, a change in attention of the user to a different portion of the three-dimensional volume, and/or an air gesture directed to a portion of the three-dimensional volume, and moving the three-dimensional virtual content optionally includes ceasing to display the first user interface object at the first position relative to the first three-dimensional application volume and displaying the first user interface object at a second position relative to the first three-dimensional application volume); and changing the orientation of the two-dimensional user interface element from the first orientation relative to the three-dimensional virtual content to the second orientation relative to the three-dimensional virtual content includes: in accordance with a determination that the first user interface object is displayed at a first location, changing the orientation of the two-dimensional user interface element to a first updated orientation; and in accordance with a determination that the first user interface object is displayed at a second location, different from the first location, changing the orientation of the two-dimensional user interface element to a second updated orientation, different from the first updated orientation (e.g., changed in conjunction with, such as concurrently with, before, and/or after displaying the first user interface object at the second position relative to the first three-dimensional application volume). In some embodiments, as described in more detail herein with reference to method 15000, the first user interface object is displayed at an updated location due to a movement of the viewpoint of the user and/or a selection of the first user interface object. For example, in FIG. 19F, in response to detecting that the user 7002 has moved relative to the movement affordance 19014, the computer system 101 displays the movement affordance 19014 at an updated position with respect to the application user interface 19002 and rotates the planes of the user interface element 19018, the user interface element 19020, and the user interface element 19016 (e.g., the orientation of each of the user interface elements 19018, 19020, and 19016 are updated so the user interface elements remain parallel to the movement affordance 19014 at its updated position) to face the viewpoint of the user 7002.

In some embodiments, detecting, via the one or more input devices, a change in a viewpoint of the user from a first viewpoint to a second viewpoint; and in response to detecting the change in the viewpoint of the user from the first viewpoint to the second viewpoint, and in accordance with a determination that the change in the viewpoint of the user meets second criteria (e.g., the change in the viewpoint of the user is more than a threshold amount, of for example, 2 degree, 5 degree, 10 degree, 15 degree, or another value), moving the first user interface object from a first position in the three-dimensional environment to a second position in the three-dimensional environment that is different from the first position in the three-dimensional environment. For example, in FIG. 19F, after an amount of time t1 (e.g., 5 ms, 50 ms, 500 ms, 1 s, 2 s, or another time value) has elapsed after the movement of the viewpoint of the user 7002 has stopped (e.g., since the viewpoint of the user 7002 has remained substantially stationary), the computer system 101 redisplays the movement affordance 19014 at an updated anchoring point (e.g., the anchoring point 19040-2, at a time A2).

In some embodiments, the second criteria include a requirement that second viewpoint is maintained (e.g., the viewpoint of the user does not change from the second viewpoint) for a threshold duration (e.g., 0.2 s, 0.5 s, 1 s, 2 s, 5 s, or another time threshold duration) in order for the second criteria to be met. For example, in FIG. 19F, after an amount of time t1 (e.g., 5 ms, 50 ms, 500 ms, 1 s, 2 s, or another time value) has elapsed after the movement of the viewpoint of the user 7002 has dropped below a movement threshold (e.g., less than 50 mm, 40 mm, 30 mm, 20 mm, 10 mm, or another value) or has stopped (e.g., since the viewpoint of the user 7002 has remained substantially stationary), the computer system 101 redisplays the movement affordance 19014 at an updated anchoring point (e.g., the anchoring point 19040-2, at a time A2).

In some embodiments, displaying the first view of the three-dimensional environment that includes the three-dimensional virtual content and the two-dimensional user interface element includes displaying, via the one or more display generation components, the two-dimensional user interface element with a first spatial relationship to the first user interface object (e.g., a first and/or fixed angle relative to a reference axis of the first user interface object); and changing the orientation of the two-dimensional user interface element from the first orientation relative to the three-dimensional virtual content to the second orientation relative to the three-dimensional virtual content includes maintaining the first spatial relationship of the two-dimensional user interface element to the first user interface object. For example, in FIGS. 19M and 19N, the computer system 101 updates a position of the movement affordance 19014 and rotates (e.g., about the y-axis) the planes of the user interface element 19016, the user interface element 19020, and the user interface element 19064 to face the user 7002 at the updated position of the user 7002, while keeping a tilt (e.g., rotation about the x-axis) of the user interface element 19016, the user interface element 19020, and the user interface element 19064 at an angle 19098 (e.g., analogous to the angle 19094, rotated anti-clockwise from a vertical edge of the application user interface 19002, as viewed in a top view 19096).

In some embodiments, displaying the first view of the three-dimensional environment that includes the three-dimensional virtual content and the two-dimensional user interface element includes displaying, via the one or more display generation components, the two-dimensional user interface element with a first angle relative to a first axis. In some embodiments, the method includes: while displaying the three-dimensional virtual content at the second location and the two-dimensional user interface element with the second orientation, detecting, via the one or more input devices, a set of one or more user inputs that corresponds to a request to move the three-dimensional virtual content (e.g., from the second location in the three-dimensional environment) to a third location in the three-dimensional environment, wherein the second location is between the first location and the third location (e.g., the third location is the furthest away and the first location is the closest to the first viewpoint of the user of the first, second, and third locations); and in some embodiments, the third location is outside of a respective span of locations that includes the first location and the second location. In some embodiments, in response to detecting the set of one or more user inputs that corresponds to the request to move the three-dimensional virtual content to the third location in the three-dimensional environment: displaying, via the one or more display generation components, the three-dimensional virtual content at the third location; and changing the orientation of the two-dimensional user interface element from the second orientation to a third orientation that is different from the first orientation and the second orientation, including displaying the two-dimensional user interface element with the first angle relative to the first axis (e.g., the first angle relative to the first axis corresponds to a maximum or minimum angle at which the two-dimensional user interface element may be rotated about the first axis to face a viewpoint of the user, and/or a plane of the two-dimensional user interface element at the third orientation is not displayed perpendicularly to a viewpoint of the user). In some embodiments, in response to detecting a user input (e.g., a set of one or more user inputs) that corresponds to a request to move the first three-dimensional virtual content to a fourth location, wherein the first location is between the second location and the fourth location (e.g., the third location is the furthest away and the fourth location is the closest of the first, second, third, and fourth location to the first viewpoint of the user, or vice versa), the computer system displays the two-dimensional user interface element at the fourth location with the first orientation (e.g., the first orientation is associated with a minimum angle and the second orientation is associated with a maximum angle, or vice versa, to which the two-dimensional user interface element can be oriented). In some embodiments, the third location is associated with a maximum (or minimum) angle from the first viewpoint of the user to which the two-dimensional user interface element can be oriented with respect to the first viewpoint of the user. In some embodiments, the fourth location is associated with a minimum (or maximum) angle from the first viewpoint of the user to which the two-dimensional user interface element can be oriented. For example, in FIG. 19L, the side view 19066 shows the user interface element 19080 does not pivot beyond a maximum (e.g., clockwise rotation, in the side view 19066) angle or a minimum (e.g., anti-clockwise rotation) angle about the x-axis.

In some embodiments, displaying the first view of the three-dimensional environment that includes the three-dimensional virtual content and the two-dimensional user interface element includes displaying, via the one or more display generation components, the two-dimensional user interface element with the first angle relative to the first axis and a second angle relative to a second axis that is different from the first axis; and changing the orientation of the two-dimensional user interface element from the second orientation to the third orientation includes displaying the two-dimensional user interface element with the first angle relative to the first axis and a third angle, different from the second angle, relative to the second axis. In some embodiments, the second angle is not a maximum or minimum angle at which the two-dimensional user interface element may be rotated about the second axis to face a viewpoint of the user. For example, in FIG. 19L, the side view 19066 shows the user interface element 19080 does not pivot beyond a maximum (e.g., clockwise rotation, in the side view 19066) angle or a minimum (e.g., anti-clockwise rotation) angle about the x-axis. The top view 19168 shows that the user interface element 19080 does not have a maximum or minimum limit to the amount of rotation about the reference point 19078 (e.g., about the y axis).

In some embodiments, while displaying the three-dimensional virtual content at the second location in the three-dimensional environment and displaying the two-dimensional user interface element with the second orientation, detecting, via the one or more input devices, a set of one or more user inputs that corresponds to a request to move the three-dimensional virtual content (e.g., an air pinch gesture that optionally includes movement of the air drag gesture, a button press that optionally includes movement of the attention of the user, a verbal request to move the three-dimensional virtual content, and/or movement of the attention of the user while a selection input is performed by a hand of the user for moving the three-dimensional virtual content from the second location) to a fourth location in the three-dimensional environment, wherein the third location is between the first location and the fourth location; and in response to detecting the set of one or more user inputs that corresponds to the request to move the first three-dimensional virtual content to the fourth location in the three-dimensional environment: displaying, via the one or more display generation components, the a first three-dimensional application volume at the fourth location; and changing the orientation of the two-dimensional user interface element from the second orientation to a fourth orientation that is different from the first orientation and the second orientation, including displaying the two-dimensional user interface element with the first angle relative to the first axis and with the third angle relative to the second axis, wherein the first angle is different from the third angle. In some embodiments, the third angle is a maximum or minimum angle at which the two-dimensional user interface element may be rotated about the second axis to face the viewpoint of the user, and the first angle is a maximum or minimum angle at which the two-dimensional user interface element may be rotated about the first axis to face the viewpoint of the user. For example, in FIG. 19L, the side view 19066 shows the user interface element 19080 does not pivot beyond a maximum (e.g., clockwise rotation, in the side view 19066) angle or a minimum (e.g., anti-clockwise rotation) angle about the x-axis. The top view 19168 shows that the user interface element 19080 does not have a maximum or minimum limit to the amount of rotation about the reference point 19078 (e.g., about the y axis).

In some embodiments, changing the orientation of the two-dimensional user interface element from the first orientation relative to the three-dimensional virtual content to the second orientation includes: in accordance with a determination that a first pivot point has been selected (e.g., by the operating system or an application developer) for the two-dimensional user interface element, (e.g., a first configuration of settings defining one or more axes of rotation for the two-dimensional user interface element), rotating the two-dimensional user interface element about the first pivot point (e.g., a first pivot point for pivoting the two-dimensional user interface element from a reference orientation such as the first orientation, and/or an orientation that is parallel to an edge of the three-dimensional application volume, to the second orientation), and in accordance with a determination that a second pivot point, different from the first pivot point, has been selected (e.g., by the operating system or an application developer)for the two-dimensional user interface, rotating the two-dimensional user interface element about the second pivot point, different from the first pivot point (e.g., a second pivot point for pivoting the two-dimensional user interface element from a reference orientation such as the first orientation, and/or an orientation that is parallel to an edge of the three-dimensional application volume, to a third orientation). For example, in FIG. 19L, the side view 19067-1 shows that the user interface element 19074 is rotated clockwise (as viewed in the side view 19067-1) from a default position 19090 (e.g., parallel to a vertical edge of the application user interface 19002) about the reference point 19084 so that a plane of the user interface element 19074 is substantially perpendicular to a direction along which the attention 17014 of the user 7002 is directed. The side view 19067-3 shows that the user interface element 19074 is rotated clockwise (e.g., as viewed in the side view 19067-3) from the default position 19090 (e.g., parallel to the vertical edge of the application user interface 19002) about the reference point 19088 so that a plane of the user interface element 19074 is substantially perpendicular to a direction along which the attention 17014 of the user 7002 is directed. In some embodiments, a location of the reference point (e.g., whether the reference point 19088 or the reference point 19084 is selected) is selected by the computer system 101. In some embodiments, a developer who designs the application user interface 19002 selects the location of the reference point.

In some embodiments, aspects/operations of methods 12000, 13000, 14000, 15000, 20000, and 21000 may be interchanged, substituted, and/or added between these methods. For brevity, these details are not repeated here.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

As described above, one aspect of the present technology is the gathering and use of data available from various sources to improve accuracy and reliability when detecting where a user is located, where a user's attention is directed, and/or what hand gestures a user is performing. The present disclosure contemplates that in some instances, this gathered data may include personal information data that uniquely identifies or can be used to contact or locate a specific person. Such personal information data can include demographic data, location-based data, telephone numbers, email addresses, twitter IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to improve accuracy and reliability when detecting where a user is located, where a user's attention is directed, and/or what hand gestures a user is performing. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of XR experiences, the present technology can be configured to allow users to select to “opt in” or “opt out” of participation in the collection of personal information data during registration for services or anytime thereafter. In another example, users can select not to provide data for customization of services. In yet another example, users can select to limit the length of time data is maintained or entirely prohibit the development of a customized service. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, an XR experience can generated by inferring preferences based on non-personal information data or a bare minimum amount of personal information, such as the content being requested by the device associated with a user, other non-personal information available to the service, or publicly available information.

1. A method, comprising:
at a computer system that is in communication with one or more display generation components and one or more input devices:
displaying, via the one or more display generation components, a first view of a three-dimensional environment, wherein the first view of the three-dimensional environment includes first application content that corresponds to a first application;
while displaying the first application content that corresponds to the first application in the first view of the three-dimensional environment, detecting a first change in position of attention of a user relative to the first application content; and
in response to detecting the first change in position of the attention of the user relative to the first application content:
in accordance with a determination that the attention of the user has moved closer to a first portion of a first boundary that confines the first application content in two or more dimensions than to a second portion of the first boundary that is adjacent to the first portion of the first boundary, visually emphasizing the first portion of the first boundary relative to the second portion of the first boundary; and
in accordance with a determination that the attention of the user has moved closer to the second portion of the first boundary than the first portion of the first boundary, visually emphasizing the second portion of the first boundary relative to the first portion of the first boundary.

2. The method of claim 1, wherein detecting the first change in position of the attention of the user relative to the first application content includes detecting that the attention of the user has moved to a respective location in the three-dimensional environment that meets first criteria, wherein the first criteria require that the respective location is within a first threshold range of the first boundary in order for the first criteria to be met.

3. The method of claim 1, wherein the first portion of the first boundary is a portion of a respective two-dimensional surface, and the second portion of the first boundary is a different portion of the respective two-dimensional surface.

4. The method of claim 1, including:
in response to detecting the first change in position of the attention of the user relative to the first application content:
in accordance with a determination that the attention of the user has moved closer to a respective portion of the first boundary than to one or more other portions of the first boundary, visually emphasizing the respective portion of the first boundary relative to the one or more other portions of the first boundary.

5. The method of claim 1, including:
in response to detecting the first change in position of the attention of the user relative to the first application content:
displaying one or more portions of the first boundary that extend in a first dimension and a second dimension without displaying one or more portions of the first boundary that extend in a third dimension that is different from the first dimension and from the second dimension.

6. The method of claim 1, including:
while visually emphasizing a respective portion of the first boundary, detecting a second change in position of the attention of the user relative to the first application content; and
in response to detecting the second change in position of the attention of the user relative to the first application content:
in accordance with a determination that the attention of the user has moved closer to a third portion of the first boundary than to the respective portion of the first boundary:
ceasing to visually emphasize the respective portion of the first boundary, and visually emphasizing the third portion of the first boundary relative to the respective portion of the first boundary.

7. The method of claim 1, wherein detecting the first change in position of the attention of the user relative to the first application content includes detecting a change in position of a gaze of the user relative to the first application content.

8. The method of claim 1, wherein detecting the first change in position of the attention of the user relative to the first application content includes detecting movement of a viewpoint of the user relative to the first application content.

9. The method of claim 1, wherein the first portion of the first boundary is a portion of a first surface of the first boundary, and the second portion of the first boundary is a portion of a second surface of the first boundary.

10. The method of claim 1, wherein visually emphasizing a respective portion of the first boundary includes displaying a region of the respective portion that is closer to an edge of the first boundary with greater visual emphasis than a region of the respective portion that is further from the edge of the first boundary.

11. The method of claim 1, including:
in response to detecting the first change in position of the attention of the user relative to the first application content, displaying at least one of the first portion of the first boundary and the second portion of the first boundary without displaying one or more additional portions of the first boundary that are different from the first portion and from the second portion; and
while displaying the at least one of the first portion of the first boundary and the second portion of the first boundary without displaying the one or more additional portions of the first boundary, detecting a user input corresponding to a request to resize the first application content; and
in response to detecting the user input corresponding to the request to resize the first application content, displaying the one or more additional portions of the first boundary.

12. The method of claim 11, including:
in response to detecting the first change in position of the attention of the user relative to the first application content, displaying a first extent of the first boundary; and
in response to detecting the user input corresponding to the request to resize the first application content, displaying a second extent of the first boundary, wherein the second extent is greater than the first extent.

13. The method of claim 1, including:
displaying, via the one or more display generation components, a second view of a three-dimensional environment, wherein the second view of the three-dimensional environment includes second application content that corresponds to a second application;
while displaying the second application content that corresponds to the second application in the second view of the three-dimensional environment, detecting, via the one or more input devices, that the attention of the user has moved relative to the second application content; and
in response to detecting that the attention of the user has moved relative to the second application content:
in accordance with a determination that the second application content does not extend to a second boundary that confines the second application content in two or more dimensions and that the attention of the user has moved closer to a first portion of the second boundary than to a second portion of the second boundary that is adjacent to the first portion of the second boundary, visually emphasizing the first portion of the second boundary relative to the second portion of the second boundary; and
in accordance with a determination that the second application content extends to the second boundary, forgoing visually emphasizing the first portion of the second boundary relative to the second portion of the second boundary.

14. The method of claim 1, including displaying one or more application management controls corresponding to the first application at respective positions relative to the first application content based on the first boundary.

15. The method of claim 14, wherein the one or more application management controls include one or more auxiliary user interface elements displayed outside of the first boundary.

16. The method of claim 14, wherein the one or more application management controls include a resize affordance.

17. The method of claim 16, wherein:
detecting the first change in position of the attention of the user relative to the first application content includes detecting a change in position of the attention of the user to a respective location in the three-dimensional environment that is outside of a first region corresponding to the resize affordance; and
the resize affordance is displayed in response to detecting the first change in position of the attention of the user to the respective location in the three-dimensional environment.

18. The method of claim 17, wherein:
in accordance with a determination that the respective location in the three-dimensional environment is a first location in the three-dimensional environment, the resize affordance is displayed with a first spatial relationship relative to the first boundary; and
in accordance with a determination that the respective location in the three-dimensional environment is a second location in the three-dimensional environment that is different from the first location, the resize affordance is displayed with a second spatial relationship relative to the first boundary that is different from the first spatial relationship.

19. The method of claim 17, wherein the resize affordance displayed in response to detecting the first change in position of the attention of the user to the respective location in the three-dimensional environment is displayed with a first appearance, and the method includes:
while displaying the resize affordance with the first appearance, detecting, via the one or more input devices, a change in position of the attention of the user relative to the first application content to the first region corresponding to the resize affordance; and
in response to detecting the change in position of the attention of the user to the first region corresponding to the resize affordance, displaying, via the one or more display generation components, the resize affordance with a second appearance that is different from the first appearance.

20. The method of claim 17, including:
while displaying the resize affordance, detecting, via the one or more input devices, a change in position of the attention of the user outside of a second region corresponding to the resize affordance; and
in response to detecting the change in position of the attention of the user outside of the second region corresponding to the resize affordance, ceasing to display the resize affordance.

21. The method of claim 14, wherein the one or more application management controls include a move affordance.

22. The method of claim 14, wherein the one or more application management controls have a three-dimensional appearance that includes a non-zero length, non-zero width, and non-zero depth.

23. The method of claim 14, wherein displaying a respective control of the one or more application management controls includes:
in accordance with a determination that the first boundary has a first volumetric shape, displaying the respective control of the one or more application management controls with a first shape; and
in accordance with a determination that the first boundary has a second volumetric shape that is different from the first volumetric shape, displaying the respective control of the one or more application management controls with a second shape that is different from the first shape.

24. The method of claim 1, wherein displaying the first view of the three-dimensional environment includes displaying, via the one or more display generation components, third application content concurrently with the first application content with an overlap between a portion of a third boundary that confines the third application content in two or more dimensions and a portion of the first boundary, and the method includes:
while displaying the third application content concurrently with the first application content, detecting, via the one or more input devices, that the attention of the user is directed toward the overlap between the portion of the first boundary of the first application content and the portion of the third boundary of the third application content; and
in response to detecting that the attention of the user is directed toward the overlap between the portion of the first boundary of the first application content and the portion of the third boundary of the third application content:
in accordance with a determination that the first application content has higher priority than the third application content, visually emphasizing the portion of the first boundary of the first application content relative to the portion of the third boundary of the third application content; and
in accordance with a determination that the third application content has higher priority than the first application content, visually emphasizing the portion of the third boundary of the third application content relative to the portion of the first boundary of the first application content.

25. The method of claim 1, including:
while displaying one or more portions of the first boundary:
in accordance with a determination that the first application is associated with a first boundary appearance setting, displaying the one or more portions of the first boundary with a first appearance; and
in accordance with a determination that the first application is associated with a second boundary appearance setting that is different from the first boundary appearance setting, displaying the one or more portions of the first boundary with a second appearance that is different from the first appearance.

26. A computer system that is in communication with one or more display generation components and one or more input devices, the computer system comprising:
one or more processors; and
memory storing one or more programs configured to be executed by the one or more processors, the one or more programs including instructions for:
displaying, via the one or more display generation components, a first view of a three-dimensional environment, wherein the first view of the three-dimensional environment includes first application content that corresponds to a first application;
while displaying the first application content that corresponds to the first application in the first view of the three-dimensional environment, detecting a first change in position of attention of a user relative to the first application content; and
in response to detecting the first change in position of the attention of the user relative to the first application content:
in accordance with a determination that the attention of the user has moved closer to a first portion of a first boundary that confines the first application content in two or more dimensions than to a second portion of the first boundary that is adjacent to the first portion of the first boundary, visually emphasizing the first portion of the first boundary relative to the second portion of the first boundary; and
in accordance with a determination that the attention of the user has moved closer to the second portion of the first boundary than the first portion of the first boundary, visually emphasizing the second portion of the first boundary relative to the first portion of the first boundary.

27. A computer-readable storage medium storing one or more programs configured to be executed by one or more processors of a computer system that is in communication with one or more display generation components and one or more input devices, the one or more programs including instructions for:
displaying, via the one or more display generation components, a first view of a three-dimensional environment, wherein the first view of the three-dimensional environment includes first application content that corresponds to a first application;
while displaying the first application content that corresponds to the first application in the first view of the three-dimensional environment, detecting a first change in position of attention of a user relative to the first application content; and
in response to detecting the first change in position of the attention of the user relative to the first application content:
in accordance with a determination that the attention of the user has moved closer to a first portion of a first boundary that confines the first application content in two or more dimensions than to a second portion of the first boundary that is adjacent to the first portion of the first boundary, visually emphasizing the first portion of the first boundary relative to the second portion of the first boundary; and
in accordance with a determination that the attention of the user has moved closer to the second portion of the first boundary than the first portion of the first boundary, visually emphasizing the second portion of the first boundary relative to the first portion of the first boundary.

28-103. (canceled)
